(19) United States
(12) Patent Application Publication
(10) Pub. No.: US 2014/0006306 A1
(43) Pub. Date: Jan. 2, 2014

(54) Consistent Interface for Sales Order

(71) Applicant: Sanu Koshy, Chennai (IN)

(72) Inventor: Sanu Koshy, Chennai (IN)

(73) Assignee: SAP AG

(21) Appl. No.: 13/535,648

(22) Filed: Jun. 28, 2012

(51) Int. Cl. G06Q 10/00

(52) U.S. Cl. 705/345

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a sales order business object.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

Some details of the subject matter of this specification are described in previously-filed U.S. patent application Ser. No. 11/803,178, entitled “Consistent Set of Interfaces Derived From a Business Object Model”, filed on May 11, 2007, which is hereby incorporated by reference.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer-readable medium includes program code for providing a message-based interface for exchanging information about sales orders. The medium comprises program code for receiving, via a message-based interface exposing at least one service as defined in a service registry and from a heterogeneous application executing in an environment of computer systems providing message-based services, a first message for querying information about specific sales orders, identified by selection criteria, including information about parties associated with sales orders and corresponding purchase orders. The first message includes a message package hierarchically organized as a sales order by elements query sync message entity, where the sales order by elements query sync message entity includes a sales order selection by elements entity from a sales order selection by elements package, and where the sales order selection by elements entity includes at least one selection by identifier (ID). The medium further comprises program code for sending a second message to the heterogeneous application responsive to the first message.

Implementations can include the following. The sales order selection by elements entity further includes at least one of the following: at least one selection by buyer party ID, at least one selection by item list customer order life cycle status code, at least one selection by name, at least one selection by buyer ID, at least one selection by posting date, at least one selection by data origin type code, at least one selection by item list execution release status code, at least one selection by approval status code, and at least one selection by employee responsible party ID. The sales order selection by elements entity further includes at least one of the following: at least one selection by sales unit party ID, at least one selection by sales and service business area sales organisation ID, at least one selection by sales and service business area distribution channel code, at least one selection by service performer party ID, at least one selection by service execution team party ID, at least one selection by product ID, at least one selection by product requirement specification ID, and at least one selection by last changed date.

In another aspect, a distributed system operates in a landscape of computer systems providing message-based services defined in a service registry. The system comprises a graphical user interface comprising computer readable instructions, embedded on tangible media, for querying information about specific sales orders, identified by selection criteria, including information about parties associated with sales orders and corresponding purchase orders, the instructions using a request. The system further comprises a first memory storing a user interface controller for processing the request and involving a message including a message package hierarchically organized as a sales order by elements query sync message entity, where the sales order by elements query sync message entity includes a sales order selection by elements entity from a sales order selection by elements package, and where the sales order selection by elements entity includes at least one selection by identifier (ID). The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

In another aspect, a computer-readable medium includes program code for providing a message-based interface for exchanging information about sales orders. The medium comprises program code for receiving, via a message-based interface exposing at least one service as defined in a service registry and from a heterogeneous application executing in an environment of computer systems providing message-based services, a first message for querying information about sales orders, including information about parties associated with sales orders and corresponding purchase orders, the information used to enable an initial load of data, including for a fast search infrastructure. The first message includes a message package hierarchically organized as a sales order query all sync message entity, wherein the sales order query all sync message entity includes a processing constraints entity for specifying a format and content of sales order data to be returned. The medium further comprises program code for sending a second message to the heterogeneous application responsive to the first message.

In another aspect, a distributed system operates in a landscape of computer systems providing message-based services defined in a service registry. The system comprises a graphical user interface comprising computer readable instructions, embedded on tangible media, for querying information about sales orders, including information about parties associated with sales orders and corresponding purchase orders, the information used to enable an initial load of data, including for a fast search infrastructure, the instructions using a request. The system further comprises a first memory storing a user interface controller for processing the request and involving a message including a message package hierarchically organized as a sales order query all sync message entity, wherein the sales order query all sync message entity includes a processing constraints entity for specifying a format and content of sales order data to be returned. The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIGS. 32-1 through 32-7 depict an example SalesOrder object model.

FIG. 33 depicts an example SalesOrderByElementsQuery_sync message data type.

FIGS. 34-1 through 34-22 depict an example SalesOrderByElementsResponse_sync message data type.

FIGS. 35-1 through 35-20 depict an example SalesOrderByElementsQuery_sync element structure.

FIGS. 36-1 through 36-485 depict an example SalesOrderByElementsResponse_sync element structure.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

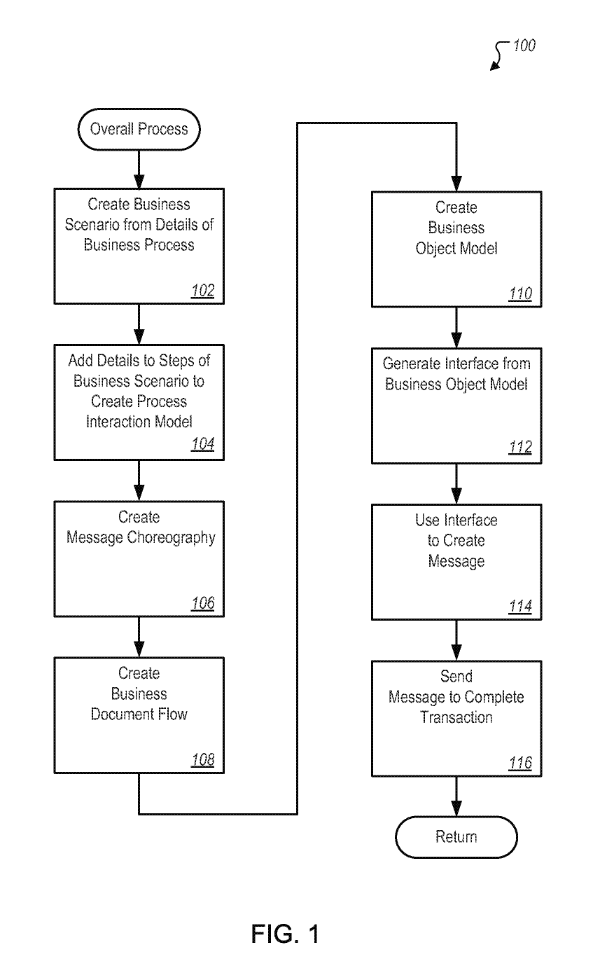

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

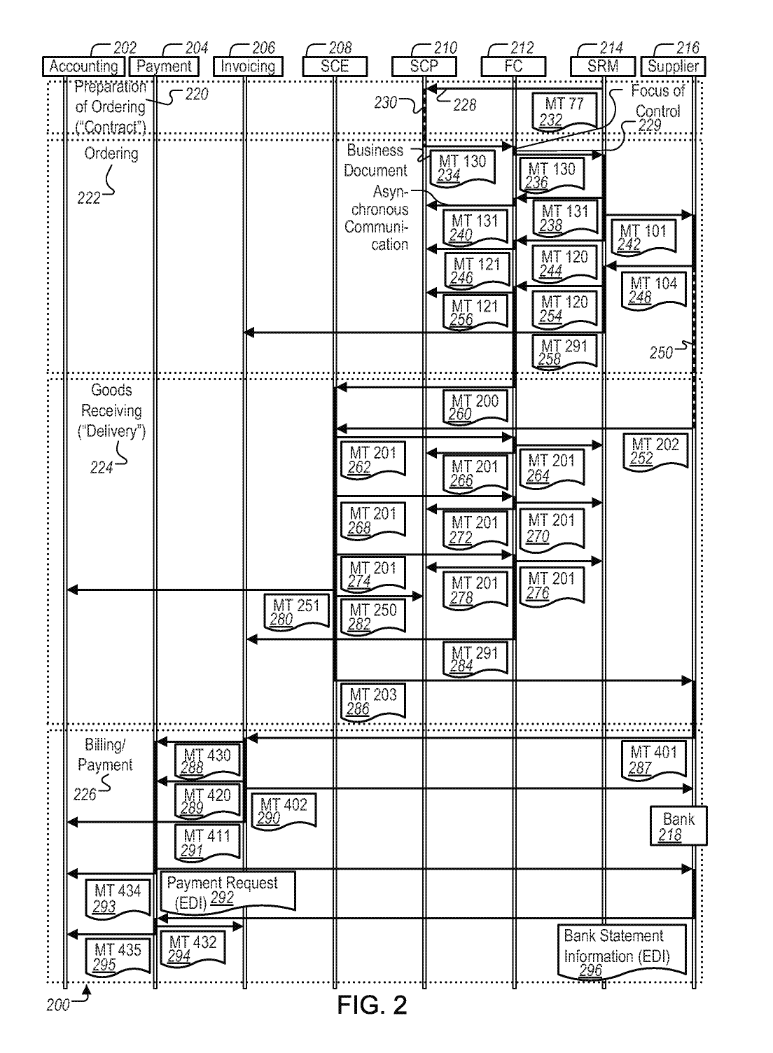

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

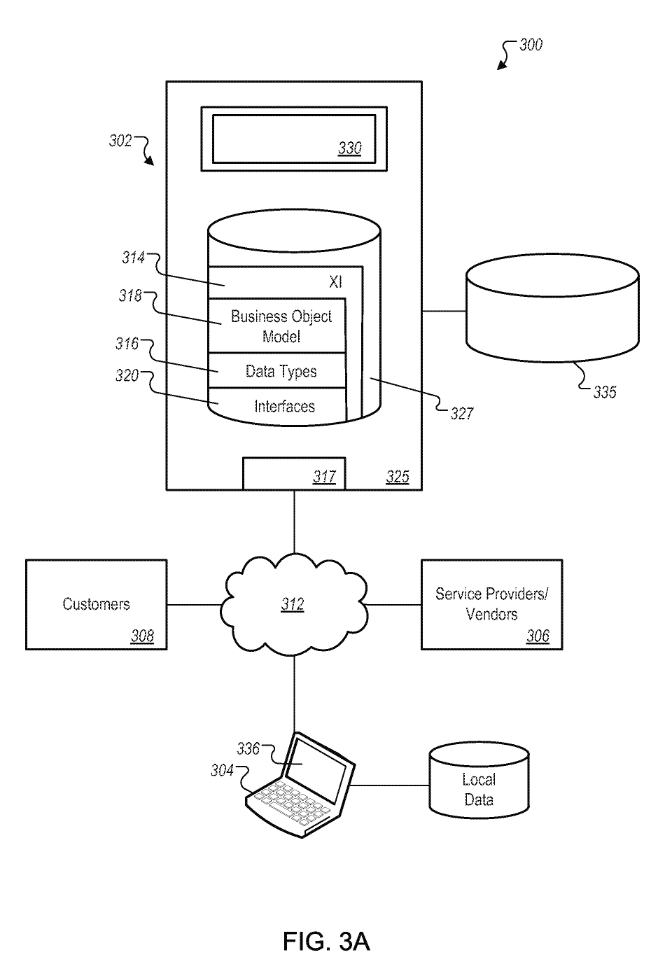

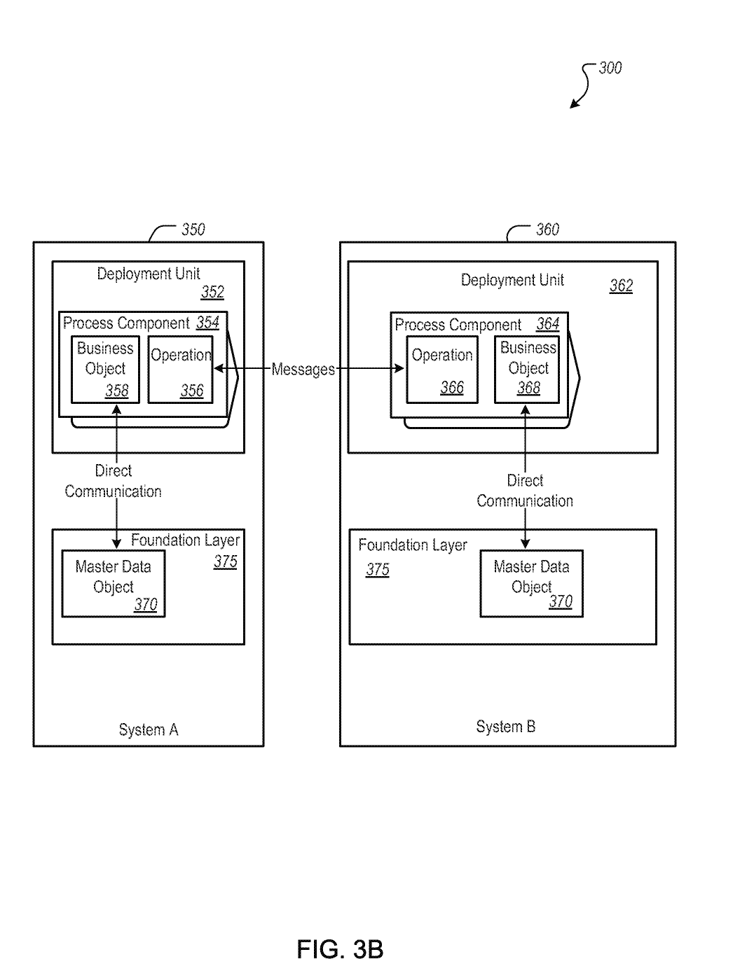

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

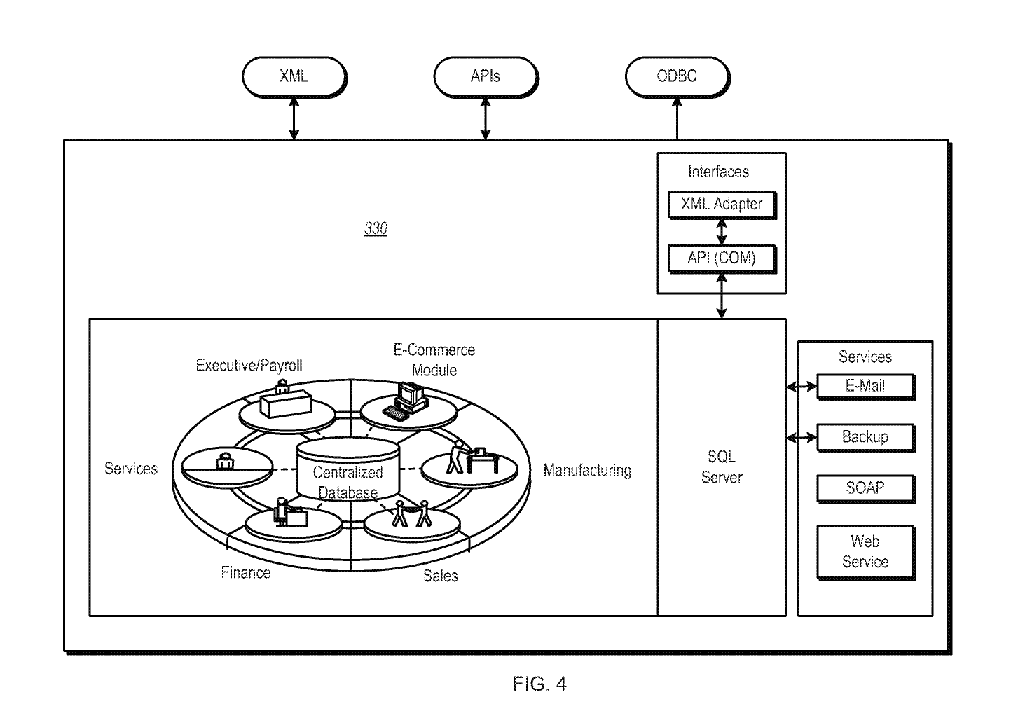

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

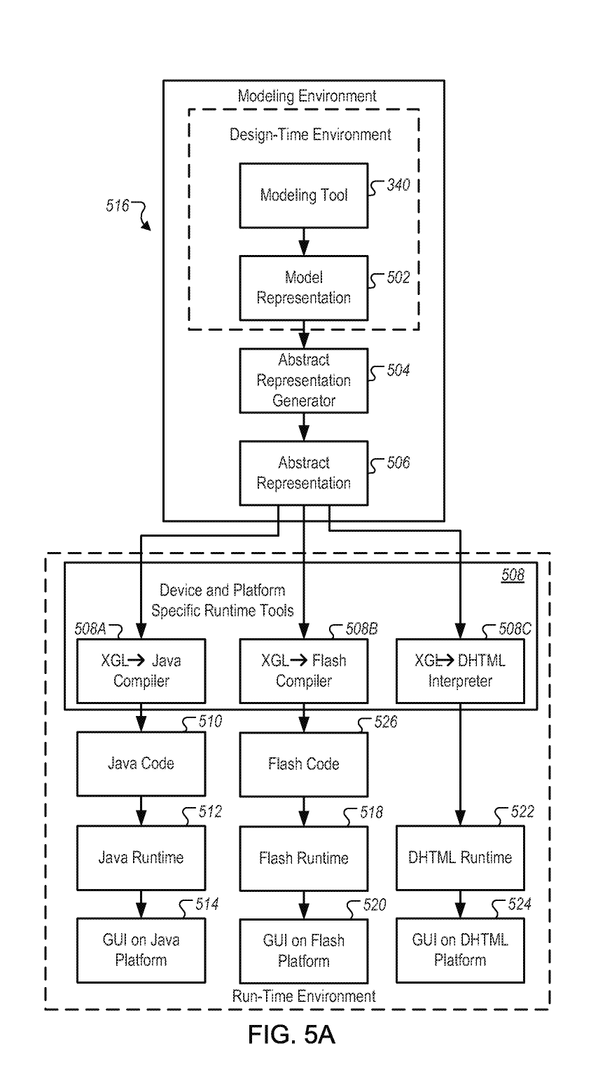

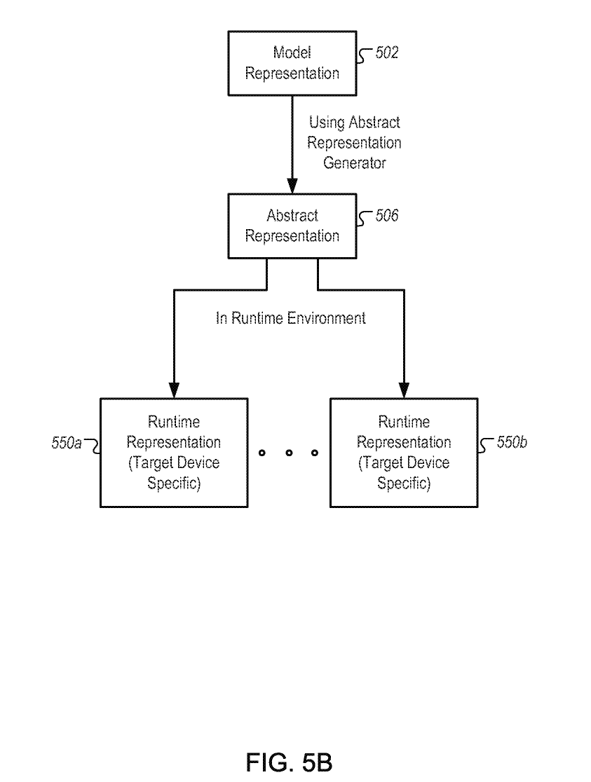

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

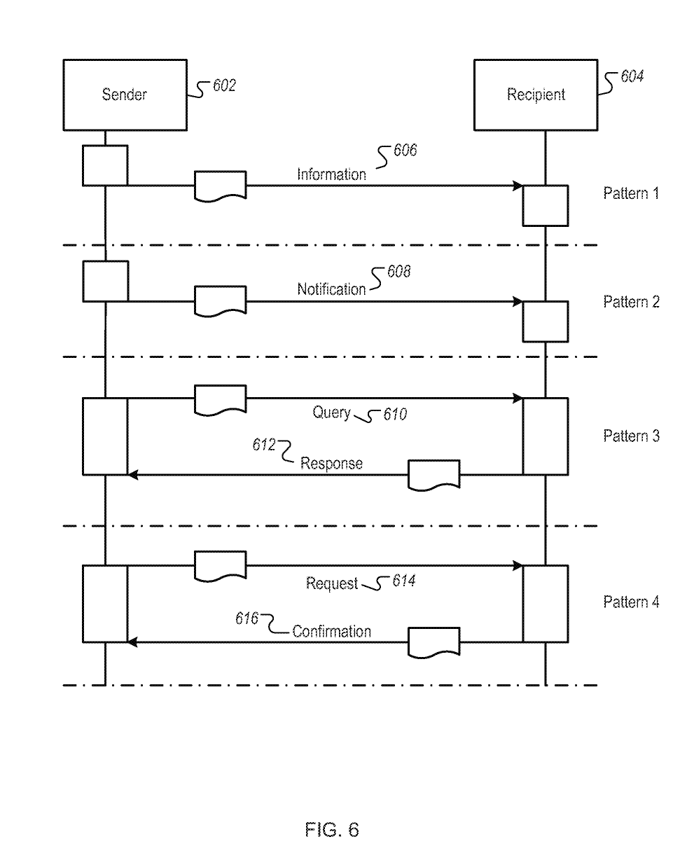

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

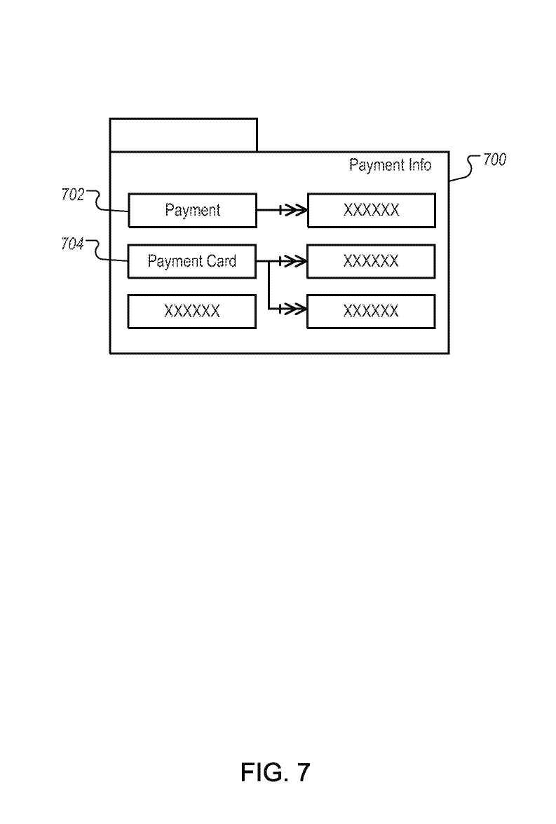

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

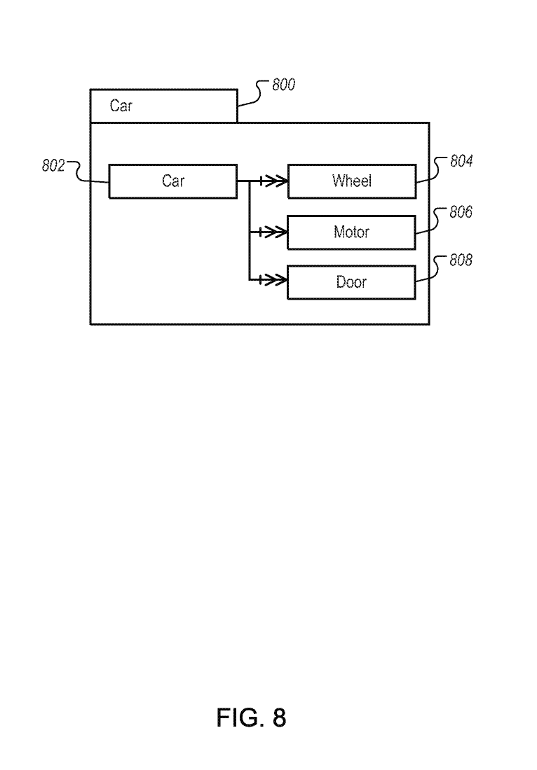

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

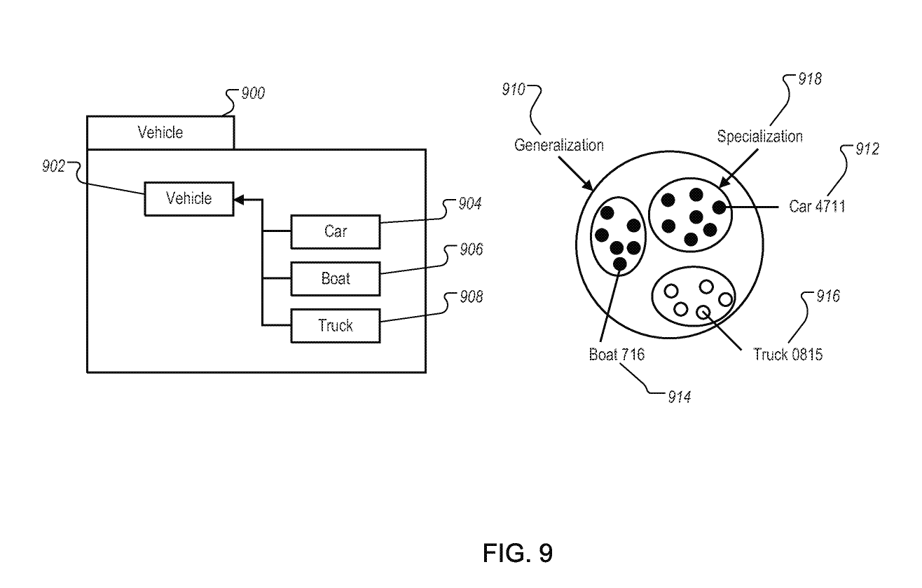

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

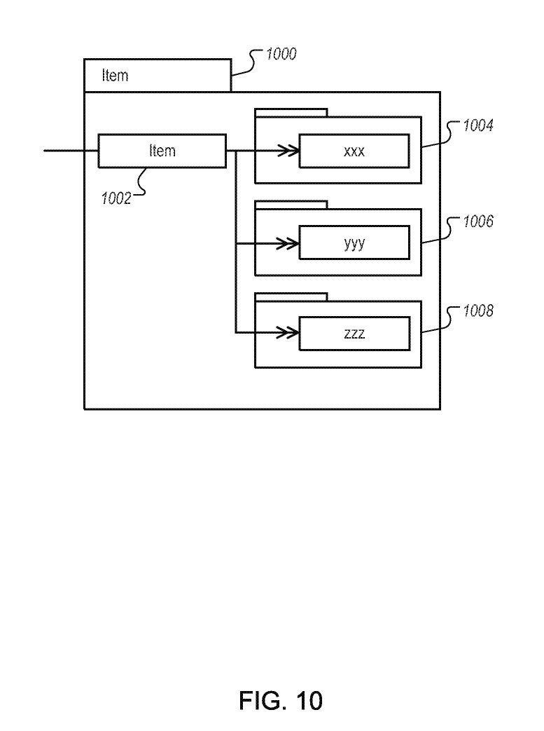

Packages also may be used to represent hierarchy levels. For example, as depicted in FIG. 10, the Item Package 1000 includes Item 1002 with subitem xxx 1004, subitem yyy 1006, and subitem zzz 1008.

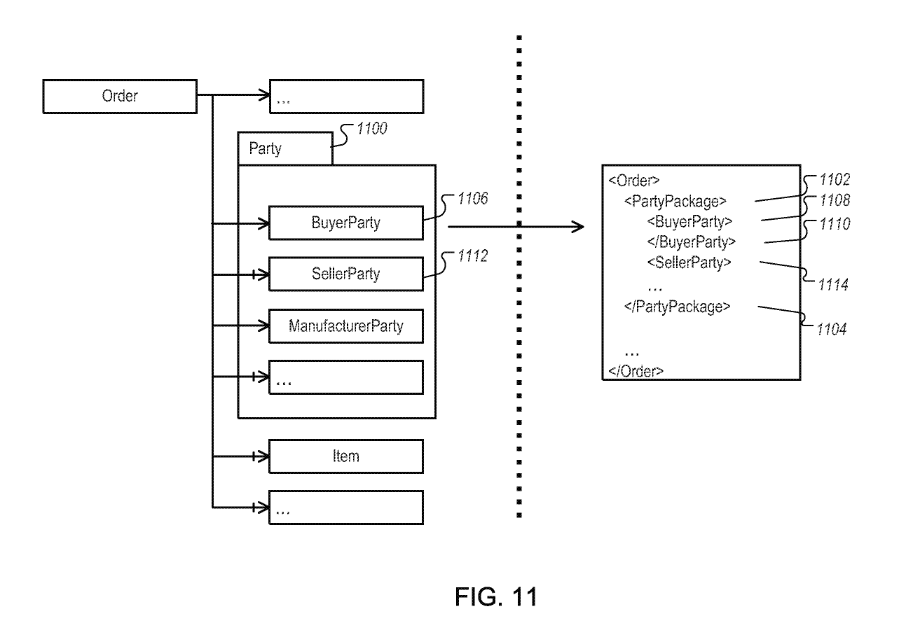

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

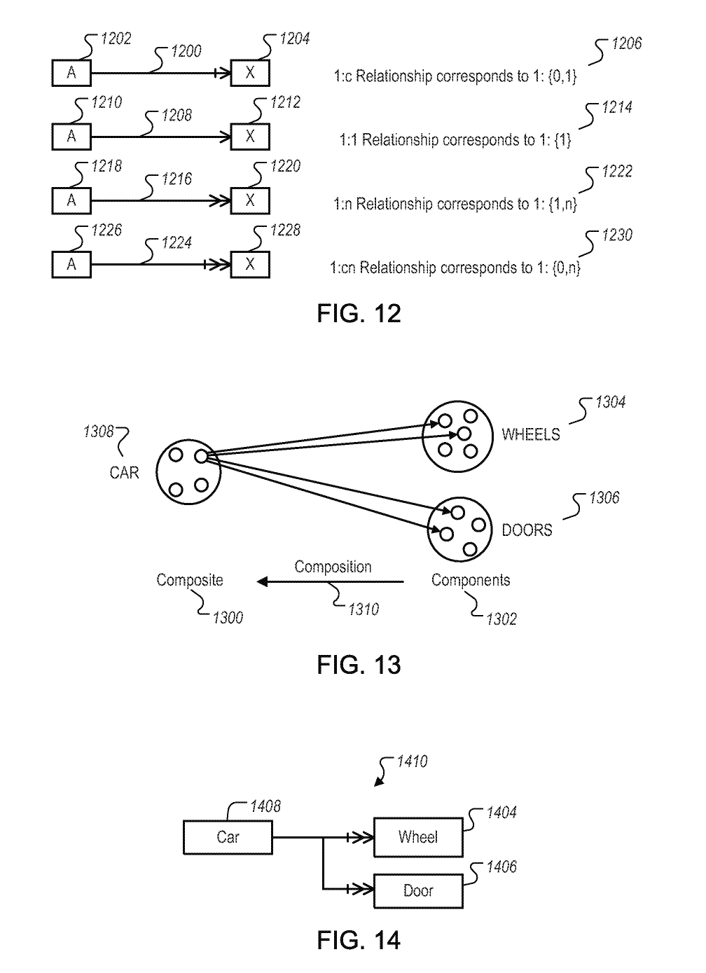

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

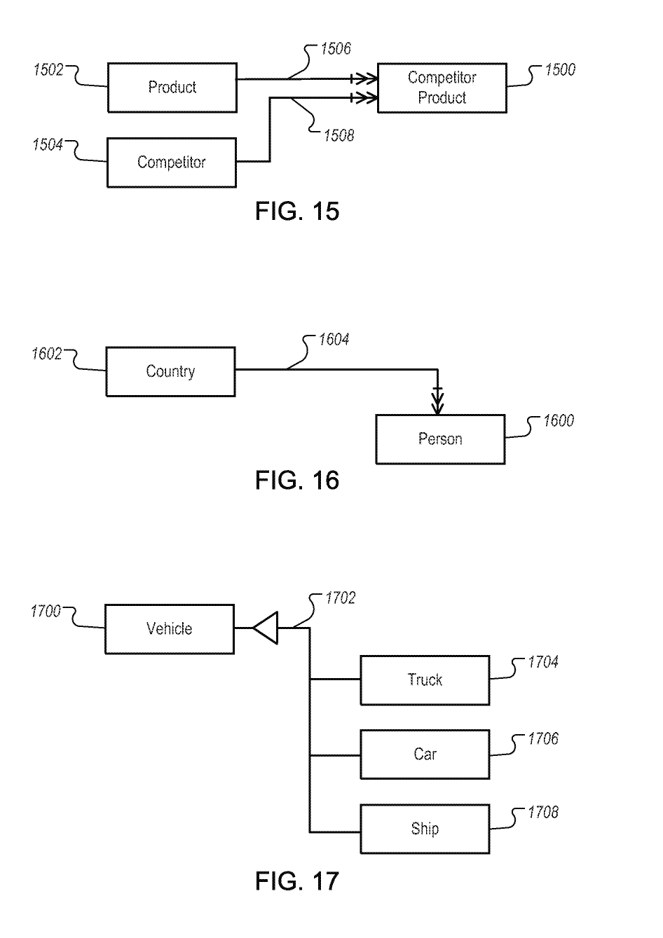

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

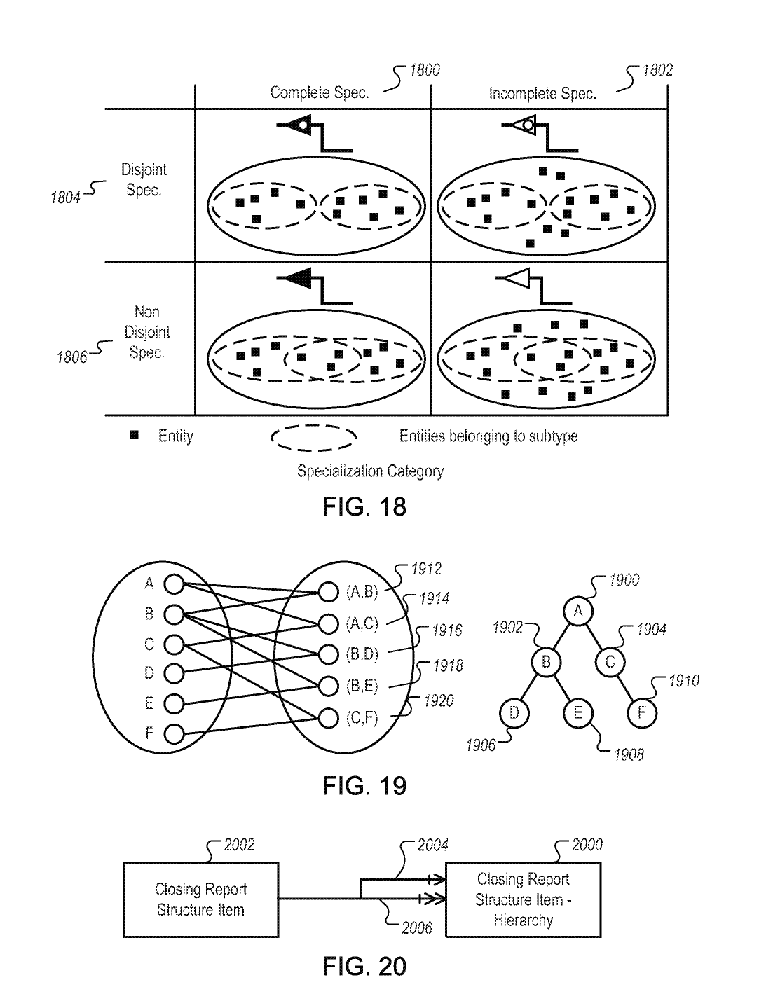

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

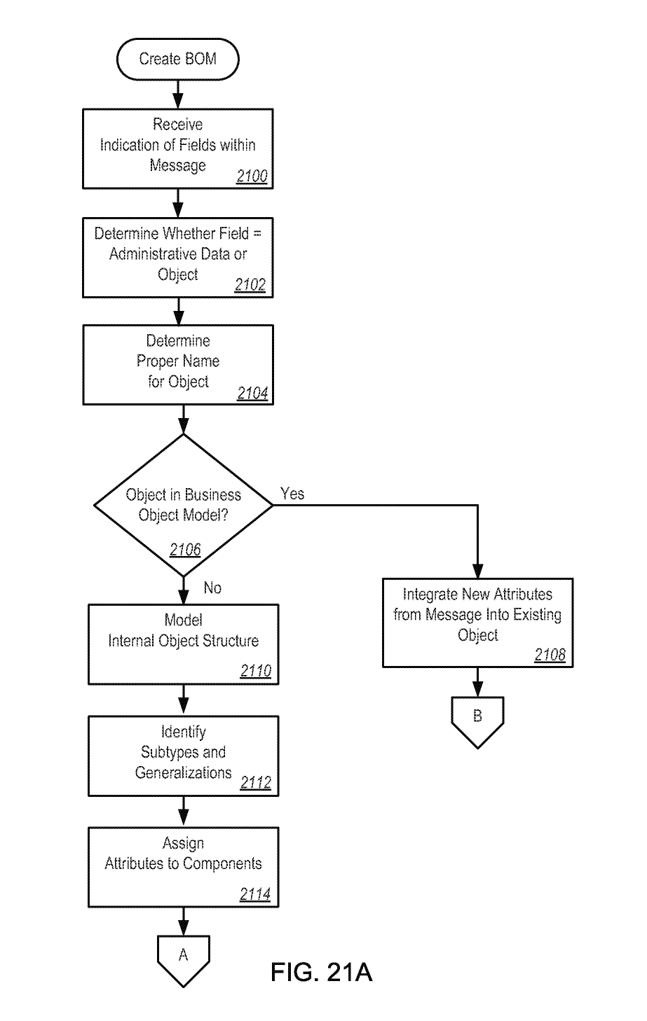

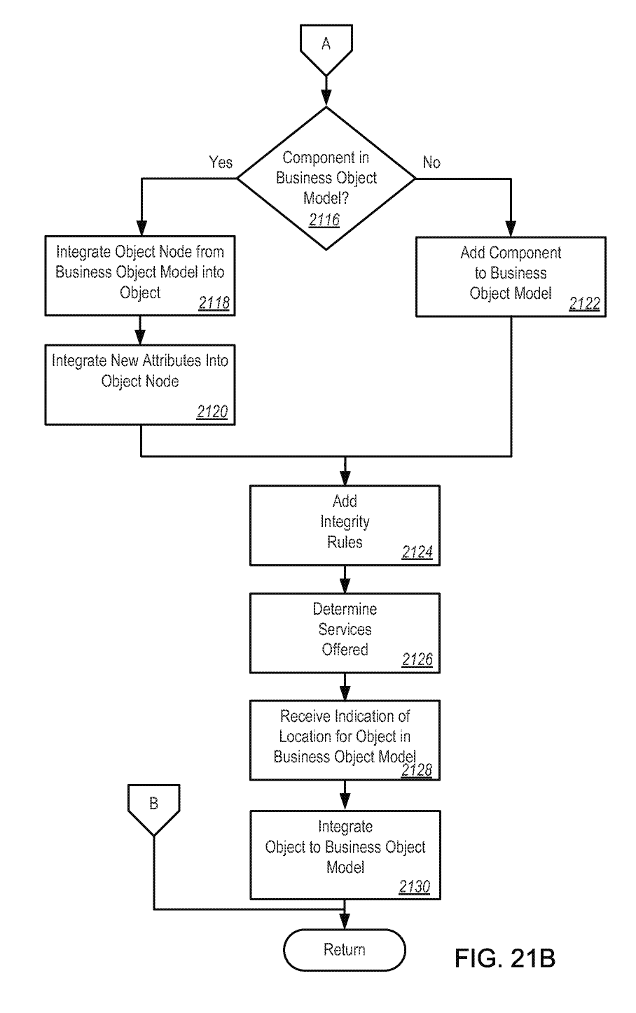

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase | | |
| AdditionalID | Order | | |
| PostingDate | | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | DeliveryTerms | | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase Order | |
| ParentItemID | | Item | |
| HierarchyType | | | |
| ProductID | | | Product |
| ProductType | | | |
| ProductNote | | | |
| ProductCategoryID | | | Product |
| | | | Category |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| Purchase | | | | 1 |
| Order | | | | |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | Delivery | | | 0 . . . 1 |
| | Terms | | | |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | Cash | | | 0 . . . 1 |
| | Discount | | | |
| | Terms | | | |
| | | MaximumCashDiscount | | 0 . . . 1 |
| | | NormalCashDiscount | | 0 . . . 1 |
| | Payment | | | 0 . . . 1 |
| | Form | | | |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | Delivery | 1 |
| | | | Period | |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | Contact | | 0 . . . 1 |
| | | | Person | | |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentF orm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase- | | | | 1 |
| Order | | | | |
| | ID | | | 1 |
| | SellerID | | | 0 . . . 1 |
| | BuyerPosting- | | | 0 . . . 1 |
| | DateTime | | | |
| | BuyerLast- | | | 0 . . . 1 |
| | ChangeDate- | | | |
| | Time | | | |
| | SellerPosting- | | | 0 . . . 1 |
| | DateTime | | | |
| | SellerLast- | | | 0 . . . 1 |
| | ChangeDate- | | | |
| | Time | | | |
| | Acceptance- | | | 0 . . . 1 |
| | StatusCode | | | |
| | Note | | | 0 . . . 1 |
| | ItemList- | | | 0 . . . 1 |
| | Complete- | | | |
| | Transmission- | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product- | | | 0 . . . 1 |
| | RecipientParty | | | |
| | VendorParty | | | 0 . . . 1 |
| | Manufacturer- | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo- | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom- | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

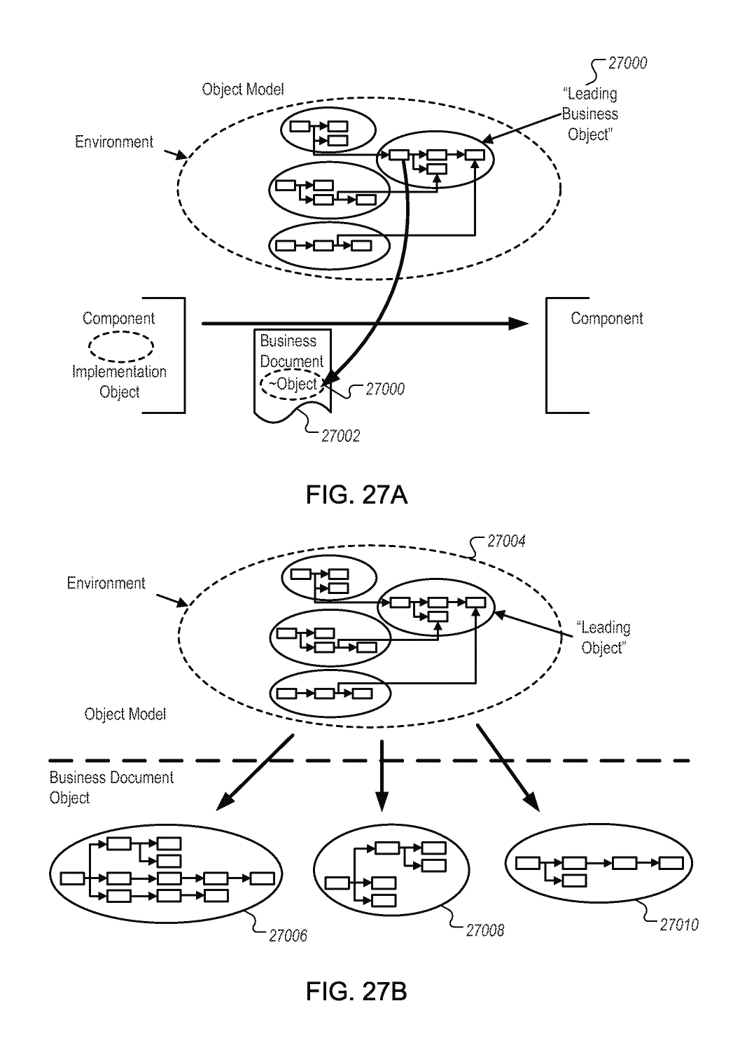

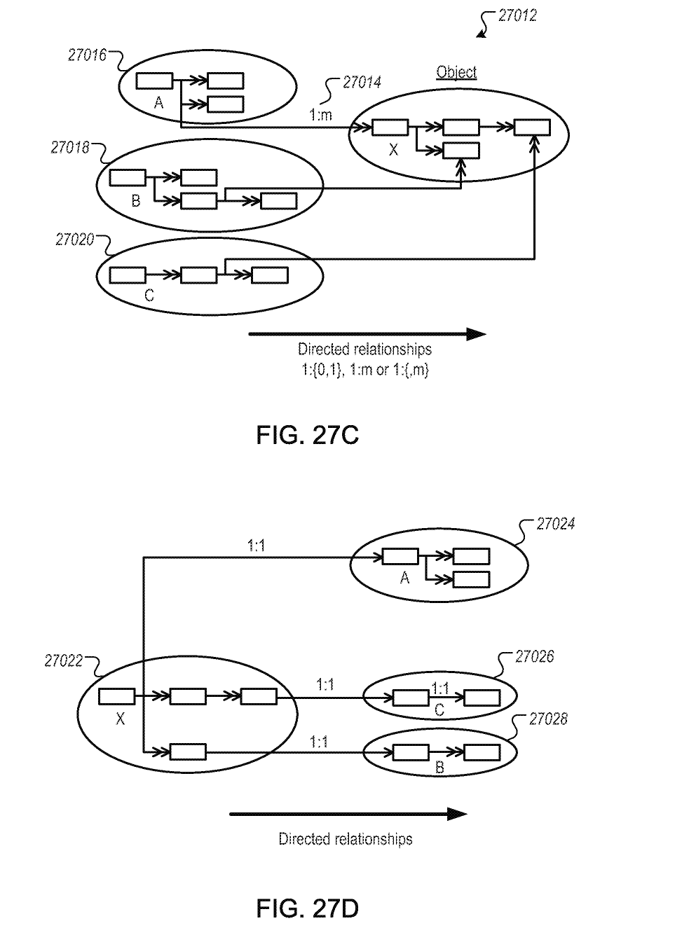

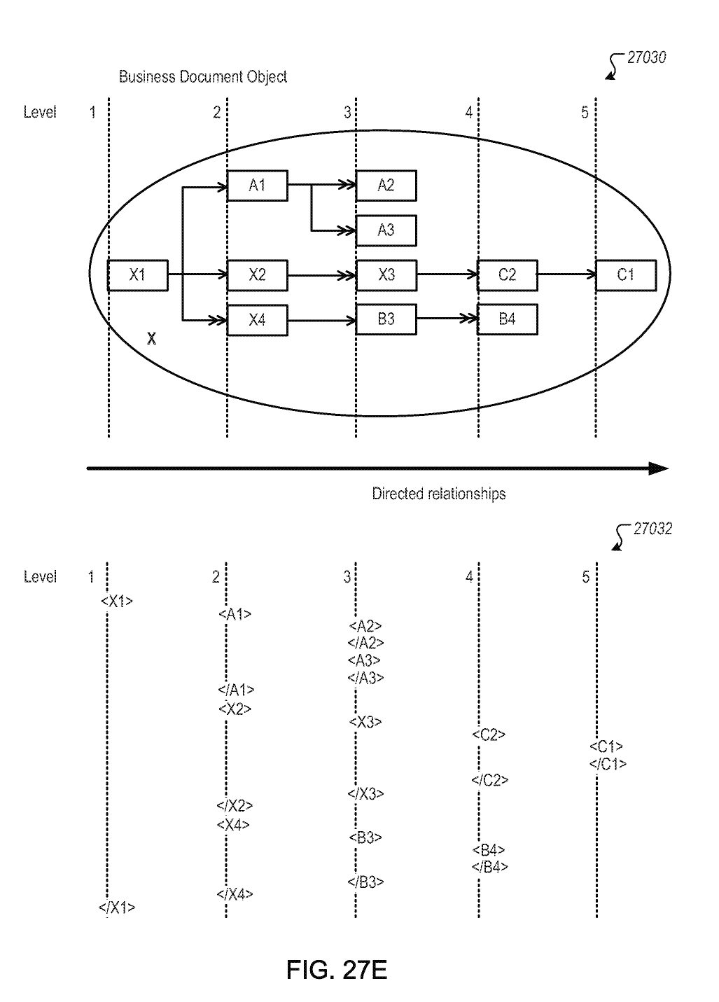

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

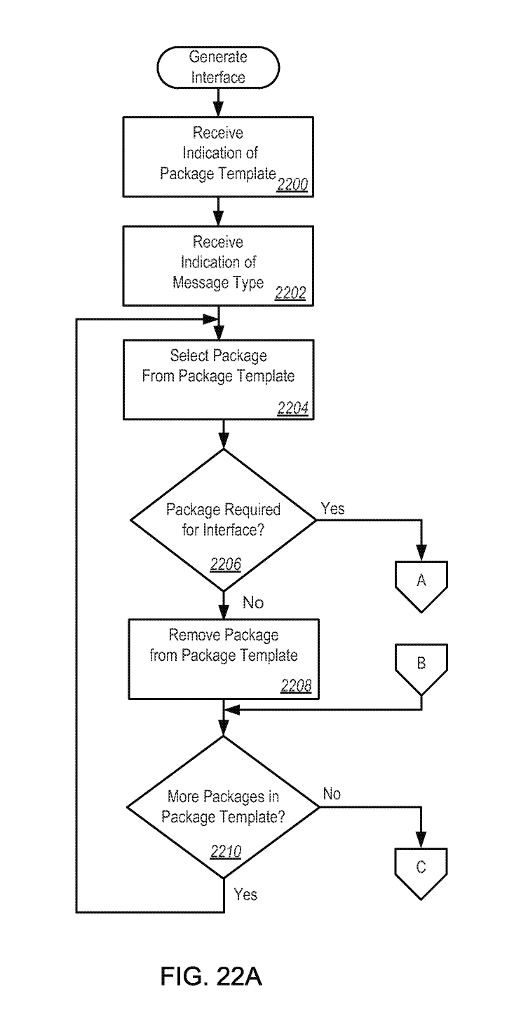

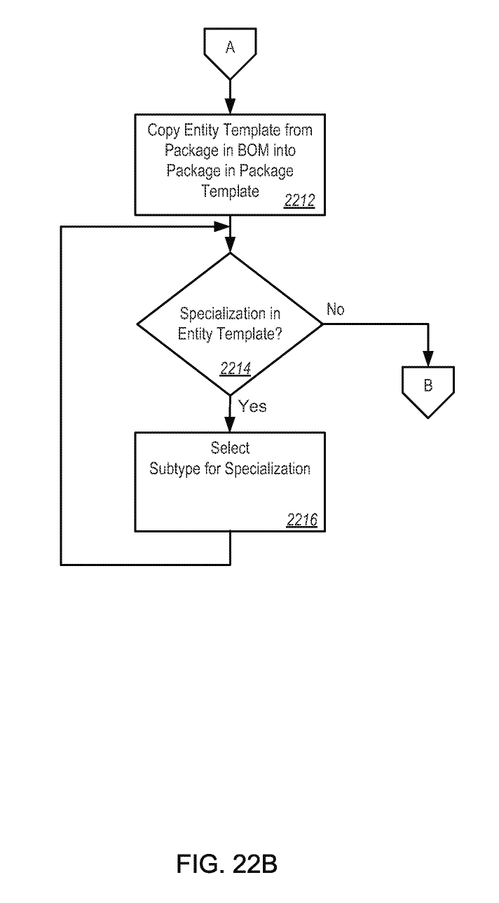

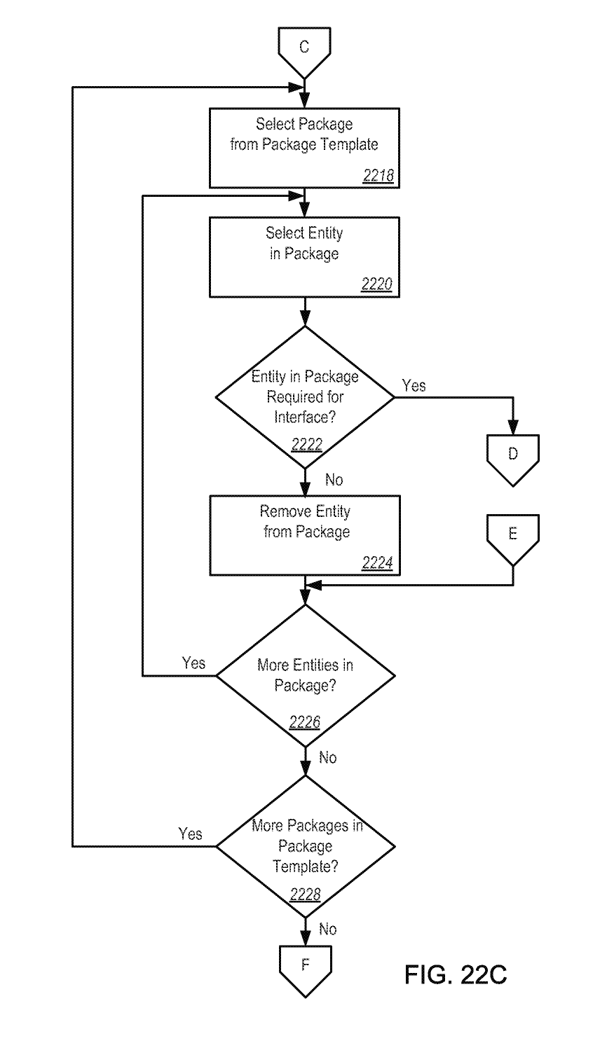

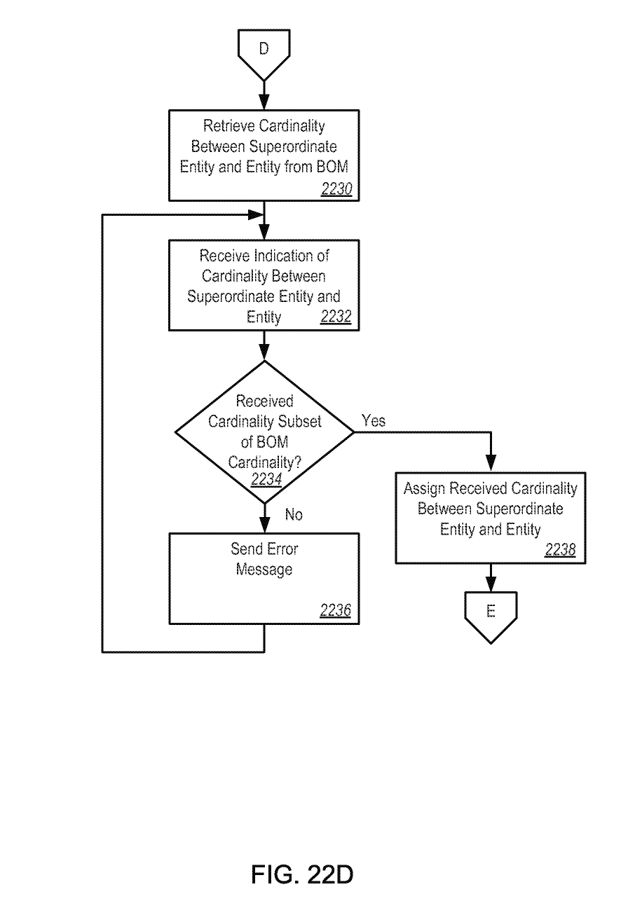

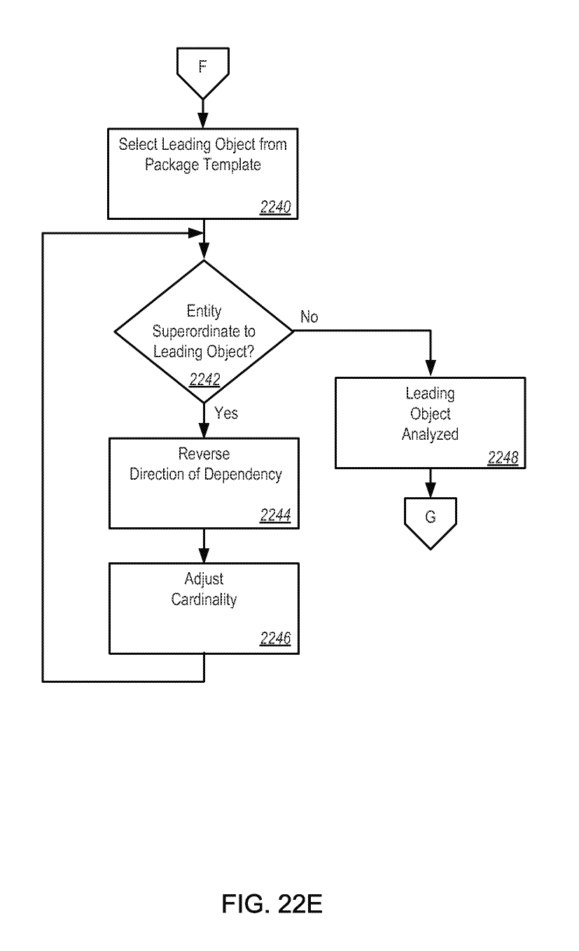

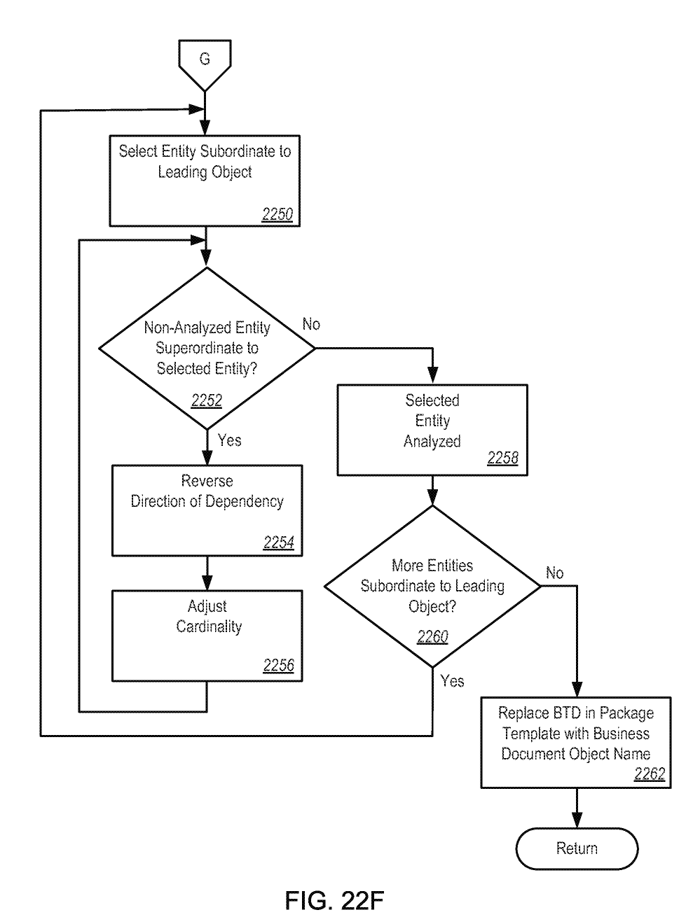

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

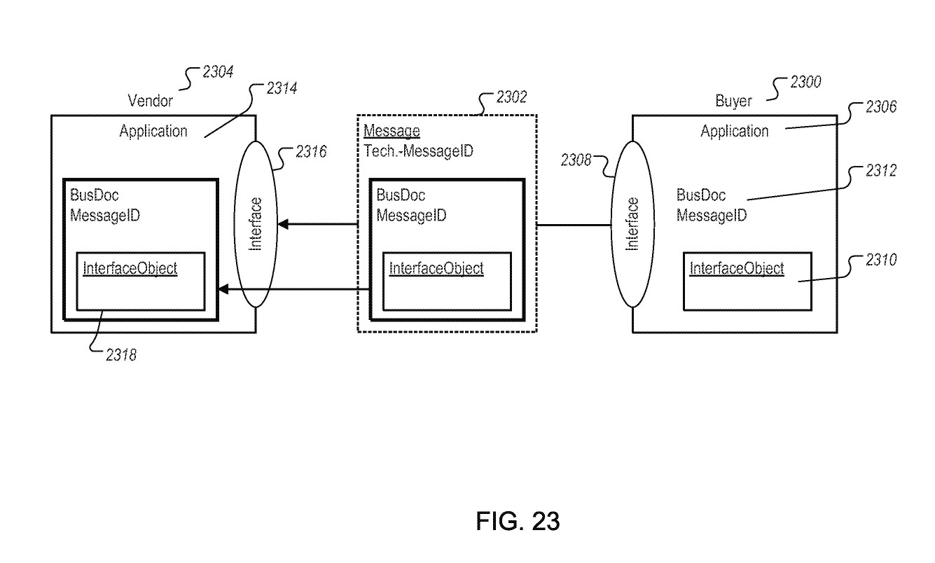

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

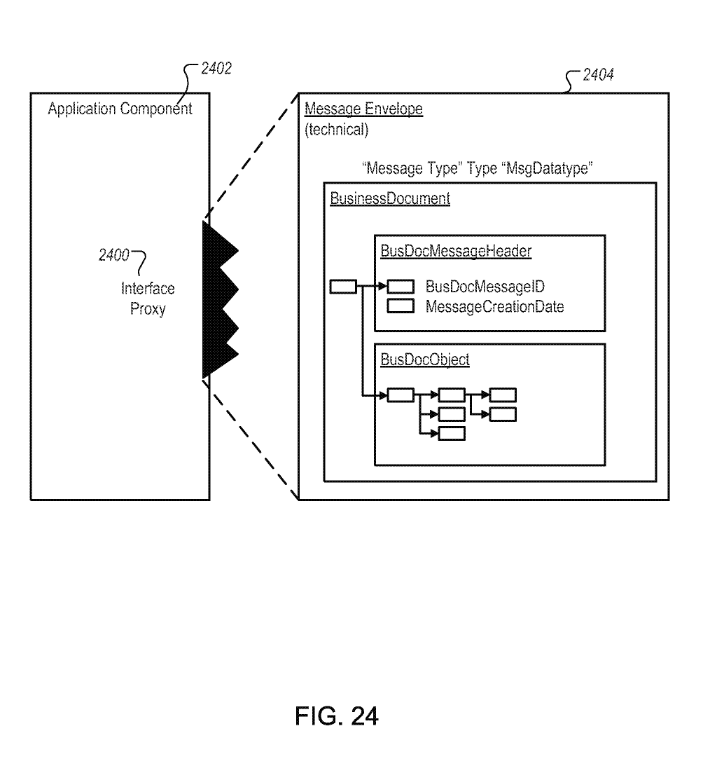

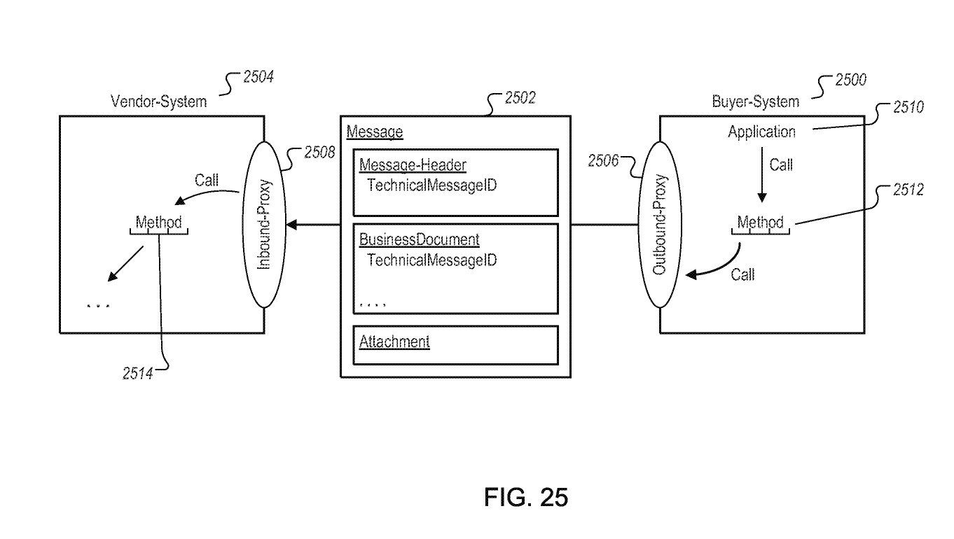

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

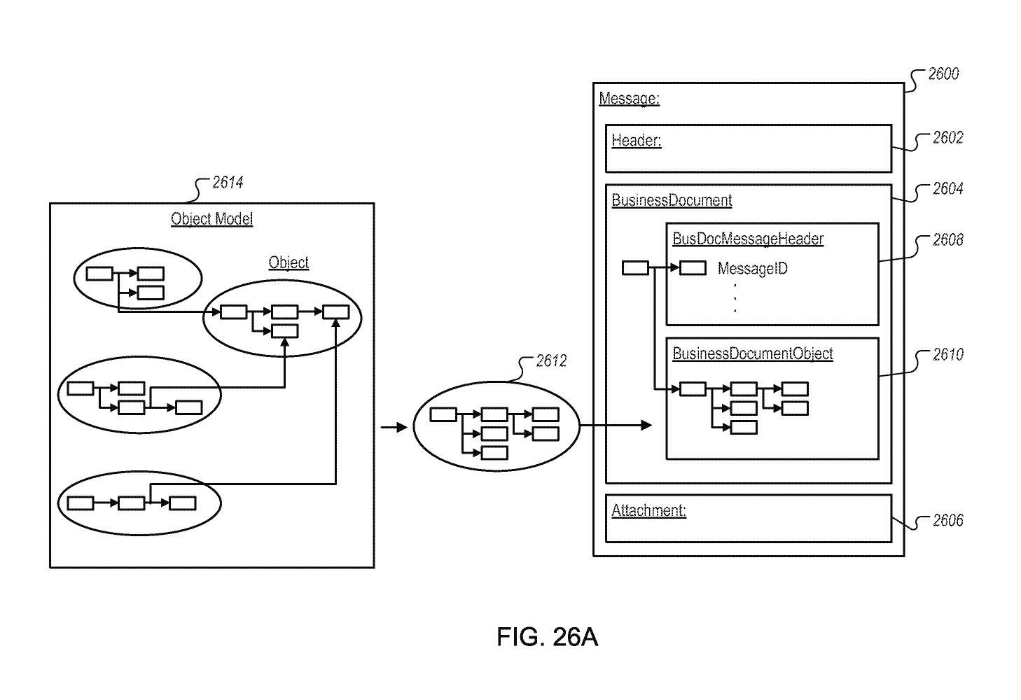

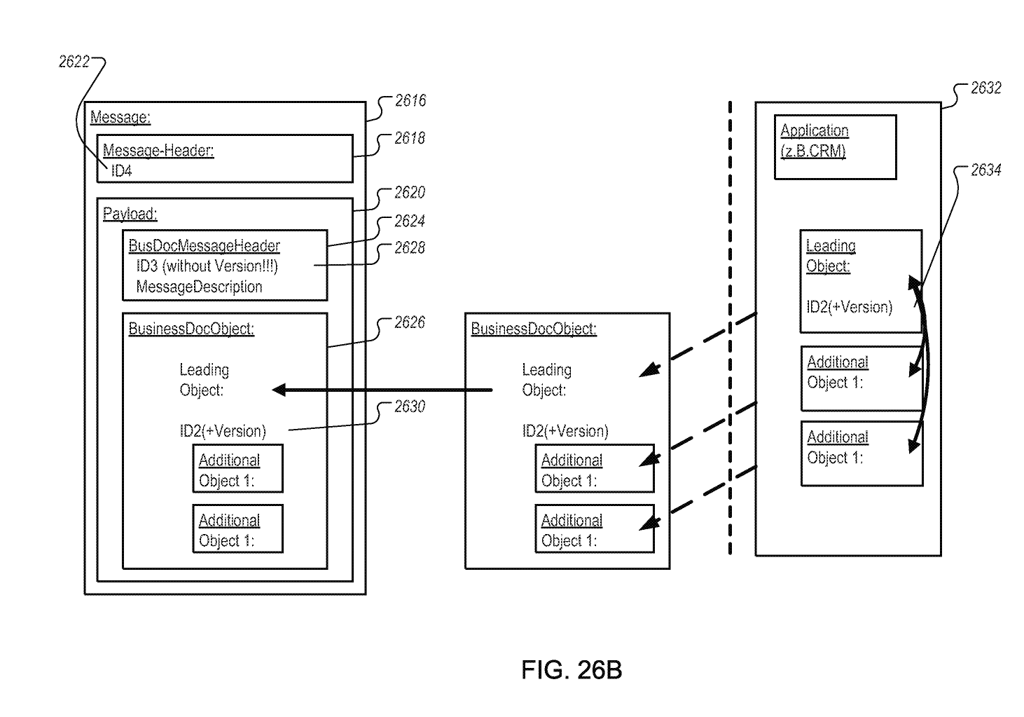

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

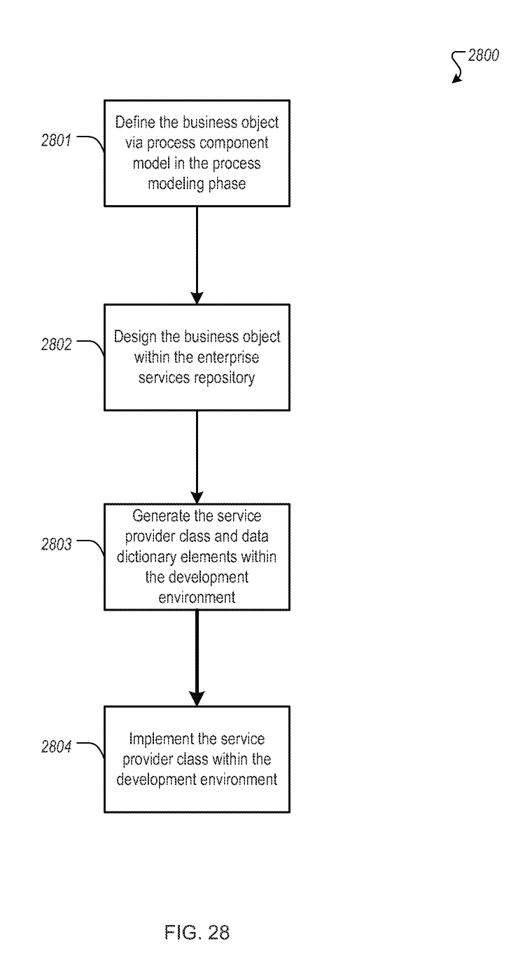

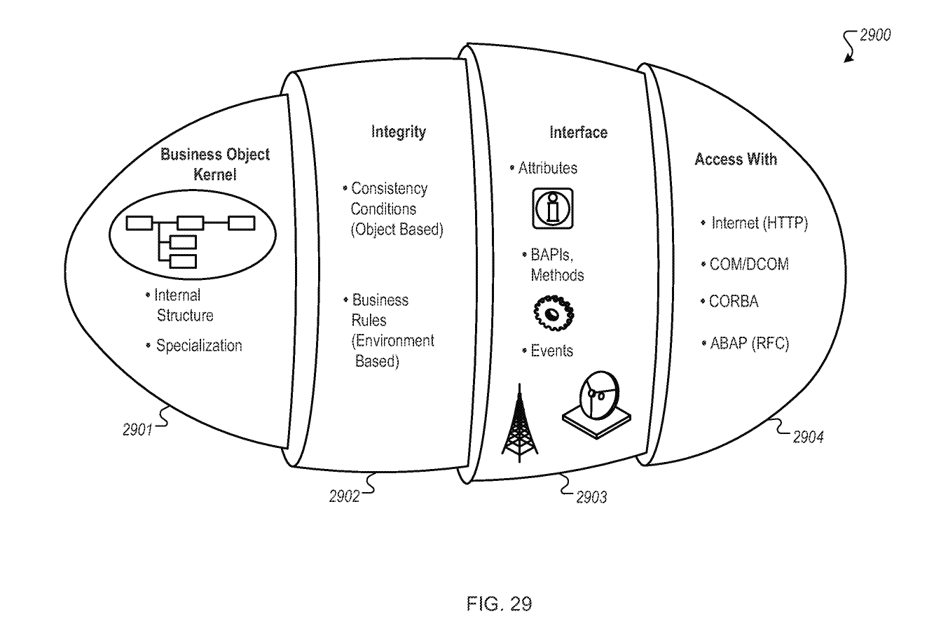

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

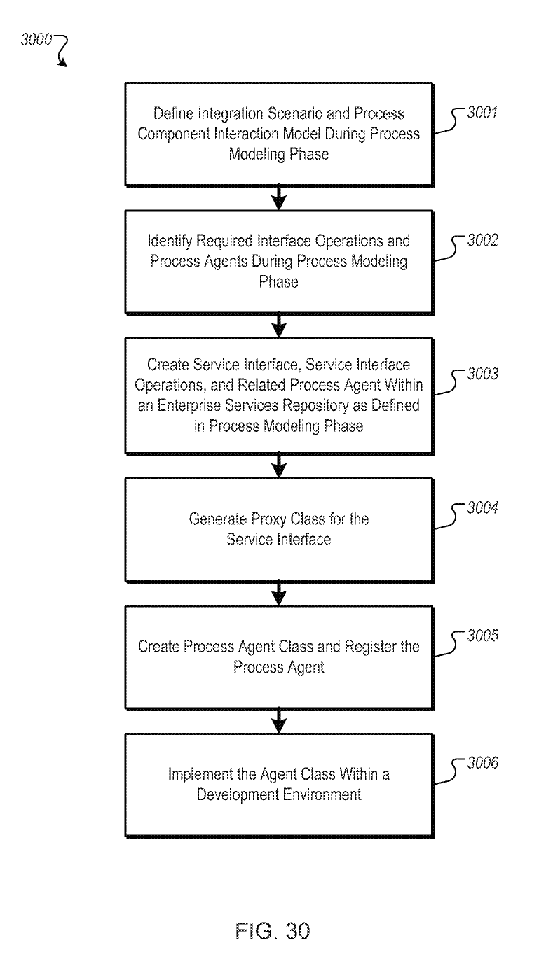

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

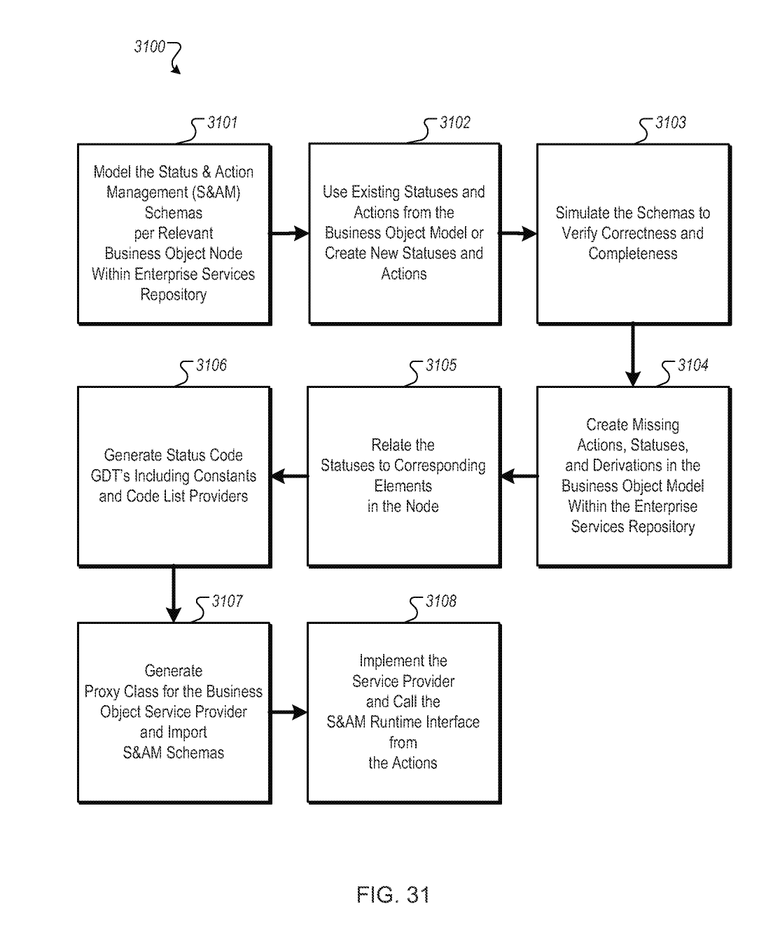

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

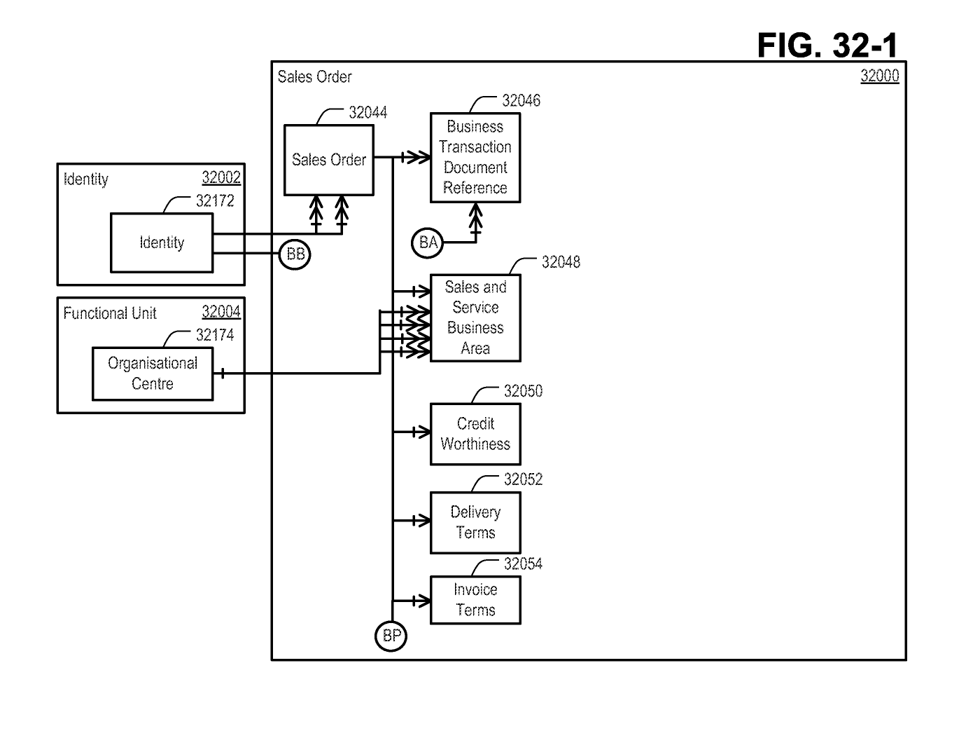

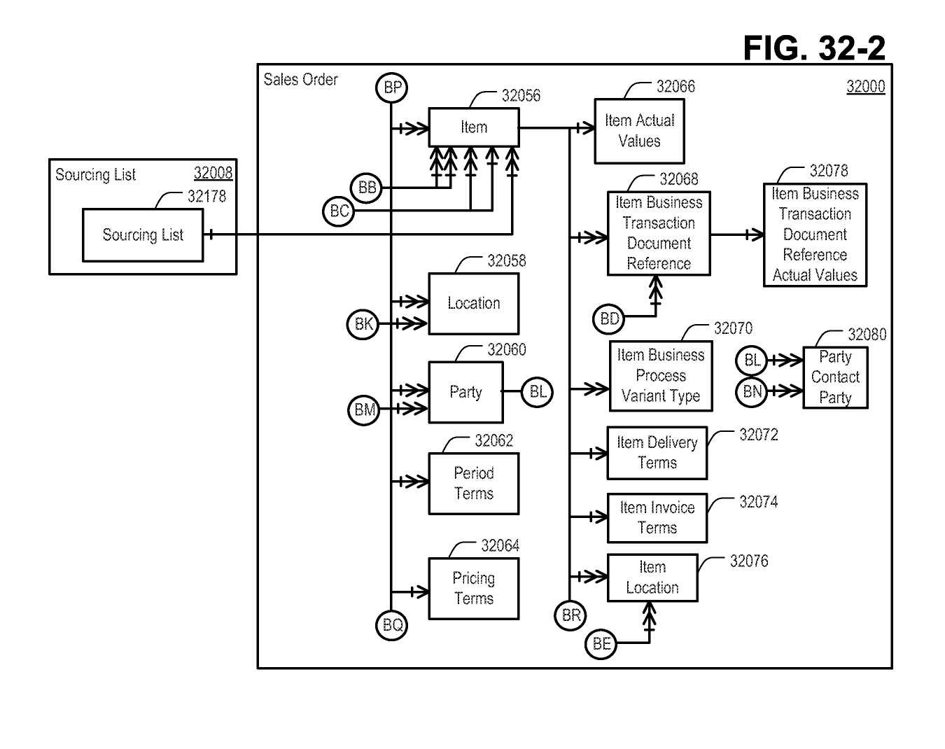

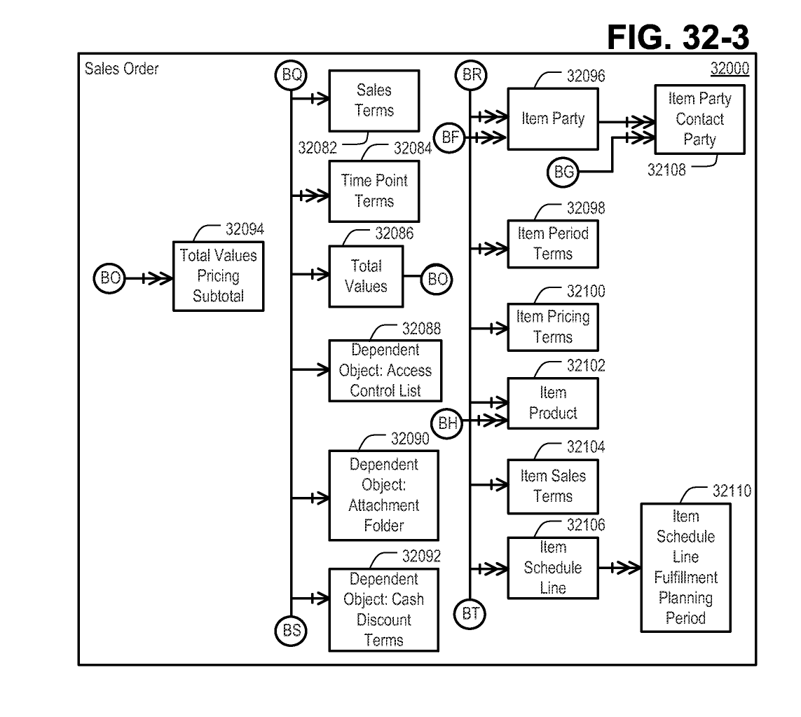

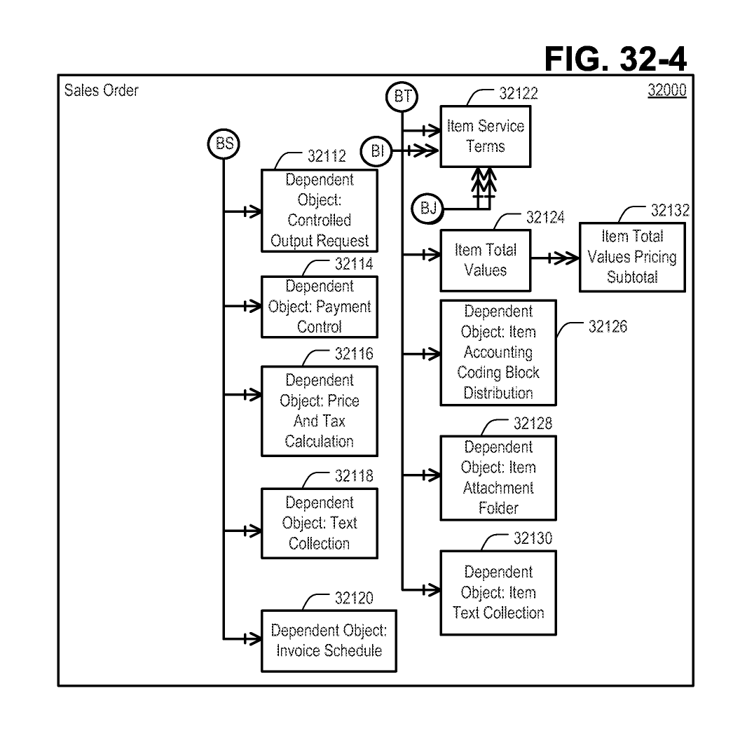

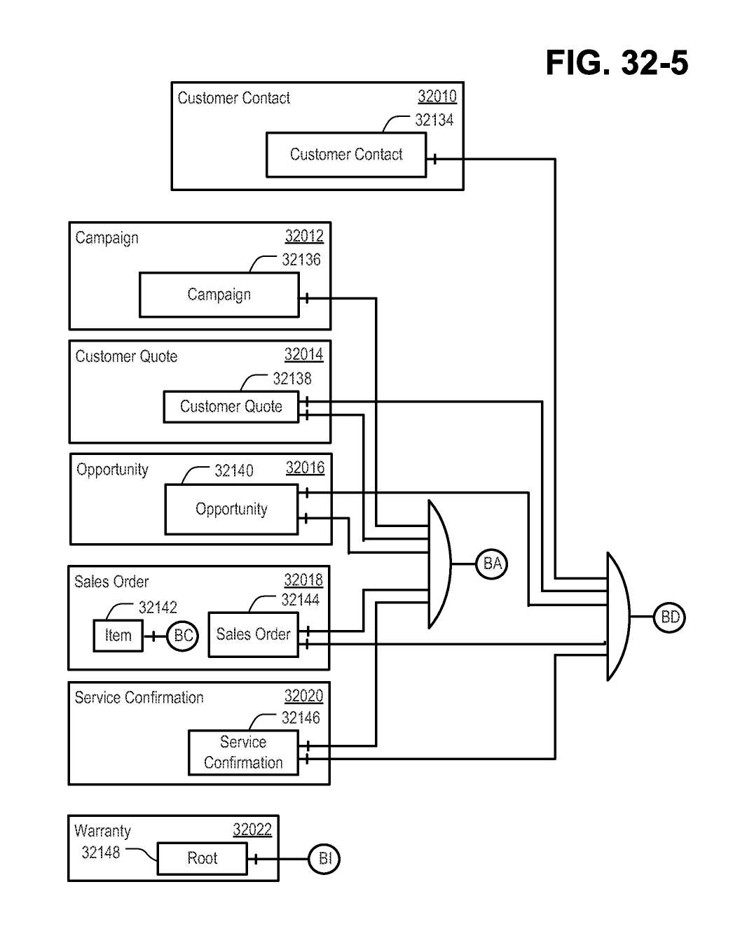

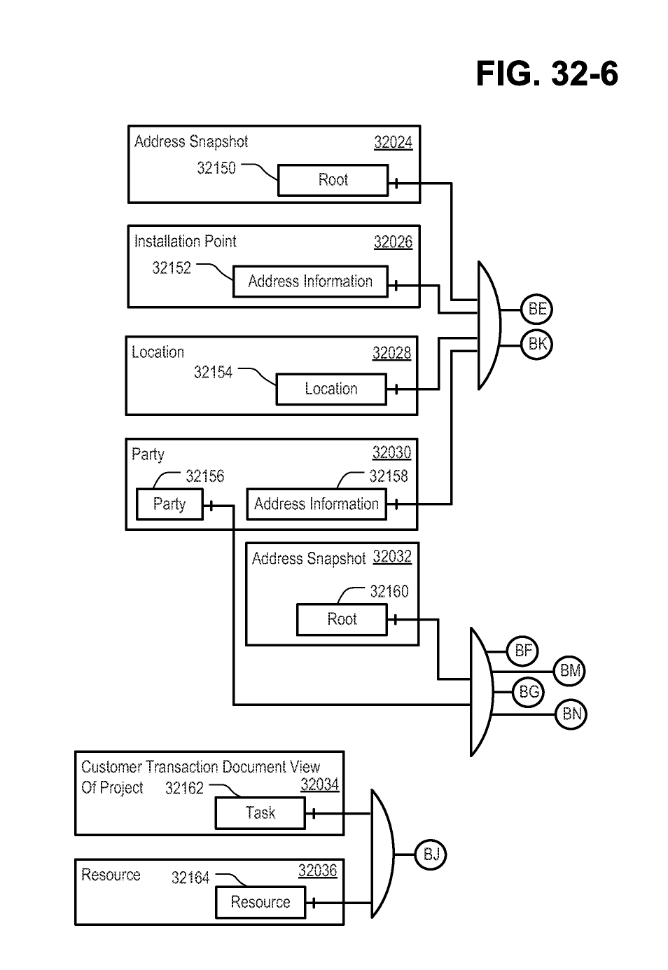

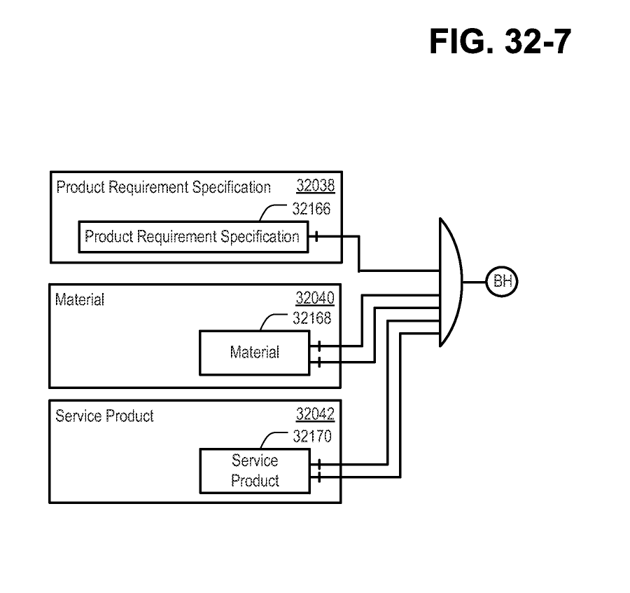

FIGS. 32-1 through 32-7 illustrate an example object model for a Sales Order business object 32000. Specifically, the object model depicts interactions among various components of the Sales Order business object 32000, as well as external components that interact with the Sales Order business object 32000 (shown here as 32002 through 32042 and 32134 through 32178). The Sales Order business object 32000 includes elements 32044 through 32132 that can be hierarchical, as depicted. For example, Sales Order entity 32044 hierarchically includes zero or more Business Transaction Document Reference entities 32046, zero or more Sales and Service Business Area entities 32048, and various other entities. Similarly, Item Party entity 32096 includes zero or more Item Party Contact Party entities 32018. Some or all of the entities 32044 through 32132 can correspond to packages and/or entities in the message data types described below.

The business object Sales Order is an agreement between a seller and a customer concerning a sale and delivery of goods, as well as any services that are associated with these processes, on a specific date, for a specific quantity, and for a specific price. The Sales Order business object belongs to the process component Sales Order Processing. The Sales Order business object belongs to the deployment unit Customer Relationship Management. The Sales Order business object is a projection of Customer Transaction Document Template. A SalesOrder can include: information that applies to an entire SalesOrder such as parties involved, one or more sales/delivery/invoicing-specific agreements, and status and references; SalesOrder items with item information and dependent data, such as product information, parties involved, sales/delivery/invoicing-specific agreements, and status and references; and Schedule lines for an item that specify when and in which quantity products are to be made available. The business object Sales Order has an object category of Business Transaction Document and a technical category of Standard Business Object.

The business object Sales Order includes various service interfaces. The business object Sales Order is involved in the following Process Component Interactions: Accounting Coding Block Distribution Processing_Sales Order Processing, Data Migration System_Sales Order Processing, External E-Commerce System_Sales Order Processing, External Sales Order Processing_Sales Order Processing, Intrastat Valuation_Sales Order Processing_Intrastat Information Requesting, Project Processing_Customer Relationship Auxiliaries Processing_Project and Customer Transaction Document Assignment, Purchase Order Processing at Customer_Sales Order Processing, Purchase Order Processing_Sales Order Processing, Customer and Partner Control Center Management at Provider_Sales Order Processing, Sales Order Processing Customer and Partner Control Center Management at Provider, Sales Order Processing_Accounting, Sales Order Processing_Customer Invoice Processing, Sales Order Processing_Customer Project Invoice Preparation, Sales Order Processing_Customer Requirement Processing, Sales Order Processing_Customer Requirement Processing_Availability Information, Sales Order Processing_Due Item Processing_Credit Usage, Sales Order Processing_Financial Accounting Master Data Management, Sales Order Processing_Form External Accounting, Sales Order Processing_IForm External Supply Chain Management, and Sales Order Processing_Project Processing_Customer Transaction Document and Project Assignment.

A service interface Credit Usage Out has a technical name of SalesOrderProcessingCreditUsageOut. The Service Interface Credit Usage Out is part of the following Process Component Interactions: Sales Order Processing_Due Item Processing_Credit Usage. The service interface Credit Usage Out is an interface to check creditworthiness. An operation Request Creditworthines has a technical name of SalesOrderProcessingCreditUsageOut.RequestCreditworthiness and can be used to check whether a current sales order is covered by a current credit limit of a customer. The operation Request Creditworthiness is based on a message type Credit Worthiness Query that is derived from the business object Sales Order. The operation Request Creditworthiness is based on a message type Credit Worthiness Response that is derived from the business object Sales Order.

A service interface Customer Transaction Document And Project Assignment Out has a technical name of SalesOrderProcessingCustomerTransactionDocumentAndProjectAssignmentOut. The service interface Customer Transaction Document And Project Assignment Out is part of the following Process Component Interactions: Sales Order Processing_Project Processing_Customer Transaction Document and Project Assignment. The service interface Customer Transaction Document And Project Assignment Out is an interface to request a creation of a customer project based on a sales order and to notify about a sales order, including project-based services or expenses and assignments of sales order items and project tasks. A Notify Of Sales Order And Assignment operation has a technical name of SalesOrderProcessingCustomerTransactionDocumentAndProjectAssignmentOut. NotifyOfSalesOrderAndAssignment and can be used to notify about a sales order, including project-based services or expenses and assignments of sales order items and project tasks. The Notify Of Sales Order And Assignment operation is based on message type CustomerTransactionDocumentAndProjectAssignmentNotification that is derived from business object Customer Transaction Document Template.

A Request Project Creation operation has a technical name of SalesOrderProcessingCustomerTransactionDocumentAndProjectAssignmentOut.RequestProjectCreation and can be used to request a creation of a customer project based on a sales order. The Request Project Creation operation is based on a message type Sales Order Project Create Confirmation_Sync that is derived from the business object Project. The Request Project Creation operation is based on a message type Sales Order Project Create Request_Sync that is derived from business object Sales Order.

A Request Project Creation Process Cancellation operation has a technical name of SalesOrderProcessingCustomerTransactionDocumentAndProjectAssignmentOut.RequestProjectCreationProcessCancellation and can be used to request to delete a customer project that was created based on a sales order. The operation Request Project Creation Process Cancellation is based on message type Sales Order Project Creation Process Cancel Request that is derived from the business object Sales Order.

A service interface Fulfillment In has a technical name of SalesOrderProcessingFulfillmentIn. The service interface Fulfillment In is part of the following Process Component Interactions: Sales Order Processing_Customer Requirement Processing and Sales Order Processing_IForm External Supply Chain Management. The interface Fulfillment In can be used to update a sales order with information about availability, reservations, and fulfillment execution. A Change Sales Order based on Product Availability Update and Product Customer Requirement Fulfillment Confirmation operation has a technical name of SalesOrderProcessingFulfillmentIn.ChangeSalesOrderBasedOnProductAvailabilityUpdateAndProductCustomerRequirementFulfillmentConfirmation and may be used to update the sales order with availability and reservation information based on changes in fulfillment planning as well as to update the sales order with information from fulfillment confirmation. The Change Sales Order based on Product Availability Update and Product Customer Requirement Fulfillment Confirmation operation is based on the message type Product Available To Promise Update Notification And Fulfillment Confirmation that is derived from the business object Customer Requirement.

A service interface Fulfillment Out has a technical name of SalesOrderProcessingFulfillmentOut. The service interface Fulfillment Out is part of the following Process Component Interactions: Sales Order Processing_Customer Requirement Processing, Sales Order Processing_Customer Requirement Processing_Availability Information, and Sales Order Processing_IForm External Supply Chain Management. The service interface Fulfillment Out can be used to request availability information and reservation, fulfillment planning and fulfillment execution for sales orders.

A Register Product Customer Requirement Deletion Notification has a technical name of SalesOrderProcessingFulfillmentOut.RegisterProductCustomerRequirementDeletionNotificat ion and can be used to register a provisional requirement reservation for deletion and trigger deletion in case of failure or cancellation. The Register Product Customer Requirement Deletion Notification operation is based on message type Provisional Customer Requirement Delete Notification that is derived from the business object Customer Requirement.

A Request Product Availability Information operation has a technical name of SalesOrderProcessingFulfillmentOut.RequestProductAvailabilityInformation and can be used to request product availability information for sales order items. The Request Product Availability Information operation is based on message type Product Availability Query that is derived from the business object Customer Requirement and is based on message type Product Availability Response that is derived from the business object Customer Requirement.

A Request Product Availability Information and Provisional Reservation operation has a technical name of SalesOrderProcessingFulfillmentOut.RequestProductAvailabilityInformationAndProvisional Reservation and can be used to request product availability information including the creation of a provisional reservation for a customer requirement. The Request Product Availability Information and Provisional Reservation operation is based on message type Product Available To Promise Check Confirmation that is derived from the business object Customer Requirement and is based on message type Product Available To Promise Check Request that is derived from the business object Customer Requirement.

A Request Product Customer Requirement Reservation and Fulfillment operation has a technical name of SalesOrderProcessingFulfillmentOut.RequestProductCustomerRequirementReservationAndFulfillment and can be used to request a reservation and fulfillment of a customer requirement. The Request Product Customer Requirement Reservation and Fulfillment operation is based on message type Customer Requirement Fulfillment Request that is derived from the business object Customer Requirement.

A service interface Manage Sales Order In has a technical name of ManageSalesOrderIn. The service interface Manage Sales Order In is part of the following Process Component Interactions: External E-Commerce System_Sales Order Processing and External Sales Order Processing_Sales Order Processing. The service interface Manage Sales Order In is an interface to replicate or create sales orders from a source system or file to a target system. A Manage Sales Order In Check Maintain as Bundle operation has a technical name of ManageSalesOrderIn.CheckMaintainBundle and can be used to check whether one or more sales order can be maintained using imported structured data. The Manage Sales Order In Check Maintain as Bundle operation is based on message type Sales Order Request Bundle Check Maintain Query_sync that is derived from the business object Sales Order and is based on message type Sales Order Request Bundle Check Maintain Response_sync that is derived from the business object Sales Order. A Manage Sales Order In Create operation has a technical name of ManageSalesOrderIn.Create and can be used to create a sales order by using imported structured data. The Manage Sales Order In Create operation is based on message type SalesOrderCreateConfirmation_sync and is based on message type SalesOrderCreateRequest_sync.

A Manage Sales Order In Maintain as Bundle operation has a technical name of ManageSalesOrderIn.MaintainBundle and can be used to maintain one or more sales orders using imported structured data. The Manage Sales Order In Maintain as Bundle operation is based on message type Sales Order Bundle Maintain Confirmation_sync that is derived from the business object Sales Order and is based on message type Sales Order Bundle Maintain Request_sync that is derived from the business object Sales Order.

A Manage Sales Order In Read operation has a technical name of ManageSalesOrderIn.Read and can be used to read the business object Sales Order data. The Manage Sales Order In Read operation is based on message type SalesOrderByIDQuery_sync and on message type SalesOrderByIDResponse_sync.

A Manage Sales Order In Update operation has a technical name of ManageSalesOrderIn.Update and can be used to update the business object Sales Order with data imported via an interface. The Manage Sales Order In Update operation is based on message type SalesOrderUpdateConfirmation_sync and on message type SalesOrderUpdateRequest_sync.

A service interface Migration In has a technical name of SalesOrderProcessingMigrationIn. The service interface Migration In is part of the following Process Component Interactions: Data Migration System_Sales Order Processing. The service interface Migration In is an interface to migrate sales orders. A Create Sales Order operation has a technical name of SalesOrderProcessingMigrationIn.CreateSalesOrder and can be used to create a sales order based on migrated data. The Create Sales Order operation is based on message type Sales Order Migrate Request that is derived from the business object Sales Order.

A service interface Ordering In has a technical name of SalesOrderProcessingOrderingIn. The service interface Ordering In is part of the following Process Component Interactions: Purchase Order Processing at Customer_Sales Order Processing and Purchase Order Processing_Sales Order Processing. The service interface Ordering In can be used to create, change, or cancel a sales order based on requests from a customer.

A Cancel Sales Order operation has a technical name of SalesOrderProcessingOrderingIn.CancelSalesOrder and can be used to cancel a sales order based on a cancellation of a purchase order from a customer. The Cancel Sales Order operation is based on message type Purchase Order Cancellation Request that is derived from the business object Purchase Order.

A Change Sales Order operation has a technical name of SalesOrderProcessingOrderingIn.ChangeSalesOrder and can be used to update a sales order based on changes from a purchase order. The Change Sales Order operation is based on message type Purchase Order Change Request that is derived from the business object Purchase Order.

A Create Sales Order has a technical name of SalesOrderProcessingOrderingIn.CreateSalesOrder and can be used to create a sales order based on a purchase order. The Create Sales Order operation is based on message type Purchase Order Request that is derived from the business object Purchase Order.

The service interface Ordering Out has a technical name of SalesOrderProcessingOrderingOut. The service interface Ordering Out is part of the following Process Component Interactions: Purchase Order Processing at Customer_Sales Order Processing and Purchase Order Processing_Sales Order Processing. The service interface Ordering Out can be used to inform a customer about sales orders.

A Confirm Sales Order operation has a technical name of SalesOrderProcessingOrderingOut.ConfirmSalesOrder and can be used to confirm a creation, change or cancellation of a sales order to a customer. The Confirm Sales Order operation is based on message type Purchase Order Confirmation that is derived from the business object Purchase Order Confirmation.

A service interface Product and Resource Valuation Out operation has a technical name of SalesOrderProcessingProductAndResourceValuationOut. The service interface Product and Resource Valuation Out is part of the following Process Component Interactions: Sales Order Processing_Financial Accounting Master Data Management. The service interface Product and Resource Valuation Out can be used to request product valuation data.

A Request Product Valuation operation has a technical name of SalesOrderProcessingProductAndResourceValuationOut.RequestProductValuation and can be used to request a product valuation. The Request Product Valuation operation is based on message type Product and Resource Valuation Query and on message type Product and Resource Valuation Response.

A service interface Project and Customer Transaction Document Assignment Notification In has a technical name of CustomerRelationshipAuxiliariesProcessingProjectAndCustomerTransactionDocumentAssignmentNotificationIn. The service interface Project and Customer Transaction Document Assignment Notification In is part of the following Process Component Interactions: Project Processing_Customer Relationship Auxiliaries and Processing_Project and Customer Transaction Document Assignment. The service interface Project and Customer Transaction Document Assignment Notification In is an interface to notify about a customer project and assignments of project tasks to customer transaction document items.

A Maintain Customer Transaction Document View of Project and Assignment operation has a technical name of CustomerRelationshipAuxiliariesProcessingProjectAndCustomerTransactionDocumentAssignmentNotificationIn.MaintainCustomerTransactionDocumentViewOfProjectAndAssignment. The Maintain Customer Transaction Document View of Project and Assignment operation is based on message type Project and Customer Transaction Document Assignment Notification that is derived from the business object Project.

A service interface Query Sales Order In has a technical name of QuerySalesOrderIn. The service interface Query Sales Order In is part of the following Process Component Interactions: External E-Commerce System_Sales Order Processing and External Sales Order Processing_Sales Order Processing. The service interface Query Sales Order In is an interface to query sales order data.

A Find By Elements operation has a technical name of QuerySalesOrderIn.FindByElements and can be used to query sales order data by elements. The Find By Elements operation is based on message type Sales Order By Elements Query_sync that is derived from the business object Sales Order and on message type Sales Order By Elements Response_sync that is derived from the business object Sales Order.

A service interface Request Customer Project Invoicing In has a technical name of SalesOrderProcessingRequestCustomerProjectInvoicingIn. The service interface Request Customer Project Invoicing In is part of the following Process Component Interactions: Sales Order Processing_Customer Project Invoice Preparation. The service interface is an interface to change a sales order based on a customer project invoicing agreement.

A Change Sales Order based on Customer Project Invoicing Agreement operation has a technical name of SalesOrderProcessingRequestCustomerProjectInvoicingIn.ChangeSalesOrderBasedOnCustomerProjectlnvoicingAgreement and can be used to update a sales order from a customer project invoicing agreement. The Change Sales Order based on Customer Project Invoicing Agreement operation is based on message type Customer Project Invoicing Agreement Maintain Confirmation that is derived from the business object Customer Project Invoicing Agreement.

A service interface Request Customer Project Invoicing Out has a technical name of SalesOrderProcessingRequestCustomerProjectInvoicingOut. The service interface Request Customer Project Invoicing Out is part of the following Process Component Interactions: Sales Order Processing_Customer Project Invoice Preparation. The service interface Request Customer Project Invoicing Out is an interface to request customer project invoicing.

A Request Customer Project Invoicing operation has a technical name of SalesOrderProcessingRequestCustomerProjectInvoicingOut.RequestCustomerProjectInvoicing and can be used to request invoicing for a customer project. The Request Customer Project Invoicing operation is based on message type Customer Project Invoicing Agreement Maintain Request that is derived from the business object Customer Project Invoicing Agreement.

A service interface Request Invoicing In has a technical name of SalesOrderProcessingRequestInvoicingIn. The Service Interface Request Invoicing In is part of the following Process Component Interactions: Sales Order Processing_Customer Invoice Processing. The service interface Request Invoicing In is an interface to update a sales order with information from invoicing.

A Change Sales Order based on Customer Invoice operation has a technical name of SalesOrderProcessingRequestInvoicingIn.ChangeSalesOrderBasedOnCustomerInvoice and can be used to update a sales order based on changes from a customer invoice. The Change Sales Order based on Customer Invoice operation is based on message type Customer Invoice Issued Confirmation that is derived from the business object Customer Invoice.

A service interface Request Invoicing Out has a technical name of SalesOrderProcessingRequestInvoicingOut. The service interface Request Invoicing Out is part of the following Process Component Interactions: Sales Order Processing_Customer Invoice Processing. The service interface Request Invoicing Out is an interface to request invoicing.

A Request Invoicing operation has a technical name of SalesOrderProcessingRequestInvoicingOut.RequestInvoicing and can be used to request invoicing of a sales order, and point in time and dependence on other invoicing information, such as delivery, which can be decided by an invoicing process. The Request Invoicing operation is based on message type Customer Invoice Request Request that is derived from the business object Customer Invoice Request.

A service interface Request Store Sales Order Status Change In has a technical name of RequestStoreSalesOrderStatusChangeIn. The Service Interface Request Store Sales Order Status Change In is part of the following Process Component Interactions: Customer and Partner Control Center Management at Provider_Sales Order Processing. The service interface Request Store Sales Order Status Change In is an interface to change Store sales order status based on status changes in a Customer and Partner control center.

A Change Sales Order Status operation has a technical name of RequestStoreSalesOrderStatusChangeIn.ChangeSalesOrderStatus and can be used to request Store sales order status change based on status changes in Customer and Partner control center. The Change Sales Order Status operation is based on message type Store Sales Order Status Change Request that is derived from the business object Sales Order.

A service interface StoreSalesOrderNotificationOut has a technical name of StoreSalesOrderNotificationOut. The service interface StoreSalesOrderNotificationOut is part of the following Process Component Interactions: Sales Order Processing Customer and Partner Control Center Management at Provider. The service interface StoreSalesOrderNotificationOut is an interface to notify a customer about Store sales orders.

A NotifyOfSalesOrder operation has a technical name of StoreSalesOrderNotificationOut.NotifyOfSalesOrder and can be used to notify sales order details to a control center. The NotifyOfSalesOrder operation is based on message type StoreSalesOrderNotification that is derived from the business object Sales Order.

A service interface Sales And Purchasing Accounting Out has a technical name of SalesOrderProcessingSalesAndPurchasingAccountingOut. The service interface Sales And Purchasing Accounting Out is part of the following Process Component Interactions: Sales Order Processing_Accounting and Sales Order Processing_Form External Accounting. The service interface Sales And Purchasing Accounting Out is an interface to inform accounting when a sales order is created, updated, or changed. When a sales order also includes a service provision, accounting is notified when the service provision is created or cancelled.

A Notify of Sales Order operation has a technical name of SalesOrderProcessingSalesAndPurchasingAccountingOut.NotifyOfSalesOrder and can be used to inform accounting when a sales order is created, updated, or changed. When a sales order also includes a service provision, accounting is notified when the service provision is created or cancelled. The Notify of Sales Order operation is based on message type Sales And Purchasing Accounting Notification that is derived from the business object Accounting Notification.

A service interface Sales Order Accountability In has a technical name of SalesOrderProcessingSalesOrderAccountabilityIn. The service interface Sales Order Accountability In is part of the following Process Component Interactions: Accounting Coding Block Distribution Processing_Sales Order Processing. The service interface Sales Order Accountability In has an interface to provide information about whether expenses or resources can be assigned to sales orders in accounting.

A Check Sales Order Accountability operation has a technical name of SalesOrderProcessingSalesOrderAccountabilityIn.CheckSalesOrderAccountability and can be used to check sales orders for existence and availability for expense or resource assignment in Financial Accounting. The Check Sales Order Accountability operation is based on message type Accounting Object Check Confirmation that is derived from the business object Accounting Coding Block Distribution and on message type Accounting Object Check Request that is derived from the business object Accounting Coding Block Distribution.

A service interface Sales Order Action In has a technical name of SalesOrderActionIn. The service interface Sales Order Action In is part of the following Process Component Interactions: External E-Commerce System_Sales Order Processing.

A Sales Order Action In Finish Fulfilment Processing Item operation has a technical name of SalesOrderActionIn.FinishFulfilmentProcessingItem and is an interface to set a fulfillment status for an item of a sales order to ‘Finished’. The Sales Order Action In Finish Fulfilment Processing Item operation is based on message type SalesOrderFinishFulfilmentProcessingItemConfirmation_sync and on message type SalesOrderFinishFulfilmentProcessingItemRequest_sync.

A Sales Order Action In Finish Fulfilment Processing Of All Items operation has a technical name of SalesOrderActionIn.FinishFulfilmentProcessingOfAllItems and is an interface to set a fulfillment status for all items of a sales order to ‘Finished’. The Sales Order Action In Finish Fulfilment Processing Of All Items operation is based on message type SalesOrderFinishFulfilmentProcessingOfAllItemsConfirmation_sync. The Sales Order Action In Finish Fulfilment Processing Of All Items operation is based on message type SalesOrderFinishFulfilmentProcessingOfAllItemsRequest_sync.

A Sales Order Action In Release All Items To Execution operation has a technical name of SalesOrderActionIn.ReleaseAllItemsToExecution and is an interface to release all items of a sales order for execution. The Sales Order Action In Release All Items To Execution operation is based on message type SalesOrderReleaseAllItemsToExecutionConfirmation_sync and on message type SalesOrderReleaseAllItemsToExecutionRequest_sync.

A Sales Order Action In Release Customer Request operation has a technical name of SalesOrderActionIn.ReleaseCustomerRequest. The Sales Order Action In Release Customer Request operation is based on message type SalesOrderReleaseCustomerRequestConfirmation_sync and on message type SalesOrderReleaseCustomerRequestRequest_sync.

A Sales Order Action In Release To Execute Item operation has a technical name of SalesOrderActionIn.ReleaseToExecuteItem and is an interface to release an item of a sales order for execution. The Sales Order Action In Release To Execute Item operation is based on message type SalesOrderReleaseToExecuteItemConfirmation_sync and on SalesOrderReleaseToExecuteItemRequest_sync.

A service interface Sales Order Intrastat Information Requesting In has a technical name of SalesOrderProcessingSalesOrderIntrastatInformationRequestingIn. The service interface Sales Order Intrastat Information Requesting In is part of the following Process Component Interactions: Intrastat Valuation_Sales Order Processing_Intrastat Information Requesting. The service interface Sales Order Intrastat Information Requesting In is an interface to provide sales order information for intrastat purposes.

A Provide operation has a technical name of SalesOrderProcessingSalesOrderIntrastatInformationRequestingIn.Provide and can be used to provide intrastat relevant information about a sales order. The Provide operation is based on message type Sales Order Intrastat By ID Query_sync that is derived from the business object Sales Order and on message type Sales Order Intrastat By ID Response_sync that is derived from the business object Sales Order.

A Sales Order Root Node represents a document for customer specific business transactions, including data related to delivery of goods, provision of services, prices, and preparation of invoicing. The Root Node can be time dependent on Time Point.

The elements located directly at the node Sales Order are defined by the data type CustomerTransactionDocumentElements. These elements include: ID, BuyerID, TypeCode, ProcessingTypeCode, DateTime, Name, BuyerDateTime, BuyerName, DataOriginTypeCode, SystemAdministrativeData, UUID, FulfillmentBlockingReasonCode, MigratedDataAdaptationTypeCode, ServiceConfirmationCreationCode, and Status.

ID may be an alternative key, is a unique identifier assigned by a seller for a Customer Transaction Document, and may be based on datatype GDT: BusinessTransactionDocumentID. BuyerID is a unique identifier for a Customer Transaction Document assigned by a buyer, and may be based on datatype GDT: BusinessTransactionDocumentID. TypeCode may be optional, is an encoded representation of a type of Customer Transaction Document, may be based on datatype GDT: BusinessTransactionDocumentTypeCode, may be set internally, includes a fixed value CustomerTransactionDocumentTemplate, and may be used to display a type, such as in cross-business object lists. ProcessingTypeCode is an encoded representation of Customer Transaction Document processing in a process component, may be based on datatype GDT: BusinessTransactionDocumentProcessingTypeCode, and can include standard orders, for example. DateTime may be optional, is a creation date time of a Customer Transaction Document, from a business perspective, and may be based on datatype GDT: GLOBAL_DateTime. Name is a name of a Customer Transaction Document, and may be based on datatype GDT: EXTENDED_Name. BuyerDateTime may be optional, is a date/time assigned by a buyer for a Customer Transaction Document, and may be based on datatype GDT: GLOBAL_DateTime, with a qualifier of Buyer. BuyerName is a short-text description for a Customer Transaction Document assigned by a buyer and may be based on datatype GDT: MEDIUM_Name. DataOriginTypeCode is a type of a source of a Customer Transaction Document, and may be based on datatype GDT: CustomerTransactionDocumentDataOriginTypeCode. SystemAdministrativeData includes administrative data stored in a system, such as system users and change dates/times, and may be based on datatype GDT: SystemAdministrativeData. UUID may be an alternative key, is a universally unique Customer Transaction Document identifier, may be assigned internally, and may be based on datatype GDT: UUID. FulfillmentBlockingReasonCode may be optional, specifies why a Customer Transaction Document document is blocked for delivery of goods or provision of services, and may be based on datatype GDT: CustomerTransactionDocumentFulfilmentBlockingReasonCode. MigratedDataAdaptationTypeCode may be optional, is a coded representation of a type of data adaptation performed during migration of a customer transaction document, and may be based on datatype GDT: MigratedDataAdaptationTypeCode. In some implementations, when migrating data from a source system to a target system, this data may be adapted. For example, a business object or business document may be completely or partially taken over. In some implementations, a MigratedDataAdaptationTypeCode is used when a CustomerTransactionDocument is migrated. ServiceConfirmationCreationCode indicates whether it is possible to create a service confirmation based on the content of a customer transaction document, and may be based on datatype GDT: CustomerTransactionDocumentServiceConfirmationCreationCode. Status may be optional, can represent CustomerTransactionDocumentStatus, can describe some or all statuses of a Customer Transaction Document, and may be based on datatype BOIDT: CustomerTransactionDocumentStatus. Status can include Status/PaymentAuthorisationStatusCode, Status/ItemListCancellationStatusCode, Status/ItemListCustomerOrderLifeCycleStatusCode, Status/ItemListFulfilmentProcessingStatusCode, Status/ItemListPlanningReleaseStatusCode, Status/ItemListExecutionReleaseStatusCode, Status/ConfirmationIssuingStatusCode, Status/ItemListInvoiceProcessingStatusCode, Status/ApprovalStatusCode, Status/ItemListProductAvailabilityConfirmationStatusCode, Status/ConsistencyStatusCode, Status/GeneralDataCompletenessStatusCode, Status/CancellationStatusCode, Status/InvoicingBlockingStatusCode, Status/FulfilmentBlockingStatusCode, Status/CustomerRequestReleaseStatusCode, and Status/ReleaseStatusCode. Status/PaymentAuthorisationStatusCode may be optional, is a status in a case of a result of an authorisation of a payment by payment card in a Customer Invoice Request, and may be based on datatype GDT: AuthorisationStatusCode. Status/ItemListCancellationStatusCode may be optional, aggregates a cancellation status of one or more items, and may be based on datatype GDT: CancellationStatusCode. Status/ItemListCustomerOrderLifeCycleStatusCode may be optional, aggregates a life cycle status of one or more items, and may be based on datatype GDT: CustomerOrderLifeCycleStatusCode. Status/ItemListFulfilmentProcessingStatusCode may be optional, aggregates a fulfillment status of one or more items, and may be based on datatype GDT: ProcessingStatusCode, with a qualifier of Fulfilment. Status/ItemListPlanningReleaseStatusCode may be optional, is a status that represents a PlanningReleaseStatusCode of one or more items in an aggregated form, and may be based on datatype GDT: ReleaseStatusCode, with a qualifier of Planning. Status/ItemListExecutionReleaseStatusCode may be optional, represents an ExecutionReleaseStatusCode of one or more items in an aggregated form, and may be based on datatype GDT: ReleaseStatusCode, with a qualifier of Execution. Status/ConfirmationIssuingStatusCode may be optional, represents a state of an issuing process of a confirmation, and may be based on datatype GDT: IssuingStatusCode, with a qualifier of Confirmation. Issuing can be printed or output via xml or by any other output method. Status/ItemListInvoiceProcessingStatusCode may be optional, represents an aggregated representation of InvoicingStatus of one or more items, and may be based on datatype GDT: ProcessingStatusCode, with a qualifier of Invoice. Status/ApprovalStatusCode may be optional, is a status of an approval of a customer transaction document, and may be based on datatype GDT: ApprovalStatusCode. Status/ItemListProductAvailabilityConfirmationStatusCode may be optional, aggregates a status of a product availability check of one or more items, and may be based on datatype GDT: ProductAvailabilityConfirmationStatusCode. Status/ConsistencyStatusCode may be optional, describes a status consisting of errors, e.g., where business data is not consistent or data that otherwise includes errors, and may be based on datatype GDT: ConsistencyStatusCode. Status/GeneralDataCompletenessStatusCode may be optional, indicates that all or part of general business data is missing, and may be based on datatype GDT: DataCompletenessStatusCode, with a qualifier of General. Status/CancellationStatusCode may be optional, indicates whether a cancellation for a Customer Transaction Document exists, and may be based on datatype GDT: CancellationStatusCode. Status/InvoicingBlockingStatusCode may be optional, represents a block of an invoicing process, and may be based on datatype GDT: BlockingStatusCode, with a qualifier of Invoicing. Status/FulfilmentBlockingStatusCode may be optional, represents a block of the delivery of goods or the provision of services, and may be based on datatype GDT: BlockingStatusCode, with a qualifier of Fulfilment. Status/CustomerRequestReleaseStatusCode may be optional, represents a release of a customer request by a customer to a seller, and may be based on datatype GDT: ReleaseStatusCode, with a qualifier of Request. In some implementations, the code values “6—Not relevant”, “1—Not released”, and “3—Released” are used. Status/ReleaseStatusCode may be optional, represents a release of a customer transaction document for subsequent processes, and may be based on datatype GDT: ReleaseStatusCode.

The following composition relationships to subordinate nodes exist: BusinessTransactionDocumentReference, in a 1:CN cardinality relationship; SalesAndServiceBusinessArea, in a 1:C cardinality relationship; Credit Worthiness, in a 1:C cardinality relationship; DeliveryTerms, in a 1:C cardinality relationship; InvoiceTerms, in a 1:C cardinality relationship; Item, in a 1:CN cardinality relationship; Location, in a 1:CN cardinality relationship; PeriodTerms, in a 1:CN cardinality relationship; PricingTerms, in a 1:C cardinality relationship; SalesTerms, in a 1:C cardinality relationship; TimePointTerms, in a 1:CN cardinality relationship; TotalValues, in a 1:C cardinality relationship; and Party, in a 1:CN cardinality relationship, which may be filtered. The filter elements are defined by the data type PartyFilterElements, and can include RoleCategoryCode and MainIndicator. RoleCategoryCode may be optional and may be based on datatype GDT: PartyRoleCategoryCode. MainIndicator may be optional and may be based on datatype GDT: Indicator. The following composition relationships to dependent objects can exist: AccessControlList, in a 1:1 cardinality relationship, which is a list of access groups that have access to a CustomerTransactionDocument; AttachmentFolder, in a 1:C cardinality relationship, which is a collection of documents attached for a CustomerTransactionDocument; CashDiscountTerms, in a 1:C cardinality relationship, which includes data used for a CustomerTransactionDocument for handling payments; ControlledOutputRequest, in a 1:C cardinality relationship, which is a controller of output requests and processed output requests related to a CustomerTransactionDocument; PaymentControl, in a 1:C cardinality relationship, which includes data used for making payments by credit card; PriceAndTaxCalculation, in a 1:C cardinality relationship, which includes price and tax components determined by price and tax determination/valuation that are valid for a CustomerTransactionDocument; TextCollection, in a 1:C cardinality relationship, which is a collection of natural-language text that refers to a CustomerTransactionDocument; and Invoice Schedule, in a 1:C cardinality relationship.

The following inbound association relationships may exist: Creation Identity, from the business object Identity/node Identity, in a 1:CN cardinality relationship, which is an identity of a user that created a Customer Transaction Document; and Last Change Identity, from the business object Identity/node Identity, in a 1:CN cardinality relationship, which is an identity of a user that last changed a Customer Transaction Document.

The following specialization associations for navigation may exist to the node Business Transaction Document Reference: Activity Reference, with a target cardinality of CN, which is an association to a reference that occurs in an EmailActivityReference specialization; Base Business Transaction Document Reference, with a target cardinality of C, which is an association to a reference that occurs in a specialization, is used as a basis, and in a use case of returns, is either a sales order or a customer invoice; Campaign Reference, with a target cardinality of C, which is an association to a reference that occurs in a CampaignReference specialization; Customer Invoice Reference, with a target cardinality of CN, which is an association to a reference that occurs in an InvoiceReference specialization; Opportunity Reference, with a target cardinality of CN, which is an association to a reference that occurs in an OpportunityReference specialization; Outbound Delivery Reference, with a target cardinality of CN, which is an association to a reference that occurs in an OutboundDeliveryReference specialization; Preceding Customer Quote Reference, with a target cardinality of CN, which is an association to a reference that occurs in a CustomerQuoteReference specialization; Purchase Order Reference, with a target cardinality of C, which is an association to a reference that occurs in a PurchaseOrderReference specialization; Sales Order Reference, with a target cardinality of CN, which is an association to a BTDReference that occurs in a SalesOrderReference specialization; Selected Document Reference, with a target cardinality of CN, which is association for navigation to selected business document references that are important for a business document flow; ActivityReference, with a target cardinality of CN, which is an association to a reference that occurs in an ActivityReference specialization; and Service Confirmation Reference, with a target cardinality of CN, which is an association to a reference that occurs in a ServiceConfirmationReference specialization.

The following specialization associations for navigation may exist to the business object Business Document Flow/node Business Document Flow: Business Document Flow, which a target cardinality of C, which is an association from BusinessDocumentFlow and which is a view on a set of preceding and succeeding business transaction documents for a current CustomerTransactionDocumentTemplate document. The following specialization associations for navigation may exist to the node Item: Sales Item, with a target cardinality of CN, which is an association to an Item that occurs in a SalesItem specialization. The following specialization associations for navigation may exist to the node Location: Service Point Location, with a target cardinality of C, which is a location that occurs in a ServicePointLocation specialization; and Ship to Location, with a target cardinality of C, which is an association to a Location that occurs in a ShipToLocation specialization.

The following specialization associations for navigation may exist to the node Party: Bill to Party, with a target cardinality of C, which is an association to a Party that occurs in a BillToParty specialization; Buyer Party, with a target cardinality of C, which is an association to a Party that occurs in a BuyerParty specialization; Employee Responsible Party, with a target cardinality of C, which is an association to a Party that occurs in an EmployeeResponsible specialization; Service Execution Team Party, with a target cardinality of C, which is an association to a Party that occurs in a ServiceExecutionTeam specialization; Freight Forwarder Party, with a target cardinality of C, which is an association to a Party that occurs in a FreightForwarderParty specialization; Payer Party, with a target cardinality of C, which is an association to a Party that occurs in a PayerParty specialization; Product Recipient Party, with a target cardinality of C, which is an association to a Party that occurs in a ProductRecipientParty specialization; Sales Partner Party, with a target cardinality of C; which is an association to a Party that occurs in a SalesPartnerParty specialization; Sales Unit Party, with a target cardinality of C, which is an association to a Party that occurs in a SalesUnit specialization; Seller Party, with a target cardinality of C, which is an association to a Party that occurs in a SellerParty specialization; Service Performer Party, with a target cardinality of C, which is an association to a Party that occurs in a ServicePerformer specialization; and Vendor Party, with a target cardinality of C, which is an association to a Party that occurs in a VendorParty specialization.

The following specialization associations for navigation may exist to the node Period Terms: Requested Fulfillment Period, with a target cardinality of C, which is an association to a PeriodTerms that occurs in a RequestedFulfillmentPeriod specialization. The following specialization associations for navigation may exist to the node Time Point Terms: Execution Release Time Point, with a target cardinality of C, which is an association to a TimePointTerms that occurs in an ExecutionReleaseTimePoint specialization.

In some implementations, TypeCode and ProcessingTypeCode are not able to be changed after they have been created. In some implementations, SystemAdministrativeData is set internally by the system and is not assigned or changed externally. In some implementations, once a CustomerTransactionDocumentTemplate has been created, an associated document may only be deleted if no subsequent processes have been started that are mapped using one or more statuses that forbid a delete action. In such implementations, the document can only be canceled and is not deleted.

An Add Reference with Data Provision action can be used to add a BusinessTransactionDocumentReference and provide relevant data from a referenced document to a CustomerTransactionDocument. The action elements are defined by the data type CustomerTransactionDocumentAddReferenceWithDataProvisionActionElements. These elements include: BusinessTransactionDocumentKey, which may include BusinessTransactionDocumentKey/BusinessTransactionDocumentTypeCode and BusinessTransactionDocumentKey/BusinessTransactionDocumentID. BusinessTransactionDocumentKey may be optional, is a unique key assigned by a seller for a Customer Transaction Document, and may be based on datatype KDT: BusinessTransactionDocumentKey. BusinessTransactionDocumentKey/BusinessTransactionDocumentID may be optional, is a unique identifier for a business transaction document, and may be based on datatype GDT: BusinessTransactionDocumentID. BusinessTransactionDocumentKey/BusinessTransactionDocumentTypeCode may be optional and is a coded representation of a document type that occurs in business transactions. The document type can describe a business nature of similar documents and can define basic features of the document type. BusinessTransactionDocumentKey/BusinessTransactionDocumentTypeCode may be based on datatype GDT: BusinessTransactionDocumentTypeCode.

An Approve action can be used to set a value of an approval status to “Approved”. A Block Fulfilment action blocks an item for delivery by setting a delivery block. In some implementations, the Block Fulfilment action is valid only for those items that are relevant for delivery. In some implementations, the Block Fulfilment action sets a “Fulfilment blocking” status variable to “Blocked”. The action elements are defined by the data type CustomerTransactionDocumentBlockFulfilmentActionElements. These elements include CustomerTransactionDocumentFulfilmentBlockingReasonCode, which may be optional, specifies why delivery processing for a business transaction item is blocked, and may be based on datatype GDT: CustomerTransactionDocumentFulfilmentBlockingReasonCode.

A Block Invoicing action blocks CustomerTransactionDocuments for invoicing by setting an invoicing block. In some implementations, the Block Invoicing action is valid only for invoice-relevant CustomerTransactionDocumentTemplate documents. In some implementations, the Block Invoicing action sets a status variable ‘InvoicingBlocking’ to ‘blocked’. The action elements are defined by the data type CustomerTransactionDocumentBlockInvoicingActionElements. These elements include InvoicingBlockingReasonCode, which may be optional, specifies why processing of invoicing documents is blocked for a business transaction item, and may be based on datatype GDT: InvoicingBlockingReasonCode.

A Check Consistency action checks a CustomerTransactionDocument for errors. In some implementations, the Check Consistency action is always allowed. In some implementations, the Check Consistency action sets a ConsistencyStatus to either ‘Consistent’ or ‘Inconsistent’.

A Check Customer Request Release Relevance action checks if a customer request is to be explicitly released. In some implementations, the CustomerRequestRelease status is in status ‘Not relevant’ or ‘Not released’ as a precondition. In some implementations, the ConfirmationIssuing status is in status ‘Not issued’ as a precondition. In some implementations, changes to status after performing the Check Customer Request Release Relevance action include the changing of a ‘CustomerRequestRelease’ status to ‘Not released’ or to ‘Not relevant’.

A Check General Data Completeness action checks for general data completeness. A Check Payment Authorisation Relevance action checks if a Payment Card payment is to be authorised in a customer transaction document. In some implementations, a precondition of the Check Payment Authorisation Relevance action is that invoicing of a customer transaction document has not been started. In some implementations, after the Check Payment Authorisation Relevance action, PaymentCardAuthorisationStatus is set to ‘Check Pending’ or ‘Authorisation not required’, depending on the result of the check.

A Check Release Relevance action checks if a customer transaction document is to be explicitly released. In some implementations, preconditions for the Check Release Relevance action include the Release status being in status ‘Not relevant’ or ‘Not released’ and the ConfirmationIssuing status being in status ‘Not issued’. In some implementations, the Check Release Relevance action changes a Release' status to ‘Not released’ or to ‘Not relevant’.

A Copy action creates a customer transaction document from an existing customer transaction document. The two customer transaction documents are not necessarily linked in a business sense. A Create From Business Partner action creates a CustomerTransactionDocument with a provided Business Partner as a buyer party. A Create with Reference action creates a CustomerTransactionDocument with reference to an existing document, from which relevant data is transferred. A Finish Fulfilment Processing Of All Items action sets a FulfilmentProcessingStatus of one or more items in a customer transaction document to “Finished”. A Notify Of Confirmation Issue action notifies about a successful issuing of a confirmation and changes a confirmation issuing status from “Issue requested” to “Issued”. A Reject action sets the value of an approval status to “Rejected”. A Release action releases a customer transaction document for subsequent processing. In some implementations, a precondition for the Release action is that a Release status has the value ‘Not Released’. In some implementations, the Release action changes a ‘Release’ status from ‘Not released’ to ‘Released’.

A Release Customer Request action releases a customer request. In some implementations, a precondition for the Release Customer Request action is that a CustomerRequestRelease status has the value ‘Not Released’. In some implementations, the Release action changes a ‘CustomerRequestRelease’ status from ‘Not released’ to ‘Released’. A Release All Items To Execution action sets an ExecutionReleaseStatus of one or more items in a customer transaction document to “Released”. A Request Confirmation Issue action represents a request to issue a confirmation. In some implementations, the Request Confirmation Issue action changes a ‘Confirmation issuing’ status variable from ‘Not issued’ to ‘Issue requested’.

A Request Payment Authorisation action triggers a calculation of open amounts to be charged on a payment card and initiates an authorisation request. In some implementations, a precondition for the Request Payment Authorisation action is that a customer transaction document is not yet fully invoiced. In some implementations, after the Request Payment Authorisation action, a PaymentAuthorisationStatus is set to ‘Check Pending’, ‘Not authorised’ or ‘Authorised’, depending of the result of the check.

A Send Back for Revision action sets a value of an approval status to “In revision”. A Submit for Approval action sets the value of an approval status to either “Approval not necessary” or “In approval”. An Unblock Fulfilment action resets a delivery block. In some implementations, the Unblock Fulfilment action is applicable for only those delivery-relevant items for which a delivery block has been set. In some implementations, the Unblock Fulfilment action changes a “Fulfilment blocking” status variable from “Blocked” to “Not blocked”.

An Unblock Invoicing action removes an invoice block. In some implementations, the Unblock Invoicing action is valid only for invoice-relevant CustomerTransactionDocumentTemplate documents with an invoice block. In some implementations, the Unblock Invoicing action changes an InvoiceBlock status from ‘blocked’ to ‘not blocked’. A Withdraw action sets the value of an approval status to “Withdrawn”.

A Create Project action can be used to create a project based on a customer transaction document. Two different variants of projects can be created: in a first variant, a ‘Project structure based on customer project invoicing’ method, a project task can be created for each customer project invoicing method used in a sales order, and customer project invoicing methods can be Time and Material, and Fixed Price (see GDT CustomerProjectInvoicingMethodCode), so at most, two project tasks will be created; and in a second variant, a ‘Project structure based on sales order structure’ method, a project structure can correspond to a sales order structure, sales order items can be linked to synchronously created project tasks, and the second variant can be defined with a GDT ProjectCreationMethodCode as an action parameter element. The action elements are defined by the data type CustomerTransactionDocumentCreateProjectActionElements. These elements include: ProjectResponsibleEmployeeID, ProjectResponsibleCostCentreID, ProjectCreationMethodCode, and ProjectIntercompanySettlementIndicator. ProjectResponsibleEmployeeID may be an identifier of a project manager of a project, and may be based on datatype GDT: EmployeeID. ProjectResponsibleCostCentreID may be an identifier of a responsible unit for a project, and may be based on datatype GDT: OrganisationalCentreID. ProjectCreationMethodCode allows the user to define a granularity for project creation, and may be based on datatype GDT: ProjectCreationMethodCode. ProjectIntercompanySettlementIndicator may be optional and may be based on datatype GDT: Indicator.

A Query By Elements query may return a list of all CustomerTransactionDocumentTemplate documents including specified selection criteria. The selection criteria can be specified by a logical ‘AND’ combination of query elements. The query elements are defined by the data type CustomerTransactionDocumentElementsQueryElements. These elements include: ID, TypeCode, DateTime, Name, BuyerID, BuyerName, DataOriginTypeCode, SystemAdministrativeData, BusinessPartnerCommonPersonNameGivenName, CreationBusinessPartnerCommonPersonNameFamilyName, LastChangeBusinessPartnerCommonPersonNameGivenName, LastChangeBusinessPartnerCommonPersonNameFamilyName, SalesAndServiceBusinessAreaSalesOrganisationID, SalesAndServiceBusinessAreaSalesGroupID, SalesAndServiceBusinessAreaSalesOfficeID, SalesAndServiceBusinessAreaDistributionChannelCode, SalesAndServiceBusinessAreaServiceOrganisationID, PartyBuyerPartyKey, BuyerPartyContactPartyPartyKey, PartySalesUnitPartyKey, PartyEmployeeResponsiblePartyKey, PartyProcessorPartyKey, PartyServicePerformerPartyKey, PartyServiceSupportTeamPartyKey, PartyName, PartySortingFormattedName, PartyServiceExecutionTeamPartyKey, PartyRoleCode, ItemDescription, ItemProductProductInternalID, ItemProductProductBuyerID, ItemProductProductRequirementSpecificationKey, ItemCustomerOrderLifeCycleStatusCode, ItemCustomerContractLifeCycleStatusCode, ItemLastChangeDateTime, ServiceTermsServiceIssueCategoryCatalogueCategoryKey, SolutionProposalCustomerProblemAndSolutionKey, ServiceReferenceObjectMainMaterialKey, ServiceReferenceObjectMainIndividualMaterialKey, IncidentServiceIssueCategoryMainServiceIssueCategoryCatalogueCategoryKey, BusinessTransactionDocumentReferenceBusinessTransactionDocumentReferenceID, BusinessTransactionDocumentReferenceBusinessTransactionDocumentReferenceTypeCode, TimePointTermsFirstReactionDueTimePoint, TimePointTermsCompletionDueTimePoint, ItemTimePointTermsCompletionDueTimePoint, TimePointTermsRequestInitialReceiptTimePoint, ValidityPeriod, SolutionProposalExternalKnowledgeBaseArticleID, PeriodTermsRequestedFulfilmentPeriod, TotalValuesNextAuthorisationDateTime, SearchText, and Status.

ID is a unique identifier assigned by a seller for a Customer Transaction Document, and may be based on datatype GDT: BusinessTransactionDocumentID. TypeCode Is an encoded representation of a type of Customer Transaction Document, and may be based on datatype GDT: BusinessTransactionDocumentTypeCode. DateTime is a creation time posting time of a Customer Transaction Document, from a business perspective, and may be based on datatype GDT: GLOBAL_DateTime, with a qualifier of Posting. Name is a name of a Customer Transaction Document, and may be based on datatype GDT: MEDIUM_Name. BuyerID is a unique identifier for a Customer Transaction Document assigned by a buyer, and may be based on datatype GDT: BusinessTransactionDocumentID. BuyerName is a short-text description for a Customer Transaction Document assigned by a buyer, and may be based on datatype GDT: MEDIUM_Name. DataOriginTypeCode is a type of origin of a customer transaction document, and may be based on datatype GDT: CustomerTransactionDocumentDataOriginTypeCode. SystemAdministrativeData is administrative data stored in a system, such as system users and change dates/times, and may be based on datatype GDT: SystemAdministrativeData. CreationBusinessPartnerCommonPersonNameGivenName is administrative data stored in a system, such as system users and change dates/times, and may be based on datatype GDT: MEDIUM_Name. CreationBusinessPartnerCommonPersonNameFamilyName is administrative data stored in a system, such as system users and change dates/times, and may be based on datatype GDT: MEDIUM_Name. LastChangeBusinessPartnerCommonPersonNameGivenName is administrative data stored in a system, such as system users and change dates/times, and may be based on datatype GDT: MEDIUM_Name. LastChangeBusinessPartnerCommonPersonNameFamilyName is administrative data stored in a system, such as system users and change dates/times, and may be based on datatype GDT: MEDIUM_Name. SalesAndServiceBusinessAreaSalesOrganisationID is an identifier for a sales organization that is responsible for a Customer Transaction Document, and may be based on datatype GDT: OrganisationalCentreID. SalesAndServiceBusinessAreaSalesGroupID is an identifier for a sales group that is responsible for a Customer Transaction Document, and may be based on datatype GDT: OrganisationalCentreID. SalesAndServiceBusinessAreaSalesOfficeID is an identifier for a sales office that is responsible for a Customer Transaction Document, and may be based on datatype GDT: OrganisationalCentreID. SalesAndServiceBusinessAreaDistributionChannelCode is a coded representation of a distribution channel by which goods and services reach customers, and may be based on datatype GDT: DistributionChannelCode. SalesAndServiceBusinessAreaServiceOrganisationID is an identifier for a service organization, and may be based on datatype GDT: OrganisationalCentreID. PartyBuyerPartyKey is an identifier for a BuyerParty, and may be based on datatype KDT: PartyKey. PartyBuyerParty can include PartyBuyerPartyKey/PartyID, which is an identifier for a party and may be based on datatype GDT: PartyID. BuyerPartyContactPartyPartyKey may be based on datatype KDT: PartyKey and may include BuyerPartyContactPartyPartyKey/PartyID, which is an identifier for a party and may be based on datatype GDT: PartyID. PartySalesUnitPartyKey is a key to identify a sales unit party, and may be based on datatype KDT: PartyKey. PartySalesUnitPartyKey may include PartySalesUnitPartyKey/PartyID, which is an identifier for a party and may be based on datatype GDT: PartyID. PartyEmployeeResponsiblePartyKey is an identifier of a responsible employee, and may be based on datatype KDT: PartyKey. PartyEmployeeResponsiblePartyKey/PartyID is an identifier for a party, and may be based on datatype GDT: PartyID. PartyProcessorPartyKey is an identifier of a processor of a Customer Transaction Document document, and may be based on datatype KDT: PartyKey. PartyServicePerformerPartyKey is an identifier of a service performer, and may be based on datatype KDT: PartyKey. PartyServicePerformerPartyKey/PartyID may include PartyServicePerformerPartyKey, which is an identifier for a party, and may be based on datatype GDT: PartyID. PartyServiceSupportTeamPartyKey may be based on datatype KDT: PartyKey. PartyPartyKey is an identifier for a Party or ItemParty in a business document, and may be based on datatype KDT: PartyKey. PartyPartyKey may include PartyPartyKey/PartyID, which is an identifier for a party, and may be based on datatype GDT: PartyID. PartyName is a name of a party that occurs in a customer transaction document (e.g., a FamilyName of business partner is considered). BusinessPartnerCommonPersonNameFamilyName may be based on datatype GDT: MEDIUM_Name, with a qualifier of Party. PartyAdditionalName is an additional name of a party that occurs in a customer transaction document (e.g., a given name of a business partner is considered). BusinessPartnerCommonPersonNameGivenName may be based on datatype GDT: LANGUAGEINDEPENDENT_MEDIUM_Name, with a qualifier of PartyAdditional. PartySortingFormattedName is a sorting formatted name of a party that occurs in a customer transaction document and SortingFormattedName of business partner is considered. BusinessPartnerCommonSortingFormattedName may be based on datatype GDT: LONG_Name. PartyServiceExecutionTeamPartyKey may be based on datatype KDT: PartyKey. PartyServiceExecutionTeamPartyKey may include PartyServiceExecutionTeamPartyKey/PartyID, which is an identifier for a party and may be based on datatype GDT: PartyID. PartyRoleCode is a party role for a Party or ItemParty in a business document. The PartyPartyRoleCode or the ItemPartyPartyRoleCode corresponds with the query element PartyRoleCode. PartyRoleCode may be based on datatype GDT: PartyRoleCode. ItemDescription may be based on datatype GDT: SHORT_Description. ItemProductProductKey is an identifier specified for a product, and may be based on datatype KDT: ProductUnformattedKey. ItemProductProductKey may include ItemProductProductKey/ProductTypeCode, which is a coded representation of a product type, such as material or service, and may be based on datatype GDT: ProductTypeCode. ItemProductProductKey can include ItemProductProductKey/ProductidentifierTypeCode, which is a coded representation of a product identifier type, and may be based on datatype GDT: ProductidentifierTypeCode. ItemProductProductKey can include ItemProductProductKey/ProductID, which is an identifier for a product, and may be based on datatype GDT: NOCONVERSION_ProductID. ItemProductProductInternalID is a unique identifier for a product assigned by a seller, and may be based on datatype GDT: ProductInternalID. ItemProductProductBuyerID is a unique identifier for a product assigned by a buyer, and may be based on datatype GDT: ProductPartyID. ItemProductProductRequirementSpecificationKey is a key to identify a product requirement specification of an item, and may be based on datatype KDT: RequirementSpecificationKey. ItemProductProductRequirementSpecificationKey can include ItemProductProductRequirementSpecificationKey/RequirementSpecificationID, which is an identifier for a requirement specification that is unique within a system, and may be based on datatype GDT: RequirementSpecificationID. ItemProductProductRequirementSpecificationKey can include ItemProductProductRequirementSpecificationKey/RequirementSpecificationVersionID, which is an identifier for a version of a requirement specification, and may be based on datatype GDT: VersionID. ItemCustomerOrderLifeCycleStatusCode is a status that represents a basic processing progress on an item of a Customer Transaction Document, and may be based on datatype GDT: CustomerOrderLifeCycleStatusCode. ItemCustomerContractLifeCycleStatusCode may be based on datatype GDT: CustomerContractLifeCycleStatusCode_V1. ItemLastChangeDateTime is a date/time at which a customer transaction document was last changed, and may be based on datatype GDT: GLOBAL_DateTime. ServiceTermsServiceIssueCategoryCatalogueCategoryKey is a key to identify a category that schedules a service business transaction, and may be based on datatype KDT: ServiceIssueCategoryCatalogueCategoryKey. SolutionProposalCustomerProblemAndSolutionKey is a key to identify a customer problem and solution, and may be based on datatype KDT: CustomerProblemAndSolutionKey. ServiceReferenceObjectMainMaterialKey is a material to which a service primarily refers, and may be based on datatype KDT: ProductKey. ServiceReferenceObjectMainIndividualMaterialKey is an individual material to which a service primarily refers, and may be based on datatype KDT: ProductKey. IncidentServiceIssueCategoryMainServiceIssueCategoryCatalogueCategoryKey is a key to identify a main category that is used to categorize an individual incident in a service process, and may be based on datatype KDT: ServiceIssueCategoryCatalogueCategoryKey. BusinessTransactionDocumentReferenceBusinessTransactionDocumentReferenceID is an identifier of a referenced business document. The BusinessTransactionDocumentReferenceBusinessTransactionDocumentReferenceID or the ItemBusinessTransactionDocumentReferenceBusinessTransactionDocumentReferenceID corresponds with the query element BusinessTransactionDocumentReferenceBusinessTransactionDocumentReferenceID.

BusinessTransactionDocumentReferenceBusinessTransactionDocumentReferenceID may be based on datatype GDT: BusinessTransactionDocumentID. BusinessTransactionDocumentReferenceBusinessTransactionDocumentReferenceTypeCode is a type of a referenced business transaction document. The BusinessTransactionDocumentReferenceBusinessTransactionDocumentReferenceTypeCode or the ItemBusinessTransactionDocumentReferenceBusinessTransactionDocumentReferenceTypeC ode corresponds with the query element BusinessTransactionDocumentReferenceBusinessTransactionDocumentReferenceTypeCode. BusinessTransactionDocumentReferenceBusinessTransactionDocumentReferenceTypeCode may be based on datatype GDT: BusinessTransactionDocumentTypeCode. TimePointTermsFirstReactionDueTimePoint is a point-in-time by which a response to a newly received service request or service order is required, and may be based on datatype GDT: TimePoint, with a qualifier of FirstReactionDue. TimePointTermsCompletionDueTimePoint is a point-in-time by which a service request or service order is to be fully processed, and may be based on datatype GDT: TimePoint, with a qualifier of CompletionDue. ItemTimePointTermsCompletionDueTimePoint is a point-in-time by which a service order item is to be fully processed, and may be based on datatype GDT: TimePoint, with a qualifier of CompletionDue. TimePointTermsRequestInitialReceiptTimePoint is a point-in-time by which a request is initially received, and may be based on datatype GDT: TimePoint, with a qualifier of RequestInitialReceipt. ValidityPeriod is a period when a Customer Transaction Document document is valid, and may be based on datatype GDT: TimePointPeriod, with a qualifier of Validity. SolutionProposalExternalKnowledgeBaseArticleID may be based on datatype GDT: KnowledgeBaseArticleID, with a qualifier of External. PeriodTermsRequestedFulfilmentPeriod may be based on datatype GDT: TimePointPeriod. TotalValuesNextAuthorisationDateTime may be based on datatype GDT: LOCALNORMALISED_DateTime, with a qualifier of Authorisation. SearchText includes free text including one or several word search terms to use for searching for a customer transaction document, and may be based on datatype GDT: SearchText.

Status includes one or more statuses of a Customer Transaction Document and can correspond to similar elements in the Root node. Status may be based on datatype BOIDT: CustomerTransactionDocumentStatus. Status may include: Status/PaymentAuthorisationStatusCode, Status/ItemListCancellationStatusCode, Status/ItemListCustomerOrderLifeCycleStatusCode, Status/ItemListFulfilmentProcessingStatusCode, Status/ItemListPlanningReleaseStatusCode, Status/ItemListExecutionReleaseStatusCode, Status/ConfirmationIssuingStatusCode, Status/ItemListInvoiceProcessingStatusCode, Status/ApprovalStatusCode, Status/ItemListProductAvailabilityConfirmationStatusCode, Status/ConsistencyStatusCode, Status/GeneralDataCompletenessStatusCode, Status/InvoicingBlockingStatusCode, Status/FulfilmentBlockingStatusCode, Status/CustomerRequestReleaseStatusCode, Status/ReleaseStatusCode, Status/ItemListCustomerContractLifeCycleStatusCode, Status/ItemListValidityStatusCode, Status/ItemListReleaseStatusCode, and Status/CustomerContractTemplateLifeCycleStatusCode.

Status/PaymentAuthorisationStatusCode is a status for a result of an authorisation of a payment by a payment card in a Customer Invoice Request, and may be based on datatype GDT: AuthorisationStatusCode. Status/ItemListCancellationStatusCode aggregates a cancellation status of items, and may be based on datatype GDT: CancellationStatusCode. Status/ItemListCustomerOrderLifeCycleStatusCode aggregates a life cycle status of items, and may be based on datatype GDT: CustomerOrderLifeCycleStatusCode. Status/ItemListFulfilmentProcessingStatusCode aggregates a fulfillment status of items, and may be based on datatype GDT: ProcessingStatusCode, with a qualifier of Fulfilment. Status/ItemListPlanningReleaseStatusCode represents a PlanningReleaseStatusCode of items in an aggregated form, and may be based on datatype GDT: ReleaseStatusCode, with a qualifier of Planning Status/ItemListExecutionReleaseStatusCode represents an ExecutionReleaseStatusCode of items in an aggregated form, and may be based on datatype GDT: ReleaseStatusCode, with a qualifier of Execution. Status/ConfirmationIssuingStatusCode represents a state of an issuing process of a confirmation, and may be based on datatype GDT: IssuingStatusCode, with a qualifier of Confirmation. Issuing can be printed or output via xml or by any other output method. Status/ItemListInvoiceProcessingStatusCode represents an aggregated representation of InvoicingStatus of items, and may be based on datatype GDT: ProcessingStatusCode, with a qualifier of Invoice. Status/ApprovalStatusCode is a status of an approval of a customer transaction document, and may be based on datatype GDT: ApprovalStatusCode. Status/ItemListProductAvailabilityConfirmationStatusCode aggregates a status of product availability check of items, and may be based on datatype GDT: ProductAvailabilityConfirmationStatusCode. Status/ConsistencyStatusCode describes a status consisting of errors, such as where business data is not consistent, or other data that includes errors, and may be based on datatype GDT: ConsistencyStatusCode. Status/GeneralDataCompletenessStatusCode indicates that all or part of general business data is missing, and may be based on datatype GDT: DataCompletenessStatusCode, with a qualifier of General. Status/InvoicingBlockingStatusCode represents a block of an invoicing process, and may be based on datatype GDT: BlockingStatusCode, with a qualifier of Invoicing. Status/FulfilmentBlockingStatusCode represents a block of a delivery of goods or a provision of services, and may be based on datatype GDT: BlockingStatusCode, with a qualifier of Fulfilment. Status/CustomerRequestReleaseStatusCode represents a release of a customer request by a customer to a seller, and may be based on datatype GDT: ReleaseStatusCode, with a qualifier of Request. In some implementations, the code values “6—Not relevant”, “1—Not released” and “3—Released” are used. Status/ReleaseStatusCode represents a release of a customer transaction document for subsequent processes, and may be based on datatype GDT: ReleaseStatusCode. Status/ItemListCustomerContractLifeCycleStatusCode aggregates a contract life cycle status of items, and may be based on datatype GDT: CustomerContractLifeCycleStatusCode_V1. Status/ItemListValidityStatusCode aggregates a validity status of items, and may be based on datatype GDT: ValidityStatusCode. Status/ItemListReleaseStatusCode aggregates a release status of items, and may be based on datatype GDT: ReleaseStatusCode. Status/CustomerContractTemplateLifeCycleStatusCode may be based on datatype GDT: CustomerContractTemplateLifeCycleStatusCode.

A Select All query may be used to provide NodeIDs of all instances of the node. The SelectAll query can be used to enable an initial load of data for a Fast Search Infrastructure.

A BusinessTransactionDocumentReference is a unique reference between a CustomerTransactionDocument and another business document or another business document item. References can result in the linking of business documents or business document items to a CustomerTransactionDocument. BusinessTransactionDocumentReference can occur in the following specializations: PurchaseOrderReference, CustomerQuoteReference, SalesOrderReference, OutboundDeliveryReference, InboundDeliveryReference, CustomerInvoiceReference, ServiceRequestReference, ServiceContractReference, ServiceConfirmationReference, ServiceOrderReference, CustomerComplaintReference, EmailActivityReference, PhoneCallActivityReference, LetterActivityReference, FaxActivityReference, AppointmentActivityReference, OpportunityReference, and ActivityReference.

The elements located directly at the node Business Transaction Document Reference are defined by the data type CustomerTransactionDocumentBusinessTransactionDocumentReferenceElements. These elements include: BusinessTransactionDocumentReference, BusinessTransactionDocumentRelationshipRoleCode, and DataProviderIndicator. BusinessTransactionDocumentReference includes a unique reference to a different business document or to an item of a different business document, and may be based on datatype GDT: BusinessTransactionDocumentReference. BusinessTransactionDocumentRelationshipRoleCode may be optional, is a coded representation of a role that a referenced business document or item of a referenced business document adopts in a reference relationship, and may be based on datatype GDT: BusinessTransactionDocumentRelationshipRoleCode. DataProviderIndicator specifies whether a business document provides data for a referenced business document, and may be based on datatype GDT: Indicator, with a qualifier of DataProvider.

The following inbound association relationships may exist: Campaign, from the business object Campaign/node Campaign, with a cardinality of C:CN, which is a campaign that is referenced through specialisation CampaignReference; CustomerQuote, from the business object Customer Quote/node Customer Quote, with a cardinality of C:CN, which is a CustomerQuote that is referenced through the specialisation CustomerQuoteReference; Opportunity, from the business object Opportunity/node Opportunity, with a cardinality of C:CN, which is an Opportunity that is referenced through the specialisation OpportunityReference; SalesOrder, from the business object Sales Order/node Sales Order, with a cardinality of C:CN, which is a SalesOrder that is referenced through the specialisation SalesOrderReference; ServiceConfirmation, from the business object Service Confirmation/node Service Confirmation, with a cardinality of C:CN, which is a ServiceConfirmation that is referenced through the specialisation ServiceConfirmationReference.

The following specialization associations for navigation may exist to the node Sales Order: Parent, with a target cardinality of 1; and Root, with a target cardinality of 1 In some implementations, BusinessTransactionDocumentReference includes one or more immediate neighbors of the CustomerTransaction-DocumentTemplate document.

The following associations from the referenced business transaction documents can be used by the listed projections of a CustomerTransactionDocument_Template: for ServiceRequest—ServiceRequest, ServiceOrder, EmailActivity, PhoneCallActivity, LetterActivity, FaxActivity, and AppointmentActivity; for Service Order—CustomerQuote, OutboundDelivery, CustomerInvoice, ServiceRequest, ServiceContract, ServiceConfirmation, ServiceOrder, CustomerComplaint, EmailActivity, PhoneCallActivity, LetterActivity, FaxActivity, and AppointmentActivity; for Service Confirmation—SalesOrder, OutboundDelivery, CustomerInvoice, ServiceRequest, ServiceConfirmation, ServiceOrder, EmailActivity, PhoneCallActivity, LetterActivity, FaxActivity, and AppointmentActivity; for Sales Order—PurchaseOrder, CustomerQuote, SalesOrder, OutboundDelivery, CustomerInvoice, ServiceConfirmation, and Opportunity; for Customer Quote—CustomerQuote, SalesOrder, and Opportunity; for Customer Return—SalesOrder, InoundDelivery, and CustomerInvoice; and for Support Request—ServiceRequest.

A SalesAndServiceBusinessArea is a business or service specific area within an enterprise that is valid for a CustomerTransactionDocument, such as, for example, sales organization, service organization, distribution channel, or division. Such elements can be derived from an organizational unit Sales Unit or Service Unit (e.g., see Party responsible for the CustomerTransactionDocument), and can be overwritten manually.

The elements located directly at the node Sales And Service Business Area are defined by the data type CustomerTransactionDocumentSalesAndServiceBusinessAreaElements. These elements include: SalesOrganisationID, SalesGroupID, SalesOfficeID, DistributionChannelCode, ServiceOrganisationID, SalesOrganisationUUID, SalesGroupUUID, SalesOfficeUUID, and ServiceOrganisationUUID. SalesOrganisationID may be optional, is an identifier for a sales organization that is responsible for a Customer Transaction Document, and may be based on datatype GDT: OrganisationalCentreID. SalesGroupID may be optional, is an identifier for a sales group that is responsible for a Customer Transaction Document, and may be based on datatype GDT: OrganisationalCentreID. SalesOfficeID may be optional, is an identifier for a sales office that is responsible for a Customer Transaction Document, and may be based on datatype GDT: OrganisationalCentreID. DistributionChannelCode is a coded representation of a distribution channel by which goods and services reach customers, and may be based on datatype GDT: DistributionChannelCode. ServiceOrganisationID may be optional, is an identifier for a service organization, and may be based on datatype GDT: OrganisationalCentreID. SalesOrganisationUUID is a universally unique identifier for a sales organization, and may be based on datatype GDT: UUID. SalesGroupUUID is a universally unique identifier for a sales group, and may be based on datatype GDT: UUID. SalesOfficeUUID is a universally unique identifier for a sales office, and may be based on datatype GDT: UUID. ServiceOrganisationUUID is a universally unique identifier for a service organization, and may be based on datatype GDT: UUID.

The following inbound aggregation relationships may exist: Sales Group, from the business object Functional Unit/node Organisational Centre, with a cardinality of C:CN, which is a Functional Unit within a specialisation Sales Group; Sales Office, from the business object Functional Unit/node Organisational Centre, with a cardinality of C:CN, which is a functional Unit within a specialization Sales Office; Sales Organisation, from the business object Functional Unit/node Organisational Centre, with a cardinality of C:CN, which is a FunctionalUnit with a specializations Sales Organisation; Service Organisation, from the business object Functional Unit/node Organisational Centre, with a cardinality of C:CN, which is a Functional Unit within a specialisation Service Organisation. The following specialization associations for navigation may exist to the node Sales Order: Parent, with a target cardinality of 1; and Root, with a target cardinality of 1.

Credit Worthiness is information about credit worthiness of a party in a customer transaction document. In most cases the party is a payer party. Credit Worthiness includes data about an amount of a credit limit, credit exposure, and credit worthiness. In some implementations, credit worthiness data is transient. The elements located directly at the node Credit Worthiness are defined by the data type CustomerTransactionDocumentCreditWorthinessElements. These elements include: CreditLimitAmount, CreditExposureAmount, and Indicator. CreditLimitAmount is an amount up to which a credit can be used, and may be based on datatype GDT: Amount, with a qualifier of CreditLimit. CreditExposureAmount is an amount up to which a credit line has been used, and may be based on datatype GDT: Amount, with a qualifier of CreditExposure. Indicator indicates whether a payer is creditworthy, and may be based on datatype GDT: Indicator. The following specialization associations for navigation may exist to the node Sales Order Parent, with a target cardinality of 1; and Root, with a target cardinality of 1.

DeliveryTerms are agreements that apply for delivery of goods and provision of services in a CustomerTransactionDocument. The elements located directly at the node Delivery Terms are defined by the data type CustomerTransactionDocumentDeliveryTermsElements. These elements include: DeliveryPriorityCode, Incoterms, PartialDeliveryControlCode, QuantityTolerance, and CompleteDeliveryRequestedIndicator DeliveryPriorityCode may be optional, is a coded representation of priority/urgency of delivery, and may be based on datatype GDT: PriorityCode, with a qualifier of Delivery. Incoterms includes conventional contract formulations for delivery terms, and may be based on datatype GDT: Incoterms. PartialDeliveryControlCode may be optional and is a coded representation of partial delivery control. PartialDeliveryControlCode specifies whether a customer permits partial deliveries and in what form, and may be based on datatype GDT: PartialDeliveryControlCode. QuantityTolerance may be optional, is a tolerated difference between a requested and an actual delivery quantity in percentage form, and may be based on datatype GDT: QuantityTolerance. CompleteDeliveryRequestedIndicator may be optional and may be based on datatype GDT: Indicator. The following specialization associations for navigation may exist to the node Sales Order: Parent, with a target cardinality of 1; and Root, with a target cardinality of 1. In some implementations, the DeliveryControlCode field value ‘Complete delivery’ and the QuantityTolerances field are mutually exclusive. In some implementations, it is not recommended to maintain quantity tolerances and to set complete delivery at the same time.

InvoiceTerms are agreements that apply for invoicing goods and services in a CustomerTransactionDocument. The elements located directly at the node Invoice Terms are defined by the data type CustomerTransactionDocumentInvoiceTermsElements. These elements include: ProposedInvoiceDate, ProposedInvoiceDateDateCalculationFunctionReference, InvoicingBlockingReasonCode, and CustomerProjectInvoiceRequisitionItemCreationMethodCode. ProposedInvoiceDate may be optional, is a date on which an invoice is proposed to be created with a rule for automatic scheduling, and may be based on datatype GDT: Date, with a qualifier of Invoice. ProposedInvoiceDateDateCalculationFunctionReference is a date rule for determining a proposed price date, and may be based on datatype GDT: DateCalculationFunctionReference. InvoicingBlockingReasonCode may be optional, specifies why processing of invoicing documents is blocked for a business transaction item, and may be based on datatype GDT: InvoicingBlockingReasonCode. CustomerProjectInvoiceRequisitionItemCreationMethodCode may be optional and may be based on datatype GDT: CustomerProjectInvoiceRequisitionItemCreationMethodCode. The following specialization associations for navigation may exist to the node Sales Order: Parent, with a target cardinality of 1; and Root, with a target cardinality of 1. In some implementations, at least one of the elements is set.

Item is an item of a customer-specific business transaction that focuses on delivering goods or providing a service, on prices, and on preparing an invoice. Item is an identifying and administrative item information in a CustomerTransactionDocument which, in addition to schedule lines, includes data that applies to an item, for example, product information, parties involved, sales, delivery, or customer invoicing-specific agreements, status, and references. Item can occur in the following specializations: Sales Service Item, Sales Service Quote Item, Service Contract Item, Customer Service Confirmation Item, Customer Spare Part Quote Item, Customer Service Quote Item, Customer Spare Part Confirmation Item, Customer Service Item, Customer Spare Part Item, Sales Item, Sales Quote Item, Complaint Item, Customer Return Item, Compensation Delivery Item, Refund Item, and Sales Contract Item.

The elements located directly at the node Item are defined by the data type CustomerTransactionDocumentItemElements. These elements include: ID, BuyerID, TypeCode, ProcessingTypeCode, DateTime, Description, BuyerDateTime, BuyerName, HierarchyRelationship, UUID, SystemAdministrativeData, FulfilmentPartyCategoryCode, MigratedDataAdaptationTypeCode, and Status.

ID is a unique identifier for an item of a Customer Transaction Document assigned by a seller in a Customer Transaction Document, and may be based on datatype GDT: BusinessTransactionDocumentItemID BuyerID may be optional, is a unique identifier for a Customer Transaction Document item assigned by a buyer, and may be based on datatype GDT: BusinessTransactionDocumentItemID TypeCode is a coded representation of a type of a Customer Transaction Document item, may be based on datatype GDT: BusinessTransactionDocumentItemTypeCode, can be set internally from a ProcessingTypeCode, and includes a permissible item specialization of a CustomerTransactionDocumentTemplate. An example of a TypeCode is a SalesItem. ProcessingTypeCode may be optional, is a coded representation of item processing of a Customer Transaction Document in a process component, and may be based on datatype GDT: BusinessTransactionDocumentItemProcessingTypeCode. ProcessingTypeCode “Item type” or “item category” can include standard order items, for example. DateTime may be optional, is a creation time posting time of a Customer Transaction Document item from a business perspective, and may be based on datatype GDT: GLOBAL_DateTime. Description is a short description of a Customer Transaction Document item, and may be based on datatype GDT: SHORT_Description. BuyerDateTime may be optional, is a date/time assigned by a buyer for a Customer Transaction Document item, and may be based on datatype GDT: GLOBAL_DateTime, with a qualifier of Buyer. BuyerName is a name of an item assigned by a buyer, and may be based on datatype GDT: MEDIUM_Name. HierarchyRelationship is a relationship between a subitem and a main item to describe item hierarchies, and may be based on datatype BOIDT: CustomerTransactionDocumentItemHierarchyRelationship. HierarchyRelationship can include HierarchyRelationship/ParentItemID, which may be optional, is an identifier of a higher-level item in an item hierarchy of a Customer Transaction Document, and may be based on datatype GDT: BusinessTransactionDocumentItemID HierarchyRelationship can include HierarchyRelationship/ParentItemUUID, which is a UUID of a higher-level item in an item hierarchy of a Customer Transaction Document, and may be based on datatype GDT: UUID. HierarchyRelationship can include HierarchyRelationship/TypeCode, which is a relationship type of an item hierarchy in a customer transaction document, and may be based on datatype GDT: BusinessTransactionDocumentItemHierarchyRelationshipTypeCode. UUID may be an alternative key, is an identifier for a Customer Transaction Document item, can be assigned internally, and may be based on datatype GDT: UUID. A UUID can serve as an alternate key, with which other business objects can define foreign keys. SystemAdministrativeData is administrative data stored in a system that can include system users and change dates/times and may be based on datatype GDT: SystemAdministrativeData. FulfilmentPartyCategoryCode is a party category of a fulfilment of a customer transaction document item, may be based on datatype GDT: FulfilmentPartyCategoryCode, and defines if a delivery of a material or provision of a service is done by an owning company or by an external supplier. MigratedDataAdaptationTypeCode may be optional, is a coded representation of a type of data adaption performed during migration of a customer transaction document item, and may be based on datatype GDT: MigratedDataAdaptationTypeCode. In some implementations, data may be adapted when migrating data from a source system to a target system, for example. In some implementations, a MigratedDataAdaptationTypeCode is used when a CustomerTransactionDocument item is migrated. Status may be optional, may be based on CustomerTransactionDocumentItemStatus, may describe statuses of a Customer Transaction Document at an item level, and may be based on datatype BOIDT: CustomerTransactionDocumentItemStatus. Status can include Status/ConsistencyStatusCode, Status/ProductAvailabilityConfirmationStatusCode, Status/FulfilmentDataCompletenessStatusCode, Status/InvoicingDataCompletenessStatusCode, Status/PricingDataCompletenessStatusCode, Status/GeneralDataCompletenessStatusCode, Status/FulfilmentProcessingStatusCode, Status/InvoiceProcessingStatusCode, Status/CustomerOrderLifeCycleStatusCode, Status/CancellationStatusCode, Status/PlanningReleaseStatusCode, Status/ExecutionReleaseStatusCode, Status/ApprovalStatusCode, and Status/ReleaseStatusCode. Status/ConsistencyStatusCode may be optional, denotes whether a Customer Transaction Document has errors, and may be based on datatype GDT: ConsistencyStatusCode. Status/ProductAvailabilityConfirmationStatusCode may be optional, provides a result of an availability check, and may be based on datatype GDT: ProductAvailabilityConfirmationStatusCode. Status/FulfilmentDataCompletenessStatusCode may be optional, describes whether data has been completely entered in an area Fulfillment, and may be based on datatype GDT: DataCompletenessStatusCode, with a qualifier of Fulfilment. Status/InvoicingDataCompletenessStatusCode may be optional, describes whether data has been completely entered in an area Invoicing, and may be based on datatype GDT: DataCompletenessStatusCode, with a qualifier of Invoicing. Status/PricingDataCompletenessStatusCode may be optional, describes whether data has been completely entered in an area Pricing, and may be based on datatype GDT: DataCompletenessStatusCode, with a qualifier of Pricing. Status/GeneralDataCompletenessStatusCode may be optional, describes whether general data has been completely entered, and may be based on datatype GDT: DataCompletenessStatusCode, with a qualifier of General. Status/FulfilmentProcessingStatusCode may be optional, describes a processing progress regarding a delivery or provision of a service, and may be based on datatype GDT: ProcessingStatusCode, with a qualifier of Fulfilment. Status/InvoiceProcessingStatusCode may be optional, describes processing progress during invoicing, and may be based on datatype GDT: ProcessingStatusCode, with a qualifier of Invoice. Status/CustomerOrderLifeCycleStatusCode may be optional, represents basic processing progress on an item of a Customer Transaction Document, and may be based on datatype GDT: CustomerOrderLifeCycleStatusCode. Status/CancellationStatusCode may be optional, indicates whether a cancellation for a Customer Transaction Document exists, and may be based on datatype GDT: CancellationStatusCode. Status/PlanningReleaseStatusCode may be optional, represents a planning progress of an item, and may be based on datatype GDT: ReleaseStatusCode, with a qualifier of Planning. Status/ExecutionReleaseStatusCode may be optional, represents an execution progress of an item, and may be based on datatype GDT: ReleaseStatusCode, with a qualifier of Execution. Status/ApprovalStatusCode may be optional, describes whether an approval by a creator of a quote has taken place, and may be based on datatype GDT: ApprovalStatusCode. Status/ReleaseStatusCode may be optional, represents a release of a customer transaction document item for subsequent processes, and may be based on datatype GDT: ReleaseStatusCode.

The following composition relationships to subordinate nodes exist: ItemActualValues, in a 1:C cardinality relationship; ItemBusinessTransactionDocumentReference, in a 1:CN cardinality relationship; and ItemBusinessProcessVariantType, in a 1:N cardinality relationship, which may be filtered. The filter elements are defined by the data type BusinessProcessVariantTypeFilterElements and these elements include BusinessProcessVariantTypeCode, which may be optional, and may be based on datatype GDT: BusinessProcessVariantTypeCode. The following composition relationships to subordinate nodes exist: ItemPeriodTerms, in a 1:CN cardinality relationship; ItemPricingTerms, in a 1:C cardinality relationship; ItemProduct, in a 1:C cardinality relationship; ItemSalesTerms, in a 1:C cardinality relationship; ItemScheduleLine, in a 1:CN cardinality relationship; ItemServiceTerms, in a 1:C cardinality relationship; ItemTotalValues, in a 1:C cardinality relationship; ItemDeliveryTerms, in a 1:C cardinality relationship; ItemInvoiceTerms, in a 1:C cardinality relationship; ItemLocation, in a 1:CN cardinality relationship; and ItemParty, in a 1:CN cardinality relationship, which may be filtered. The filter elements are defined by the data type PartyFilterElements and these elements include RoleCategoryCode and MainIndicator. RoleCategoryCode may be optional and may be based on datatype GDT: PartyRoleCategoryCode. MainIndicator may be optional and may be based on datatype GDT: Indicator.

The following composition relationships to dependent objects exist: Item Accounting Coding Block Distribution, with a cardinality of 1:C, which distributes value changes from a customer transaction document item to coding blocks, whereby the distribution may occur on the basis of amounts or quantities. The distribution of coding blocks can include an identification of the distribution and information that is valid for some or all coding blocks, such as company performing reporting, a date on which the coding blocks are valid, or a quantity-based or amount-based total for which assignments are to be made. The following composition relationships to dependent objects exist: ItemAttachmentFolder, with a cardinality of 1:C, which is a collection of documents attached for an item of a CustomerTransactionDocument; and ItemTextCollection, with a cardinality of 1:C, which is a collection of natural-language texts that refer to an item in a CustomerTransactionDocument.

The following inbound association relationships may exist: CreationIdentity, from the business object Identity/node Identity, with a cardinality of 1:CN, which is an identity of a user that created a Customer Transaction Document Item; Last Change Identity, from the business object Identity/node Identity, with a cardinality of 1:CN, which is an identity of a user that last changed a Customer Transaction Document Item; Child Item, from the business object Sales Order/node Item, with a cardinality of C:CN, which is a child item in an item hierarchy; and Parent Item, from the business object Sales Order/node Item, with a cardinality of C:C, which is a parent item in an item hierarchy. An Item can include other items, thus creating item hierarchies. Items that are a part of an item hierarchy and do not have any further higher-level items are called main items, e.g., root nodes of the hierarchy. All other items are called subitems.

The following are example types of hierarchy relationships: Bill of Material, which is a product with a bill of materials that is mapped in a CustomerTransactionDocumentTemplate as an item hierarchy, where a product itself is mapped as a main item and components of the bill of materials as the subitems; Free Goods—e.g., if free goods are granted for an item, an item hierarchy is generated with subitems which include free goods information; and Sourcing—e.g., if a product used by a customer is not able to be procured, an item hierarchy can be generated for the item, with subitems which include information on substituted products.

A SourcingList inbound association relationship may exist from the business object Sourcing List/node Sourcing List, with a cardinality of C:CN, which is a sourcing list that includes sources of supplies that are valid for a customer transaction document item. The following specialization associations for navigation can exist to the node Item: Price and Tax Calculation Item, with a target cardinality of C, which is an association to an item in the results of price and tax calculation. The following specialization associations for navigation can exist to the node Item Business Process Variant Type: Main Item Business Process Variant Type, with a target cardinality of C, which is an association to a main ItemBusinessProcessVariantType. The following specialization associations for navigation can exist to the node Item Business Transaction Document Reference: Base Item Business Transaction Document Item Reference, with a target cardinality of C, which is an association to a reference that occurs in a specialization and is used as a basis, and for returns where the BaseItemBusinessTransactionDocumentItemReference is either a sales order item or a customer invoice item; Base Item Customer Quote Item Reference, with a target cardinality of C, which is an association to a reference that occurs in an ItemCustomerQuoteItemReference specialization and is used as a basis; Base Item Service Order Item Reference, with a target cardinality of C, which is an association to a reference of an item to Service Order that is used as a basis; BaseItemBusinessTransactionDocumentItemReference, with a target cardinality of C, which is an association to a reference that occurs in a specialization and is used as a basis, and where for returns, the BaseItemBusinessTransactionDocumentItemReference is either a sales order item or a customer invoice item; Item Customer Invoice Item Reference, with a target cardinality of CN, which is an association to a reference that occurs in an ItemCustomerInvoiceItemReference specialization; Item Inbound Delivery Item Reference, with a target cardinality of CN, which is an association to a reference that occurs in an ItemInboundDeliveryItemReference specialization; Item Outbound Delivery Item Reference, with a target cardinality of CN, which is an association to a reference that occurs in an ItemOutboundDeliveryItemReference specialization; Item Purchase Order Item Reference, with a target cardinality of C, which is an association to a reference that occurs in an ItemPurchaseOrderItemReference specialization; Item Sales Order Item Reference, with a target cardinality of CN, which is an association to a reference that occurs in an ItemSalesOrderItemReference specialization; and Item Service Confirmation Item Reference, with a target cardinality of CN, which is an association to a reference that occurs in an ItemServiceConfirmationItemReference specialization.

The following specialization associations for navigation can exist to the node Item Location: Ship From Item Location, with a target cardinality of C, which is an association to a Party that occurs in a ShipFromItemLocation specialization; Ship to Item Location, with a target cardinality of C, which is an association to a party that occurs in a ShipToItemLocation specialization; and Service Point Item Location, with a target cardinality of C, which is an association to a party that occurs in a ServicePointItemLocation specialization.

The following specialization associations for navigation can exist to the node Item Party: Bill to Item Party, with a target cardinality of C, which is an association to a Party that occurs in a BillToItemParty specialization; Buyer Item Party, with a target cardinality of C, which is an association to a Party that occurs in a BuyerItemParty specialization; Employee Responsible Item Party, with a target cardinality of C, which is an association to a party that occurs in an EmployeeResponsibleItemParty specialization; Payer Item Party, with a target cardinality of C, which is an association to a Party that occurs in a PayerItemParty specialization; Product Recipient Item Party, with a target cardinality of C, which is an association to a Party that occurs in a ProductRecipientItemParty specialization; Sales Unit Item Party, with a target cardinality of C, which is an association to a Party that occurs in a SalesUnitItemParty specialization; Seller Item Party, with a target cardinality of C, which is an association to a Party that occurs in a SellerItemParty specialization; Service Execution Team Item Party, with a target cardinality of C, which is an association to a Party that occurs in a specialization ServiceExecutionTeamItemParty; Service Performer Item Party, with a target cardinality of C, which is an association to a Party that occurs in a ServicePerformerItemParty specialization; ContractReleaseAuthorizedItemParty, with a target cardinality of C, which is an association to a Party that occurs in a ContractReleaseAuthorizedItemParty specialization; Tax Reporting Unit Item Party, with a target cardinality of C, which is a party that has a tax reporting unit role category assigned; and Vendor Item Party, with a target cardinality of C, which is an association to a Party that occurs in a VendorItemParty.

The following specialization associations for navigation can exist to the node Item Period Terms Actual Fulfilment Item Period, with a target cardinality of C, which is an association to an ItemPeriodTerms that occurs in an ActualFulfilmentItemPeriodTerms specialization; and Requested Fulfilment Item Period, with a target cardinality of C, which is an association to an ItemPeriodTerms that occurs in a RequestedFulfilmentItemPeriodTerms specialization.

The following specialization associations for navigation can exist to the node Item Schedule Line Confirmed Item Schedule Line, with a target cardinality of CN, which is an association to a Schedule Line that occurs in the ConfirmedItemScheduleLine specialization; Confirmation Relevant Item Schedule Line, with a target cardinality of CN, which is an association to an item schedule line relevant to order confirmation, where confirmation relevant schedule lines occur in a ConfirmedItemScheduleLine or a PromisedItemScheduleLine specialization; First Fulfilled Item Schedule Line, with a target cardinality of C, which is an association to a first ItemScheduleLine that occurs in a FulfilledItemScheduleLine specialization; First Promised Item Schedule Line, with a target cardinality of C, which is an association to a first ScheduleLine that occurs in a PromisedItemScheduleLine specialization; First Simulated Confirmed Item Schedule Line, with a target cardinality of C, which is an association to a first ItemScheduleLine that occurs in a SimulatedConfirmedItemScheduleLine specialization; First Requested Item Schedule Line, with a target cardinality of C, which is an association to a ScheduleLine that occurs in a RequestedItemScheduleLine specialization; Promised Item Schedule Line, with a target cardinality of CN, which is an association to a ScheduleLine that occurs in a PromisedItemScheduleLine specialization; and Requested Item Schedule Line, with a target cardinality of CN, which is an association to an ItemScheduleLine that occurs in a RequestedItemScheduleLine specialization.

The following specialization associations for navigation can exist to the node Sales Order: Parent, with a target cardinality of 1; and Root, with a target cardinality of 1. The following specialization associations for navigation can exist to the node To-Be-Scheduled Item: Invoice Schedule Item, with a target cardinality of C.

In some implementations, the BuyerID and the ID are not changed after an item has been created. In some implementations, the ParentItemID and the HierarchyRelationshipTypeCode are not changed after an item has been created. In some implementations, SystemAdministrativeData is set internally by the system and is not assigned or changed externally. In some implementations, the ParentItemID is not changed after an item has been created. In some implementations, the HierarchyRelationshipTypeCode is not changed after an item has been created. In some implementations, the ParentItemID, ParentItemUUID and HierarchyRelationshipTypeCode are set together.

A Cancel action cancels items by setting a cancellation reason. In some implementations, a precondition of the Cancel action is that the Cancel action is allowed only if an item has not been cancelled or completed. The Cancel action can set the status variable ‘CancellationStatus’ to ‘Cancelled’. The Cancel action elements are defined by the data type CustomerTransactionDocumentItemCancelActionElements. These elements include CancellationReasonCode, which may be optional, is a reason for canceling a sales transaction, and may be based on datatype GDT: CancellationReasonCode.

A Cancel Planning Release action cancels the planning release of an item of a CustomerTransactionDocument. In some implementations, a precondition of the Cancel Planning Release action is that the action is valid for items that have a PlanningReleaseStatus of “Released”. The Cancel Planning Release action sets the PlanningReleaseStatus to “Not released”.

A Check Consistency action checks a CustomerTransactionDocument for errors and sets a ConsistencyStatus to either ‘Consistent’ or ‘Inconsistent’. A Check Fulfilment Data Completeness action evaluates if all data needed for fulfilment has been entered and sets a FulfilmentDataCompletenessStatus to either ‘Incomplete’ or ‘Complete’. A Check General Data Completeness action checks for general data completeness. A Check Invoicing Data Completeness action evaluates if all data needed for invoicing has been entered and sets a InvoicingDataCompletenessStatus to either ‘Incomplete’ or ‘Complete’.

A Check Product Availability and Confirm action carries out a new availability check ATP (AvailableToPromise) and transfers confirmed dates, quantities and products from the result of the check. In some implementations, a precondition of the Check Product Availability and Confirm action is that the action is valid for items that are relevant for a logistical process. After the Check Product Availability and Confirm action, confirmed quantities from results of the availability check are placed in one or more schedule lines. In the case of product substitution due to planning aspects availability or discontinued parts, subitems are also created with replaced products. Sourcing called during the availability check returns a ShipFromLocation. The Check Product Availability and Confirm action can influence an ATP Confirmation Status.

A Check Pricing Data Completeness action evaluates if data needed for pricing has been entered and sets a PricingDataCompleteness Status to either ‘Incomplete’ or ‘Complete’. A Confirm Customer Invoice Issue action updates an invoice quantity and sets an Invoicing status according to an update in a Customer Invoice Processing System. The Confirm Customer Invoice Issue action may be performed inside an agent. The Confirm Customer Invoice Issue action sets the Invoice Status according to an update in a Customer Invoice Processing System. Action elements for the Confirm Customer Invoice Issue action are defined by the data type CustomerTransactionDocumentItemConfirmCustomerInvoiceIssueActionElements. These elements include InvoiceProcessingStatusCode, which may be optional, describes a processing progress during invoicing, and may be based on datatype GDT: ProcessingStatusCode, with a qualifier of Invoice.

A Confirm Product Customer Requirement Fulfillment action receives an external status determined by a logistics system and sets a FulfilmentStatus in an item. In some implementations, the Confirm Product Customer Requirement Fulfillment action is always permitted if the processing progress from the logistics system is always received. The Confirm Product Customer Requirement Fulfillment action sets a ‘FulfilmentStatus’ according to a transferred value. Action elements for the Confirm Product Customer Requirement Fulfillment action are defined by the data type CustomerTransactionDocumentItemConfirmProductCustomerRequirementFulfillmentAction Elements. These elements include FulfillmentProcessingStatusCode, which may be optional and may be based on datatype GDT: ProcessingStatusCode. The Confirm Product Customer Requirement Fulfillment action can be used to report a progress of delivery of goods or provision of services.

A Finish Fulfilment Processing action sets a FulfilmentProcessingStatus of an item of a CustomerTransactionDocument to “Finished” and may be valid for items that have a FulfillmentProcessingStatus of “In Process”.

A Notify Of Sales Order Creation action notifies of a creation of a reference to a sales order item, may be valid if either an approval process is not used and an approval status has the value ‘Approval Not Necessary’ or the approval status has the value ‘Approved’, and sets an OrderingProcessingStatus to either ‘In Process’ or “Finished”. A Notify Of Sales Order Deletion action notifies of a deletion of a reference to a sales order item, may be valid if OrderingProcessingStatus is ‘In Process’ or ‘Finished’, and sets an OrderingProcessingStatus to either ‘Not Started’ or ‘In Process’. A Notify Of Product Availability Confirmation Update action changes a sales order with availability and reservation information based on changes in fulfilment planning. A Release to Execute action releases an item of a CustomerTransactionDocument for execution, may be valid for items that have an ExecutionReleaseStatus of “Not released”, and sets an ExecutionReleaseStatus to “Released”.

A Release to Plan action releases an item of a CustomerTransactionDocument for planning, may be valid for items that have a planning release status of “Not released”, and sets the PlanningReleaseStatus to “Released”. A Revoke Cancellation action undoes the action Cancel, can only be carried out with items that have been cancelled, and changes a ‘CancellationStatus’ status variable from ‘cancelled’ to ‘not cancelled’. A Start Fulfilment Processing action sets a FulfilmentProcessingStatus of an item of a CustomerTransactionDocument to “In Process”, may be valid for items that have a FulfillmentProcessingStatus of “Open”, and sets the FulfillmentProcessingStatus to “In Process”.

ItemActualValues are cumulated data quantities or values of an item in a CustomerTransactionDocument that are derived from a particular business process or a reference document. The elements located directly at the node Item Actual Values are defined by the data type CustomerTransactionDocumentItemActualValuesElements. These elements include: FulfilledQuantity, FulfilledQuantityTypeCode, AcceptedFulfilledQuantity, AcceptedFulfilledQuantityTypeCode, RejectedFulfilledQuantity, RejectedFulfilledQuantityTypeCode, InvoicedQuantity, InvoicedQuantityTypeCode, InvoicedAmount, OrderedQuantity, OrderedQuantityTypeCode, ConfirmedFulfilledQuantity, and ConfirmedFulfilledQuantityTypeCode.

FulfilledQuantity is a cumulated, fulfilled quantity in an item in a Customer Transaction Document document, can be used in a context of order and returns, and may be based on datatype GDT: Quantity, with a qualifier of Fulfilled. FulfilledQuantityTypeCode qualifies a type of a fulfilled quantity, and may be based on datatype GDT: QuantityTypeCode, with a qualifier of Fulfilled. AcceptedFulfilledQuantity is a cumulated, accepted fulfilled quantity in a Customer Transaction Document item, can be used in a context of returns, and may be based on datatype GDT: Quantity, with a qualifier of Fulfilled. AcceptedFulfilledQuantityTypeCode qualifies a type of an accepted fulfilled quantity, and may be based on datatype GDT: QuantityTypeCode, with a qualifier of Fulfilled. RejectedFulfilledQuantity is a cumulated, rejected fulfilled quantity in a Customer Transaction Document item, can be used in a context of returns, and may be based on datatype GDT: Quantity, with a qualifier of Fulfilled. RejectedFulfilledQuantityTypeCode qualifies a type of a rejected fulfilled quantity, and may be based on datatype GDT: QuantityTypeCode, with a qualifier of Fulfilled. InvoicedQuantity is a cumulated, invoiced quantity in a SalesOrder item, and may be based on datatype GDT: Quantity, with a qualifier of Invoiced. InvoicedQuantityTypeCode qualifies a type of an invoiced quantity, and may be based on datatype GDT: QuantityTypeCode, with a qualifier of Invoiced. InvoicedAmount is a cumulated, invoiced amount in a Customer Transaction Document item, and may be based on datatype GDT: Amount, with a qualifier of Invoiced. OrderedQuantity is a cumulated, ordered quantity for a Customer Transaction Document item, can be used in a context of quotes and contracts, and may be based on datatype GDT: Quantity, with a qualifier of Ordered. OrderedQuantityTypeCode qualifies a type of an ordered quantity, and may be based on datatype GDT: QuantityTypeCode, with a qualifier of Ordered. ConfirmedFulfilledQuantity is a cumulated, fulfilled quantity that has been confirmed in a customer transaction document item, and may be based on datatype GDT: Quantity, with a qualifier of Fulfilled. In some implementations, a confirmed fulfilled quantity represents a cumulated, fulfilled quantity of spare parts or services confirmed by a service performer, or materials confirmed by a customer. ConfirmedFulfilledQuantityTypeCode qualifies a type of a confirmed fulfilled quantity, and may be based on datatype GDT: QuantityTypeCode, with a qualifier of Fulfilled.

The following specialization associations for navigation may exist to the node Item: Parent, with a target cardinality of 1. The following specialization associations for navigation may exist to the node Sales Order: Root, with a target cardinality of 1.

An ItemBusinessTransactionDocumentReference is a unique reference between an item in a CustomerTransactionDocument and another business document or another business document item. References can result in business documents or business document items that are linked directly to an item of a CustomerTransactionDocument.

ItemBusinessTransactionDocumentReference can occur in the following specializations: ItemPurchaseOrderItemReference, ItemCustomerQuoteItemReference, ItemSalesOrderItemReference, ItemOutboundDeliveryItemReference, ItemInboundDeliveryItemReference, ItemConfirmedInboundDeliveryItemReference, ItemCustomerInvoiceItemReference, ItemSalesContractItemReference, ItemServiceContractItemReference, ItemServiceConfirmationItemReference, ItemServiceOrderItemReference, ItemCustomerComplaintItemReference, and ItemOpportunityItemReference.

The elements located directly at the node Item Business Transaction Document Reference are defined by the data type CustomerTransactionDocumentItemBusinessTransactionDocumentReferenceElements. These elements include: BusinessTransactionDocumentReference, BusinessTransactionDocumentRelationshipRoleCode, and DataProviderIndicator. BusinessTransactionDocumentReference includes a unique reference to a different business document or to an item of a different business document, and may be based on datatype GDT: BusinessTransactionDocumentReference. BusinessTransactionDocumentRelationshipRoleCode may be optional, is a coded representation of a role that a referenced business document or item of a referenced business document adopts in a reference relationship, and may be based on datatype GDT: BusinessTransactionDocumentRelationshipRoleCode. DataProviderIndicator specifies whether a business document provides data for a referenced business document, and may be based on datatype GDT: Indicator, with a qualifier of DataProvider.

The following composition relationships to subordinate nodes exist: ItemBusinessTransactionDocumentReferenceActualValues, in a 1:C cardinality relationship. The following inbound association relationship may exist: CustomerContract, from the business object Customer Contract/node Customer Contract, with a cardinality of C:CN; Customer Quote, from the business object Customer Quote/node Customer Quote, with a cardinality of C:CN, which is a CustomerQuote that is referenced through specialisation ItemCustomerQuoteItemReference; Opportunity, from the business object Opportunity/node Opportunity, with a cardinality of C:CN, which is an opportunity that is referenced through specialisation ItemOpportunityItemReference; SalesOrder, from the business object Sales Order/node Sales Order, with a cardinality of C:CN, which is a SalesOrder that is referenced through specialisation ItemSalesOrderItemReference; and ServiceConfirmation, from the business object Service Confirmation/node Service Confirmation, with a cardinality of C:CN, which is a ServiceConfirmation that is referenced through specialisation ItemServiceConfirmationitemReference.

The following specialization associations for navigation may exist: Parent, to the node Item, with a target cardinality of 1; and Root, to the node Sales Order, with a target cardinality of 1 In some implementations, an ItemBusinessTransactionDocumentReference includes a CustomerTransactionDocument's direct neighbors. The following associations from a referenced business transaction document items are used by listed projections of a CustomerTransactionDocument_Template: for Service Order—CustomerQuote, OutboundDelivery, CustomerInvoice, ServiceContract, ServiceConfirmation, ServiceOrder, and CustomerComplaint; for Service Confirmation—SalesOrder, OutboundDelivery, CustomerInvoice, and ServiceOrder; for Sales Order—PurchaseOrder, CustomerQuote, SalesOrder, OutboundDelivery, CustomerInvoice, ServiceConfirmation, and Opportunity; for Customer Quote—CustomerQuote, SalesOrder, and Opportunity; and for Customer Return—SalesOrder, InoundDelivery, and CustomerInvoice.

ItemBusinessTransactionDocumentReferenceActualValues includes data quantities and values of a reference of a CustomerTransactionDocument to a different document that is replicated from the referenced document. The elements located directly at the node Item Business Transaction Document Reference Actual Values are defined by the data type CustomerTransactionDocumentItemBusinessTransactionDocumentReferenceActualValuesElements. These elements include: QuantityRoleCode, Quantity, AmountRoleCode, Amount, TimePointRoleCode, and TimePoint. QuantityRoleCode may be optional, is a coded representation of a role of a quantity, and may be based on datatype GDT: QuantityRoleCode. Quantity is a non-monetary numeral specification of a quantity in a unit of measure, and may be based on datatype GDT: Quantity. AmountRoleCode may be optional, is a coded representation of a role of an amount, and may be based on datatype GDT: AmountRoleCode. Amount is an amount with a corresponding currency unit, and may be based on datatype GDT: Amount. TimePointRoleCode is a coded representation of a role of a time, and may be based on datatype GDT: TimePointRoleCode. TimePoint is a unique time point in a specific time context. A time point can be defined by means of a time and date value, as well as by a time zone, and may be based on datatype GDT: TimePoint. A DateTime representation can be used. The following specialization associations for navigation may exist: Parent, to the node Item Business Transaction Document Reference, with a target cardinality of 1; and Root, to the node Sales Order, with a target cardinality of 1.

ItemBusinessProcessVariantType defines a character of a business process variant of an item of a CustomerTransactionDocument. ItemBusinessProcessVariantType represents a typical way of processing an item of a CustomerTransactionDocument in a process component from a business point of view. The elements located directly at the node Item Business Process Variant Type are defined by the data type CustomerTransactionDocumentItemBusinessProcessVariantTypeElements. These elements include: BusinessProcessVariantTypeCode and MainIndicator. BusinessProcessVariantTypeCode is a coded representation of a business process variant type of a Customer Transaction Document item; and may be based on datatype GDT: BusinessProcessVariantTypeCode. MainIndicator is an type that specifies whether a current BusinessProcessVariantTypeCode is a main indicator, and may be based on datatype GDT: Indicator, with a qualifier of Main. The following specialization associations for navigation may exist: Parent, to the node Item, with a target cardinality of 1; and Root, to the node Sales Order, with a target cardinality of 1.

ItemDeliveryTerms are item-specific agreements that apply for a delivery of goods and/or provision of services in a CustomerTransactionDocument. The elements located directly at the node Item Delivery Terms are defined by the data type CustomerTransactionDocumentItemDeliveryTermsElements. These elements include: DeliveryPriorityCode, Incoterms, PartialDeliveryControlCode, QuantityTolerance, and DeliveryItemGroupID. DeliveryPriorityCode may be optional, is a coded representation of priority/urgency of delivery, and may be based on datatype GDT: PriorityCode, with a qualifier of Delivery. Incoterms includes conventional contract formulations for delivery terms, and may be based on datatype GDT: Incoterms. PartialDeliveryControlCode may be optional, is a coded representation of partial delivery control, specifies whether a customer permits partial deliveries and in what form, and may be based on datatype GDT: PartialDeliveryControlCode. QuantityTolerance may be optional, is a tolerated difference between a requested and actual delivery quantity in percentage form, and may be based on datatype GDT: QuantityTolerance. DeliveryItemGroupID may be optional, is a unique identifier for a DeliveryGroup in which one or more items are combined for joint delivery, and may be based on datatype GDT: BusinessTransactionDocumentItemGroupID. The following specialization associations for navigation may exist: Parent, to the node Item, with a target cardinality of 1; and Root, to the node Sales Order, with a cardinality of 1.

In some implementations, ItemDeliveryTerms are set as defaults from DeliveryTerms and can be changed. In some implementations, DeliveryControlCode field values ‘full delivery’ and ‘one-off delivery on required delivery date’ result in the PartialDeliveryNumber field being set to the same value. In some implementations, DeliveryControlCode field values ‘full delivery’ and ‘one-off delivery’ at a document level header result in all items being part of a joint delivery group. In some implementations, DeliveryControlCode field value ‘Complete delivery’ and the QuantityTolerances field are mutually exclusive and in such implementations, it is not recommended that quantity tolerances be maintained at the same time complete delivery is set. In some implementations, with a DeliveryControlCode field value of ‘partial delivery’, the PartialDeliveryNumber attribute can be used to further restrict a number of partial deliveries.

ItemInvoiceTerms are item-specific agreements that apply for invoicing goods and services in a CustomerTransactionDocument. The elements located directly at the node Item Invoice Terms are defined by the data type CustomerTransactionDocumentItemInvoiceTermsElements. These elements include: ProposedInvoiceDate, ProposedInvoiceDateDateCalculationFunctionReference, ToBeInvoicedQuantity, and ToBeInvoicedQuantityTypeCode. ProposedInvoiceDate may be optional, is a date on which an invoice is proposed to be created with a rule for automatic scheduling, and may be based on datatype GDT: Date, with a qualifier of Invoice. ProposedInvoiceDateDateCalculationFunctionReference may be optional, is a date rule for determining a proposed price date, and may be based on datatype GDT: DateCalculationFunctionReference. ToBeInvoicedQuantity is a quantity of a product to be invoiced, and may be based on datatype GDT: Quantity, with a qualifier of ToBeInvoiced. ToBeInvoicedQuantityTypeCode qualifies a type of quantity to be invoiced, and may be based on datatype GDT: QuantityTypeCode, with a qualifier of ToBeInvoiced. The following specialization associations for navigation may exist: Parent, to the node Item, with a target cardinality of 1; and Root, to the node Sales Order, with a target cardinality of 1. In some implementations, ItemInvoiceTerms are proposed from InvoiceTerms and can be changed.

An ItemLocation is a place to which and from which goods are delivered/supplied or where a service is provided. ItemLocation can occur in the same specializations as for Location. The elements located directly at the node Item Location are defined by the data type CustomerTransactionDocumentItemLocationElements. These elements include: LocationID, LocationUUID, AddressReference, RoleCode, RoleCategoryCode, and DeterminationMethodCode. LocationID is an identifier of a business object Location, and may be based on datatype GDT: LocationID. LocationUUID is a universally unique identifier of a business object Location, and may be based on datatype GDT: UUID. AddressReference includes information to reference an address of a business object, and may be based on datatype BOIDT: ObjectNodeLocationAddressReference. AddressReference may include AddressReference/AddressHostUUID, AddressReference/AddressHostTypeCode, AddressReference/BusinessObjectTypeCode, AddressReference/InstalledBaseID, AddressReference/InstallationPointID, and AddressReference/PartyKey. AddressReference/AddressHostUUID is a universally unique identifier for an address of a business partner, an organizational unit or its specializations, a business object InstalledBase, or a business object InstallationPoint. AddressReference/AddressHostUUID may be based on datatype GDT: UUID. AddressReference/AddressHostTypeCode may be optional, is a coded representation of an address host type of an address referenced by an AddressUUID or an address included using a Location Address composition, and may be based on datatype GDT: AddressHostTypeCode. AddressReference/BusinessObjectTypeCode may be optional, and is a coded representation of a type of a business object in which an address referenced in a LocationAddressUUID is integrated as a dependent object. AddressReference/BusinessObjectTypeCode may be based on datatype GDT: BusinessObjectTypeCode. AddressReference/InstalledBaseID is an identifier for an installed base that references an address using an AddressUUID, and may be based on datatype GDT: InstalledBaseID. AddressReference/InstallationPointID is an identifier for an installation point that references an address using an AddressUUID, and may be based on datatype GDT: InstallationPointID. AddressReference/PartyKey is an alternative identifier of a party that represents a business partner or an organizational unit that references an address using an AddressUUID. AddressReference/PartyKey may be based on datatype KDT: PartyKey. AddressReference/PartyKey may include AddressReference/PartyKey/PartyTypeCode, which is a coded representation of a type of party, and may be based on datatype GDT: BusinessObjectTypeCode. AddressReference/PartyKey may include AddressReference/PartyKey/PartyID, which is an identifier for a party, and may be based on datatype GDT: PartyID. RoleCode may be optional, is a coded representation of a role of a Node Location in a Customer Transaction Document document, and may be based on datatype GDT: LocationRoleCode. RoleCategoryCode may be optional, is a coded representation of a Role Category of a Node Location in a Customer Transaction Document document, and may be based on datatype GDT: LocationRoleCategoryCode. DeterminationMethodCode may be optional, is a coded representation of a LocationDeterminationMethod, and may be based on datatype GDT: LocationDeterminationMethodCode.

The following inbound aggregation relationships may exist: Address Snapshot, from the business object Address Snapshot/node Root, with a cardinality of C:CN; InstallationPointAddressInformation, from the business object Installation Point/node Address Information, with a cardinality of C:CN, which is an installation point address to which or at which goods are delivered or a service is provided, in the roles ShipFromLocation, ShipToLocation Returns and ServicePoint; Location, from the business object Location/node Location, with a cardinality of C:CN, which is a location to which or at which goods are delivered or a service is provided, in the roles ShipFromLocation, ShipToLocation Returns and ServicePoint; and PartyAddressInformation, from the business object Party/node Address Information, with a cardinality of C:CN, which is AddressInformation of a representative of a Business Partner or Organizational Centre corresponding to an ItemLocation.

The following specialization associations for navigation may exist: Address Snapshot Overview, to the business object Address Snapshot/node Overview, with a target cardinality of C; Parent, to the node Item, with a target cardinality of 1; Root, to the node Sales Order, with a target cardinality of 1. The following specialization associations for navigation may exist to the business object Used Address/node Used Address: Used Address, with a target cardinality of C. An address used for a location can be a referenced address of master data object. A node ID of a node in a master data object can be determined via the PartyTypeCode, AddressHostUUID and AddressHostTypeCode elements that have a composition relationship to a DO address that is to be represented by a TO UsedAddress.

In some implementations, there is either an aggregation or a composition relationship to a dependent object. In some implementations, if there is an aggregation relationship to a business object Location, the LocationID attribute is filled with the ID of a business object Location and other ID fields, e.g., PartyID, InstalledBaseID and InstallationPointID, remain blank. In some implementations, if an address of a party references a BusinessPartner or an OrganisationalCentre, the PartyID attribute is filled with the ID of the Party and other ID fields, e.g., LocationID, InstalledBaseID and InstallationPointID, remain blank. In some implementations, a reference is stored in the AddressUUID attribute. In some implementations, if there is an aggregation relationship to an address of an InstalledBase, the InstalledBaseID attribute is filled with the ID of the InstalledBase and other ID fields, e.g., LocationID, PartyID and InstallationPointID, remain blank. In some implementations, a reference is stored in the AddressUUID InstalledBaseAddressInformationUUID attribute. In some implementations, if there is an aggregation relationship to an address of an InstallationPoint, the InstallationPointID attribute is filled with the ID of the InstallationPoint and other ID fields, e.g., LocationID, PartyID and InstalledBaseID, remain blank. In some implementations, a reference is stored in the AddressUUID attribute. In some implementations, if an address is referenced via the element AddressUUID, then the elements AddressBusinessObjectTypeCode and AddressHostTypeCode are also filled.

An ItemParty is a natural or legal person, organization, organizational unit or group that is involved in a CustomerTransactionDocument in a PartyRole. ItemParty can occur in the same specializations as those in the node Party. In some implementations, ItemParty does not occur in the specialization VendorParty. The elements located directly at the node Item Party are defined by the data type CustomerTransactionDocumentItemPartyElements. These elements include: PartyKey, PartyUUID, RoleCategoryCode, RoleCode, AddressReference, DeterminationMethodCode, and MainIndicator. PartyKey is an identifier for a party in a PartyRole in a business document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. PartyUUID is a unique identifier for a business partner, organizational unit, or associated specializations, and may be based on datatype GDT: UUID. RoleCategoryCode may be optional, is a coded representation of a category of a party in a business document, and may be based on datatype GDT: PartyRoleCategoryCode. RoleCode may be optional, represents a party role of a party in a business document, and may be based on datatype GDT: PartyRoleCode. AddressReference is information used to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator is an indicator that specifies whether a current BusinessProcessVariantTypeCode is a main code, and may be based on datatype GDT: Indicator, with a qualifier of Main.

The following composition relationships to subordinate nodes can exist: ItemPartyContactParty, with a cardinality of 1:CN. The following inbound aggregation relationships may exist: Address Snapshot, from the business object Address Snapshot/node Root, with a cardinality of C:CN; and Party, from the business object Party/node Party, with a cardinality of C:CN, which is a referenced party in Master Data. The following specialization associations for navigation can exist: Address Snapshot Overview, to the business object Address Snapshot/node Overview, with a target cardinality of C; Parent, to the node Item, with a target cardinality of 1; Main Party Contact Party, to the node Item Party Contact Party, with a target cardinality of C, which is an association to a PartyContact that occurs in a MainPartyContactParty specialization; Root, to the node Sales Order, with a target cardinality of 1; and UsedAddress, to the business object Used Address/node Used Address, with a target cardinality of C.

In some implementations, ItemBuyerParty and an associated ContactParty do not deviate in a party node from the BuyerParty. In some implementations, ItemPayerParty and an associated ContactParty do not deviate in the party node from the PayerParty. In some implementations, ItemSalesUnitParty does not deviate in the party node from the SalesUnitParty. In some implementations, the BuyerParty is not changed after a document has been created. In some implementations, the PayerParty is not be changed after being created. In some implementations, there is one aggregation relationship to a business partner, an organizational unit, or associated specializations. In some implementations, if the PartyUUID exists, the PartyTypeCode also exists. In some implementations, Parties are referenced via the Transformed Object Party that represents at least one of the following business objects: Company, SalesUnit, ServiceUnit, ReportingLineUnit, Supplier, Customer, Employee, or BusinessPartner.

An ItemPartyContactParty is a natural person or organizational unit that can be contacted for a respective ItemParty. A contact can be a contact person or a secretariat, for example. Communication data can be available for the contact. The elements located directly at the node Item Party Contact Party are defined by the data type CustomerTransactionDocumentItemPartyContactPartyElements. These elements include: PartyKey, PartyUUID, AddressReference, DeterminationMethodCode, and MainIndicator. PartyKey is an identifier for a contact party in a customer transaction document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. In some implementations, if a business partner or organizational unit are referenced, the PartyID attribute includes associated identifiers. PartyUUID is a unique identifier for a business partner, organizational unit or associated specializations, and may be based on datatype GDT: UUID. AddressReference includes information to reference an address of a Party, and may be based on datatype GDT: PartyAddressReference. DeterminationMethodCode may be optional is a coded representation of a PartyDeterminationMethod, and may be based on datatype GDT: PartyDeterminationMethodCode. MainIndicator may be optional, specifies whether a PartyContactParty is emphasized in a number of contacts with a same PartyRole, and may be based on datatype GDT: Indicator, with a qualifier of Main.

The following inbound aggregation relationships may exist: Address Snapshot, from the business object Address Snapshot/node Root, with a cardinality of C:CN; and Party, from the business object Party/node Party, with a cardinality of C:CN, which includes referenced Party in Master Data. The following specialization associations for navigation may exist: Address Snapshot Overview, to the business object Address Snapshot/node Overview, with a target cardinality of C; Parent, to the node Item Party, with a target cardinality of 1; Root, to the node Sales Order, with a target cardinality of 1; and Used Address, to the business object Used Address/node Used Address, with a target cardinality of C. An address used for a Party can be: 1) a referenced address of a master data object; or 2) a PartyAddress used via a composition relationship. A determination can be made regarding which of the two cases applies by means of the PartyAddressHostTypeCode element, e.g., an instance of the TO UsedAddress represents such an address. In the first case mentioned above, a node ID of a node in the master data object can be determined via the PartyTypeCode, PartyAddressUUID and PartyAddressHostTypeCode elements.that have a composition relationship to a DO address that is to be represented by a TO UsedAddress. Additionally, a TO UsedAddress in an implemented association can be provided with the following information: BusinessObjectTypeCode, BusinessObjectNodeTypeCode and Node ID of a <business object-Node>-Party node. These can be used in case changes to the TO UsedAddress take place. In this case, a master data address can be copied by the TO UsedAddress. Changes can take place to the copy, and a corresponding DO Address can be created at a <business object-Node>Party via a PartyAddress composition relationship. In the second case mentioned above, the TO UsedAddress can be informed of the BusinessObjectTypeCode, BusinessObjectNodeTypeCode and Node ID of an associated <business object-Node>-Party. Additionally, information can be provided indicating that such information is not an example of a referenced address. In this case, the TO UsedAddress represents the DO address used at the <business object-Node>-Party via the PartyAddress composition relationship.

ItemPeriodTerms is a period related agreement for goods and services that can occur at an item level in a CustomerTransactionDocument. Item Period Terms can occur in the following specializations: Requested Fulfilment Item Period Terms and Actual Fulfilment Item Period Terms. A specialization type can be implemented by Type Attribute. The elements located directly at the node Item Period Terms are defined by the data type CustomerTransactionDocumentItemPeriodTermsElements. These elements include: PeriodRoleCode, TimePointPeriod, StartTimePointDateCalculationFunctionReference, and EndTimePointDateCalculationFunctionReference. PeriodRoleCode is a role of a specified period, and may be based on datatype GDT: PeriodRoleCode. TimePointPeriod is a specification of a period, and may be based on datatype GDT: TimePointPeriod. StartTimePointDateCalculationFunctionReference is a reference to a function with which a start point-in-time of a period can be calculated, and may be based on datatype GDT: DateCalculationFunctionReference. EndTimePointDateCalculationFunctionReference is a reference to a function with which an end point-in-time of a period can be calculated, and may be based on datatype GDT: DateCalculationFunctionReference. The following specialization associations for navigation may exist: Parent, to the node Item, with a target cardinality of 1; and Root, to the node Sales Order, with a target cardinality of 1.

ItemPricingTerms are item-specific characteristics used for pricing and value dating goods and services in a CustomerTransactionDocument. The elements located directly at the node Item Pricing Terms are defined by the data type CustomerTransactionDocumentItemPricingTermsElements. These elements include: CurrencyCode, CustomerPricingProcedureDeterminationCode, PriceDateTime, PriceSpecificationCustomerGroupCode, CustomerPriceListTypeCode, CustomerGroupCode, WarrantyGoodwillCode, PriceSpecificationLabourResourceGroupCode, and GrossAmountIndicator. CurrencyCode may be optional, is a currency for valuation of goods and services ordered, and may be based on datatype GDT: CurrencyCode. CustomerPricingProcedureDeterminationCode may be optional, is a customer scheme for determining a pricing procedure proposed by a buyer or an ordering party, and may be based on datatype GDT: CustomerPricingProcedureDeterminationCode. PriceDateTime is a price date used to determine price specifications using a rule for automatic scheduling, and may be based on datatype GDT: LOCALNORMALISED_DateTime, with a qualifier of Price. PriceSpecificationCustomerGroupCode is a group of LabourResources for which same price specifications are valid, and may be based on datatype GDT: PriceSpecificationCustomerGroupCode. CustomerPriceListTypeCode may be optional, is a customer price list type proposed by a buyer or ordering party, and may be based on datatype GDT: CustomerPriceListTypeCode. CustomerGroupCode represents a group of customers for general purposes, such as pricing and statistics, that is proposed by a buyer or ordering party. CustomerGroupCode may be based on datatype GDT: CustomerGroupCode. WarrantyGoodwillCode specifies an extent to which a provision of services or materials are not or are only partially invoiced to a customer in the case of a warranty or compensation, and may be based on datatype GDT: WarrantyGoodwillCode. PriceSpecificationLabourResourceGroupCode represents a group of LabourResources for which same price specifications are valid, and may be based on datatype GDT: PriceSpecificationLabourResourceGroupCode. GrossAmountIndicator may be optional, is an indicator that specifies whether a price and/or value is given as a gross amount that includes taxes, and may be based on datatype GDT: Indicator, with a qualifier of GrossAmount.

The following specialization associations for navigation may exist: Parent, to the node Item, with a target cardinality of 1; and Root, to the node Sales Order, with a target cardinality of 1. In some implementations, a currency and associated elements for currency conversion are not changed at an item-level. In some implementations, a calculation procedure is not changed at an item level. In some implementations, ItemPricingTerms are set as defaults from PricingTerms and can be changed.

ItemProduct is an identification, description and classification of a product material or ServiceProduct in an item. The elements located directly at the node Item Product are defined by the data type CustomerTransactionDocumentItemProductElements. These elements include: ProductKey, ProductInternalID, ProductStandardID, QuantityMeasureUnitCode, QuantityTypeCode, ProductBuyerID, ProductCategoryHierarchyProductCategoryIDKey, PriceSpecificationProductGroupCode, CashDiscountDeductibleIndicator, IdentifiedStockKey, ProductRequirementSpecificationKey, ProductRequirementSpecificationKey/RequirementSpecificationID, ProductRequirementSpecificationVersionUUID, ProductUUID, PricingProductKey, and PricingProductUUID.

ProductKey is a key to identify a product in a customer transaction document item, and may be based on datatype KDT: ProductUnformattedKey. ProductKey may include ProductKey/ProductTypeCode, which is a coded representation of a product type, such as material or service, and may be based on datatype GDT: ProductTypeCode. ProductKey may include ProductKey/ProductidentifierTypeCode, which is a coded representation of a product identifier type, and may be based on datatype GDT: ProductidentifierTypeCode. ProductKey/ProductID is an identifier for a product, and may be based on datatype GDT: NOCONVERSION_ProductID. ProductInternalID is an internal identifier of a product, and may be based on datatype GDT: ProductInternalID. ProductStandardID is a standard ID for a product, and may be based on datatype GDT: ProductStandardID. QuantityMeasureUnitCode may be optional, is a unit of measure in which quantities are used for a product in a Customer Transaction Document, and may be based on datatype GDT: MeasureUnitCode. QuantityTypeCode is a type code in which quantities are used for a product in a Customer Transaction Document, and may be based on datatype GDT: QuantityTypeCode. ProductBuyerID may be optional, is a unique identifier for a product assigned by a buyer, and may be based on datatype GDT: ProductPartyID. ProductCategoryHierarchyProductCategoryIDKey is a key to identify a product category assigned to a product, and may be based on datatype KDT: ProductCategoryHierarchyProductCategoryIDKey. ProductCategoryHierarchyProductCategoryIDKey may include ProductCategoryHierarchyProductCategoryIDKey/ProductCategoryHierarchyID, which is an identifier for a product category hierarchy, and may be based on datatype GDT: ProductCategoryHierarchyID. ProductCategoryHierarchyProductCategoryIDKey may include ProductCategoryHierarchyProductCategoryIDKey/ProductCategoryInternalID, which is an identifier for a product category, and may be based on datatype GDT: ProductCategoryInternalID. PriceSpecificationProductGroupCode is a coded representation of a product group to which a product is assigned and for which specific price specifications apply, and may be based on datatype GDT: PriceSpecificationProductGroupCode. CashDiscountDeductibleIndicator specifies if a discount can be granted for a product, and may be based on datatype GDT: Indicator, with a qualifier of CashDiscountDeductible. IdentifiedStockKey is a key to identify an Identified Stock related to a corresponding material, and may be based on datatype KDT: IdentifiedStockKey. IdentifiedStockKey can include IdentifiedStockKey/MaterialKey, which is a grouping of elements that uniquely identifies a material, a sub-quantity of which is identified by the identified stock. IdentifiedStockKey/MaterialKey may be based on datatype KDT: ProductKey. ProductRequirementSpecificationKey is a key to identify a product requirement specification, and may be based on datatype KDT: RequirementSpecificationKey. ProductRequirementSpecificationKey may include ProductRequirementSpecificationKey/RequirementSpecificationID, which is an identifier for a requirement specification that is unique within a system, and may be based on datatype GDT: RequirementSpecificationID. ProductRequirementSpecificationKey/RequirementSpecificationVersionID is an identifier for a version of a requirement specification, and may be based on datatype GDT: VersionID. The requirements specification describes a collection of requirements for a corresponding product used in a customer transaction document item and also includes corresponding specifications for fulfilling these requirements. In some implementations, the product requirement specification belongs to a corresponding product in a customer transaction document item. ProductRequirementSpecificationVersionUUID is a unique identification of a product requirement specification version, and may be based on datatype GDT: UUID. ProductUUID is a UUID of a product, and may be based on datatype GDT: UUID. PricingProductKey is an identification of a product that is used for Pricing, and may be based on datatype KDT: ProductKey. PricingProductKey may include PricingProductKey/ProductTypeCode, which is a coded representation of a product type such as a material or service, and may be based on datatype GDT: ProductTypeCode. PricingProductKey may include PricingProductKey/ProductidentifierTypeCode, which is a coded representation of a product identifier type, and may be based on datatype GDT: ProductidentifierTypeCode. PricingProductKey may include PricingProductKey/ProductID, which is an identifier for a product, and may be based on datatype GDT: ProductID. PricingProductUUID is a UUID of a product that is used for pricing, and may be based on datatype GDT: UUID.

The following inbound aggregation relationships may exist: Material, from the business object Material/node Material, with a cardinality of C:CN, which denotes a material in a customer transaction document item; Material_V1, from the business object Material/node Material, with a cardinality of C:CN, which is a material in a customer transaction document item; ProductRequirementSpecification, from the business object Product Requirement Specification/node Product Requirement Specification, with a cardinality of C:CN, which denotes a product requirement specification in a customer transaction document item; ServiceProduct, from the business object Service Product/node Service Product, with a cardinality of C:CN, which denotes a service product in a customer transaction document item; and ServiceProduct_V1, from the business object Service Product/node Service Product, with a cardinality of C:CN, which denotes a service product in a customer transaction document item. The following specialization associations for navigation may exist: Parent, to the node Item, with a target cardinality of 1; and Root, to the node Sales Order, with a target cardinality of 1. In some implementations, the ProductTypeCode is determined internally and is not subsequently changed. In some implementations, the elements of the ItemProduct are taken as defaults from a Material or a ServiceProduct and can be subsequently changed.

ItemSalesTerms are item-specific agreements and conditions that apply for selling goods and services in a CustomerTransactionDocument. The elements located directly at the node Item Sales Terms are defined by the data type CustomerTransactionDocumentItemSalesTermsElements. These elements include: IndustrialSectorCode, IndustryClassificationSystemCode, ProductUsageCode, CancellationReasonCode, and ProbabilityPercent. IndustrialSectorCode represents an industrial sector assigned to a buyer ordering party. An industrial sector is a division of an enterprise according to a focus of business activities. IndustrialSectorCode may be based on datatype GDT: IndustrialSectorCode. IndustryClassificationSystemCode is a code for an industry system assigned to a buyer ordering party. An industry system or industry classification system is a systematically structured hierarchy. IndustryClassificationSystemCode may be based on datatype GDT: IndustryClassificationSystemCode. ProductUsageCode defines what a buyer ordering party uses a product for in a current process, and may be based on datatype GDT: ProductUsageCode. CancellationReasonCode is a reason for canceling a sales transaction, can be set by both a buyer and seller, and may be based on datatype GDT: CancellationReasonCode. ProbabilityPercent may be optional, is a probability of a sales order or contract arising from a quote, and may be based on datatype GDT: SMALLNONNEGATIVE_Percent. The following specialization associations for navigation may exist: Parent, to the node Item, with a target cardinality of 1; and Root, to the node Sales Order, with a target cardinality of 1. In some implementations, ItemSalesTerms are set as defaults from the SalesTerms and can subsequently be changed. In some implementations, the following elements are not overwritten on an item: RegionCode, IndustrialSectorCode, IndustryClassificationSystemCode and ProductUsageCode. In some implementations, ConfirmationFixedIndicator is always set.

An ItemScheduleLine is an agreement regarding when products of an item are requested or provided and in what amount. Item Schedule Line can occur in the following specializations: Requested Item Schedule Line, Confirmed Item Schedule Line, Promised Item Schedule Line, and Fulfilled Item Schedule Line. The elements located directly at the node Item Schedule Line are defined by the data type CustomerTransactionDocumentItemScheduleLineElements. These elements include: ID, BuyerID, TypeCode, Quantity, QuantityTypeCode, DateTimePeriod, ProductAvailabilityConfirmationCommitmentCode, UUID, RelatedUUID, and RelatedID.

ID may be optional, is a unique identifier for an ItemScheduleLine assigned by a seller, and may be based on datatype GDT: BusinessTransactionDocumentItemScheduleLineID. BuyerID may be optional, is a unique identifier for an ItemScheduleLine assigned by a buyer, and may be based on datatype GDT: BusinessTransactionDocumentItemScheduleLineID. TypeCode may be optional, is a coded representation of a type of an ItemScheduleLine, such as RequestedScheduleLine, and may be based on datatype GDT: BusinessTransactionDocumentItemScheduleLineTypeCode. In some implementations, for ServiceProductItem, BusinessTransactionDocumentItemScheduleLineTypeCode 1 Requested is allowed. In some implementations, for SparePartItem, BusinessTransactionDocumentItemScheduleLineTypeCodes “1” Requested, “2” Confirmed and “3” Promised are allowed. In some implementations, BusinessTransactionDocumentItemScheduleLineTypeCode “4” Fulfilled is allowed Quantity is a quantity with reference to a TypeCode, and may be based on datatype GDT: Quantity. QuantityTypeCode qualifies a type of a quantity, and may be based on datatype GDT: QuantityTypeCode. DateTimePeriod is a time period with reference to TypeCode, and may be based on datatype GDT: UPPEROPEN_LOCALNORMALISED_DateTimePeriod. ProductAvailabilityConfirmationCommitmentCode defines a binding character of a confirmed quantity and delivery period, and may be based on datatype GDT: ProductAvailabilityConfirmationCommitmentCode. UUID may be an alternative key, is a UUID of a scheduling line, and may be based on datatype GDT: UUID. RelatedUUID is a UUID of a corresponding schedule line that stands in relation to a current schedule line, and may be based on datatype GDT: UUID. RelatedID may be optional, is an identifier of a corresponding schedule line that stands in relation to a current schedule line, and may be based on datatype GDT: BusinessTransactionDocumentItemScheduleLineID.

The following composition relationships to subordinate nodes exist: ItemScheduleLineFulfilmentPlanningPeriod, with a cardinality of 1:CN. The following specialization associations for navigation may exist: Parent, to the node Item, with a target cardinality of 1; Issue Item Schedule Line Fulfilment Planning Period, to the node Item Schedule Line Fulfilment Planning Period, with a target cardinality of C, which is an association to an ItemScheduleLineFulfillmentPlanningDate that occurs in an IssuePeriod specialization; RelatedItemScheduleLine, to node ItemScheduleLine, with a target cardinality of CN, which is an association to the ItemScheduleLine node itself and which specifies a relationship between schedule lines (e.g., an ItemScheduleLine instance can also refer to another ItemSchedule line instance, such as references that indicate which confirmed schedule lines belong to a particular requested schedule line); Positioning Item Schedule Line Fulfilment Planning Period, with a target cardinality of C, which is an association to an ItemScheduleLineFulfillmentPlanningDate that occurs in a PositioningPeriod specialization; and Root, to the node Sales Order, with a target cardinality of 1. In some implementations, a time period for a requested schedule line is proposed from a RequestedFulfilmentPeriod, and can be changed. In some implementations, in service product items, one RequestedScheduleLine is allowed. In some implementations, all ItemScheduleLines for an item use a same unit of measure.

Item Schedule Line Fulfilment Planning Period includes dates for front-end process steps for delivery of goods or provision of services. Item Schedule Line Fulfilment Planning Period can occur in the following specializations: Positioning Item Schedule Line Fulfilment Planning Period and Issue Item Schedule Line Fulfilment Planning Period. The elements located directly at the node Item Schedule Line Fulfilment Planning Period are defined by the data type CustomerTransactionDocumentItemScheduleLineFulfilmentPlanningPeriodElements. These elements include: PeriodRoleCode and DateTimePeriod. PeriodRoleCode is a coded representation of semantics of an ItemScheduleLineFulfillmentPlanningDateTimePeriod, for example ConfirmedProductAvailabilityDateTimePeriod, and may be based on datatype GDT: PeriodRoleCode. DateTimePeriod is a time period with reference to PeriodRoleCode, and may be based on datatype GDT: UPPEROPEN_LOCALNORMALISED_DateTimePeriod. The following specialization associations for navigation may exist: Parent, to the node Item Schedule Line, with a target cardinality of 1; and Root, to the node Sales Order, with a target cardinality of 1.

ItemServiceTerms are item-specific conditions and agreements that apply for the execution of a service. The elements located directly at the node Item Service Terms are defined by the data type CustomerTransactionDocumentItemServiceTermsElements. These elements include: ConfirmationRelevanceIndicator, EmployeeTimeConfirmationRelevanceIndicator, ExpenseReportingConfirmationRelevanceIndicator, ServiceWorkingConditionsCode, ServicePlannedDuration, WarrantyKey, WarrantyUUID, WarrantyValidityPeriod, ResourceID, ResourceUUID, and ProjectTaskUUID. ConfirmationRelevanceIndicator indicates whether an item is relevant for confirmation, and may be based on datatype GDT: Indicator, with a qualifier of Relevance. EmployeeTimeConfirmationRelevanceIndicator may be optional, indicates whether an item is relevant for employee time confirmation, and may be based on datatype GDT: Indicator. ExpenseReportingConfirmationRelevanceIndicator may be optional, indicates whether an item is relevant for confirmation via expense reporting, and may be based on datatype GDT: Indicator. ServiceWorkingConditionsCode indicates working conditions under which a service is to be provided, and may be based on datatype GDT: ServiceWorkingConditionsCode. ServicePlannedDuration may be optional, is a planned duration of service, and may be based on datatype GDT: Duration, with a qualifier of Planned. WarrantyKey is a key to identify a warranty that covers a service, and may be based on datatype KDT: ProductKey. WarrantyKey can include WarrantyKey/ProductID, which is an identifier for a product, and may be based on datatype GDT: ProductID. WarrantyUUID is a unique identifier for a warranty, and may be based on datatype GDT: UUID. WarrantyValidityPeriod is a period specifying a warranty validity, and may be based on datatype GDT: CLOSED_DatePeriod, with a qualifier of WarrantyValidity. ResourceID is a unique identification of a resource that provides a service product, and may be based on datatype GDT: ResourceID. A labour resource can be derived based on a service performer or a service execution team of an item. ResourceUUID is a universal unique identification of a resource providing a service product, and may be based on datatype GDT: UUID. ProjectTaskUUID is a universal unique identifier of a project task a customer transaction document item is assigned to, and may be based on datatype GDT: UUID. A project task represents a task by which a service is executed. In some implementations, an identifier of a project task can be changed until the release of the project task, and in such implementations, the project task identifier is not used as a reference. The following inbound aggregation relationships may exist: Warranty, from the business object Warranty/node Root, with a cardinality of C:CN, which is a warranty that covers a service. The following inbound association relationships may exist: ProjectTask, from the business object Customer Transaction Document View Of Project/node Task, with a cardinality of C:CN; and Resource, from the business object Resource/node Resource, with a cardinality of C:CN, which is a resource providing a service product. The following specialization associations for navigation may exist: Parent, to the node Item, with a target cardinality of 1; and Root, to the node Sales Order, with a target cardinality of 1. In some implementations, the Elements WarrantyID, WarrantyUUID and WarrantyValidityDatePeriod are inherited from node ServiceTerms and are not changeable.

ItemTotalValues are total values for an item resulting from the Item's dependent nodes. Examples include: a total desired delivery quantity or a confirmed quantity of an ItemScheduleLine, item-specific gross and net weight, a volume, a gross and net value and tax amount, and shipment costs. Quantities, weights, volumes, and values can be calculated by accumulation, and dates can be calculated by special logic, such as based on a first date and/or a last date. The elements located directly at the node Item Total Values are defined by the data type CustomerTransactionDocumentItemTotalValuesElements. These elements include: RequestedQuantity, RequestedQuantityTypeCode, ConfirmedQuantity, ConfirmedQuantityTypeCode, LastConfirmedDateTime, GrossWeightMeasure, NetWeightMeasure, VolumeMeasure, NetAmount, NetPrice, TaxAmount, FreightChargeAmount, GrossAmount, NetWithoutFreightChargeAmount, and NetWithoutFreightChargePrice.

RequestedQuantity is a total quantity requested of a Customer Transaction Document item, and may be based on datatype GDT: Quantity, with a qualifier of Requested. RequestedQuantityTypeCode qualifies a type of a requested quantity, and may be based on datatype GDT: QuantityTypeCode, with a qualifier of Requested. ConfirmedQuantity is a total confirmed quantity of a Customer Transaction Document item, and may be based on datatype GDT: Quantity, with a qualifier of Confirmed. ConfirmedQuantityTypeCode qualifies a type of a confirmed quantity, and may be based on datatype GDT: QuantityTypeCode, with a qualifier of Confirmed. LastConfirmedDateTime is a last confirmed date for a Customer Transaction Document item, and may be based on datatype GDT: LOCALNORMALISED_DateTime, with a qualifier of LastConfirmed. GrossWeightMeasure is a total gross weight of a product in a Customer Transaction Document item, and may be based on datatype GDT: Measure, with a qualifier of GrossWeight. NetWeightMeasure is a total net weight of a product in a Customer Transaction Document item, and may be based on datatype GDT: Measure, with a qualifier of NetWeight. VolumeMeasure is a total volume of a product in a Customer Transaction Document item, and may be based on datatype GDT: Measure, with a qualifier of Volume. NetAmount is a net amount of a Customer Transaction Document item, and may be based on datatype GDT: Amount, with a qualifier of Net. NetPrice is a net price of a product in a CustomerTransactionDocumentTemplate item, and may be based on datatype GDT: Price, with a qualifier of Net. TaxAmount is a tax amount of a Customer Transaction Document item, and may be based on datatype GDT: Amount, with a qualifier of Tax. FreightChargeAmount is a freight charge for a Customer Transaction Document item, and may be based on datatype GDT: Amount, with a qualifier of FreightCharge. GrossAmount is a gross amount of a Customer Transaction Document item, and may be based on datatype GDT: Amount, with a qualifier of Gross. NetWithoutFreightChargeAmount is a net value of a Customer Transaction Document item excluding freight charge, and may be based on datatype GDT: Amount, with a qualifier of NetWithoutFreightCharge. NetWithoutFreightChargePrice is a net price of a Customer Transaction Document item excluding freight charge, and may be based on datatype GDT: Price, with a qualifier of NetWithoutFreightCharge. The following composition relationships to subordinate nodes exist: ItemTotalValuesPricingSubtotal, with a cardinality of 1:CN. The following specialization associations for navigation may exist: Parent, to the node Item, with a target cardinality of 1; and Root, to the node Sales Order, with a target cardinality of 1. In some implementations, ItemTotalValues are not changed.

TotalValuesPricingSubtotal is a condition subtotal of a specific type in a total value of items that result from Pricing. The condition subtotals can be freely defined in a configuration for Pricing, and can be transferred together with a code from Pricing. The elements located directly at the node Item Total Values Pricing Subtotal are defined by the data type CustomerTransactionDocumentItemTotalValuesPricingSubtotalElements. These elements include: TypeCode and Amount. TypeCode is a coded representation of a subtotal in a price calculation, and may be based on datatype GDT: PricingSubtotalTypeCode. Amount is a value of a condition subtotal, and may be based on datatype GDT: Amount. The following specialization associations for navigation may exist: Parent, to the node Item Total Values, with a target cardinality of 1; and Root, to the node Sales Order, with a target cardinality of 1. In some implementations, ItemTotalValuesPriceSubtotal is not changed.

Location is a place to which and from which goods are delivered or services are provided/procured. A Location can occur in the following specializations: ShipToLocation (a ShipToLocation is a place to which goods are delivered), ShipFromLocation (a ShipFromLocation is a place from which goods are delivered), and ServicePoint Location (a ServicePoint is a location at which a service is performed). The elements located directly at the node Location are defined by the data type CustomerTransactionDocumentLocationElements. These elements include: LocationID, LocationUUID, AddressReference, RoleCode, RoleCategoryCode, and DeterminationMethodCode. LocationID is an identifier of a business object Location, and may be based on datatype GDT: LocationID. LocationUUID is a universally unique identifier of a business object Location, and may be based on datatype GDT: UUID. AddressReference includes information used to reference an address of a business object, and may be based on datatype BOIDT: ObjectNodeLocationAddressReference. AddressReference can include AddressReference/AddressHostUUID, AddressReference/AddressHostTypeCode, AddressReference/BusinessObjectTypeCode, AddressReference/InstalledBaseID, AddressReference/InstallationPointID, AddressReference/PartyKey, AddressReference/PartyKey/PartyTypeCode, and AddressReference/PartyKey/PartyID. AddressReference/AddressHostUUID is a universally unique identifier for an address of a business partner, an organizational unit, associated specializations, a business object InstalledBase, or a business object InstallationPoint. AddressReference/AddressHostUUID may be based on datatype GDT: UUID. AddressReference/AddressHostTypeCode may be optional, is a coded representation of an address host type of an address referenced by an AddressUUID or an address included using the Location Address composition, and may be based on datatype GDT: AddressHostTypeCode. AddressReference/BusinessObjectTypeCode may be optional, is a coded representation of a type of a business object in which an address referenced in the LocationAddressUUID is integrated as a dependent object, and may be based on datatype GDT: BusinessObjectTypeCode. AddressReference/InstalledBaseID is an identifier for an installed base that references an address using the AddressUUID, and may be based on datatype GDT: InstalledBaseID. AddressReference/InstallationPointID is an identifier for an installation point that references an address using the AddressUUID, and may be based on datatype GDT: InstallationPointID. AddressReference/PartyKey is an alternative identifier of a party that represents a business partner or an organizational unit that references an address using the AddressUUID, and may be based on datatype KDT: PartyKey. AddressReference/PartyKey can include AddressReference/PartyKey/PartyTypeCode, which is a coded representation of a type of party, and may be based on datatype GDT: BusinessObjectTypeCode. AddressReference/PartyKey can include AddressReference/PartyKey/PartyID, which is an identifier for a party, and may be based on datatype GDT: PartyID. RoleCode is a coded representation of a role of a Node Location in a Customer Transaction Document document, and may be based on datatype GDT: LocationRoleCode. RoleCategoryCode may be optional, is a coded representation of a Role Category of a Node Location in a Customer Transaction Document, and may be based on datatype GDT: LocationRoleCategoryCode. DeterminationMethodCode may be optional, is a coded representation of a LocationDeterminationMethod, and may be based on datatype GDT: LocationDeterminationMethodCode.

The following inbound aggregation relationships may exist: Address Snapshot, from the business object Address Snapshot/node Root, with a cardinality of C:CN; InstallationPointAddressInformation, from the business object Installation Point/node Address Information, with a cardinality of C:CN, which is an installation point address to which or at which goods are delivered or a service is provided in the roles ShipFromLocation, ShipToLocation Returns, and ServicePoint; Location, from the business object Location/node Location, with a cardinality of C:CN, which is a location to which or at which goods are delivered or a service is provided in the roles ShipFromLocation, ShipToLocation Returns, and ServicePoint; and PartyAddressInformation, from the business object Party/node Address Information, with a cardinality of C:CN, which includes AddressInformation of a representative of a Business Partner or Organizational Centre corresponding to a Location. The following specialization associations for navigation may exist: Address Snapshot Overview, to the business object Address Snapshot/node Overview, with a target cardinality of C; Parent, to the node Sales Order, with a target cardinality of 1; Root, with a target cardinality of 1; and Used Address, to the business object Used Address/node Used Address, with a target cardinality of C, which can be used for an address used for a Location. The address can be a referenced address of a master data object, or a node ID of a node in a master data object that can be determined via the PartyTypeCode, AddressHostUUID, and AddressHostTypeCode elements and that has a composition relationship to a DO address that is to be represented by a TO UsedAddress.

In some implementations, there is only one aggregation or composition relationship to a dependent object. If there is an aggregation relationship to the business object Location, the LocationID attribute can be filled with the ID of business object Location and other ID fields, such as PartyID, InstalledBaseID, and InstallationPointID can remain blank. In some implementations, if the address of a party is referenced representative of a BusinessPartner or an OrganisationalCentre, the PartyID attribute can be filled with the ID of the Party, and other ID fields, such as LocationID, InstalledBaseID, and InstallationPointID can remain blank, and a reference can be kept in the AddressUUID attribute. In some implementations, if there is an aggregation relationship to an address of an InstalledBase, the InstalledBaseID attribute can be filled with the ID of the InstalledBase, other ID fields, such as LocationID, PartyID, and InstallationPointID can remain blank, and a reference can be kept in the AddressUUID InstalledBaseAddressInformationUUID attribute. In some implementations, If there is an aggregation relationship to an address of an InstallationPoint, the InstallationPointID attribute can be filled with the ID of the InstallationPoint, other ID fields, such as LocationID, PartyID, and InstalledBaseID can remain blank, and a reference can be kept in the AddressUUID attribute. In some implementations, if an address is referenced via the element AddressUUID, then elements AddressBusinessObjectTypeCode and AddressHostTypeCode are also filled.

A Party is a natural or legal person, organization, organizational unit, or group that is involved in a CustomerTransactionDocument in a PartyRole. Party occurs in the following specializations: BuyerParty (a BuyerParty is a party Customer that purchases a product or service and occurs in a role of a buyer or ordering party with whom a contractual agreement is concluded), SellerParty (a SellerParty is a party that sells goods or services and represents a selling company that has a contractual agreement with a BuyerParty), ProductRecipientParty (a ProductRecipientParty is a party Customer, Supplier, or Company to whom goods are delivered or services are provided that fulfills a role of a customer who receives goods or, in case of returns, a vendor or supplying company), VendorParty (a VendorParty is a party Company, Customer or Supplier who delivers goods or provides services and who performs a role of a delivering enterprise or of an external vendor or, in the case of returns, a customer), BillToParty (a BillToParty is a party Customer to whom an invoice for goods or services is sent), PayerParty (a PayerParty is a party Customer that pays for a product or a service), SalesUnitParty (a SalesUnitParty is a party Sales Unit that is responsible for the sales of goods and services), ServiceSupportTeamParty (a ServiceSupportTeamParty is a party Service Unit that is responsible for the processing of service requests and customer complaints as well as the planning and preparation of services), ResponsibleEmployeeParty (a ResponsibleEmployeeParty is a party Employee that is responsible for the processing of sales or services), ServiceExecutionTeamParty (a ServiceExecutionTeamParty is a party Service Unit that is responsible for executing service orders), ServicePerformerParty (a ServicePerformerParty is a party Employee that provides services for a company), ProcessorParty (a ProcessorParty is a party Employee that processes a CustomerTransactionDocumentTemplate document), ContractReleaseAuthorisedParty (a ContractReleaseAuthorisedParty is a party that is authorized to release goods or services from a contract), FreightForwarderParty (a Freight ForwarderParty is a party Business Partner that supplements a service by subcontracting transportation and other associated services), and SalesPartnerParty (a SalesPartnerParty is a party that initiates and implements business transactions for another company).

A Party can be a reference to a business partner or one of its specializations, such as Customer, Supplier, or Employee, or a reference to one of the following specializations of an organizational unit: Company, FunctionalUnit, or ReportingLineUnit. The elements located directly at the node Party are defined by the data type CustomerTransactionDocumentPartyElements. These elements include: PartyKey, PartyUUID, RoleCategoryCode, RoleCode, AddressReference, DeterminationMethodCode, and MainIndicator.

PartyKey is an identifier for a party in a PartyRole in a business document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. If a business partner or organizational unit are referenced, the PartyID attribute can include associated identifiers. If an unidentified identifier is entered, for example by a user, the PartyID attribute can include such an identifier. PartyUUID is a unique identifier for a business partner, organizational unit, or associated specialization, and may be based on datatype GDT: UUID. RoleCategoryCode may be optional, indicates a Party Role Category of a party in a business document, and may be based on datatype GDT: PartyRoleCategoryCode. RoleCode may be optional, indicates a Party Role of a party in a business document, and may be based on datatype GDT: PartyRoleCode. AddressReference includes information to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator specifies whether a <business object-Node>party is emphasized with a same PartyRole in a number of parties, and may be based on datatype GDT: Indicator, with a qualifier of Main.

The following composition relationships to subordinate nodes exist: PartyContactParty, in a 1:CN cardinality relationship. The following inbound aggregation relationships may exist: Address Snapshot, from the business object Address Snapshot/node Root, with a cardinality of C:CN; and Party, from the business object Party/node Party, with a cardinality of C:CN, which is a referenced Party in Master Data. The following specialization associations for navigation can exist: Address Snapshot Overview, to the business object Address Snapshot/node Overview, with a target cardinality of C; Main Party Contact Party, to the node Party Contact Party, with a target cardinality of C, which is an association to a PartyContact that occurs in a MainPartyContactParty specialization; Parent, to the node Sales Order, with a target cardinality of 1; Root, with a target cardinality of 1; and Used Address, to the business object Used Address/node Used Address, with a target cardinality of C.

In some implementations, a BuyerParty is not changed after a document has been created. In some implementations, a PayerParty is not changed once it has been created. In some implementations, there is only one aggregation relationship to a business partner, an organizational unit, or associated specializations. In some implementations, if a PartyUUID exists, a PartyTypeCode also exists. In some implementations, parties are referenced via a Transformed Object Party that represent at least one of the following business objects: Company, SalesUnit, ServiceUnit, ReportingLineUnit, Supplier, Customer, Employee, or BusinessPartner.

A PartyContactParty is a natural person or an organizational unit that can be contacted for a respective party. A contact can be a contact person or a secretariat, for example. Communication data can be available for a contact. The elements located directly at the node Party Contact Party are defined by the data type CustomerTransactionDocumentPartyContactPartyElements. These elements include: PartyKey, PartyUUID, AddressReference, DeterminationMethodCode, and MainIndicator.

PartyKey is an identifier for a contact party in a customer transaction document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. If a business partner or organizational unit are referenced, the PartyID attribute can include corresponding identifiers. PartyUUID is a unique identifier for a business partner, organizational unit or associated specializations, and may be based on datatype GDT: UUID. AddressReference includes information to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator may be optional, specifies whether a PartyContactParty is emphasized in a number of contacts with a same PartyRole, and may be based on datatype GDT: Indicator, with a qualifier of Main. The following inbound aggregation relationships may exist: Address Snapshot, from the business object Address Snapshot/node Root, with a cardinality of C:CN; Party, from the business object Party/node Party, with a cardinality of C:CN, which is a referenced Party in master data. The following specialization associations for navigation may exist: Address Snapshot Overview, to the business object Address Snapshot/node Overview, with a target cardinality of C; Parent, to the node Party, with a target cardinality of 1; Root, to the node Sales Order, with a target cardinality of 1; and Used Address, to the business object Used Address/node Used Address, with a target cardinality of C, which is an address used for a Party. The address can be a referenced address of a master data object, or a PartyAddress used via a composition relationship. It is possible to determine which of these two types of addresses apply by means of a PartyAddressHostTypeCode element. If the address is a referenced address, a node ID of a node in a master data object can be determined via PartyTypeCode, PartyAddressUUID and PartyAddressHostTypeCode elements that have a composition relationship to a DO address that is to be represented by a TO UsedAddress. In some implementations, a master data address is copied by a TO UsedAddress, changes take place to the copy, and a corresponding DO Address is created at a Party via a PartyAddress composition relationship. If the address is a PartyAddress, a TO UsedAddress can be informed of a BusinessObjectTypeCode, BusinessObjectNodeTypeCode and Node ID of a Party.

PeriodTerms is a period related agreement for goods and services that can occur in a CustomerTransactionDocument. PeriodTerms can occur in the following specializations with reference to a role of a period PeriodRoleCode: RequestedFulfilmentPeriod; which is a period in which delivery of goods or provision of services are requested; and ValidityPeriod, which is a period during which a CustomerTransactionDocumentTemplate document is valid. The elements located directly at the node Period Terms are defined by the data type CustomerTransactionDocumentPeriodTermsElements. These elements include: PeriodRoleCode, TimePointPeriod, StartTimePointDateCalculationFunctionReference, and EndTimePointDateCalculationFunctionReference. PeriodRoleCode is a role of a specified period, and may be based on datatype GDT: PeriodRoleCode. TimePointPeriod is a specification of a period. The business role of a period can specified by a PeriodRoleCode. TimePointPeriod may be based on datatype GDT: TimePointPeriod. StartTimePointDateCalculationFunctionReference is a reference to a function with which a start point-in-time of a period is calculated, and may be based on datatype GDT: DateCalculationFunctionReference. EndTimePointDateCalculationFunctionReference is a reference to a function with which an end point-in-time of a period is calculated, and may be based on datatype GDT: DateCalculationFunctionReference. The following specialization associations for navigation may exist to the node Sales Order: Parent, with a target cardinality of 1, and Root, with a target cardinality of 1.

PricingTerms are characteristics used for pricing and valuation of goods and services in a CustomerTransactionDocument. The elements located directly at the node Pricing Terms are defined by the data type CustomerTransactionDocumentPricingTermsElements. These elements include: CurrencyCode, CustomerPricingProcedureDeterminationCode, PriceDateTime, PriceSpecificationCustomerGroupCode, CustomerPriceListTypeCode, CustomerGroupCode, WarrantyGoodwillCode, and GrossAmountIndicator. CurrencyCode may be optional, is a currency for a valuation of goods and services ordered document currency, and may be based on datatype GDT: CurrencyCode. CustomerPricingProcedureDeterminationCode may be optional, is a customer scheme for determining a pricing procedure proposed by a buyer or an ordering party, and may be based on datatype GDT: CustomerPricingProcedureDeterminationCode. PriceDateTime is a price date at which price specifications are determined using a rule for automatic scheduling, and may be based on datatype GDT: LOCALNORMALISED_DateTime, with a qualifier of Price. PriceSpecificationCustomerGroupCode is a group of customers for whom same price specifications apply that are suggested by a buyer or ordering party, and may be based on datatype GDT: PriceSpecificationCustomerGroupCode. CustomerPriceListTypeCode may be optional, is a customer price list type proposed by a buyer or ordering party, and may be based on datatype GDT: CustomerPriceListTypeCode. CustomerGroupCode is a group of customers for general purposes, such as pricing and statistics, that is proposed by a buyer or ordering party, and may be based on datatype GDT: CustomerGroupCode. WarrantyGoodwillCode specifies an extent to which a provision of services or materials are not or are only partially invoiced to a customer in the case of a warranty or compensation, and may be based on datatype GDT: WarrantyGoodwillCode. GrossAmountIndicator may be optional, is an indicator that specifies whether a price and/or value is given as a gross amount including taxes, and may be based on datatype GDT: Indicator, with a qualifier of GrossAmount. The following specialization associations for navigation may exist: Parent, to the node Sales Order, with a target cardinality of 1; and Root, to the node Sales Order, with a target cardinality of 1. In some implementations, exchange rate elements ExchangeRate are set together.

SalesTerms are agreements and conditions applicable for a sale of goods and services in a CustomerTransactionDocument. The elements located directly at the node Sales Terms are defined by the data type CustomerTransactionDocumentSalesTermsElements. These elements include: IndustrialSectorCode, IndustryClassificationSystemCode, ProductUsageCode, CancellationReasonCode, and ProbabilityPercent. IndustrialSectorCode is an industrial sector assigned to a buyer ordering party. An industrial sector is a division of enterprises according to a focus of business activities. IndustrialSectorCode may be based on datatype GDT: IndustrialSectorCode. IndustryClassificationSystemCode represents an industry system assigned to a buyer ordering party. An industry system or industry classification system is a systematically structured hierarchy, and may be based on datatype GDT: IndustryClassificationSystemCode. ProductUsageCode defines what a buyer ordering party uses a product for in a current process, and may be based on datatype GDT: ProductUsageCode. CancellationReasonCode is a reason for canceling a sales transaction, can be set by both a buyer or seller, and may be based on datatype GDT: CancellationReasonCode. ProbabilityPercent may be optional, is a probability of a sales order or contract arising from a quote, and may be based on datatype GDT: SMALLNONNEGATIVE_Percent, with a qualifier of Probability. The following specialization associations for navigation may exist to the node Sales Order: Parent, with a target cardinality of 1; and Root, with a target cardinality of 1.

TimePointTerms is a point-in-time related agreement for goods and services that can occur in a CustomerTransactionDocument. TimePointTerms can occur in the following specializations with reference to a role of a point-in-timeTimePointRoleCode: FirstReactionDueTimePoint, which is a point-in-time by which a response to a newly-received service request or service order is requested; CompletionDueTimePoint, which is a point-in-time by which a service request or service order is to be fully processed; RequestInitialReceiptTimePoint, which is a point-in-time when a request is first received; RequestReceiptTimePoint, which is a point-in-time when a request is received or updated; RequestInProcessAtTimePoint, which is a point-in-time when a request is put in process; RequestFinishedAtTimePoint, which is a point-in-time when a processing of a request is finished; RequestClosedAtTimePoint, which is a point-in-time when a request is considered as being finally closed; RequestSentToProviderAtTimePoint, which is a point-in-time when a request is forwarded to a provider; RequestCompletionByProviderDueTimePoint, which is a point-in-time by which a provider is to complete the processing of a request; RequestReceivedFromProviderAtTimePoint, which is a point-in-time by which a provider has completed the processing of a request; CompletionTimePoint, which is a point-in-time by which a customer transaction document is completed; ExecutionReleaseTimePoint, which is a point-in-time at which a customer transaction document is released for execution; Actual Arrival At Customer Time Point, which is an actual point of time at which a service performer arrived at a customer; Planned Arrival At Customer Time Point, which is a time point at which a service performer is planned to arrive at a customer; and Incident Completion Time Point, which is a time point at which an incident is completed.

The elements located directly at the node Time Point Terms are defined by the data type CustomerTransactionDocumentTimePointTermsElements. These elements include: TimePointRoleCode, TimePoint, and DateCalculationFunctionReference. TimePointRoleCode is a role of a specified point-in-time, and may be based on datatype GDT: TimePointRoleCode. TimePoint is a specification of a point-in-time. A business role of the point-in-time can be specified by the TimePointRoleCode. TimePoint may be based on datatype GDT: TimePoint. DateCalculationFunctionReference is a reference to a function with which a point-in-time is calculated, and may be based on datatype GDT: DateCalculationFunctionReference. The following specialization associations for navigation may exist to the node Sales Order: Parent, with a target cardinality of 1; and Root, with a target cardinality of 1.

TotalValues are cumulated total values that occur in a CustomerTransactionDocument, for example, a total gross and net weight, volume, gross and net amount, tax amount, or freight costs. Quantities, weights, volumes and values can be calculated by accumulation, and dates can be calculated by special logic. The elements located directly at the node Total Values are defined by the data type CustomerTransactionDocumentTotalValuesElements. These elements include: GrossWeightMeasure, NetWeightMeasure, GrossVolumeMeasure, GrossAmount, NetAmount, TaxAmount, FreightChargeAmount, NetWithoutFreightChargeAmount, LastPromisedDateTime, LastConfirmedDateTime, NextAuthorisationDateTime, and ServicePlannedDuration. GrossWeightMeasure is a total gross weight in a customer transaction document, and may be based on datatype GDT: Measure, with a qualifier of GrossWeight. NetWeightMeasure is a the total net weight in a Customer Transaction Document document, and may be based on datatype GDT: Measure, with a qualifier of NetWeight. GrossVolumeMeasure is a total gross volume in a Customer Transaction Document, and may be based on datatype GDT: Measure, with a qualifier of GrossVolume. GrossAmount is a total gross amount in a Customer Transaction Document document, and may be based on datatype GDT: Amount, with a qualifier of Gross. NetAmount is a total net amount in a Customer Transaction Document, and may be based on datatype GDT: Amount, with a qualifier of Net. TaxAmount is a total tax amount in a Customer Transaction Document, and may be based on datatype GDT: Amount, with a qualifier of Tax. FreightChargeAmount indicates total freight charges in a Customer Transaction Document document, and may be based on datatype GDT: Amount, with a qualifier of FreightCharge. NetWithoutFreightChargeAmount is a total net amount excluding freight charges, and may be based on datatype GDT: Amount, with a qualifier of NetWithoutFreightCharge. LastPromisedDateTime is a last promised date in a Customer Transaction Document document, and may be based on datatype GDT: LOCALNORMALISED_DateTime, with a qualifier of LastPromised. LastConfirmedDateTime is a last confirmed date in a Customer Transaction Document document, and may be based on datatype GDT: LOCALNORMALISED_DateTime, with a qualifier of LastConfirmed. NextAuthorisationDateTime is a time point when a next authorisation is due for a customer transaction document, may be based on datatype GDT: LOCALNORMALISED_DateTime, with a qualifier of Authorisation, and may be calculated as a lesser of a time when an authorisation expires or when an item for delivery is next due for authorisation in a current authorisation horizon. ServicePlannedDuration may be optional, is a total planned duration of services in a customer transaction document, and may be based on datatype GDT: Duration, with a qualifier of Planned. The following composition relationships to subordinate nodes exist: TotalValuesPricingSubtotal, with a cardinality of 1:CN. The following specialization associations for navigation exist to the node Sales Order: Parent, with target cardinality of 1; and Root, with a target cardinality of 1. In some implementations, TotalValues are not changed externally.

TotalValuesPricingSubtotal is a condition subtotal of a specific type in the total value of all items that result from Pricing. Condition subtotals can be freely defined in a configuration for Pricing, and can be transferred together with a code from Pricing. The elements located directly at the node Total Values Pricing Subtotal are defined by the data type CustomerTransactionDocumentTotalValuesPricingSubtotalElements. These elements include: TypeCode and Amount. TypeCode is a coded representation of a subtotal in a price calculation, and may be based on datatype GDT: PricingSubtotalTypeCode. Amount is a value of a condition subtotal, and may be based on datatype GDT: Amount. The following specialization associations for navigation exist: Root, to the node Sales Order, with a target cardinality of 1; and Parent, to the node Total Values, with a target cardinality of 1.

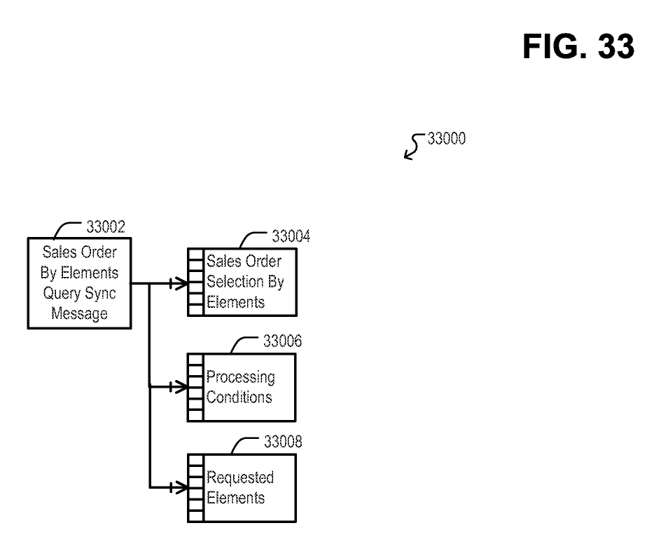

FIG. 33 illustrates one example logical configuration of a Sales Order By Elements Query Sync message 33000. Specifically, this figure depicts the arrangement and hierarchy of various components such as one or more levels of packages, entities, and datatypes, shown here as 33002 through 33008. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Sales Order By Elements Query Sync message 33000 includes, among other things, the Sales Order Selection By Elements entity 33004. Accordingly, heterogeneous applications may communicate using this consistent message configured as such.

The message type Sales Order By Elements Query_sync is derived from the business object Sales Order as a leading object together with its operation signature. The message type Sales Order By Elements Query_sync is a query about sales order by elements. The structure of the message type Sales Order By Elements Query_sync is determined by the message data type SalesOrderByElementsQueryMessage_sync. The message data type SalesOrderByElementsQueryMessage_sync includes typing data type for a sales order read request. The message data type SalesOrderByElementsQueryMessage_sync includes the SalesOrderSelectionByElements package, the ProcessingConditions package, and the RequestedElements package.

The package SalesOrderSelectionByElements includes the entity SalesOrderSelectionByElements. SalesOrderSelectionByElements includes the following non-node elements: SelectionByID, InclusionExclusionCode, IntervalBoundaryTypeCode, LowerBoundaryID, UpperBoundaryID, SelectionByBuyerPartyID, LowerBoundaryPartyID, UpperBoundaryPartyID, SelectionByItemListCustomerOrderLifeCycleStatusCode, LowerBoundaryItemListCustomerOrderLifeCycleStatusCode, UpperBoundaryItemListCustomerOrderLifeCycleStatusCode, SelectionByName, LowerBoundaryName, UpperBoundaryName, SelectionByBuyerID, SelectionByPostingDate, LowerBoundaryDateTime, UpperBoundaryDateTime, SelectionByDataOriginTypeCode, LowerBoundaryDataOriginTypeCode, UpperBoundaryDataOriginTypeCode, SelectionByItemListExecutionReleaseStatusCode, LowerBoundaryReleaseStatusCode, UpperBoundaryReleaseStatusCode, SelectionByApprovalStatusCode, LowerBoundaryApprovalStatusCode, UpperBoundaryApprovalStatusCode, SelectionByEmployeeResponsiblePartyID, LowerBoundaryPartyID, UpperBoundaryPartyID, SelectionBySalesUnitPartyID, SelectionBySalesAndServiceBusinessAreaSalesOrganisationID, LowerBoundaryOrganisationalCentreID, UpperBoundaryOrganisationalCentreID, SelectionBySalesAndServiceBusinessAreaDistributionChannelCode, LowerBoundarySalesAndServiceBusinessAreaDistributionChannelCode, UpperBoundarySalesAndServiceBusinessAreaDistributionChannelCode, SelectionByServicePerformerPartyID, SelectionByServiceExecutionTeamPartyID, SelectionByProductID, LowerBoundaryProductID, UpperBoundaryProductID, SelectionByProductRequirementSpecificationID, LowerBoundaryRequirementSpecificationID, UpperBoundaryRequirementSpecificationID, and SelectionByLastChangedDate.

SelectionByID may have a multiplicity of 0 . . . * and may be based on datatype MIDT:SalesOrderByElementsQuerySelectionByID. InclusionExclusionCode may have a multiplicity of 0 . . . 1 and may be based on datatype BGDT:InclusionExclusionCode. IntervalBoundaryTypeCode may have a multiplicity of 1 and may be based on datatype BGDT:IntervalBoundaryTypeCode. LowerBoundaryID may have a multiplicity of 0 . . . 1 and may be based on datatype BGDT:BusinessTransactionDocumentID. UpperBoundaryID may have a multiplicity of 0 . . . 1 and may be based on datatype BGDT:BusinessTransactionDocumentID. SelectionByBuyerPartyID may have a multiplicity of 0 . . . * and may be based on datatype MIDT:SalesOrderByElementsQuerySelectionByPartyID. LowerBoundaryPartyID may have a multiplicity of 0 . . . 1 and may be based on datatype BGDT:PartyID. UpperBoundaryPartyID may have a multiplicity of 0 . . . 1 and may be based on datatype BGDT:PartyID. SelectionByItemListCustomerOrderLifeCycleStatusCode may have a multiplicity of 0 . . . * and may be based on data type MIDT:SalesOrderByElementsQuerySelectionByStatushemListCustomerOrderLifeCycleStatusCode. LowerBoundaryhemListCustomerOrderLifeCycleStatusCode may have a multiplicity of 0 . . . 1 and may be based on datatype BGDT:CustomerOrderLifeCycleStatusCode. UpperBoundaryItemListCustomerOrderLifeCycleStatusCode may have a multiplicity of 0 . . . 1 and may be based on datatype BGDT:CustomerOrderLifeCycleStatusCode. SelectionByName may have a multiplicity of 0 . . . * and may be based on data type MIDT:SalesOrderByElementsQuerySelectionByName. LowerBoundaryName may have a multiplicity of 0 . . . 1 and may be based on datatype CDT:MEDIUM_Name. UpperBoundaryName may have a multiplicity of 0 . . . 1 and may be based on datatype CDT:MEDIUM_Name. SelectionByBuyerID may have a multiplicity of 0 . . . * and may be based on data type MIDT:SalesOrderByElementsQuerySelectionByID. SelectionByPostingDate may have a multiplicity of 0 . . . * and may be based on data type MIDT:SalesOrderByElementsQuerySelectionByDateTime. LowerBoundaryDateTime may have a multiplicity of 0 . . . 1 and may be based on datatype CDT:GLOBAL_DateTime. UpperBoundaryDateTime may have a multiplicity of 0 . . . 1 and may be based on datatype CDT:GLOBAL_DateTime. SelectionByDataOriginTypeCode may have a multiplicity of 0 . . . * and may be based on data type MIDT:SalesOrderByElementsQuerySelectionByDataOriginTypeCode. LowerBoundaryDataOriginTypeCode may have a multiplicity of 0 . . . 1 and may be based on datatype BGDT:CustomerTransactionDocumentDataOriginTypeCode. UpperBoundaryDataOriginTypeCode may have a multiplicity of 0 . . . 1 and may be based on datatype BGDT:CustomerTransactionDocumentDataOriginTypeCode. SelectionByItemListExecutionReleaseStatusCode may have a multiplicity of 0 . . . * and may be based on data type MIDT:SalesOrderByElementsQuerySelectionByReleaseStatusCode. LowerBoundaryReleaseStatusCode may have a multiplicity of 0 . . . 1 and may be based on datatype BGDT:ReleaseStatusCode. UpperBoundaryReleaseStatusCode may have a multiplicity of 0 . . . 1 and may be based on datatype BGDT:ReleaseStatusCode. SelectionByApprovalStatusCode may have a multiplicity of 0 . . . * and may be based on data type MIDT:SalesOrderByElementsQuerySelectionByApprovalStatusCode. LowerBoundaryApprovalStatusCode may have a multiplicity of 0 . . . 1 and may be based on datatype BGDT:ApprovalStatusCode. UpperBoundaryApprovalStatusCode may have a multiplicity of 0 . . . 1 and may be based on datatype BGDT:ApprovalStatusCode. SelectionByEmployeeResponsiblePartyID may have a multiplicity of 0 . . . * and may be based on data type MIDT:SalesOrderByElementsQuerySelectionByPartyID. SelectionBySalesUnitPartyID may have a multiplicity of 0 . . . * and may be based on data type MIDT:SalesOrderByElementsQuerySelectionByPartyID. SelectionBySalesAndServiceBusinessAreaSalesOrganisationID may have a multiplicity of 0 . . . * and may be based on data type MIDT:SalesOrderByElementsQuerySelectionByOrganisationalCentreID. LowerBoundaryOrganisationalCentreID may have a multiplicity of 0 . . . 1 and may be based on datatype BGDT:OrganisationalCentreID. UpperBoundaryOrganisationalCentreID may have a multiplicity of 0 . . . 1 and may be based on datatype BGDT:OrganisationalCentreID. SelectionBySalesAndServiceBusinessAreaDistributionChannelCode may have a multiplicity of 0 . . . * and may be based on data type MIDT:SalesOrderByElementsQuerySelectionByDistributionChannelCode. LowerBoundarySalesAndServiceBusinessAreaDistributionChannelCode may have a multiplicity of 1 and may be based on datatype BGDT:DistributionChannelCode. UpperBoundarySalesAndServiceBusinessAreaDistributionChannelCode may have a multiplicity of 0 . . . 1 and may be based on datatype BGDT:DistributionChannelCode. SelectionByServicePerformerPartyID may have a multiplicity of 0 . . . * and may be based on data type MIDT:SalesOrderByElementsQuerySelectionByPartyID. SelectionByServiceExecutionTeamPartyID may have a multiplicity of 0 . . . * and may be based on data type MIDT:SalesOrderByElementsQuerySelectionByPartyID. SelectionByProductID may have a multiplicity of 0 . . . * and may be based on data type MIDT:SalesOrderByElementsQuerySelectionByProductID. LowerBoundaryProductID may have a multiplicity of 0 . . . 1 and may be based on datatype BGDT:NOCONVERSION_ProductID. UpperBoundaryProductID may have a multiplicity of 0 . . . 1 and may be based on datatype BGDT:NOCONVERSION_ProductID. SelectionByProductRequirementSpecificationID may have a multiplicity of 0 . . . * and may be based on data type MIDT:SalesOrderByElementsQuerySelectionByProductRequirementSpecificationKeyRequirementSpecificationID. LowerBoundaryRequirementSpecificationID may have a multiplicity of 0 . . . 1 and may be based on datatype BGDT:RequirementSpecificationID. UpperBoundaryRequirementSpecificationID may have a multiplicity of 0 . . . 1 and may be based on datatype BGDT:RequirementSpecificationID. SelectionByLastChangedDate may have a multiplicity of 0 . . . * and may be based on data type MIDT:SalesOrderByElementsQuerySelectionByDateTime.

The package ProcessingConditions includes the entity ProcessingConditions. ProcessingConditions is typed by QueryProcessingConditions.

The package RequestedElements includes the entity RequestedElements. RequestedElements includes the salesOrderTransmissionRequestCode attribute, which may have a multiplicity of 0 . . . 1 and may be based on datatype BGDT:TransmissionRequestCode. RequestedElements includes the following non-node elements: SalesOrder, ItemTransmissionRequestCode, SalesAndServiceBusinessAreaTransmissionRequestCode, BillToPartyTransmissionRequestCode, AccountPartyTransmissionRequestCode, PayerPartyTransmissionRequestCode, ProductRecipientPartyTransmissionRequestCode, SalesPartnerPartyTransmissionRequestCode, FreightForwarderPartyTransmissionRequestCode, EmployeeResponsiblePartyTransmissionRequestCode, SellerPartyTransmissionRequestCode, SalesUnitPartyTransmissionRequestCode, ServiceExecutionTeamPartyTransmissionRequestCode, ServicePerformerPartyTransmissionRequestCode, SalesEmployerPartyTransmissionRequestCode, BillFromPartyTransmissionRequestCode, RequestedFulfillmentPeriodPeriodTerms, DeliveryTermsTransmissionRequestCode, PricingTermsTransmissionRequestCode, SalesTermsTransmissionRequestCode, InvoiceTermsTransmissionRequestCode, CashDiscountTermsTransmissionRequestCode, PaymentControlTransmissionRequestCode, PriceAndTaxCalculationTransmissionRequestCode, TextCollectionTransmissionRequestCode, and AttachmentFolderTransmissionRequestCode.

SalesOrder may have a multiplicity of 0 . . . 1 and may be based on data type MIDT: SalesOrderByElementsQueryRequestedElementsSalesOrder. ItemTransmissionRequestCode may have a multiplicity of 0 . . . 1 and may be based on datatype BGDT:TransmissionRequestCode. SalesAndServiceBusinessAreaTransmissionRequestCode may have a multiplicity of 0 . . . 1 and may be based on datatype BGDT:TransmissionRequestCode. BillToPartyTransmissionRequestCode may have a multiplicity of 0 . . . 1 and may be based on datatype BGDT:TransmissionRequestCode. AccountPartyTransmissionRequestCode may have a multiplicity of 0 . . . 1 and may be based on datatype BGDT:TransmissionRequestCode. PayerPartyTransmissionRequestCode may have a multiplicity of 0 . . . 1 and may be based on datatype BGDT:TransmissionRequestCode. ProductRecipientPartyTransmissionRequestCode may have a multiplicity of 0 . . . 1 and may be based on datatype BGDT:TransmissionRequestCode. SalesPartnerPartyTransmissionRequestCode may have a multiplicity of 0 . . . 1 and may be based on datatype BGDT:TransmissionRequestCode. FreightForwarderPartyTransmissionRequestCode may have a multiplicity of 0 . . . 1 and may be based on datatype BGDT:TransmissionRequestCode. EmployeeResponsiblePartyTransmissionRequestCode may have a multiplicity of 0 . . . 1 and may be based on datatype BGDT:TransmissionRequestCode. SellerPartyTransmissionRequestCode may have a multiplicity of 0 . . . 1 and may be based on datatype BGDT:TransmissionRequestCode. SalesUnitPartyTransmissionRequestCode may have a multiplicity of 0 . . . 1 and may be based on datatype BGDT:TransmissionRequestCode. ServiceExecutionTeamPartyTransmissionRequestCode may have a multiplicity of 0 . . . 1 and may be based on datatype BGDT:TransmissionRequestCode. ServicePerformerPartyTransmissionRequestCode may have a multiplicity of 0 . . . 1 and may be based on datatype BGDT:TransmissionRequestCode. SalesEmployerPartyTransmissionRequestCode may have a multiplicity of 0 . . . 1 and may be based on datatype BGDT:TransmissionRequestCode. BillFromPartyTransmissionRequestCode may have a multiplicity of 0 . . . 1 and may be based on datatype BGDT:TransmissionRequestCode. RequestedFulfillmentPeriodPeriodTerms may have a multiplicity of 0 . . . 1 and may be based on datatype BGDT:TransmissionRequestCode. DeliveryTermsTransmissionRequestCode may have a multiplicity of 0 . . . 1 and may be based on datatype BGDT:TransmissionRequestCode. PricingTermsTransmissionRequestCode may have a multiplicity of 0 . . . 1 and may be based on datatype BGDT:TransmissionRequestCode. SalesTermsTransmissionRequestCode may have a multiplicity of 0 . . . 1 and may be based on datatype BGDT:TransmissionRequestCode. InvoiceTermsTransmissionRequestCode may have a multiplicity of 0 . . . 1 and may be based on datatype BGDT:TransmissionRequestCode. CashDiscountTermsTransmissionRequestCode may have a multiplicity of 0 . . . 1 and may be based on datatype BGDT:TransmissionRequestCode. PaymentControlTransmissionRequestCode may have a multiplicity of 0 . . . 1 and may be based on datatype BGDT:TransmissionRequestCode. PriceAndTaxCalculationTransmissionRequestCode may have a multiplicity of 0 . . . 1 and may be based on datatype BGDT:TransmissionRequestCode. TextCollectionTransmissionRequestCode may have a multiplicity of 0 . . . 1 and may be based on datatype BGDT:TransmissionRequestCode. AttachmentFolderTransmissionRequestCode may have a multiplicity of 0 . . . 1 and may be based on datatype BGDT:TransmissionRequestCode.

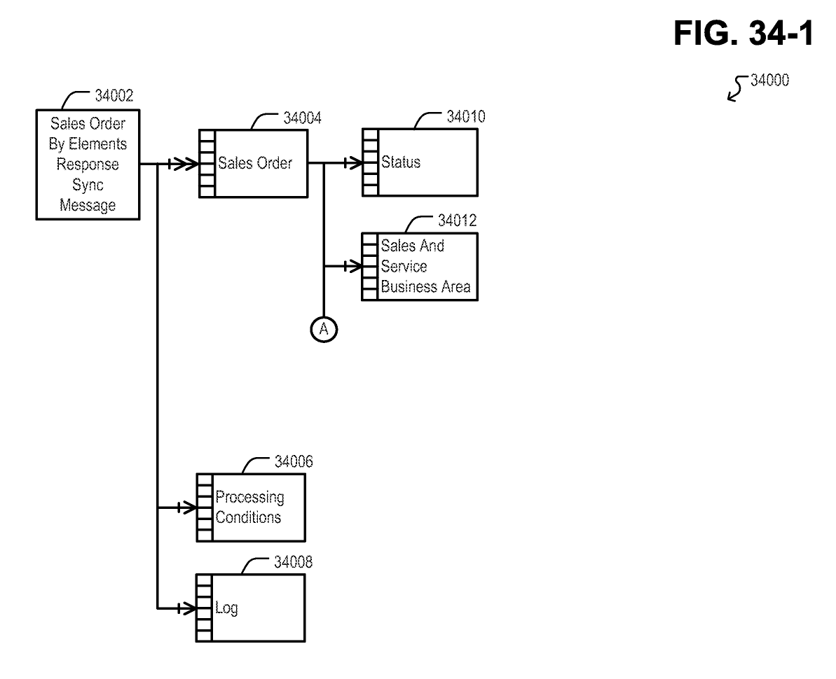

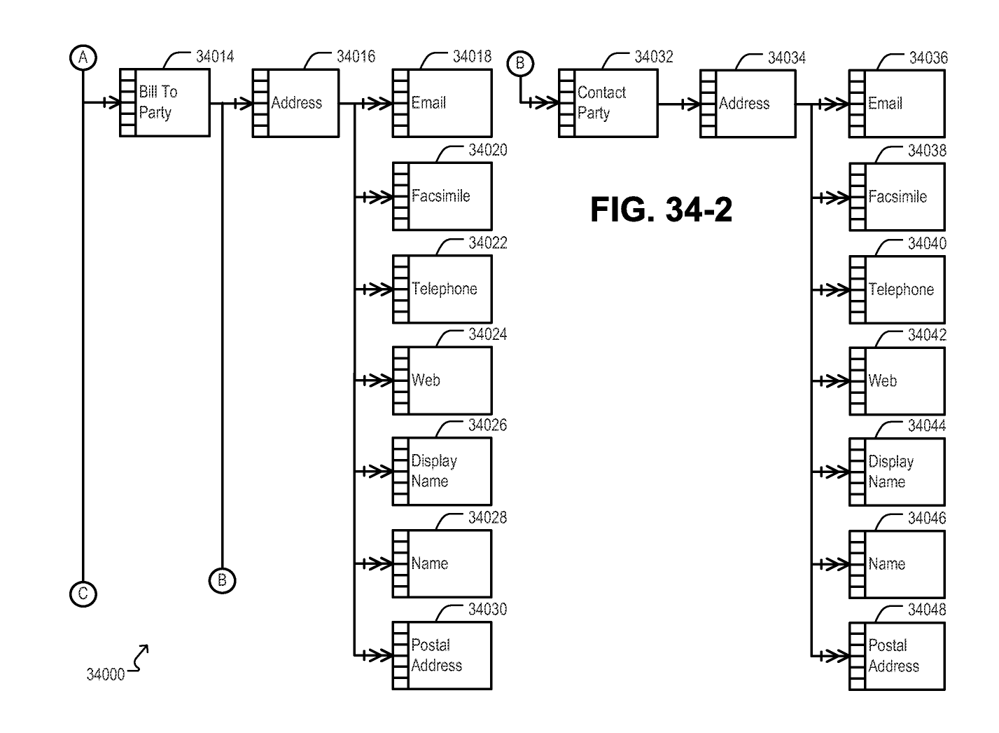

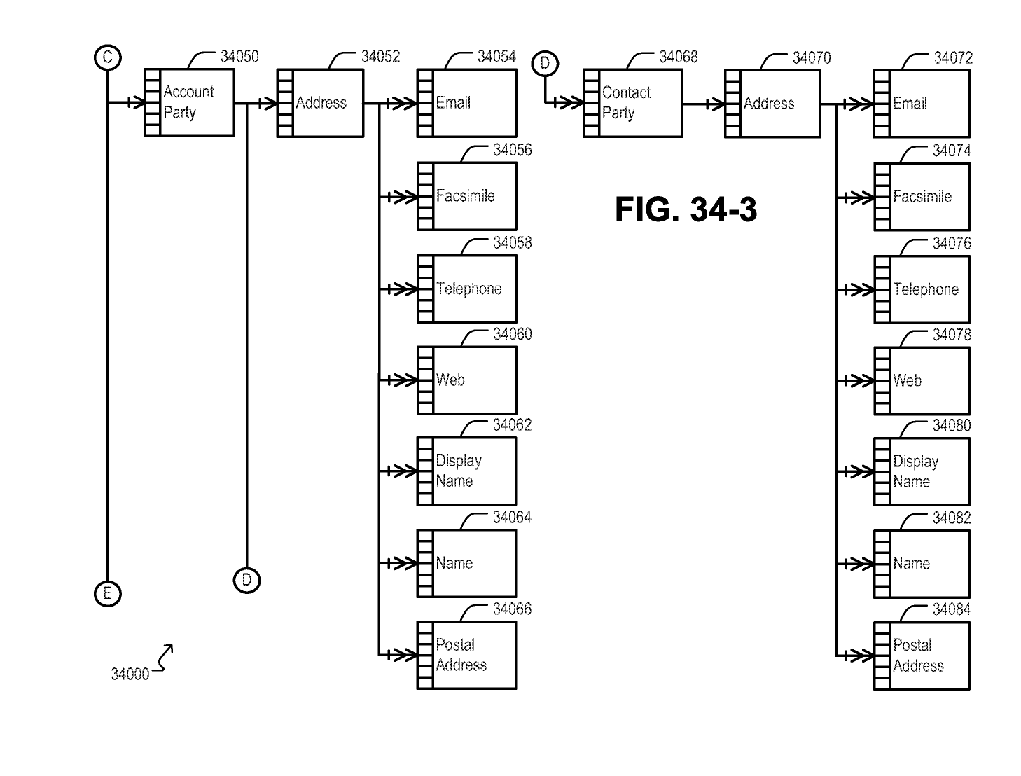

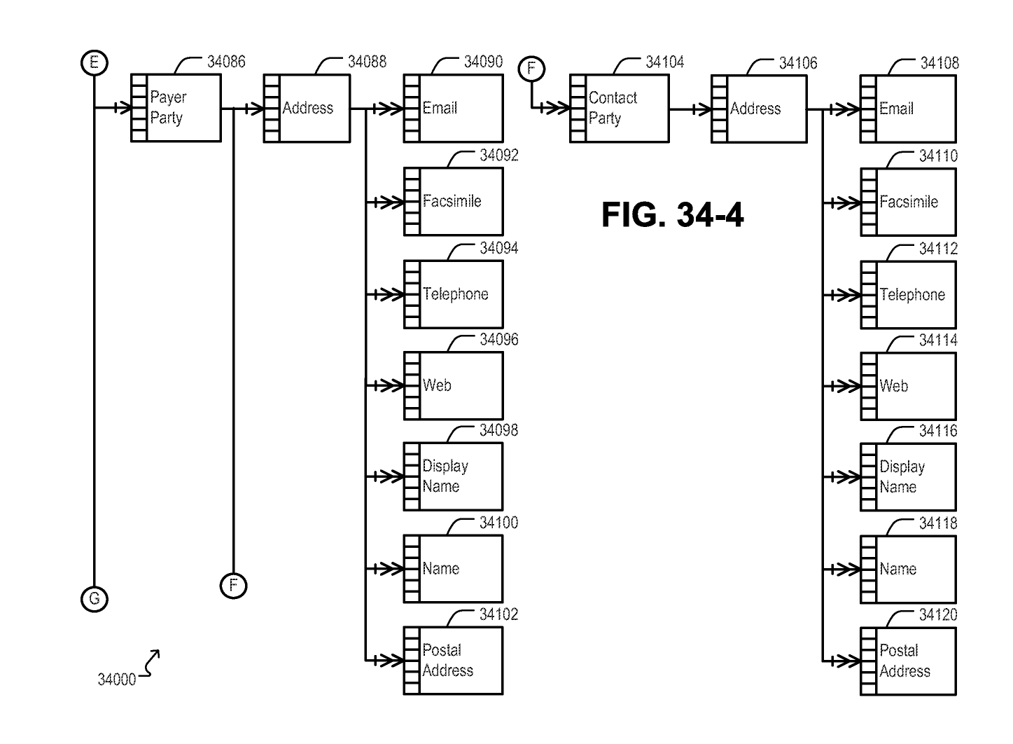

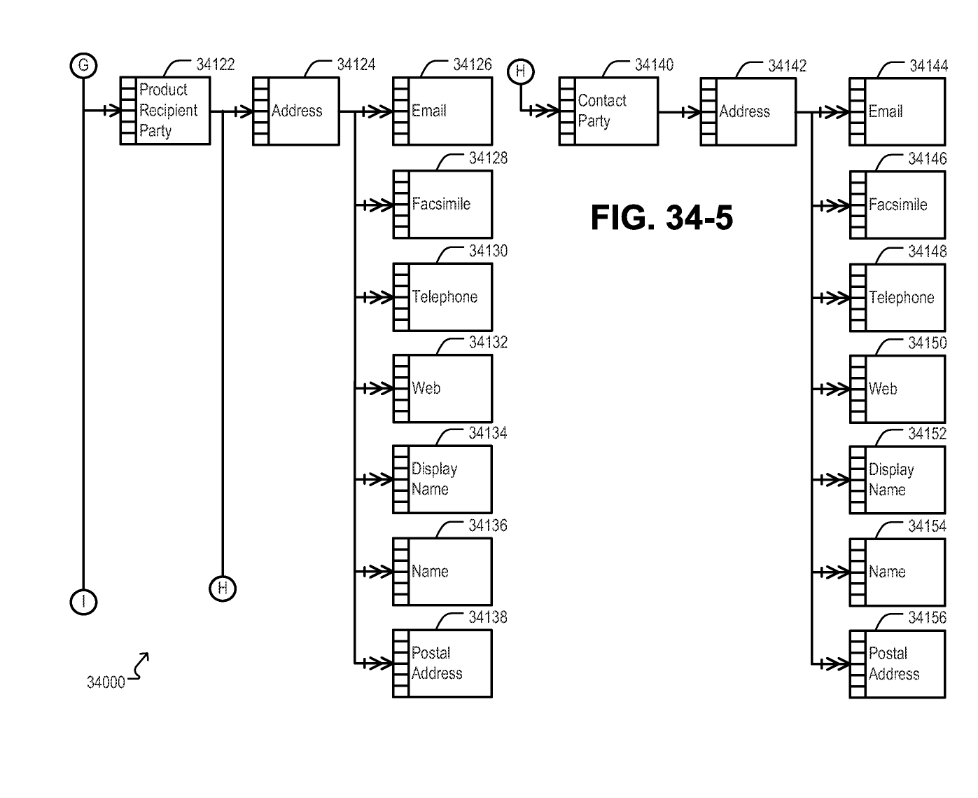

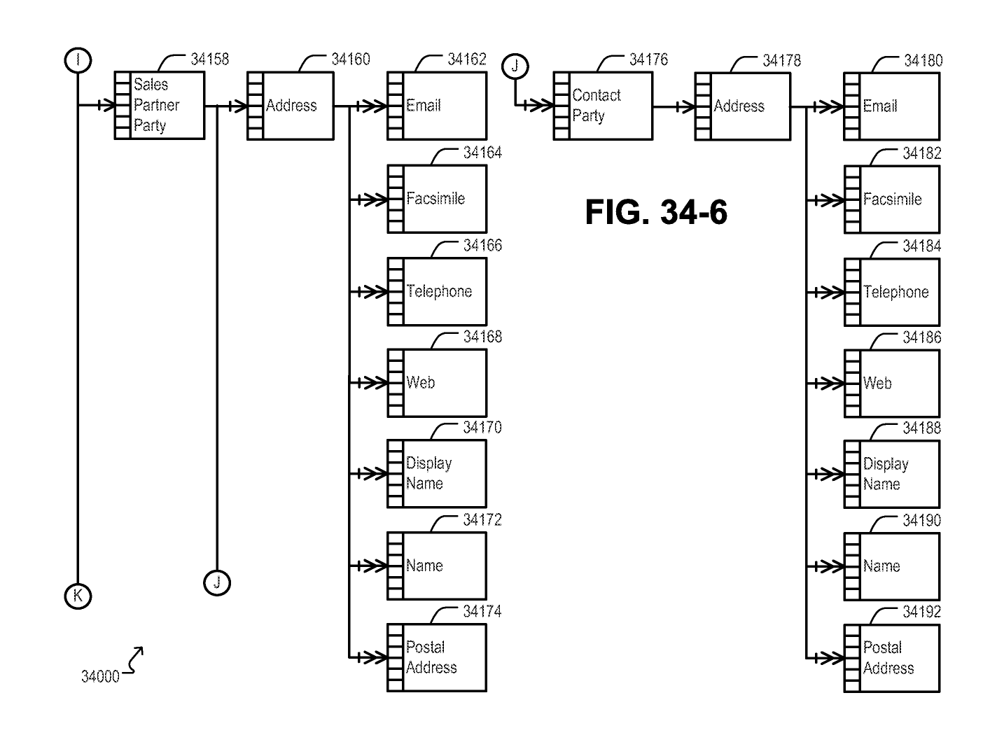

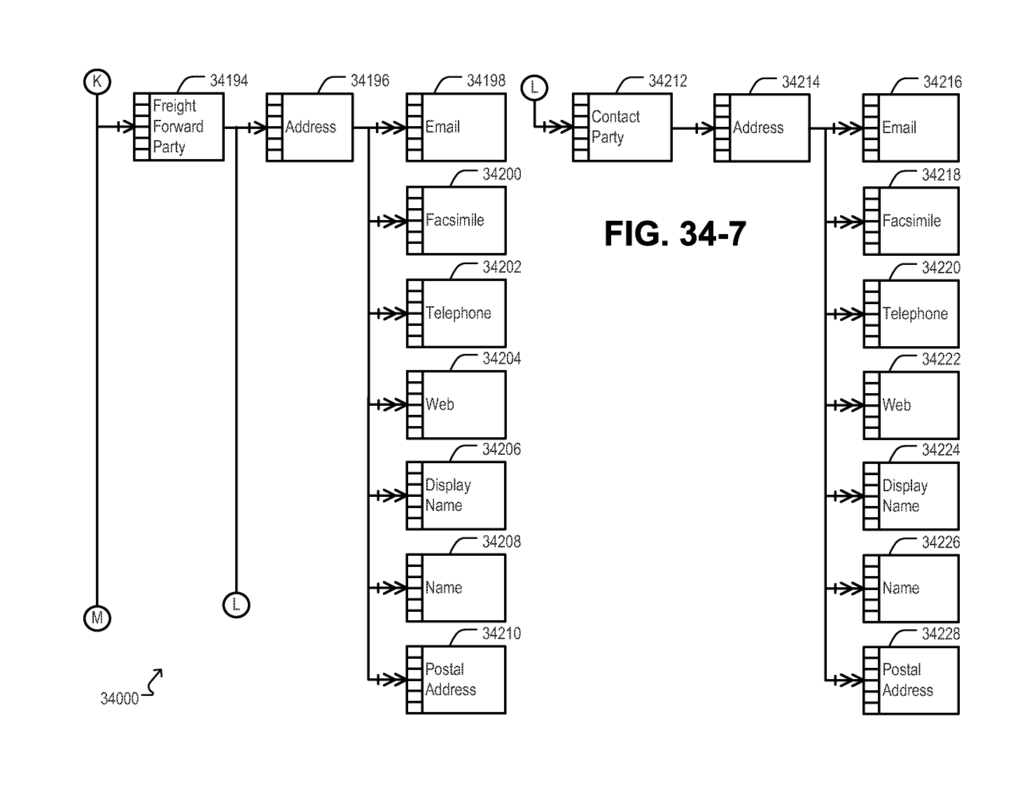

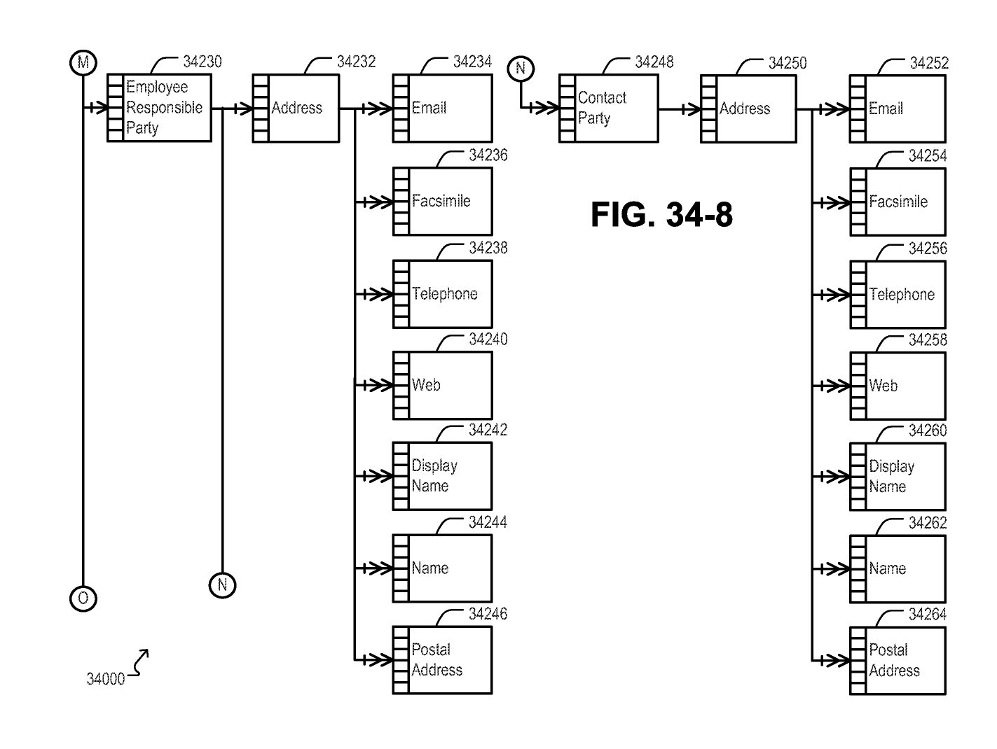

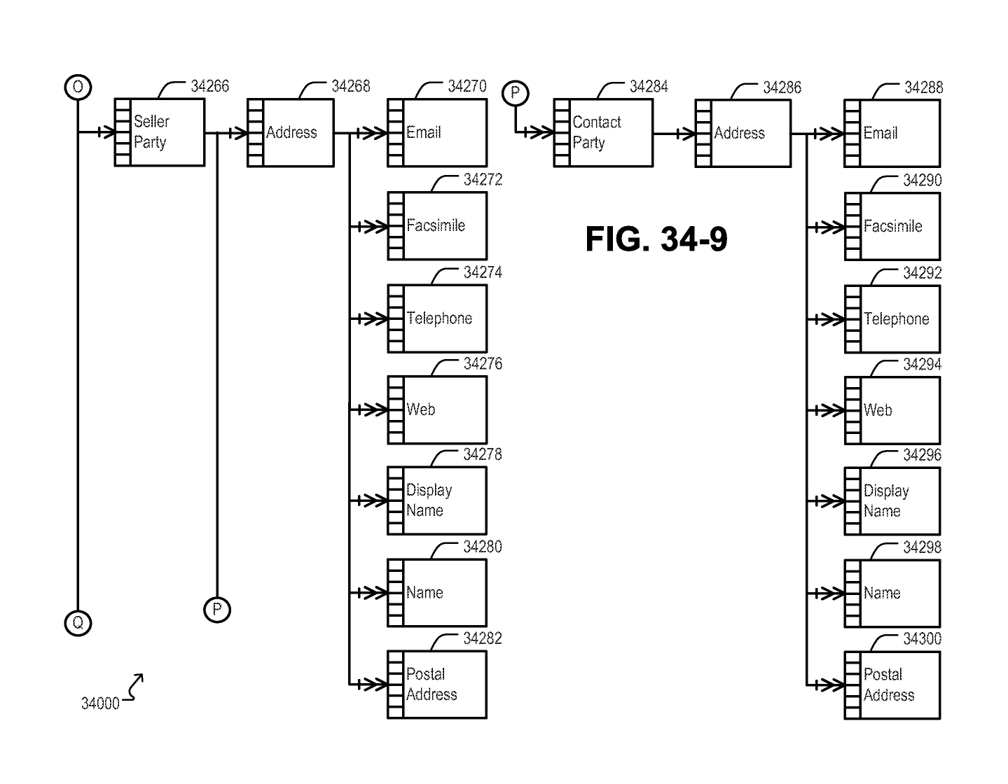

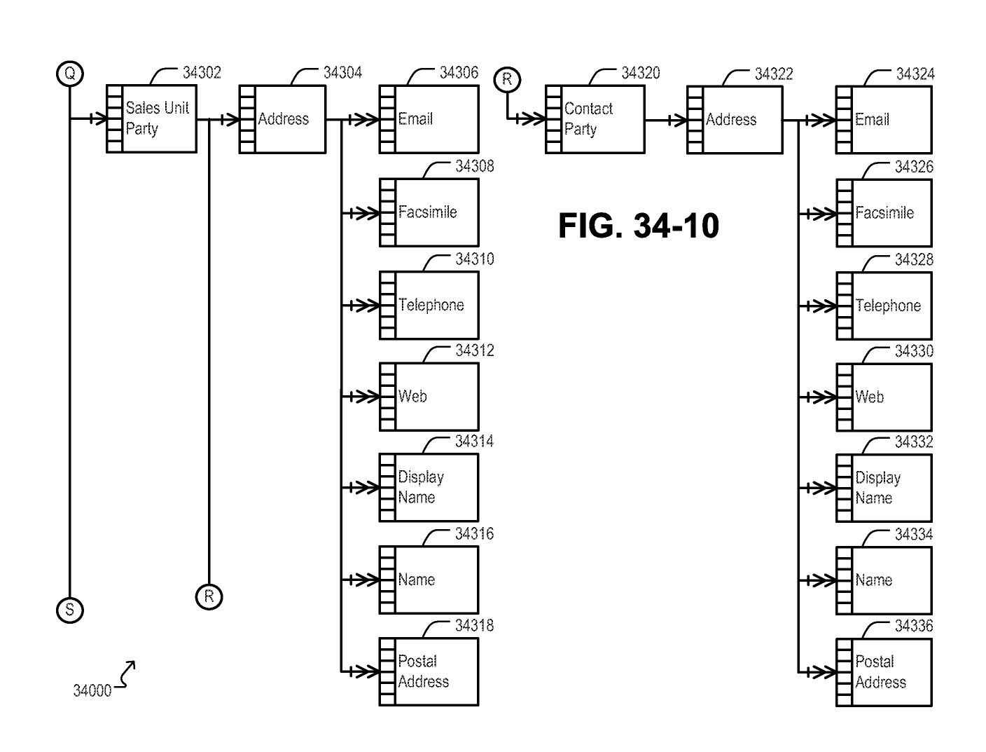

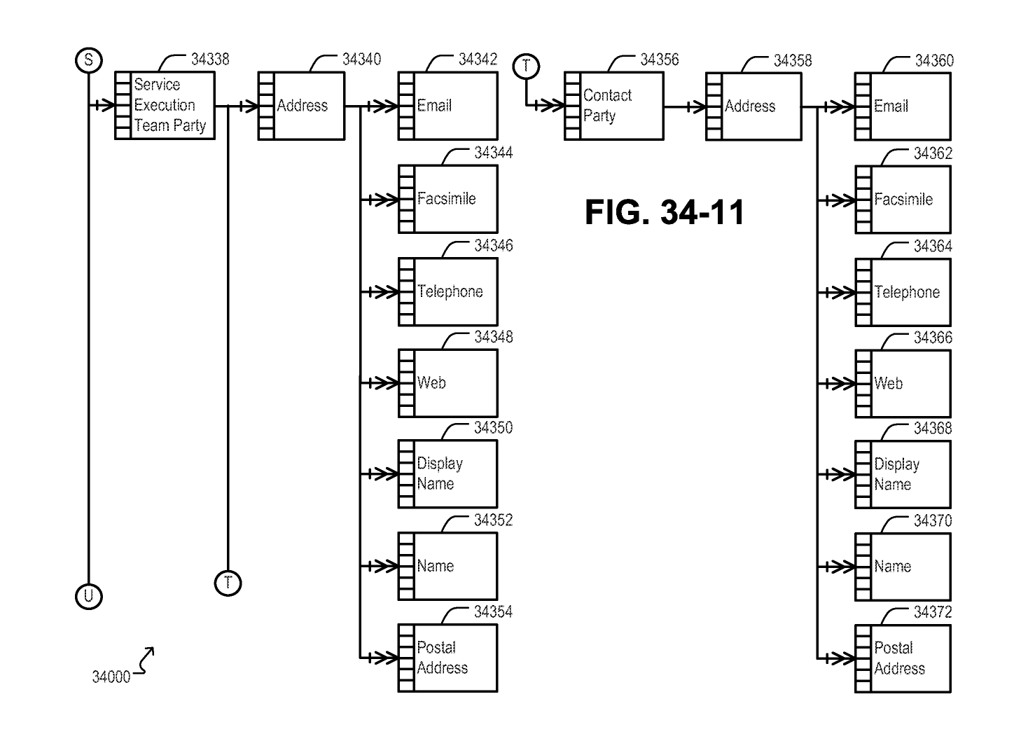

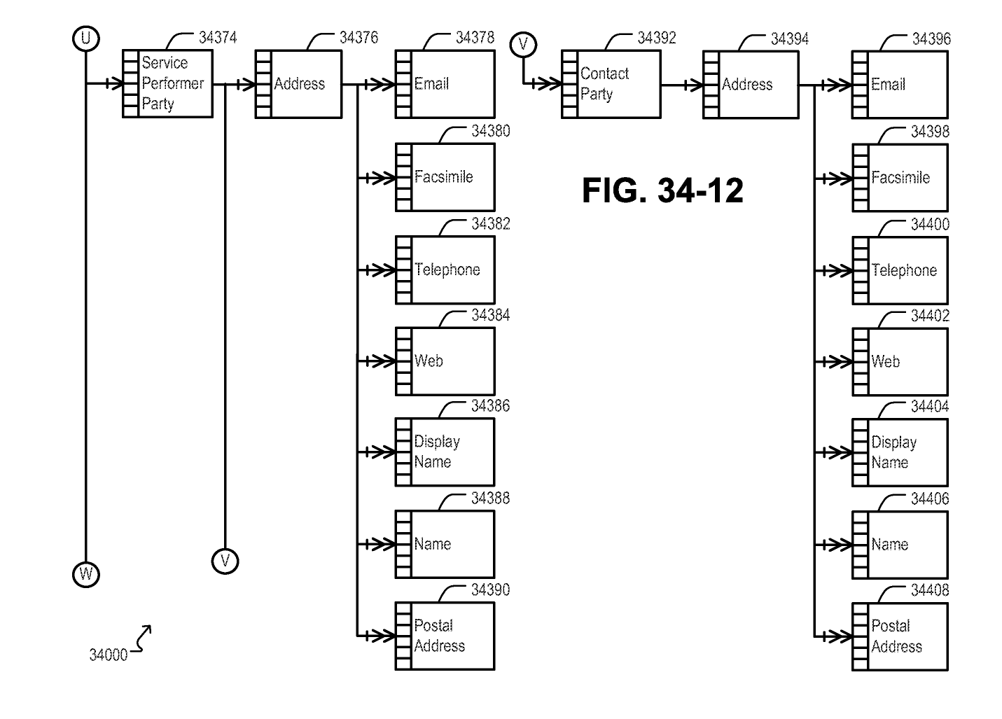

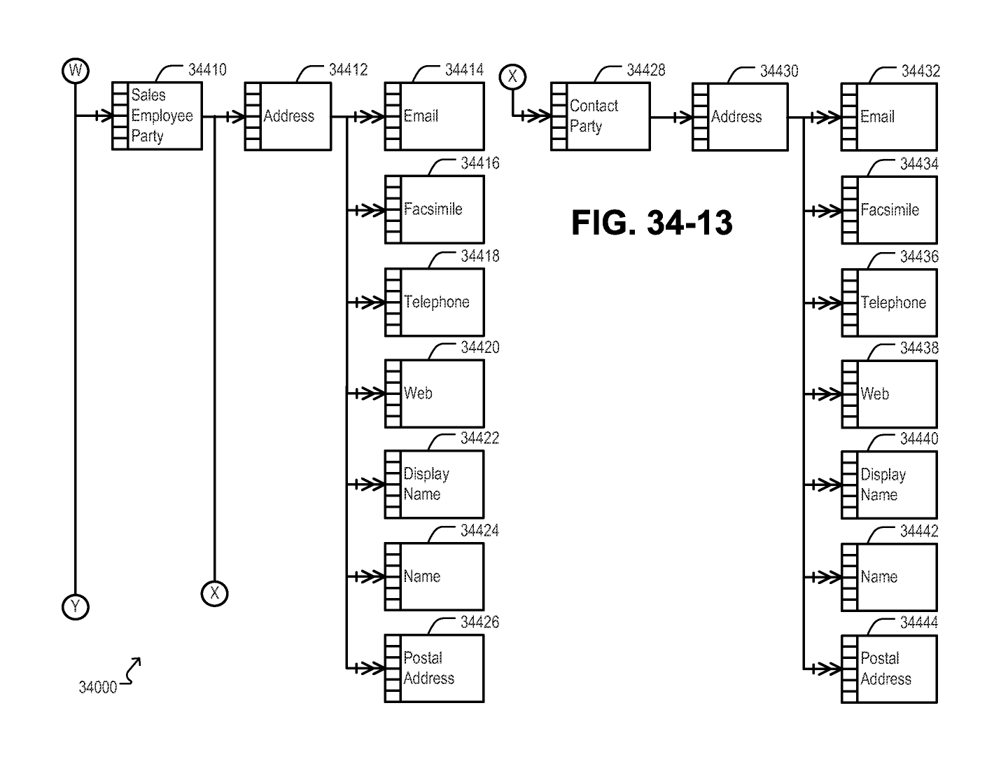

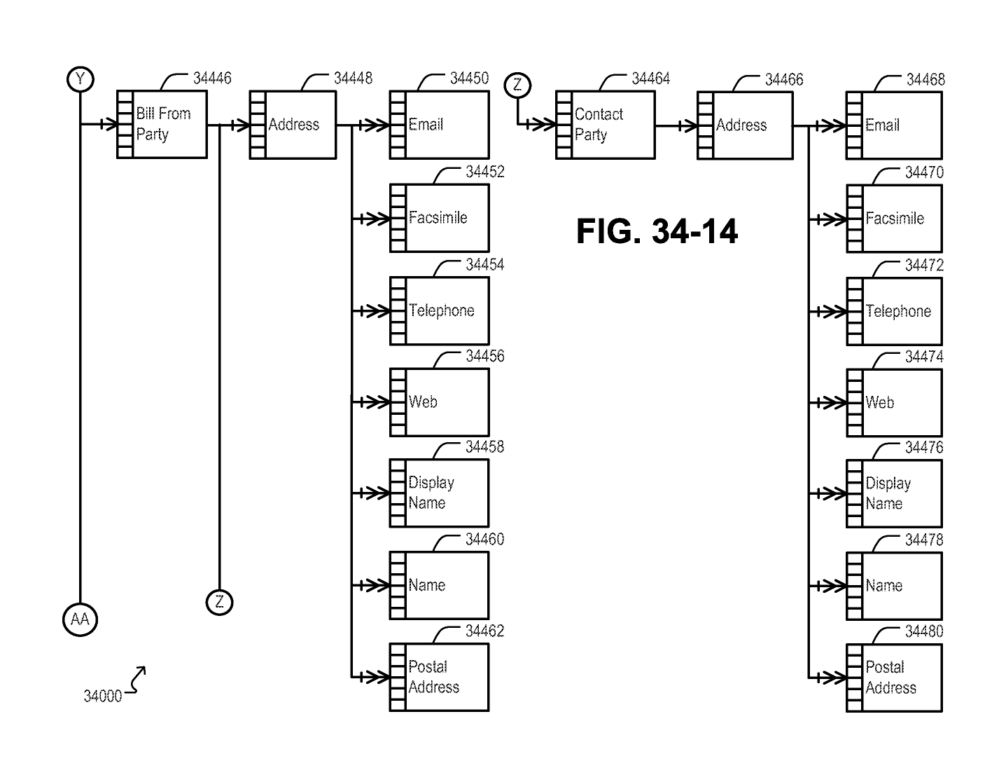

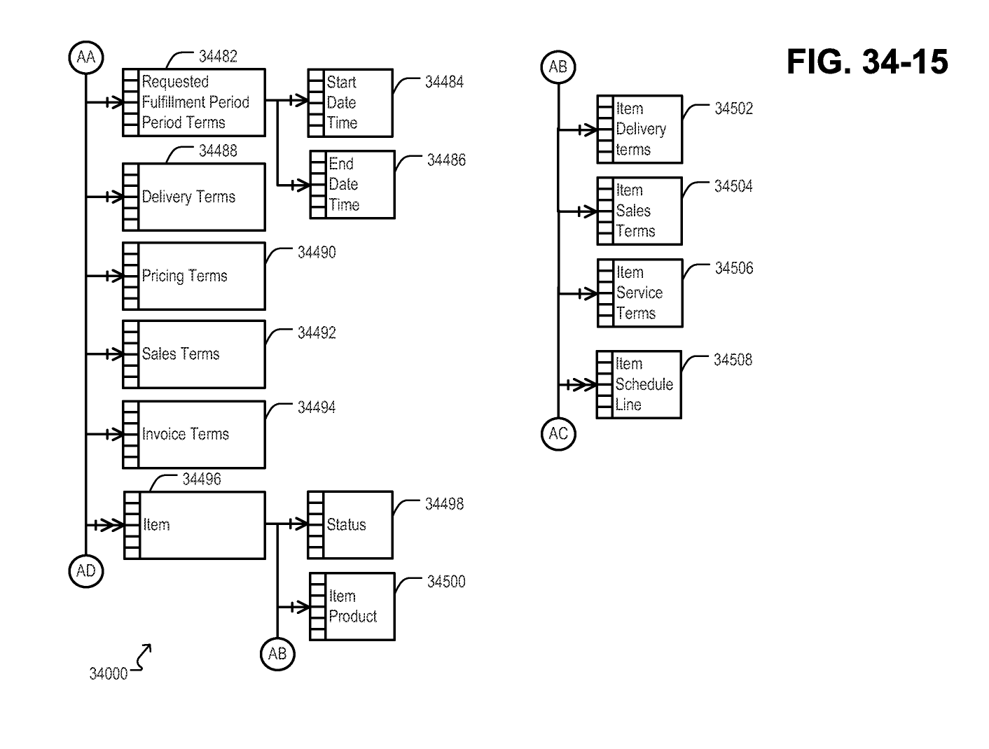

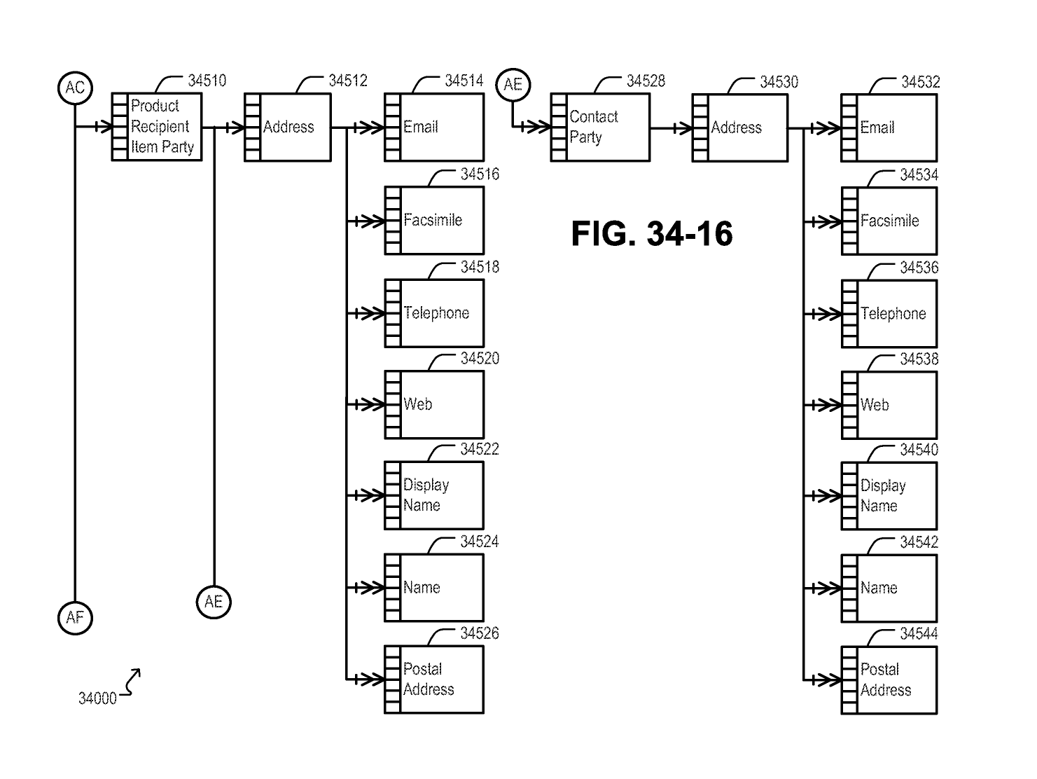

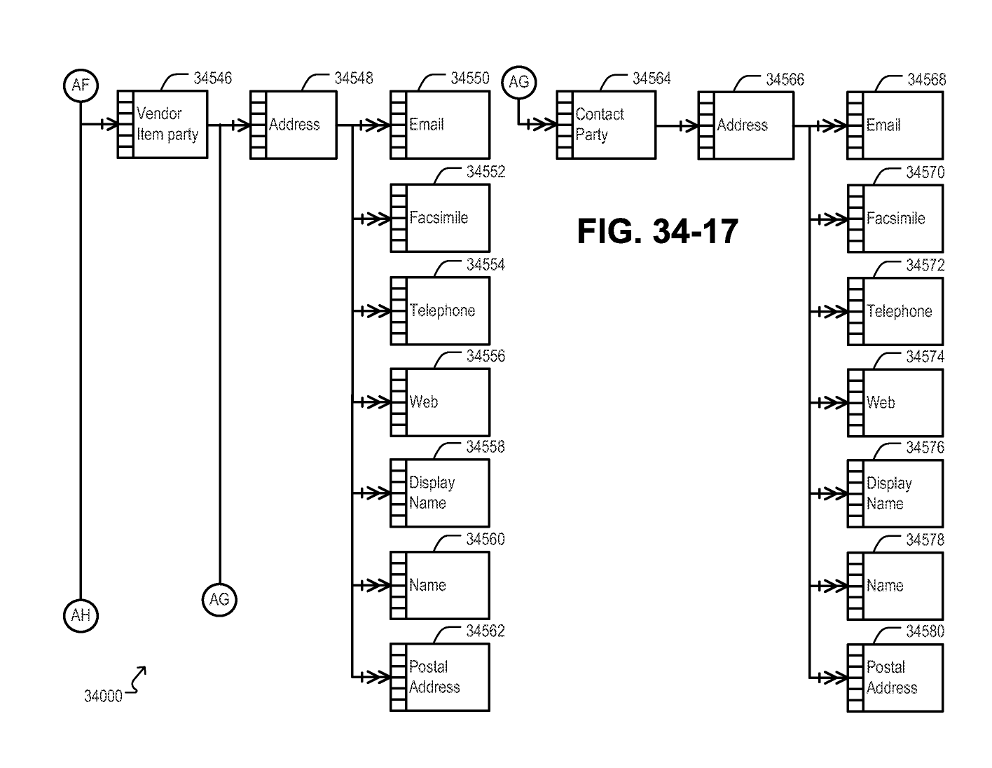

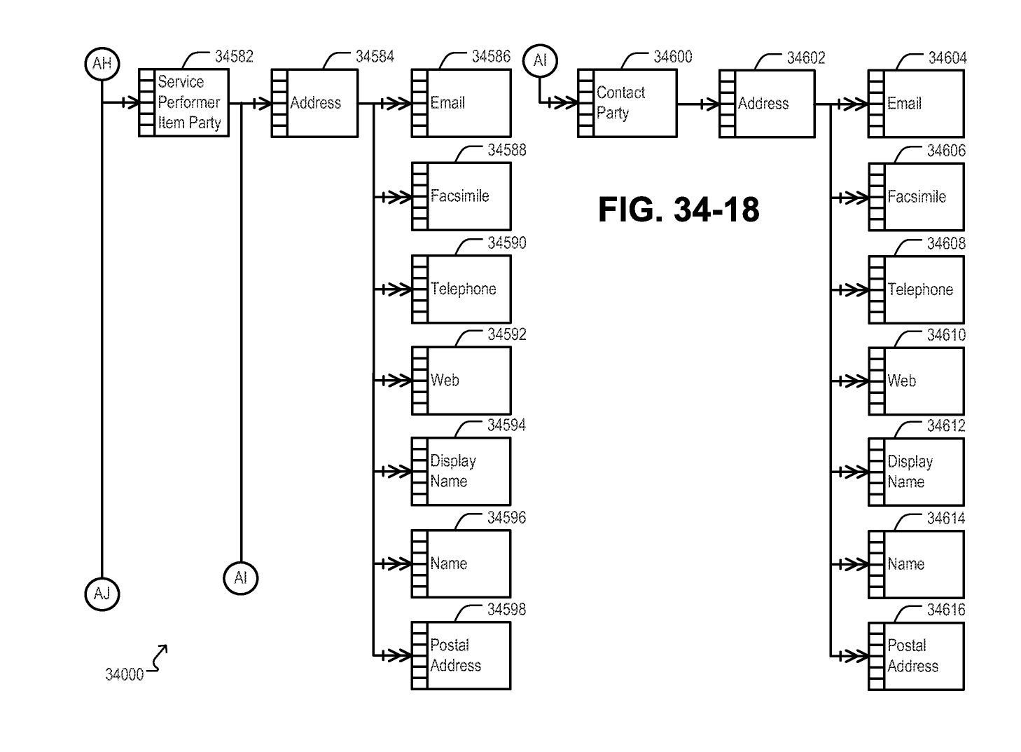

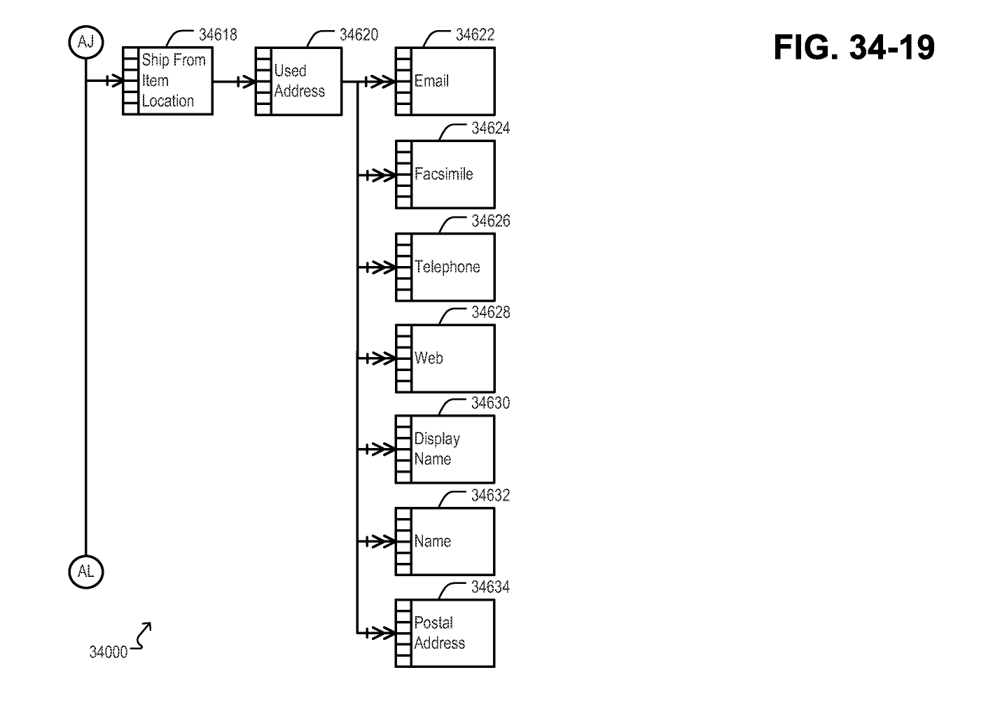

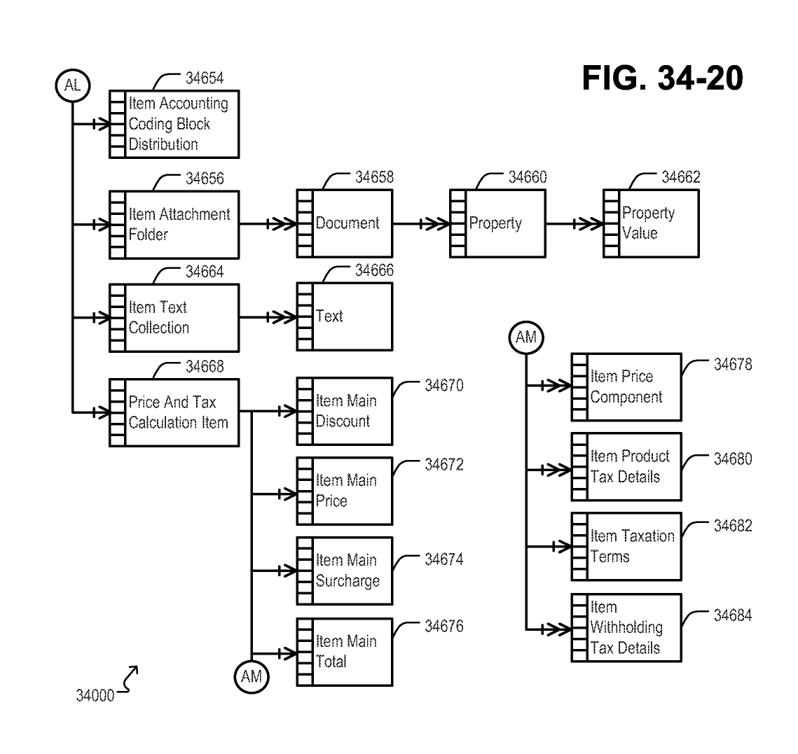

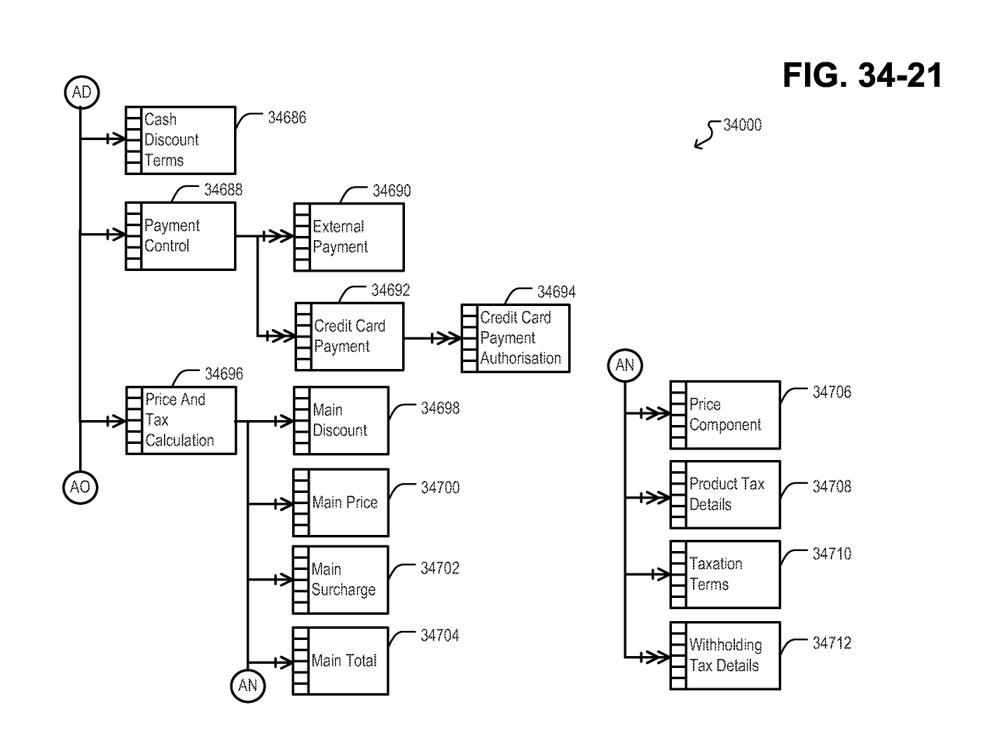

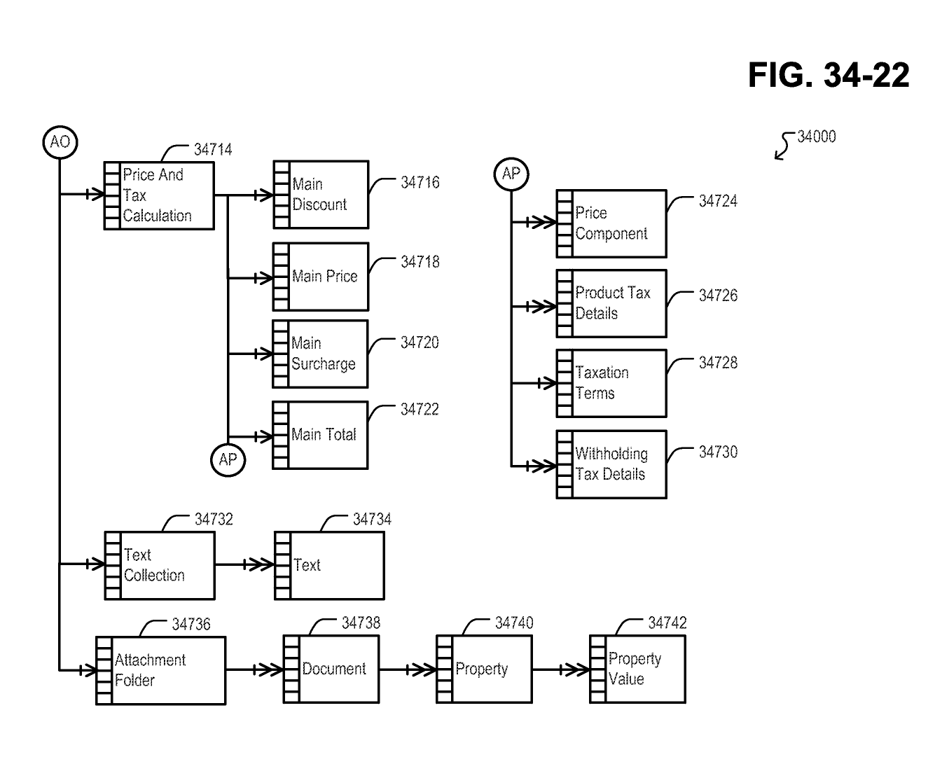

FIGS. 34-1 through 34-22 collectively illustrate one example logical configuration of a Sales Order By Elements Response Sync message 34000. Specifically, these figures depict the arrangement and hierarchy of various components such as one or more levels of packages, entities, and datatypes, shown here as 34002 through 34742. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Sales Order By Elements Response Sync message 34000 includes, among other things, the Sales Order entity 34004. Accordingly, heterogeneous applications may communicate using this consistent message configured as such.

The message type Sales Order By Elements Response_sync is derived from the business object Sales Order as a leading object together with its operation signature. The message type Sales Order By Elements Response_sync is a response concerning an inquiry about a sales order. The message type Sales Order by Elements Response_sync includes requested sales order data as well as processing conditions. Corresponding system messages can be provided as log items. The structure of the message type Sales Order By Elements Response_sync is determined by the message data type SalesOrderByElementsResponseMessage_sync. The message data type SalesOrderByElementsResponseMessage_sync is a typing data type for a sales order read response. The message data type SalesOrderByElementsResponseMessage_sync includes the SalesOrder package, the ProcessingConditions package, and the Log package.

The package SalesOrder includes the sub-packages Status, SalesAndServiceBusinessArea, Party, RequestedFulfillmentPeriodPeriodTerms, DeliveryTerms, PricingTerms, SalesTerms, InvoiceTerms, Item, CashDiscountTerms, PaymentControl, PriceAndTaxCalculation, TextCollection, and AttachmentFolder, and the entity SalesOrder. SalesOrder includes the following non-node elements: ID, UUID, BuyerID, PostingDate, Name, ChangeStateID, DataOriginTypeCode, FulfillmentBlockingReasonCode, and ServiceConfirmationCreationCode. ID may have a multiplicity of 0 . . . 1 and may be based on datatype BGDT:BusinessTransactionDocumentID. UUID may have a multiplicity of 0 . . . 1 and may be based on datatype BGDT:UUID. BuyerID may have a multiplicity of 0 . . . 1 and may be based on datatype BGDT:BusinessTransactionDocumentID. PostingDate may have a multiplicity of 0 . . . 1 and may be based on datatype CDT:GLOBAL_DateTime. Name may have a multiplicity of 0 . . . 1 and may be based on datatype CDT:EXTENDED_Name. ChangeStateID may have a multiplicity of 0 . . . 1 and may be based on datatype BGDT:ChangeStateID. DataOriginTypeCode may have a multiplicity of 0 . . . 1 and may be based on datatype BGDT:CustomerTransactionDocumentDataOriginTypeCode. FulfillmentBlockingReasonCode may have a multiplicity of 0 . . . 1 and may be based on datatype BGDT:CustomerTransactionDocumentFulfilmentBlockingReasonCode. ServiceConfirmationCreationCode may have a multiplicity of 0 . . . 1 and may be based on datatype BGDT:CustomerTransactionDocumentServiceConfirmationCreationCode.

SalesOrder includes the following node elements: Status, in a 1:C cardinality relationship; SalesAndServiceBusinessArea, in a 1:C cardinality relationship; BillToParty, in a 1:C cardinality relationship; AccountParty, in a 1:C cardinality relationship; PayerParty, in a 1:C cardinality relationship; ProductRecipientParty, in a 1:C cardinality relationship; SalesPartnerParty, in a 1:C cardinality relationship; FreightForwarderParty, in a 1:C cardinality relationship; EmployeeResponsibleParty, in a 1:C cardinality relationship; SellerParty, in a 1:C cardinality relationship; SalesUnitParty, in a 1:C cardinality relationship; ServiceExecutionTeamParty, in a 1:C cardinality relationship; ServicePerformerParty, in a 1:C cardinality relationship; SalesEmployeeParty, in a 1:C cardinality relationship; BillFromParty, in a 1:C cardinality relationship; RequestedFulfillmentPeriodPeriodTerms, in a 1:C cardinality relationship; DeliveryTerms, in a 1:C cardinality relationship; PricingTerms, in a 1:C cardinality relationship; SalesTerms, in a 1:C cardinality relationship; InvoiceTerms, in a 1:C cardinality relationship; Item, in a 1:CN cardinality relationship; CashDiscountTerms, in a 1:C cardinality relationship; PaymentControl, in a 1:C cardinality relationship; PriceAndTaxCalculation, in a 1:C cardinality relationship; TextCollection, in a 1:C cardinality relationship; and AttachmentFolder, in a 1:C cardinality relationship.

The package SalesOrderStatus includes the entity Status. Status includes the following non-node elements: PaymentAuthorisationStatusCode, ItemListCancellationStatusCode, ItemListCustomerOrderLifeCycleStatusCode, ItemListFulfilmentProcessingStatusCode, ItemListPlanningReleaseStatusCode, ItemListExecutionReleaseStatusCode, ConfirmationIssuingStatusCode, ItemListInvoiceProcessingStatusCode, ApprovalStatusCode, ItemListProductAvailabilityConfirmationStatusCode, ConsistencyStatusCode, GeneralDataCompletenessStatusCode, CancellationStatusCode, InvoicingBlockingStatusCode, FulfilmentBlockingStatusCode, CustomerRequestReleaseStatusCode, and ReleaseStatusCode.

PaymentAuthorisationStatusCode may have a multiplicity of 0 . . . 1 and may be based on datatype BGDT:AuthorisationStatusCode. ItemListCancellationStatusCode may have a multiplicity of 0 . . . 1 and may be based on datatype BGDT:CancellationStatusCode. ItemListCustomerOrderLifeCycleStatusCode may have a multiplicity of 0 . . . 1 and may be based on datatype BGDT:CustomerOrderLifeCycleStatusCode. ItemListFulfilmentProcessingStatusCode may have a multiplicity of 0 . . . 1 and may be based on datatype BGDT:ProcessingStatusCode. ItemListPlanningReleaseStatusCode may have a multiplicity of 0 . . . 1 and may be based on datatype BGDT:ReleaseStatusCode. ItemListExecutionReleaseStatusCode may have a multiplicity of 0 . . . 1 and may be based on datatype BGDT:ReleaseStatusCode. ConfirmationIssuingStatusCode may have a multiplicity of 0 . . . 1 and may be based on datatype BGDT:IssuingStatusCode. ItemListInvoiceProcessingStatusCode may have a multiplicity of 0 . . . 1 and may be based on datatype BGDT:ProcessingStatusCode. ApprovalStatusCode may have a multiplicity of 0 . . . 1 and may be based on datatype BGDT:ApprovalStatusCode. ItemListProductAvailabilityConfirmationStatusCode may have a multiplicity of 0 . . . 1 and may be based on datatype BGDT:ProductAvailabilityConfirmationStatusCode. ConsistencyStatusCode may have a multiplicity of 0 . . . 1 and may be based on datatype BGDT:ConsistencyStatusCode. GeneralDataCompletenessStatusCode may have a multiplicity of 0 . . . 1 and may be based on datatype BGDT:DataCompletenessStatusCode. CancellationStatusCode may have a multiplicity of 0 . . . 1 and may be based on datatype BGDT:CancellationStatusCode. InvoicingBlockingStatusCode may have a multiplicity of 0 . . . 1 and may be based on datatype BGDT:BlockingStatusCode. FulfilmentBlockingStatusCode may have a multiplicity of 0 . . . 1 and may be based on datatype BGDT:BlockingStatusCode. CustomerRequestReleaseStatusCode may have a multiplicity of 0 . . . 1 and may be based on datatype BGDT:ReleaseStatusCode. ReleaseStatusCode may have a multiplicity of 0 . . . 1 and may be based on datatype BGDT:ReleaseStatusCode.

The package SalesOrderSalesAndServiceBusinessArea includes the entity SalesAndServiceBusinessArea. SalesAndServiceBusinessArea includes the following non-node elements: SalesOrganisationID, SalesGroupID, SalesOfficeID, DistributionChannelCode, and ServiceOrganisationID. SalesOrganisationID may have a multiplicity of 0 . . . 1 and may be based on datatype BGDT:OrganisationalCentreID. SalesGroupID may have a multiplicity of 0 . . . 1 and may be based on datatype BGDT:OrganisationalCentreID. SalesOfficeID may have a multiplicity of 0 . . . 1 and may be based on datatype BGDT:OrganisationalCentreID. DistributionChannelCode may have a multiplicity of 0 . . . 1 and may be based on datatype BGDT:DistributionChannelCode. ServiceOrganisationID may have a multiplicity of 0 . . . 1 and may be based on datatype BGDT:OrganisationalCentreID.

The package SalesOrderParty includes the sub-packages AddressInformation and ContactParty and the entities BillToParty, AccountParty, PayerParty, ProductRecipientParty, SalesPartnerParty, FreightForwarderParty, EmployeeResponsibleParty, SellerParty, SalesUnitParty, ServiceExecutionTeamParty, ServicePerformerParty, SalesEmployeeParty, and BillFromParty.

BillToParty may include the PartyID non-node element. PartyID may have a multiplicity of 0 . . . 1 and may be based on datatype BGDT:PartyID. BillToParty may include the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode.

Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0.1 and may be based on datatype BGDT:FloorID. CareOfName may have a multiplicity of 0.1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator. Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator. DisplayName may include the FormattedName non-node element, which may have a multiplicity of 0 . . . 1 and may be based on datatype CDT:LONG_Name.

Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

AccountParty includes the PartyID non-node element, which may have a multiplicity of 0 . . . 1 and may be based on datatype BGDT:PartyID. AccountParty may include the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. SalesOrderPartyContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator. Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

PayerParty includes the PartyID non-node element, which may have a multiplicity of 0 . . . 1 and may be based on datatype BGDT:PartyID. PayerParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0.1 and may be based on datatype BGDT:FloorID. CareOfName may have a multiplicity of 0.1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. SalesOrderPartyContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

ProductRecipientParty includes the PartyID non-node element, which may have a multiplicity of 0 . . . 1 and may be based on datatype BGDT:PartyID. ProductRecipientParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. SalesOrderPartyContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0.1 and may be based on datatype BGDT:FloorID. CareOfName may have a multiplicity of 0.1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

SalesPartnerParty includes the PartyID non-node element, which may have a multiplicity of 0 . . . 1 and may be based on datatype BGDT:PartyID. SalesPartnerParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. SalesOrderPartyContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

FreightForwarderParty includes the PartyID non-node element, which may have a multiplicity of 0 . . . 1 and may be based on datatype BGDT:PartyID. FreightForwarderParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator.

MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator.

MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

EmployeeResponsibleParty includes the PartyId non-node element, which may have a multiplicity of 0 . . . 1 and may be based on datatype BGDT:PartyID. EmployeeResponsibleParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0.1 and may be based on datatype BGDT:FloorID. CareOfName may have a multiplicity of 0.1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

SellerParty includes the PartyID non-node element, which may have a multiplicity of 0 . . . 1 and may be based on datatype BGDT:PartyID. SellerParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator. T

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

SalesUnitParty includes the PartyID non-node element, which may have a multiplicity of 0 . . . 1 and may be based on datatype BGDT:PartyID. SalesUnitParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

ServiceExecutionTeamParty includes PartyID non-node element, which may have a multiplicity of 0 . . . 1 and may be based on datatype BGDT:PartyID. ServiceExecutionTeamParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode. ServicePerformerParty includes the PartyID non-node element, which may have a multiplicity of 0 . . . 1 and may be based on datatype BGDT:PartyID. ServicePerformerParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

SalesEmployeeParty includes the PartyID non-node element, which may have a multiplicity of 0 . . . 1 and may be based on datatype BGDT:PartyID. SalesEmployeeParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

BillFromParty includes the PartyID non-node element, which may have a multiplicity of 0 . . . 1 and may be based on datatype BGDT:PartyID. BillFromParty includes the following node elements: Address, in a 1:C cardinality relationship; and ContactParty, in a 1:CN cardinality relationship.

The package SalesOrderPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

mail includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderPartyContactPartyAddressInformation includes the entitity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements:

AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderRequestedFulfillmentPeriodPeriodTerms includes the entity RequestedFulfillmentPeriodPeriodTerms. RequestedFulfillmentPeriodPeriodTerms includes the following node elements: StartDateTime, in a 1:C cardinality relationship; and EndDateTime, in a 1:C cardinality relationship. The package SalesOrderRequestedFulfillmentPeriodPeriodTerms includes the entities StartDateTime and EndDateTime. StartDateTime is typed by LOCALNORMALISED_DateTime. EndDateTime is typed by LOCALNORMALISED_DateTime.

The package SalesOrderDeliveryTerms includes the entity DeliveryTerms. DeliveryTerms includes the following non-node elements: DeliveryPriorityCode, Incoterms, PartialDeliveryControlCode, and CompleteDeliveryRequestedIndicator. DeliveryPriorityCode may have a multiplicity of 0 . . . 1 and may be based on datatype BGDT:PriorityCode. Incoterms may have a multiplicity of 0 . . . 1 and may be based on datatype AGDT:Incoterms. PartialDeliveryControlCode may have a multiplicity of 0 . . . 1 and may be based on datatype BGDT:PartialDeliveryControlCode. CompleteDeliveryRequestedIndicator may have a multiplicity of 0 . . . 1 and may be based on datatype CDT:Indicator.

The package SalesOrderPricingTerms includes the entity PricingTerms. PricingTerms includes the following non-node elements: CurrencyCode, PriceDateTime, and GrossAmountIndicator. CurrencyCode may have a multiplicity of 0 . . . 1 and may be based on datatype BGDT:CurrencyCode. PriceDateTime may have a multiplicity of 0 . . . 1 and may be based on datatype CDT:LOCALNORMALISED_DateTime. GrossAmountIndicator may have a multiplicity of 1 and may be based on datatype CDT:Indicator.

The package SalesOrderSalesTerms includes the entity SalesTerms. SalesTerms includes the CancellationReasonCode non-node element, which may have a multiplicity of 0 . . . 1 and may be based on datatype BGDT:CancellationReasonCode.

The package SalesOrderInvoiceTerms includes the entity InvoiceTerms. InvoiceTerms includes the following non-node elements: ProposedInvoiceDate and InvoicingBlockingReasonCode. ProposedInvoiceDate may have a multiplicity of 0 . . . 1 and may be based on datatype CDT:Date. InvoicingBlockingReasonCode may have a multiplicity of 0 . . . 1 and may be based on datatype BGDT:InvoicingBlockingReasonCode.

The package SalesOrderItem includes the sub-packages Status, ProductInformation, DeliveryTerms, SalesTerms, ServiceTerms, ScheduleLine, Party, Location, AccountingCodingBlockDistribution, AttachmentFolder, TextCollection, and PriceAndTaxCalculation, and the entity Item. Item includes the following non-node elements: ID, BuyerID, ProcessingTypeCode, PostingDate, Description, and FulfilmentPartyCategoryCode. ID may have a multiplicity of 0 . . . 1 and may be based on datatype BGDT:BusinessTransactionDocumentItemID BuyerID may have a multiplicity of 0 . . . 1 and may be based on datatype BGDT:BusinessTransactionDocumentItemID ProcessingTypeCode may have a multiplicity of 0 . . . 1 and may be based on datatype BGDT:BusinessTransactionDocumentItemProcessingTypeCode. PostingDate may have a multiplicity of 0 . . . 1 and may be based on datatype CDT:GLOBAL_DateTime. Description may have a multiplicity of 0 . . . 1 and may be based on datatype BGDT:SHORT_Description. FulfilmentPartyCategoryCode may have a multiplicity of 0 . . . 1 and may be based on datatype BGDT:FulfilmentPartyCategoryCode. Item includes the following node elements: Status, in a 1:C cardinality relationship; ItemProduct, in a 1:C cardinality relationship; ItemDeliveryTerms, in a 1:C cardinality relationship; ItemSalesTerms, in a 1:C cardinality relationship; ItemServiceTerms, in a 1:C cardinality relationship; ItemScheduleLine, in a 1:CN cardinality relationship; ProductRecipientItemParty, in a 1:C cardinality relationship; VendorItemParty, in a 1:C cardinality relationship; ServicePerformerItemParty, in a 1:C cardinality relationship; ShipFromItemLocation, in a 1:C cardinality relationship; ItemAccountingCodingBlockDistribution, in a 1:C cardinality relationship; ItemAttachmentFolder, in a 1:C cardinality relationship; ItemTextCollection, in a 1:C cardinality relationship; and PriceAndTaxCalculationItem, in a 1:C cardinality relationship.

The package SalesOrderItemStatus includes the entity Status. Status includes the following non-node elements: ConsistencyStatusCode, ProductAvailabilityConfirmationStatusCode, FulfilmentDataCompletenessStatusCode, InvoicingDataCompletenessStatusCode, PricingDataCompletenessStatusCode, GeneralDataCompletenessStatusCode, FulfilmentProcessingStatusCode, InvoiceProcessingStatusCode, CustomerOrderLifeCycleStatusCode, CancellationStatusCode, PlanningReleaseStatusCode, ExecutionReleaseStatusCode, ApprovalStatusCode, and ReleaseStatusCode.

ConsistencyStatusCode may have a multiplicity of 0 . . . 1 and may be based on datatype BGDT:ConsistencyStatusCode. ProductAvailabilityConfirmationStatusCode may have a multiplicity of 0 . . . 1 and may be based on datatype BGDT:ProductAvailabilityConfirmationStatusCode. FulfilmentDataCompletenessStatusCode may have a multiplicity of 0 . . . 1 and may be based on datatype BGDT:DataCompletenessStatusCode. InvoicingDataCompletenessStatusCode may have a multiplicity of 0 . . . 1 and may be based on datatype BGDT:DataCompletenessStatusCode. PricingDataCompletenessStatusCode may have a multiplicity of 0 . . . 1 and may be based on datatype BGDT:DataCompletenessStatusCode. GeneralDataCompletenessStatusCode may have a multiplicity of 0 . . . 1 and may be based on datatype BGDT:DataCompletenessStatusCode. FulfilmentProcessingStatusCode may have a multiplicity of 0 . . . 1 and may be based on datatype BGDT:ProcessingStatusCode. InvoiceProcessingStatusCode may have a multiplicity of 0 . . . 1 and may be based on datatype BGDT:ProcessingStatusCode. CustomerOrderLifeCycleStatusCode may have a multiplicity of 0 . . . 1 and may be based on datatype BGDT:CustomerOrderLifeCycleStatusCode. CancellationStatusCode may have a multiplicity of 0 . . . 1 and may be based on datatype BGDT:CancellationStatusCode. PlanningReleaseStatusCode may have a multiplicity of 0 . . . 1 and may be based on datatype BGDT:ReleaseStatusCode. ExecutionReleaseStatusCode may have a multiplicity of 0 . . . 1 and may be based on datatype BGDT:ReleaseStatusCode. ApprovalStatusCode may have a multiplicity of 0 . . . 1 and may be based on datatype BGDT:ApprovalStatusCode. ReleaseStatusCode may have a multiplicity of 0 . . . 1 and may be based on datatype BGDT:ReleaseStatusCode.

The package SalesOrderItemProductInformation includes the entity ItemProduct. ItemProduct includes the following non-node elements: ProductID, ProductInternalID, ProductStandardID, ProductBuyerID, UnitOfMeasure, and ProductRequirementSpecificationKey. ProductID may have a multiplicity of 0 . . . 1 and may be based on datatype BGDT:NOCONVERSION_ProductID. ProductInternalID may have a multiplicity of 0 . . . 1 and may be based on datatype BGDT:ProductInternalID. ProductStandardID may have a multiplicity of 0 . . . 1 and may be based on datatype BGDT:ProductStandardID. ProductBuyerID may have a multiplicity of 0 . . . 1 and may be based on datatype BGDT:ProductPartyID. UnitOfMeasure may have a multiplicity of 0 . . . 1 and may be based on datatype BGDT:MeasureUnitCode. ProductRequirementSpecificationKey may have a multiplicity of 0 . . . 1 and may be based on datatype KDT: RequirementSpecificationKey.

The package SalesOrderItemDeliveryTerms includes the entity ItemDeliveryTerms. ItemDeliveryTerms includes the following non-node elements: DeliveryPriorityCode, Incoterms, and PartialDeliveryControlCode. DeliveryPriorityCode may have a multiplicity of 0 . . . 1 and may be based on datatype BGDT:PriorityCode. Incoterms may have a multiplicity of 0 . . . 1 and may be based on datatype AGDT:Incoterms. PartialDeliveryControlCode may have a multiplicity of 0 . . . 1 and may be based on datatype BGDT:PartialDeliveryControlCode.

The package SalesOrderItemSalesTerms includes the entity ItemSalesTerms. ItemSalesTerms includes the following non-node elements: IndustrialSectorCode, and CancellationReasonCode. IndustrialSectorCode may have a multiplicity of 0 . . . 1 and may be based on datatype BGDT:IndustrialSectorCode. CancellationReasonCode may have a multiplicity of 0 . . . 1 and may be based on datatype BGDT:CancellationReasonCode.

The package SalesOrderItemServiceTerms includes the entity ItemServiceTerms. ItemServiceTerms includes the following non-node elements: ConfirmationRelevanceIndicator, EmployeeTimeConfirmationRelevanceIndicator, ExpenseReportingConfirmationRelevanceIndicator, ServiceWorkingConditionsCode, ServicePlannedDuration, WarrantyKey, WarrantyValidityPeriod, ResourceID, and ProjectTaskID. ConfirmationRelevanceIndicator may have a multiplicity of 0 . . . 1 and may be based on datatype CDT:Indicator. EmployeeTimeConfirmationRelevanceIndicator may have a multiplicity of 0 . . . 1 and may be based on datatype CDT:Indicator. ExpenseReportingConfirmationRelevanceIndicator may have a multiplicity of 0 . . . 1 and may be based on datatype CDT:Indicator. ServiceWorkingConditionsCode may have a multiplicity of 0 . . . 1 and may be based on datatype BGDT:ServiceWorkingConditionsCode. ServicePlannedDuration may have a multiplicity of 0 . . . 1 and may be based on datatype CDT:Duration. WarrantyKey may have a multiplicity of 0 . . . 1 and may be based on datatype KDT: ProductKey. WarrantyValidityPeriod may have a multiplicity of 0 . . . 1 and may be based on datatype AGDT:CLOSED_DatePeriod. ResourceID may have a multiplicity of 0 . . . 1 and may be based on datatype BGDT:ResourceID. ProjectTaskID may have a multiplicity of 0 . . . 1 and may be based on datatype BGDT:ProjectElementID.

The package SalesOrderItemScheduleLine includes the entity ItemScheduleLine. ItemScheduleLine includes the following non-node elements: ID, TypeCode, Quantity, QuantityTypeCode, DateTimePeriod, ProductAvailabilityConfirmationCommitmentCode, and RelatedID. ID may have a multiplicity of 0 . . . 1 and may be based on datatype BGDT:BusinessTransactionDocumentItemScheduleLineID. TypeCode may have a multiplicity of 0 . . . 1 and may be based on datatype BGDT:BusinessTransactionDocumentItemScheduleLineTypeCode. Quantity may have a multiplicity of 0 . . . 1 and may be based on datatype CDT:Quantity. QuantityTypeCode may have a multiplicity of 0 . . . 1 and may be based on datatype BGDT:QuantityTypeCode. DateTimePeriod may have a multiplicity of 0 . . . 1 and may be based on datatype AGDT:UPPEROPEN_LOCALNORMALISED_DateTimePeriod. ProductAvailabilityConfirmationCommitmentCode may have a multiplicity of 0 . . . 1 and may be based on datatype BGDT:ProductAvailabilityConfirmationCommitmentCode. RelatedID may have a multiplicity of 0 . . . 1 and may be based on datatype BGDT:BusinessTransactionDocumentItemScheduleLineID.

The package SalesOrderItemParty includes the sub-packages AddressInformation and ContactParty and the entities ProductRecipientItemParty, VendorItemParty, and ServicePerformerItemParty. ProductRecipientItemParty includes the PartyID non-node element, which may have a multiplicity of 0 . . . 1 and may be based on datatype BGDT:PartyID. ProductRecipientItemParty includes the following node elements: Address, in a 1:C cardinality relationship; and ContactParty, in a 1:CN cardinality relationship.

The package SalesOrderItemPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderItemPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderItemPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

VendorItemParty includes the PartyID non-node element, which may have a multiplicity of 0 . . . 1 and may be based on datatype BGDT:PartyID. VendorItemParty includes the following node elements: Address, in a 1:C cardinality relationship; and ContactParty, in a 1:CN cardinality relationship.

The package SalesOrderItemPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderItemPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderItemPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

ServicePerformerItemParty includes the PartyID non-node element, which may have a multiplicity of 0 . . . 1 and may be based on datatype BGDT:PartyID. ServicePerformerItemParty includes the following node elements: Address, in a 1:C cardinality relationship; and ContactParty, in a 1:CN cardinality relationship.

The package SalesOrderItemPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderItemPartyContactParty includes the sub-package AddressInformation and the entity ContactParty. ContactParty includes the following non-node elements: PartyID and MainIndicator. PartyID may have a multiplicity of 0 . . . 1 and may be based on datatype BGDT:PartyID. MainIndicator may have a multiplicity of 0 . . . 1 and may be based on datatype CDT:Indicator. ContactParty includes the node element Address, in a 1:C cardinality relationship.

The package SalesOrderItemPartyContactPartyAddressInformation includes the entity Address. Address includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderItemLocation includes the entity ShipFromItemLocation. ShipFromItemLocation includes the LocationID non-node element, which may have a multiplicity of 0 . . . 1 and may be based on datatype BGDT:LocationID. SalesOrderItemLocation includes the UsedAddress node element, in a 1:C cardinality relationship.

The package SalesOrderItemLocation includes the sub-package AddressInformation and the entity UsedAddress. UsedAddress includes the following non-node elements: CorrespondenceLanguageCode. CorrespondenceLanguageCode may have a multiplicity of 0 . . . 1 and may be based on datatype BGDT:LanguageCode. Address includes the following node elements: Email, in a 1:CN cardinality relationship; Facsimile, in a 1:CN cardinality relationship; Telephone, in a 1:CN cardinality relationship; Web, in a 1:CN cardinality relationship; DisplayName, in a 1:CN cardinality relationship; Name, in a 1:CN cardinality relationship; and PostalAddress, in a 1:CN cardinality relationship.

Email includes the following non-node elements: URI, DefaultIndicator, and UsageDeniedIndicator. URI may have a multiplicity of 0 . . . 1 and may be based on datatype BGDT:EmailURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Facsimile includes the following non-node elements: Number, FormattedNumberDescription, DefaultIndicator, and UsageDeniedIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

Telephone includes the following non-node elements: Number, FormattedNumberDescription, DefaultConventionalPhoneNumberIndicator, DefaultMobilePhoneNumberIndicator, UsageDeniedIndicator, MobilePhoneNumberIndicator, and SMSEnabledIndicator. Number may have a multiplicity of 0 . . . 1 and may be based on datatype AGDT:PhoneNumber. FormattedNumberDescription may have a multiplicity of 0 . . . 1 and may be based on datatype BGDT:LANGUAGEINDEPENDENT_SHORT_Description. DefaultConventionalPhoneNumberIndicator may have a multiplicity of 0 . . . 1 and may be based on datatype CDT:Indicator. DefaultMobilePhoneNumberIndicator may have a multiplicity of 0 . . . 1 and may be based on datatype CDT:Indicator. UsageDeniedIndicator may have a multiplicity of 0 . . . 1 and may be based on datatype CDT:Indicator. MobilePhoneNumberIndicator may have a multiplicity of 0 . . . 1 and may be based on datatype CDT:Indicator. SMSEnabledIndicator may have a multiplicity of 0 . . . 1 and may be based on datatype CDT:Indicator.

Web includes the following non-node elements: URI, DefaultIndicator, and UsageDeniedIndicator. URI may have a multiplicity of 0 . . . 1 and may be based on datatype BGDT:WebURI. DefaultIndicator may have a multiplicity of 0 . . . 1 and may be based on datatype CDT:Indicator. UsageDeniedIndicator may have a multiplicity of 0 . . . 1 and may be based on datatype CDT:Indicator.

DisplayName may include the FormattedName non-node element, which may have a multiplicity of 0 . . . 1 and may be based on datatype CDT:LONG_Name. Name includes the following non-node elements: AddressRepresentationCode and Name. AddressRepresentationCode may have a multiplicity of 0 . . . 1 and may be based on datatype BGDT:AddressRepresentationCode. Name may have a multiplicity of 0 . . . 1 and may be based on datatype AGDT:OrganisationName.

PostalAddress includes the following non-node elements: AddressRepresentationCode, CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, BuildingID, RoomID, FloorID, CareOfName, POBoxDeviatingCountryCode, POBoxDeviatingRegionCode, POBoxDeviatingCityName, POBoxID, POBoxIndicator, TaxJurisdictionCode, and TimeZoneCode. AddressRepresentationCode may have a multiplicity of 0 . . . 1 and may be based on datatype BGDT:AddressRepresentationCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. BuildingID may have a multiplicity of 0 . . . 1 and may be based on datatype BGDT:BuildingID. RoomID may have a multiplicity of 0 . . . 1 and may be based on datatype BGDT:RoomID FloorID may have a multiplicity of 0 . . . 1 and may be based on datatype BGDT:FloorID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package SalesOrderItemAccountingCodingBlockDistribution includes the entity ItemAccountingCodingBlockDistribution. ItemAccountingCodingBlockDistribution includes the AccountingCodingBlockAssignmentProjectTaskKey non-node element, which may have a multiplicity of 0 . . . 1 and may be based on datatype KDT: ProjectTaskKey.

The package SalesOrderItemAttachmentFolder includes the entity ItemAttachmentFolder. ItemAttachmentFolder includes the UUID non-node element, which may have a multiplicity of 0 . . . 1 and may be based on datatype BGDT:UUID. ItemAttachmentFolder includes the node element Document, in a 1:CN cardinality relationship.

The package SalesOrderItemAttachmentFolder includes the entity Document. Document includes the following non-node elements: UUID, VersionID, SystemAdministrativeData, LinkInternalIndicator, CheckedOutIndicator, VisibleIndicator, VersioningEnabledIndicator, CategoryCode, CategoryName, TypeCode, TypeName, MIMECode, MIMEName, PathName, Name, AlternativeName, InternalLinkUUID, Description, ExternalLinkWebURI, FileContentURI, and FilesizeMeasure.

UUID may have a multiplicity of 0 . . . 1 and may be based on datatype BGDT:UUID. VersionID may have a multiplicity of 0 . . . 1 and may be based on datatype BGDT:VersionID. SystemAdministrativeData may have a multiplicity of 0 . . . 1 and may be based on datatype AGDT:SystemAdministrativeData. LinkInternalIndicator may have a multiplicity of 0 . . . 1 and may be based on datatype CDT:Indicator. CheckedOutIndicator may have a multiplicity of 0 . . . 1 and may be based on datatype CDT:Indicator. VisibleIndicator may have a multiplicity of 0 . . . 1 and may be based on datatype CDT:Indicator. VersioningEnabledIndicator may have a multiplicity of 0 . . . 1 and may be based on datatype CDT:Indicator. CategoryCode may have a multiplicity of 0 . . . 1 and may be based on datatype BGDT:DocumentCategoryCode. CategoryName may have a multiplicity of 0 . . . 1 and may be based on datatype CDT:LANGUAGEINDEPENDENT_LONG_Name. TypeCode may have a multiplicity of 0 . . . 1 and may be based on datatype BGDT:DocumentTypeCode. TypeName may have a multiplicity of 0 . . . 1 and may be based on datatype CDT:LANGUAGEINDEPENDENT_LONG_Name. MIMECode may have a multiplicity of 0 . . . 1 and may be based on datatype BGDT:MIMECode. MIMEName may have a multiplicity of 0 . . . 1 and may be based on datatype CDT:LANGUAGEINDEPENDENT_LONG_Name. PathName may have a multiplicity of 0 . . . 1 and may be based on datatype CDT:LANGUAGEINDEPENDENT_Name. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. FileContentURI may have a multiplicity of 0 . . . 1 and may be based on datatype BGDT:URI. FilesizeMeasure may have a multiplicity of 0 . . . 1 and may be based on datatype CDT:Measure.

Document includes the node element Property in a 1:CN cardinality relationship. Property includes the following non-node elements: TechnicalID, Name, DataTypeFormatCode, DataTypeFormatName, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. DataTypeFormatName may have a multiplicity of 0 . . . 1 and may be based on datatype CDT:LANGUAGEINDEPENDENT_LONG_Name. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description.

PropertyValue includes the node element PropertyValue in a 1:CN cardinality relationship. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

The package SalesOrderItemTextCollection includes the entity ItemTextCollection. ItemTextCollection includes the Text node element in a 1:CN cardinality relationship. The package SalesOrderItemTextCollection includes the entity Text. Text includes the following non-node elements: TypeCode, CreationDateTime, and ContentText. TypeCode may have a multiplicity of 0 . . . 1 and may be based on datatype BGDT:TextCollectionTextTypeCode. CreationDateTime may have a multiplicity of 0 . . . 1 and may be based on datatype CDT:GLOBAL_DateTime. ContentText may have a multiplicity of 0 . . . 1 and may be based on datatype CDT:LANGUAGEINDEPENDENT_Text.

The package SalesOrderItemPriceAndTaxCalculation includes the entity PriceAndTaxCalculationItem. PriceAndTaxCalculationItem includes the following non-node elements: Status, CalculationStatusCode, CountryCode, TaxationCharacteristicsCode, TaxationCharacteristicsDeterminationMethodCode, TaxJurisdictionCode, TaxRegionCode, WithholdingTaxationCharacteristicsCode, and WithholdingTaxationCharacteristicsDeterminationMethodCode. Status may have a multiplicity of 0 . . . 1 and may be based on datatype BOIDT:PriceAndTaxCalculationitemStatus. CalculationStatusCode may have a multiplicity of 1, is a status code of a price and tax calculation item, and may be based on datatype BGDT:CalculationStatusCode. CountryCode may have a multiplicity of 0 . . . 1 and may be based on datatype BGDT:CountryCode. TaxationCharacteristicsCode may have a multiplicity of 0 . . . 1 and may be based on datatype BGDT:ProductTaxationCharacteristicsCode. TaxationCharacteristicsDeterminationMethodCode may have a multiplicity of 0 . . . 1 and may be based on datatype BGDT:TaxationCharacteristicsDeterminationMethodCode. TaxJurisdictionCode may have a multiplicity of 0 . . . 1 and may be based on datatype BGDT:TaxJurisdictionCode. TaxRegionCode may have a multiplicity of 0 . . . 1 and may be based on datatype BGDT:RegionCode. WithholdingTaxationCharacteristicsCode may have a multiplicity of 0 . . . 1 and may be based on datatype BGDT:WithholdingTaxationCharacteristicsCode. WithholdingTaxationCharacteristicsDeterminationMethodCode may have a multiplicity of 0 . . . 1 and may be based on datatype BGDT:TaxationCharacteristicsDeterminationMethodCode. PriceAndTaxCalculationItem includes the following node elements: ItemMainDiscount, in a 1:C cardinality relationship; ItemMainPrice, in a 1:C cardinality relationship; ItemMainSurcharge, in a 1:C cardinality relationship; ItemMainTotal, in a 1:C cardinality relationship; ItemPriceComponent, in a 1:CN cardinality relationship; ItemProductTaxDetails, in a 1:CN cardinality relationship; ItemTaxationTerms, in a 1:C cardinality relationship; and ItemWithholdingTaxDetails, in a 1:CN cardinality relationship.

The package SalesOrderItemPriceAndTaxCalculation includes the entities ItemMainDiscount, ItemMainPrice, ItemMainSurcharge, ItemMainTotal, ItemPriceComponent, ItemProductTaxDetails, ItemTaxationTerms, and ItemWithholdingTaxDetails. ItemMainDiscount includes the following non-node elements: Description, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode. Description may have a multiplicity of 0 . . . 1 and may be based on datatype BGDT:SHORT_Description. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

ItemMainPrice includes the following non-node elements: Description, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode. Description may have a multiplicity of 0 . . . 1 and may be based on datatype BGDT:SHORT_Description. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

ItemMainSurcharge includes the following non-node elements: Description, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode. Description may have a multiplicity of 0 . . . 1 and may be based on datatype BGDT:SHORT_Description. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

ItemMainTotal includes the following non-node elements: Description, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode. Description may have a multiplicity of 0 . . . 1 and may be based on datatype BGDT:SHORT_Description. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

ItemPriceComponent includes the following non-node elements: UUID, Description, MajorLevelOrdinalNumberValue, MinorLevelOrdinalNumberValue, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode. UUID may have a multiplicity of 0 . . . 1 and may be based on datatype BGDT:UUID. Description may have a multiplicity of 0 . . . 1 and may be based on datatype BGDT:SHORT_Description. MajorLevelOrdinalNumberValue may have a multiplicity of 0 . . . 1 and may be based on datatype BGDT:OrdinalNumberValue. MinorLevelOrdinalNumberValue may have a multiplicity of 0 . . . 1 and may be based on datatype BGDT:OrdinalNumberValue. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

ItemProductTaxDetails includes the following non-node elements: UUID, ProductTax, and TransactionCurrencyProductTax. UUID may have a multiplicity of 0 . . . 1 and may be based on datatype BGDT:UUID. ProductTax may have a multiplicity of 0 . . . 1 and may be based on datatype AGDT:ProductTax. TransactionCurrencyProductTax may have a multiplicity of 0 . . . 1 and may be based on datatype AGDT:ProductTax. ItemTaxationTerms includes the following non-node elements: SellerCountryCode, SellerTaxID, SellerTaxIdentificationNumberTypeCode, BuyerCountryCode, BuyerTaxID, BuyerTaxIdentificationNumberTypeCode, EuropeanCommunityVATTriangulationIndicator, TaxDate, TaxDueDate, TaxExemptionCertificateID, TaxExemptionReasonCode, TaxExemptionReasonCodeRelevanceIndicator, FollowUpTaxExemptionCertificateID, ProductTaxStandardClassificationCode, and ProductTaxStandardClassificationSystemCode. SellerCountryCode may have a multiplicity of 0 . . . 1 and may be based on datatype BGDT:CountryCode. SellerTaxID may have a multiplicity of 0 . . . 1 and may be based on datatype BGDT:PartyTaxID. SellerTaxIdentificationNumberTypeCode may have a multiplicity of 0 . . . 1 and may be based on datatype BGDT:TaxIdentificationNumberTypeCode. BuyerCountryCode may have a multiplicity of 0 . . . 1 and may be based on datatype BGDT:CountryCode. BuyerTaxID may have a multiplicity of 0 . . . 1 and may be based on datatype BGDT:PartyTaxID. BuyerTaxIdentificationNumberTypeCode may have a multiplicity of 0 . . . 1 and may be based on datatype BGDT:TaxIdentificationNumberTypeCode. EuropeanCommunityVATTriangulationIndicator may have a multiplicity of 0 . . . 1 and may be based on datatype CDT:Indicator. TaxDate may have a multiplicity of 0 . . . 1 and may be based on datatype CDT:Date. TaxDueDate may have a multiplicity of 0 . . . 1 and may be based on datatype CDT:Date. TaxExemptionCertificateID may have a multiplicity of 0 . . . 1 and may be based on datatype BGDT:TaxExemptionCertificateID. TaxExemptionReasonCode may have a multiplicity of 0 . . . 1 and may be based on datatype BGDT:TaxExemptionReasonCode. TaxExemptionReasonCodeRelevanceIndicator may have a multiplicity of 0 . . . 1 and may be based on datatype CDT:Indicator. FollowUpTaxExemptionCertificateID may have a multiplicity of 0 . . . 1 and may be based on datatype BGDT:TaxExemptionCertificateID. ProductTaxStandardClassificationCode may have a multiplicity of 0 . . . 1 and may be based on datatype BGDT:ProductTaxStandardClassificationCode. ProductTaxStandardClassificationSystemCode may have a multiplicity of 0 . . . 1 and may be based on datatype BGDT:ProductTaxStandardClassificationSystemCode. ItemWithholdingTaxDetails includes the following non-node elements: UUID, WithholdingTax, and TransactionCurrencyWithholdingTax. UUID may have a multiplicity of 0 . . . 1 and may be based on datatype BGDT:UUID. WithholdingTax may have a multiplicity of 0 . . . 1 and may be based on datatype AGDT:WithholdingTax. TransactionCurrencyWithholdingTax may have a multiplicity of 0 . . . 1 and may be based on datatype AGDT:WithholdingTax.

The package SalesOrderCashDiscountTerms includes the entity CashDiscountTerms. CashDiscountTerms includes the following non-node elements: Code and PaymentBaselineDate. Code may have a multiplicity of 0 . . . 1 and may be based on datatype BGDT:CashDiscountTermsCode. PaymentBaselineDate may have a multiplicity of 0 . . . 1 and may be based on datatype CDT:Date.

The package SalesOrderPaymentControl includes the entity PaymentControl. PaymentControl includes the following non-node elements: PaymentProcessingCompanyUUID, PaymentProcessingCompanyID, PaymentProcessingBusinessPartnerUUID, PaymentProcessingBusinessPartnerID, ResponsibleEmployeeUUID, ResponsibleEmployeeID, PropertyMovementDirectionCode, PaymentFormCode, PaymentAmount, ExchangeRate, PaymentBlock, FirstPaymentInstructionTypeCode, SecondPaymentInstructionTypeCode, ThirdPaymentInstructionTypeCode, FourthPaymentInstructionTypeCode, BankChargeBearerCode, PaymentPriorityCode, SinglePaymentIndicator, DebitValueDate, CreditValueDate, PaymentReceivablesPayablesGroupID, PaymentReferenceID, PaymentReferenceTypeCode, and Note.

PaymentProcessingCompanyUUID may have a multiplicity of 0 . . . 1 and may be based on datatype BGDT:UUID. PaymentProcessingCompanyID may have a multiplicity of 0 . . . 1 and may be based on datatype BGDT:OrganisationalCentreID. PaymentProcessingBusinessPartnerUUID may have a multiplicity of 0 . . . 1 and may be based on datatype BGDT:UUID. PaymentProcessingBusinessPartnerID may have a multiplicity of 0 . . . 1 and may be based on datatype BGDT:BusinessPartnerInternalID. ResponsibleEmployeeUUID may have a multiplicity of 0 . . . 1 and may be based on datatype BGDT:UUID. ResponsibleEmployeeID may have a multiplicity of 0 . . . 1 and may be based on datatype BGDT:BusinessPartnerInternalID. PropertyMovementDirectionCode may have a multiplicity of 0 . . . 1 and may be based on datatype BGDT:PropertyMovementDirectionCode. PaymentFormCode may have a multiplicity of 0 . . . 1 and may be based on datatype BGDT:PaymentFormCode. PaymentAmount may have a multiplicity of 0 . . . 1 and may be based on datatype CDT:Amount. ExchangeRate may have a multiplicity of 0 . . . 1 and may be based on datatype AGDT:ExchangeRate. PaymentBlock may have a multiplicity of 0 . . . 1 and may be based on datatype AGDT:PaymentBlock. FirstPaymentInstructionTypeCode may have a multiplicity of 0 . . . 1 and may be based on datatype BGDT:PaymentInstructionTypeCode. SecondPaymentInstructionTypeCode may have a multiplicity of 0 . . . 1 and may be based on datatype BGDT:PaymentInstructionTypeCode. ThirdPaymentInstructionTypeCode may have a multiplicity of 0 . . . 1 and may be based on datatype BGDT:PaymentInstructionTypeCode. FourthPaymentInstructionTypeCode may have a multiplicity of 0 . . . 1 and may be based on datatype BGDT:PaymentInstructionTypeCode. BankChargeBearerCode may have a multiplicity of 0 . . . 1 and may be based on datatype BGDT:BankChargeBearerCode. PaymentPriorityCode may have a multiplicity of 0 . . . 1 and may be based on datatype BGDT:PriorityCode. SinglePaymentIndicator may have a multiplicity of 0 . . . 1 and may be based on datatype CDT:Indicator. DebitValueDate may have a multiplicity of 0 . . . 1 and may be based on datatype CDT:Date. CreditValueDate may have a multiplicity of 0 . . . 1 and may be based on datatype CDT:Date. PaymentReceivablesPayablesGroupID may have a multiplicity of 0 . . . 1 and may be based on datatype BGDT:BusinessTransactionDocumentGroupID. PaymentReferenceID may have a multiplicity of 0 . . . 1 and may be based on datatype BGDT:PaymentReferenceID. PaymentReferenceTypeCode may have a multiplicity of 0 . . . 1 and may be based on datatype BGDT:PaymentReferenceTypeCode. Note may have a multiplicity of 0 . . . 1 and may be based on datatype BGDT:MEDIUM_Note. PaymentControl includes the following node elements: ExternalPayment, in a 1:CN cardinality relationship; and CreditCardPayment, in a 1:CN cardinality relationship.

The package SalesOrderPaymentControl includes the entities ExternalPayment and CreditCardPayment. ExternalPayment includes the following non-node elements: UUID, HouseBankAccountUUID, HouseBankAccountKeyInternalID, PaymentTransactionReferenceID, DocumentDate, ValueDate, and Amount. UUID may have a multiplicity of 0 . . . 1 and may be based on datatype BGDT:UUID. HouseBankAccountUUID may have a multiplicity of 0 . . . 1 and may be based on datatype BGDT:UUID. HouseBankAccountKeyInternalID may have a multiplicity of 0 . . . 1 and may be based on datatype BGDT:BankAccountInternalID. PaymentTransactionReferenceID may have a multiplicity of 0 . . . 1 and may be based on datatype BGDT:PaymentTransactionReferenceID. DocumentDate may have a multiplicity of 0 . . . 1 and may be based on datatype CDT:Date. ValueDate may have a multiplicity of 0 . . . 1 and may be based on datatype CDT:Date. Amount may have a multiplicity of 0 . . . 1 and may be based on datatype CDT:Amount.

CreditCardPayment includes the following non-node elements: UUID, PaymentCardUUID, PaymentCardKey, BusinessPartnerPaymentCardDetailsKeyID, PaymentCardDataOriginTypeCode, PaymentCardAutomaticallyGeneratedIndicator, DeviceID, LocationInternalID, ClearingHouseAccountUUID, ClearingHouseAccountKeyID, PaymentCardVerificationValueText, PaymentCardVerificationValueAvailabilityCode, PaymentCardVerificationValueCheckRequiredIndicator, AuthorisationRequiredIndicator, AuthorisationLimitAmount, AuthorisationValueUnlimitedIndicator, Amount, PaymentAuthorisedAmount, and CompanyClearingHouseID.

UUID may have a multiplicity of 0 . . . 1 and may be based on datatype BGDT:UUID. PaymentCardUUID may have a multiplicity of 0 . . . 1 and may be based on datatype BGDT:UUID. PaymentCardKey may have a multiplicity of 0 . . . 1 and may be based on datatype KDT: PaymentCardKey. BusinessPartnerPaymentCardDetailsKeyID may have a multiplicity of 0 . . . 1 and may be based on datatype BGDT:BusinessPartnerPaymentCardDetailsID. PaymentCardDataOriginTypeCode may have a multiplicity of 0 . . . 1 and may be based on datatype BGDT:DataOriginTypeCode. PaymentCardAutomaticallyGeneratedIndicator may have a multiplicity of 0 . . . 1 and may be based on datatype CDT:Indicator. DeviceID may have a multiplicity of 0 . . . 1 and may be based on datatype BGDT:DeviceID. LocationInternalID may have a multiplicity of 0 . . . 1 and may be based on datatype BGDT:LocationInternalID. ClearingHouseAccountUUID may have a multiplicity of 0 . . . 1 and may be based on datatype BGDT:UUID. ClearingHouseAccountKeyID may have a multiplicity of 0 . . . 1 and may be based on datatype BGDT:ClearingHouseAccountID. PaymentCardVerificationValueText may have a multiplicity of 0 . . . 1 and may be based on datatype BGDT:PaymentCardVerificationValueText. PaymentCardVerificationValueAvailabilityCode may have a multiplicity of 0 . . . 1 and may be based on datatype BGDT:PaymentCardVerificationValueAvailabilityCode. PaymentCardVerificationValueCheckRequiredIndicator may have a multiplicity of 0 . . . 1 and may be based on datatype CDT:Indicator. AuthorisationRequiredIndicator may have a multiplicity of 0 . . . 1 and may be based on datatype CDT:Indicator. AuthorisationLimitAmount may have a multiplicity of 0 . . . 1 and may be based on datatype CDT:Amount. AuthorisationValueUnlimitedIndicator may have a multiplicity of 0 . . . 1 and may be based on datatype CDT:Indicator. Amount may have a multiplicity of 0 . . . 1 and may be based on datatype CDT:Amount. PaymentAuthorisedAmount may have a multiplicity of 0 . . . 1 and may be based on datatype CDT:Amount. CompanyClearingHouseID may have a multiplicity of 0 . . . 1 and may be based on datatype BGDT:PartyPartyID.

CreditCardPayment includes the node element CreditCardPaymentAuthorisation in a 1:CN cardinality relationship. CreditCardPaymentAuthorisation includes the following non-node elements: UUID, ID, ClearingHouseID, ProviderID, PaymentCardHolderAuthenticationID, PaymentCardHolderAuthenticationResultCode, PaymentCardHolderAuthenticationTokenText, DateTime, PaymentCardTransactionTypeCode, PreAuthorisationIndicator, Amount, ExpirationDateTime, ActiveIndicator, AppliedIndicator, ResultCode, PaymentCardAddressVerificationResultCode, ProductRecipientPartyPaymentCardAddressVerificationResultCode, PaymentCardVerificationResultCode, PaymentCardVerificationValueVerificationResultCode, and ResultDescription.

UUID may have a multiplicity of 0 . . . 1 and may be based on datatype BGDT:UUID. ID may have a multiplicity of 0 . . . 1 and may be based on datatype BGDT:PaymentCardPaymentAuthorisationPartyID_V1. ClearingHouseID may have a multiplicity of 0 . . . 1 and may be based on datatype BGDT:PaymentCardPaymentAuthorisationPartyID_V1. ProviderID may have a multiplicity of 0 . . . 1 and may be based on datatype BGDT:PaymentCardPaymentAuthorisationPartyID_V1. PaymentCardHolderAuthenticationID may have a multiplicity of 0 . . . 1 and may be based on datatype BGDT:PaymentCardHolderAuthenticationID. PaymentCardHolderAuthenticationResultCode may have a multiplicity of 0 . . . 1 and may be based on datatype BGDT:PaymentCardHolderAuthenticationResultCode. PaymentCardHolderAuthenticationTokenText may have a multiplicity of 0 . . . 1 and may be based on datatype BGDT:PaymentCardHolderAuthenticationTokenText. DateTime may have a multiplicity of 0 . . . 1 and may be based on datatype CDT:GLOBAL_DateTime. PaymentCardTransactionTypeCode may have a multiplicity of 0 . . . 1 and may be based on datatype BGDT:PaymentCardTransactionTypeCode. PreAuthorisationIndicator may have a multiplicity of 0 . . . 1 and may be based on datatype CDT:Indicator. Amount may have a multiplicity of 0 . . . 1 and may be based on datatype CDT:Amount. ExpirationDateTime may have a multiplicity of 0 . . . 1 and may be based on datatype CDT:GLOBAL_DateTime. ActiveIndicator may have a multiplicity of 0 . . . 1 and may be based on datatype CDT:Indicator. AppliedIndicator may have a multiplicity of 0 . . . 1 and may be based on datatype CDT:Indicator. ResultCode may have a multiplicity of 0 . . . 1 and may be based on datatype BGDT:AuthorisationResultCode. PaymentCardAddressVerificationResultCode may have a multiplicity of 0 . . . 1 and may be based on datatype BGDT:PaymentCardAddressVerificationResultCode. ProductRecipientPartyPaymentCardAddressVerificationResultCode may have a multiplicity of 0 . . . 1 and may be based on datatype BGDT:PaymentCardAddressVerificationResultCode. PaymentCardVerificationResultCode may have a multiplicity of 0 . . . 1 and may be based on datatype BGDT:PaymentCardVerificationResultCode. PaymentCardVerificationValueVerificationResultCode may have a multiplicity of 0 . . . 1 and may be based on datatype BGDT:PaymentCardVerificationValueVerificationResultCode. ResultDescription may have a multiplicity of 0 . . . 1 and may be based on datatype BGDT:SHORT_Description.

The package SalesOrderPriceAndTaxCalculation includes the entity PriceAndTaxCalculation. PriceAndTaxCalculation includes the following node elements: MainDiscount, in a 1:C cardinality relationship; MainPrice, in a 1:C cardinality relationship; MainSurcharge, in a 1:C cardinality relationship; MainTotal, in a 1:C cardinality relationship; PriceComponent, in a 1:CN cardinality relationship; ProductTaxDetails, in a 1:CN cardinality relationship; TaxationTerms, in a 1:C cardinality relationship; and WithholdingTaxDetails, in a 1:CN cardinality relationship.

The package SalesOrderPriceAndTaxCalculation includes the entities MainDiscount, MainPrice, MainSurcharge, MainTotal, PriceComponent, ProductTaxDetails, TaxationTerms, and WithholdingTaxDetails. MainDiscount includes the following non-node elements: Description, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode.

Description may have a multiplicity of 0 . . . 1 and may be based on datatype BGDT:SHORT_Description. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

MainPrice includes the following non-node elements: Description, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode. Description may have a multiplicity of 0 . . . 1 and may be based on datatype BGDT:SHORT_Description. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

MainSurcharge includes the following non-node elements: Description, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode. Description may have a multiplicity of 0 . . . 1 and may be based on datatype BGDT:SHORT_Description. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

MainTotal includes the following non-node elements: Description, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode. Description may have a multiplicity of 0 . . . 1 and may be based on datatype BGDT:SHORT_Description. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

PriceComponent includes the following non-node elements: UUID, Description, MajorLevelOrdinalNumberValue, MinorLevelOrdinalNumberValue, TypeCode, CategoryCode, PurposeCode, Rate, RateBaseQuantityTypeCode, CalculationBasis, CalculatedAmount, RoundingDifferenceAmount, EffectiveIndicator, GroupedIndicator, ManuallyChangedIndicator, DescriptionManuallyChangedIndicator, FixationCode, InactivityReasonCode, and OriginCode. UUID may have a multiplicity of 0 . . . 1 and may be based on datatype BGDT:UUID. Description may have a multiplicity of 0 . . . 1 and may be based on datatype BGDT:SHORT_Description. MajorLevelOrdinalNumberValue may have a multiplicity of 0 . . . 1 and may be based on datatype BGDT:OrdinalNumberValue. MinorLevelOrdinalNumberValue may have a multiplicity of 0 . . . 1 and may be based on datatype BGDT:OrdinalNumberValue. TypeCode may have a multiplicity of 0 . . . 1 and may be based on datatype BGDT:PriceSpecificationElementTypeCode. CategoryCode may have a multiplicity of 0 . . . 1 and may be based on datatype BGDT:PriceSpecificationElementCategoryCode. PurposeCode may have a multiplicity of 0 . . . 1 and may be based on datatype BGDT:PriceSpecificationElementPurposeCode. Rate may have a multiplicity of 0 . . . 1 and may be based on datatype AGDT:Rate. RateBaseQuantityTypeCode may have a multiplicity of 0 . . . 1 and may be based on datatype BGDT:QuantityTypeCode. CalculationBasis may have a multiplicity of 0 . . . 1 and may be based on datatype AGDT:PriceComponentCalculationBasis. CalculatedAmount may have a multiplicity of 0 . . . 1 and may be based on datatype CDT:Amount. RoundingDifferenceAmount may have a multiplicity of 0 . . . 1 and may be based on datatype CDT:Amount. EffectiveIndicator may have a multiplicity of 0 . . . 1 and may be based on datatype CDT:Indicator. GroupedIndicator may have a multiplicity of 0 . . . 1 and may be based on datatype CDT:Indicator. ManuallyChangedIndicator may have a multiplicity of 0 . . . 1 and may be based on datatype CDT:Indicator. DescriptionManuallyChangedIndicator may have a multiplicity of 0 . . . 1 and may be based on datatype CDT:Indicator. FixationCode may have a multiplicity of 0 . . . 1 and may be based on datatype BGDT:PriceComponentFixationCode. InactivityReasonCode may have a multiplicity of 0 . . . 1 and may be based on datatype BGDT:PriceComponentInactivityReasonCode. OriginCode may have a multiplicity of 0 . . . 1 and may be based on datatype BGDT:PriceComponentOriginCode.

ProductTaxDetails includes the following non-node elements: UUID, TaxationCharacteristicsCode, TransactionCurrencyProductTax, and ProductTax. UUID may have a multiplicity of 0 . . . 1 and may be based on datatype BGDT:UUID. TaxationCharacteristicsCode may have a multiplicity of 0 . . . 1 and may be based on datatype BGDT:ProductTaxationCharacteristicsCode. TransactionCurrencyProductTax may have a multiplicity of 0 . . . 1 and may be based on datatype AGDT:ProductTax. ProductTax may have a multiplicity of 0 . . . 1 and may be based on datatype AGDT:ProductTax.

TaxationTerms includes the following non-node elements: SellerCountryCode, SellerTaxID, SellerTaxIdentificationNumberTypeCode, BuyerCountryCode, BuyerTaxID, BuyerTaxIdentificationNumberTypeCode, EuropeanCommunityVATTriangulationIndicator, TaxDate, TaxDueDate, TaxExemptionCertificateID, TaxExemptionReasonCode, and TaxExemptionReasonCodeRelevanceIndicator. SellerCountryCode may have a multiplicity of 0 . . . 1 and may be based on datatype BGDT:CountryCode. SellerTaxID may have a multiplicity of 0 . . . 1 and may be based on datatype BGDT:PartyTaxID. SellerTaxIdentificationNumberTypeCode may have a multiplicity of 0 . . . 1 and may be based on datatype BGDT:TaxIdentificationNumberTypeCode. BuyerCountryCode may have a multiplicity of 0 . . . 1 and may be based on datatype BGDT:CountryCode. BuyerTaxID may have a multiplicity of 0 . . . 1 and may be based on datatype BGDT:PartyTaxID. BuyerTaxIdentificationNumberTypeCode may have a multiplicity of 0 . . . 1 and may be based on datatype BGDT:TaxIdentificationNumberTypeCode. EuropeanCommunityVATTriangulationIndicator may have a multiplicity of 0 . . . 1 and may be based on datatype CDT:Indicator. TaxDate may have a multiplicity of 0 . . . 1 and may be based on datatype CDT:Date. TaxDueDate may have a multiplicity of 0 . . . 1 and may be based on datatype CDT:Date. TaxExemptionCertificateID may have a multiplicity of 0 . . . 1 and may be based on datatype BGDT:TaxExemptionCertificateID. TaxExemptionReasonCode may have a multiplicity of 0 . . . 1 and may be based on datatype BGDT:TaxExemptionReasonCode. TaxExemptionReasonCodeRelevanceIndicator may have a multiplicity of 0 . . . 1 and may be based on datatype CDT:Indicator.

WithholdingTaxDetails includes the following non-node elements: UUID, WithholdingTax, and TransactionCurrencyWithholdingTax. UUID may have a multiplicity of 0 . . . 1 and may be based on datatype BGDT:UUID. WithholdingTax may have a multiplicity of 0 . . . 1 and may be based on datatype AGDT:WithholdingTax. TransactionCurrencyWithholdingTax may have a multiplicity of 0 . . . 1 and may be based on datatype AGDT:WithholdingTax.

The package SalesOrderTextCollection includes the entity TextCollection. TextCollection includes the Text node element in a 1:CN cardinality relationship. The package SalesOrderTextCollection includes the entity Text. Text includes the following non-node elements: TypeCode, CreationDateTime, and ContentText. TypeCode may have a multiplicity of 0 . . . 1 and may be based on datatype BGDT:TextCollectionTextTypeCode. CreationDateTime may have a multiplicity of 0 . . . 1 and may be based on datatype CDT:GLOBAL_DateTime. ContentText may have a multiplicity of 0 . . . 1 and may be based on datatype CDT:LANGUAGEINDEPENDENT_Text.

The package SalesOrderAttachmentFolder includes the entity AttachmentFolder. AttachmentFolder includes the UUID non-node element, which may have a multiplicity of 0 . . . 1 and may be based on datatype BGDT:UUID. AttachmentFolder includes the node element Document in a 1:CN cardinality relationship.

The package SalesOrderAttachmentFolder includes the entity Document. Document includes the following non-node elements: UUID, VersionID, SystemAdministrativeData, LinkInternalIndicator, CheckedOutIndicator, VisibleIndicator, VersioningEnabledIndicator, CategoryCode, CategoryName, TypeCode, TypeName, MIMECode, MIMEName, PathName, Name, AlternativeName, InternalLinkUUID, Description, ExternalLinkWebURI, FileContentURI, and FilesizeMeasure. UUID may have a multiplicity of 0 . . . 1 and may be based on datatype BGDT:UUID. VersionID may have a multiplicity of 0 . . . 1 and may be based on datatype BGDT:VersionID. SystemAdministrativeData may have a multiplicity of 0 . . . 1 and may be based on datatype AGDT:SystemAdministrativeData. LinkInternalIndicator may have a multiplicity of 0 . . . 1 and may be based on datatype CDT:Indicator. CheckedOutIndicator may have a multiplicity of 0 . . . 1 and may be based on datatype CDT:Indicator. VisibleIndicator may have a multiplicity of 0 . . . 1 and may be based on datatype CDT:Indicator. VersioningEnabledIndicator may have a multiplicity of 0 . . . 1 and may be based on datatype CDT:Indicator. CategoryCode may have a multiplicity of 0 . . . 1 and may be based on datatype BGDT:DocumentCategoryCode. CategoryName may have a multiplicity of 0 . . . 1 and may be based on datatype CDT:LANGUAGEINDEPENDENT_LONG_Name. TypeCode may have a multiplicity of 0 . . . 1 and may be based on datatype BGDT:DocumentTypeCode. TypeName may have a multiplicity of 0 . . . 1 and may be based on datatype CDT:LANGUAGEINDEPENDENT_LONG_Name. MIMECode may have a multiplicity of 0 . . . 1 and may be based on datatype BGDT:MIMECode. MIMEName may have a multiplicity of 0 . . . 1 and may be based on datatype CDT:LANGUAGEINDEPENDENT_LONG_Name. PathName may have a multiplicity of 0 . . . 1 and may be based on datatype CDT:LANGUAGEINDEPENDENT_Name. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. FileContentURI may have a multiplicity of 0 . . . 1 and may be based on datatype BGDT:URI. FilesizeMeasure may have a multiplicity of 0 . . . 1 and may be based on datatype CDT:Measure.

Document includes the node element Property, in a 1:CN cardinality relationship. Property includes the following non-node elements: TechnicalID, Name, DataTypeFormatCode, DataTypeFormatName, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. DataTypeFormatName may have a multiplicity of 0 . . . 1 and may be based on datatype CDT:LANGUAGEINDEPENDENT_LONG_Name. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description.

Property includes the node element PropertyValue in a 1:CN cardinality relationship. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

The package ProcessingConditions includes the entity ProcessingConditions. ProcessingConditions is typed by datatype ResponseProcessingConditions. The package Log includes the entity Log. Log is typed by datatype Log.

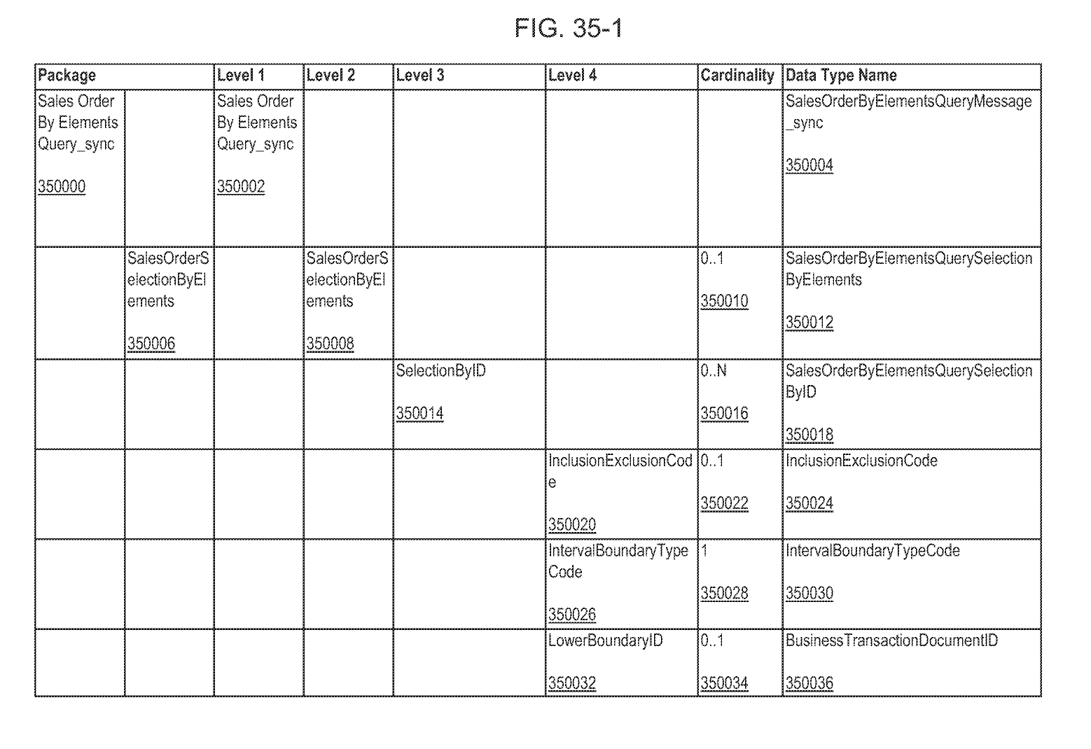

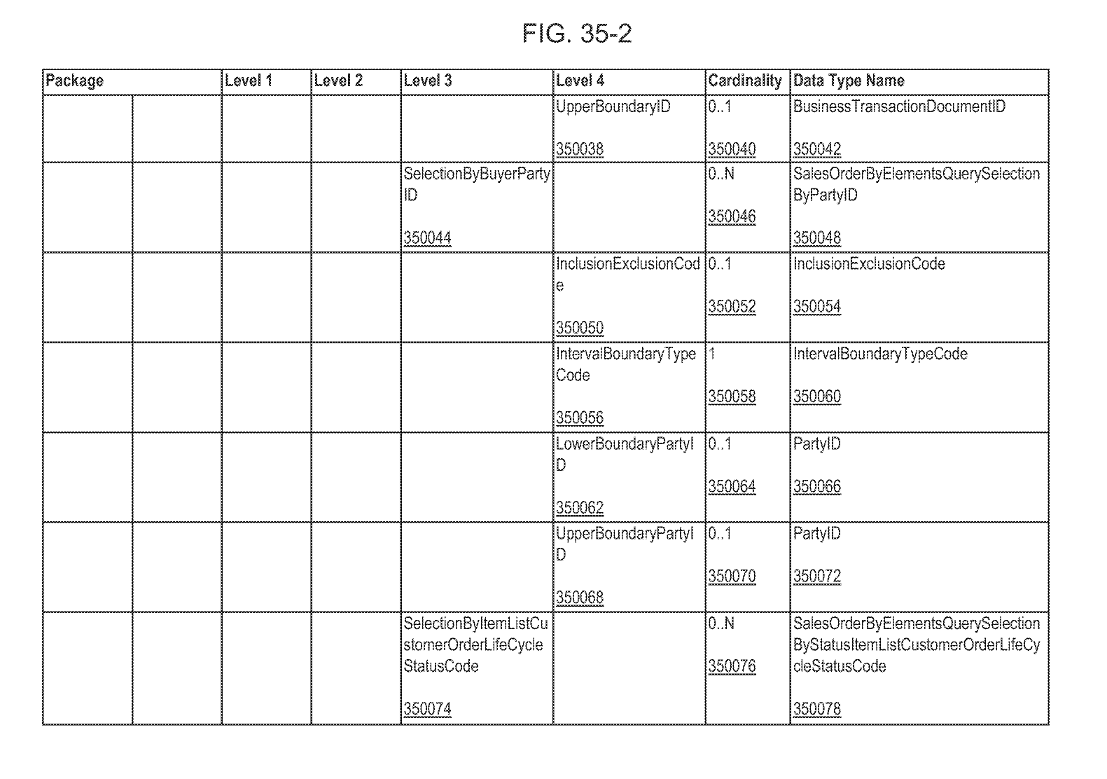

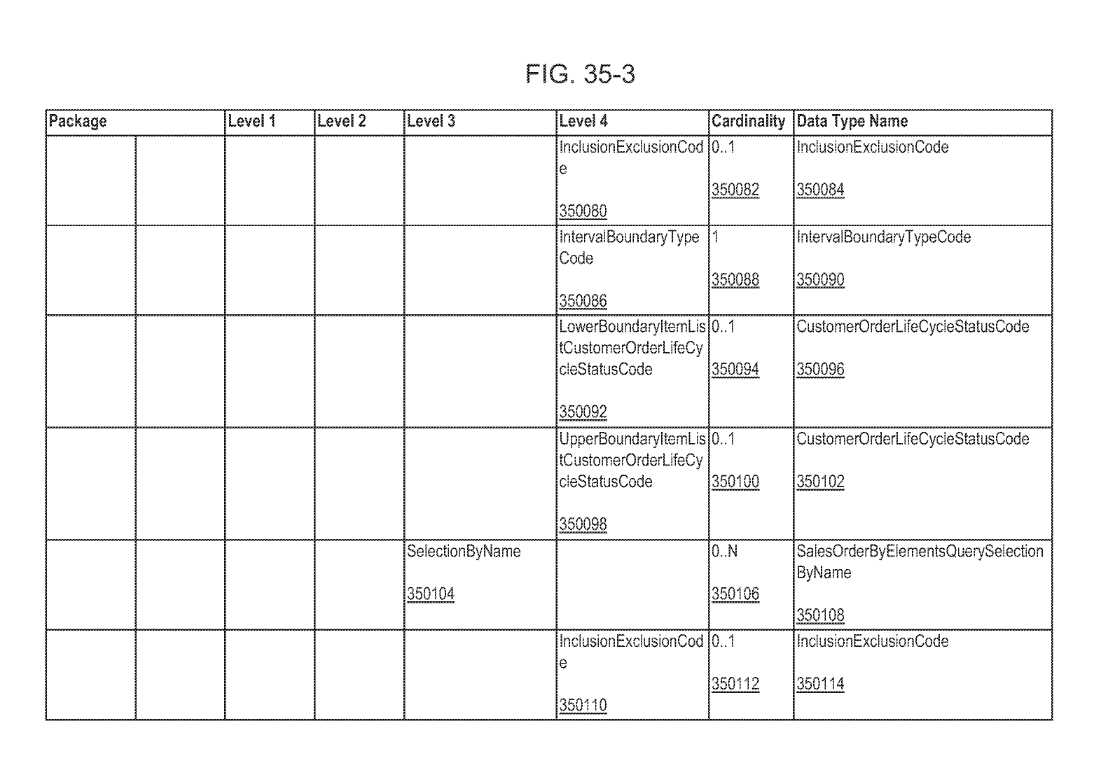

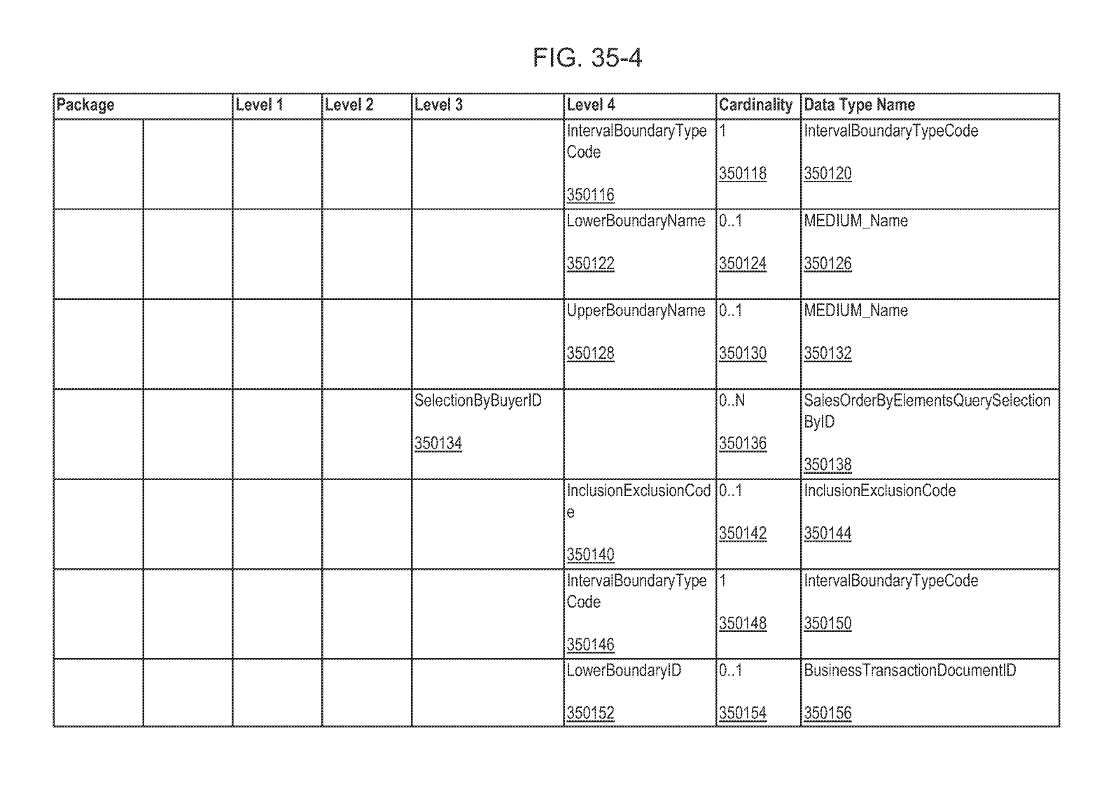

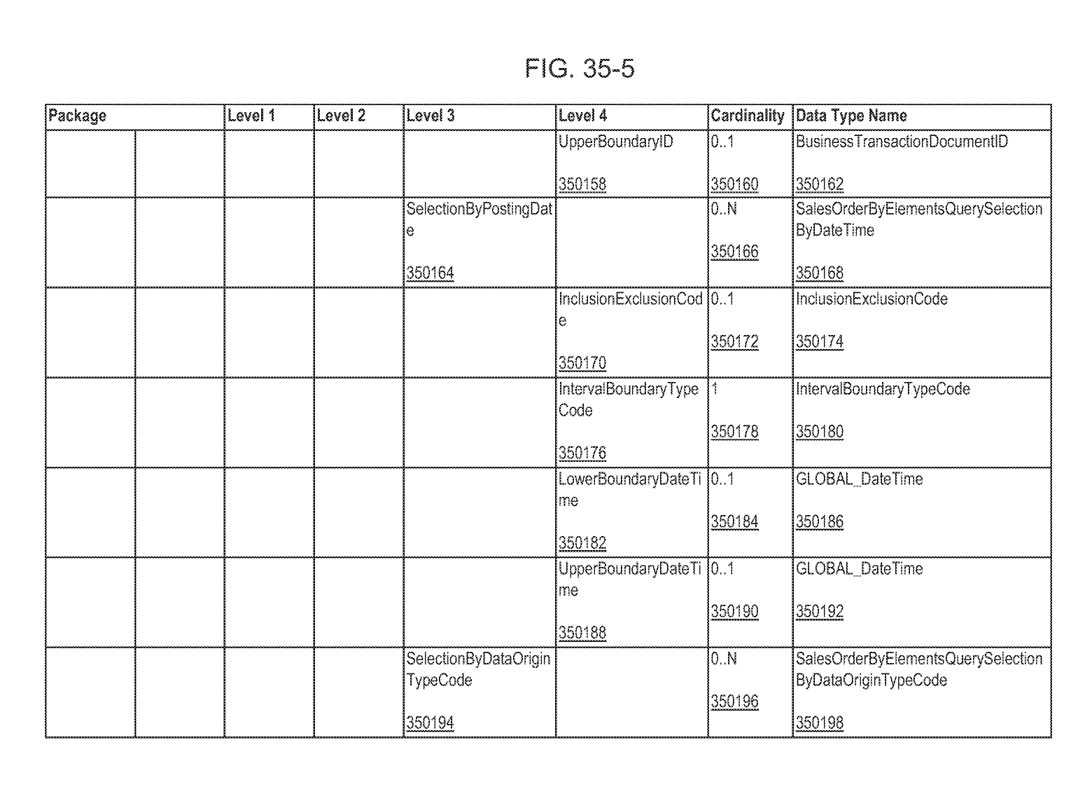

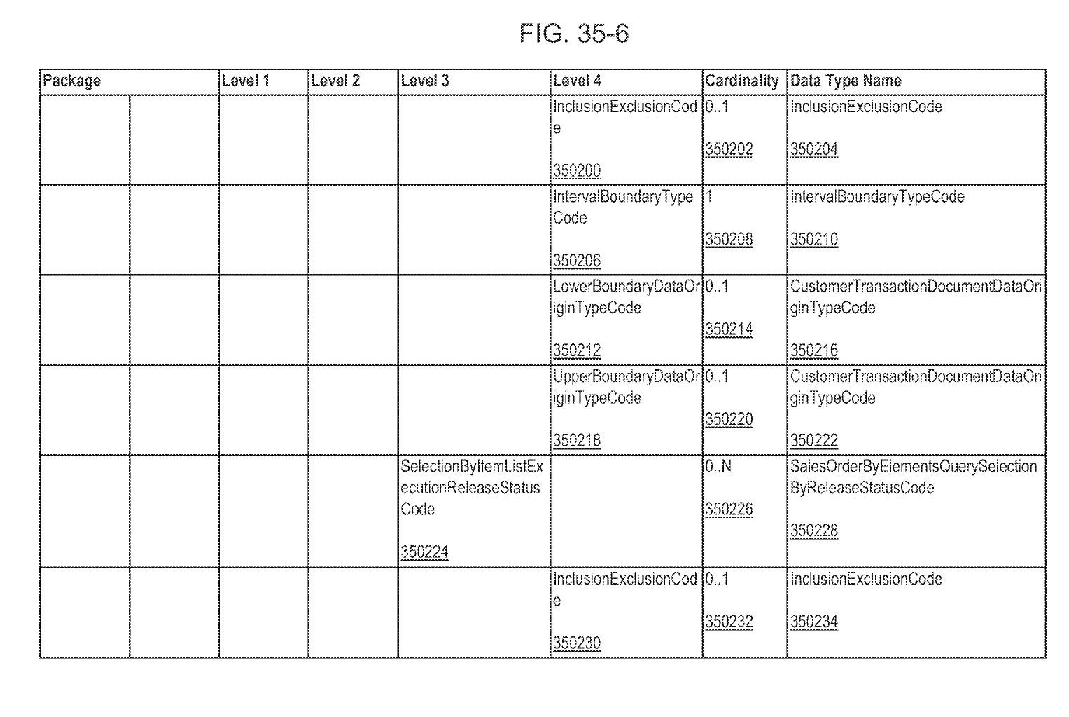

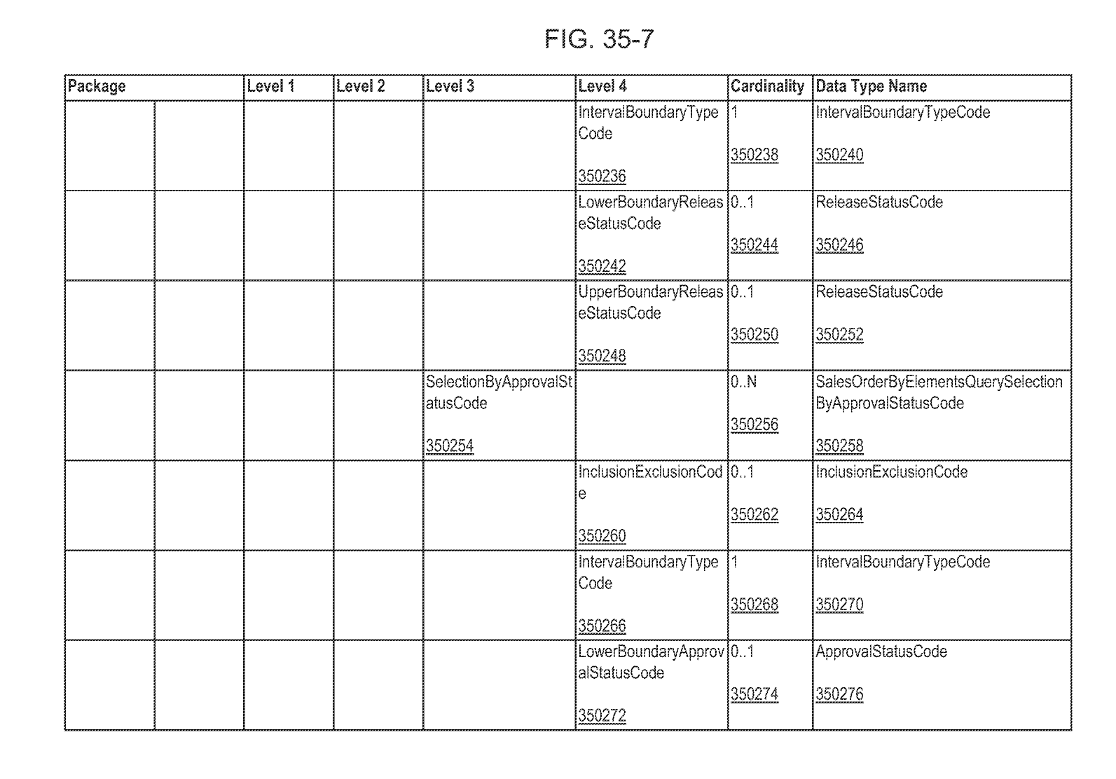

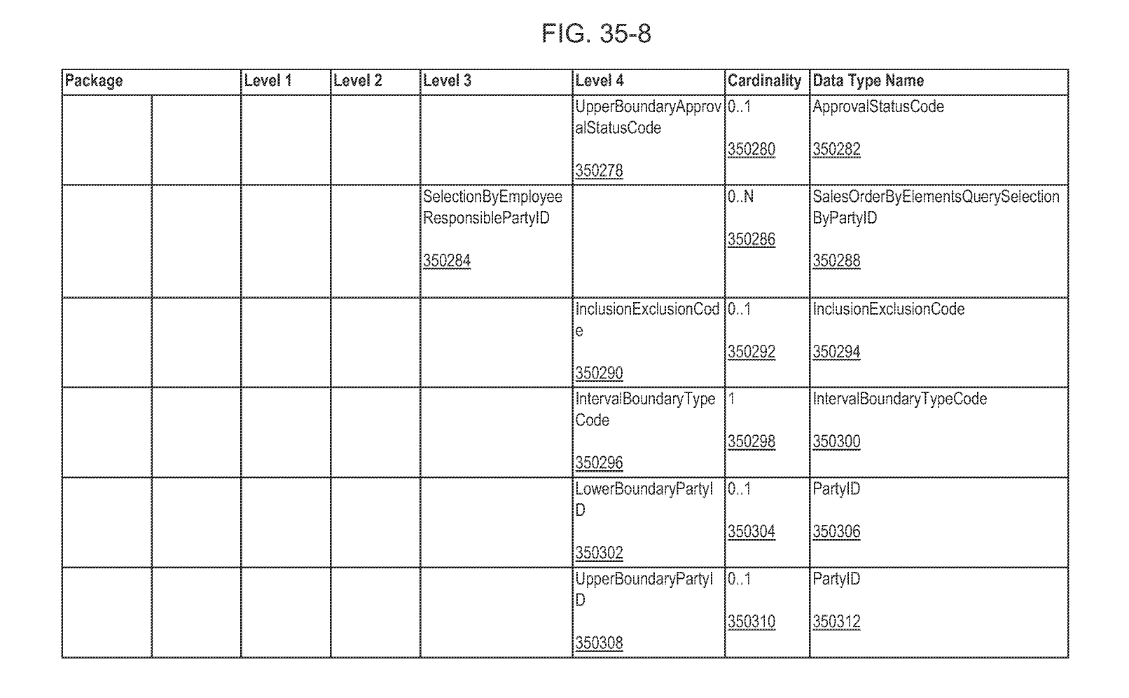

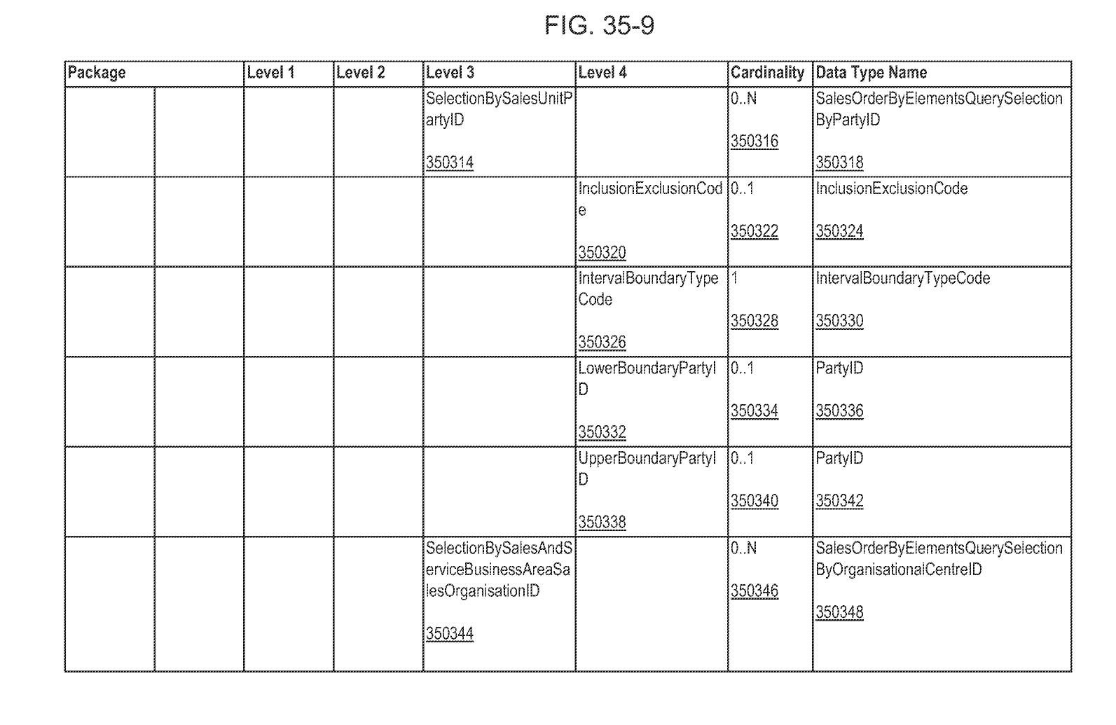

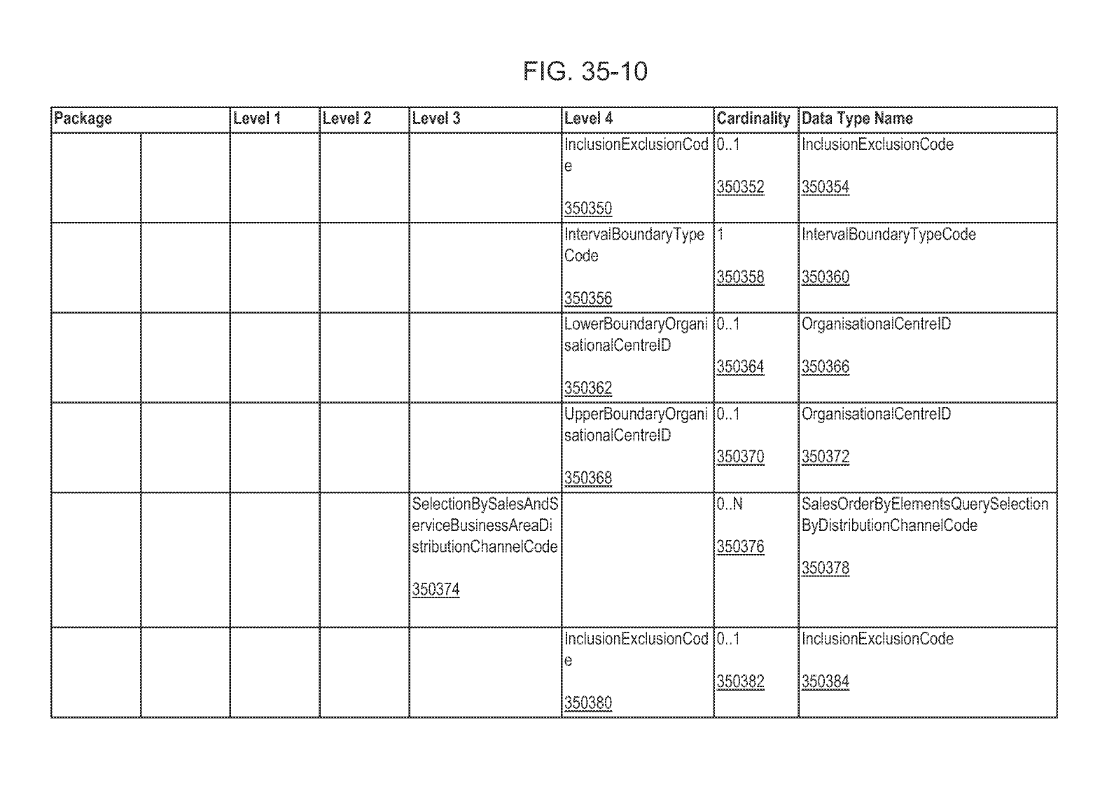

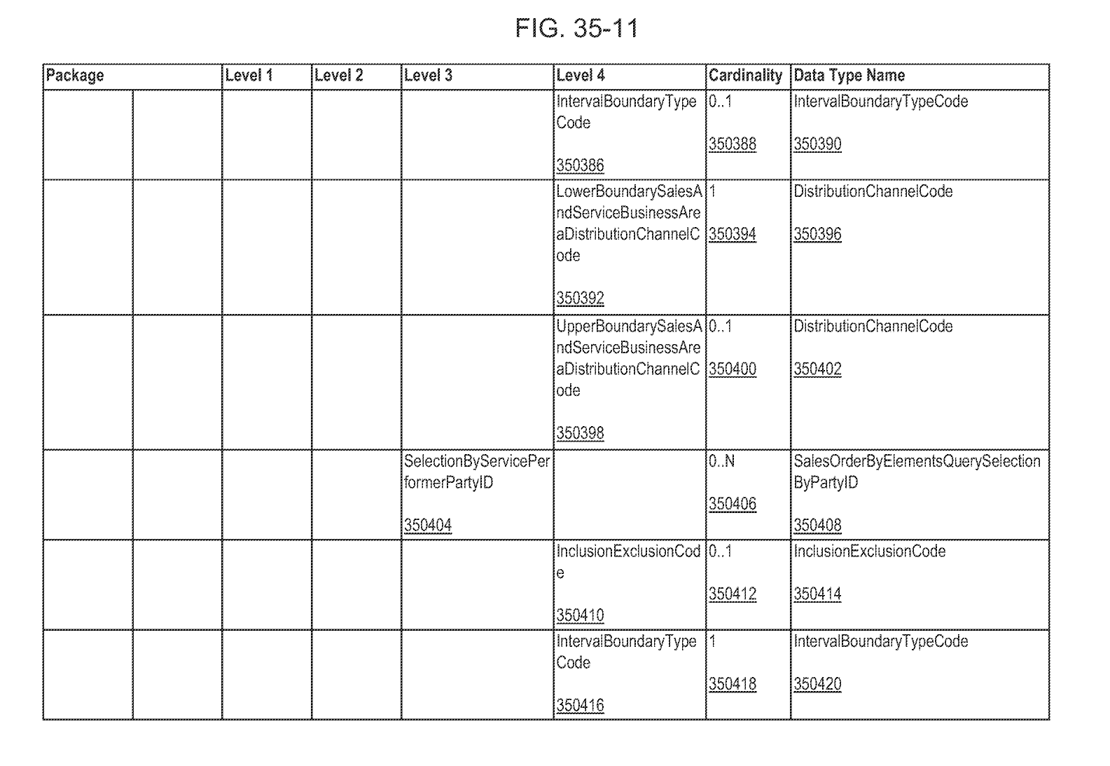

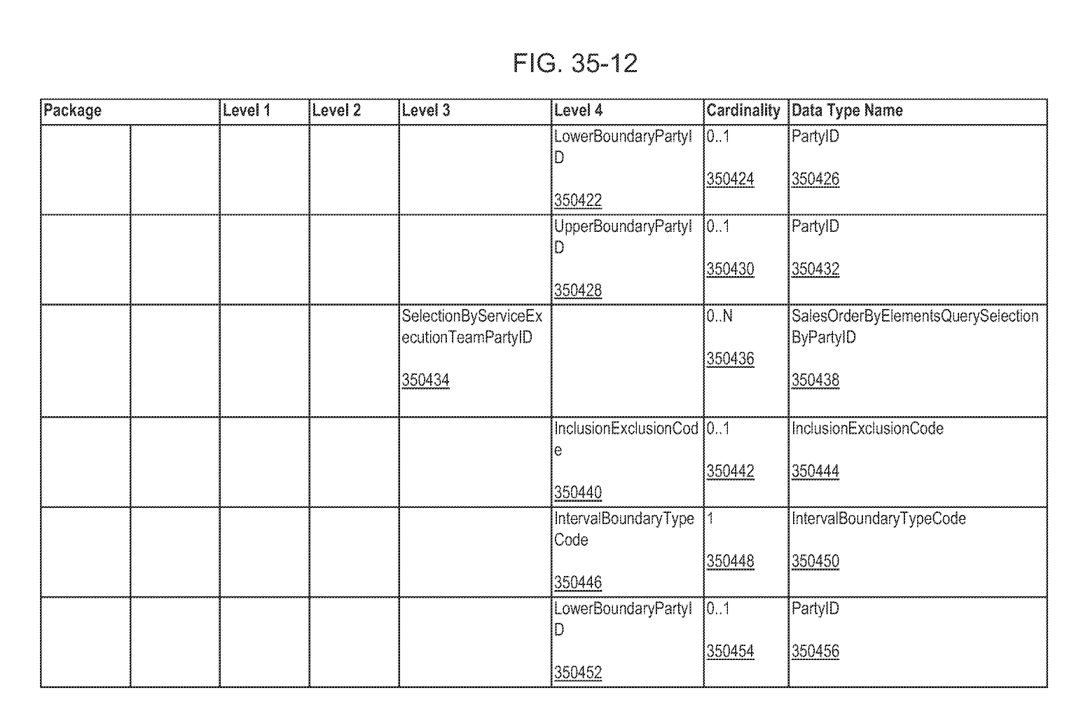

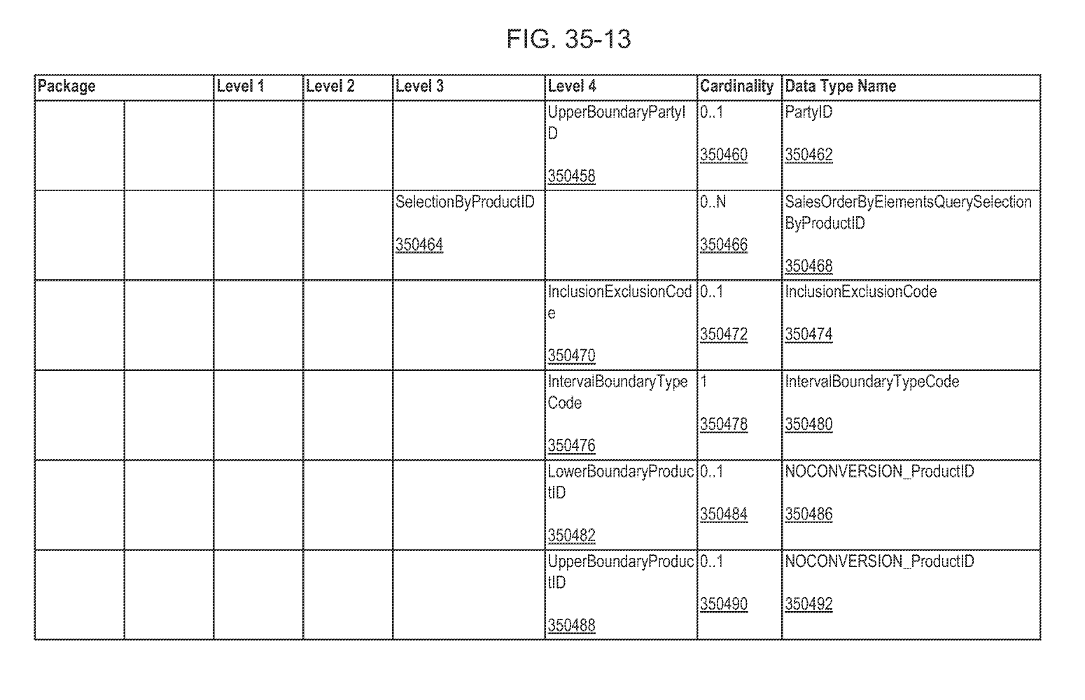

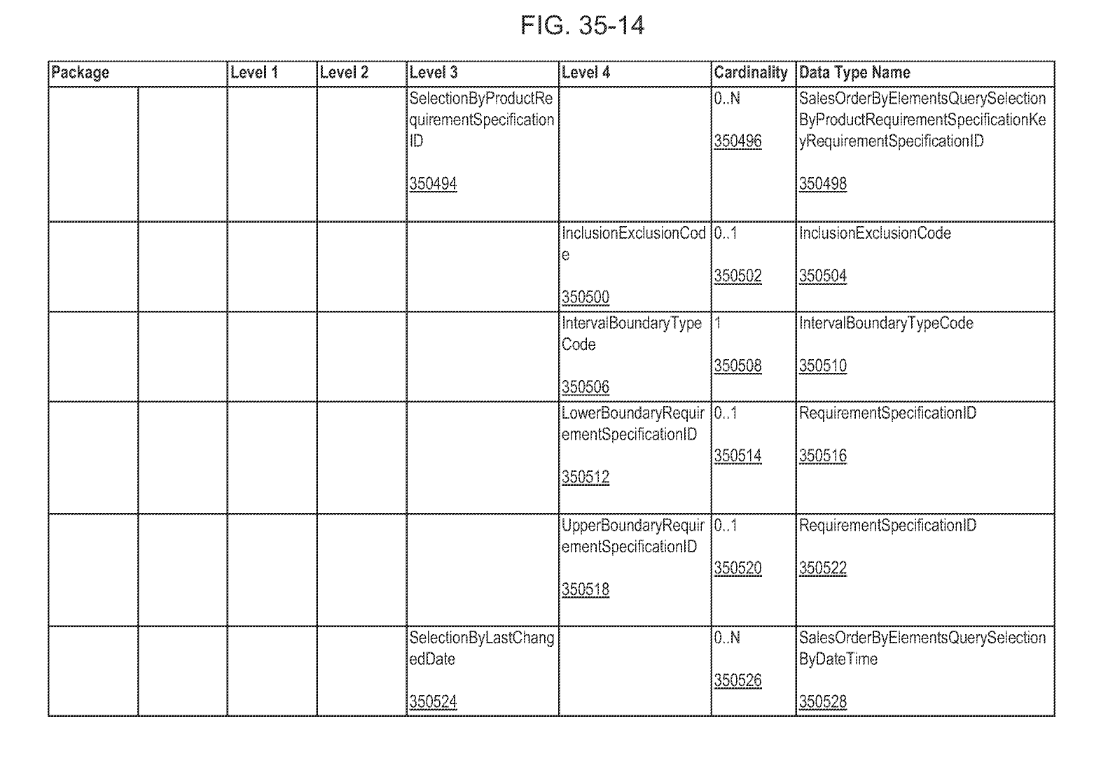

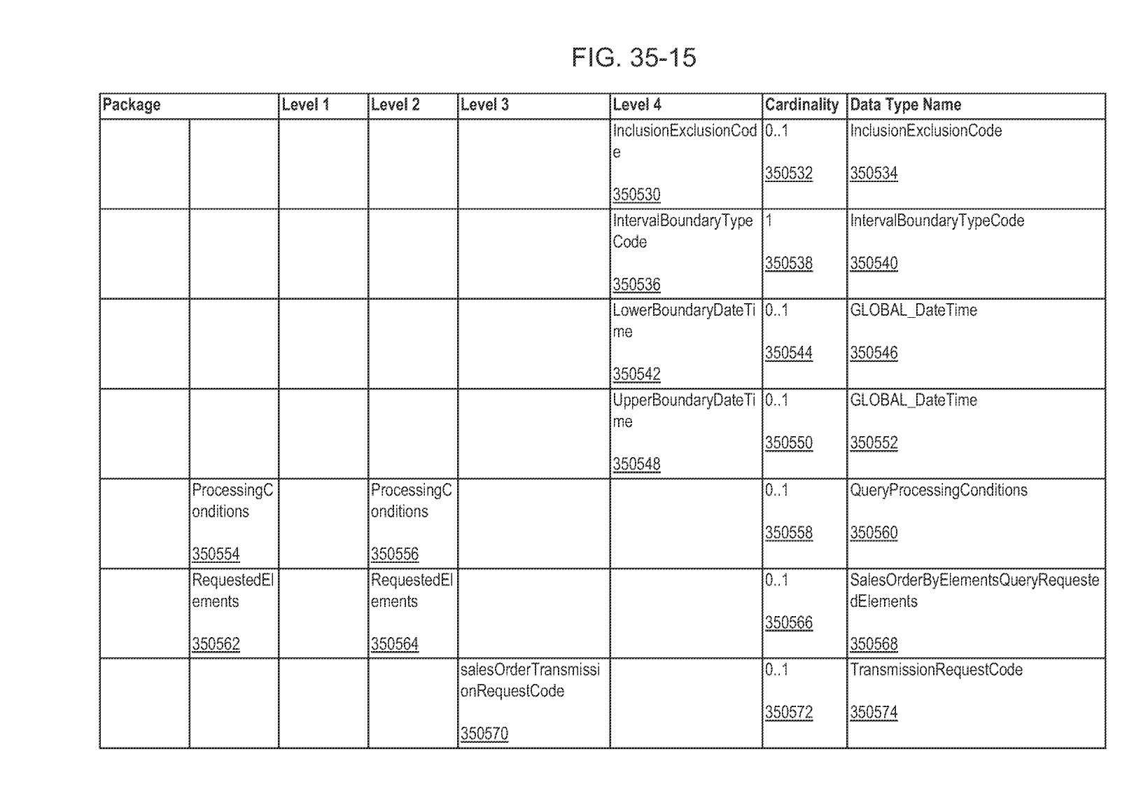

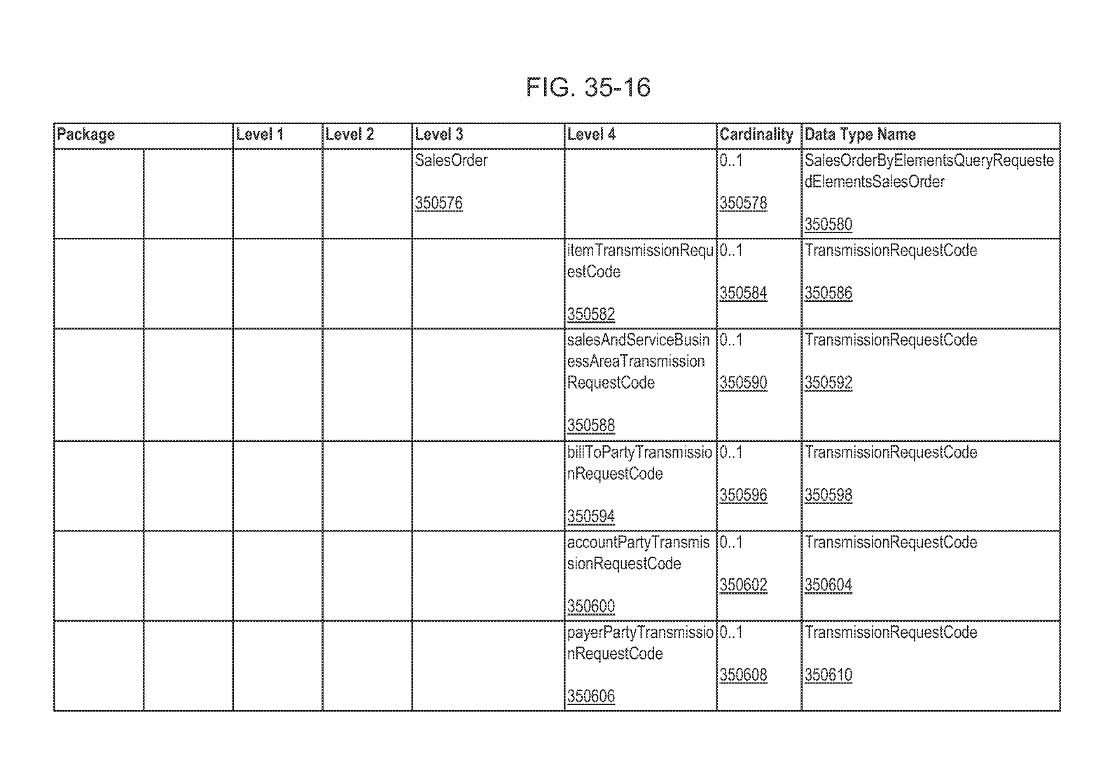

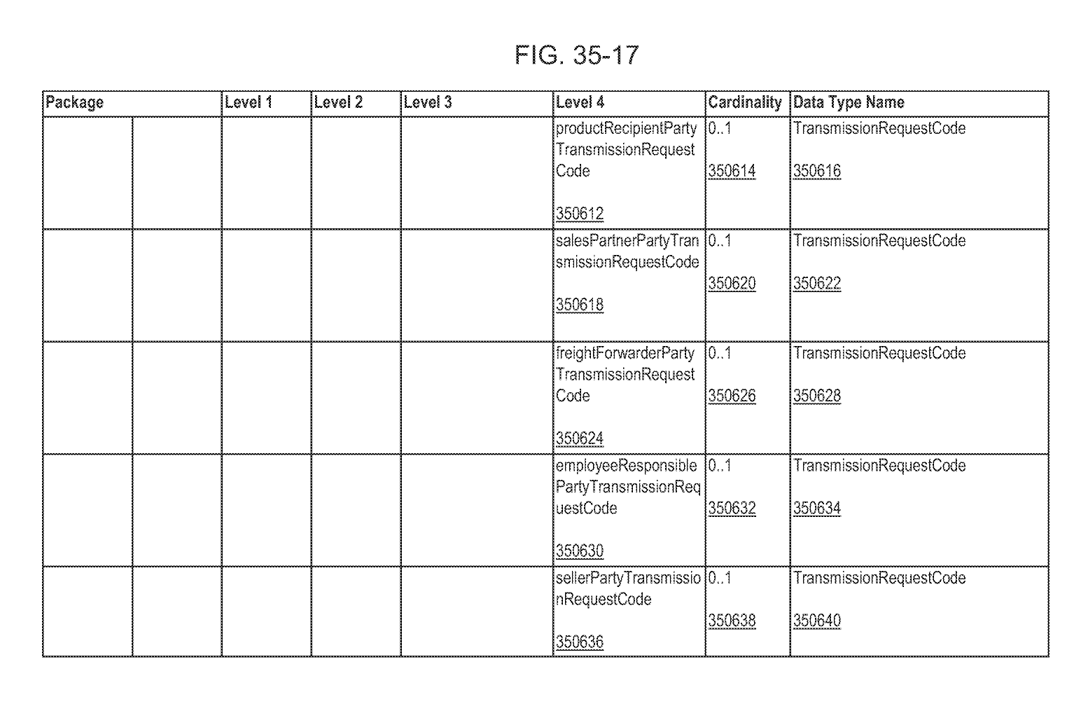

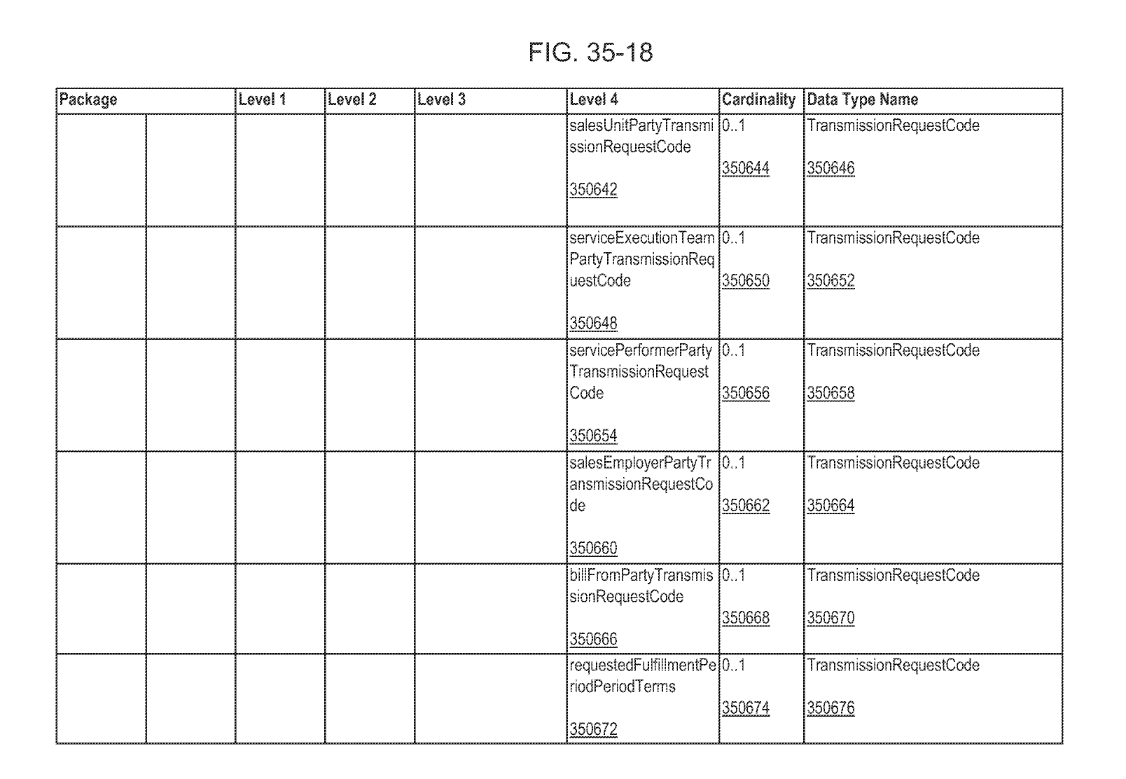

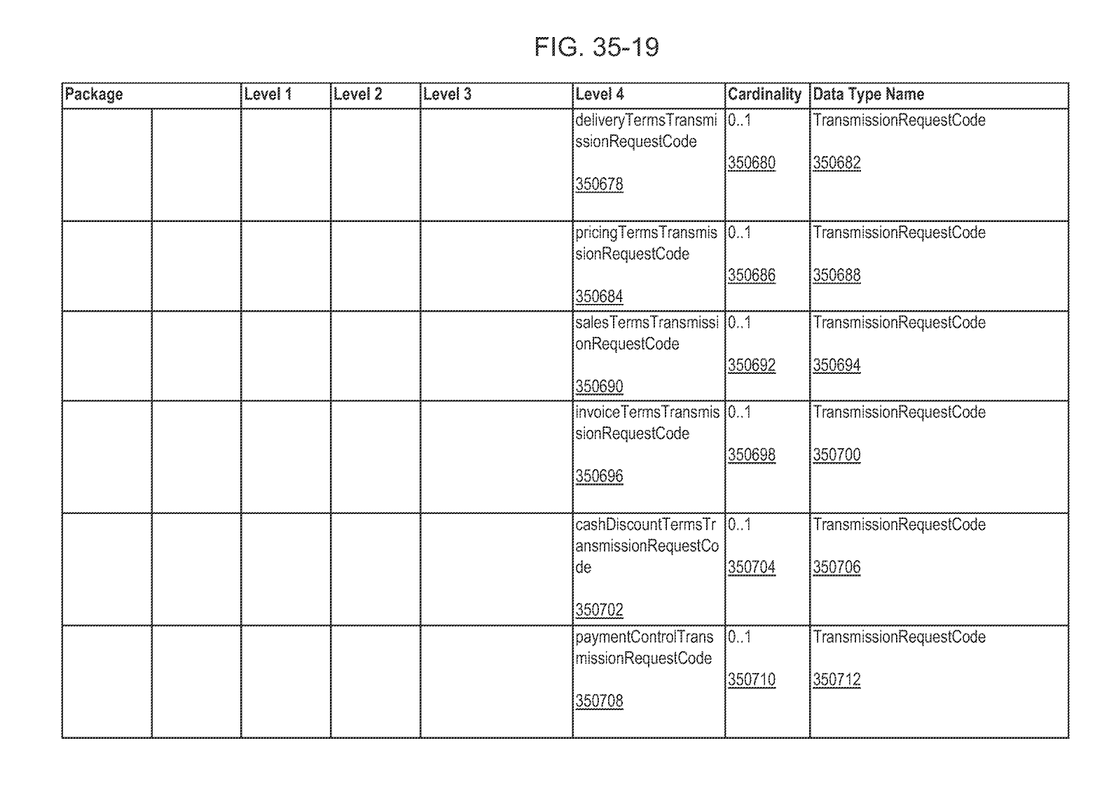

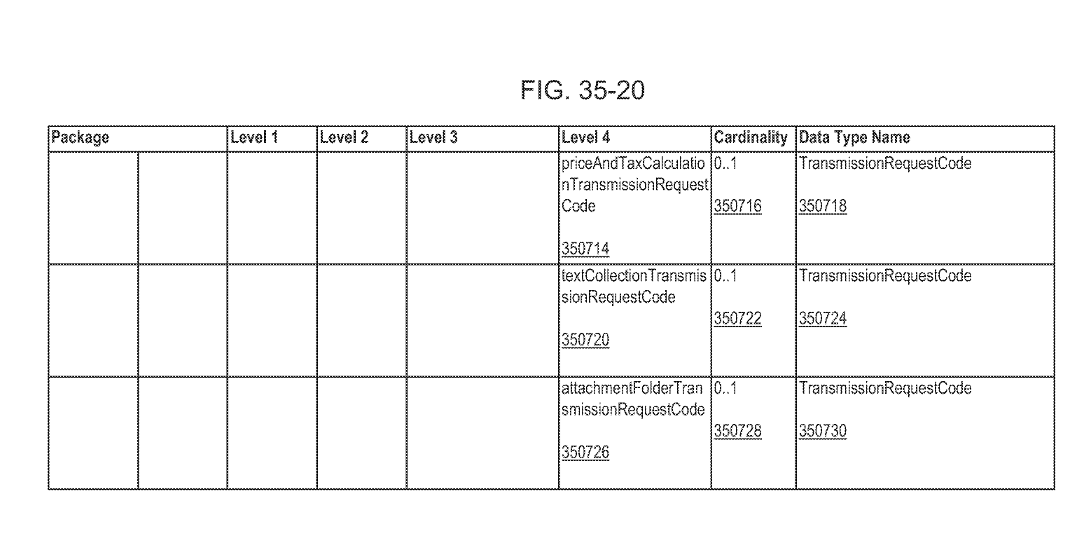

FIGS. 35-1 through 35-20 show an example configuration of an Element Structure that includes a Sales Order By Elements Query_sync 350000 package. Specifically, these figures depict the arrangement and hierarchy of various components such as one or more levels of packages, entities, and datatypes, shown here as 350000 through 350730. As described above, packages may be used to represent hierarchy levels. Entities are discrete business elements that are used during a business transaction. Data types are used to type object entities and interfaces with a structure. For example, the Sales Order By Elements Query_sync 350000 includes, among other things, a Sales Order By Elements Query_sync 350002. Accordingly, heterogeneous applications may communicate using this consistent message configured as such.

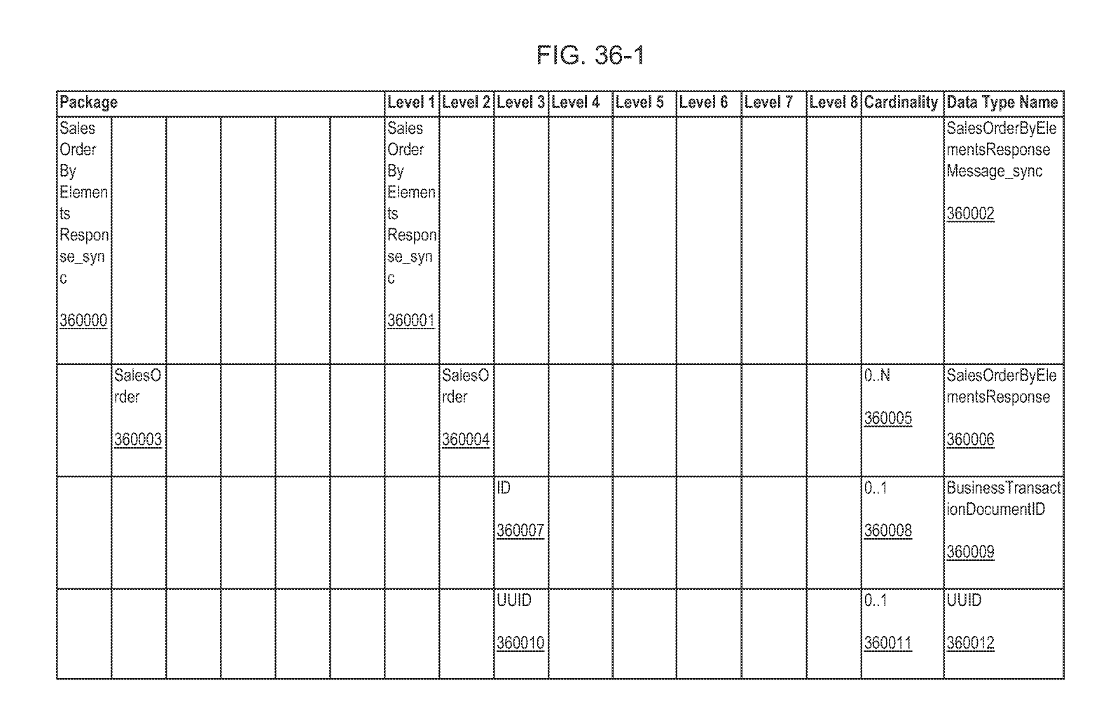

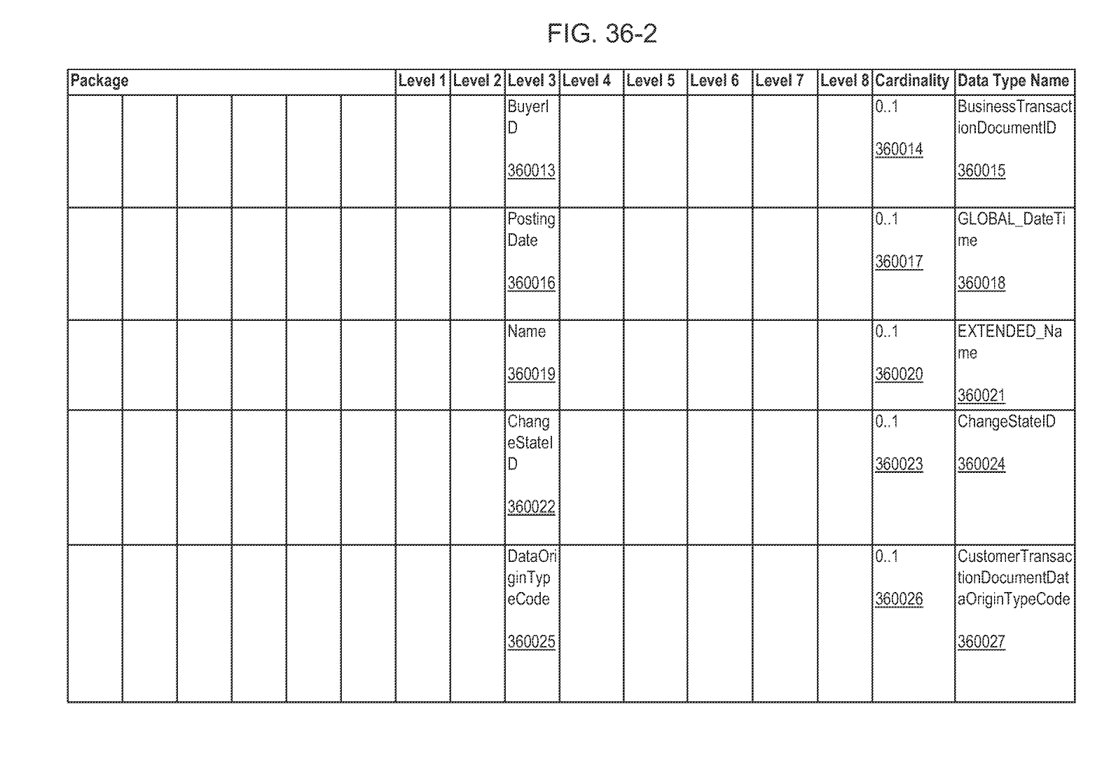

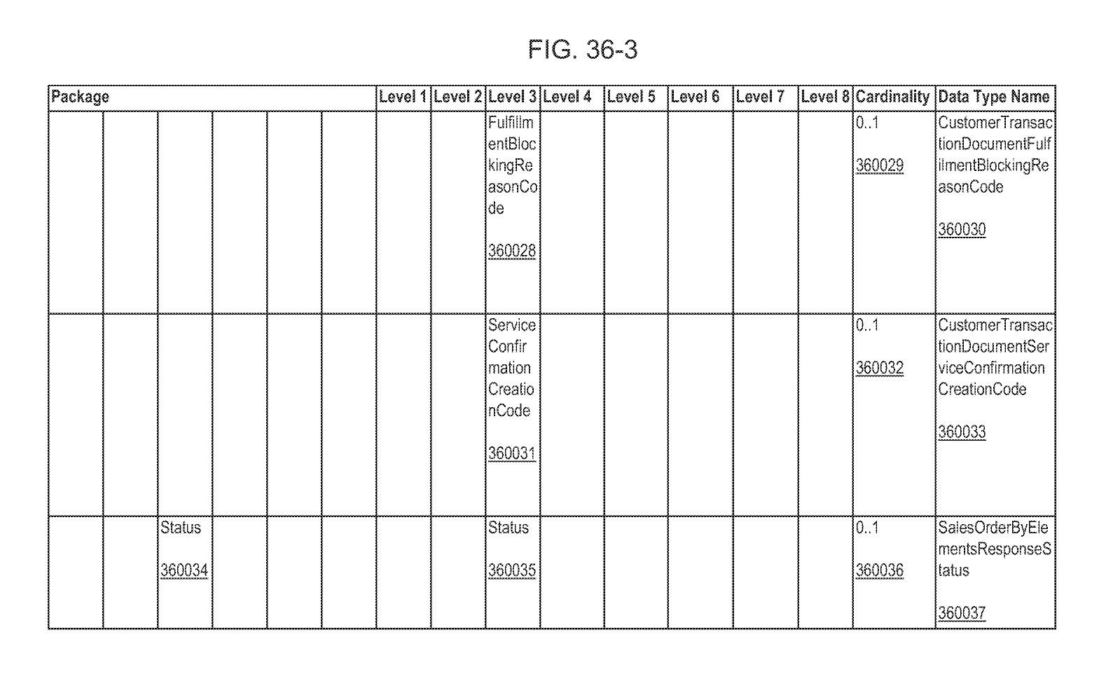

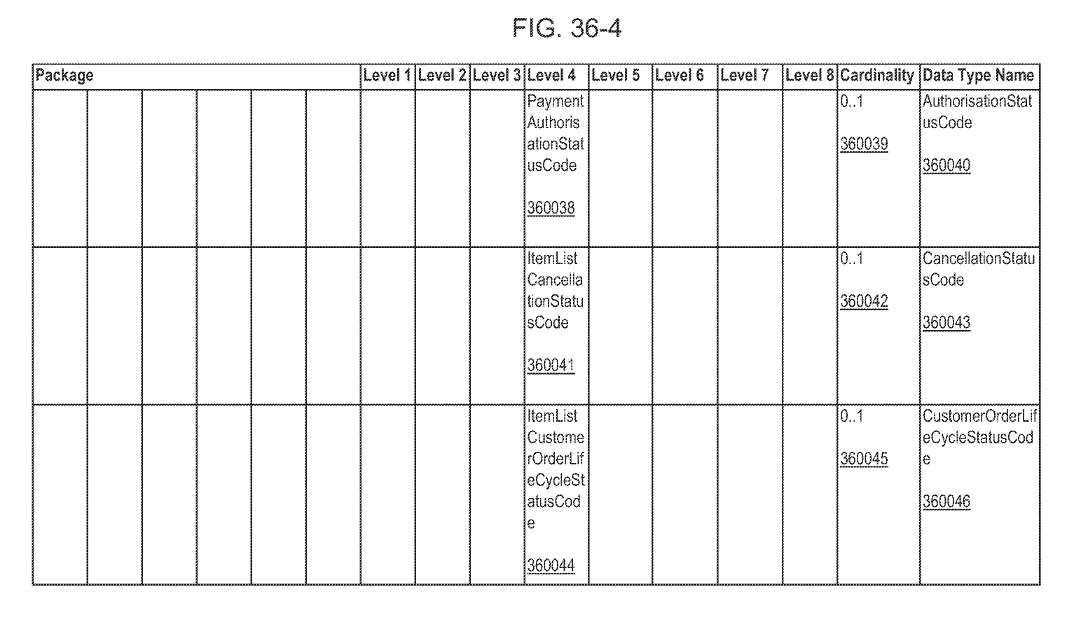

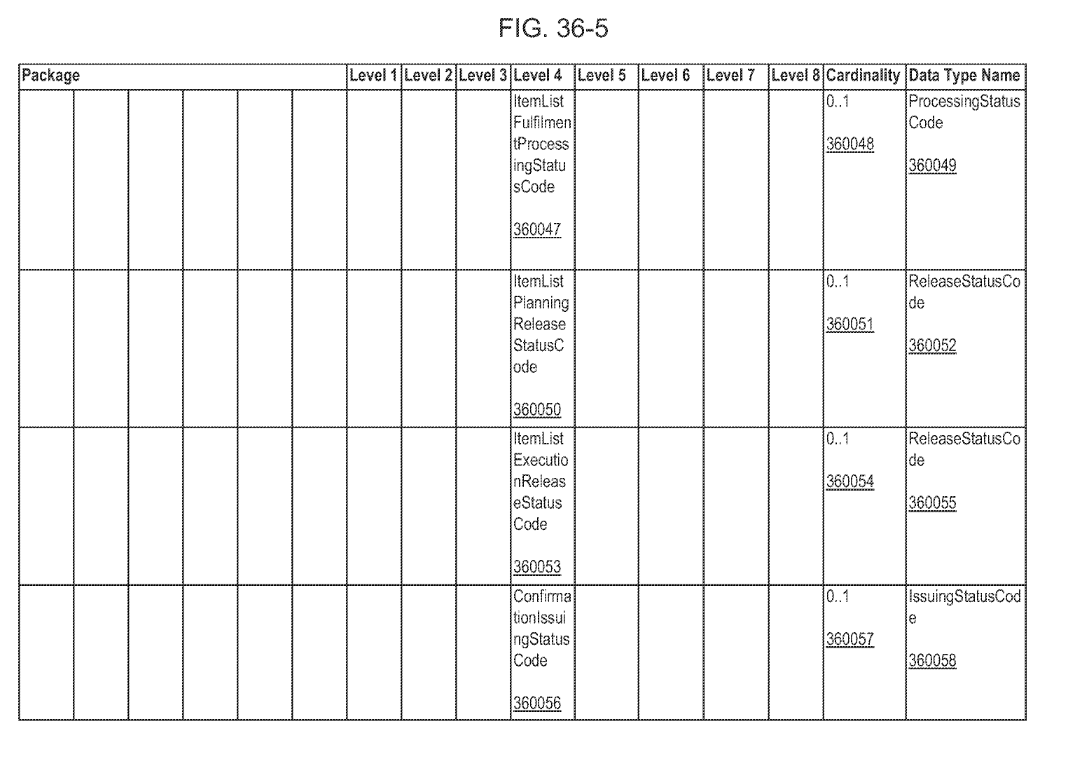

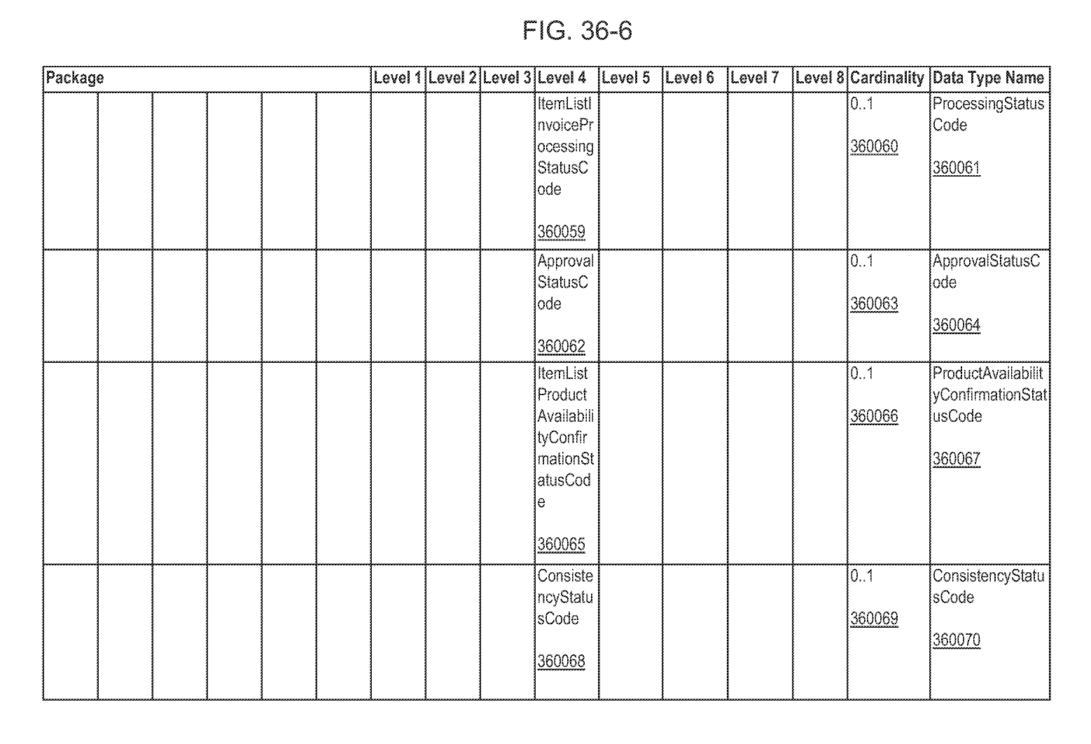

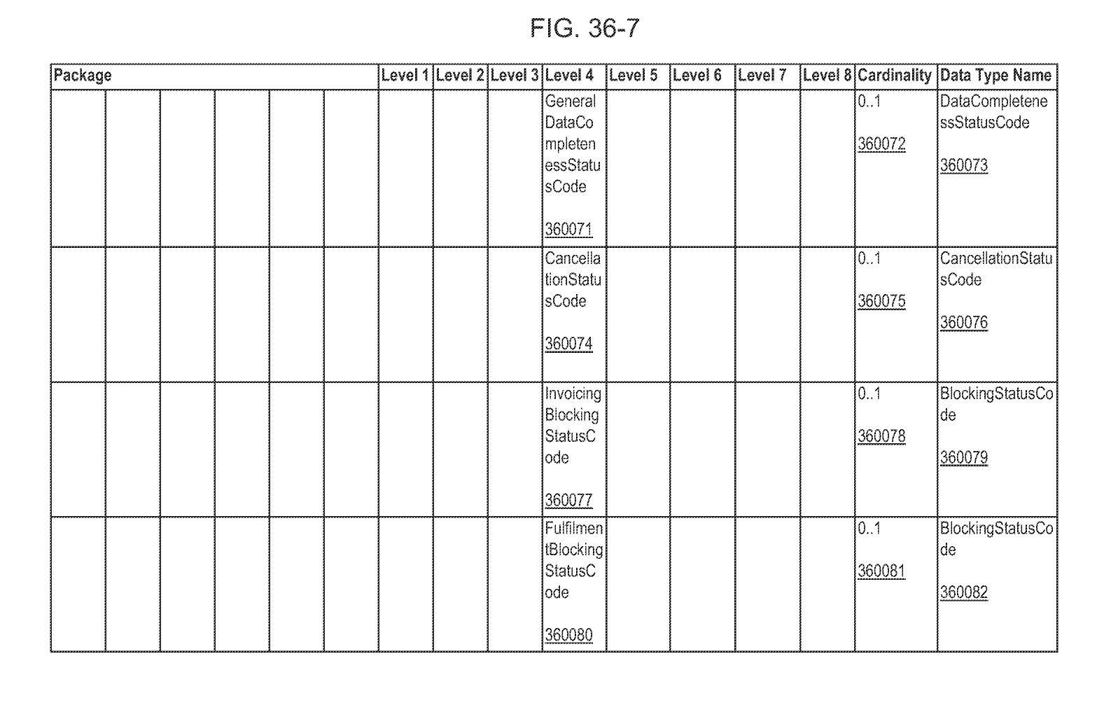

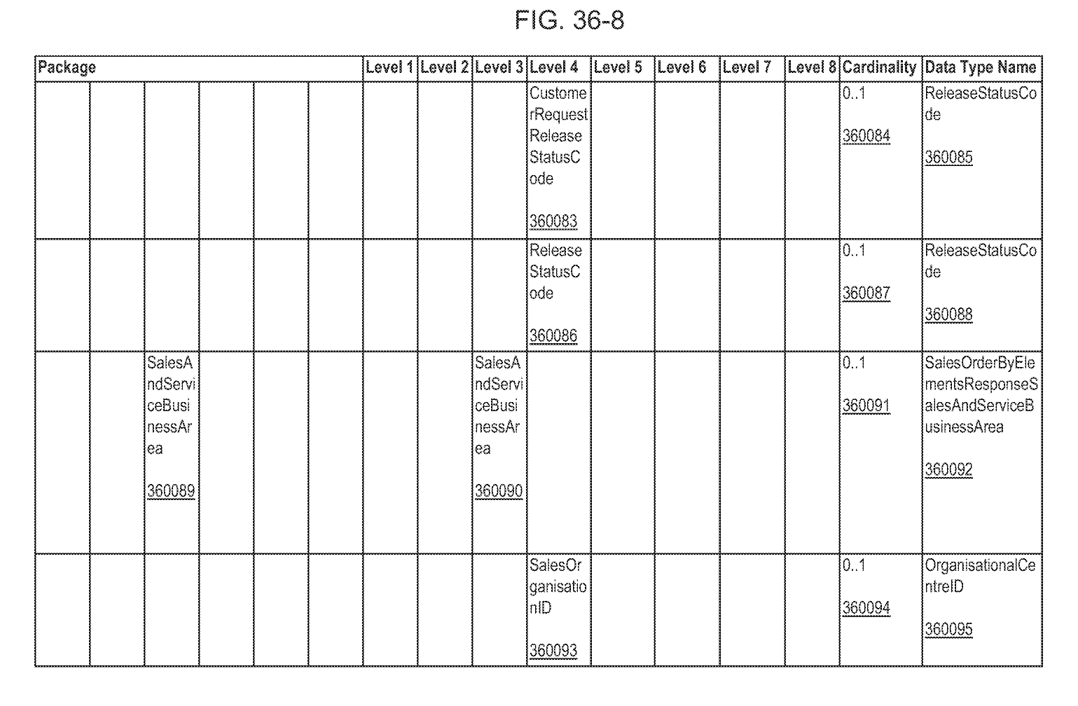

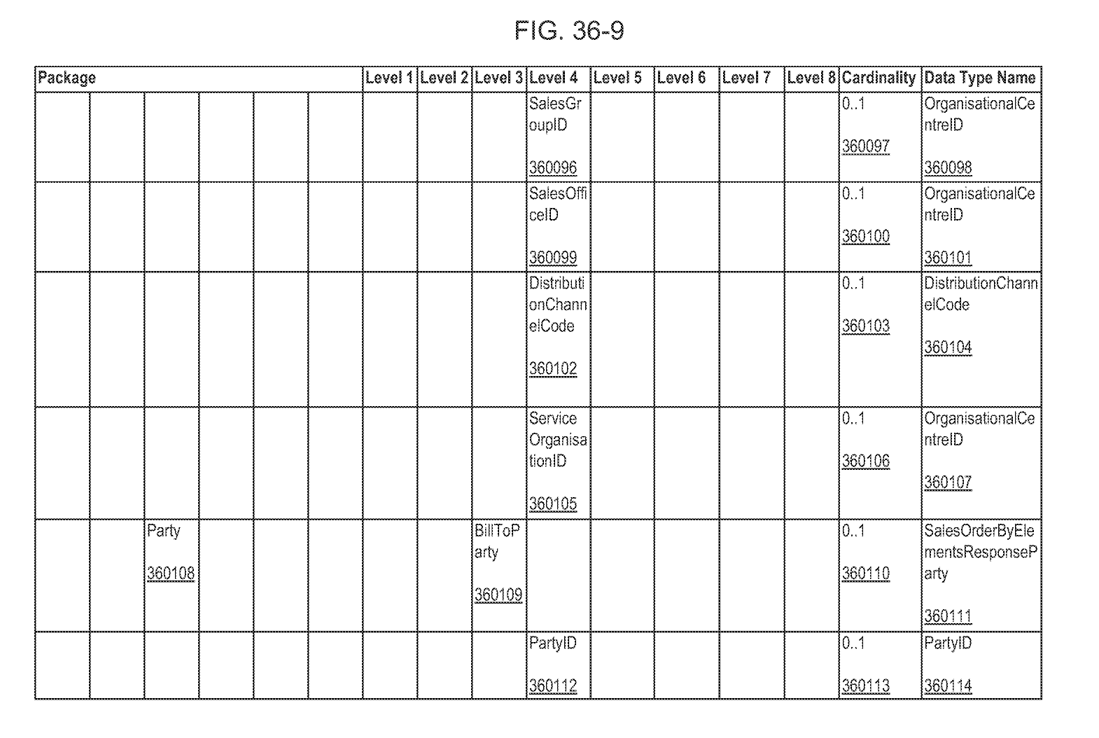

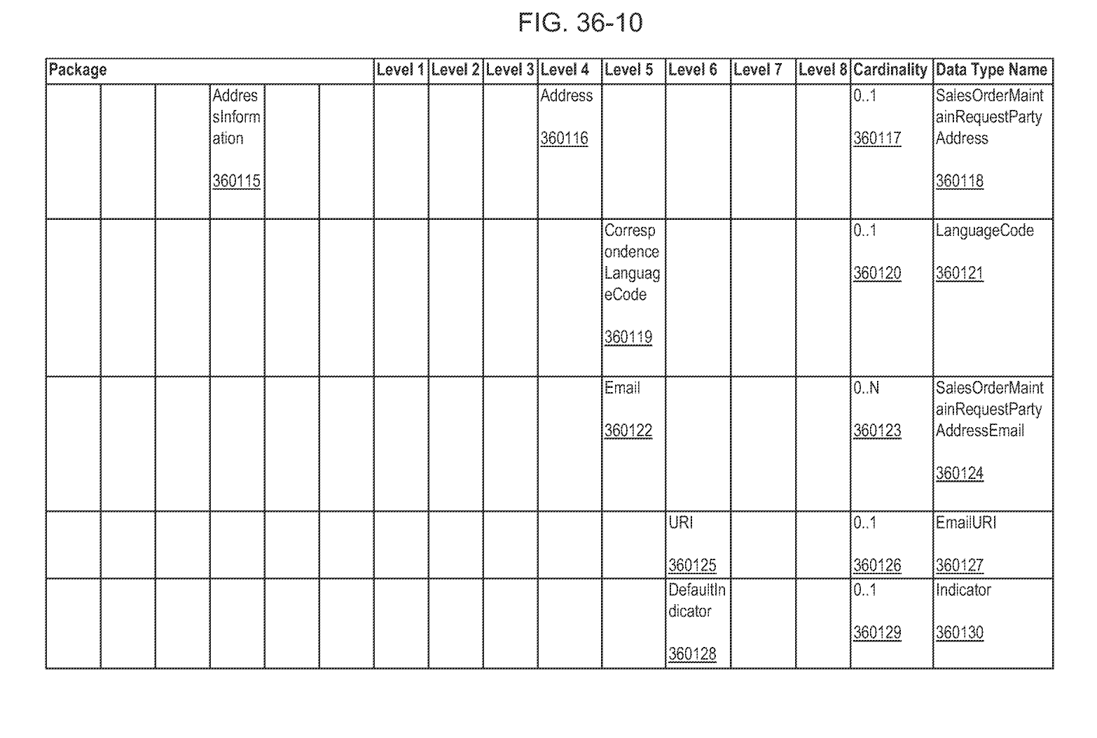

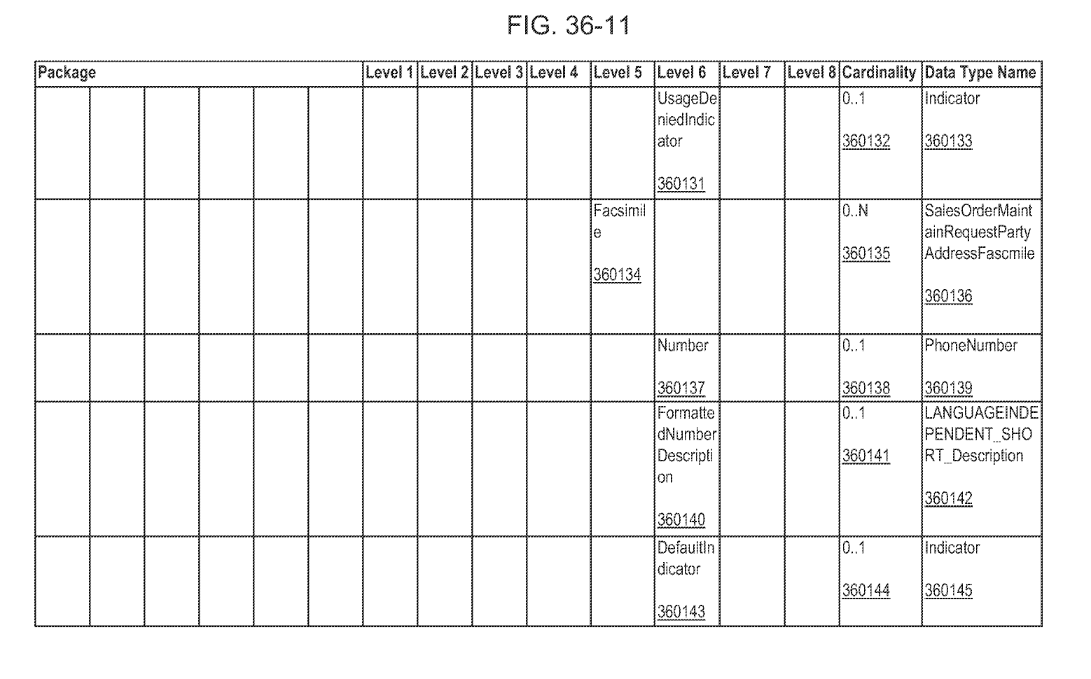

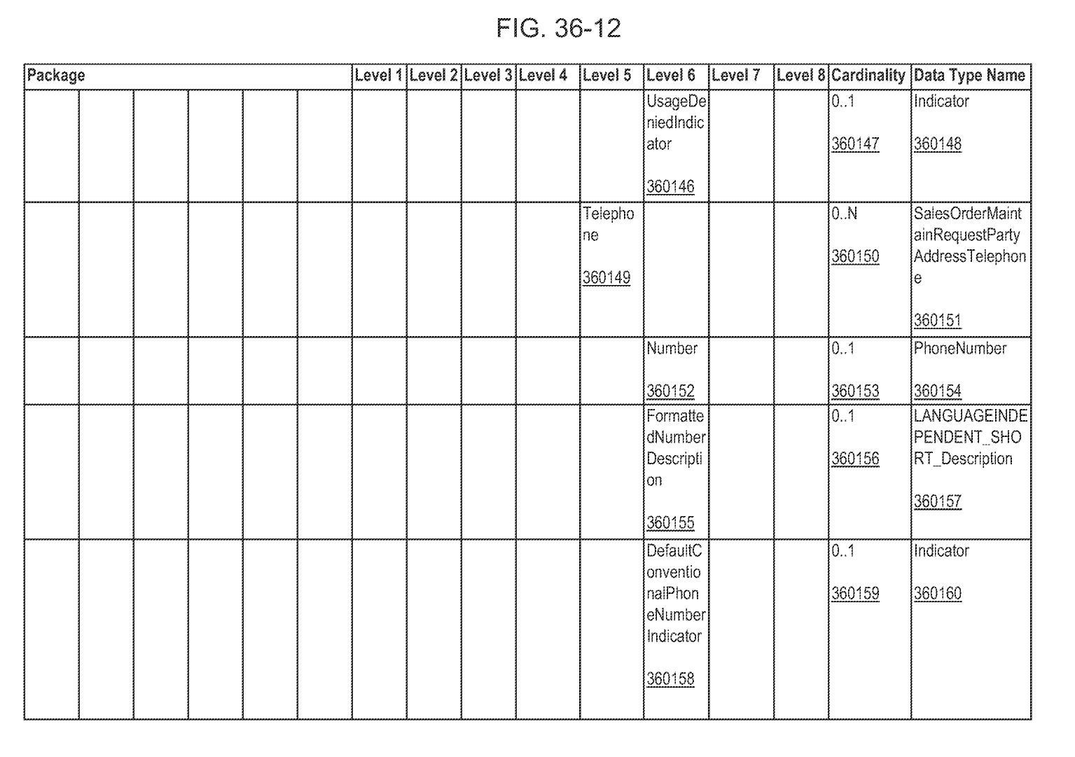

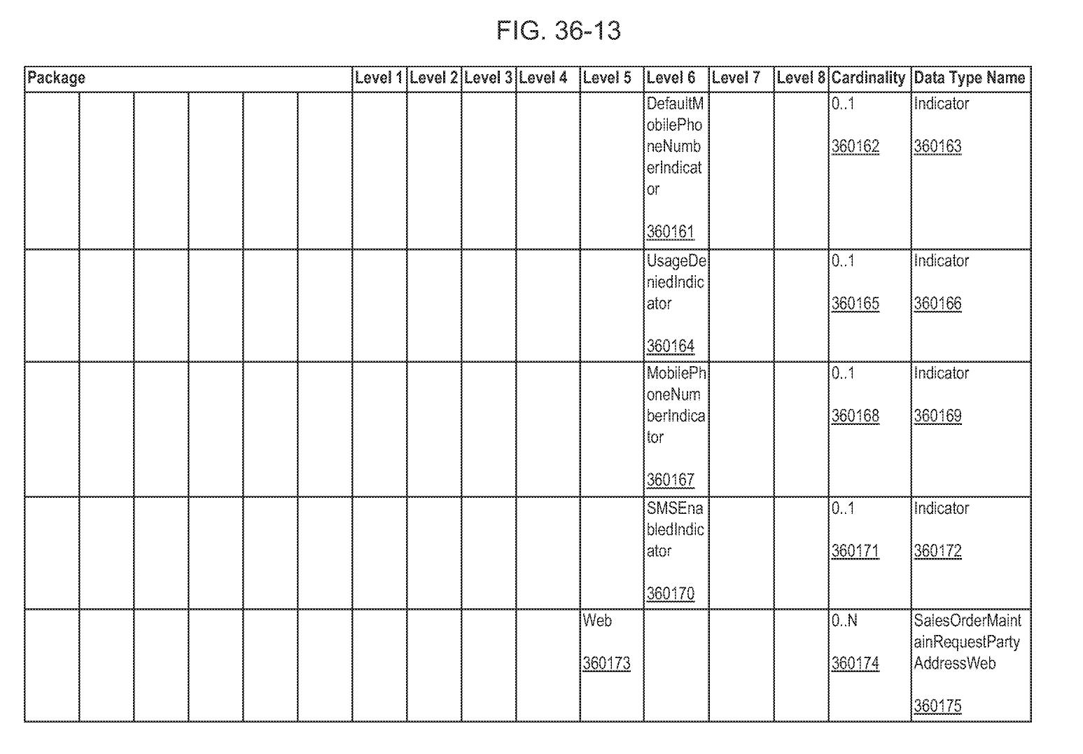

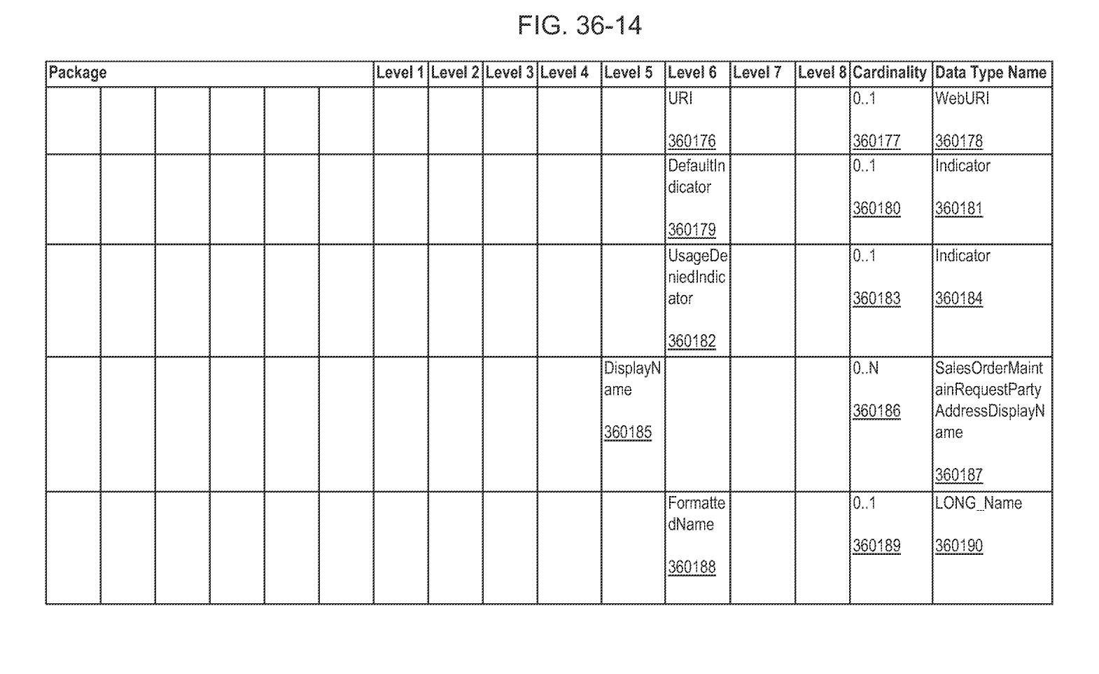

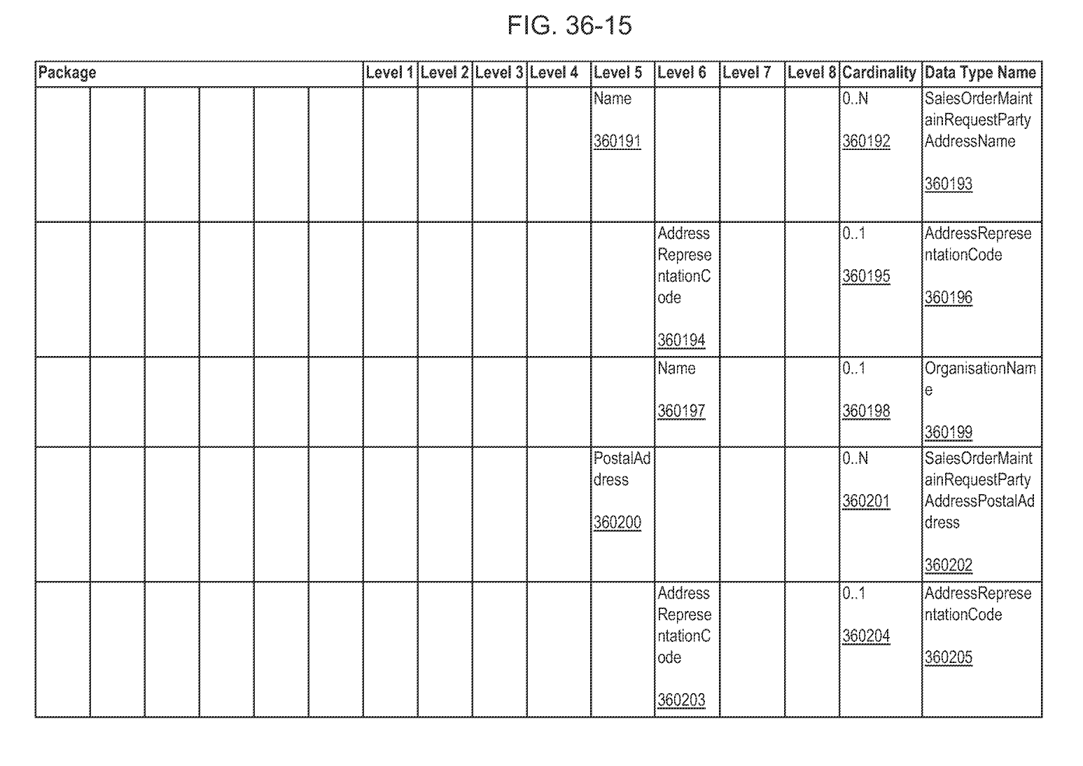

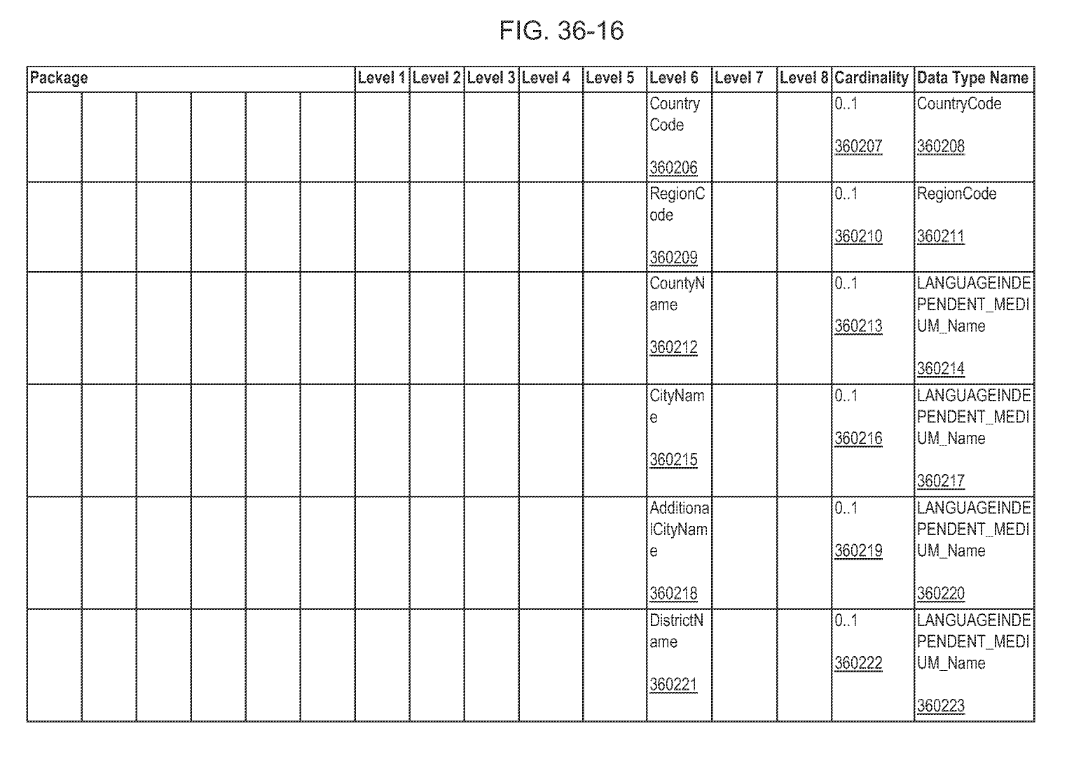

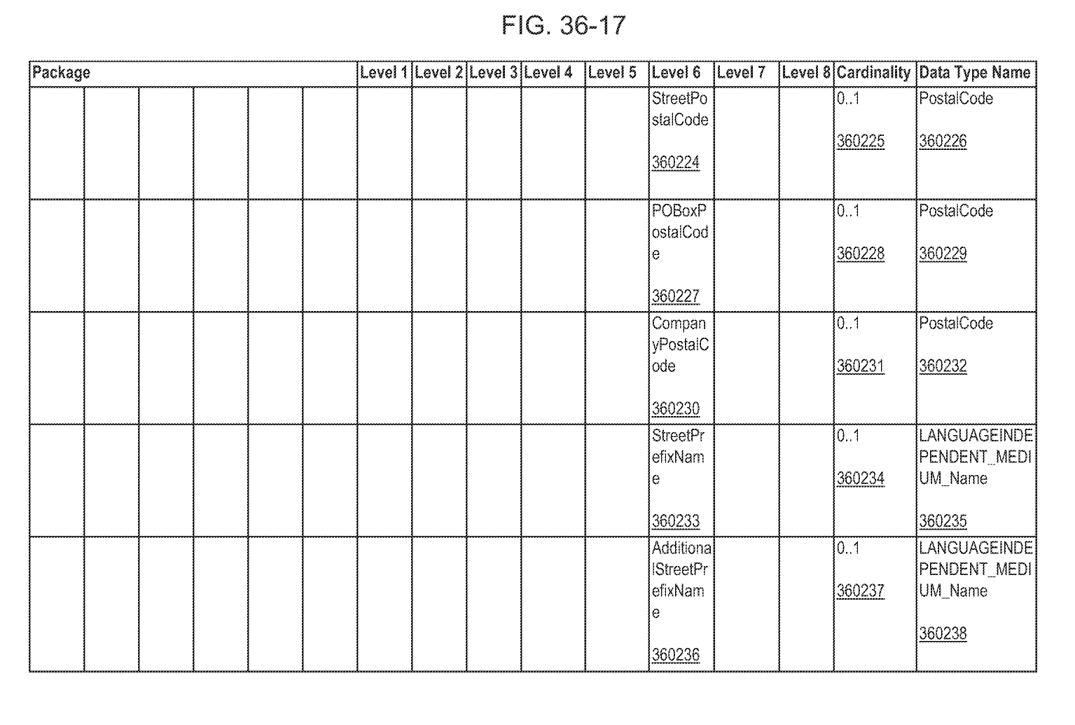

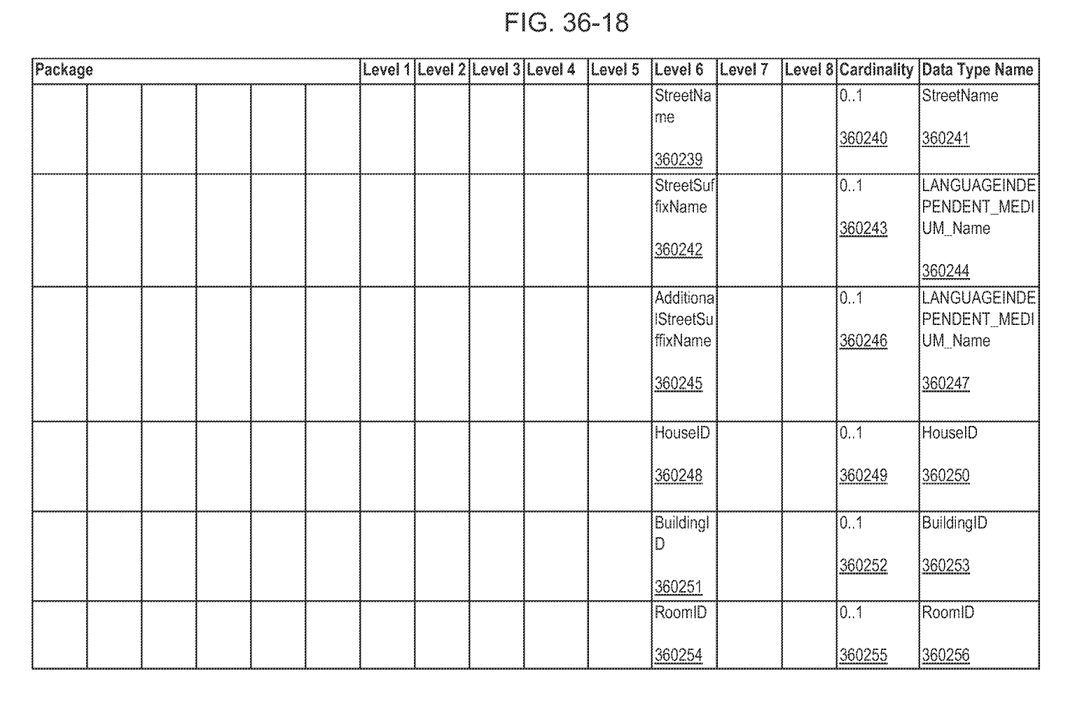

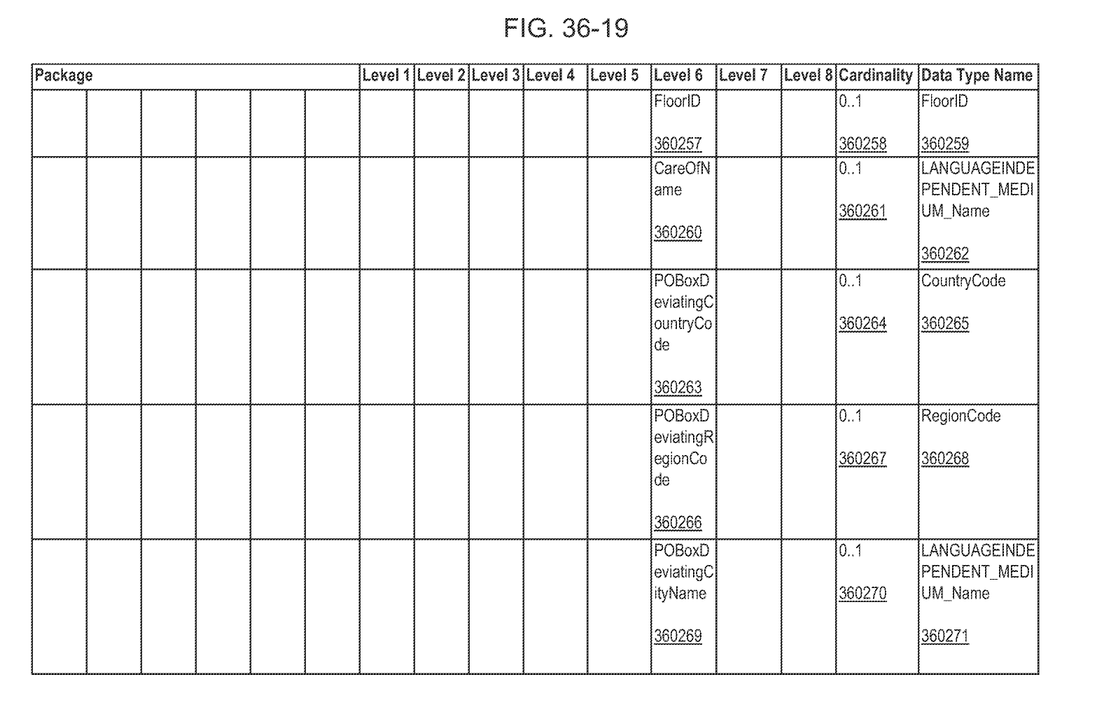

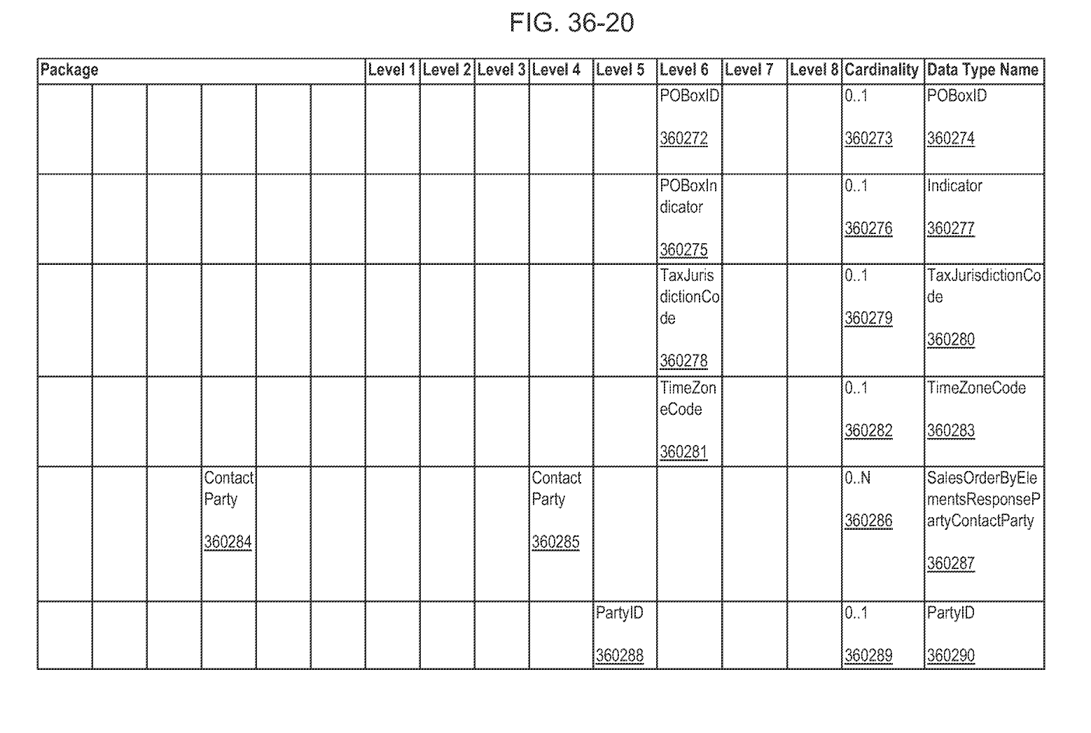

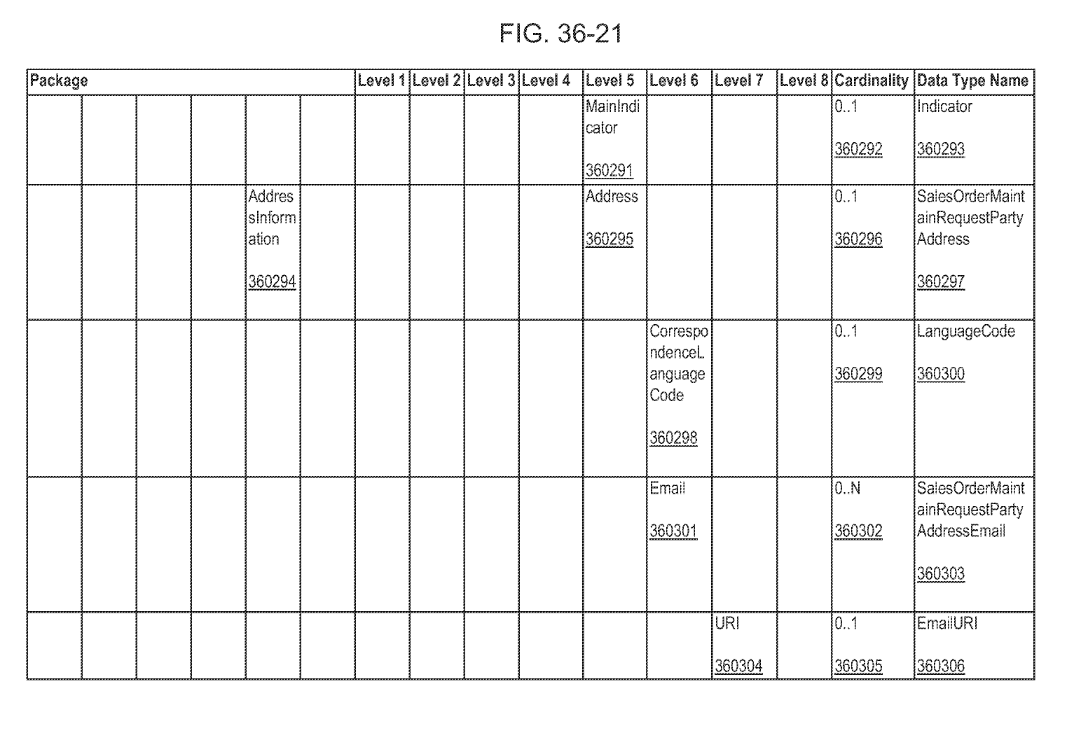

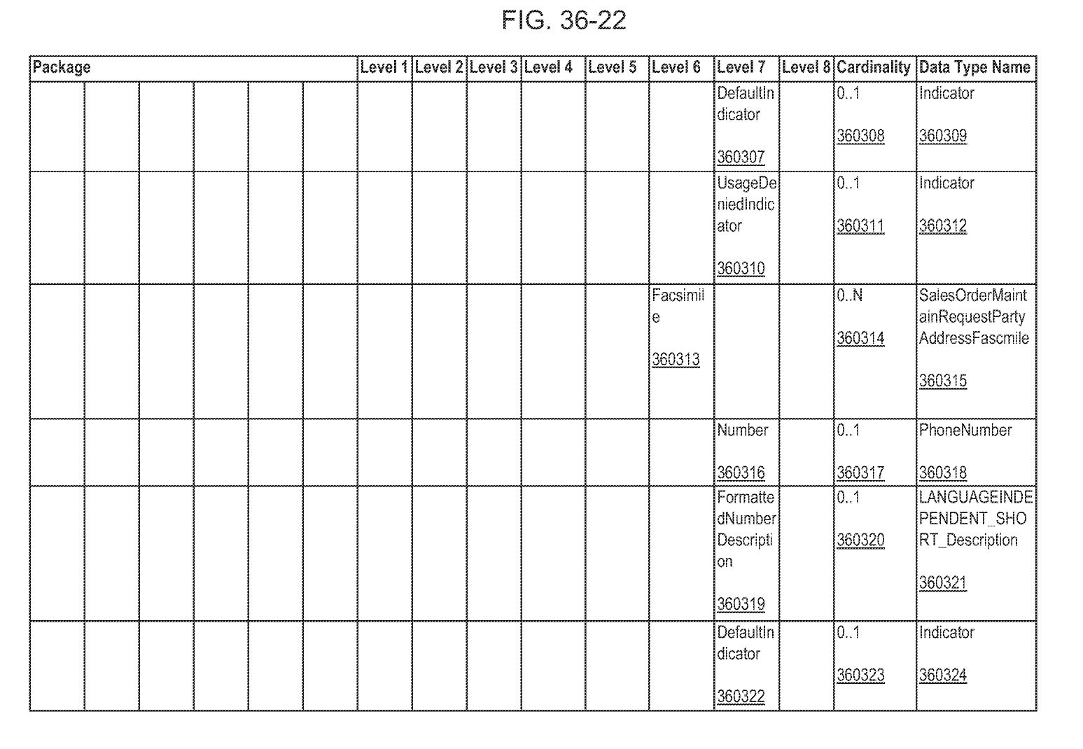

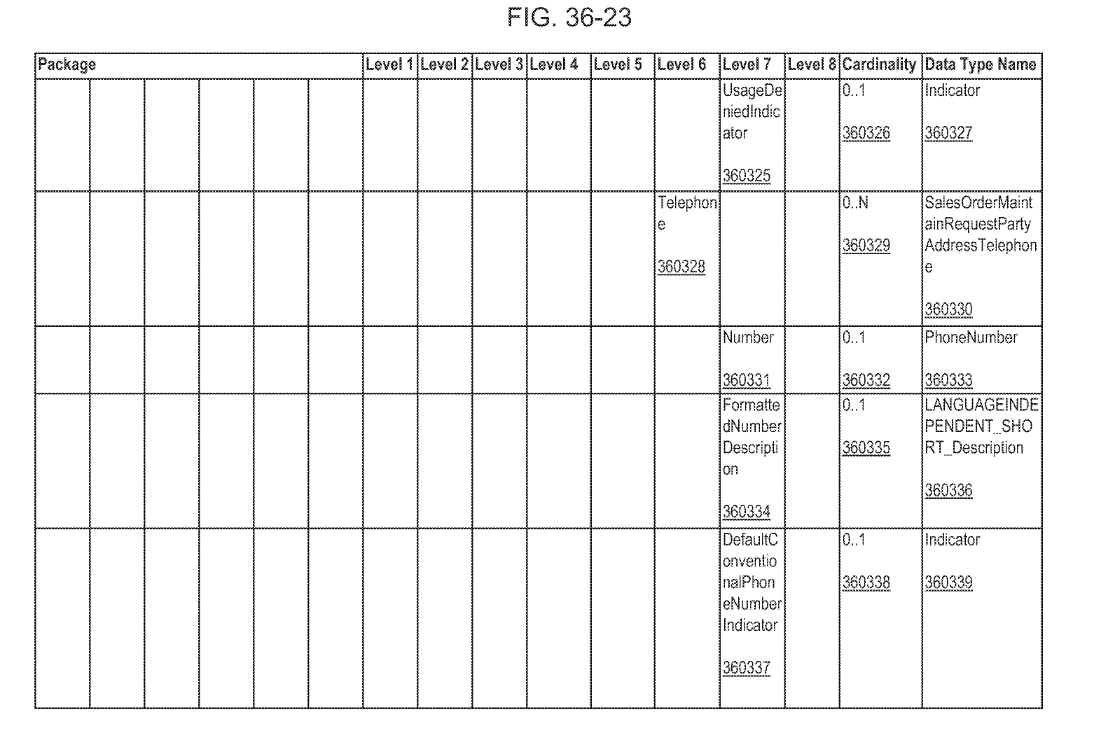

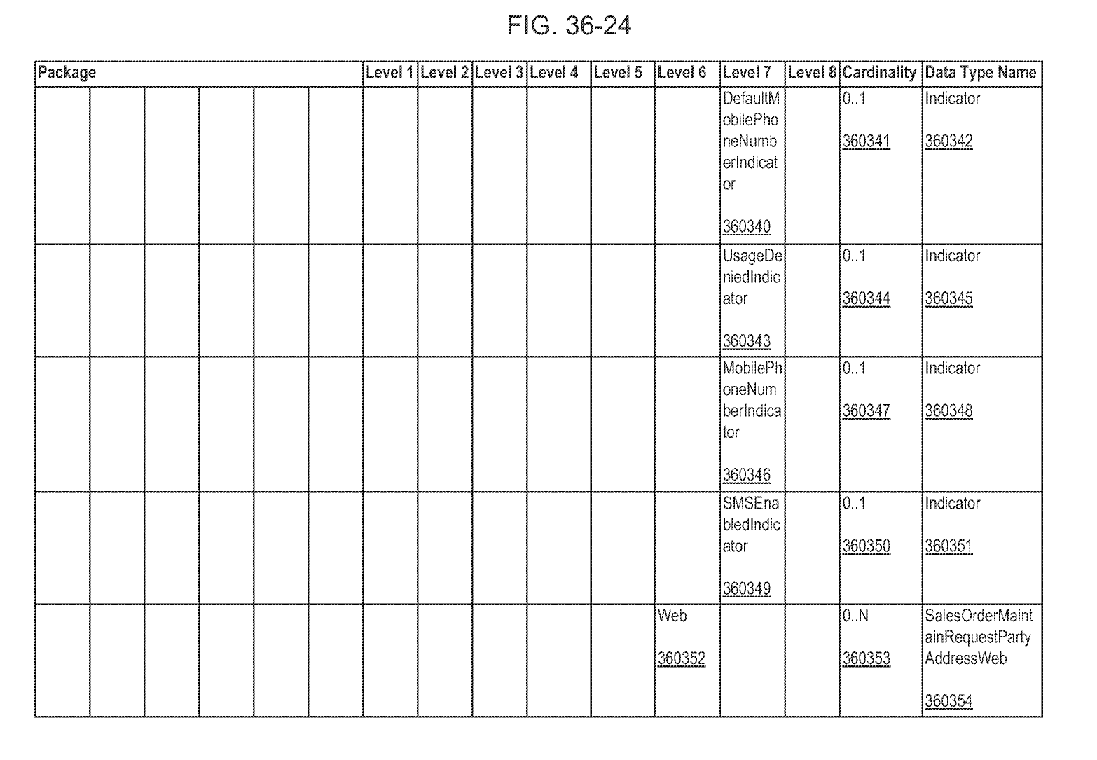

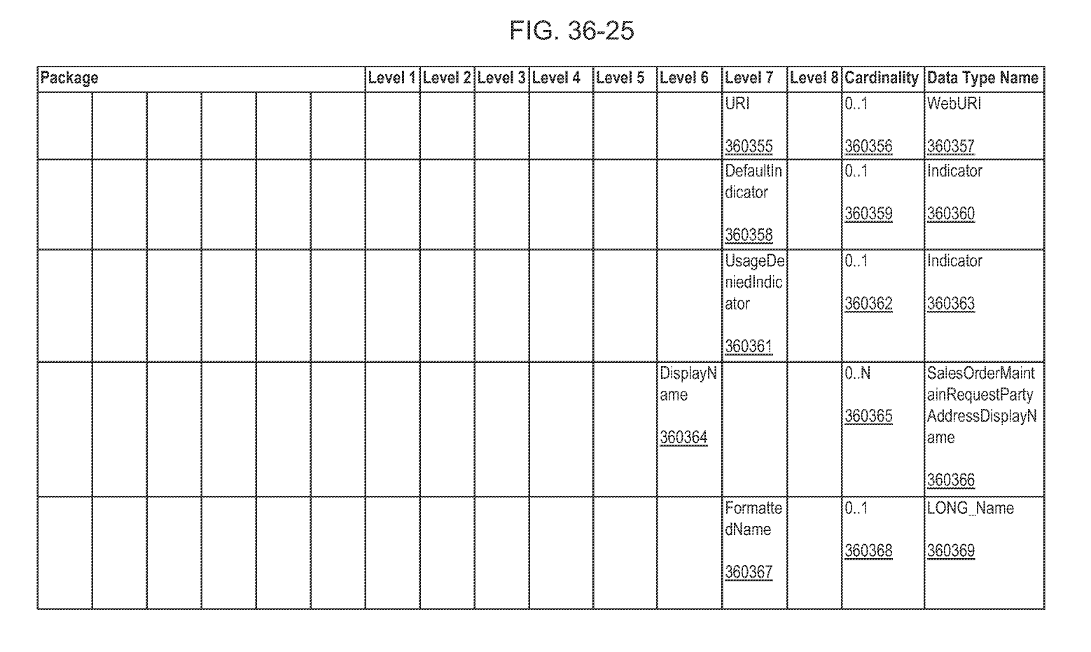

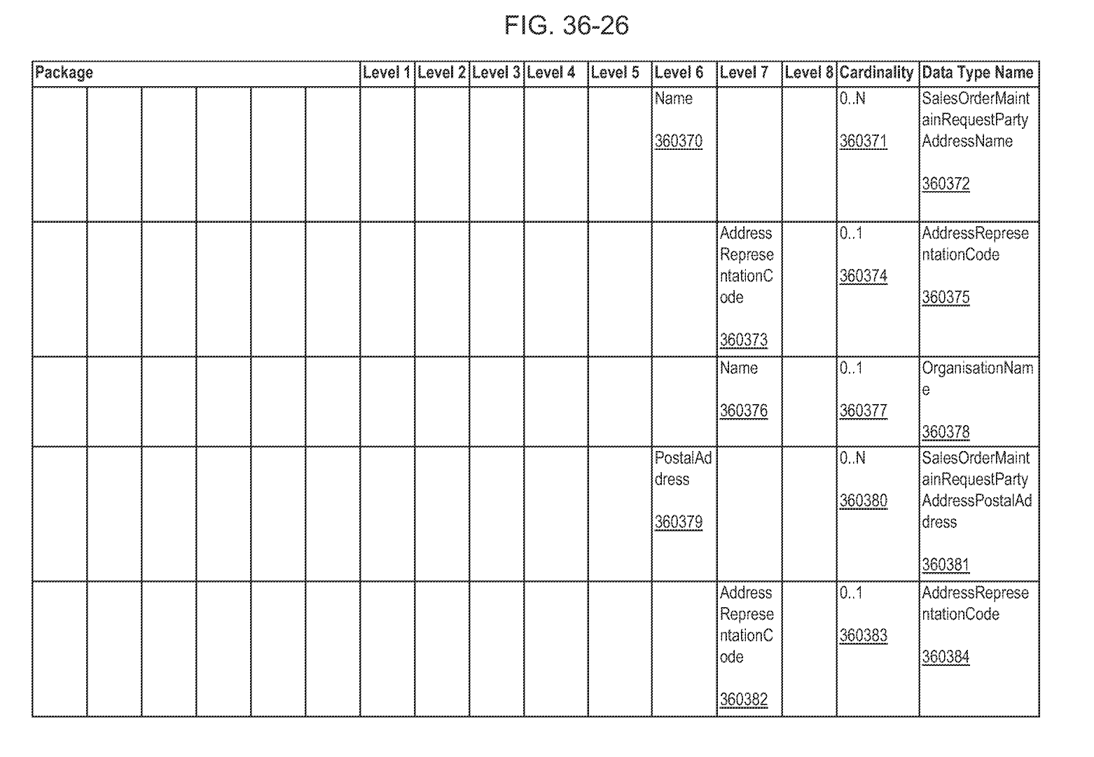

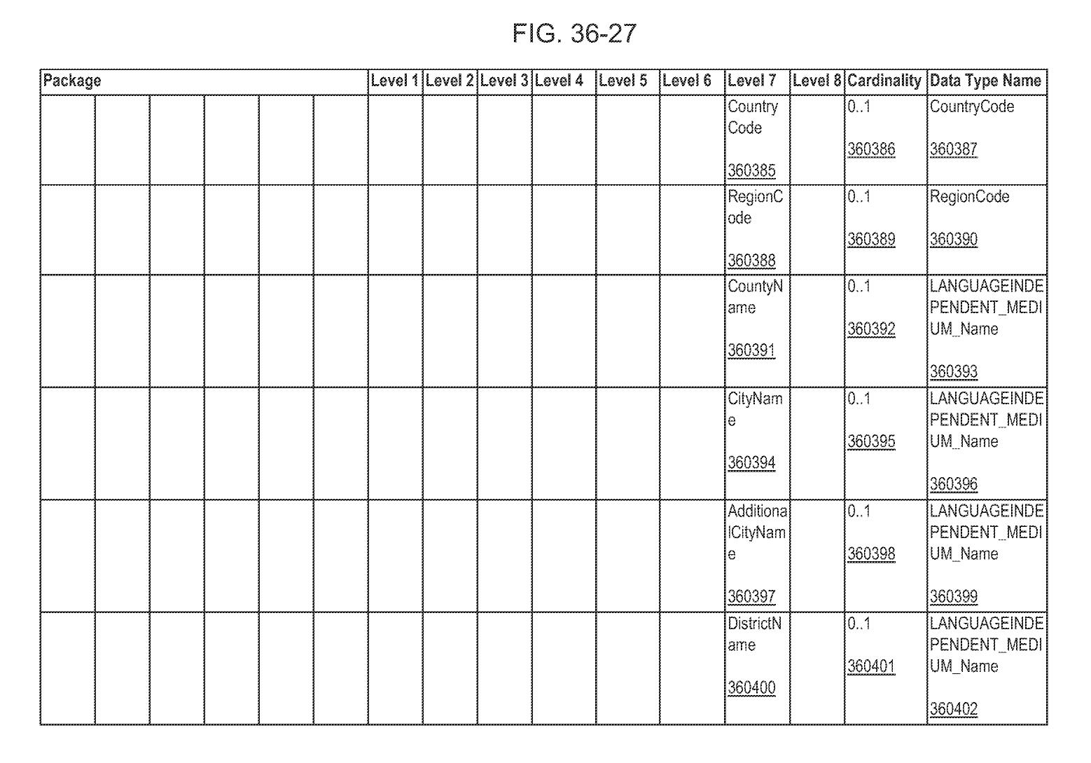

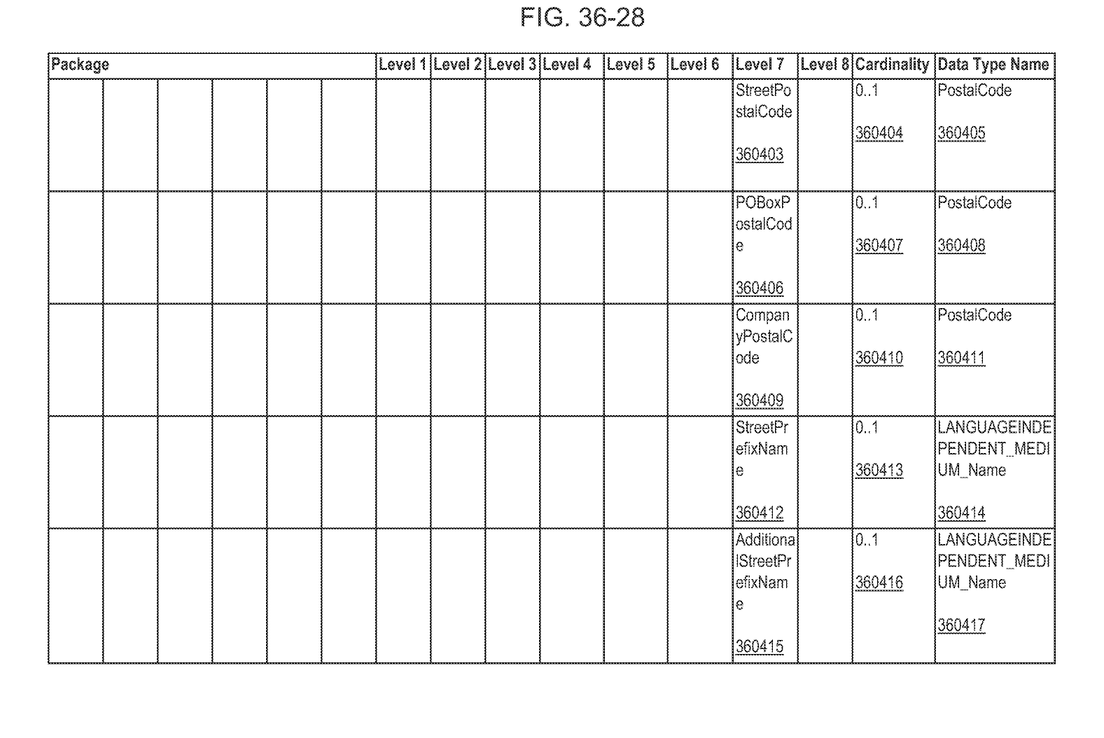

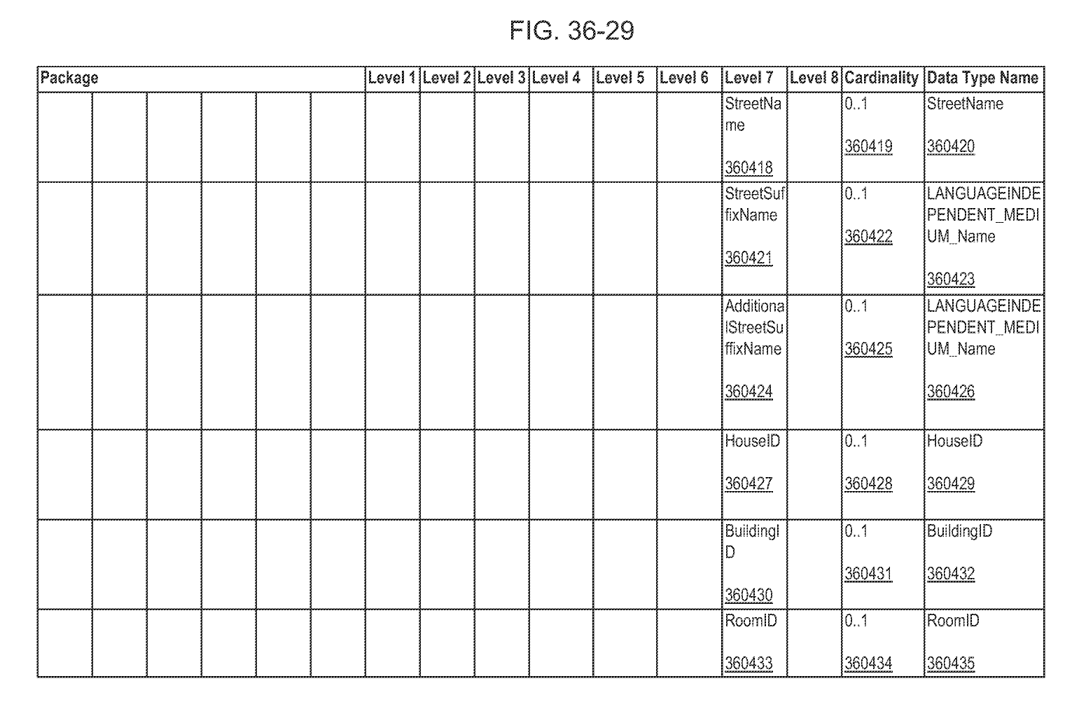

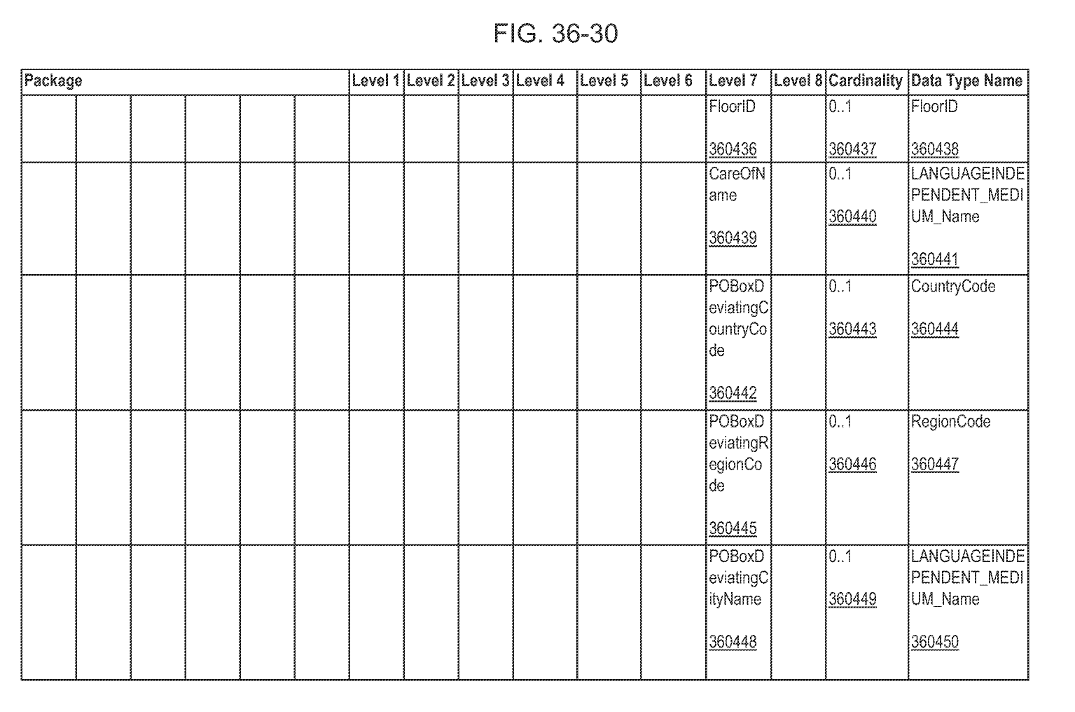

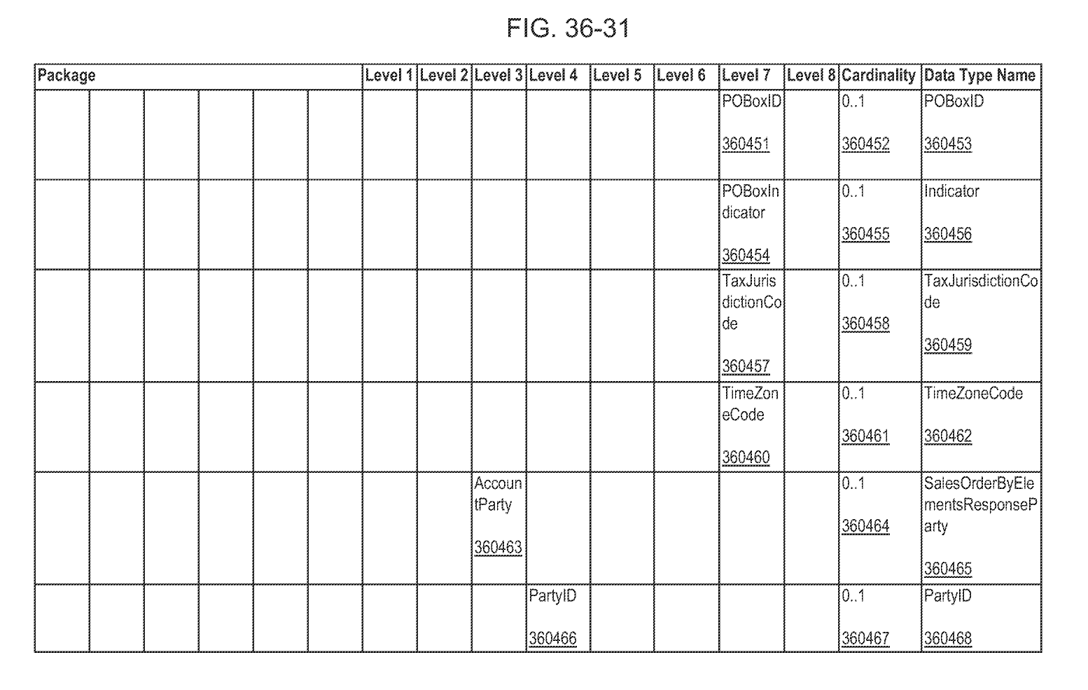

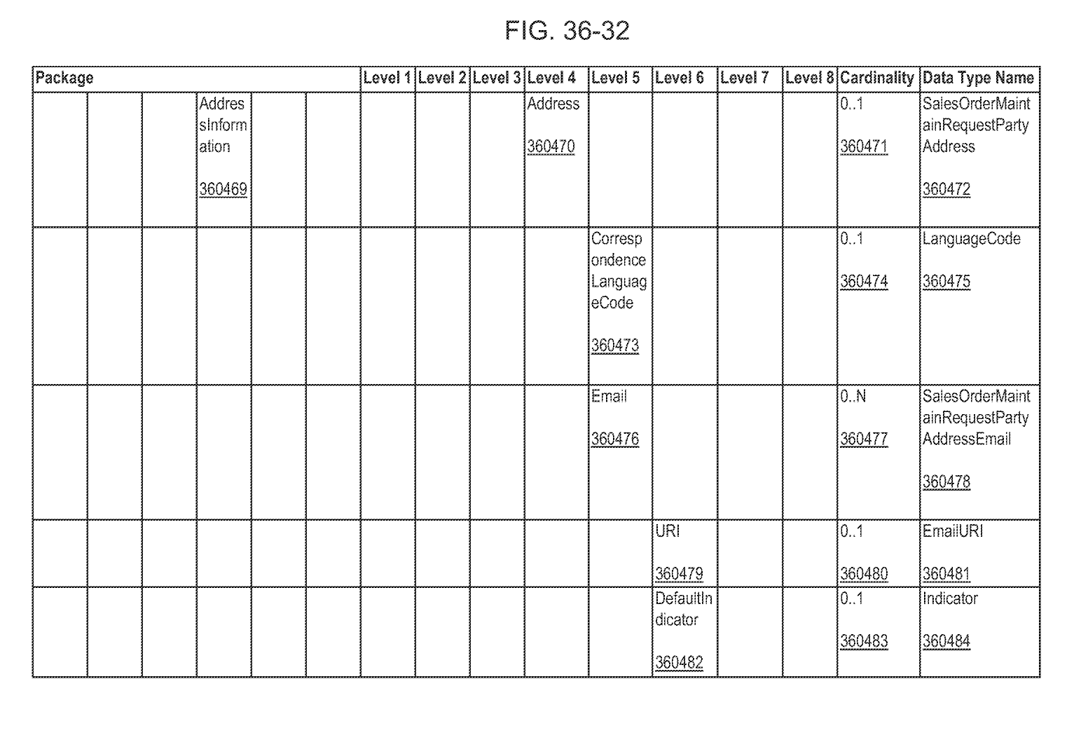

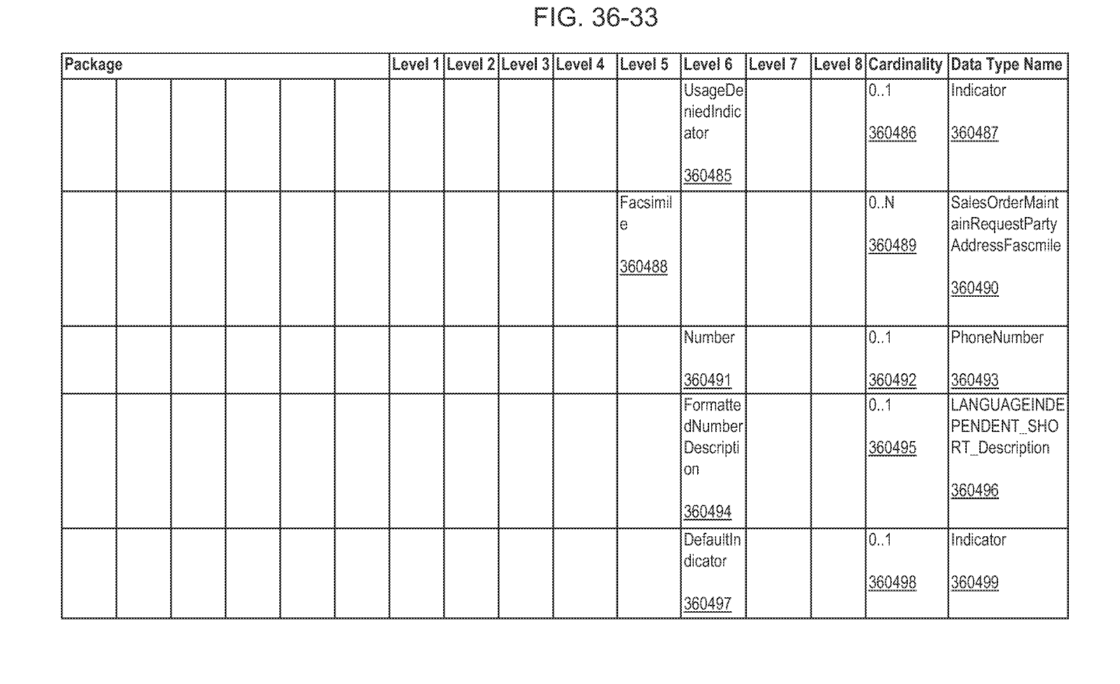

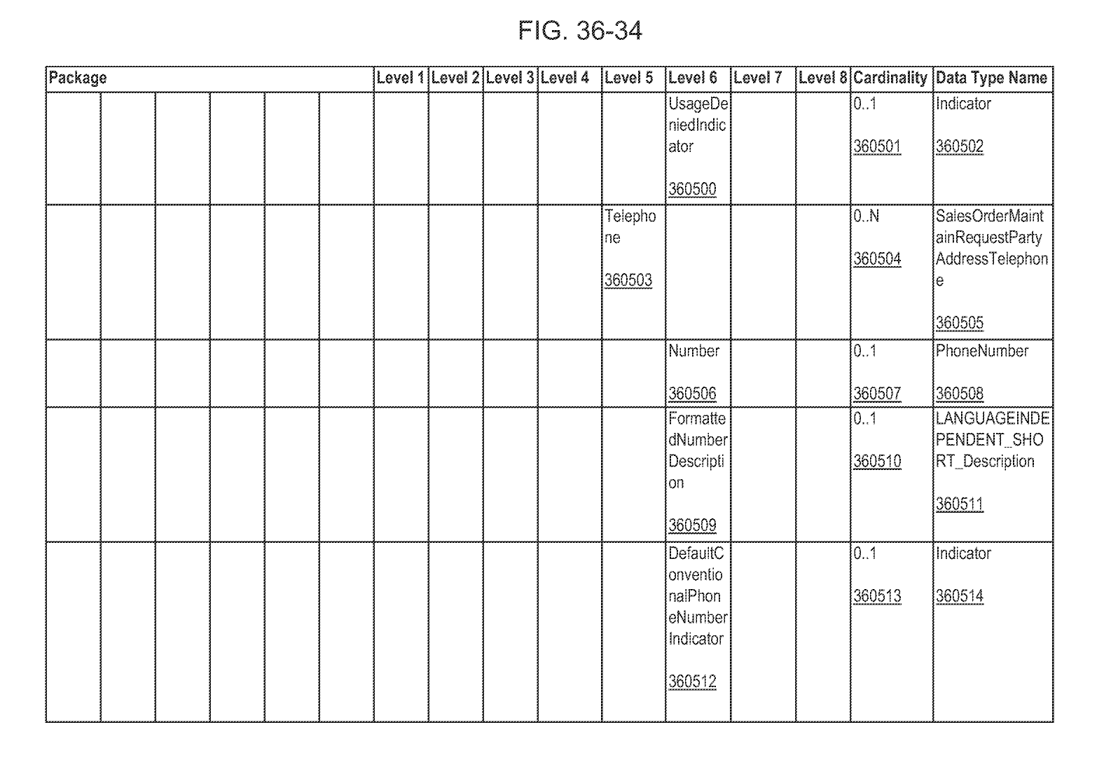

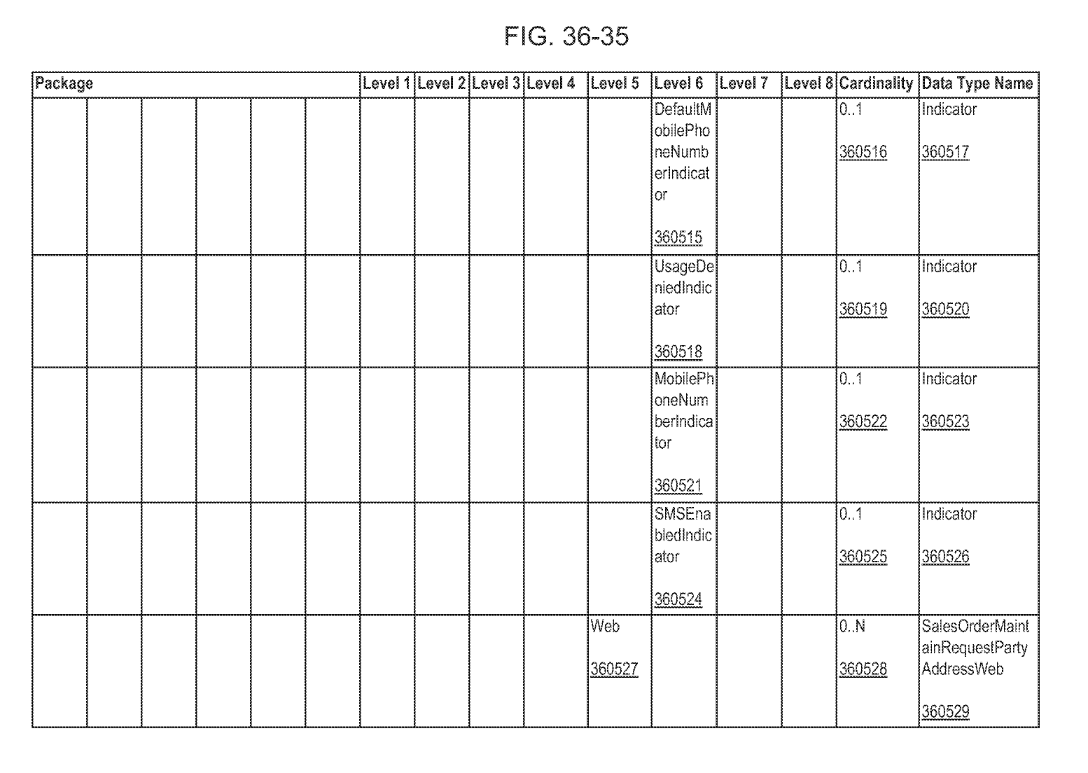

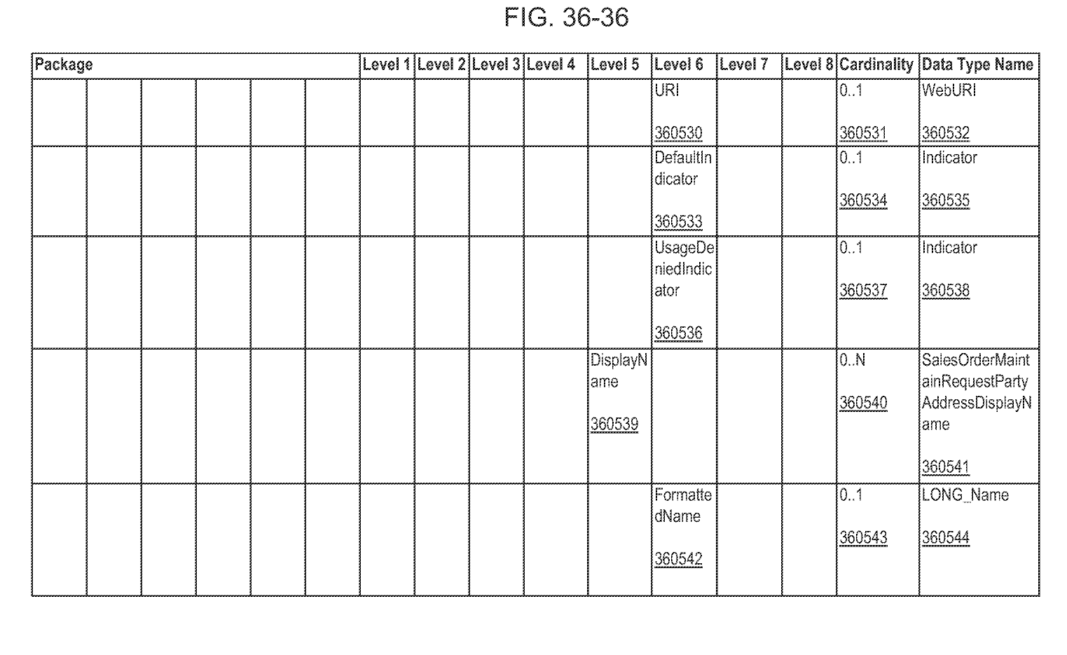

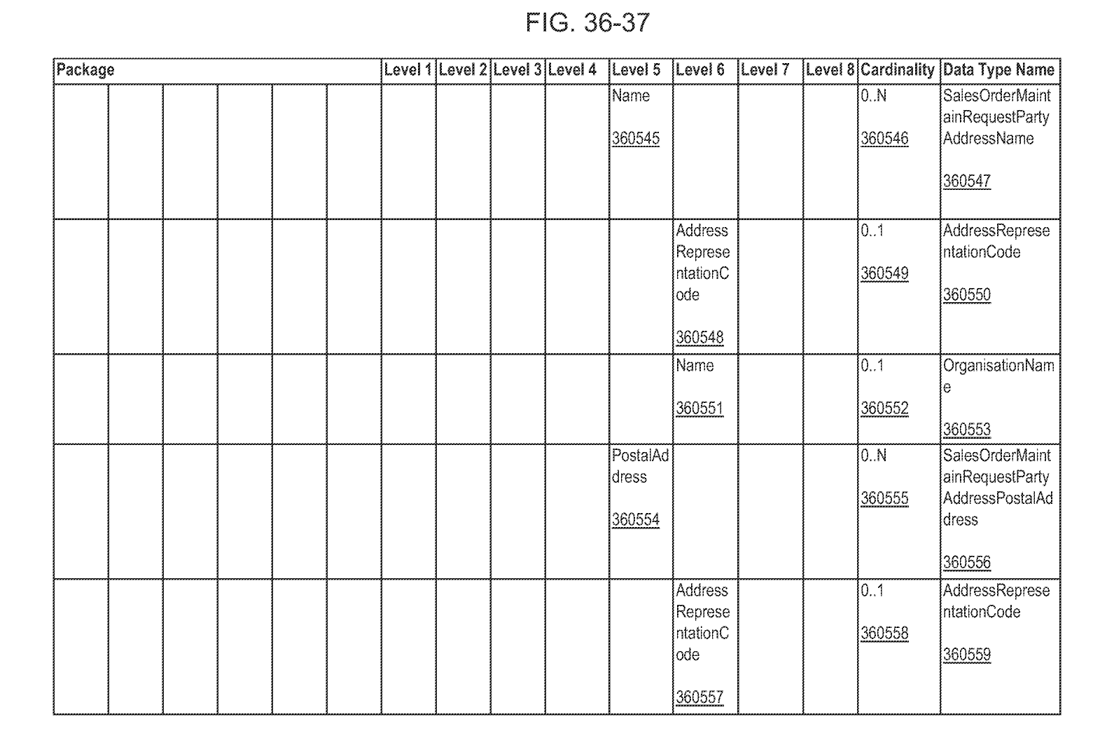

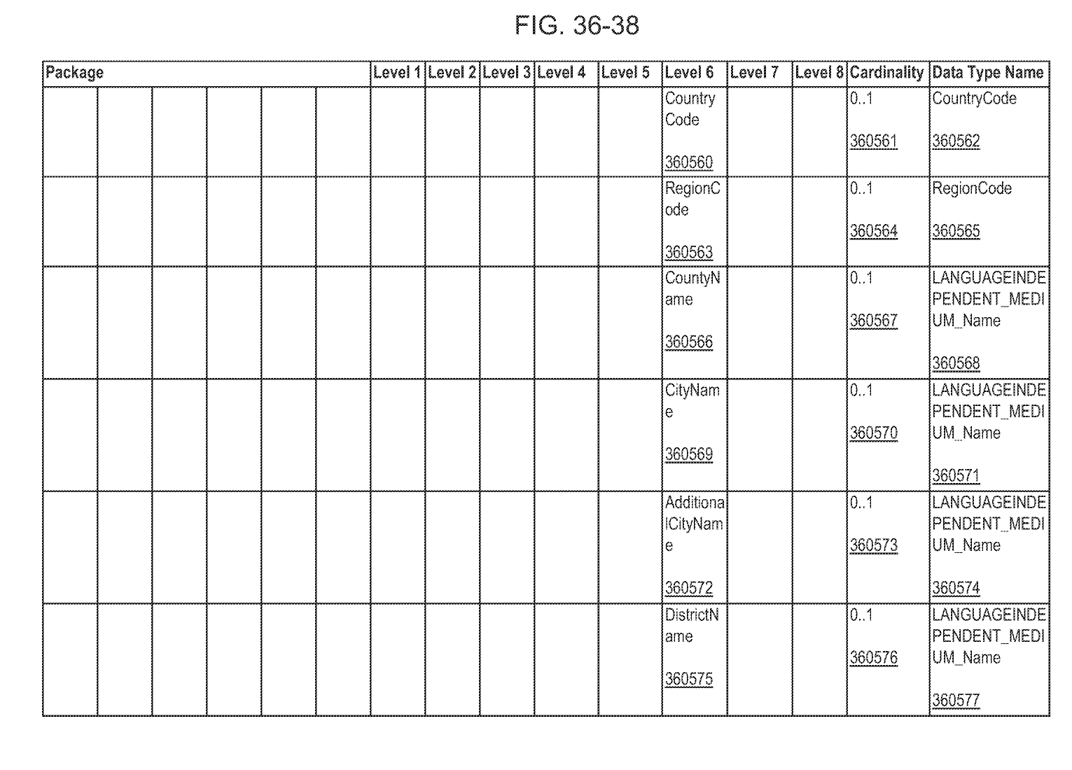

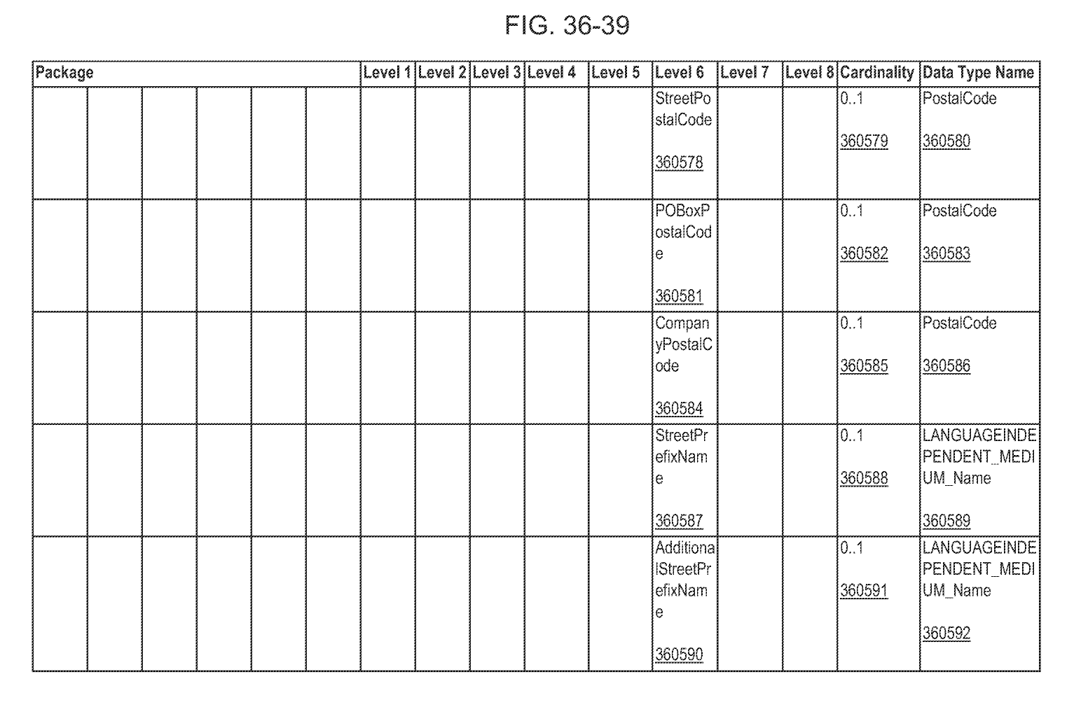

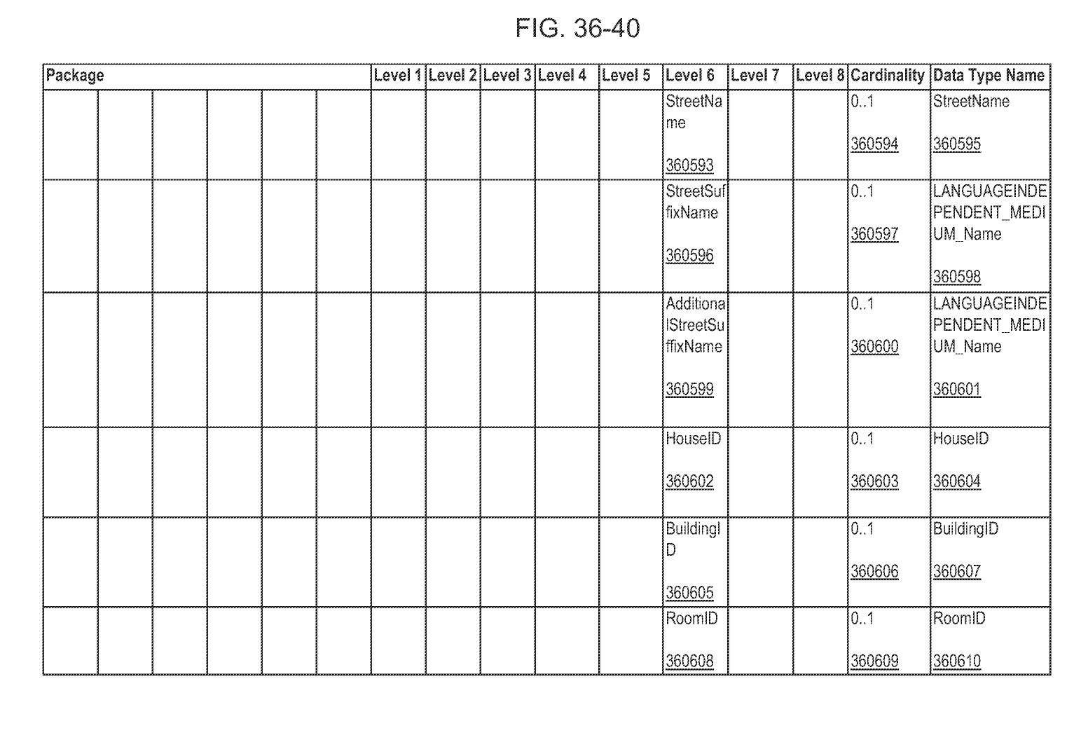

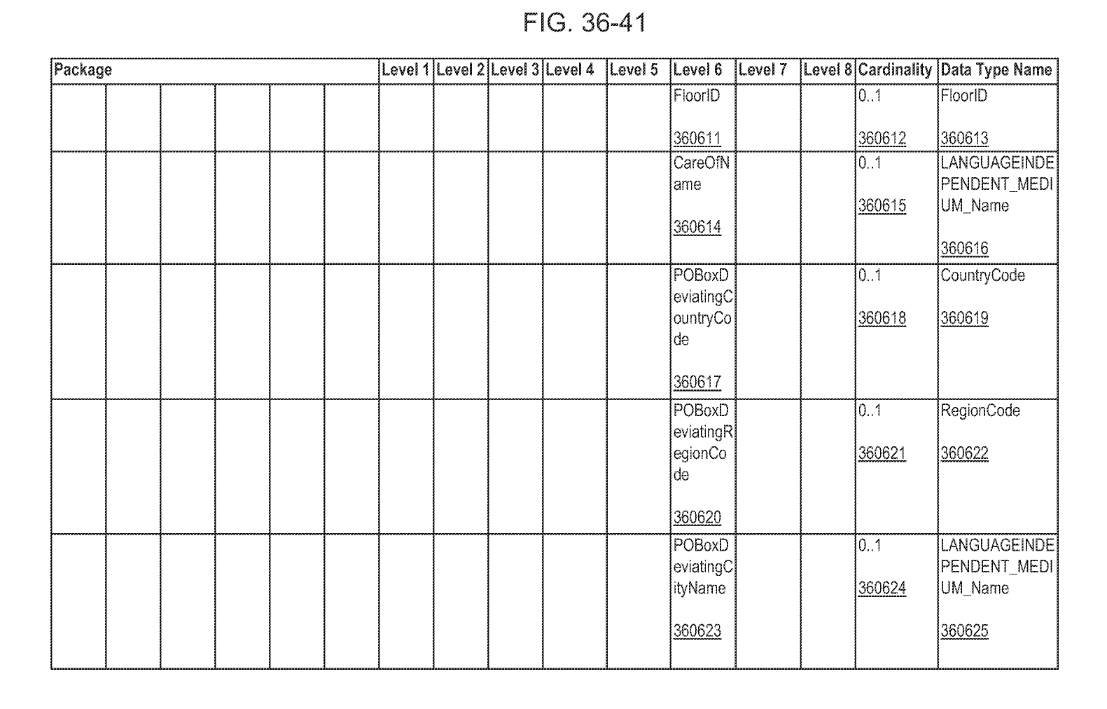

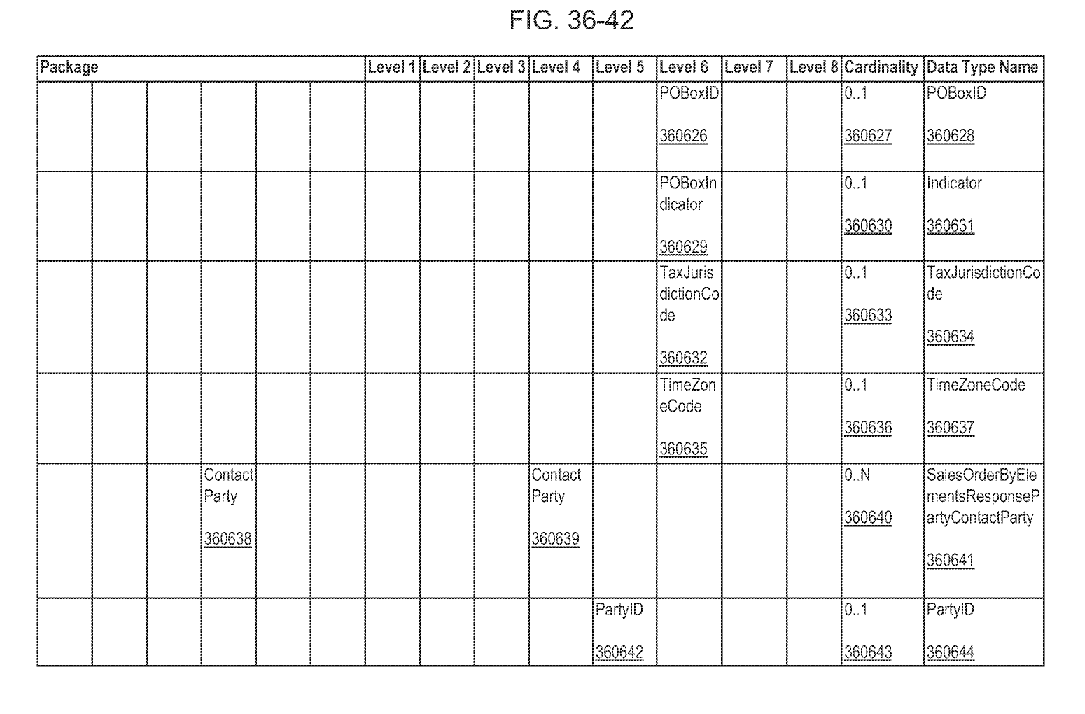

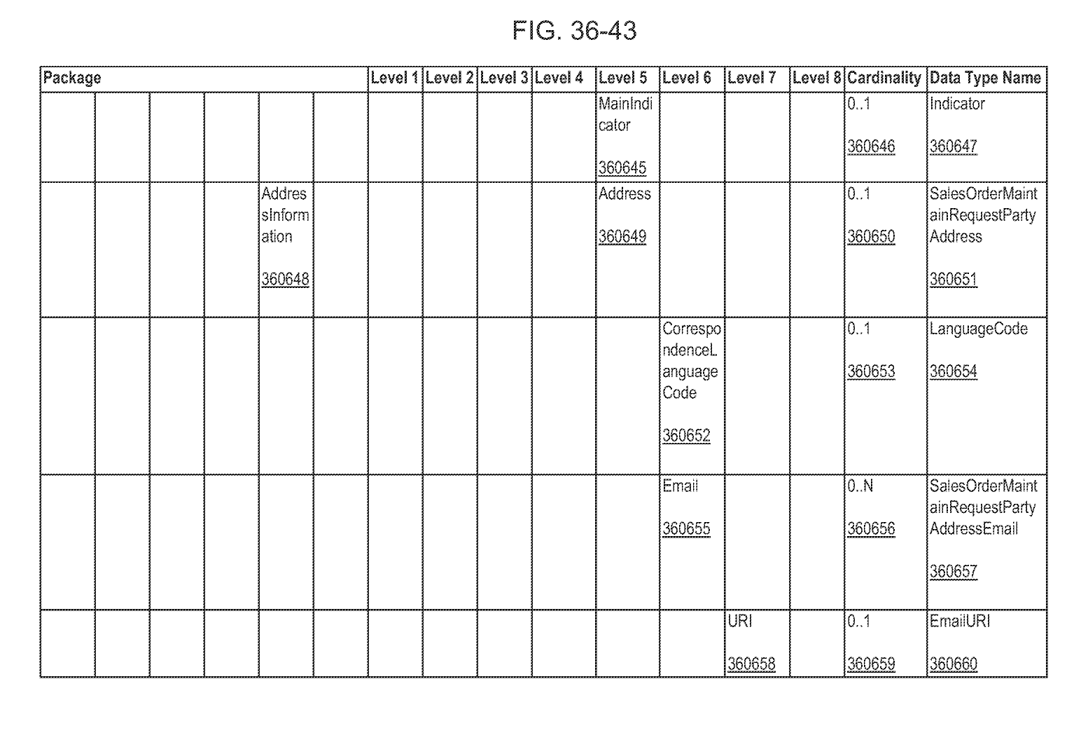

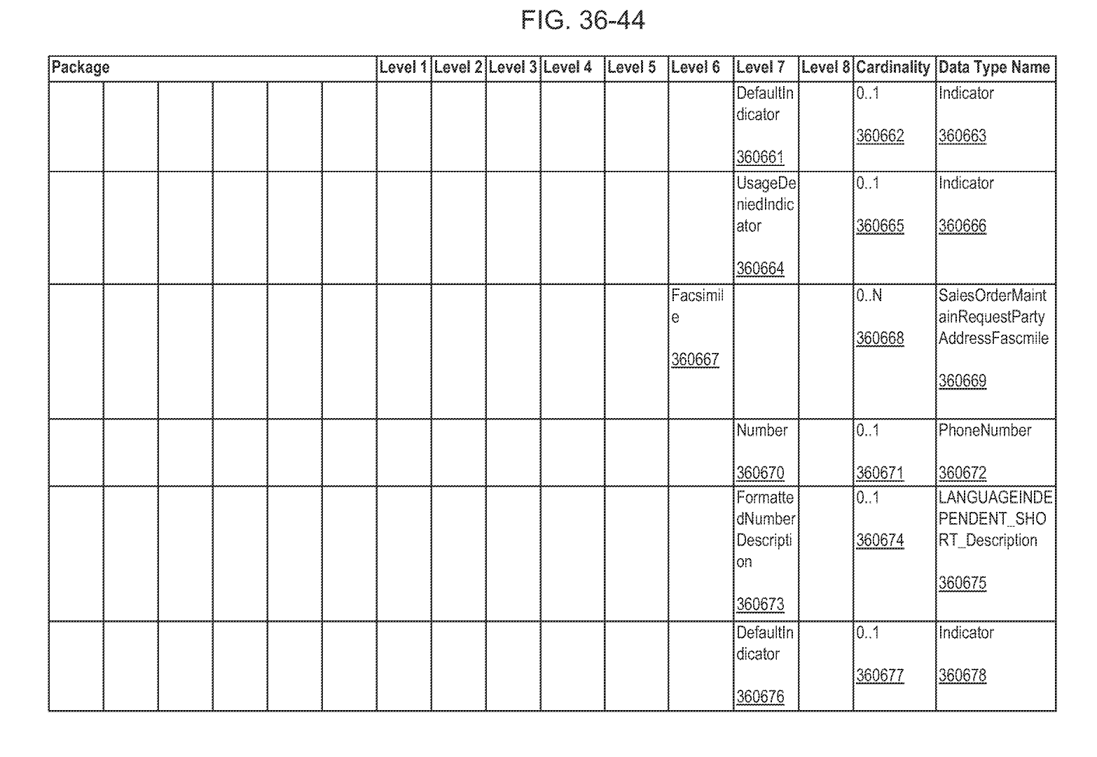

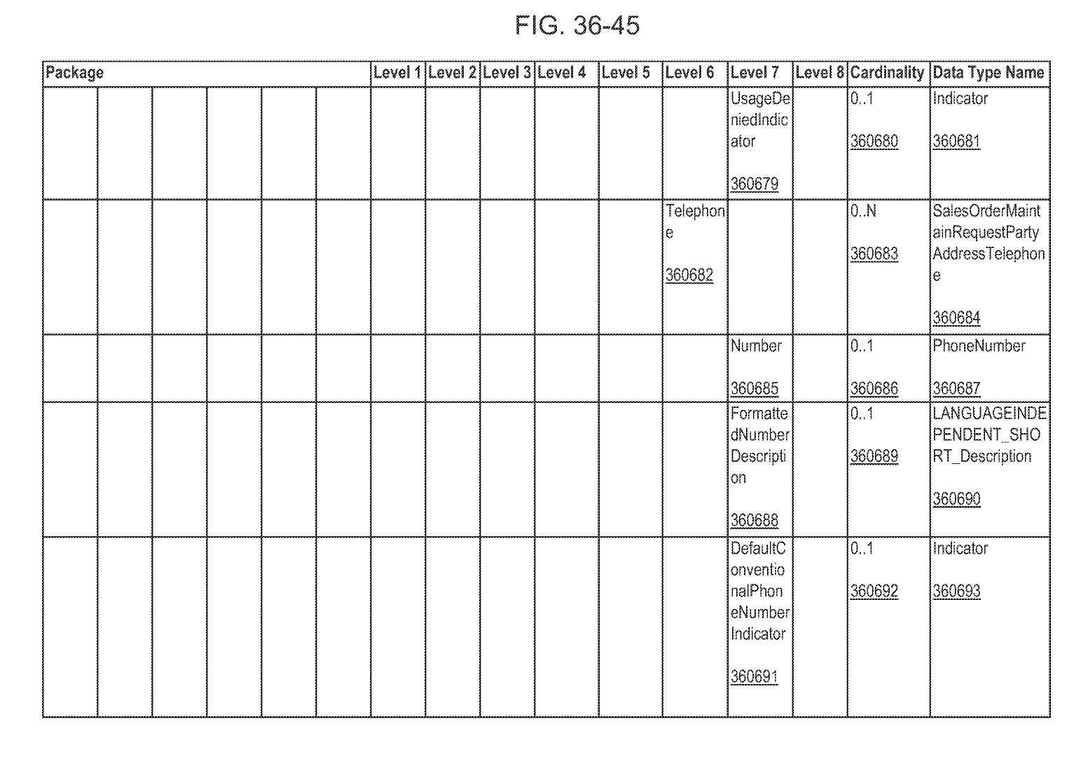

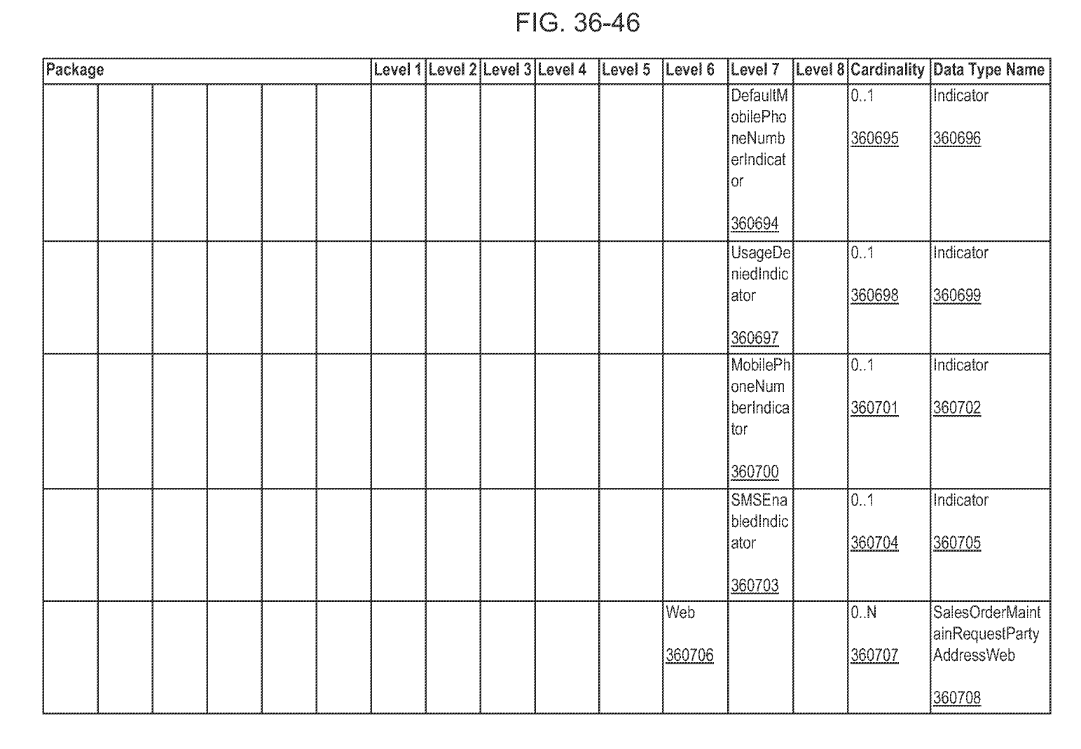

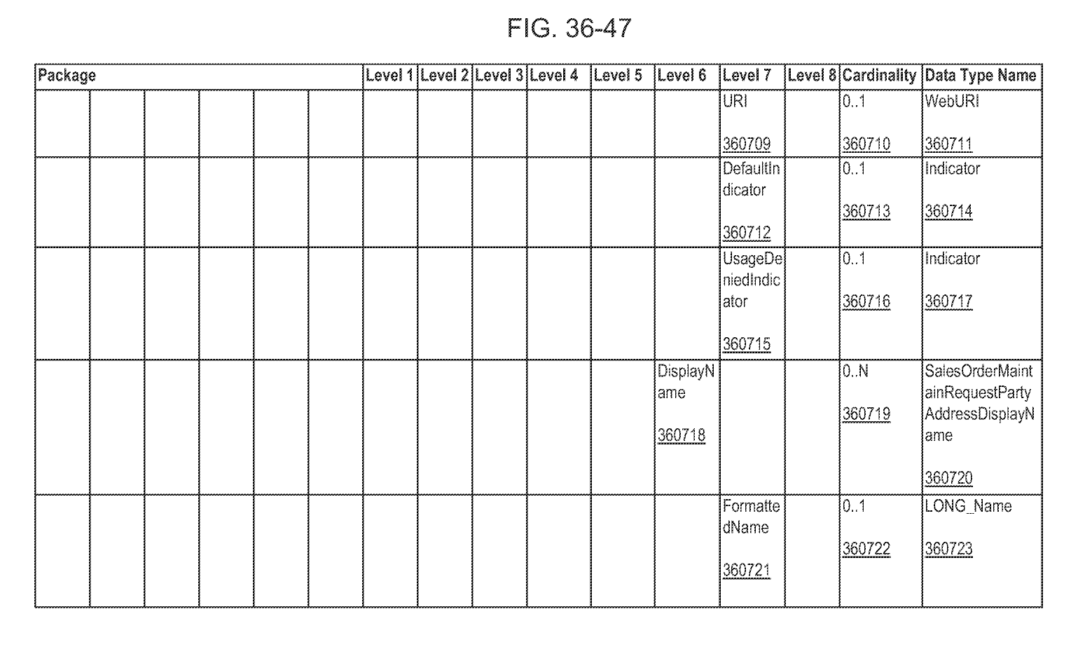

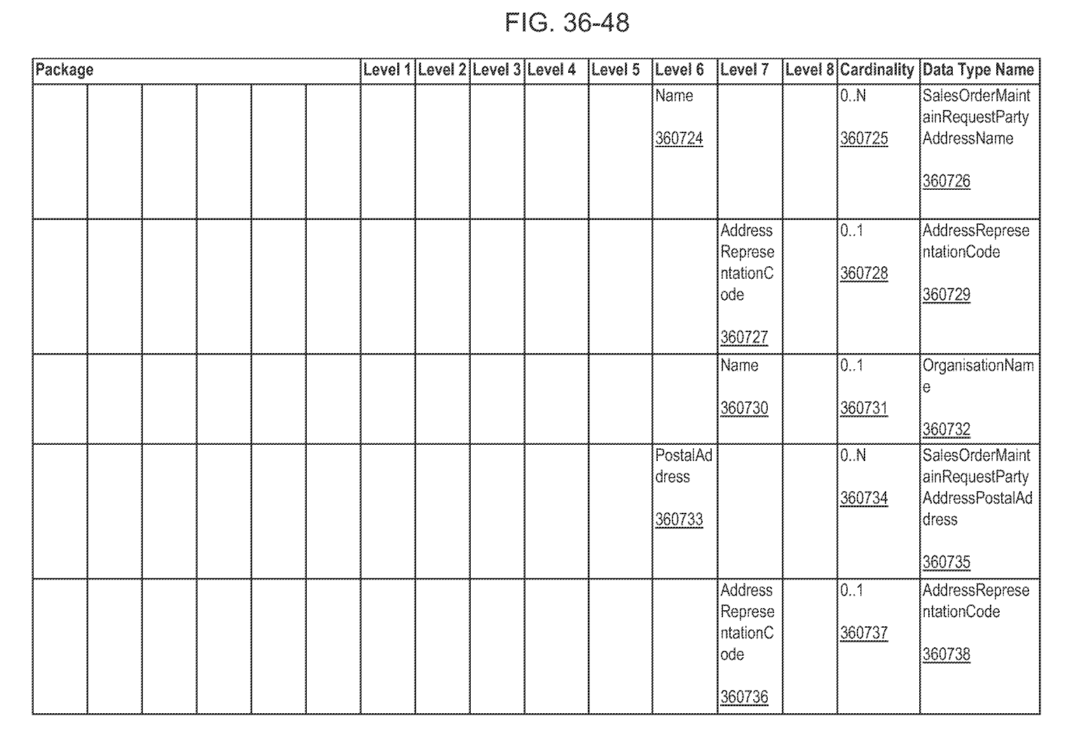

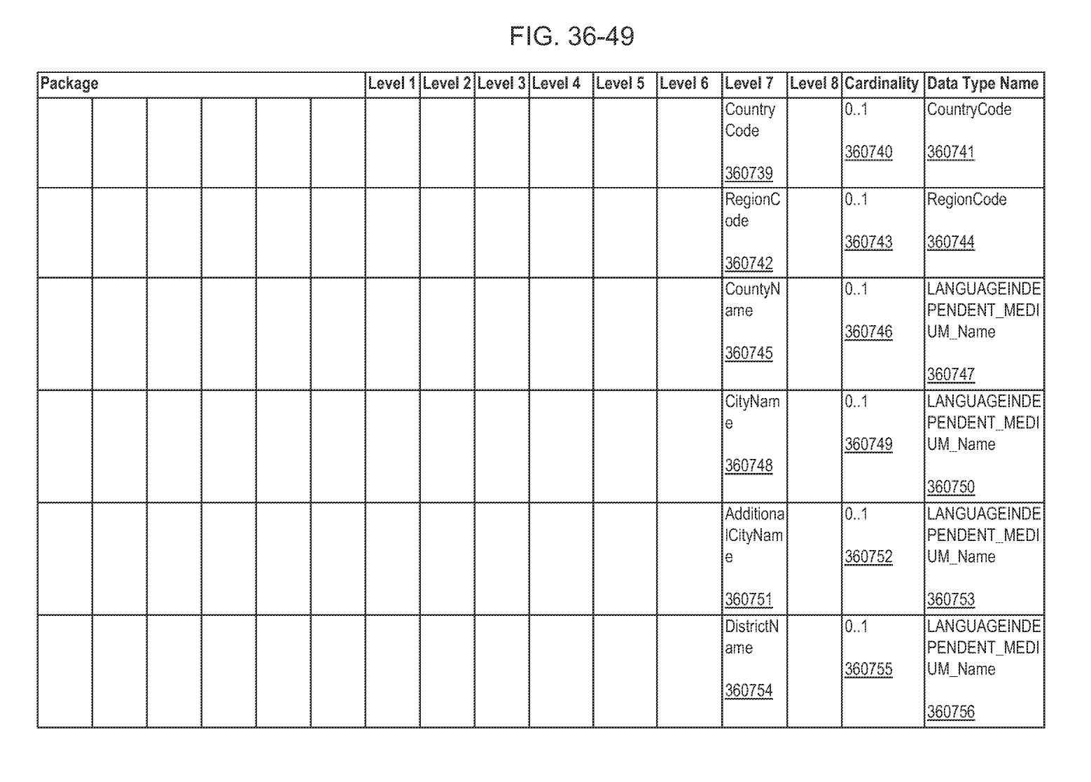

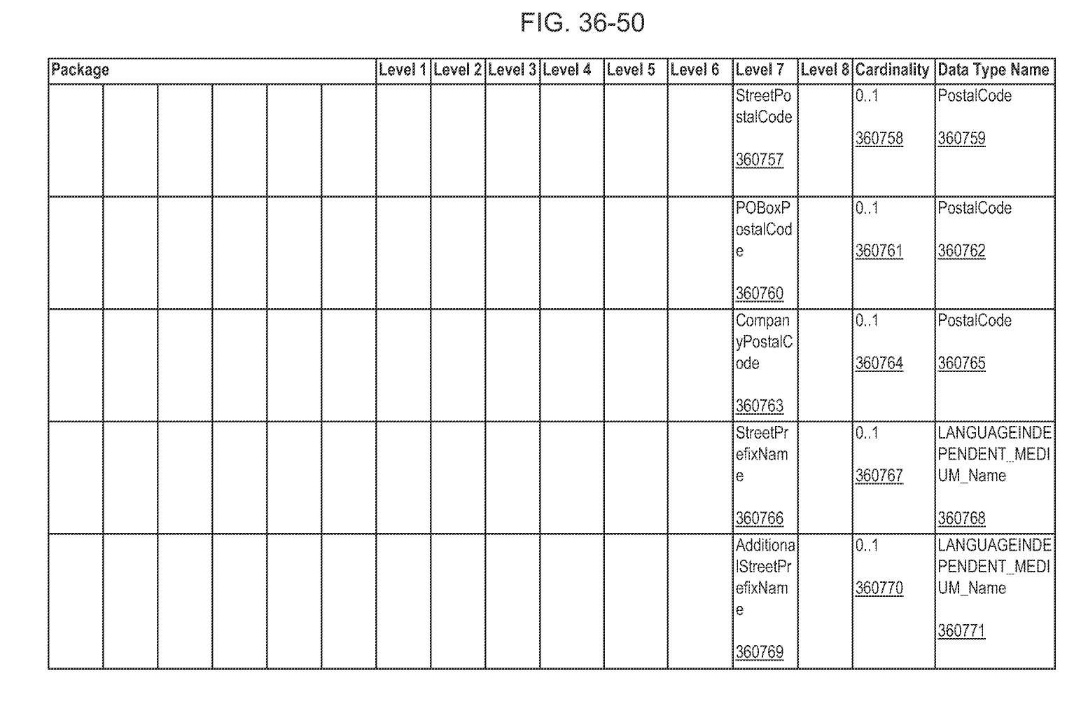

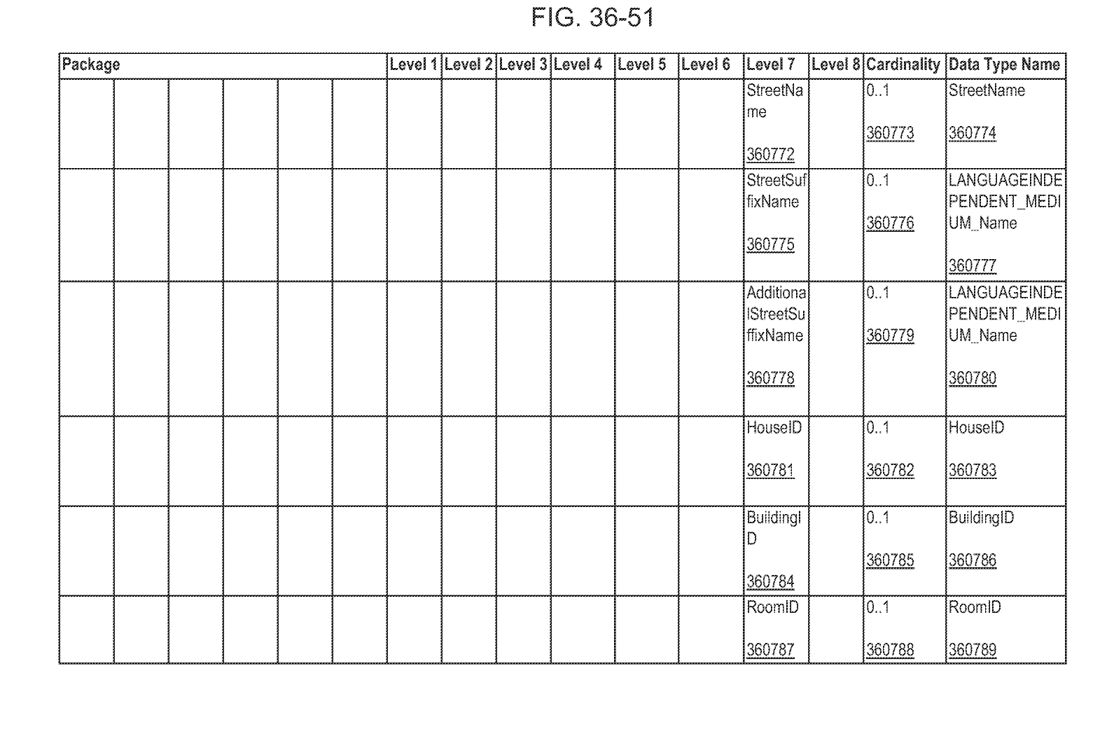

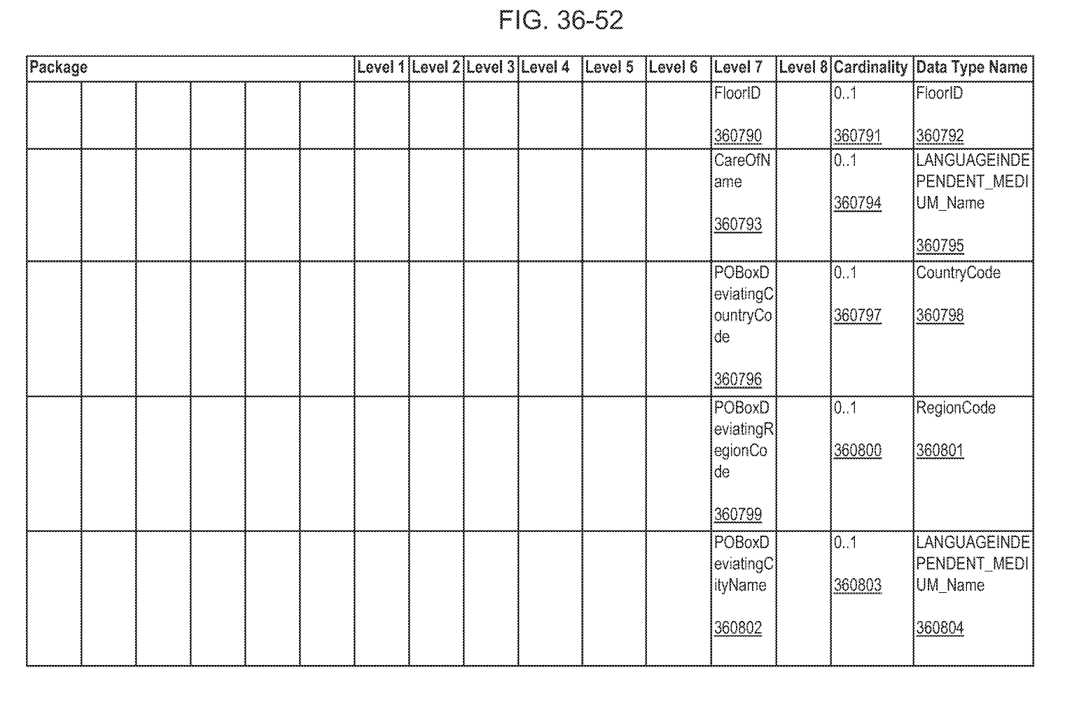

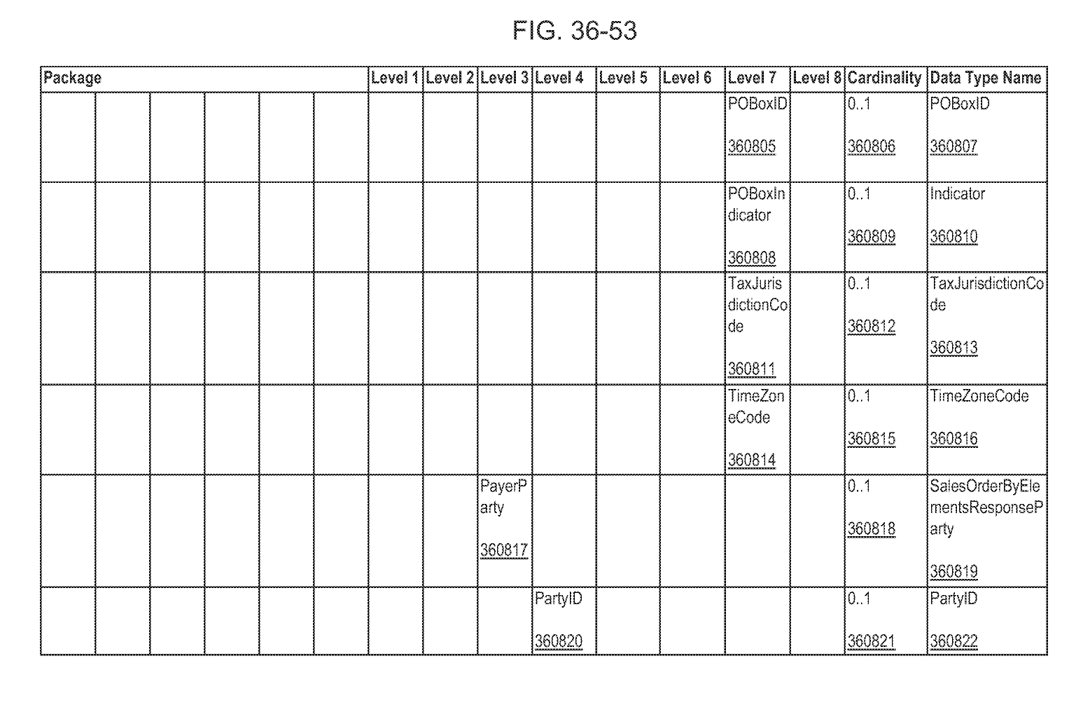

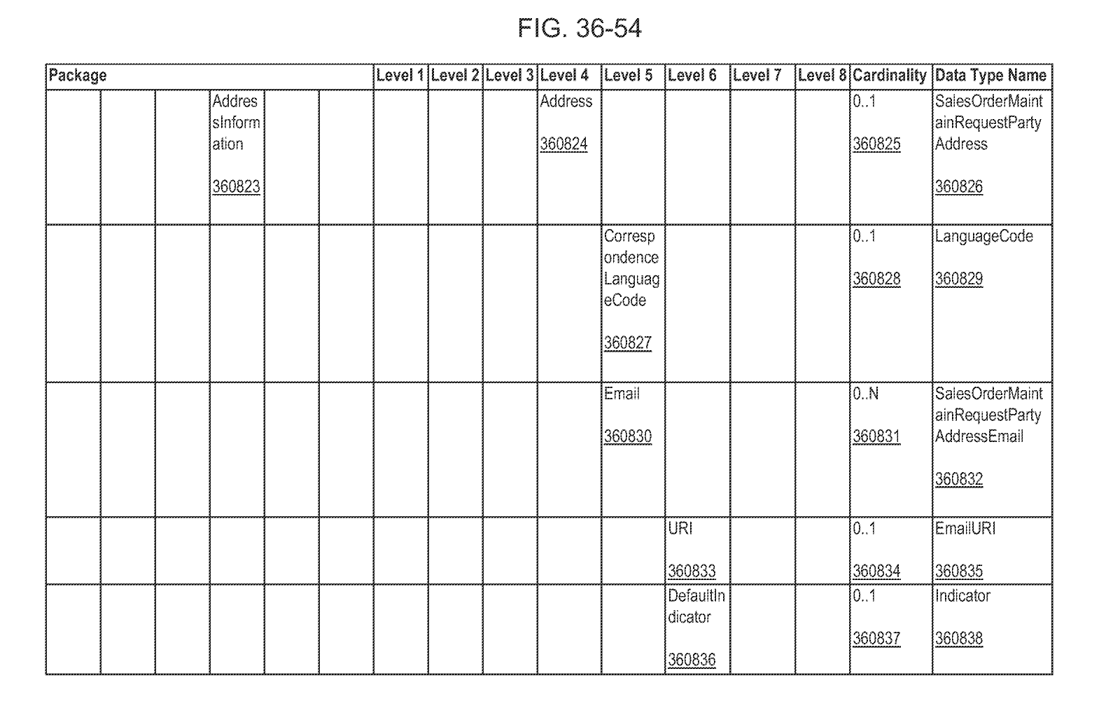

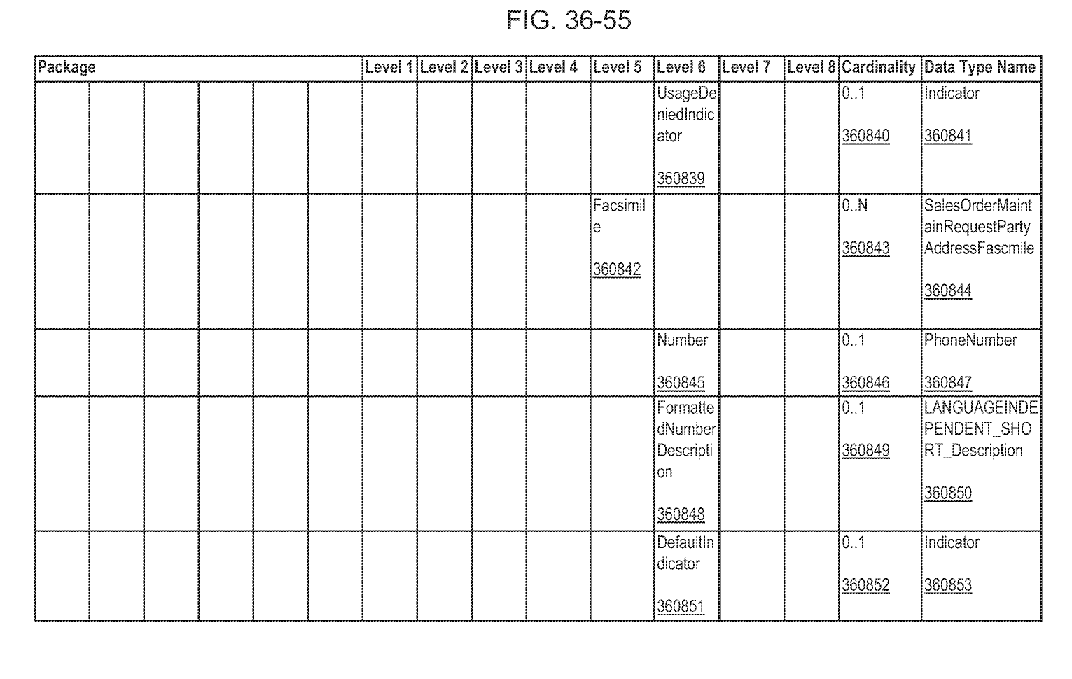

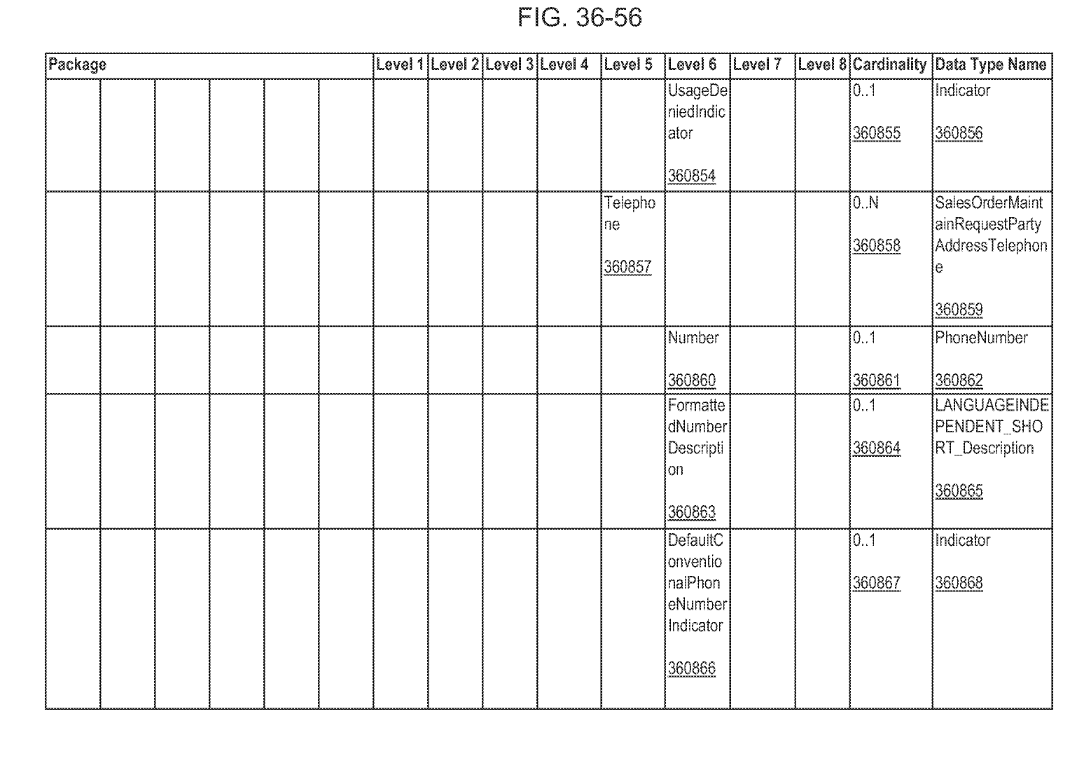

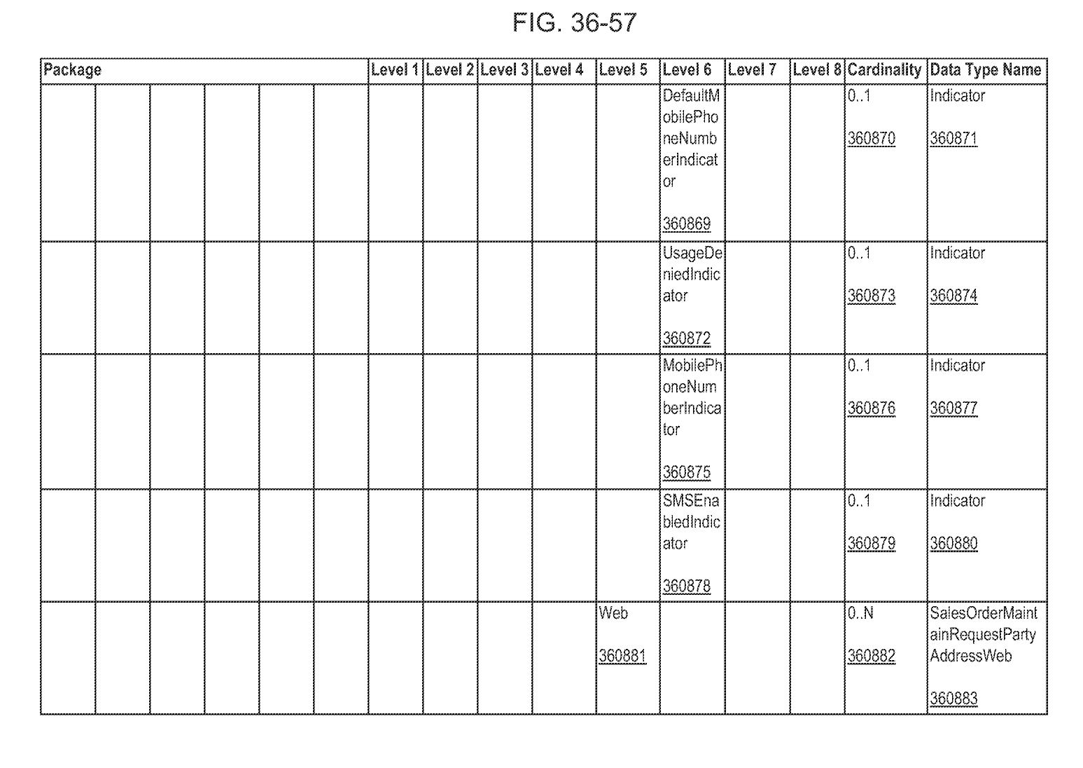

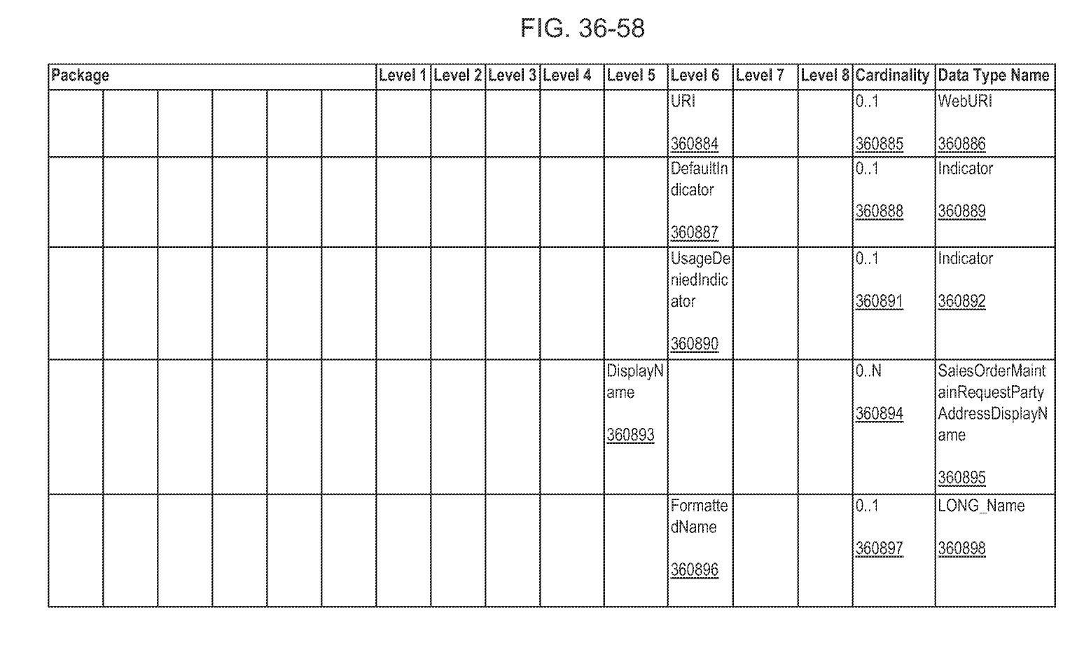

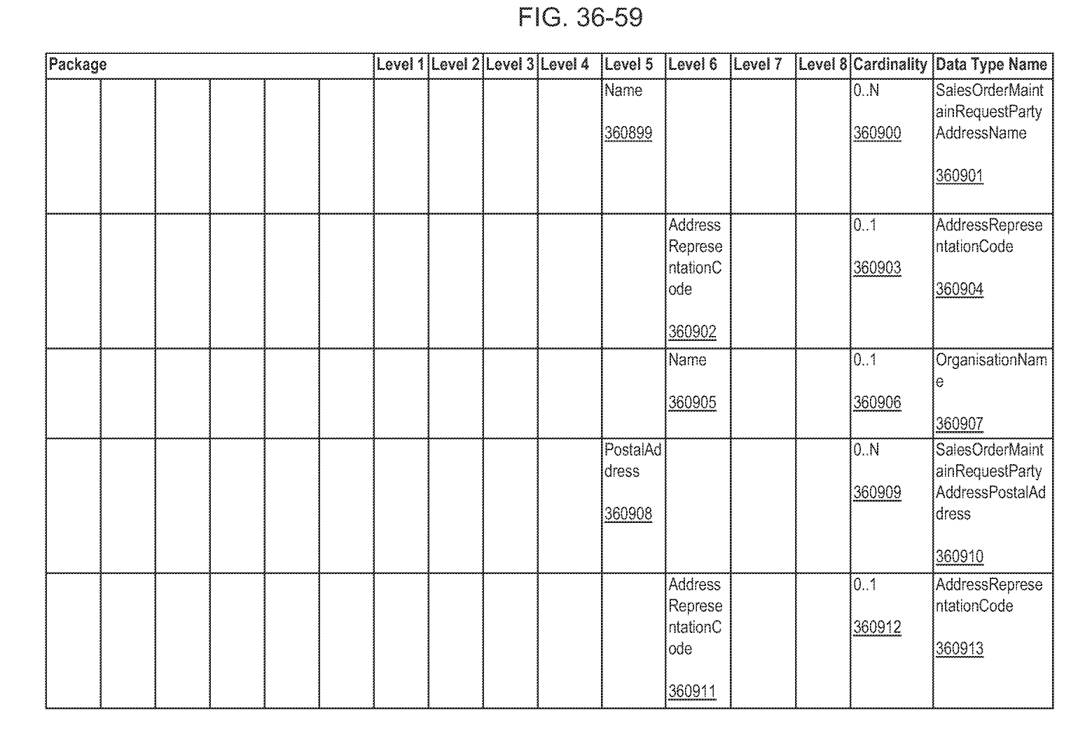

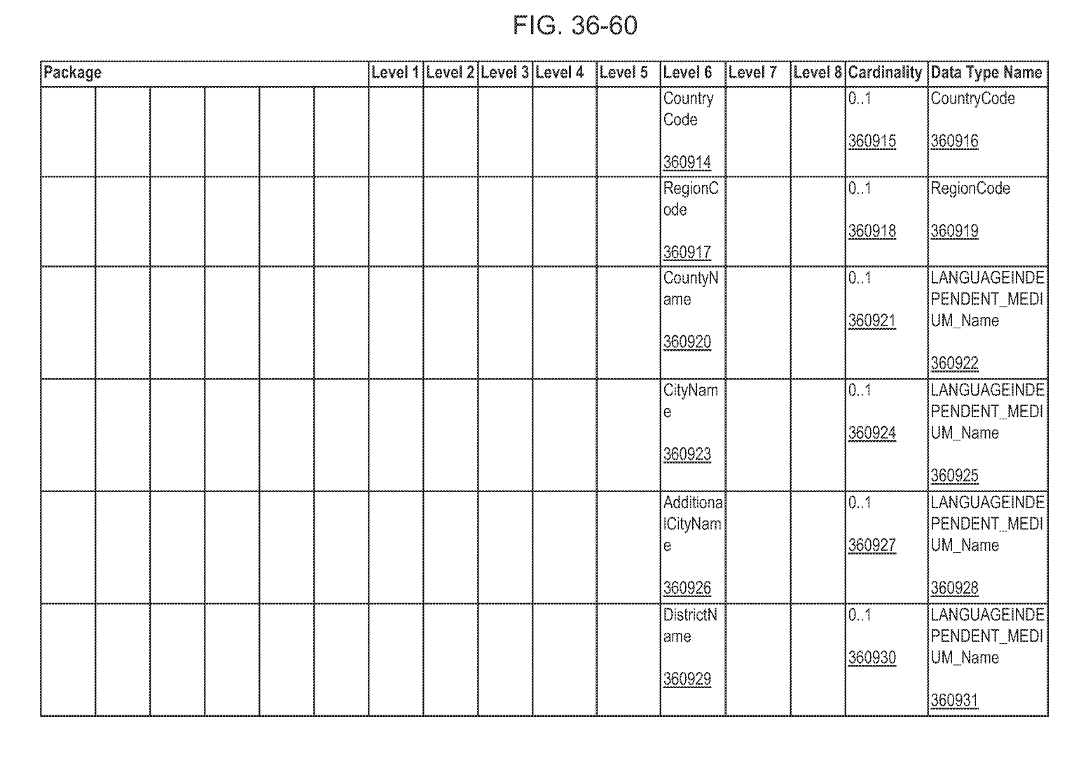

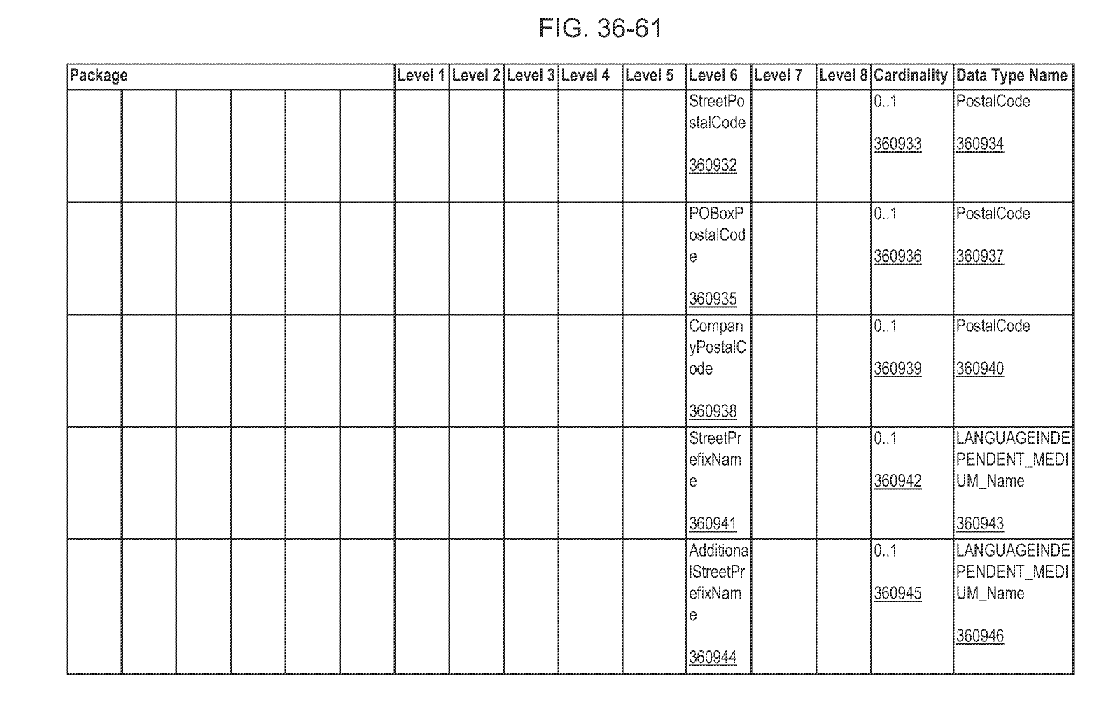

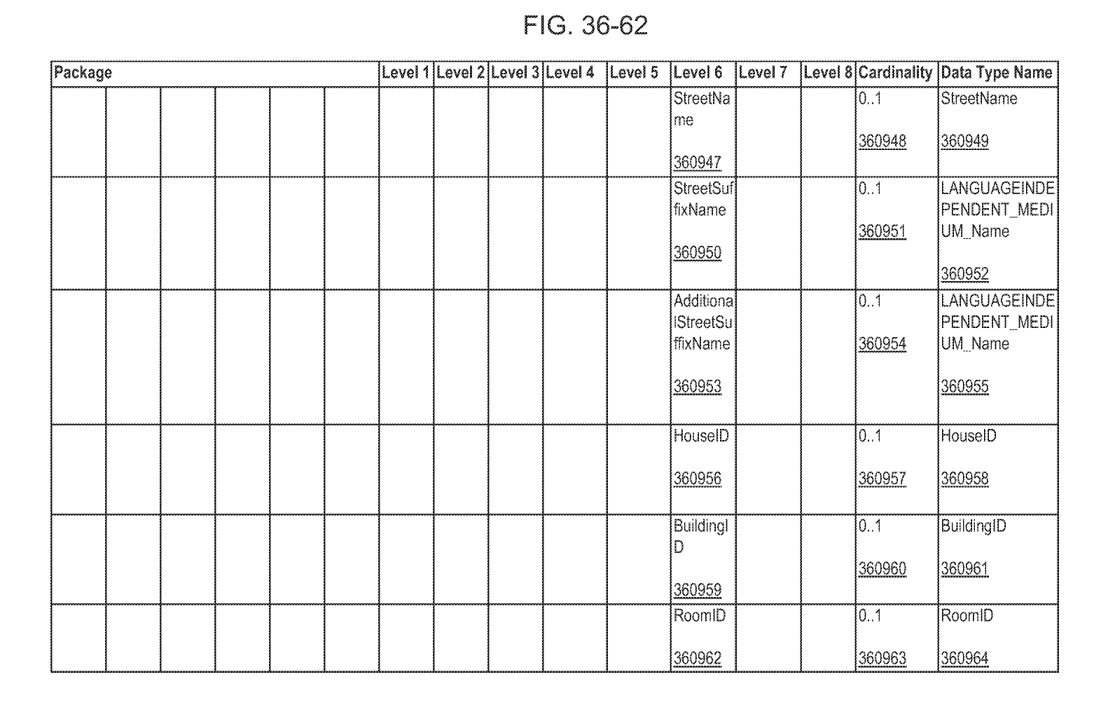

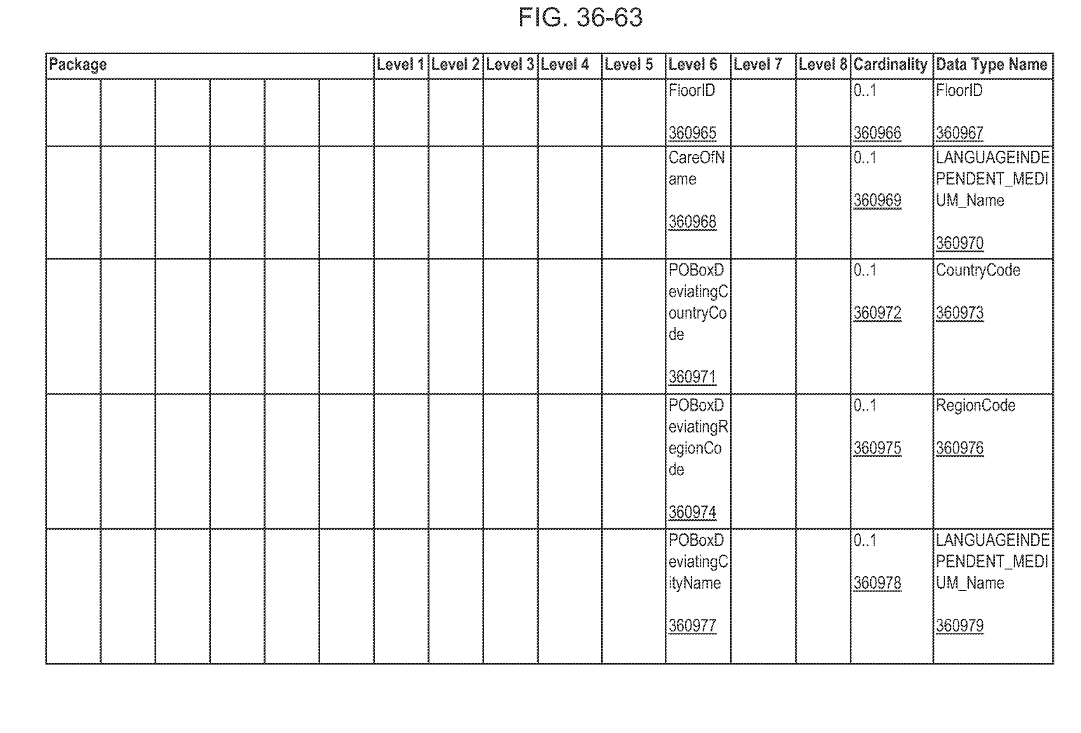

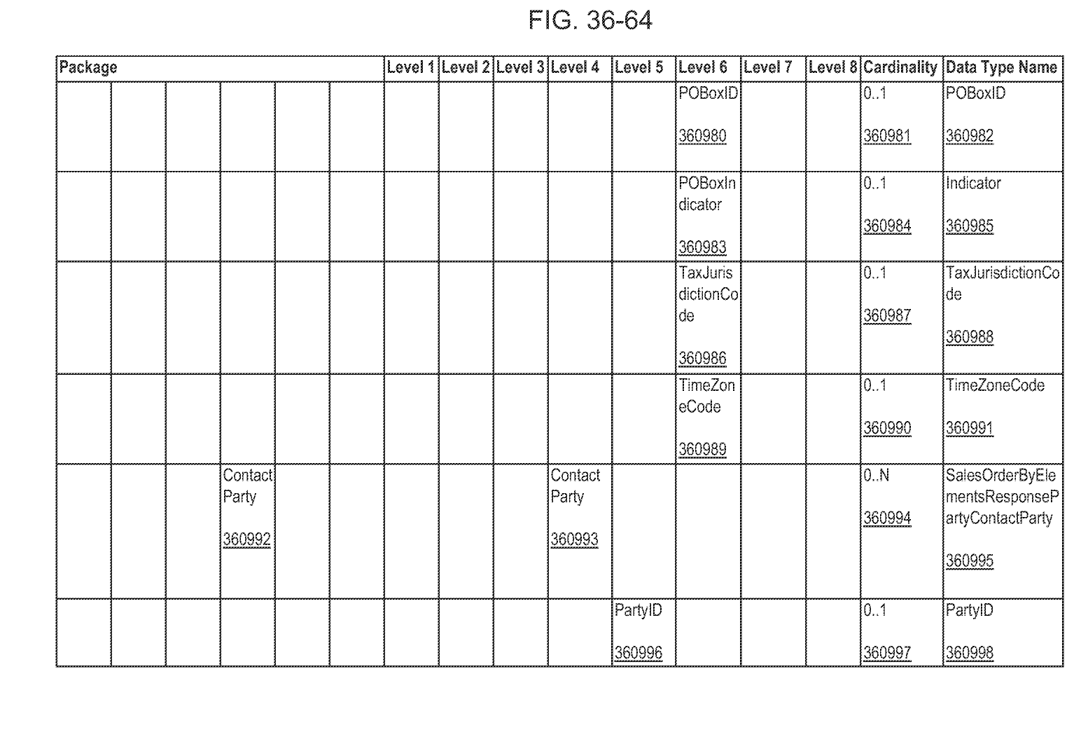

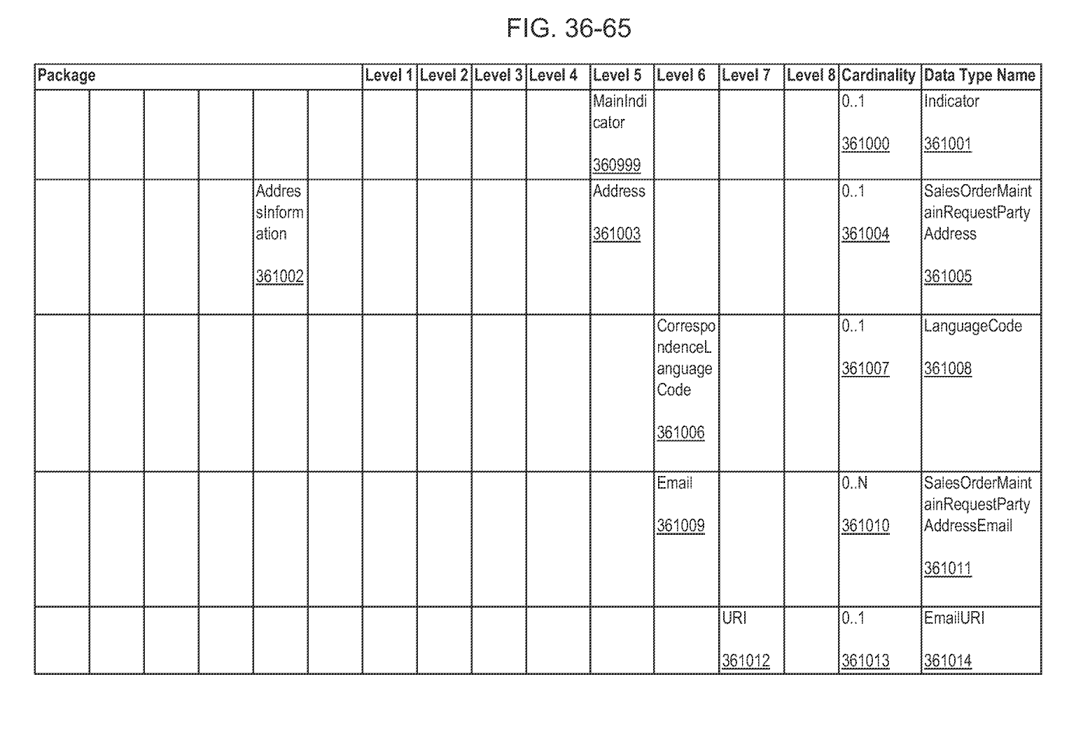

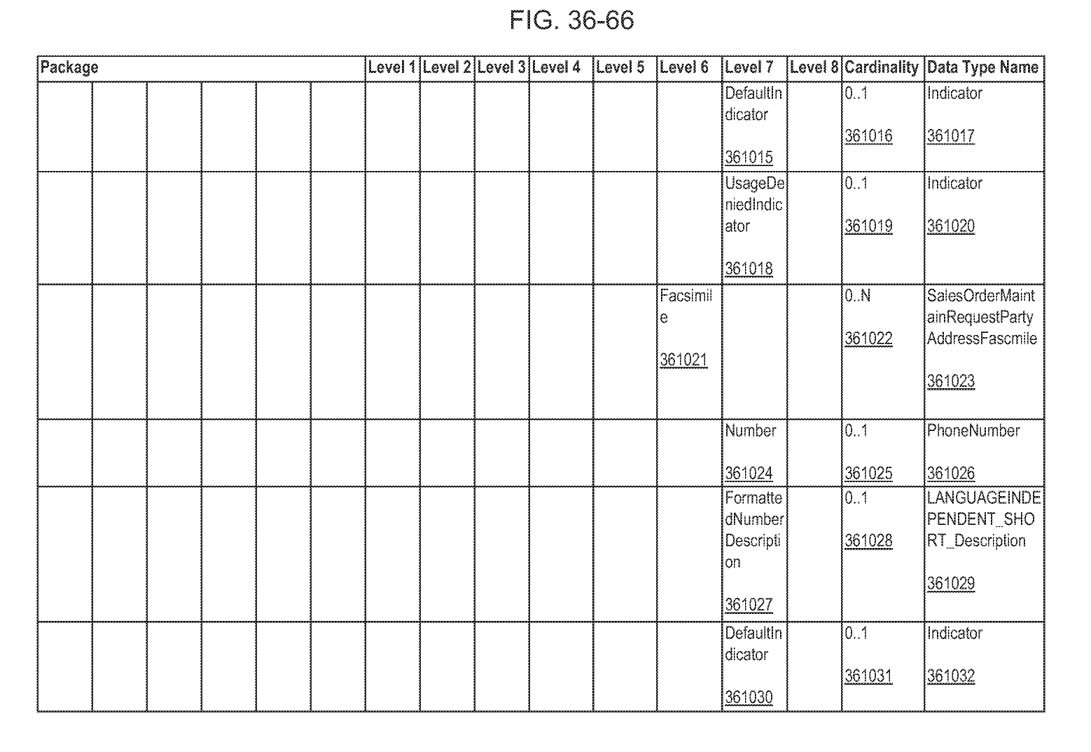

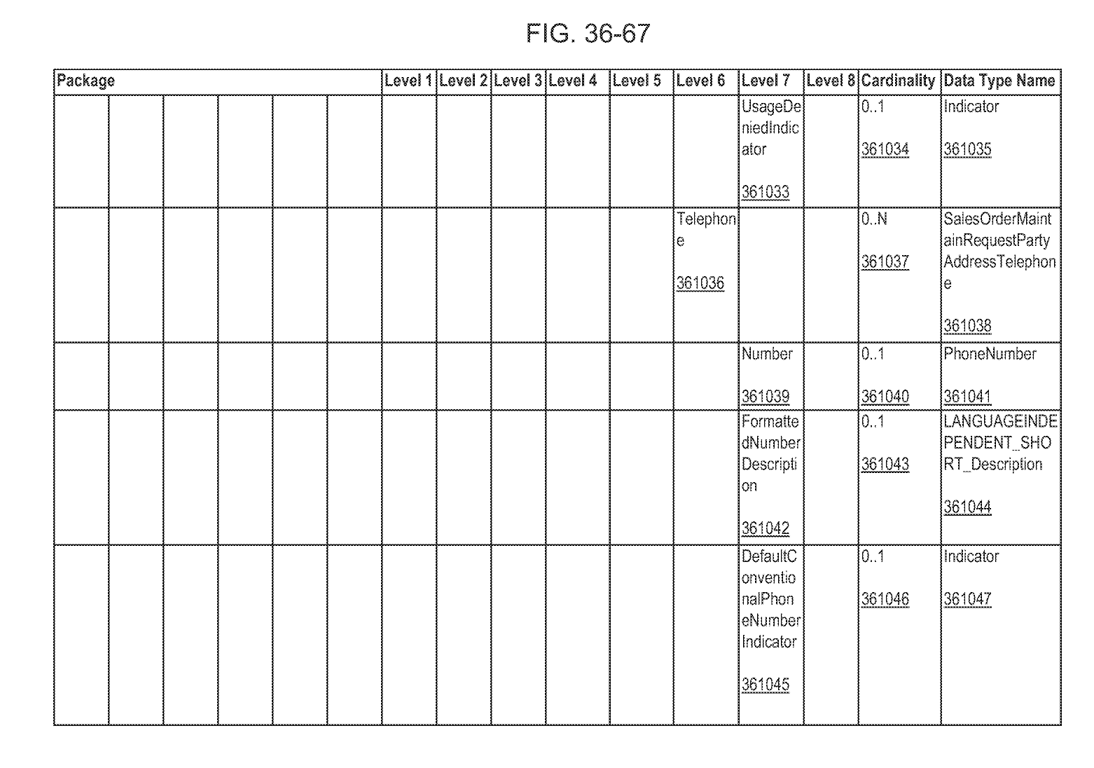

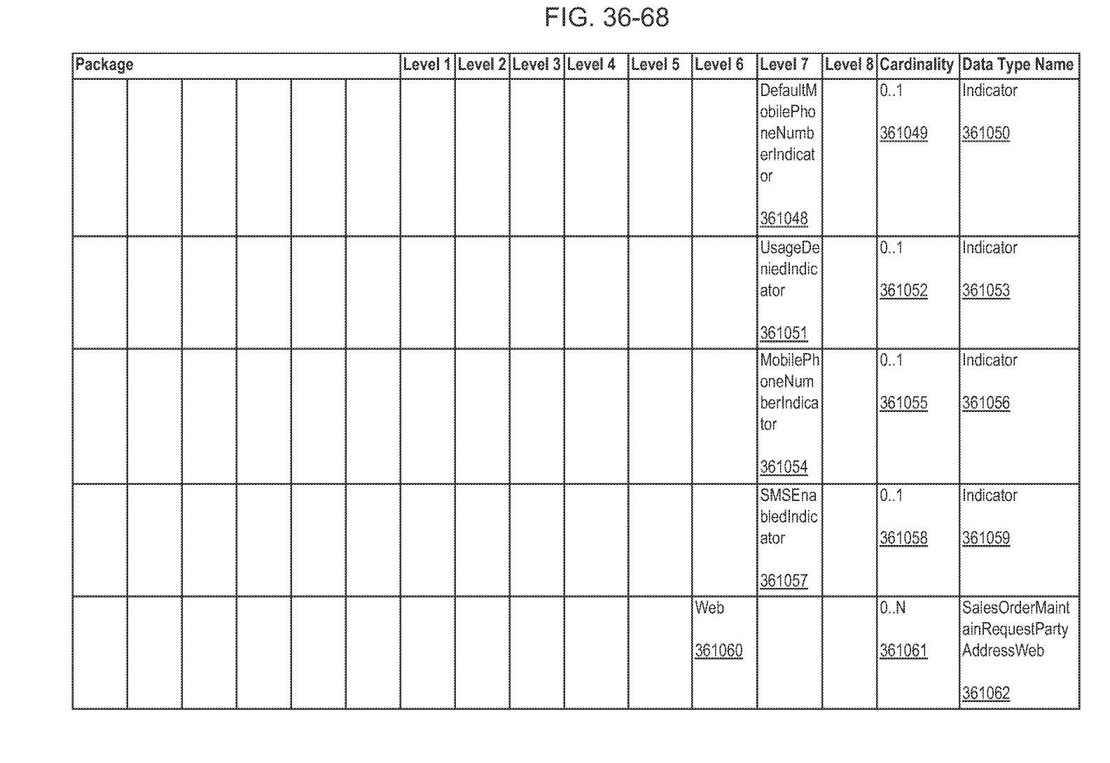

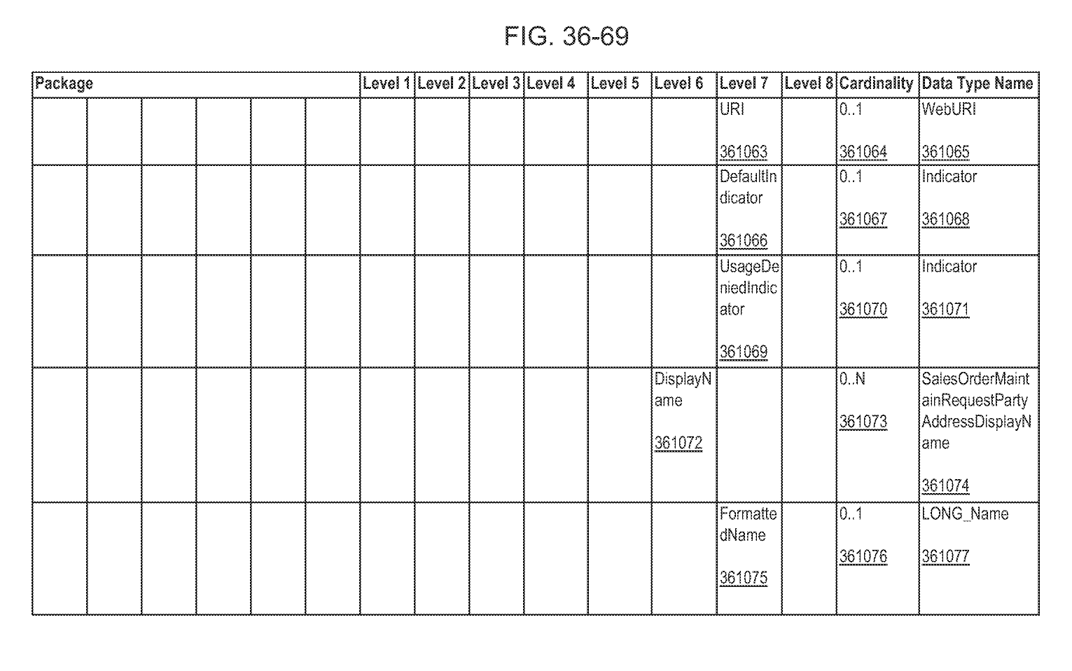

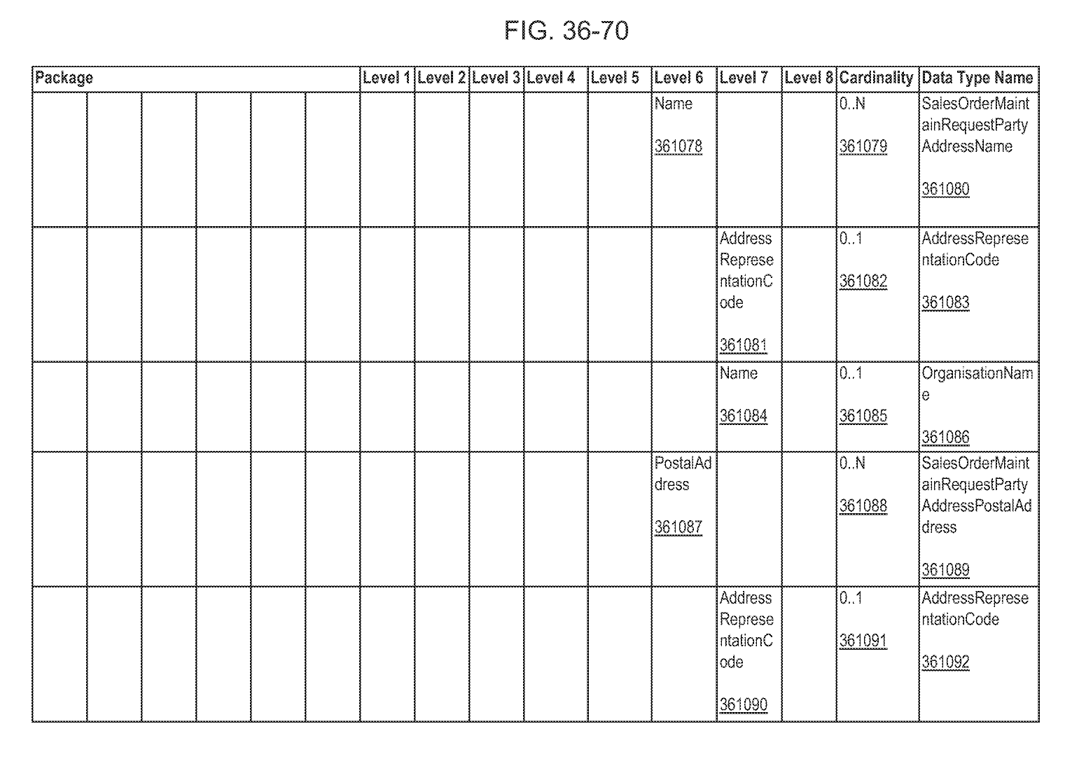

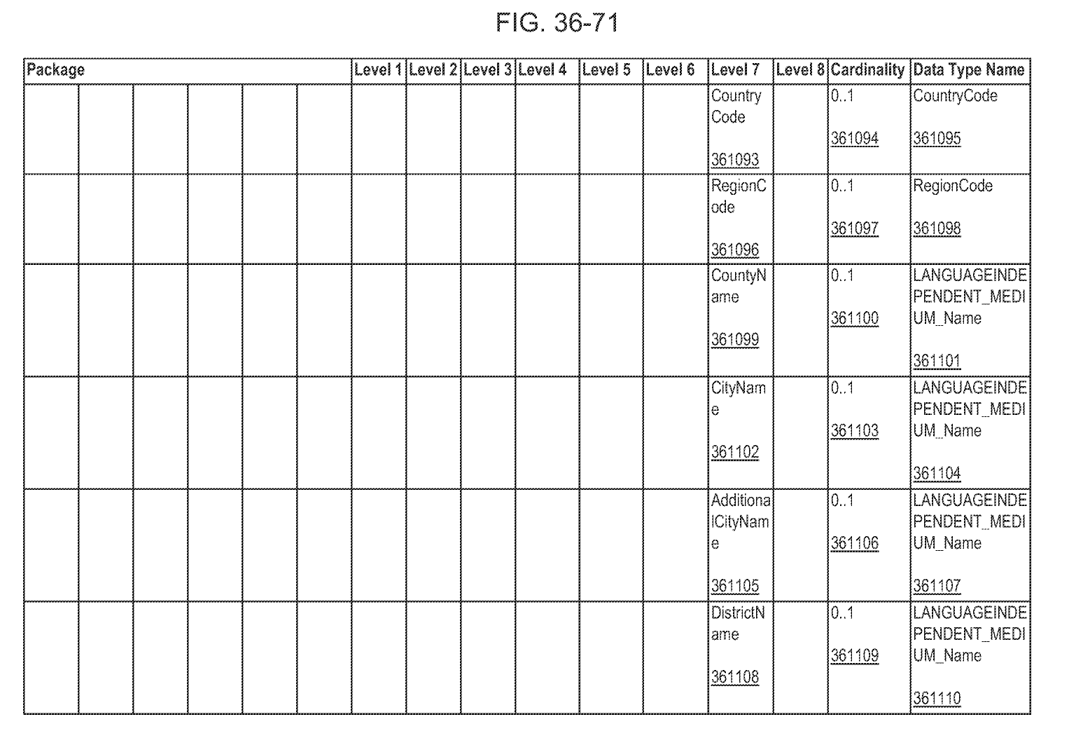

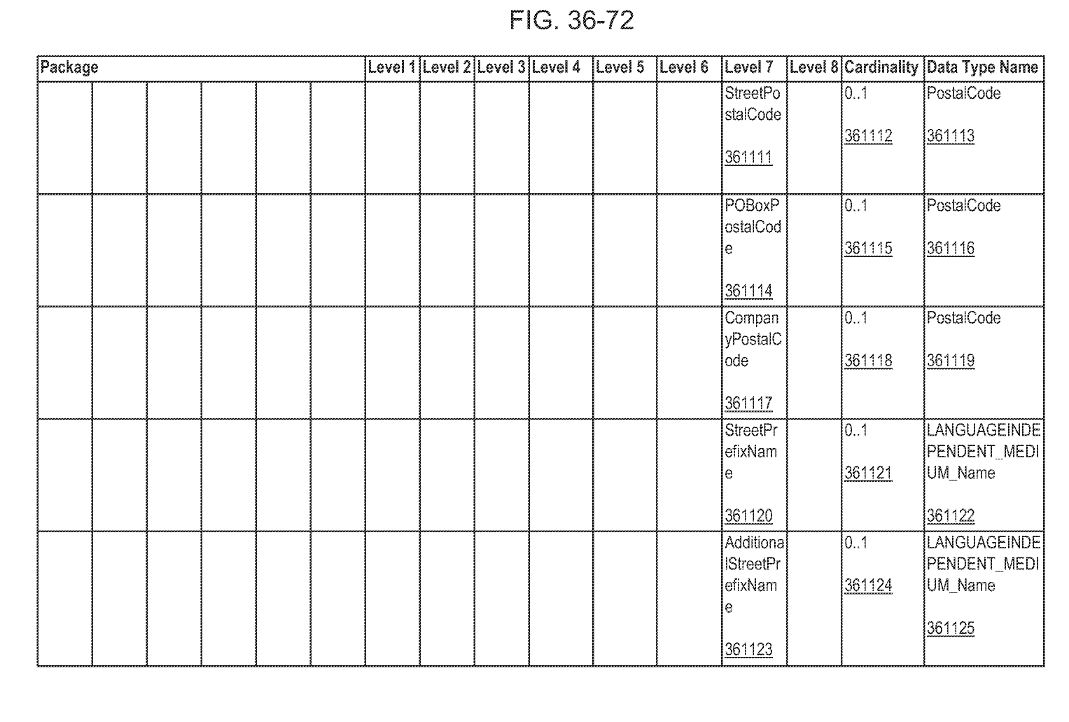

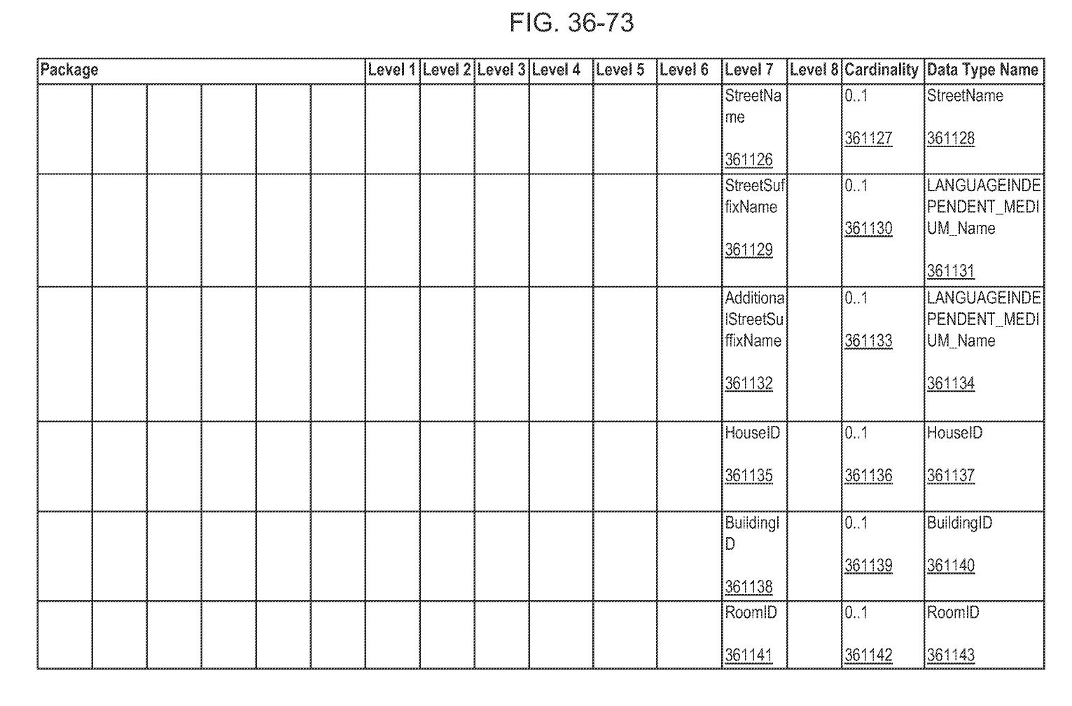

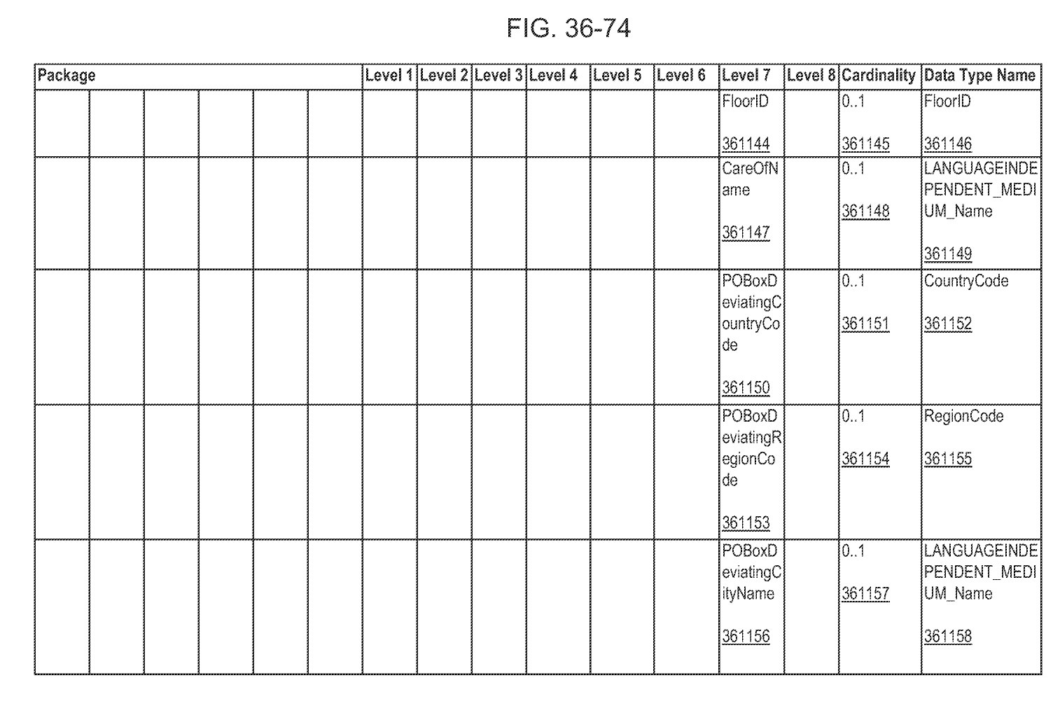

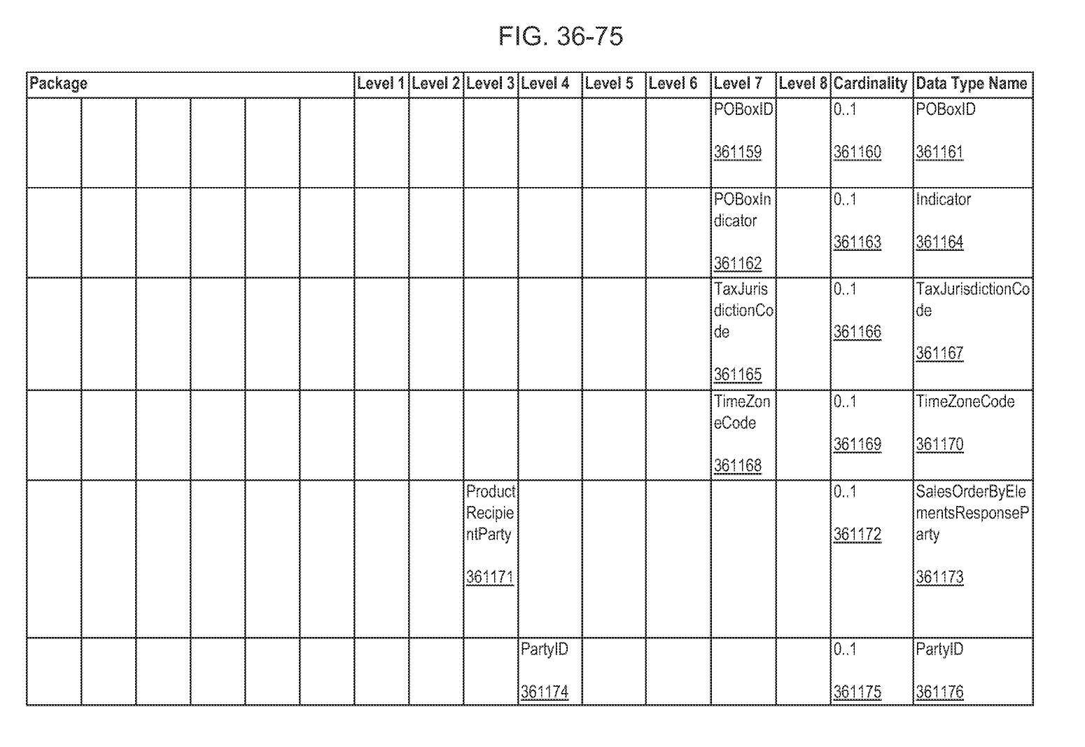

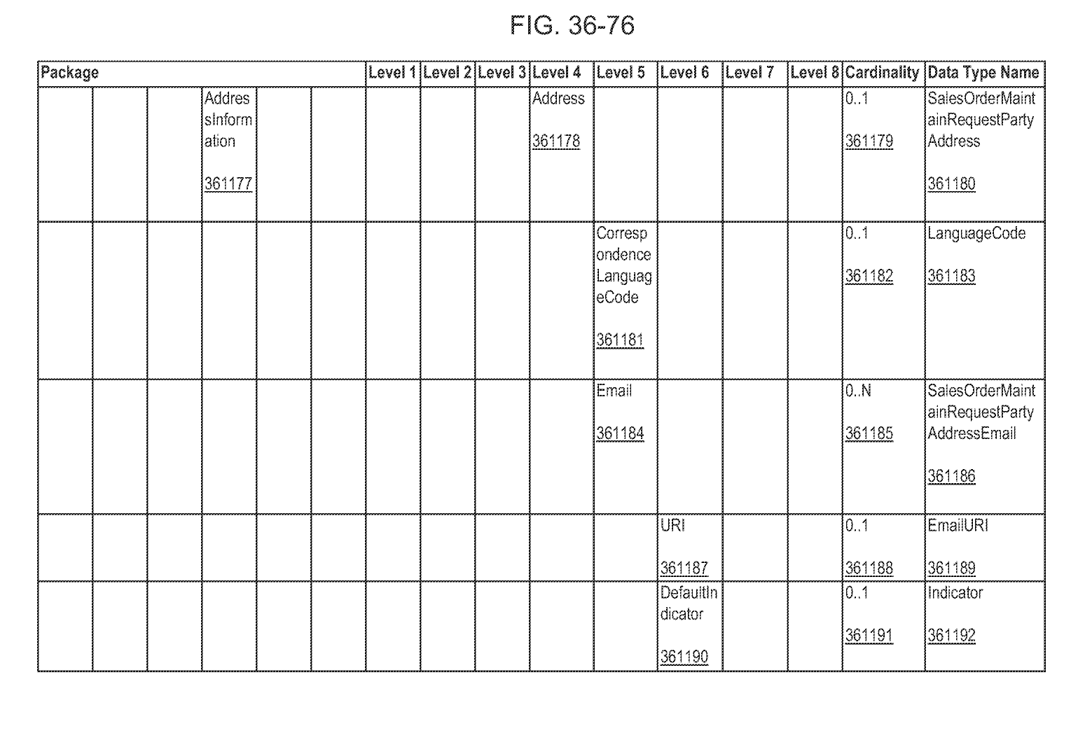

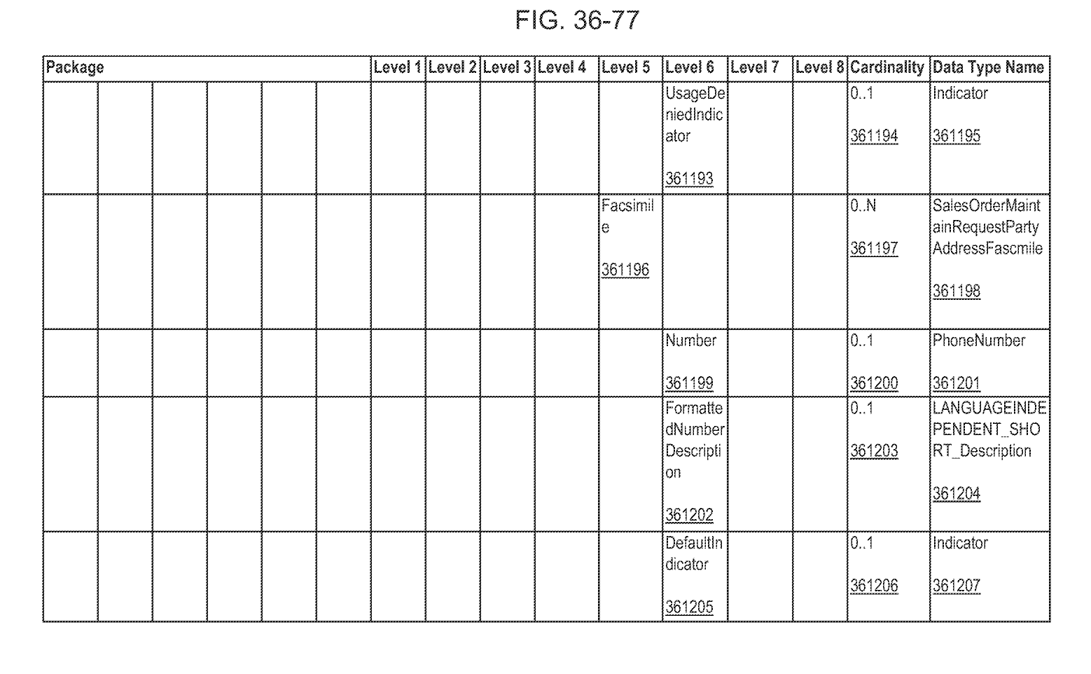

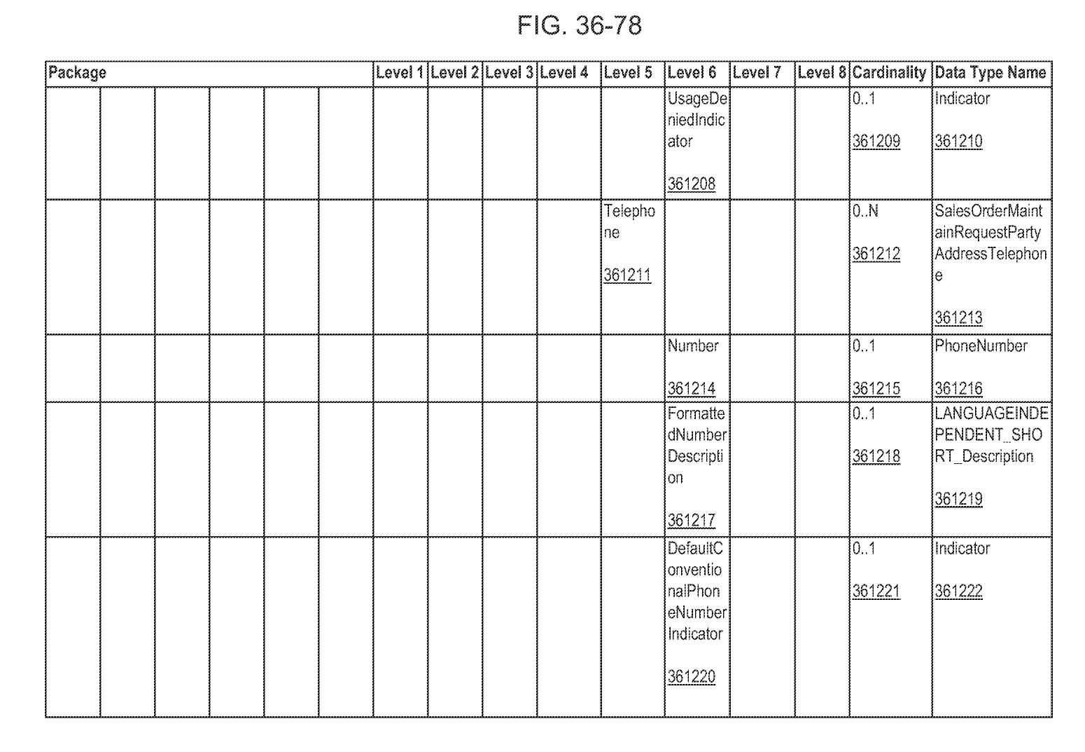

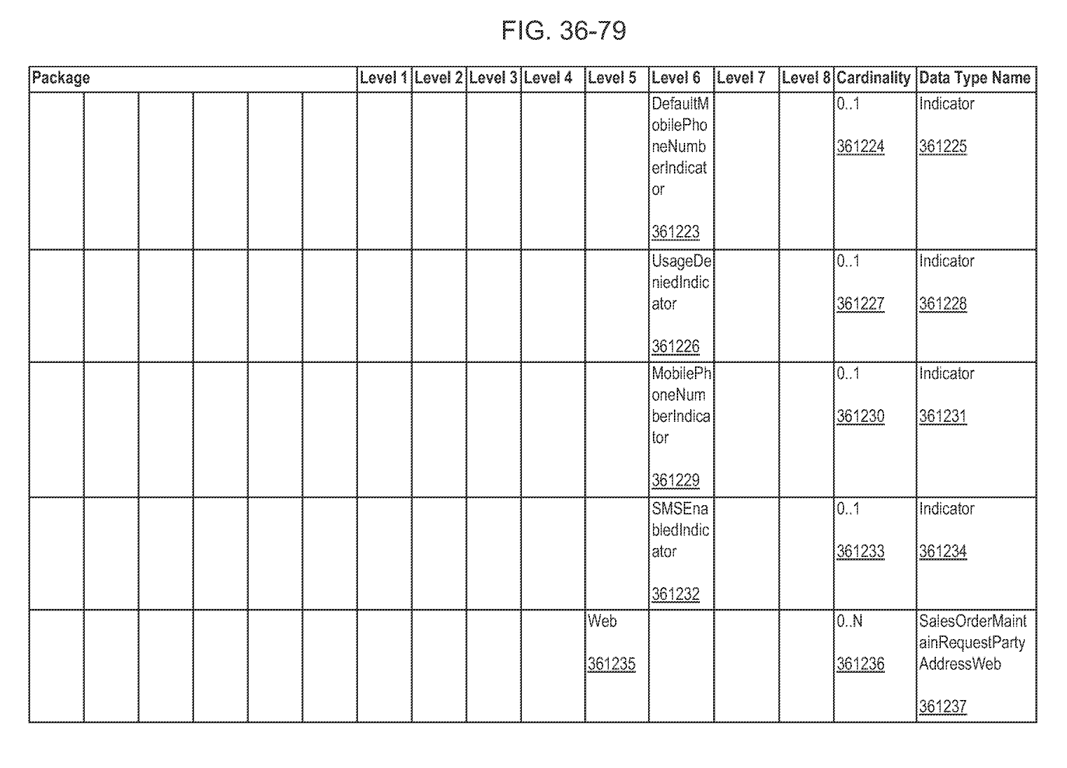

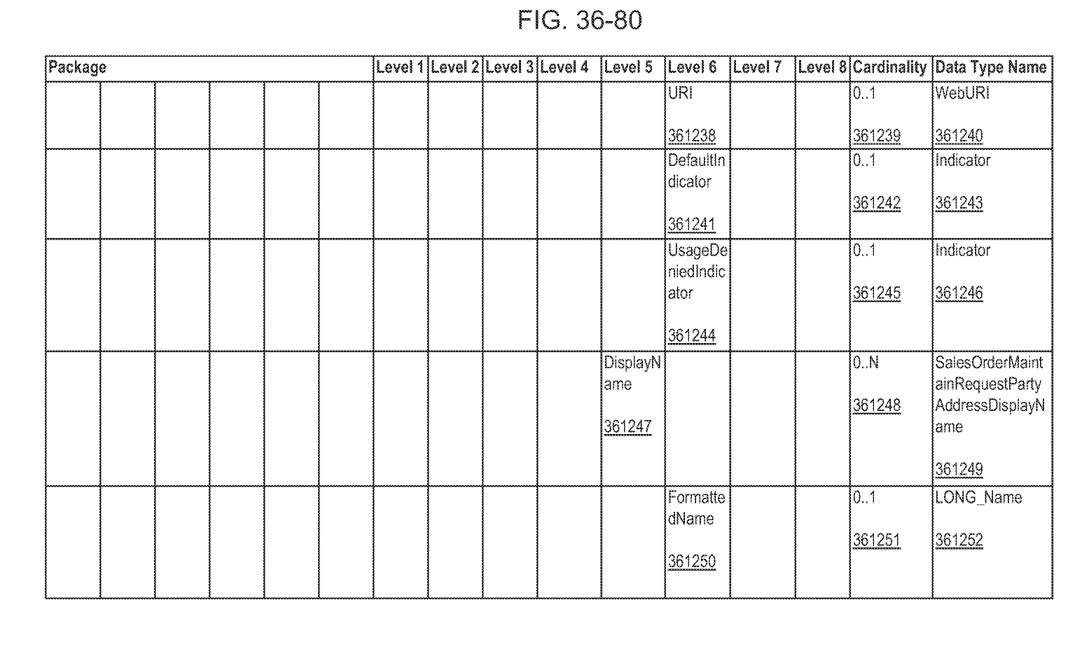

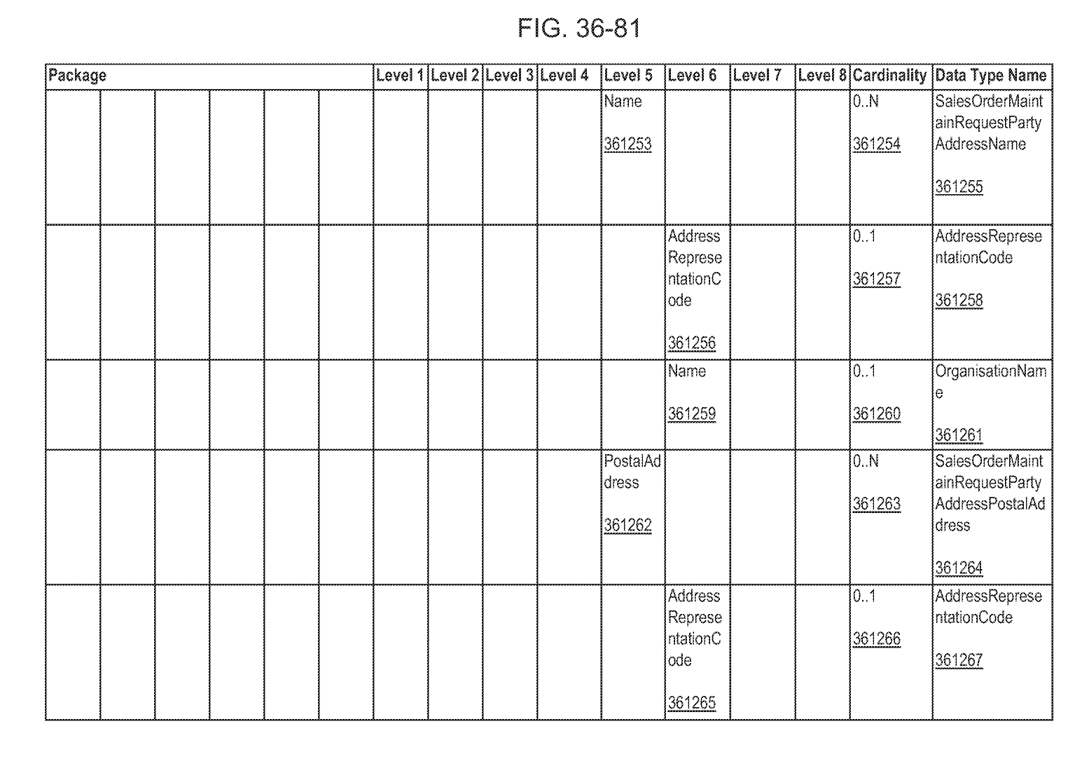

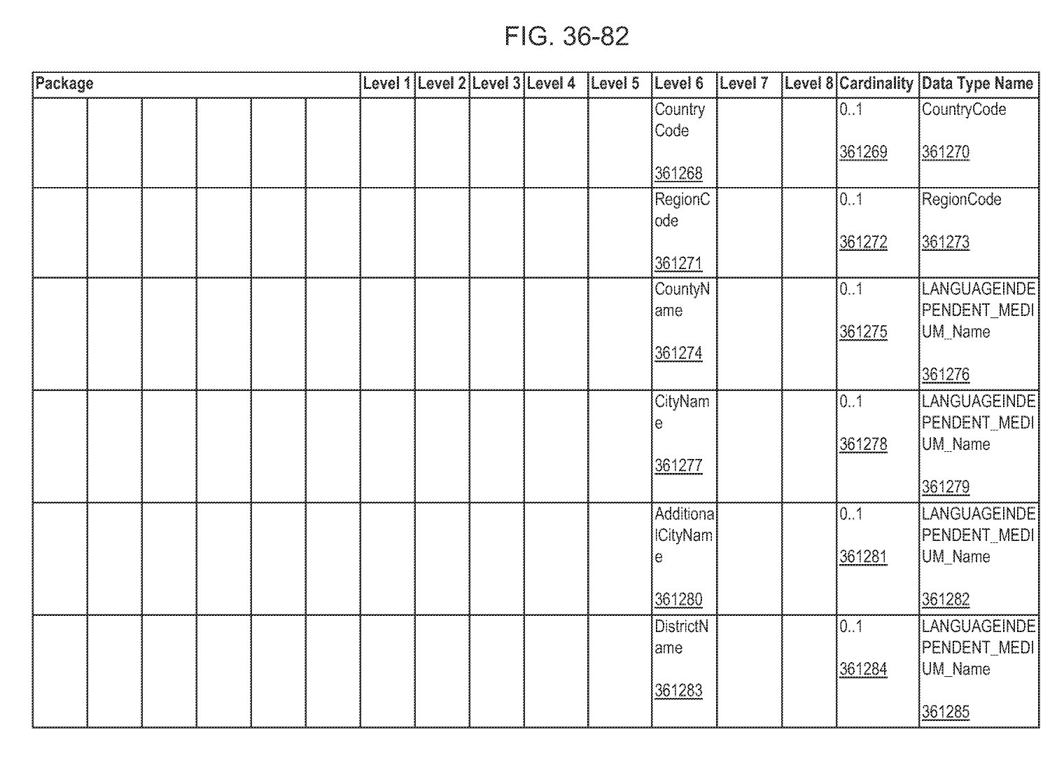

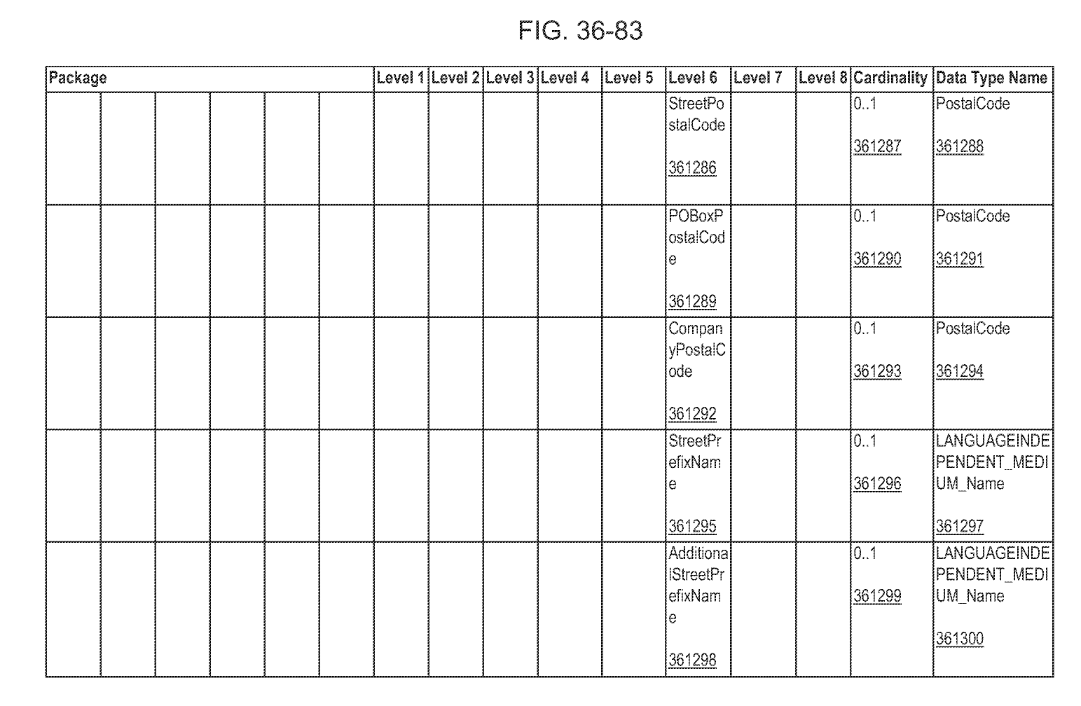

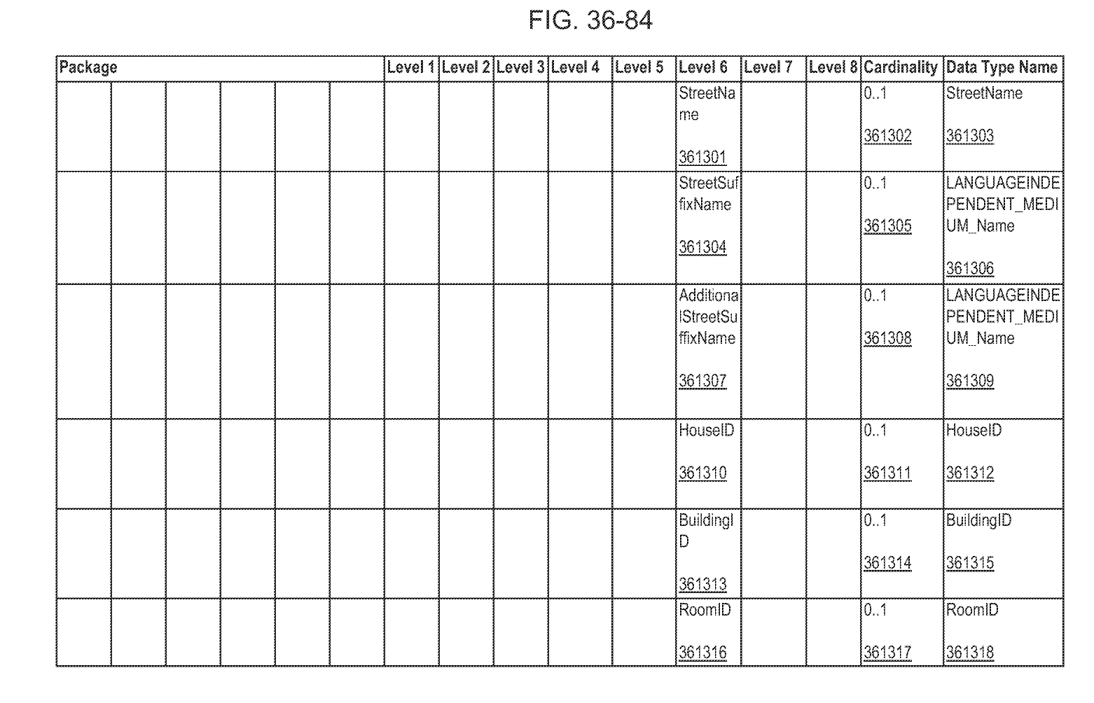

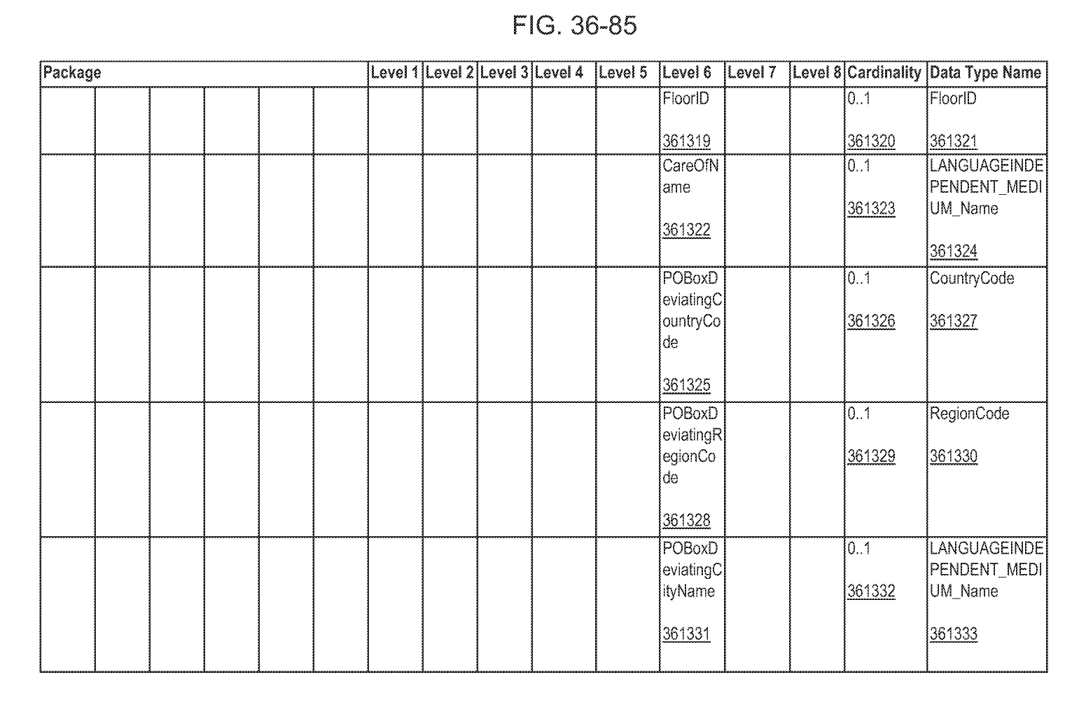

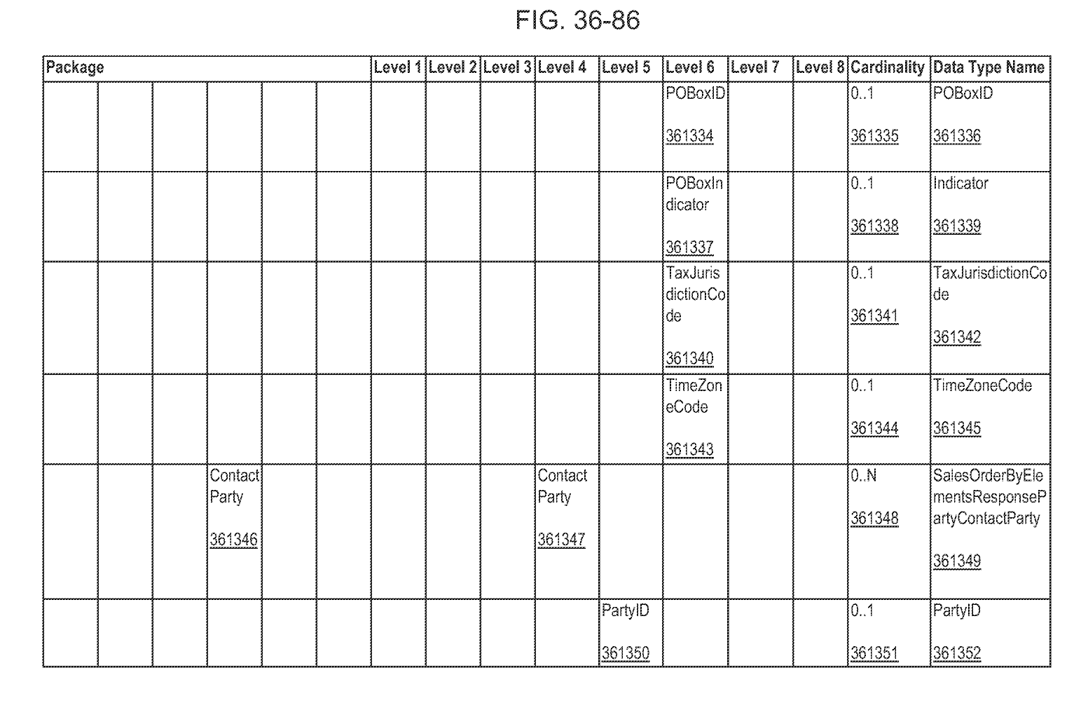

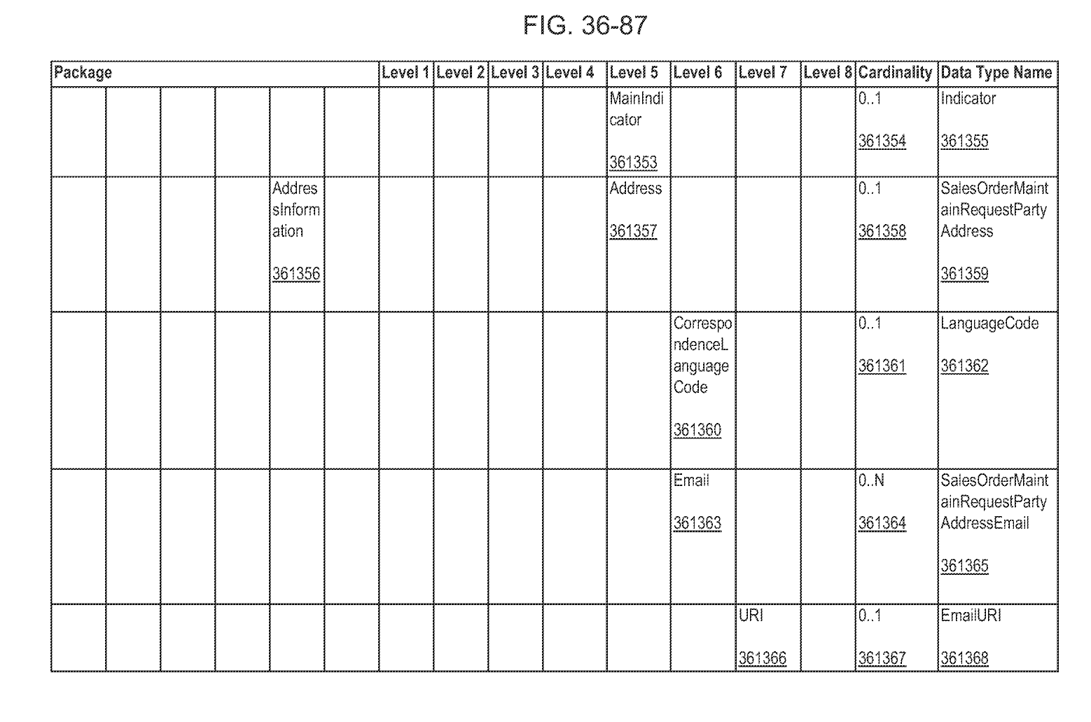

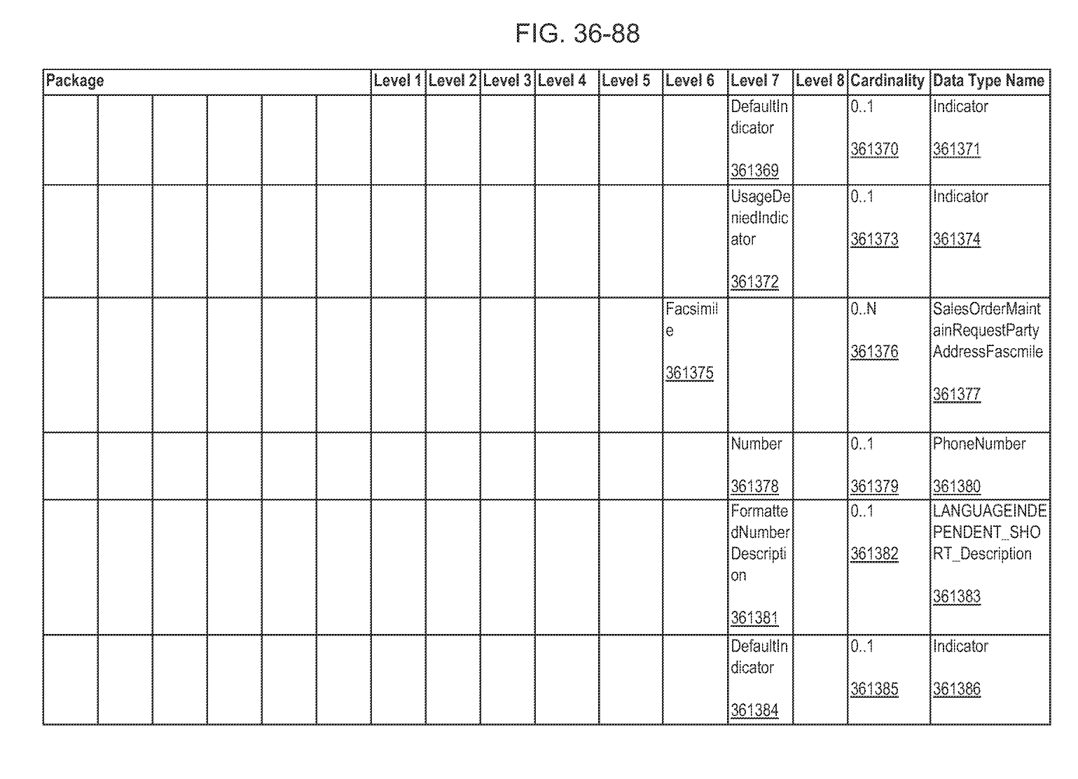

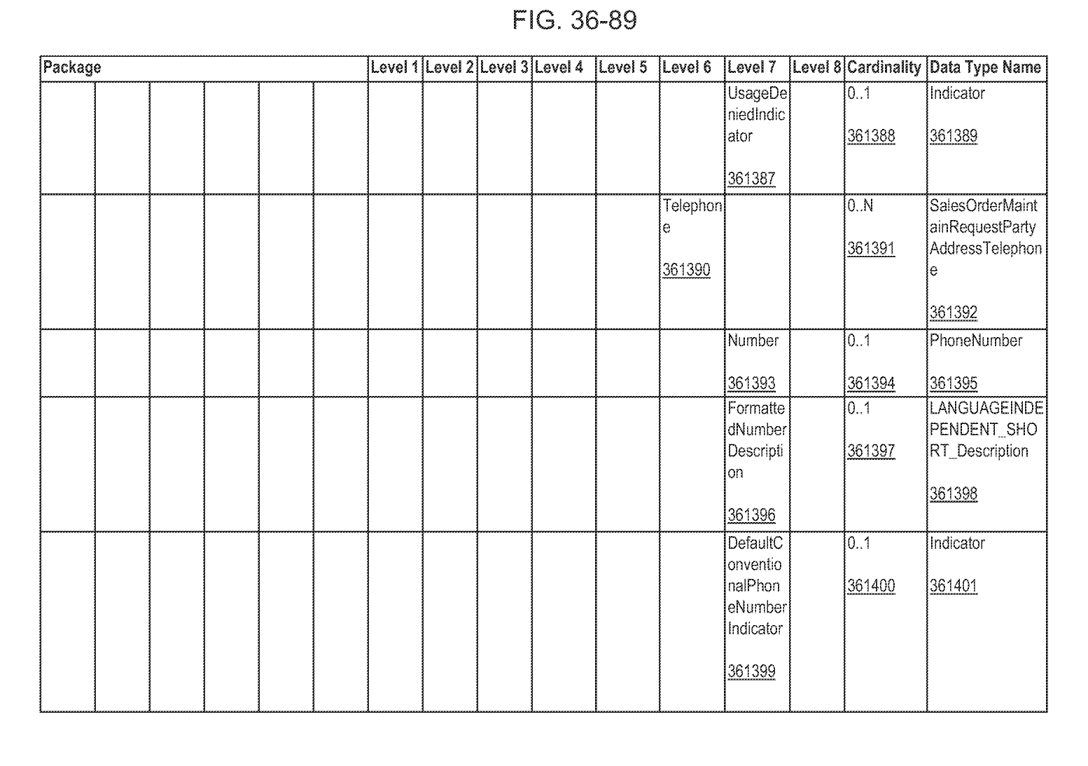

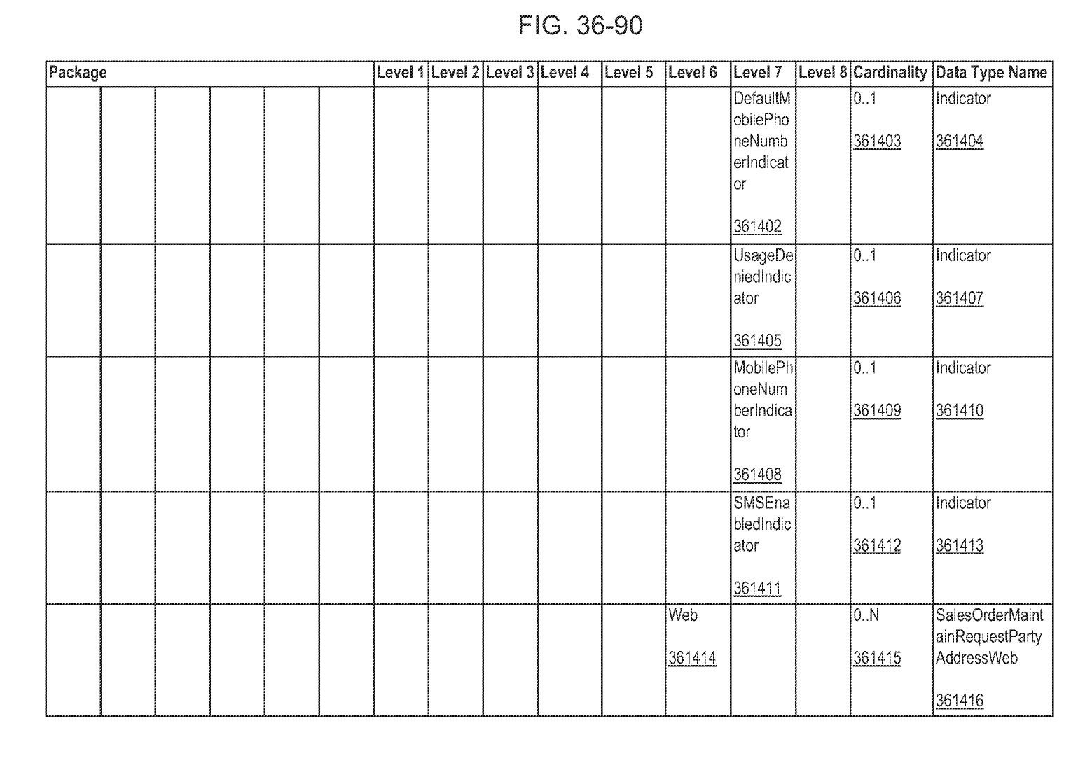

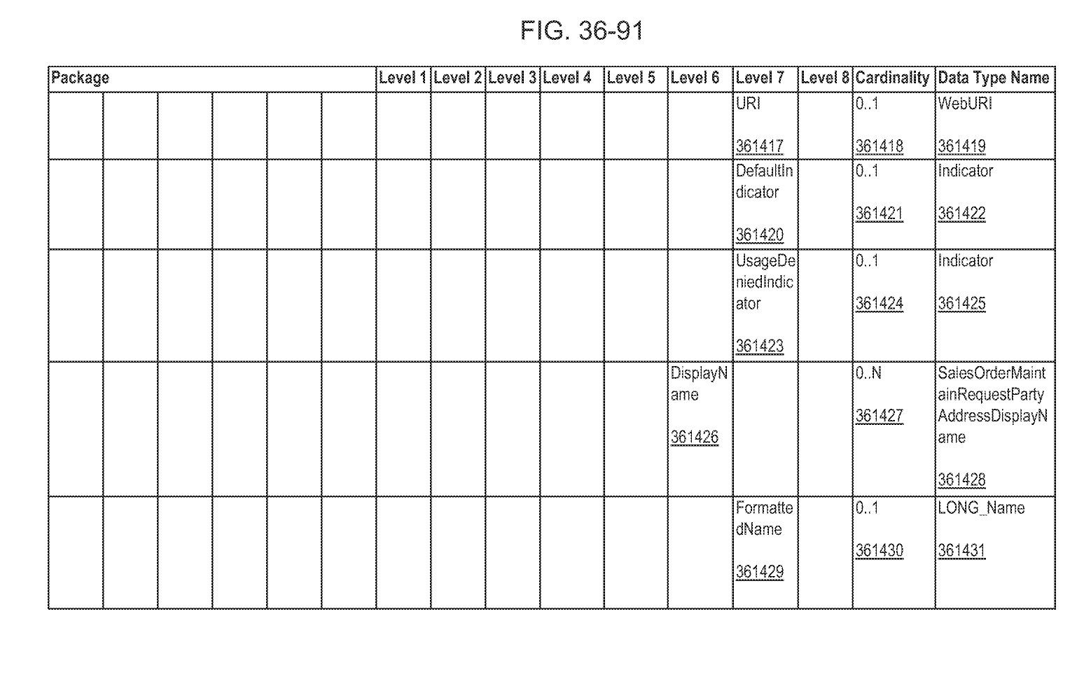

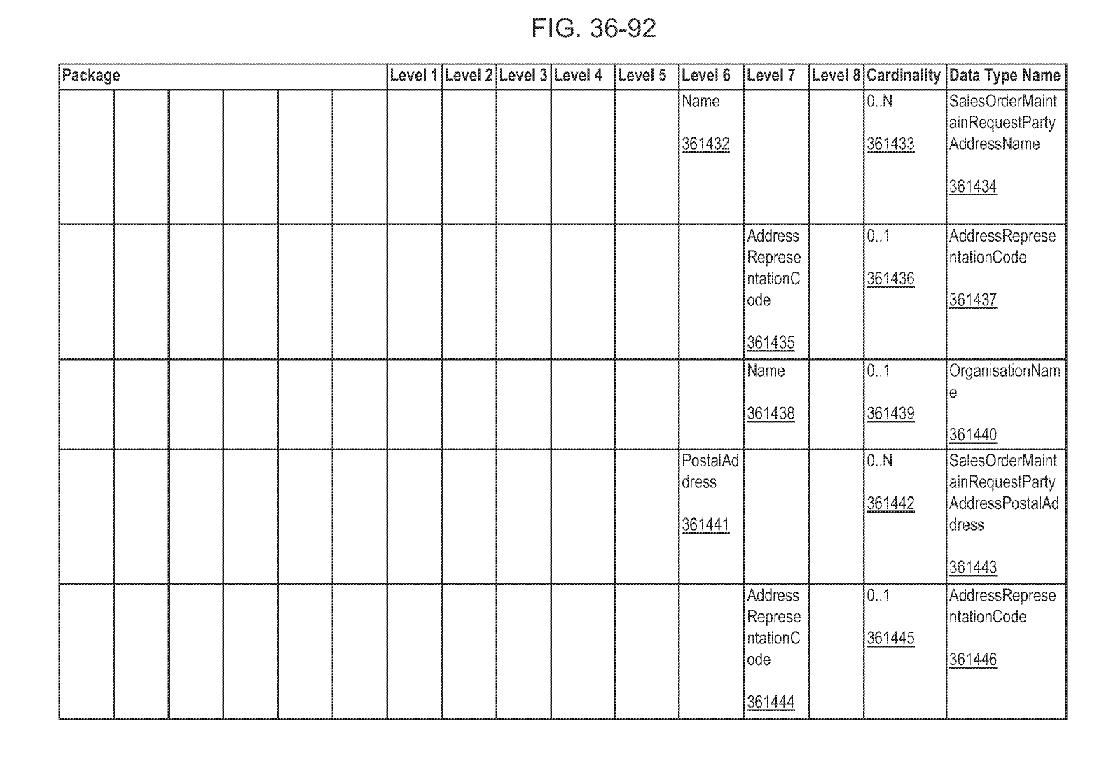

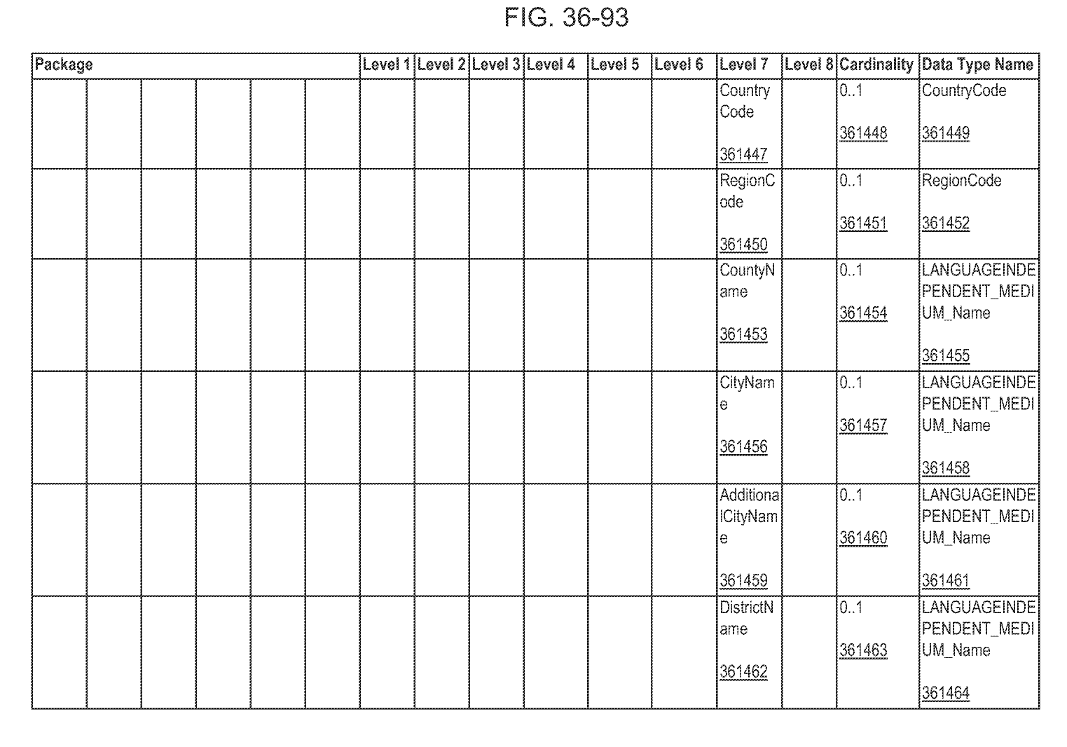

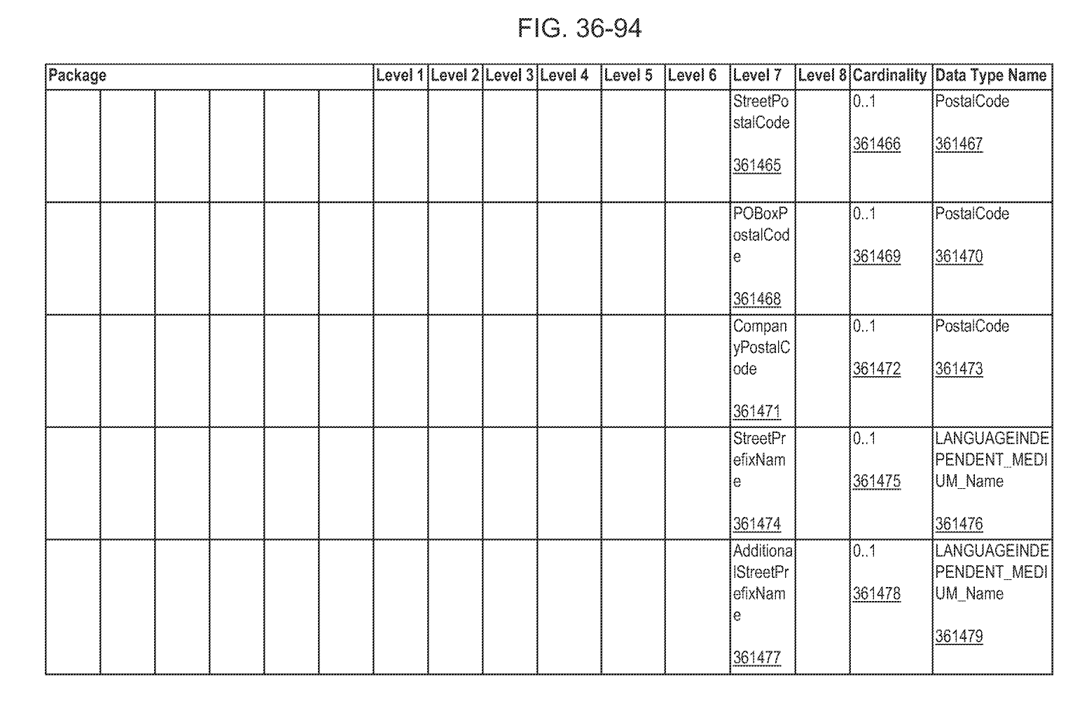

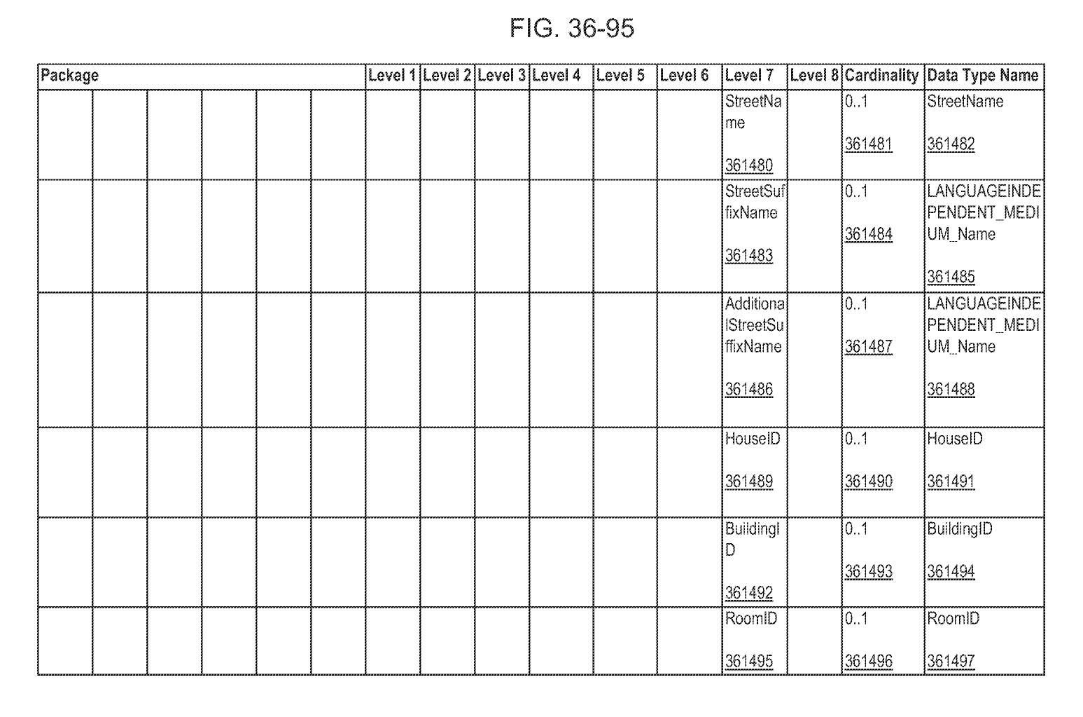

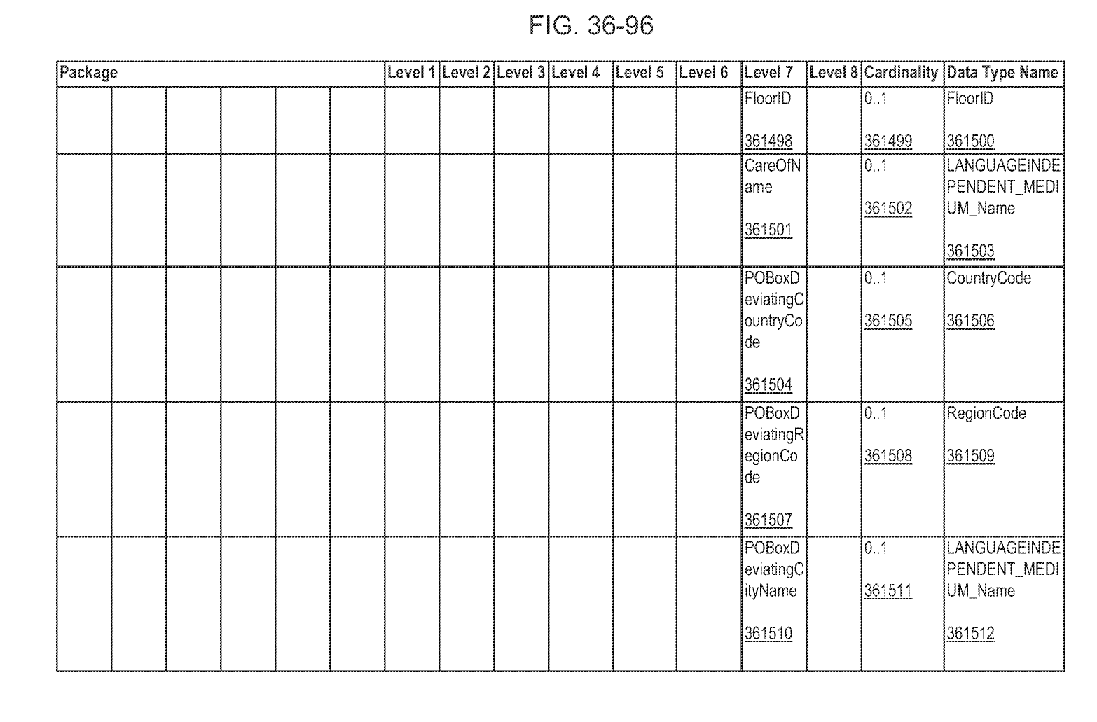

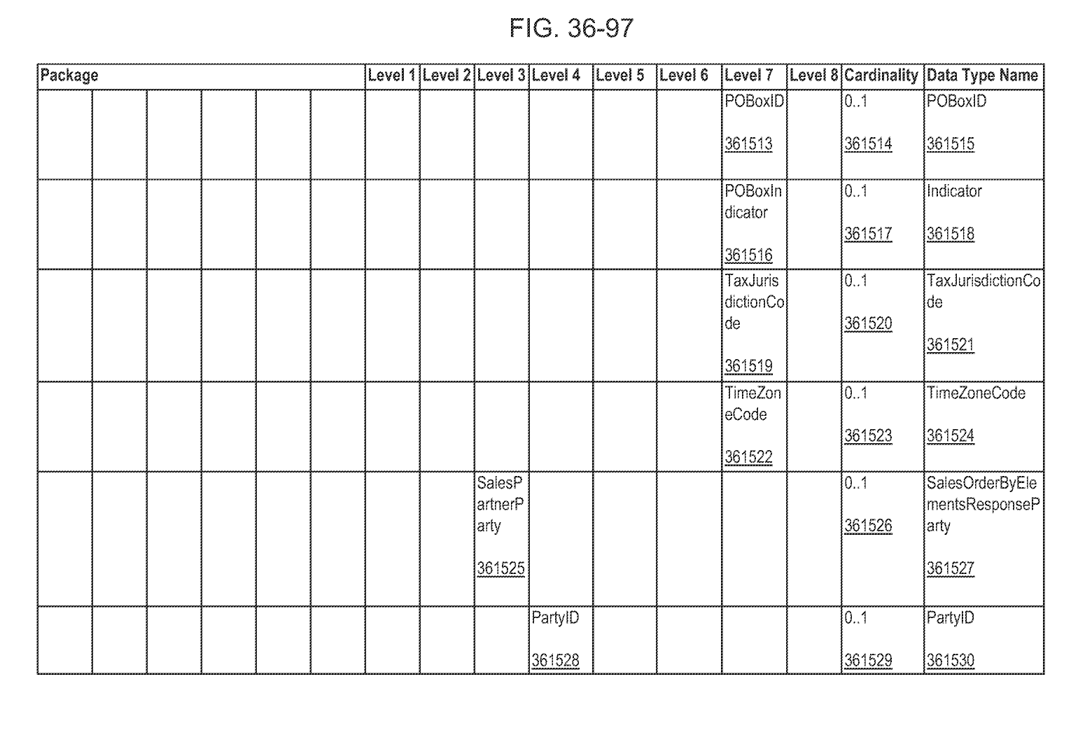

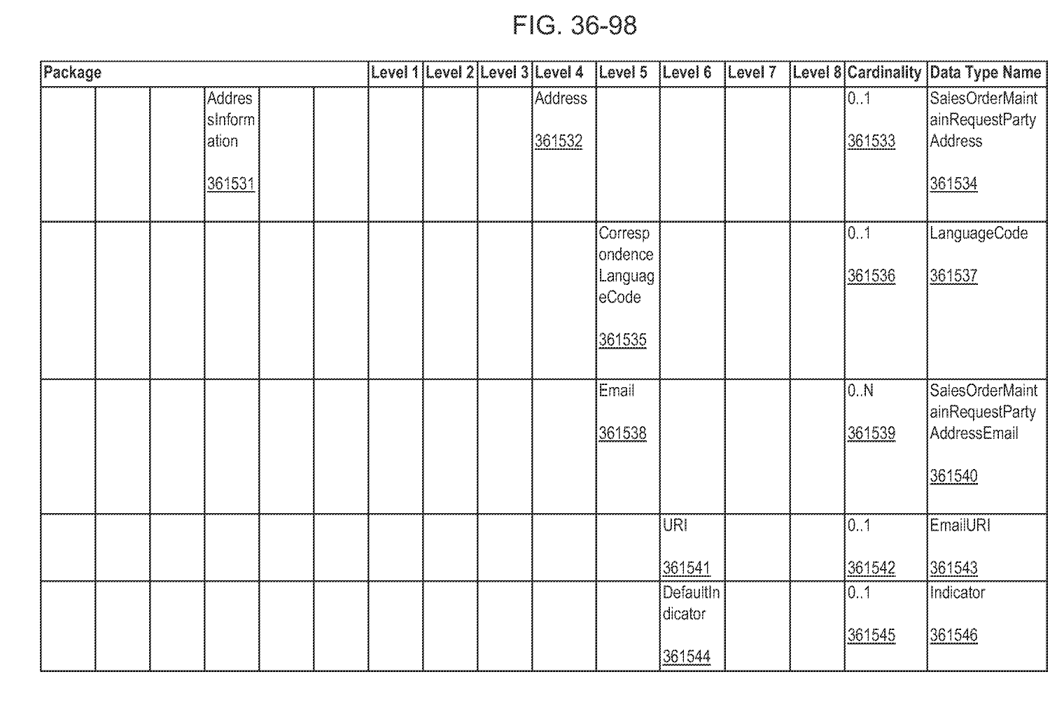

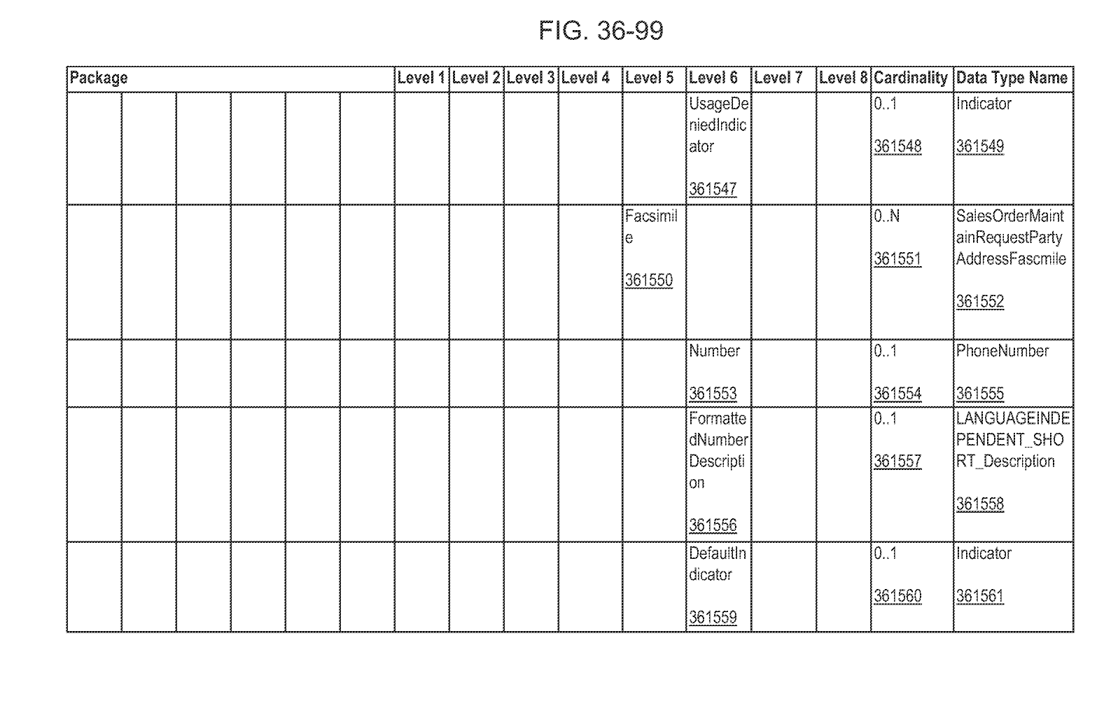

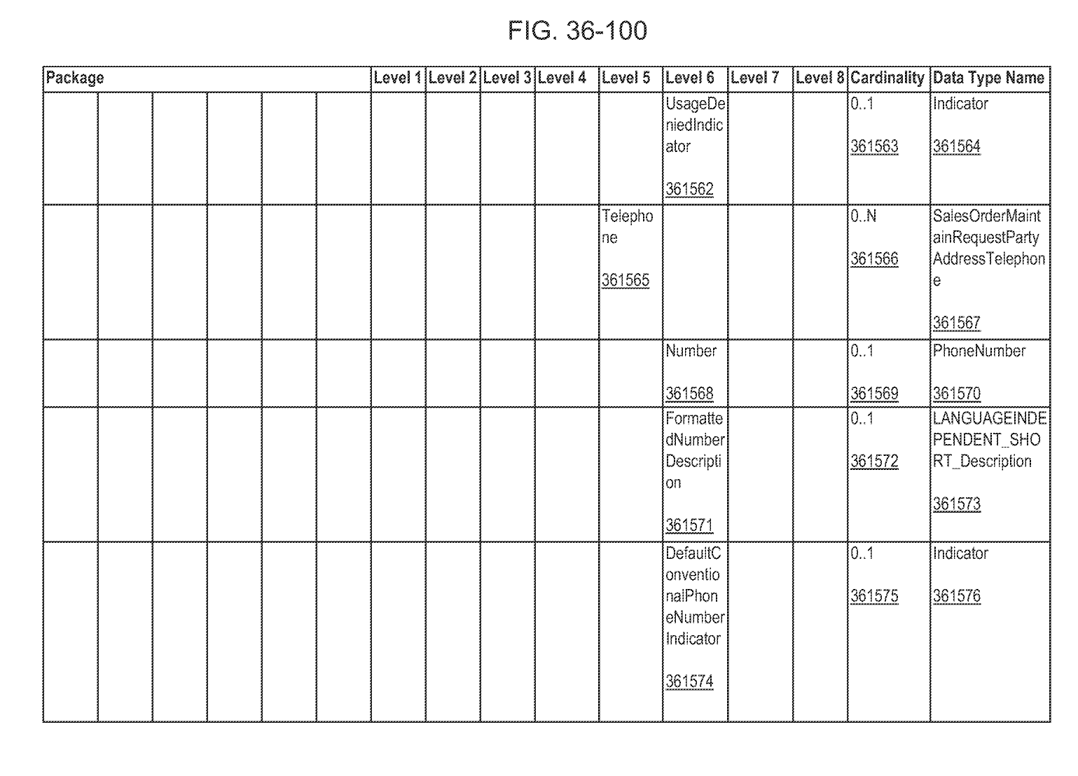

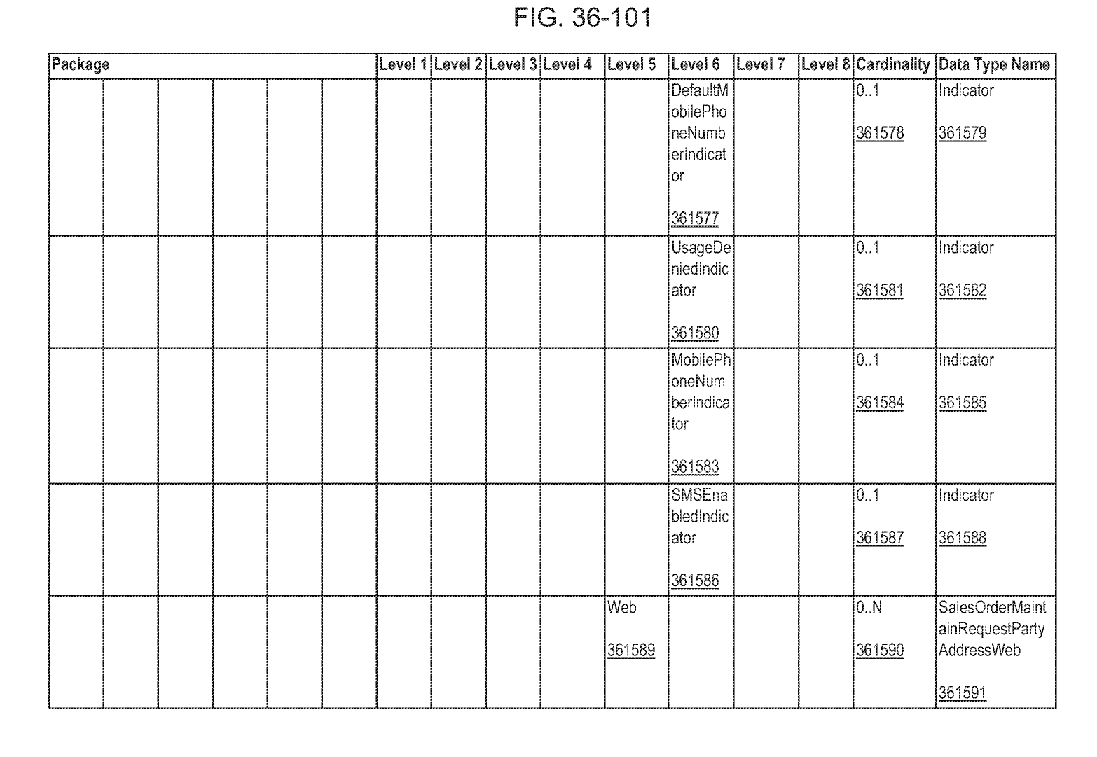

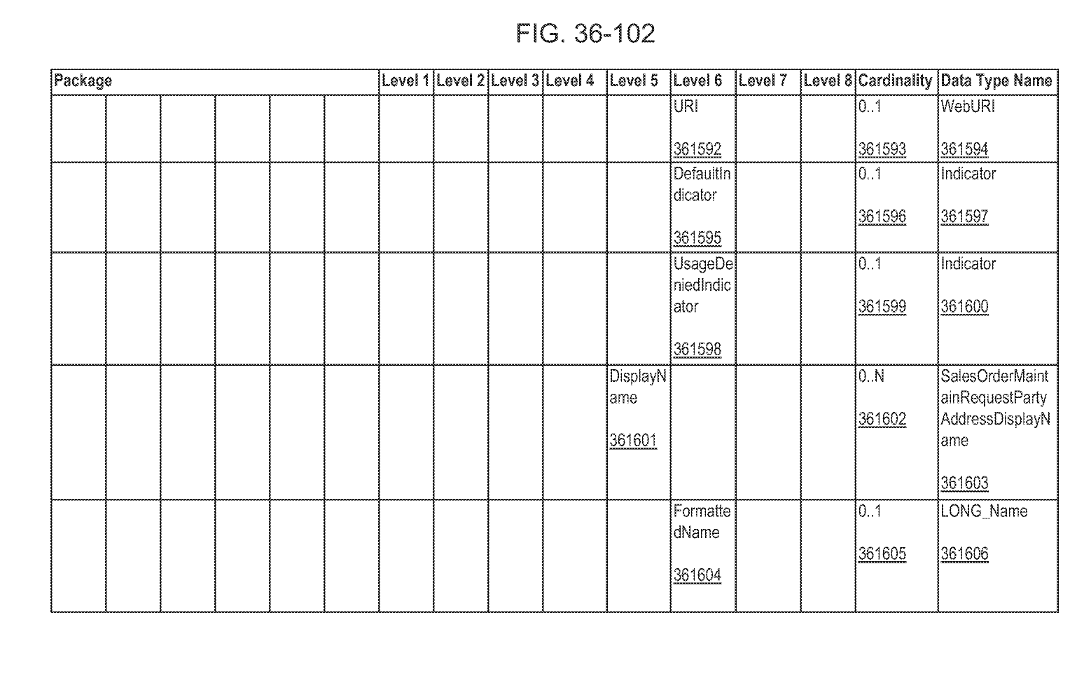

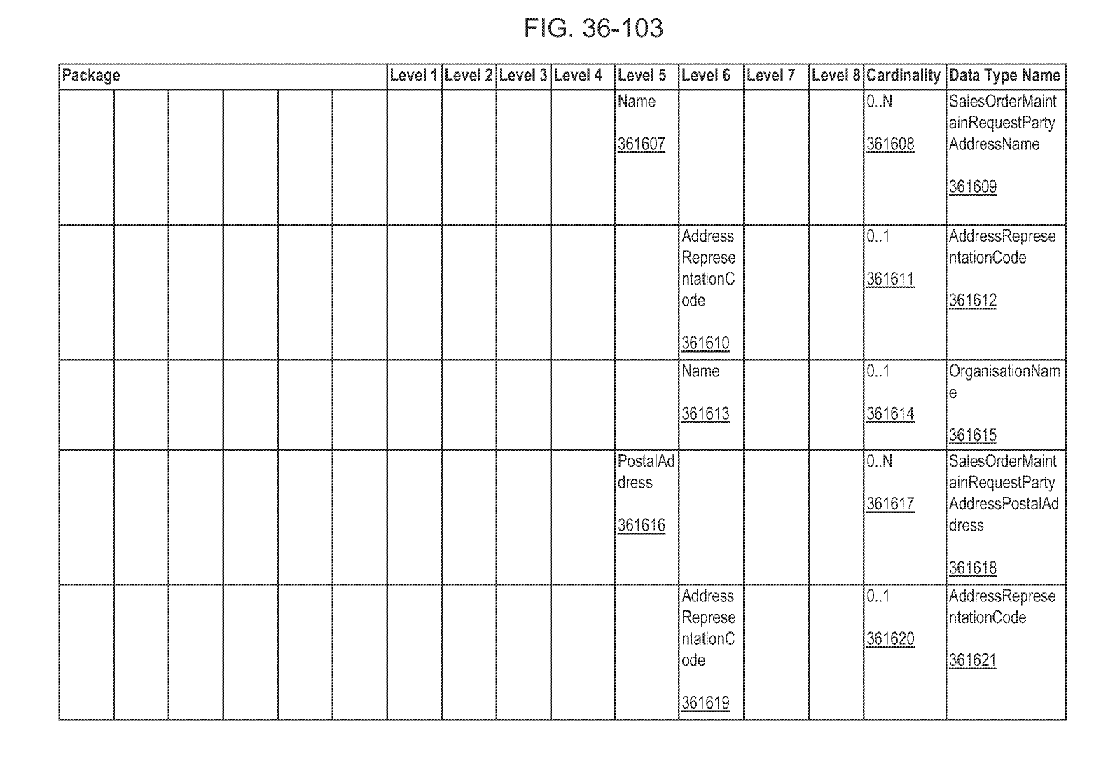

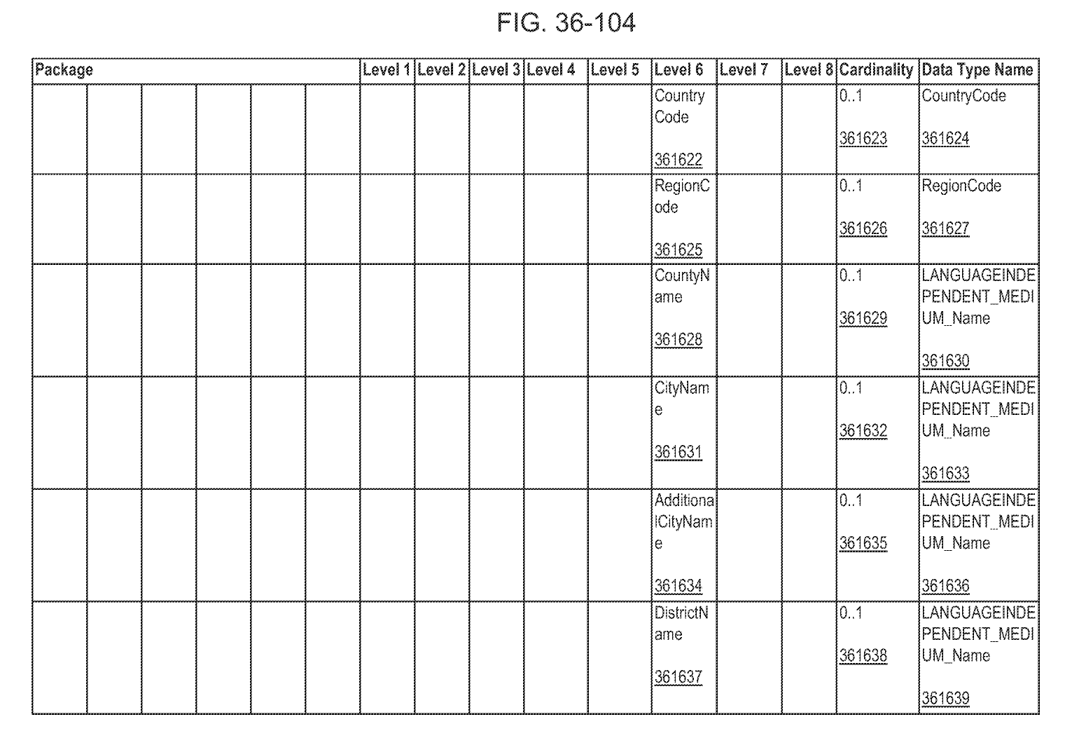

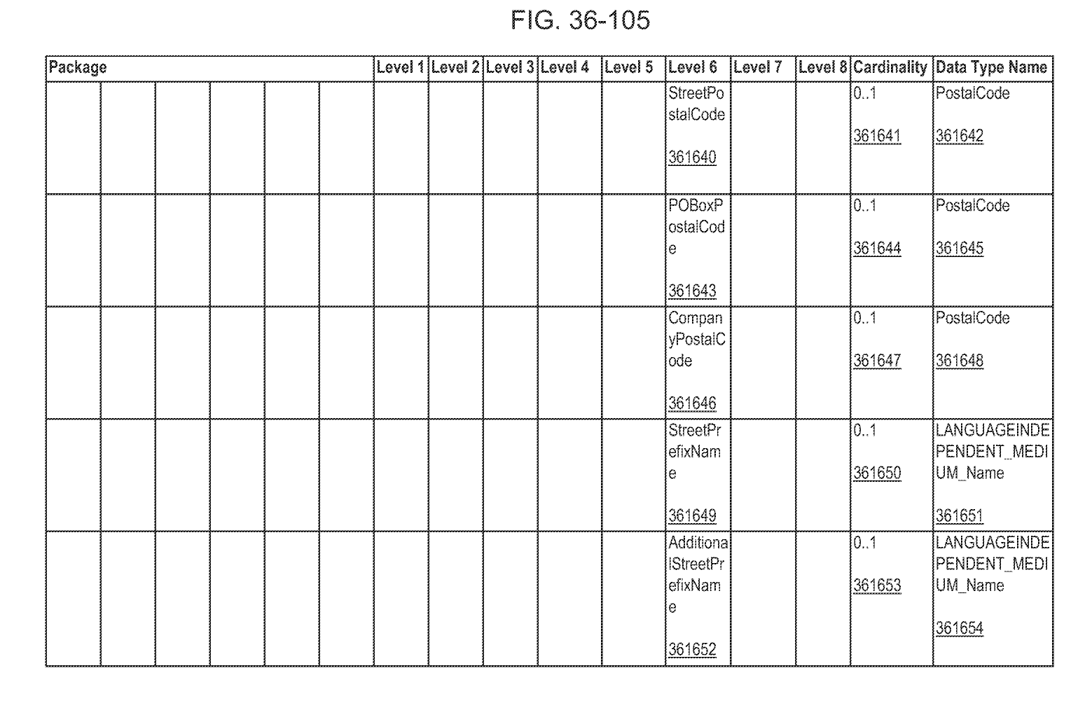

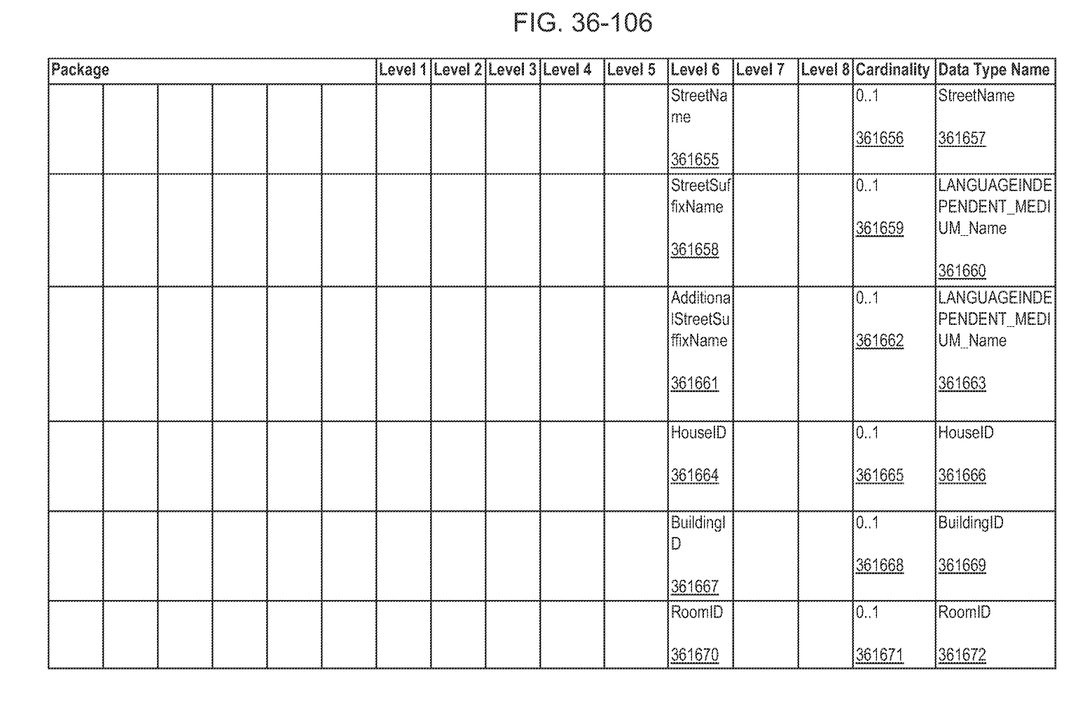

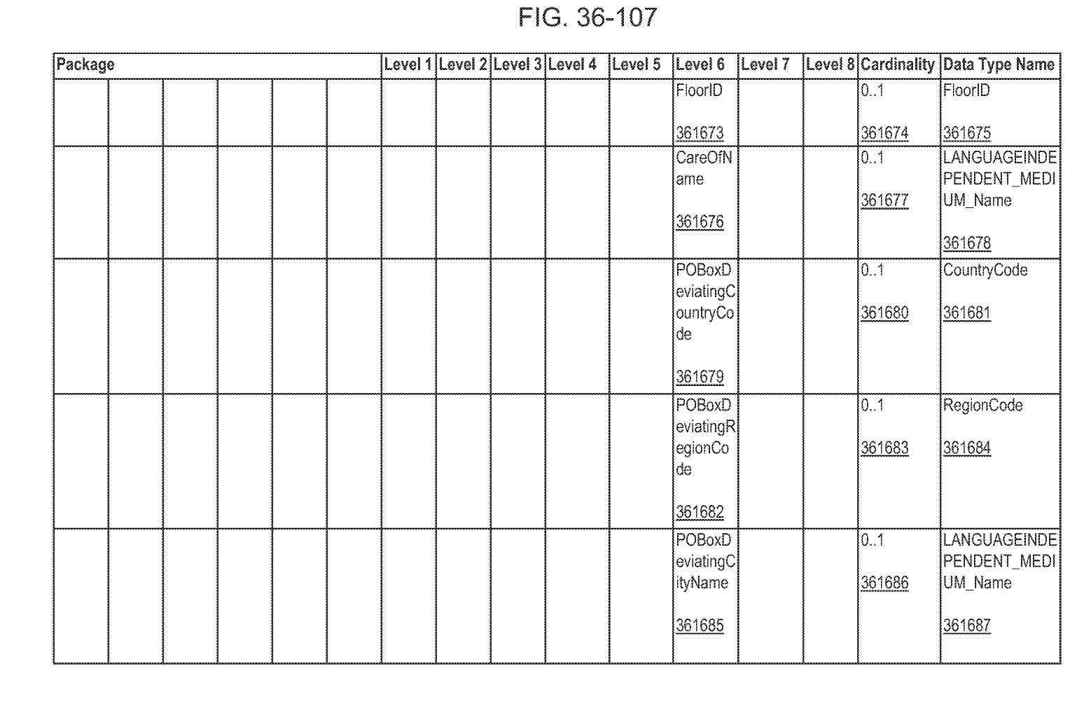

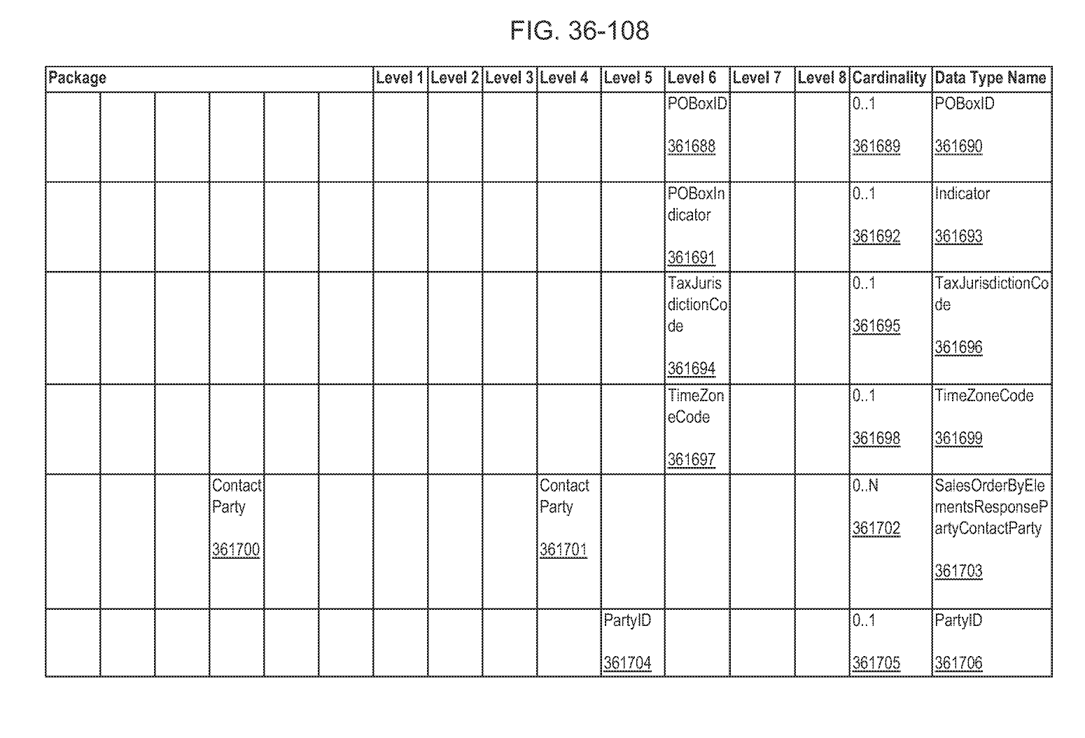

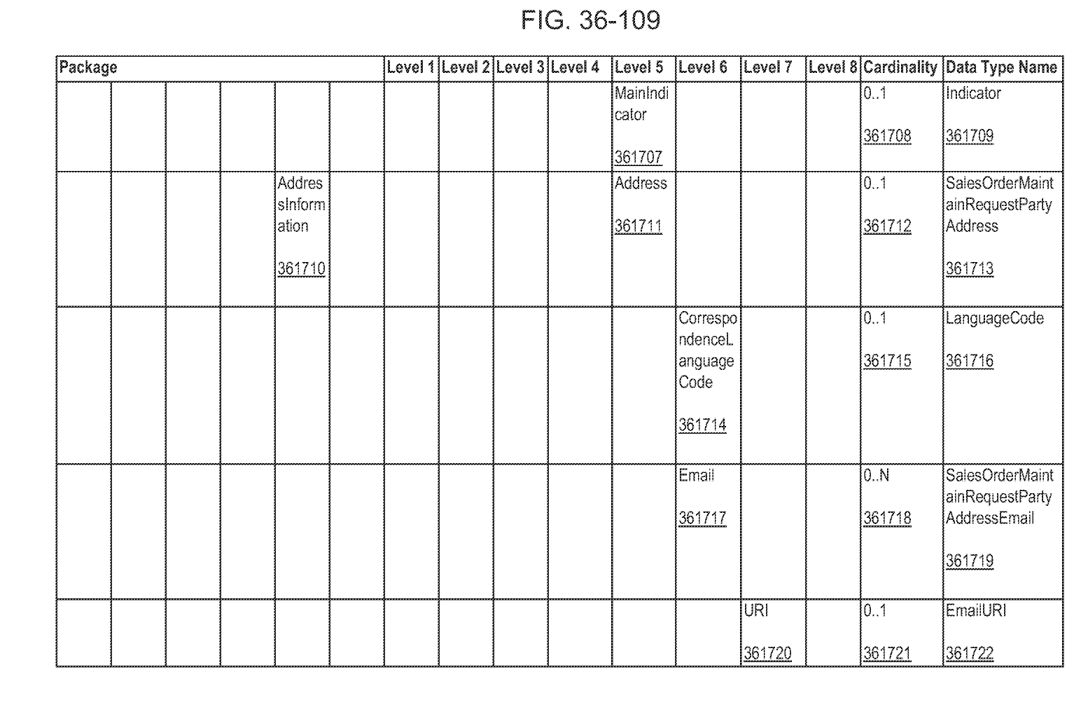

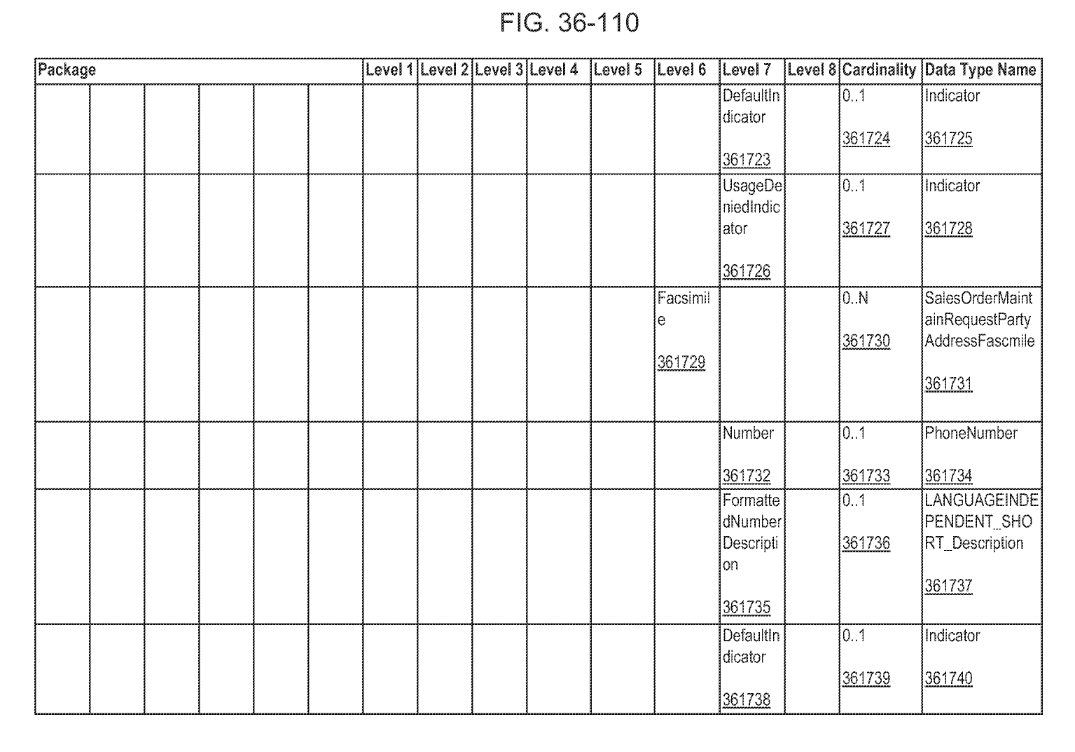

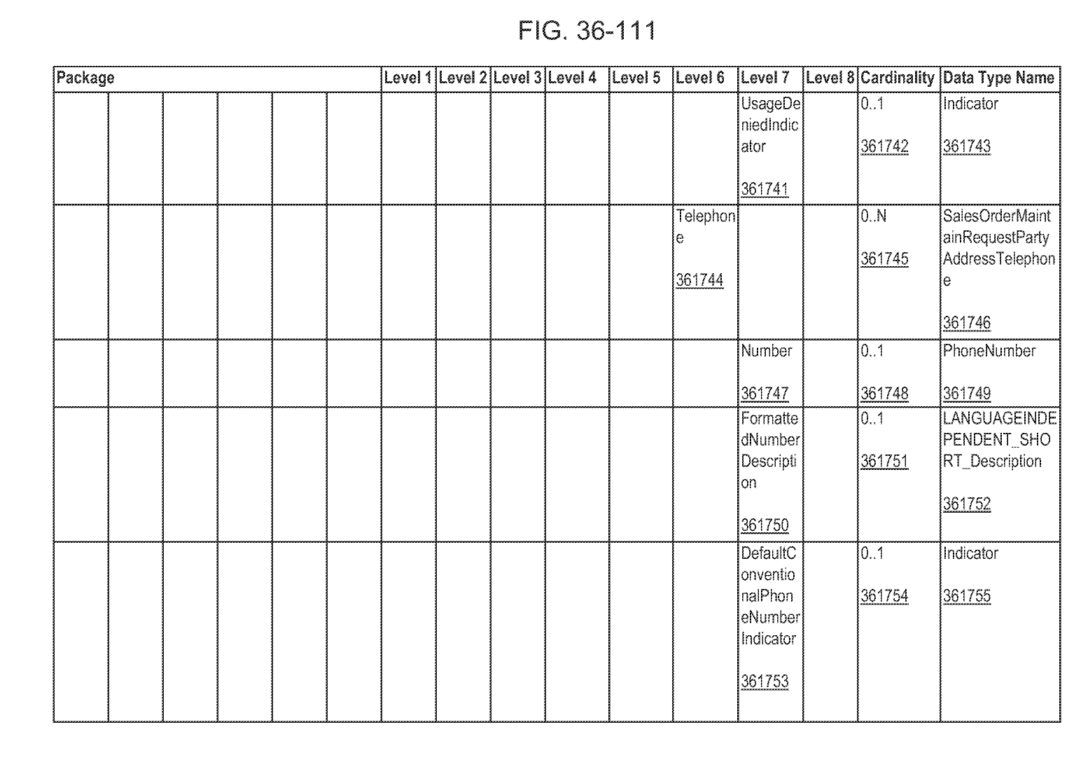

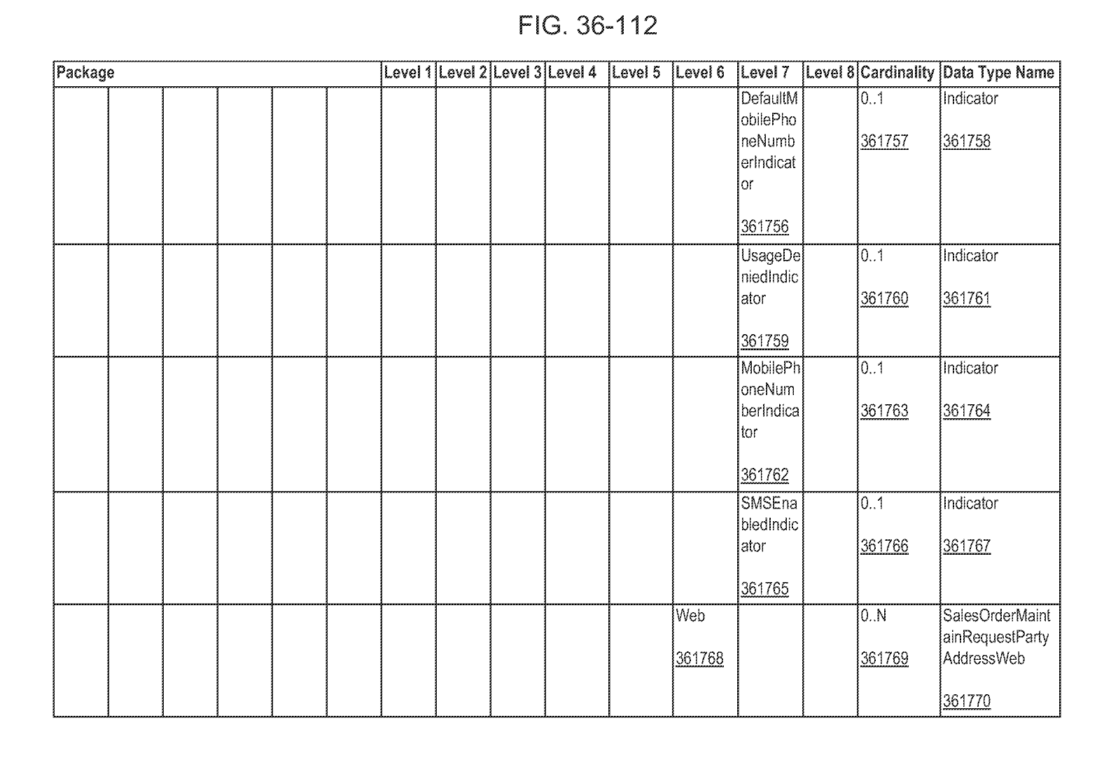

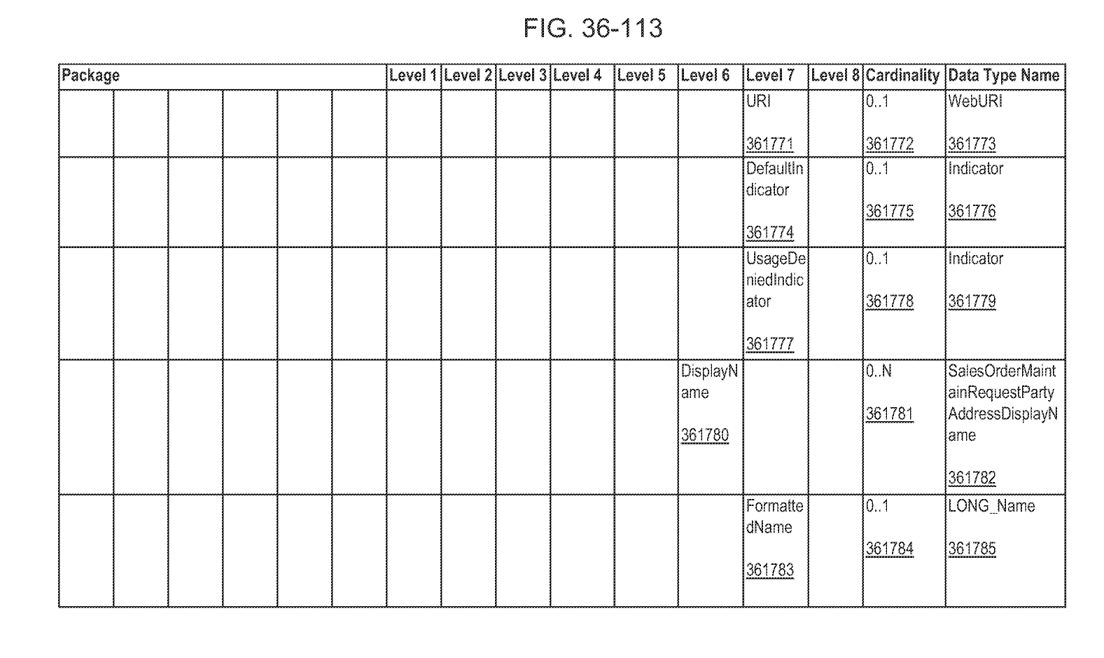

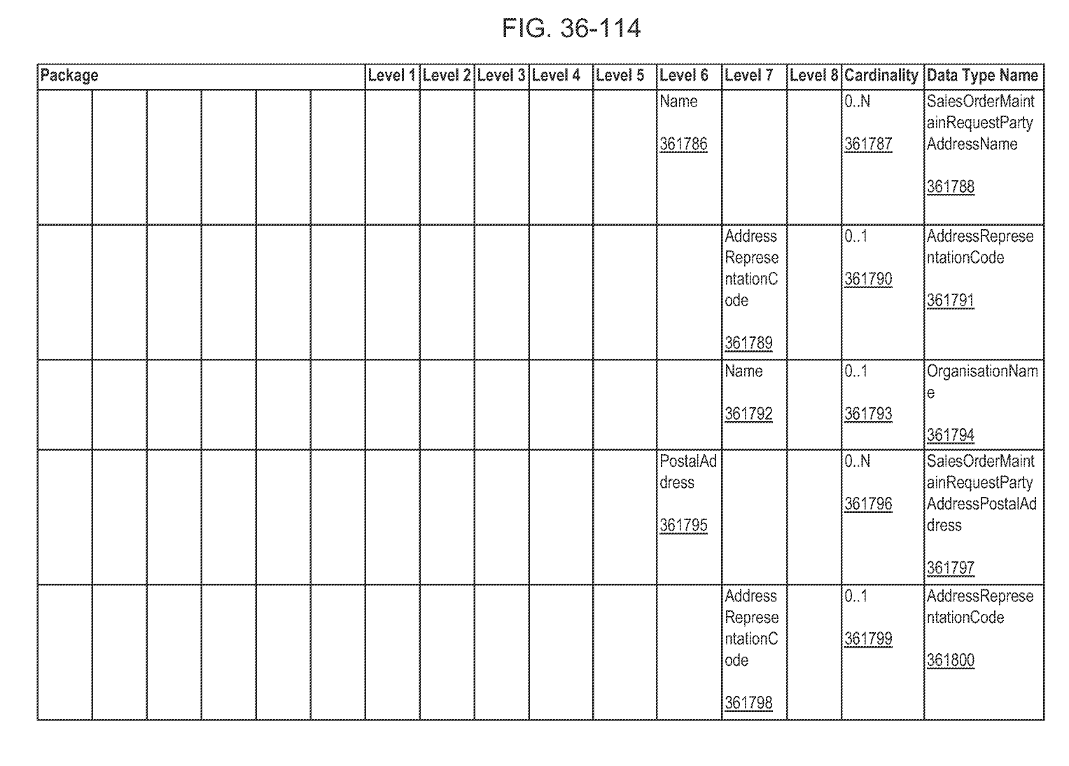

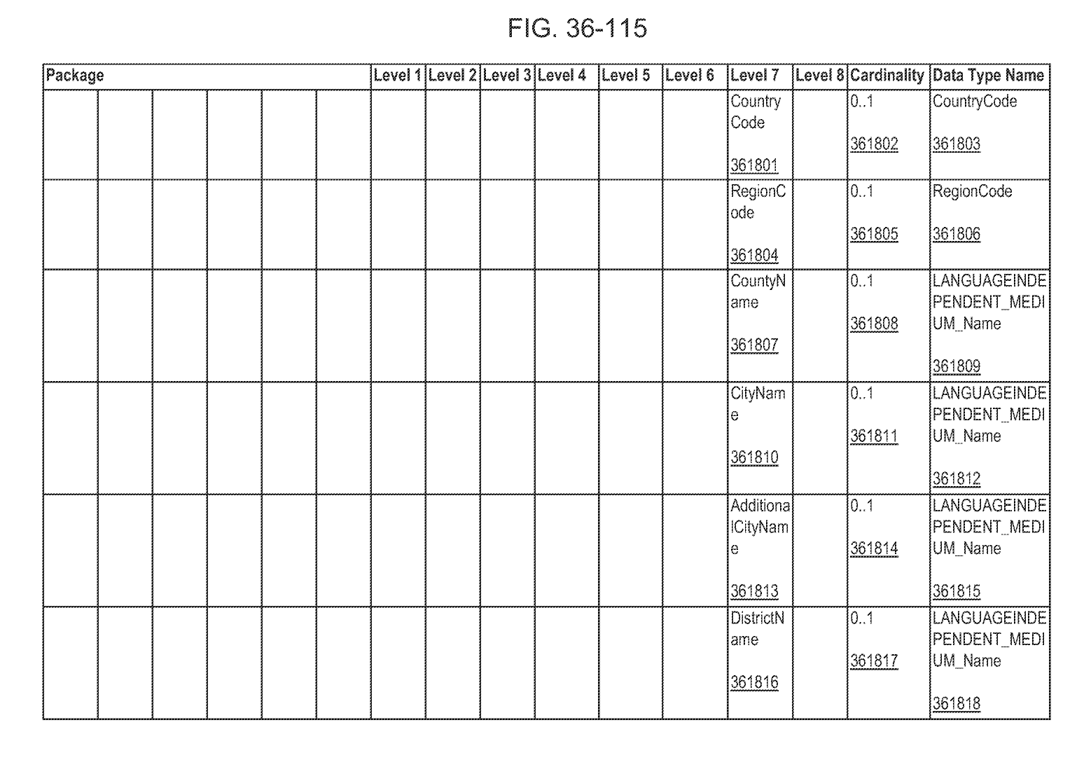

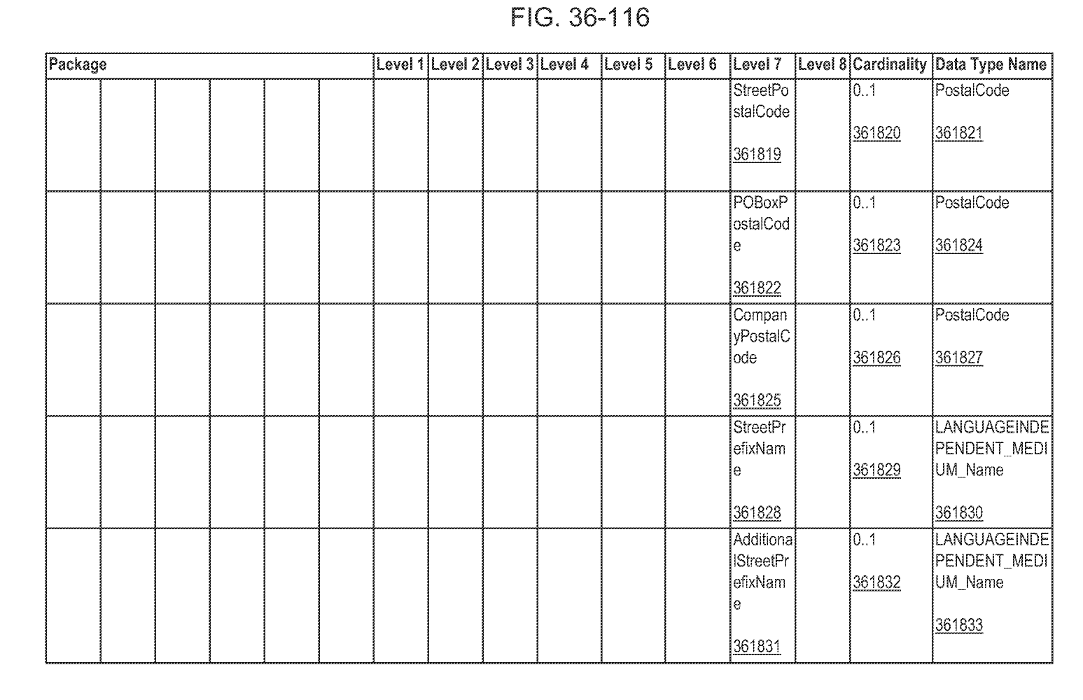

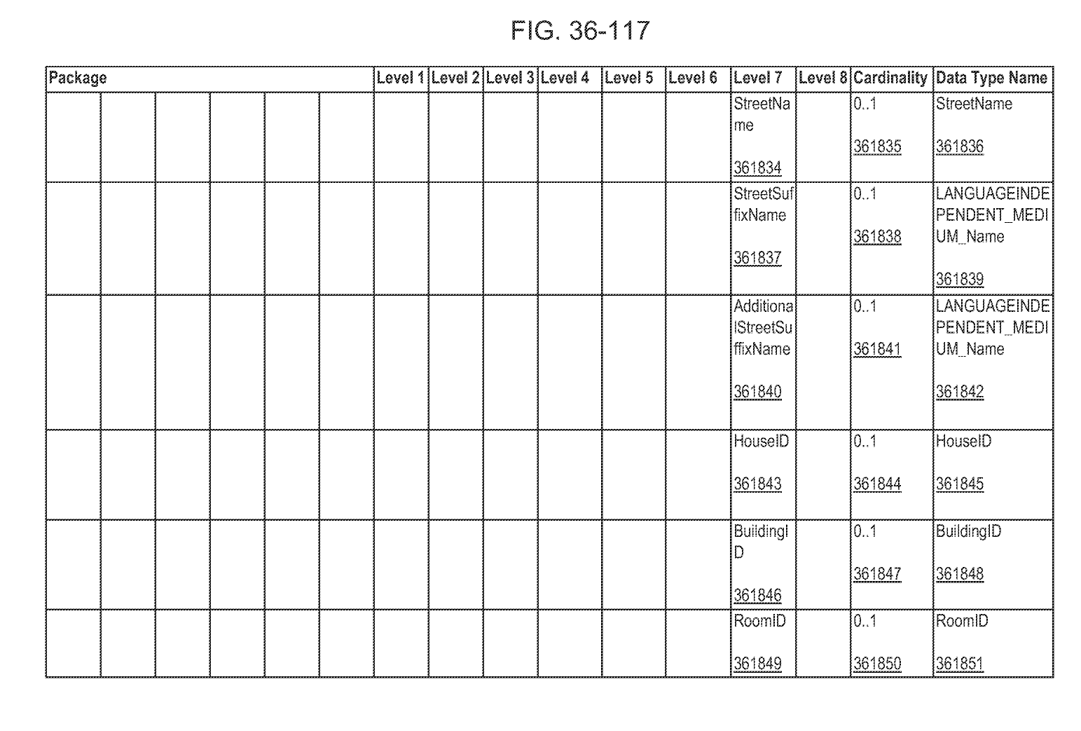

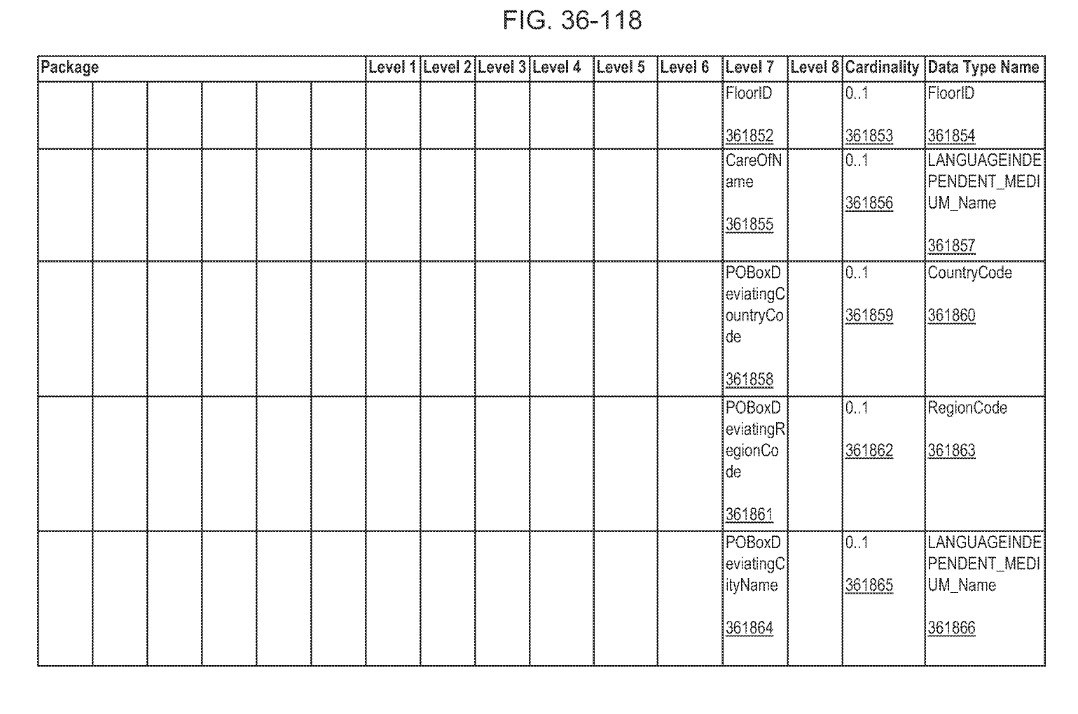

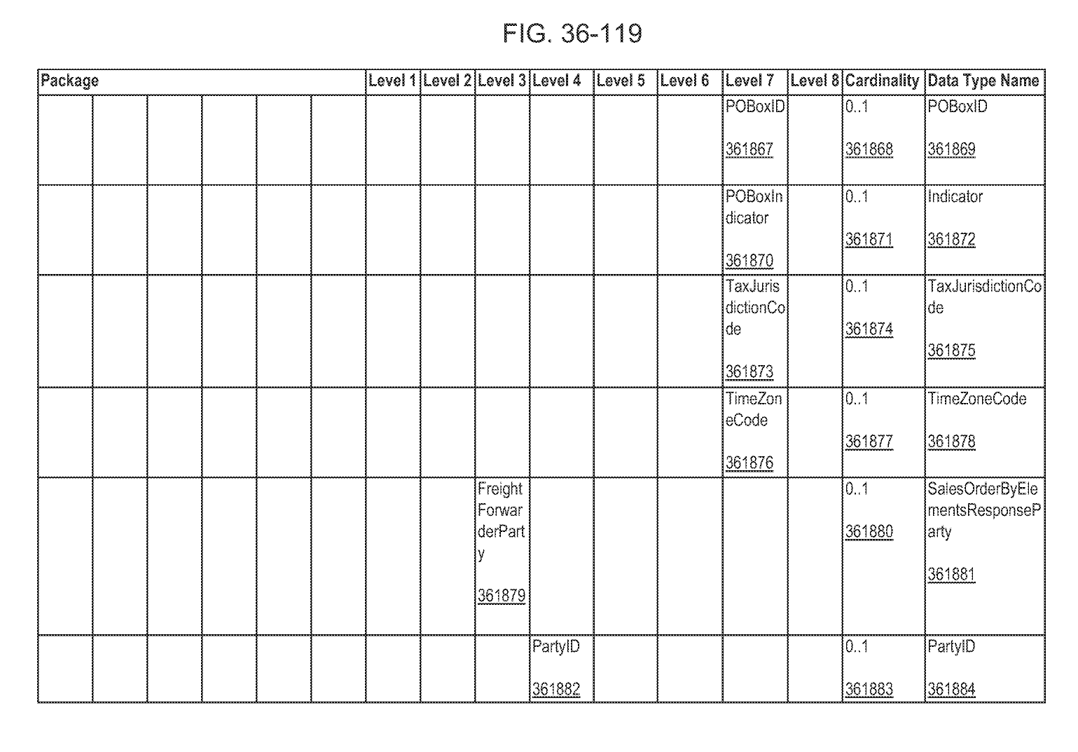

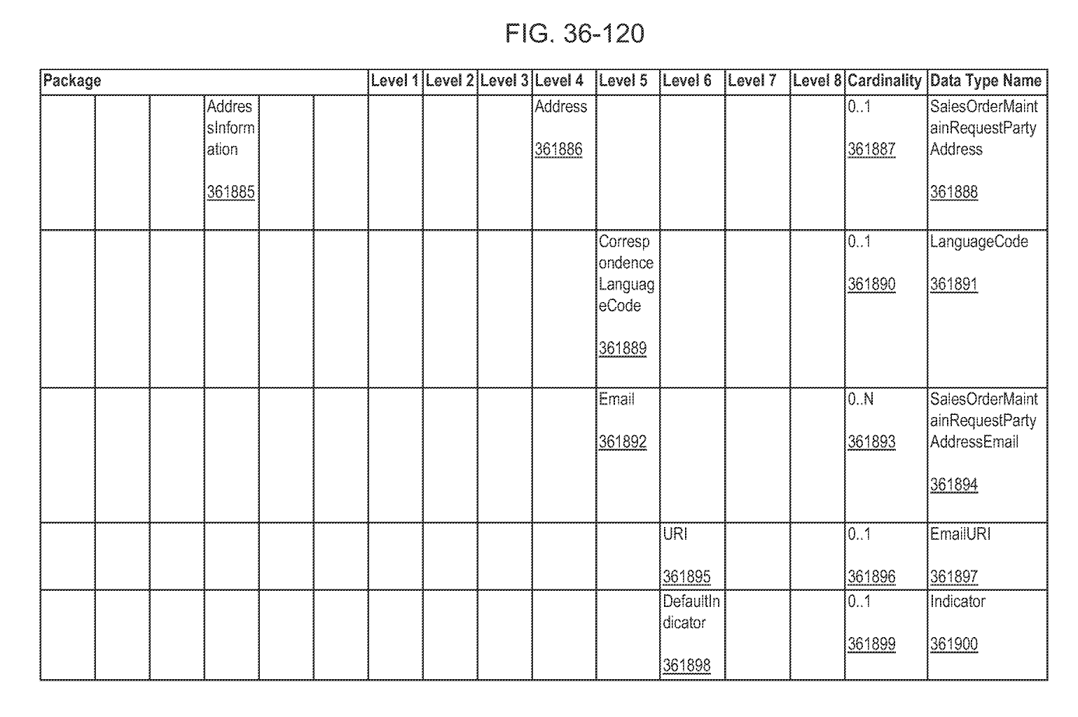

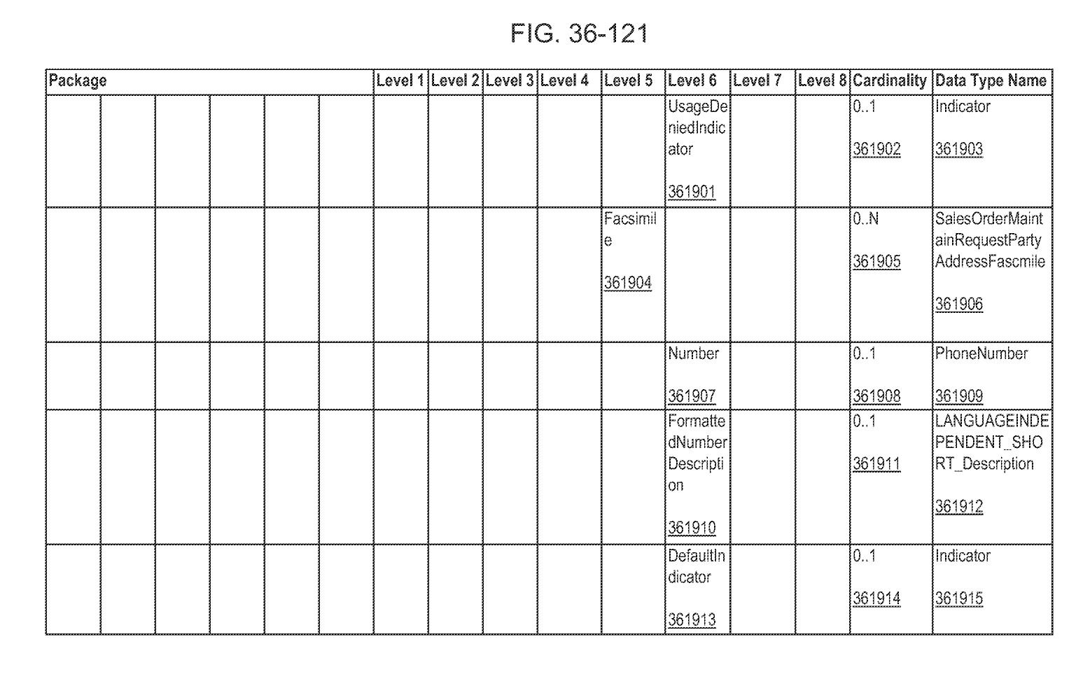

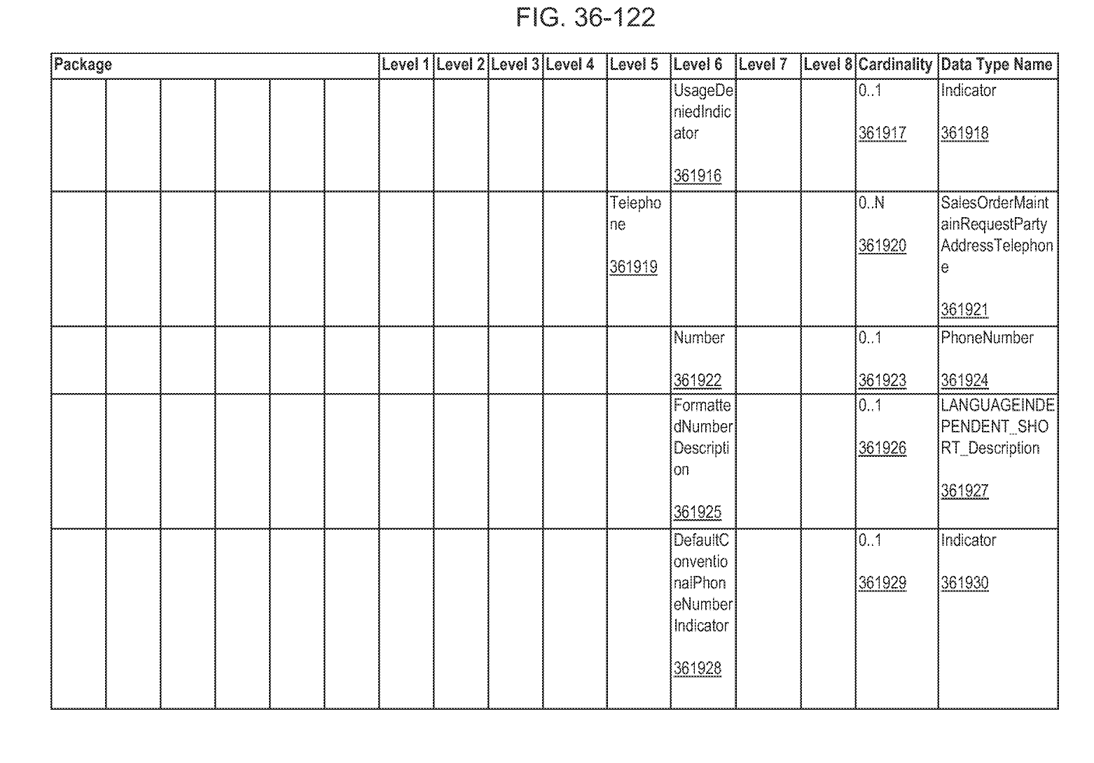

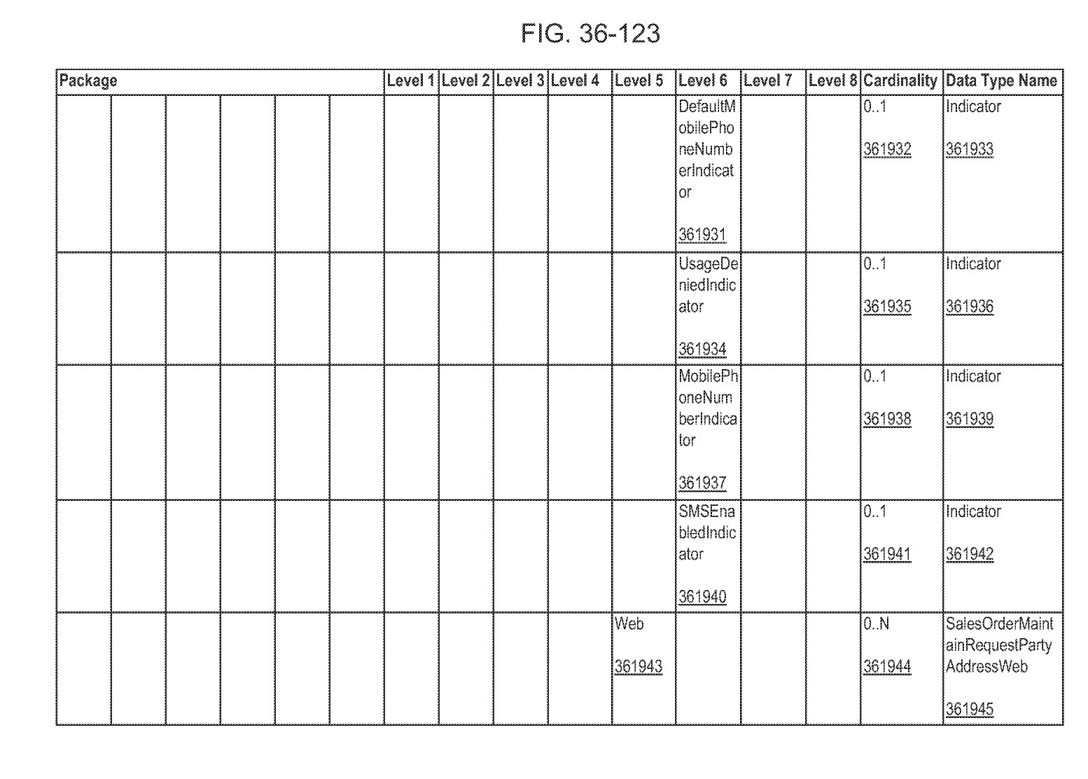

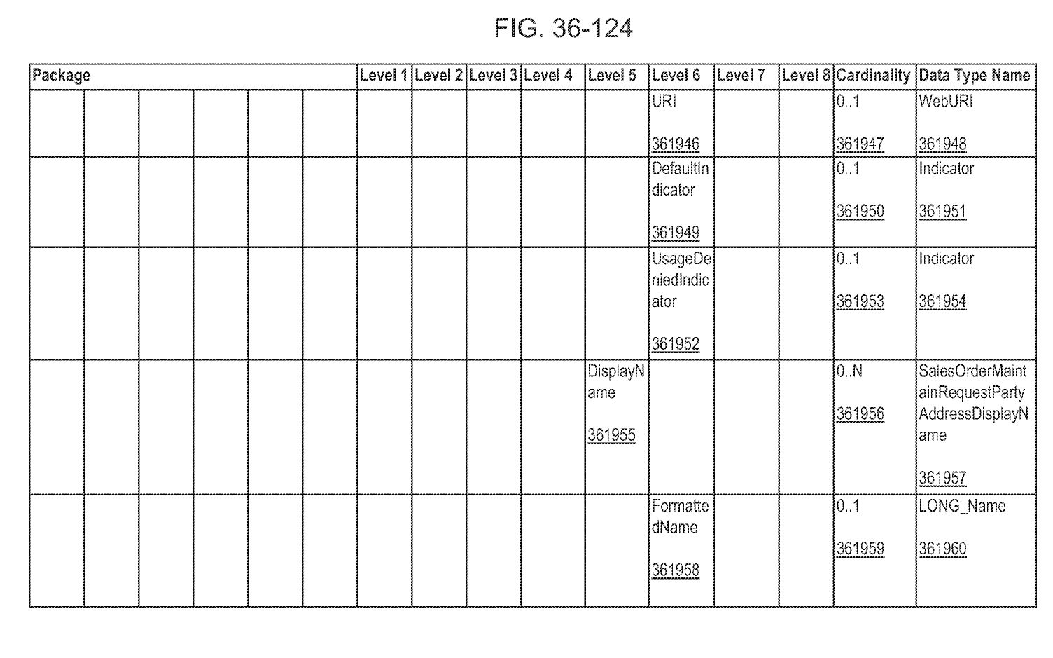

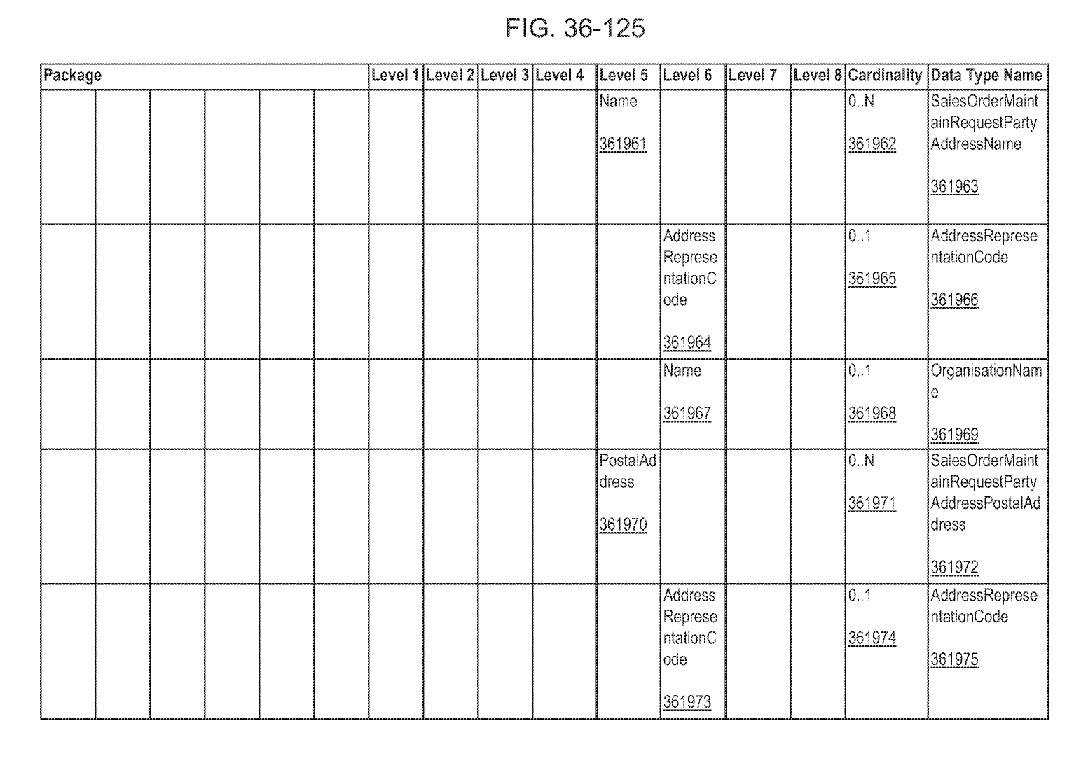

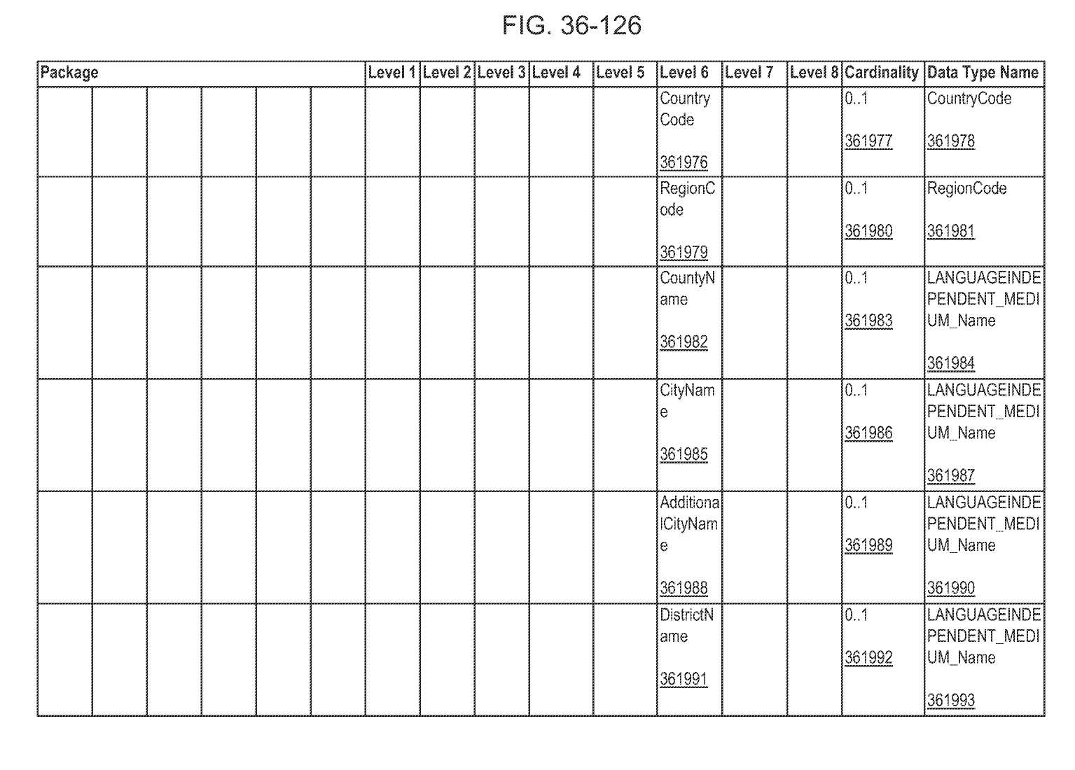

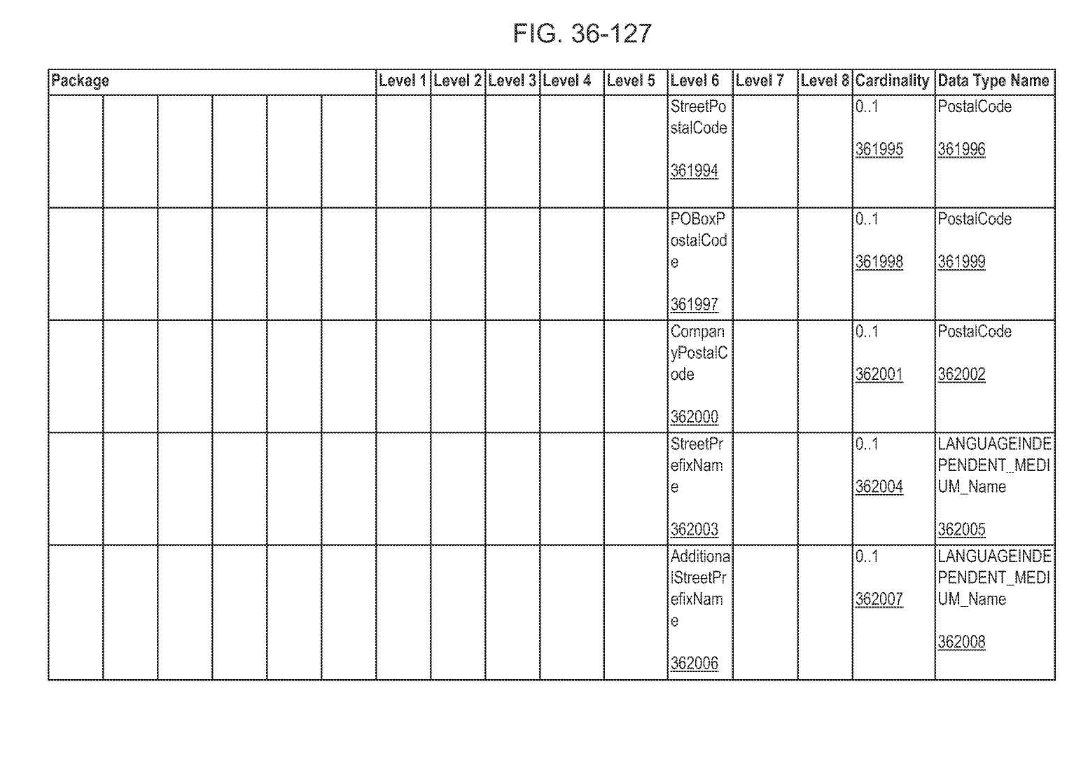

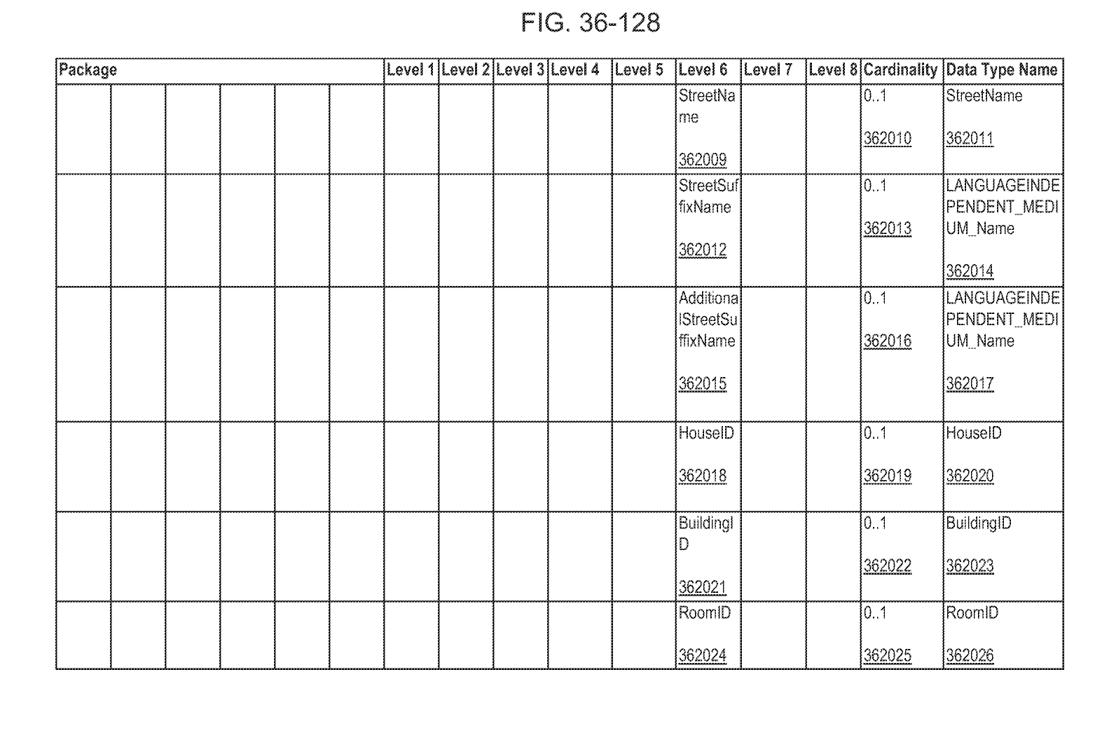

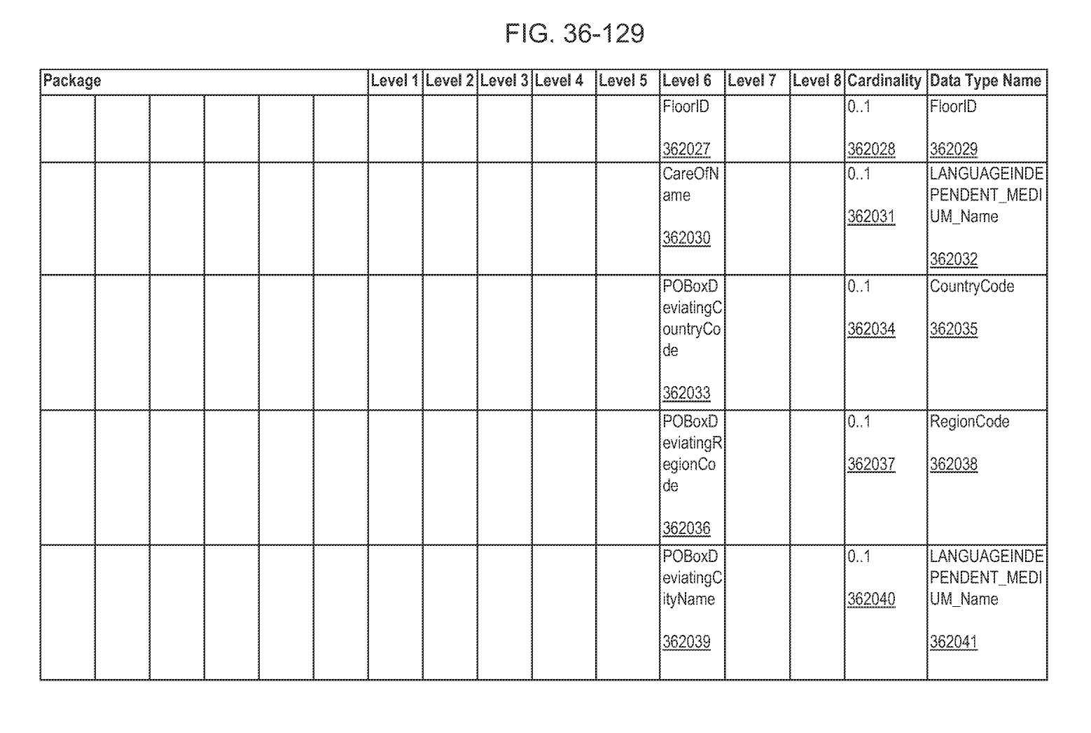

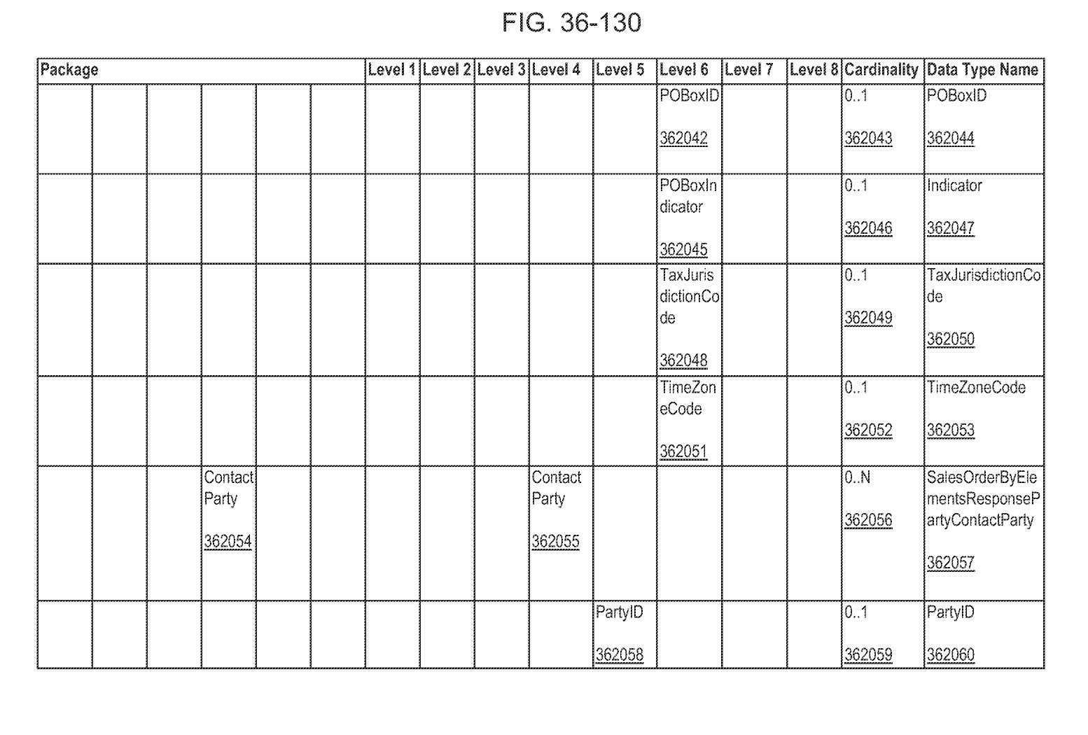

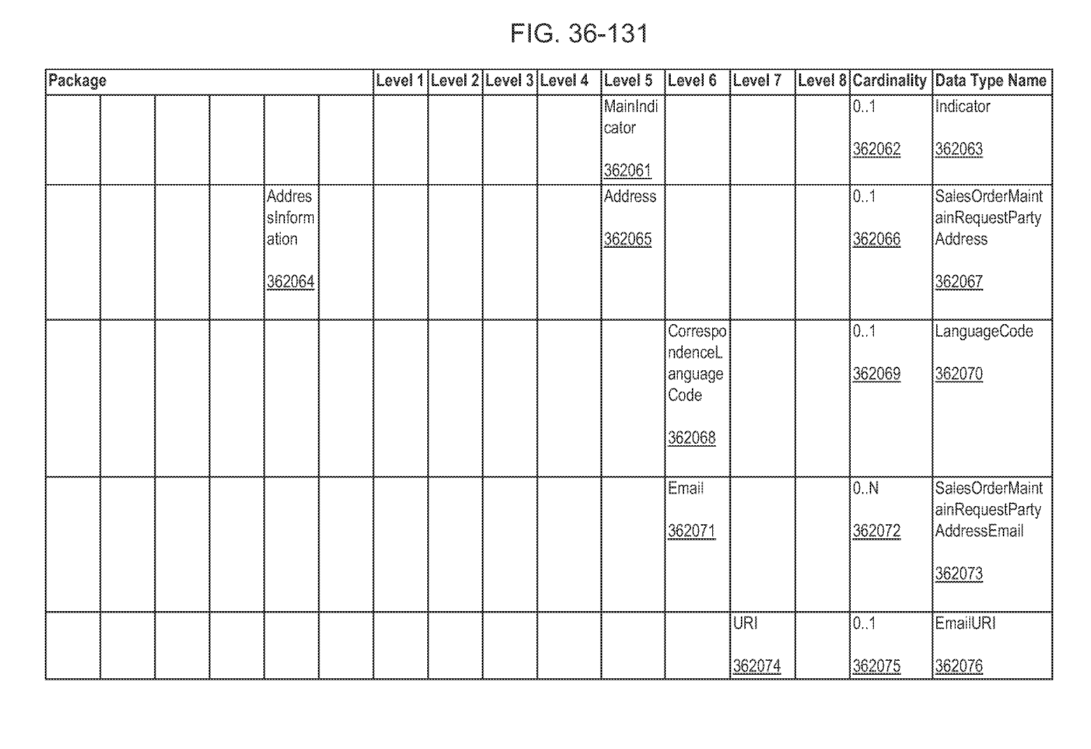

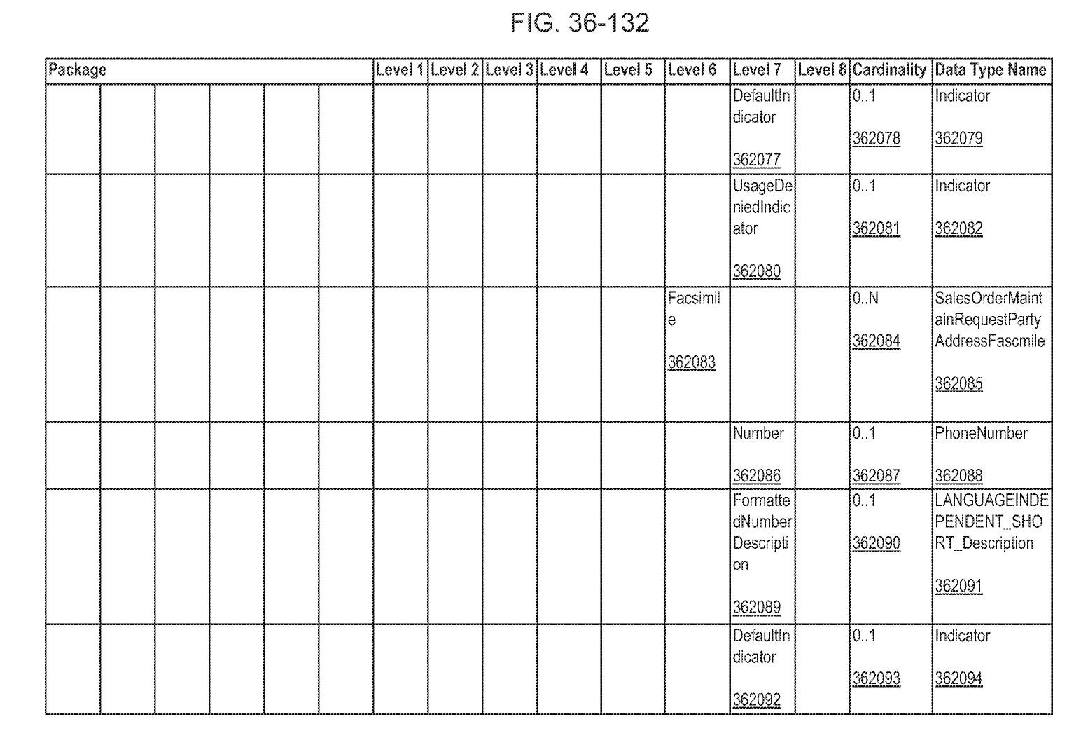

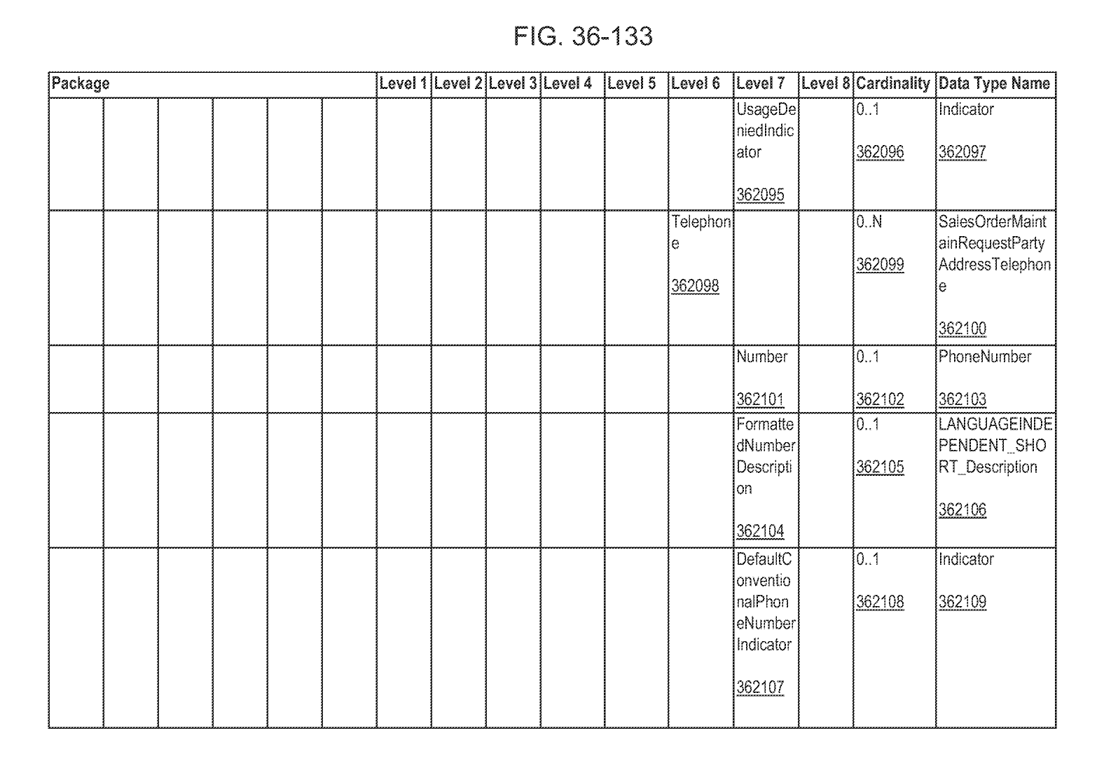

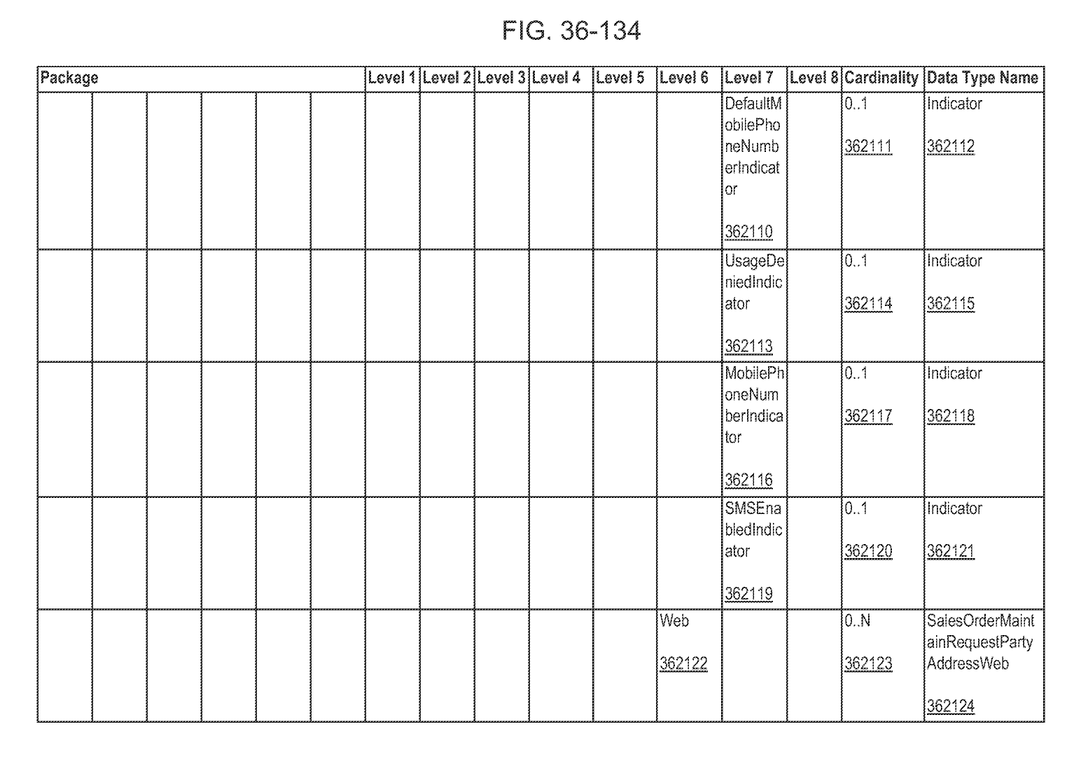

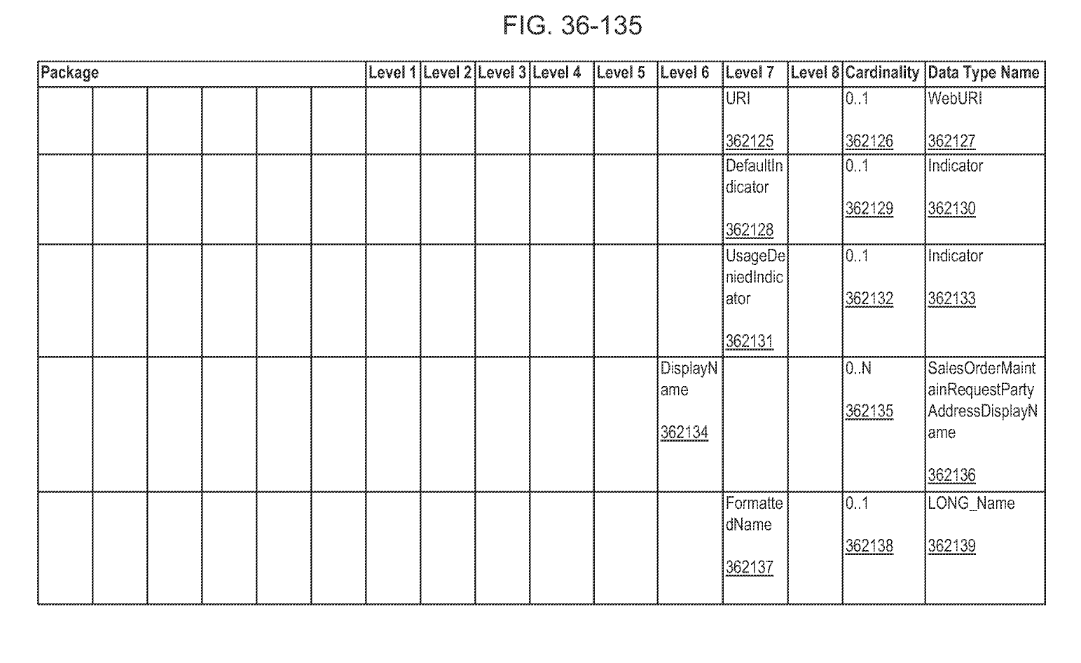

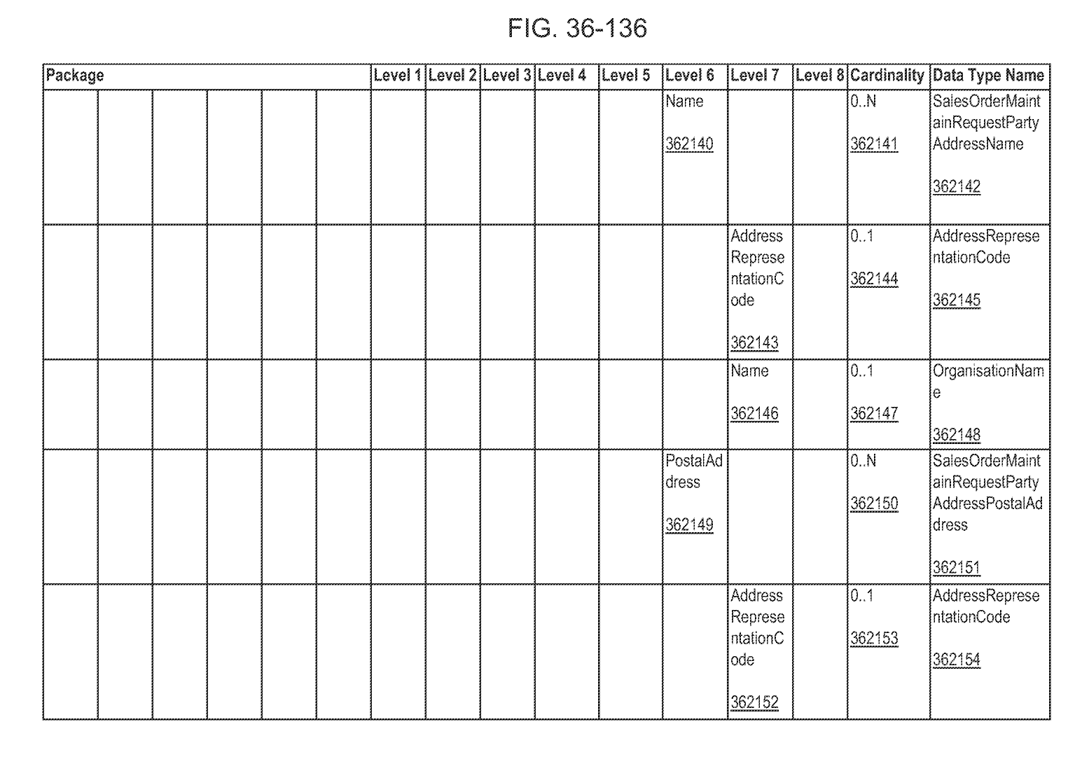

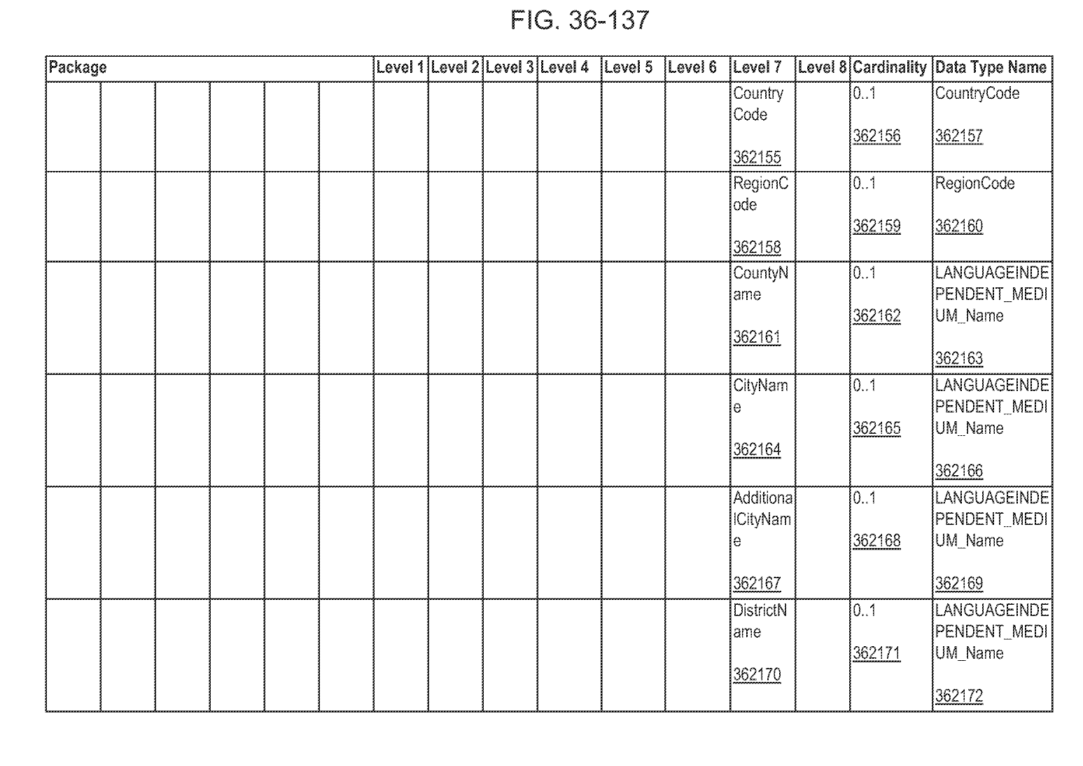

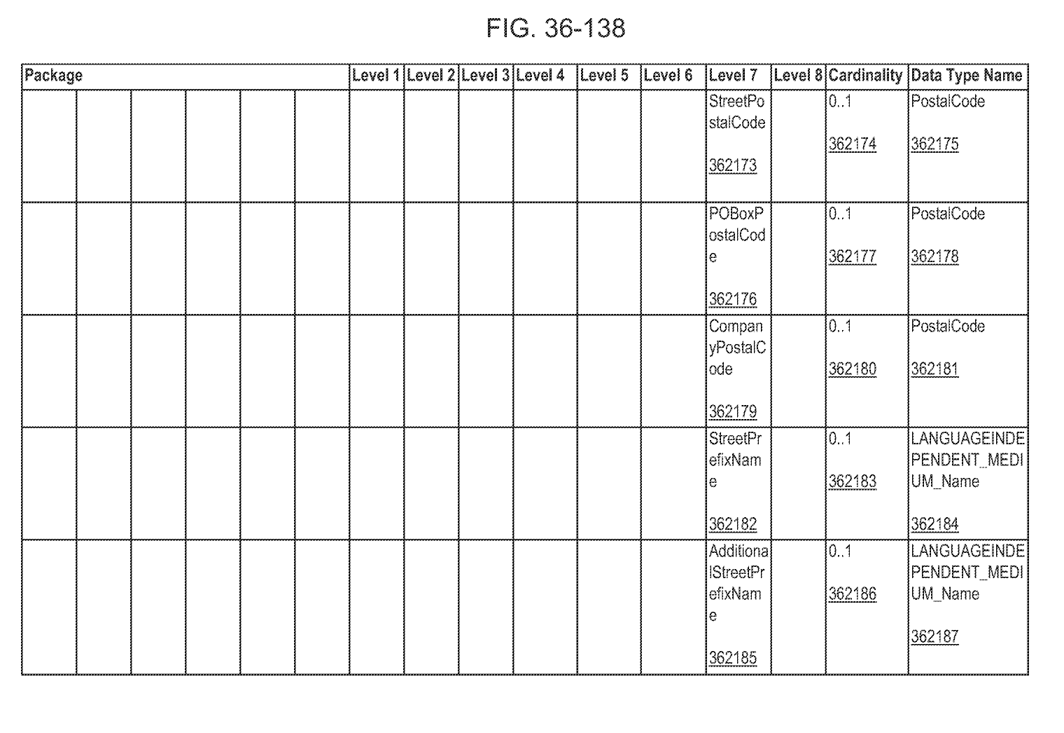

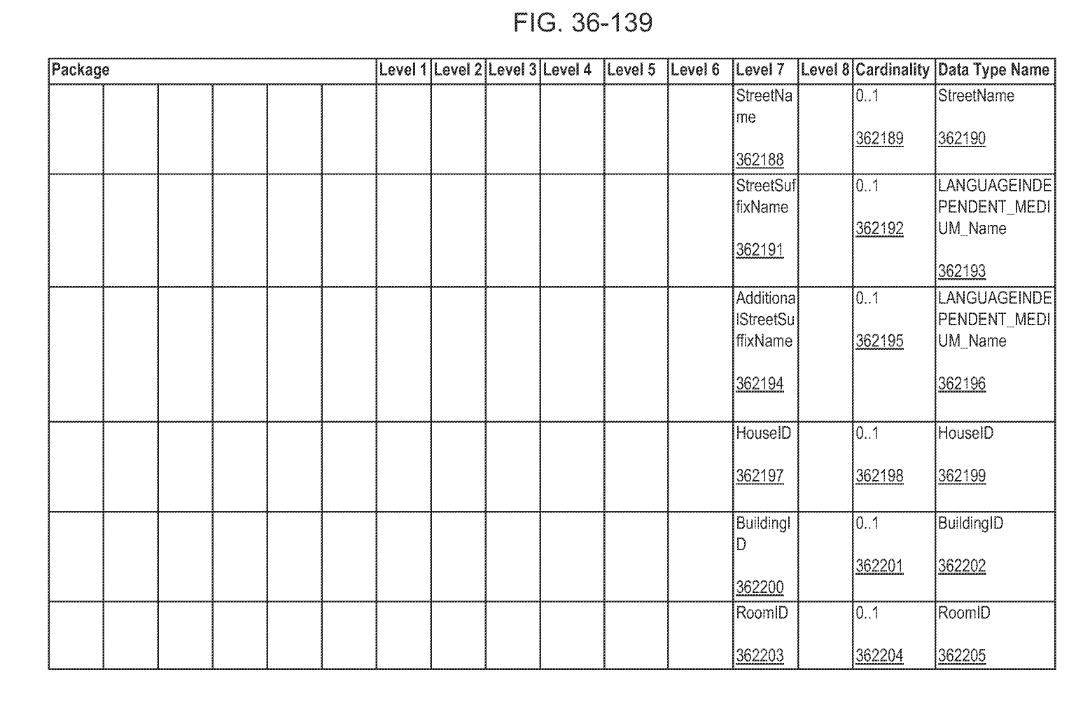

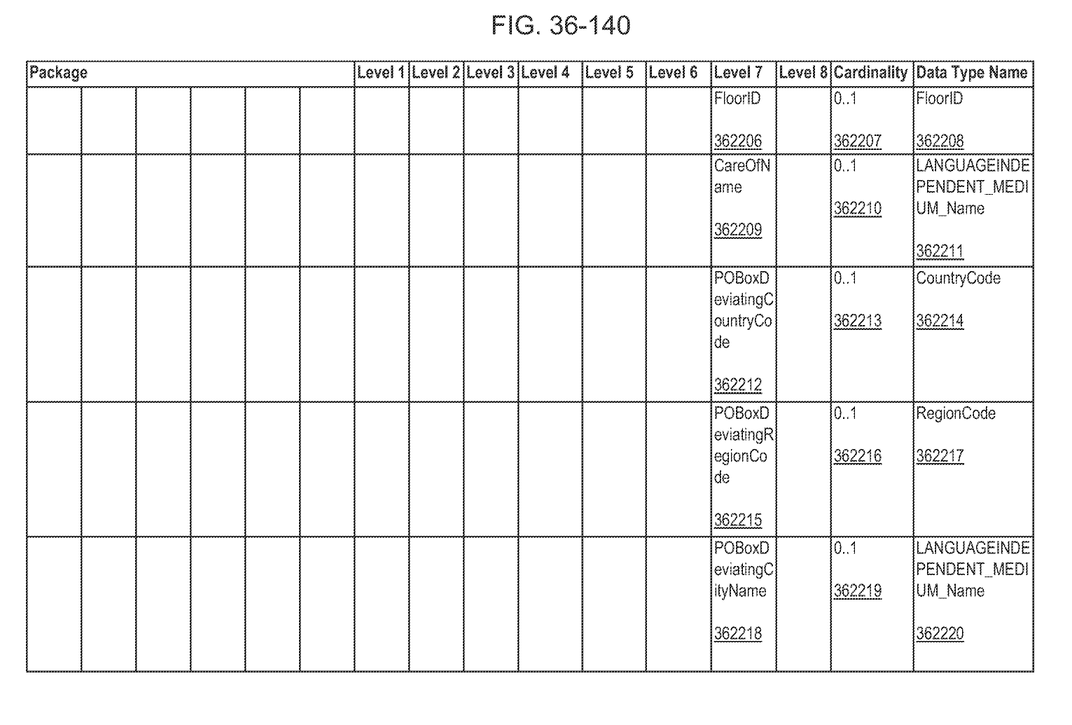

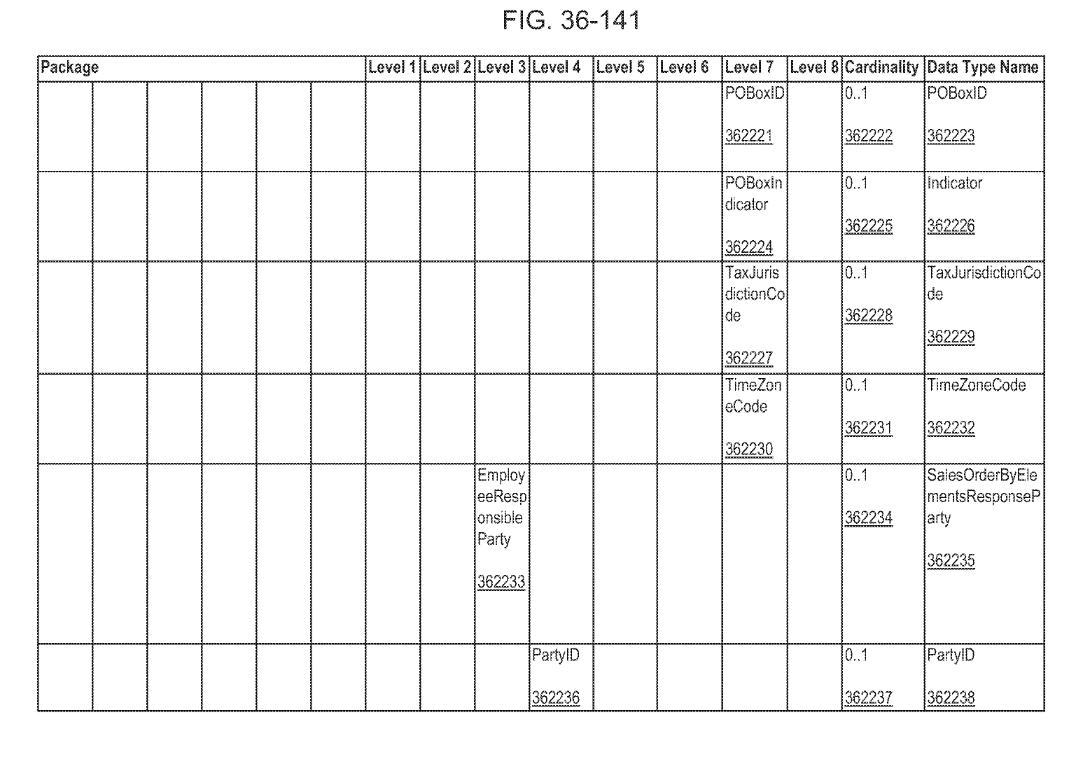

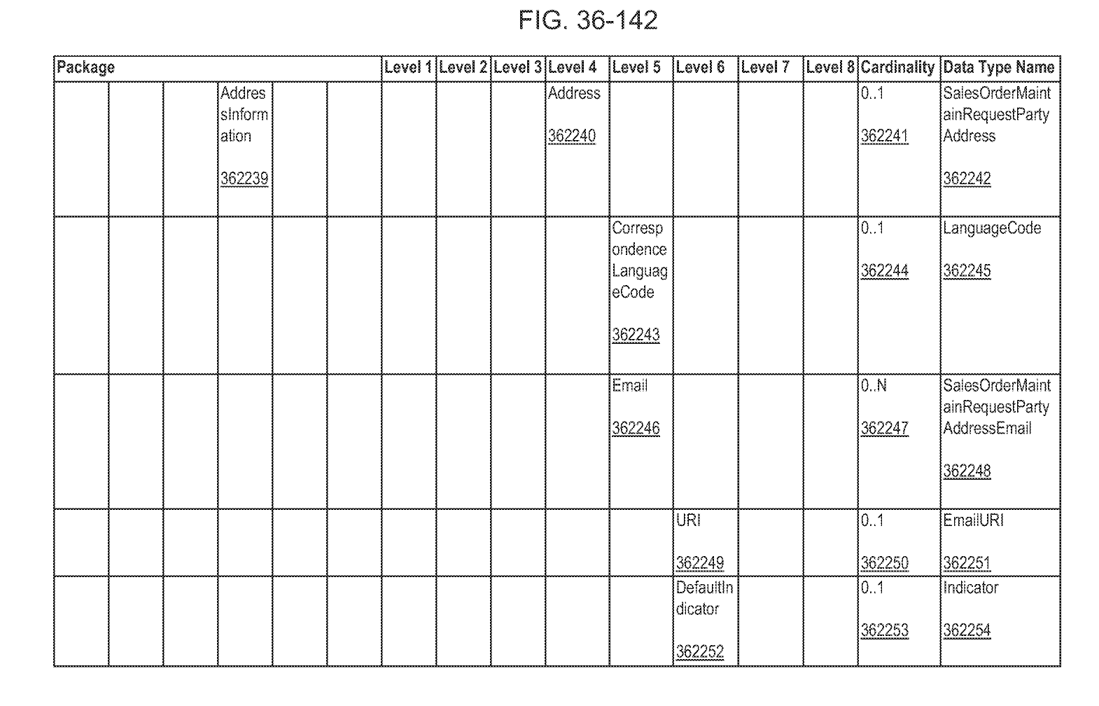

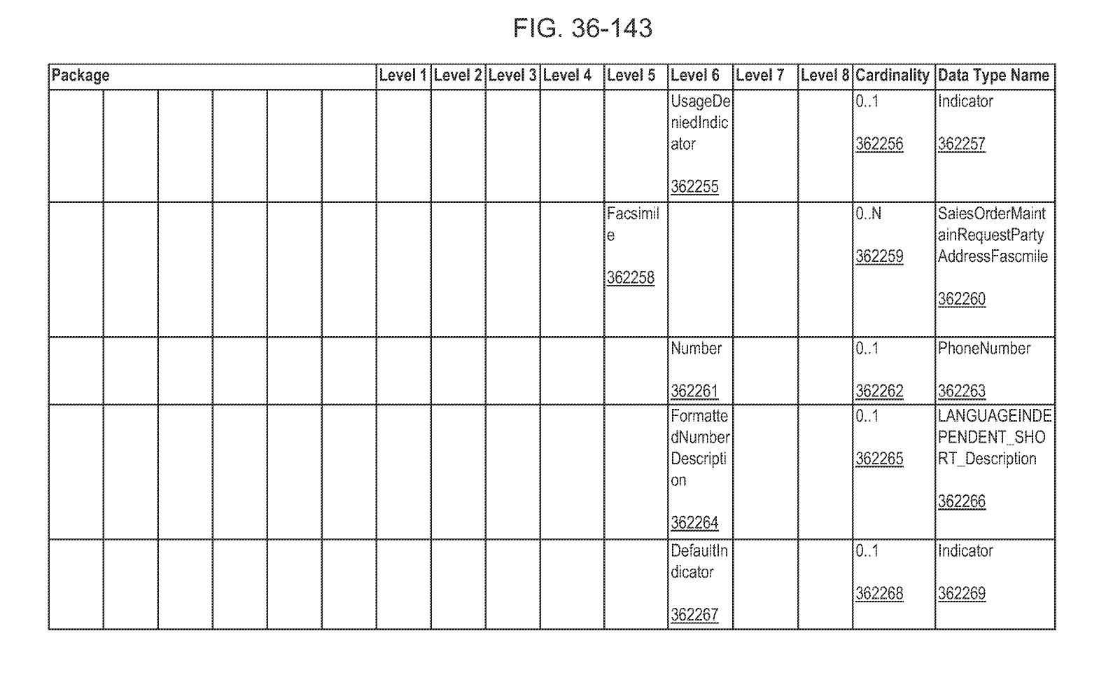

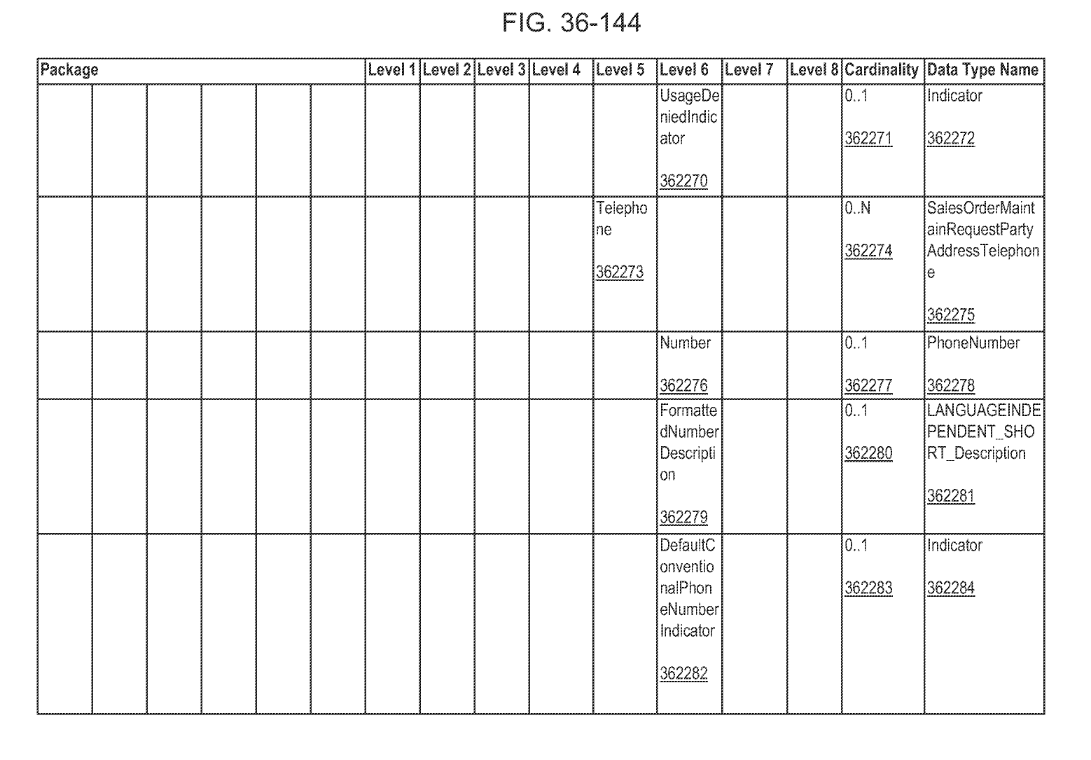

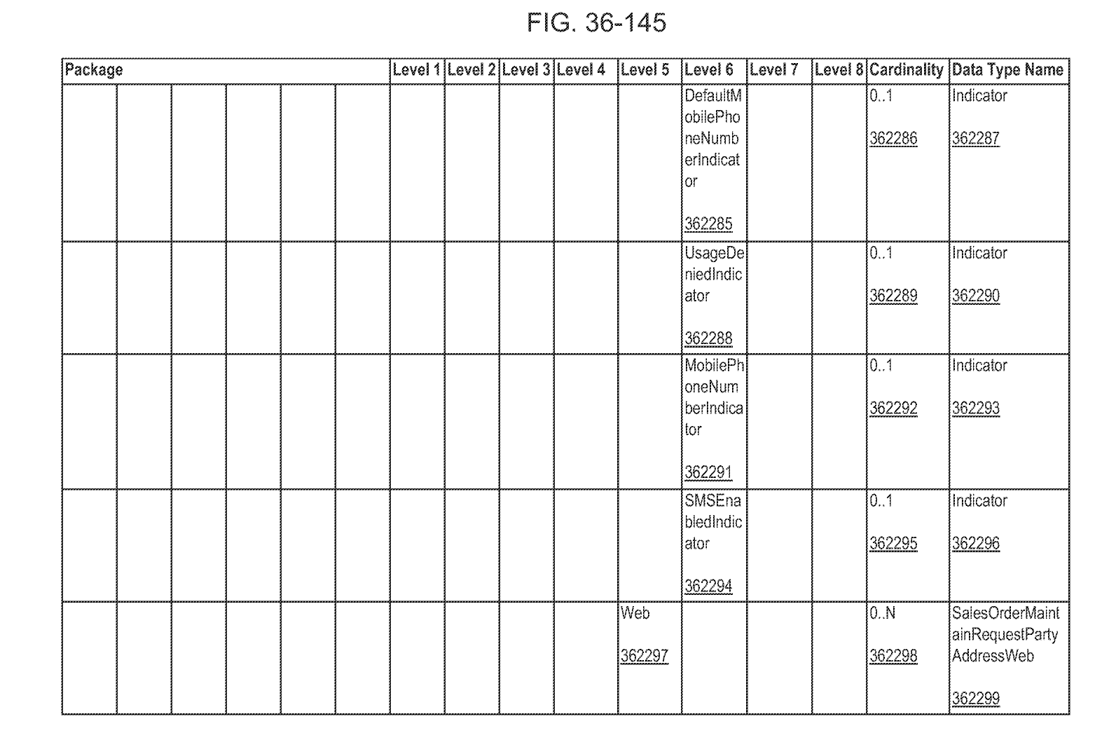

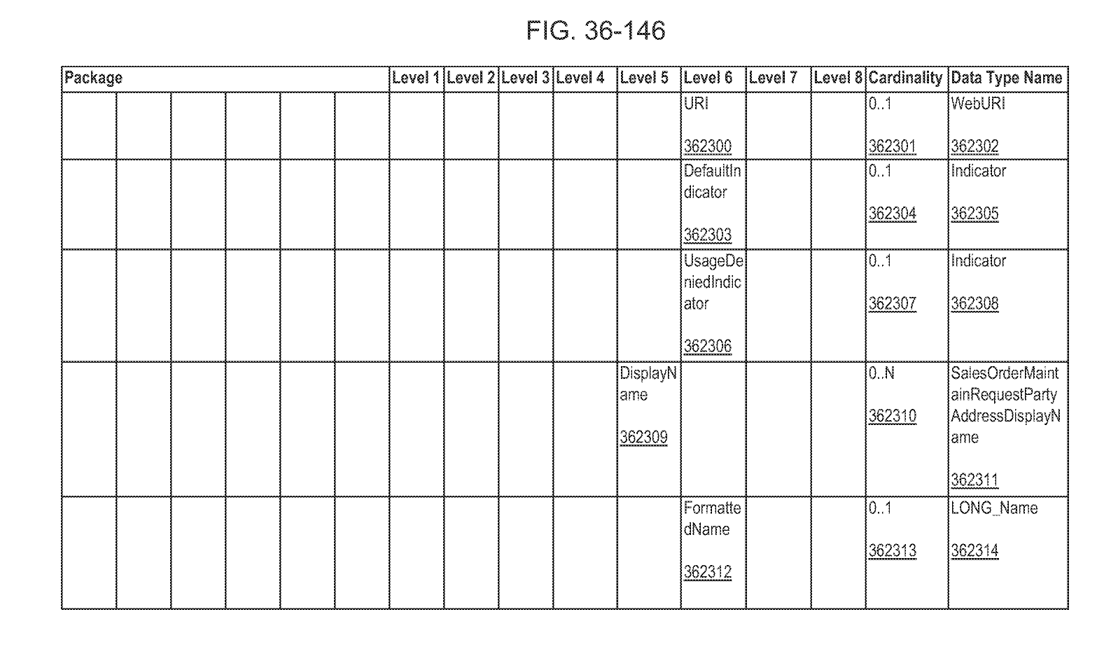

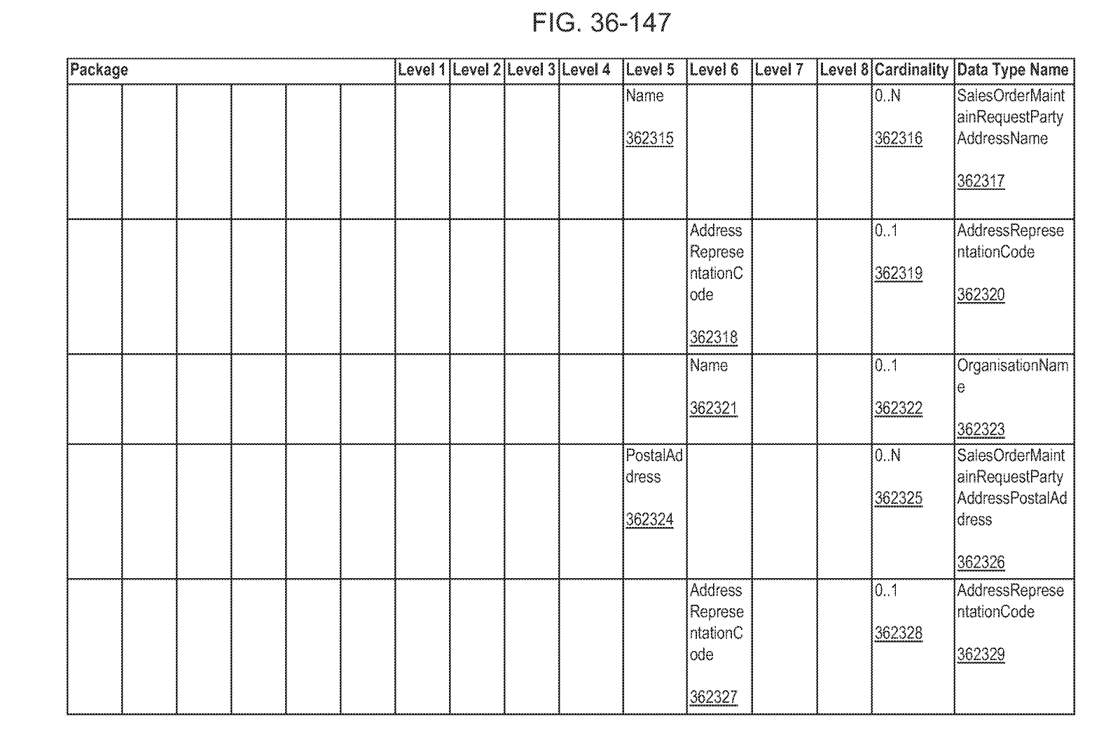

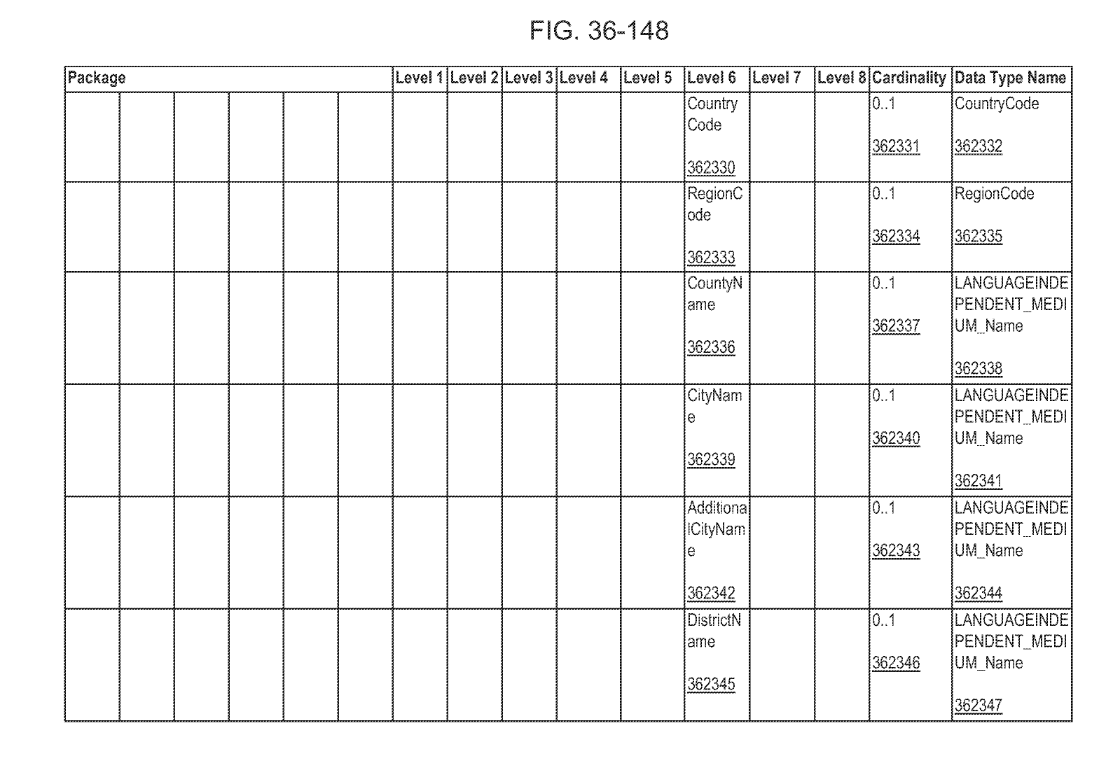

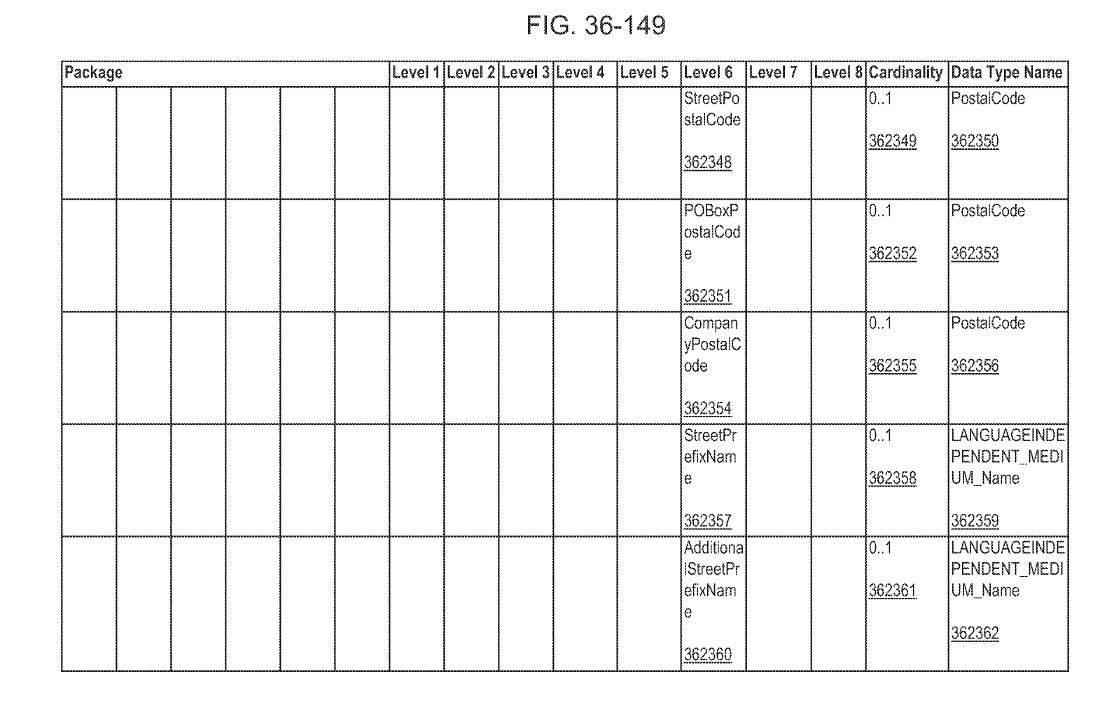

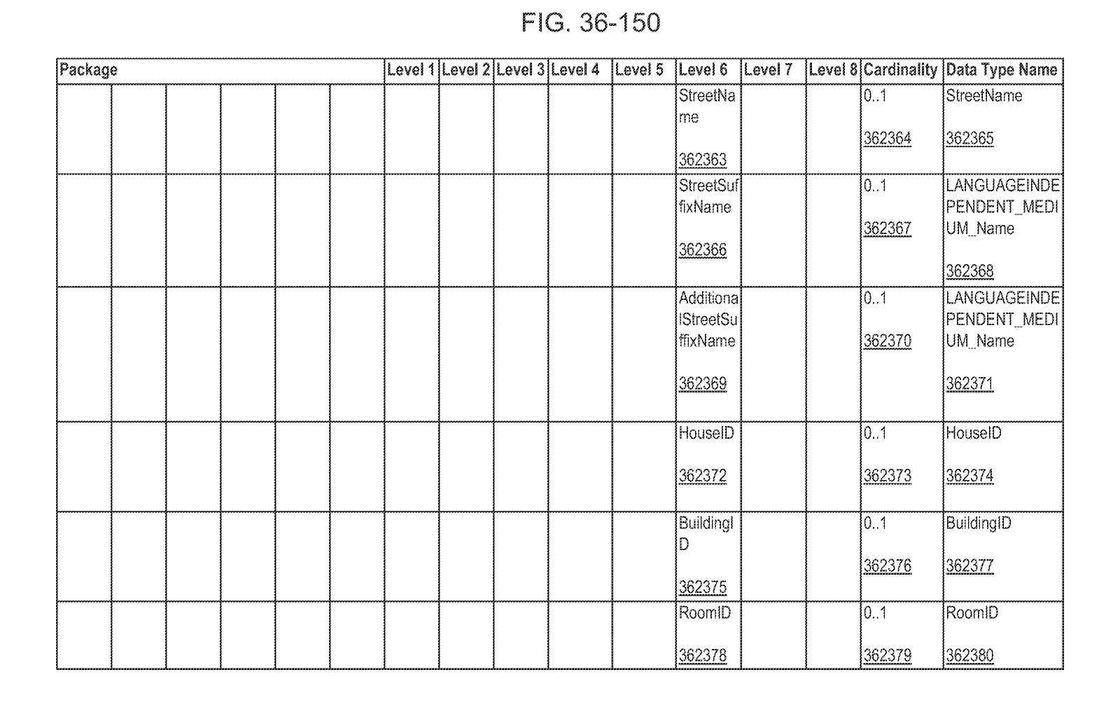

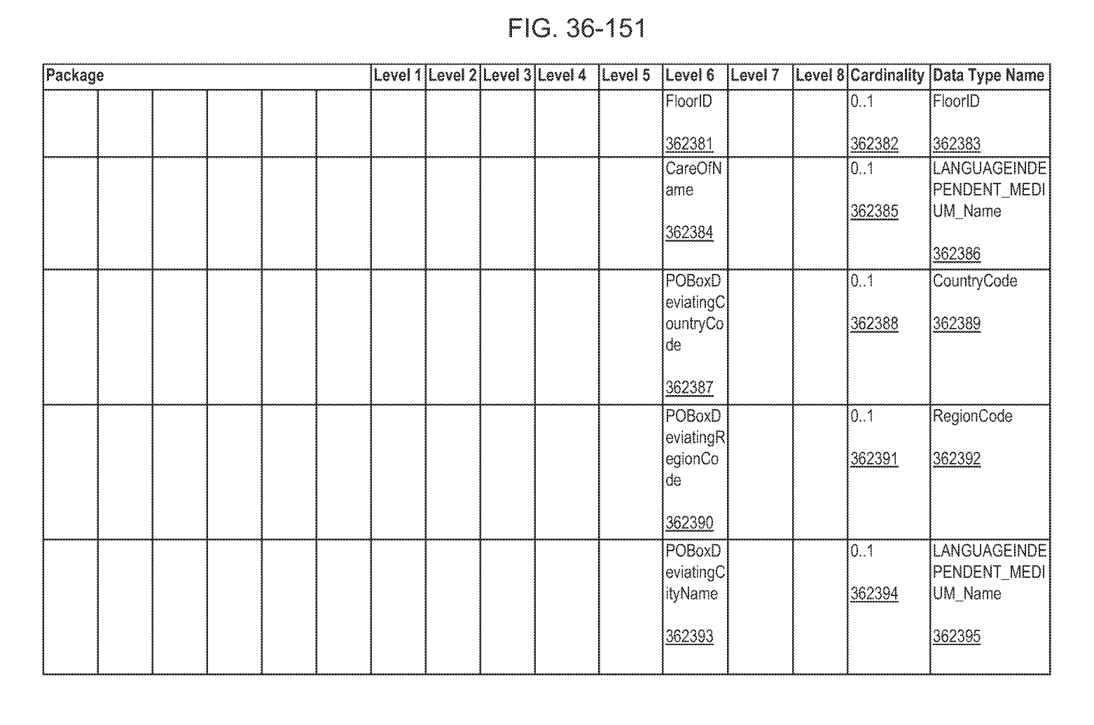

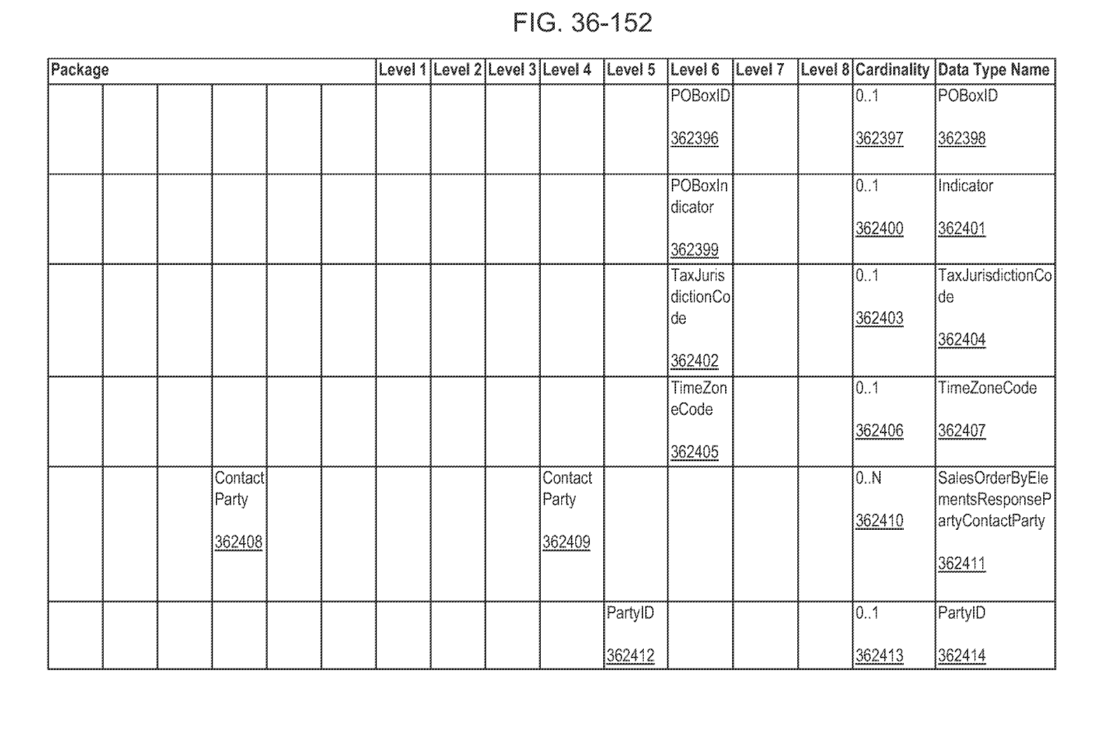

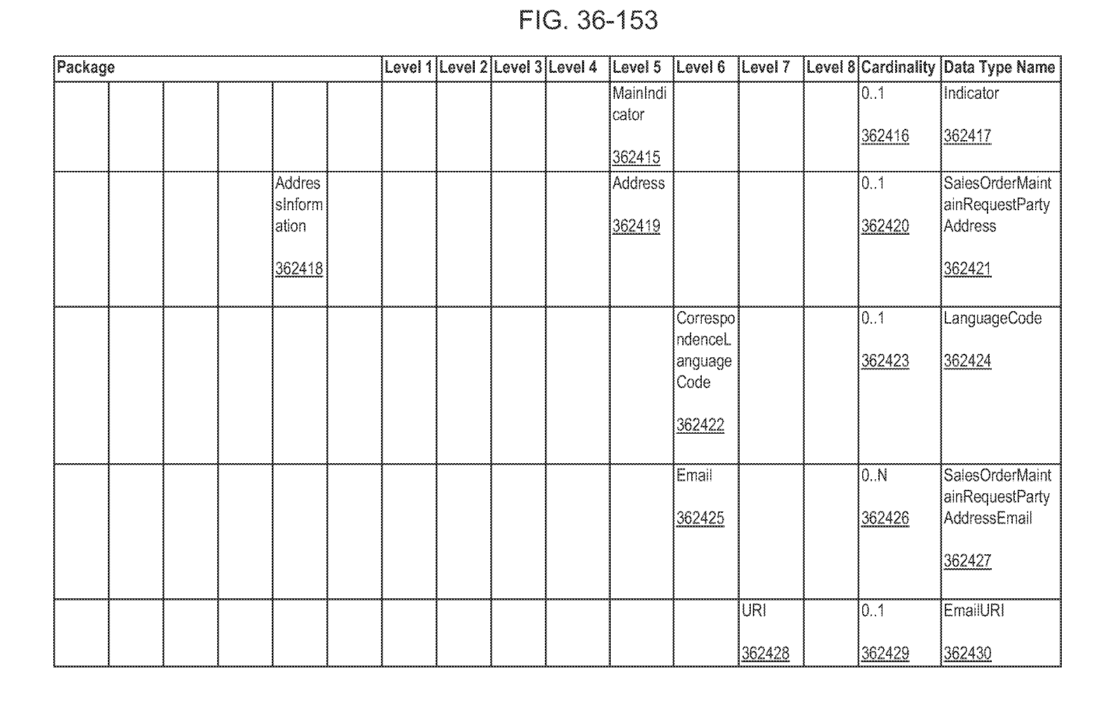

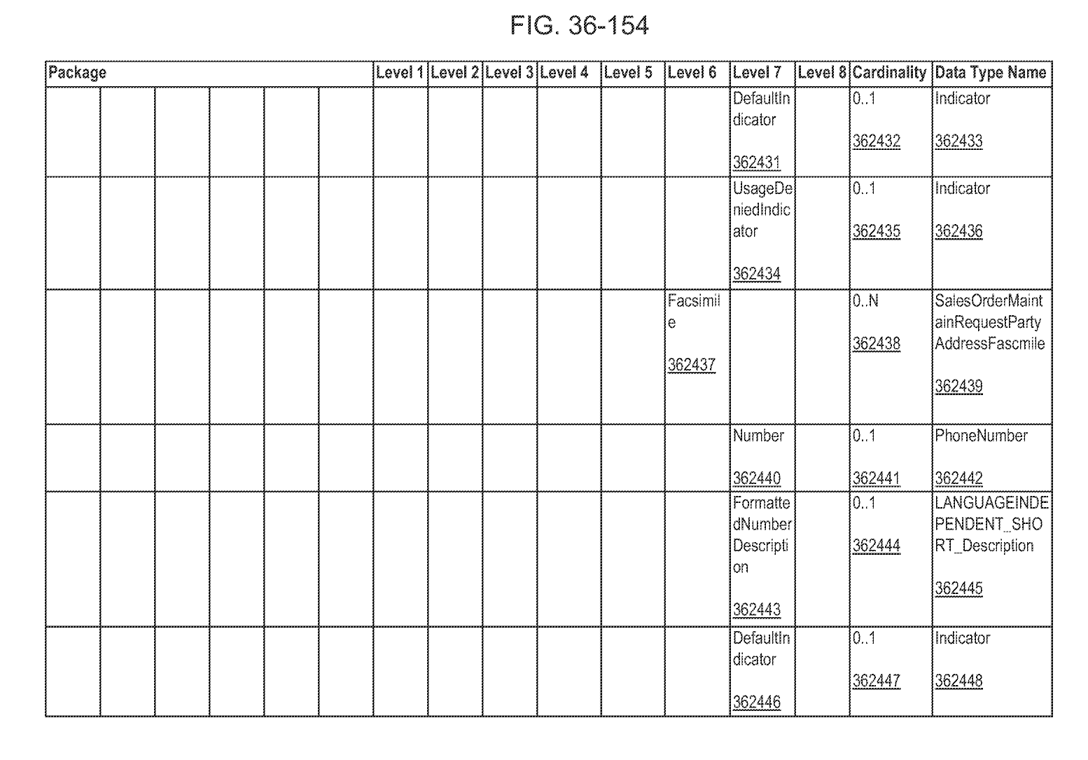

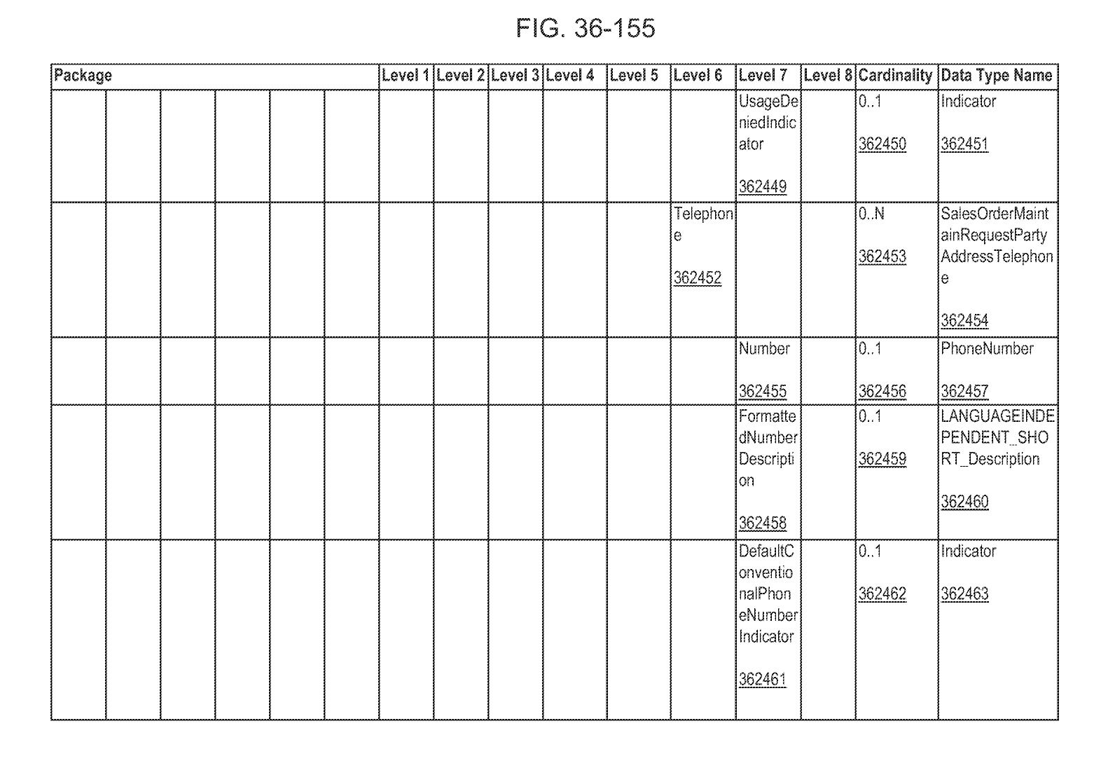

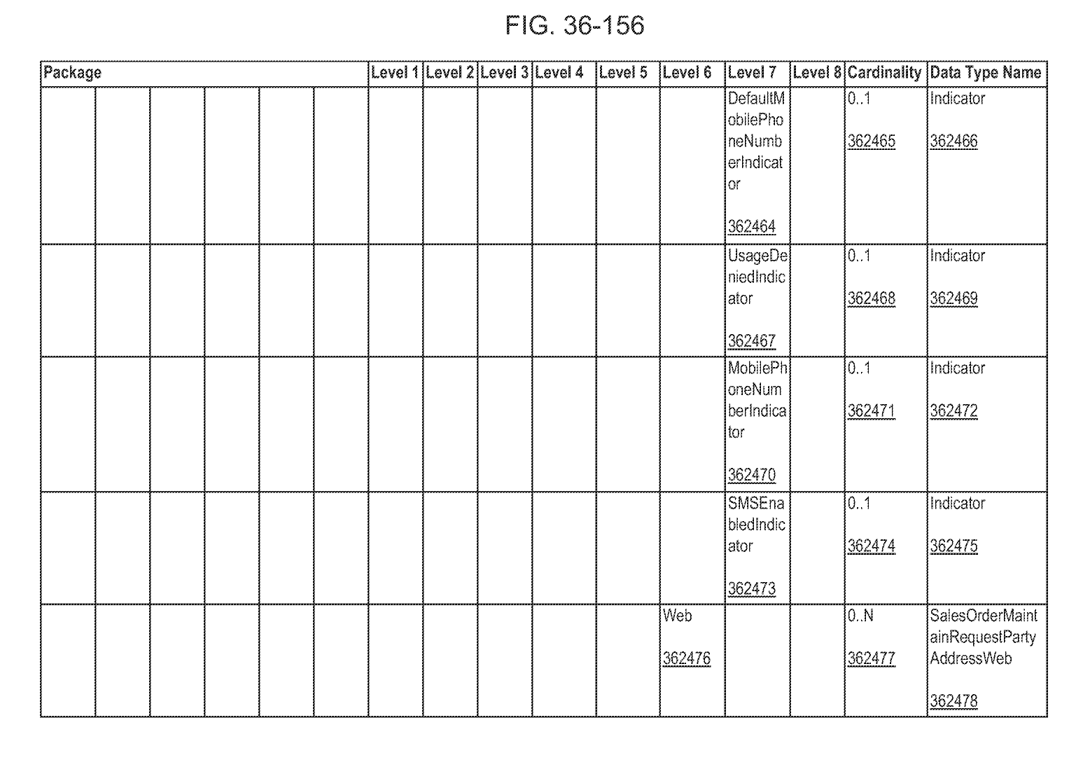

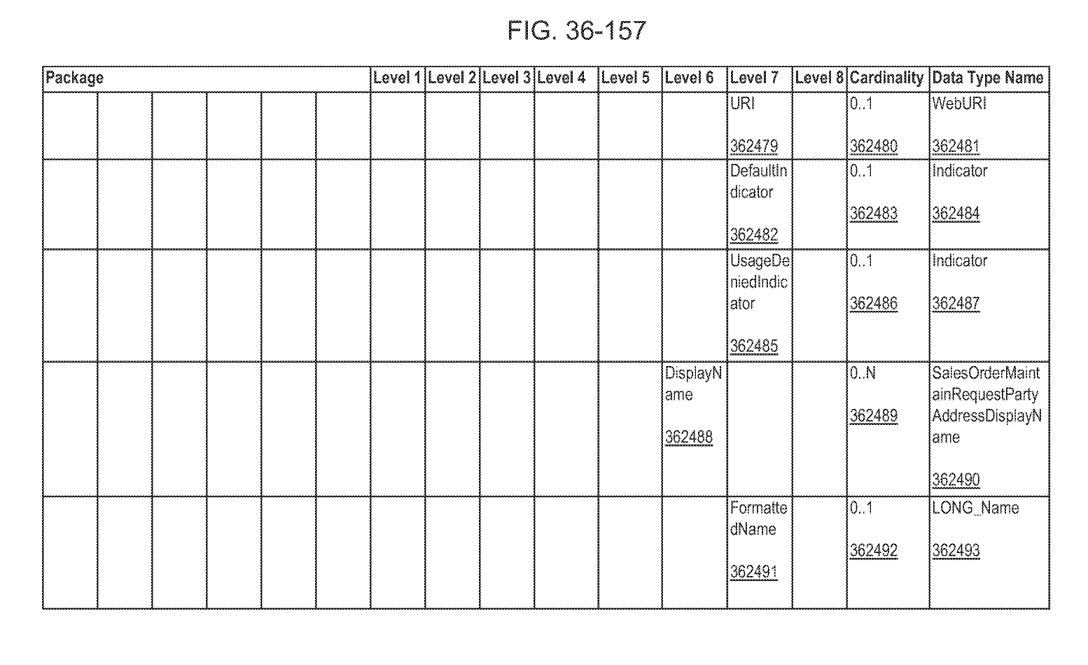

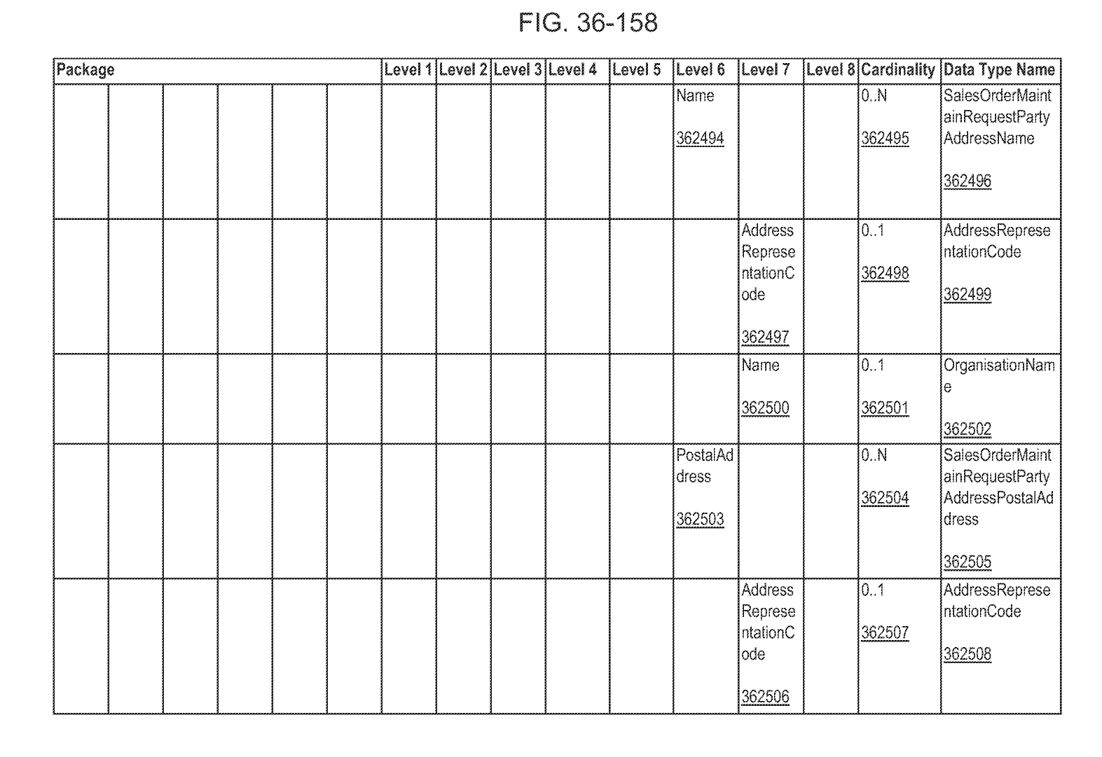

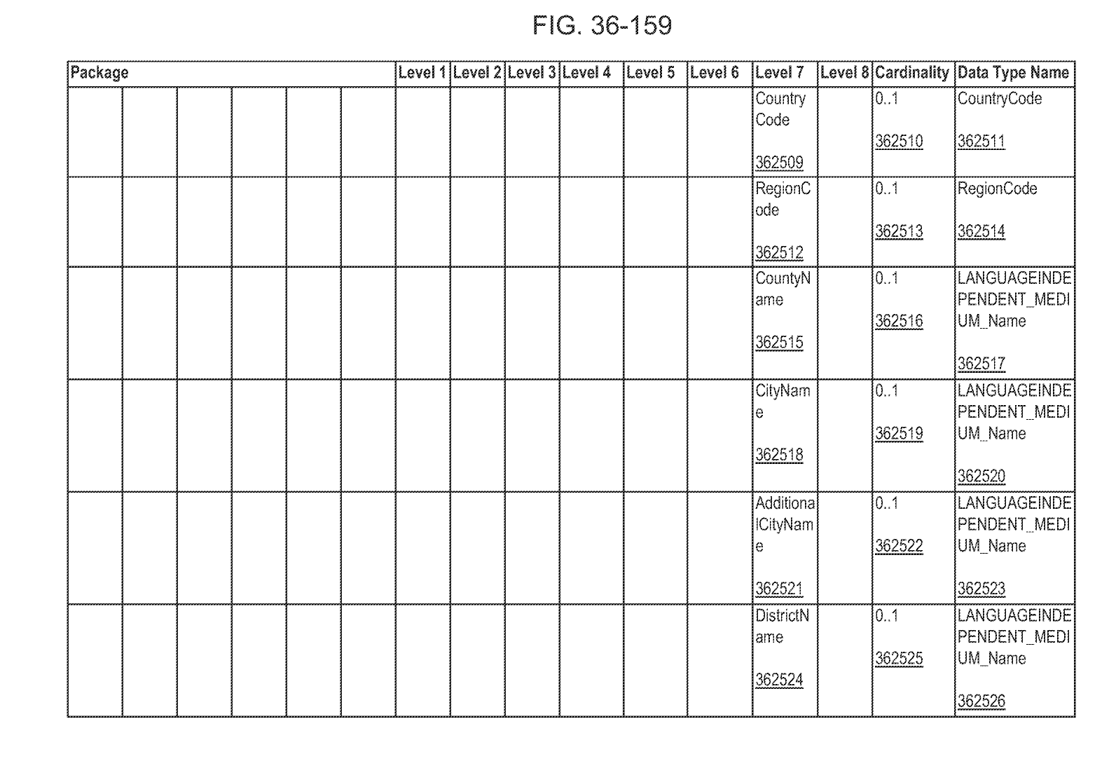

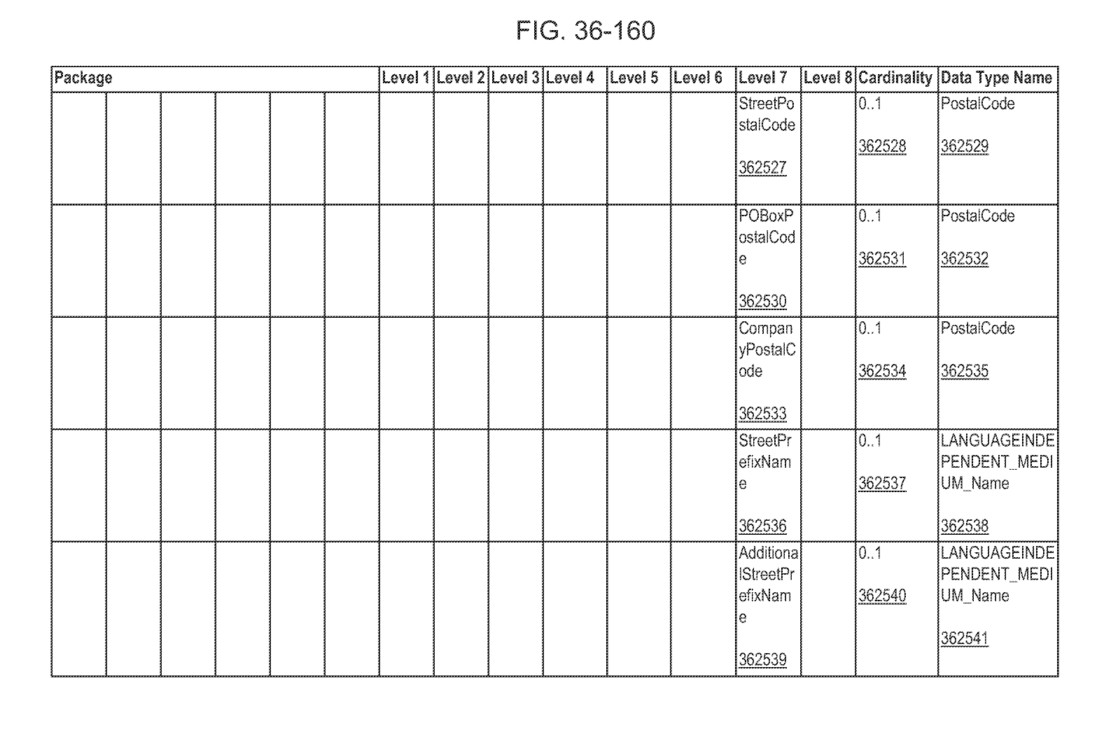

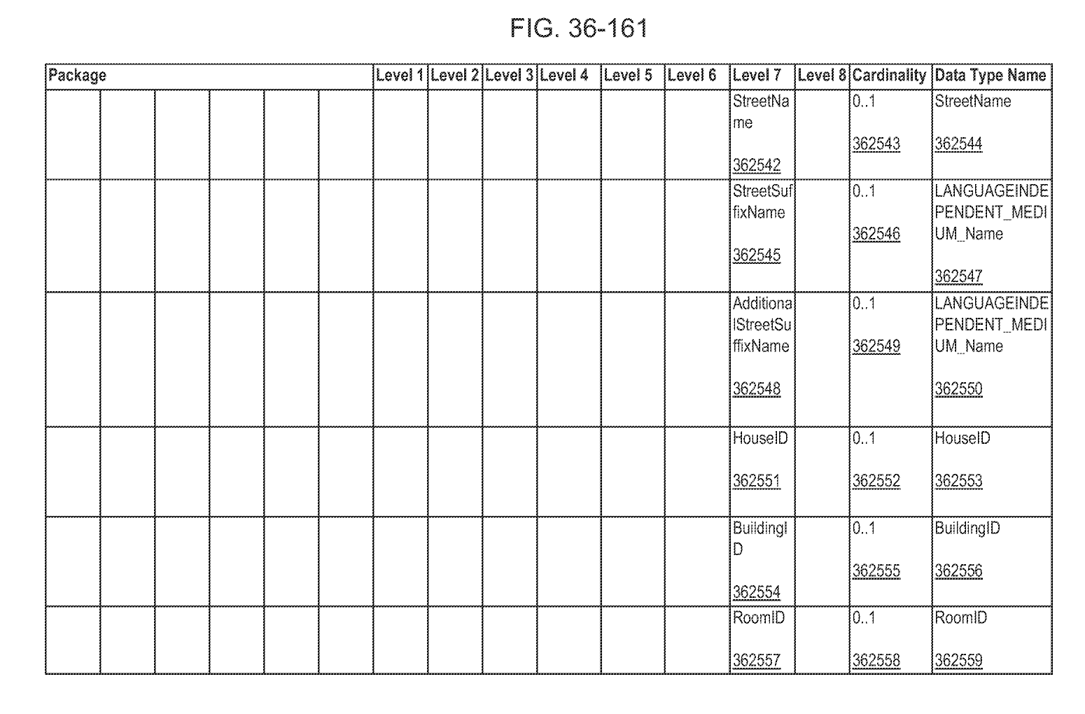

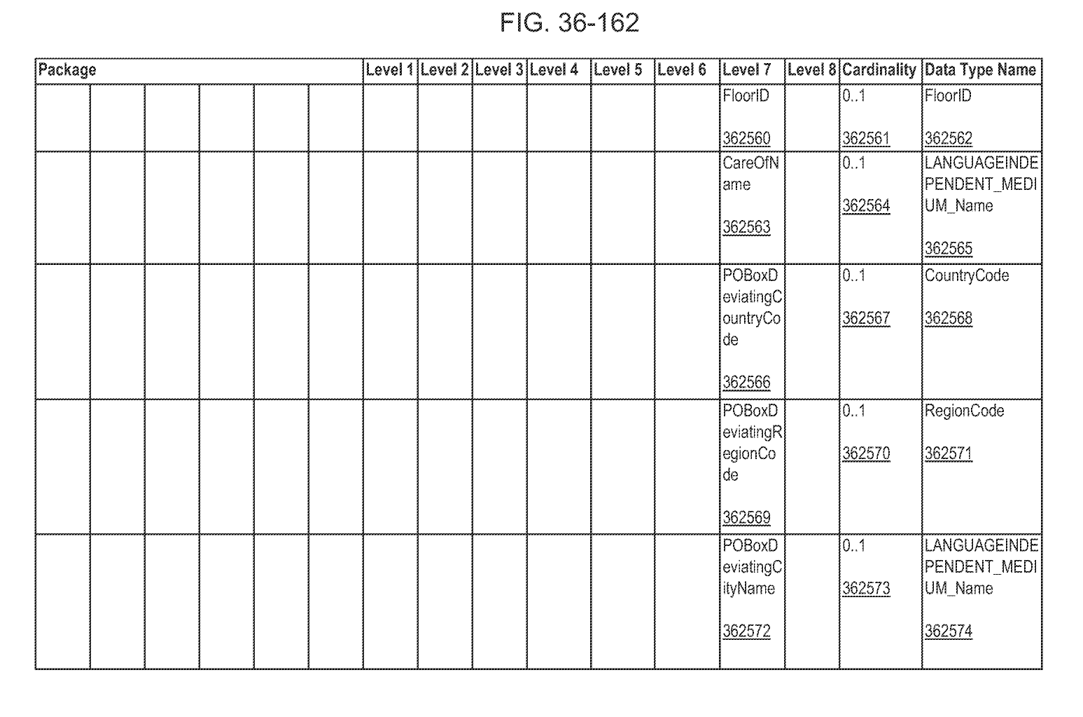

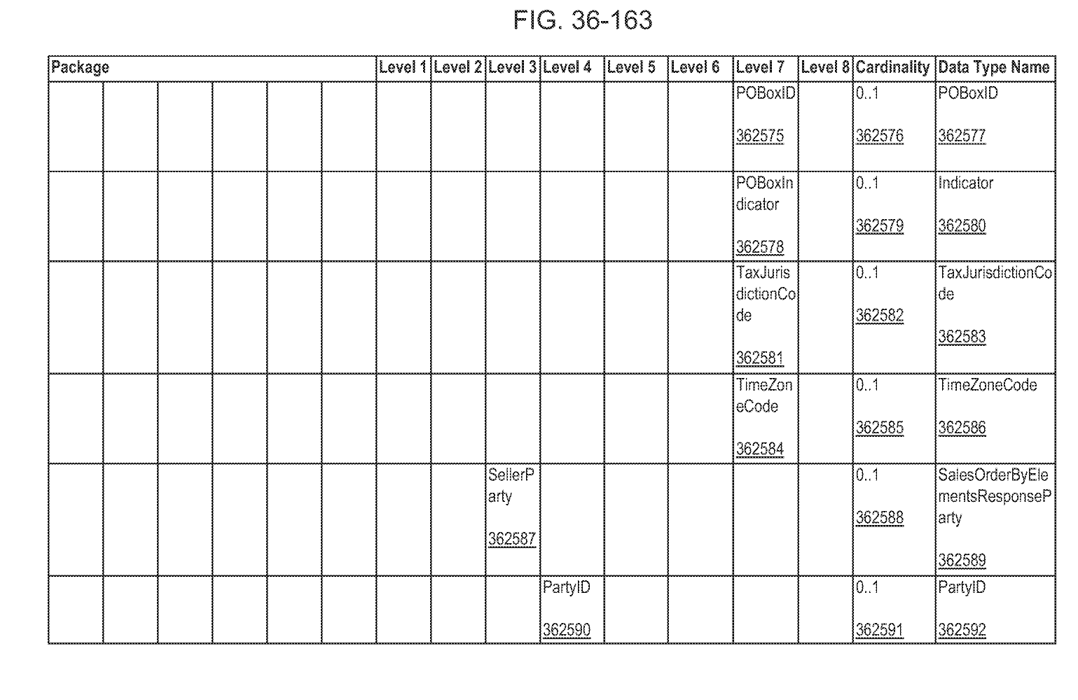

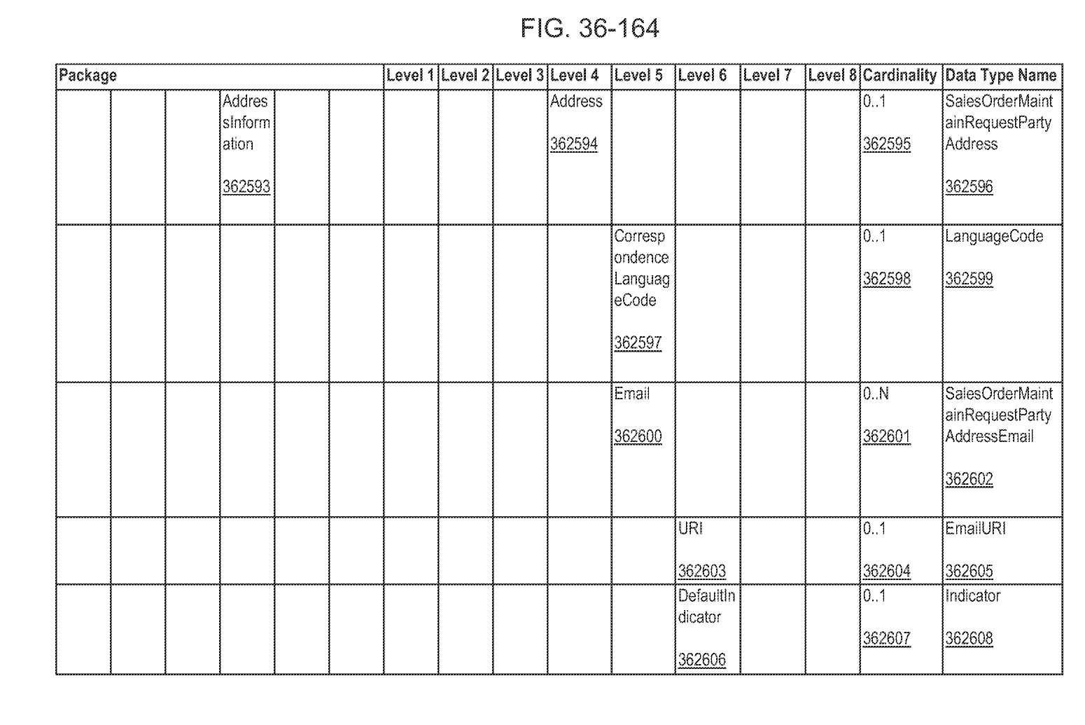

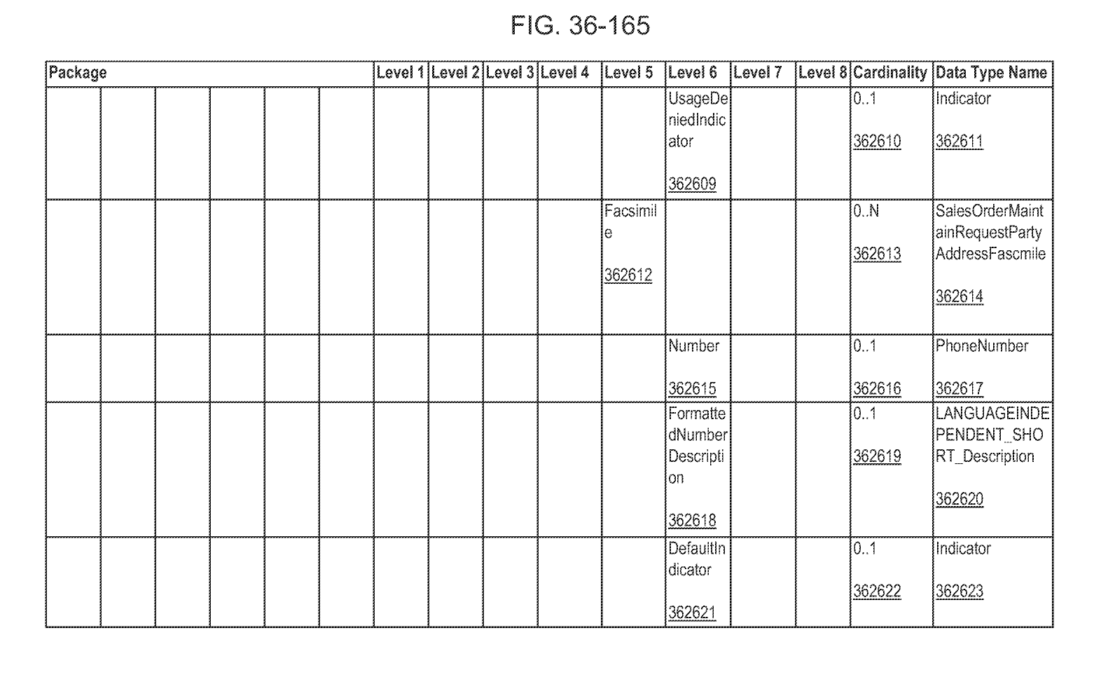

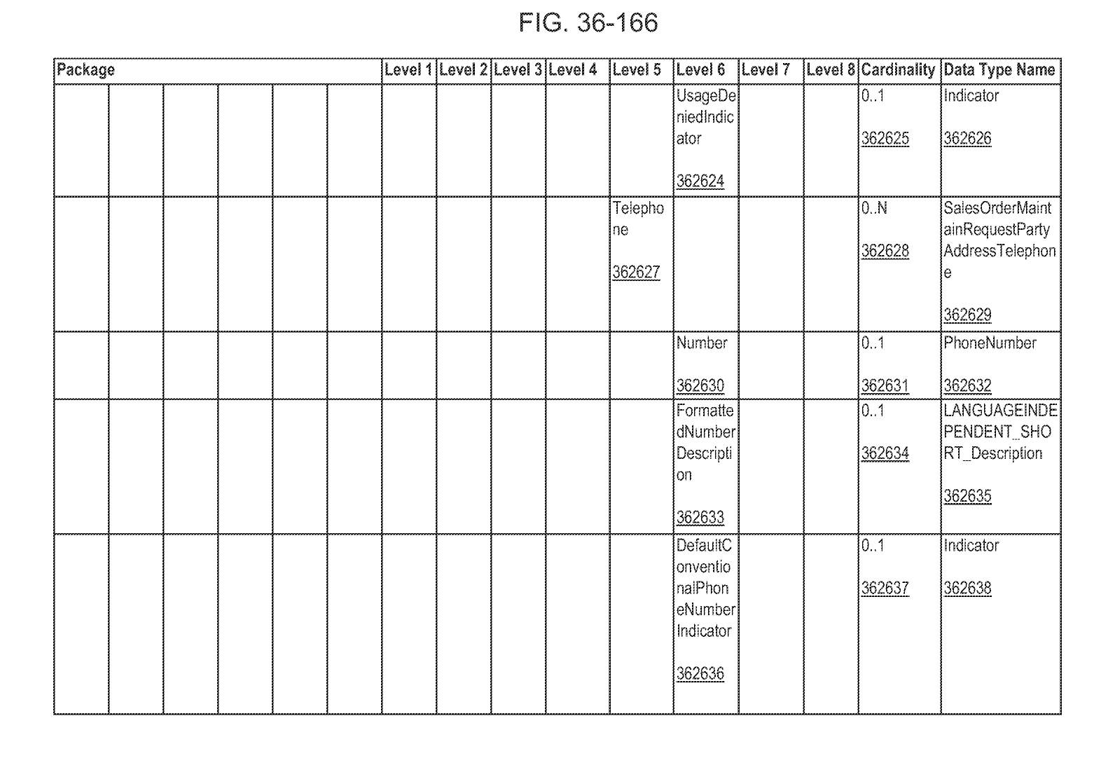

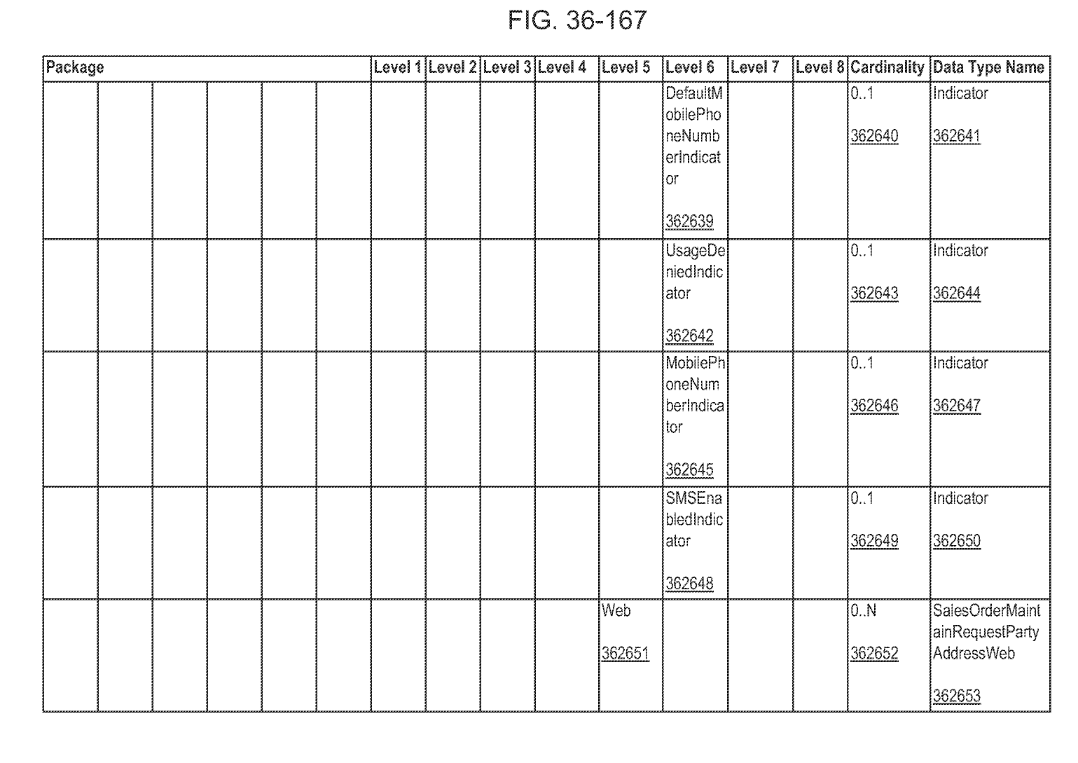

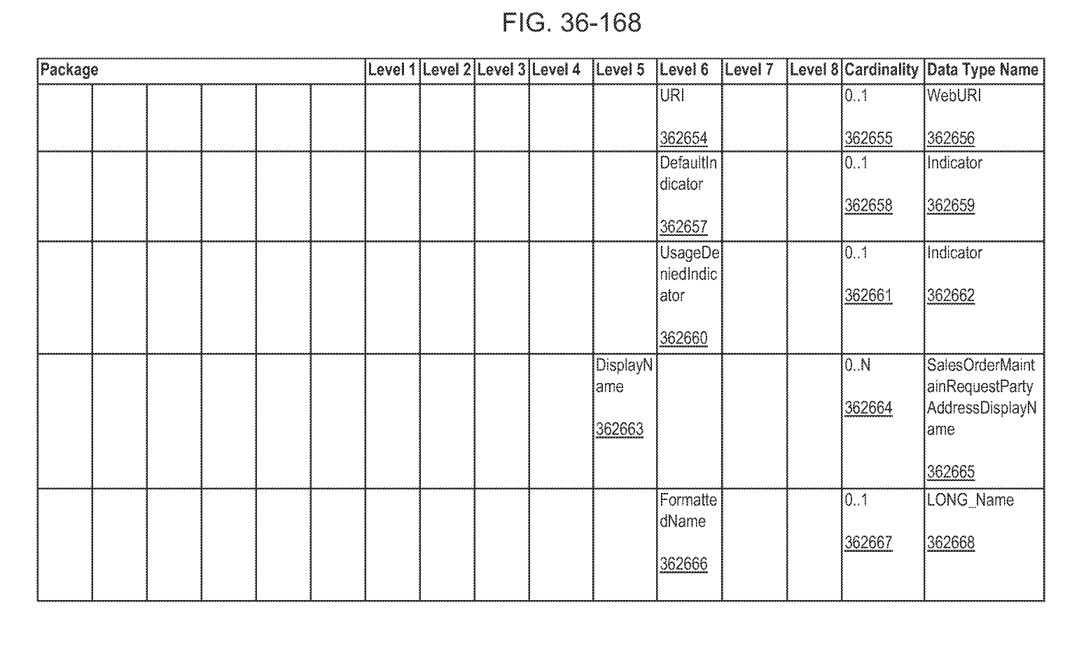

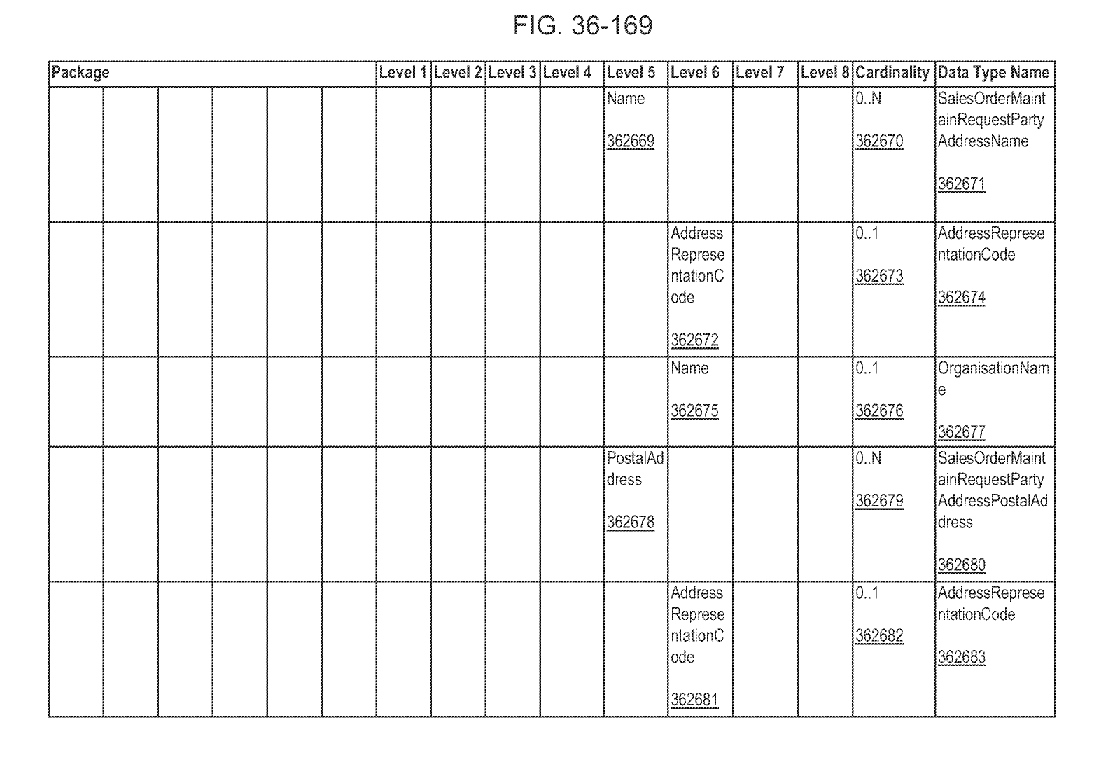

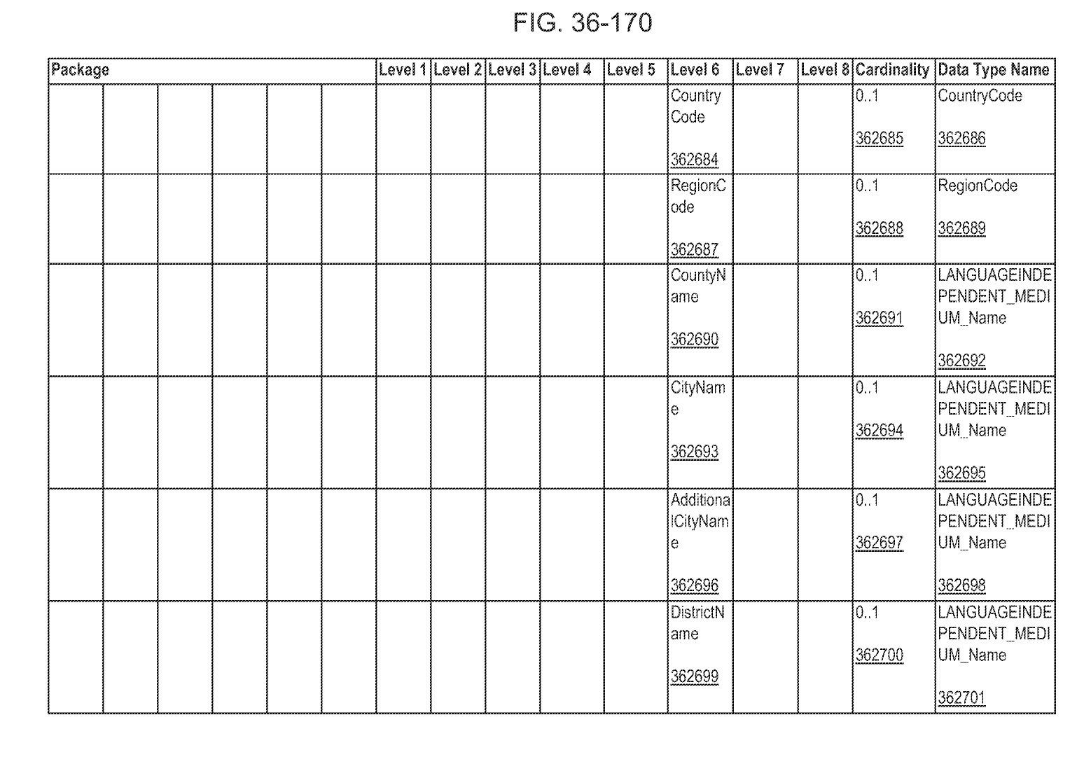

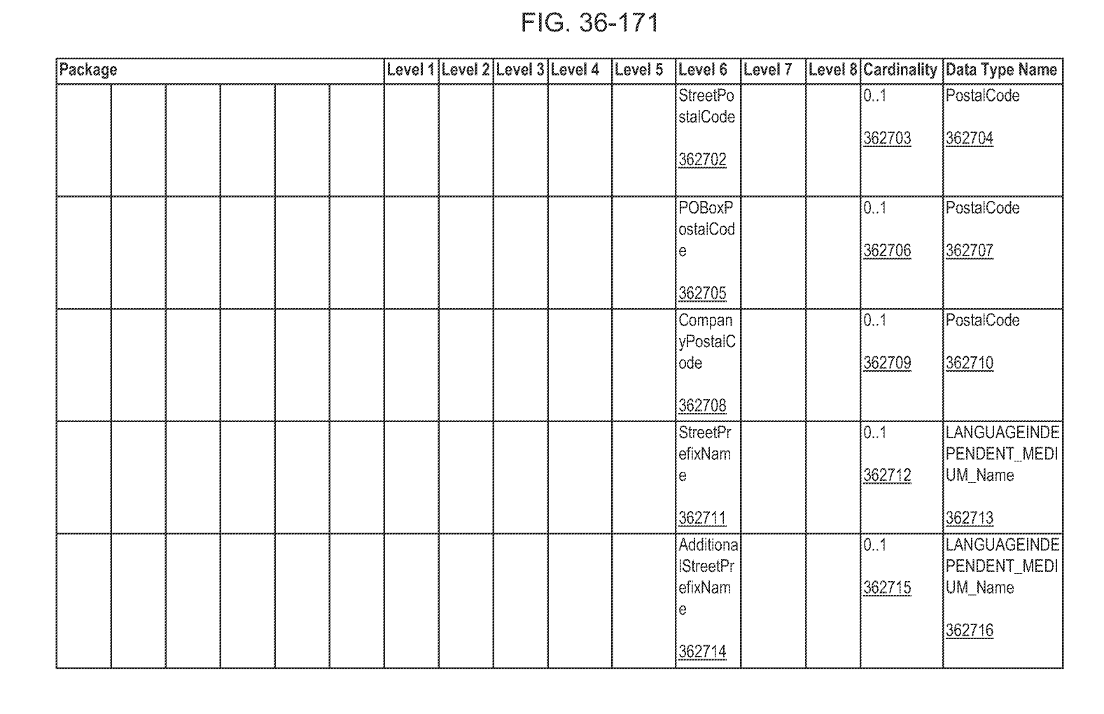

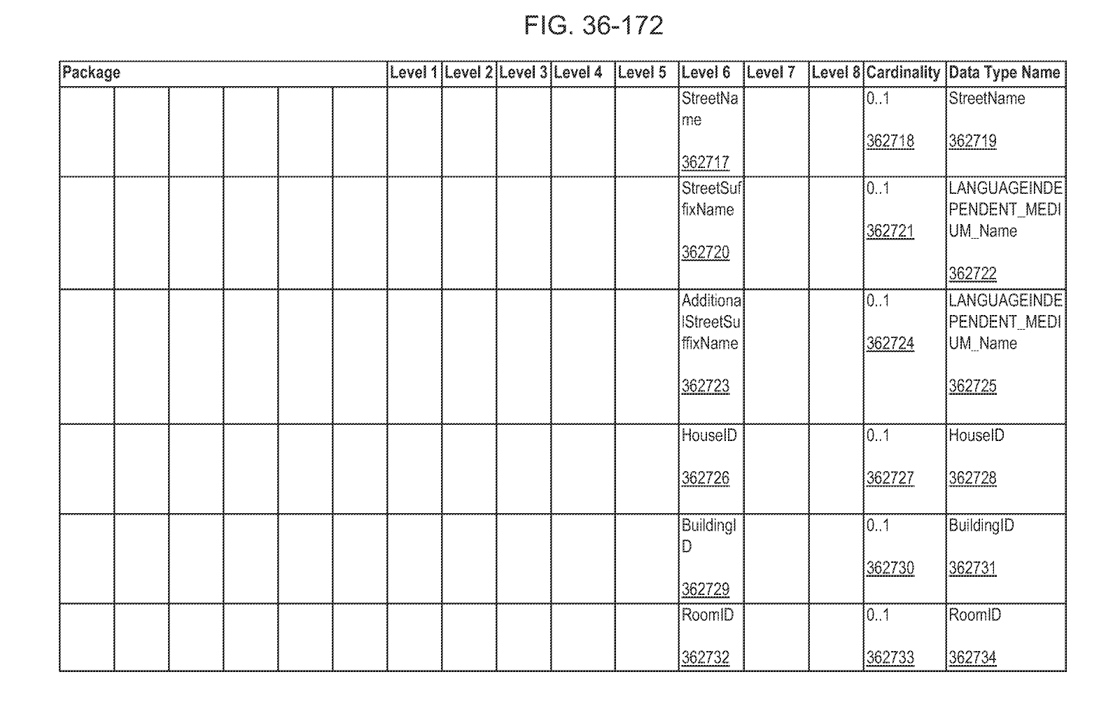

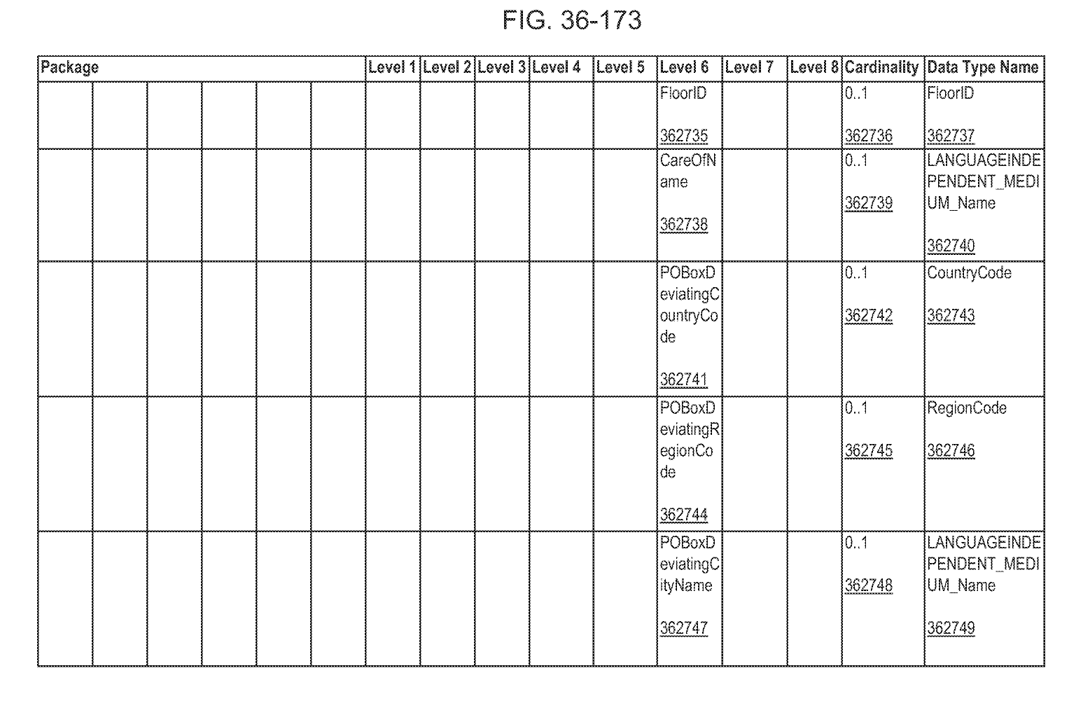

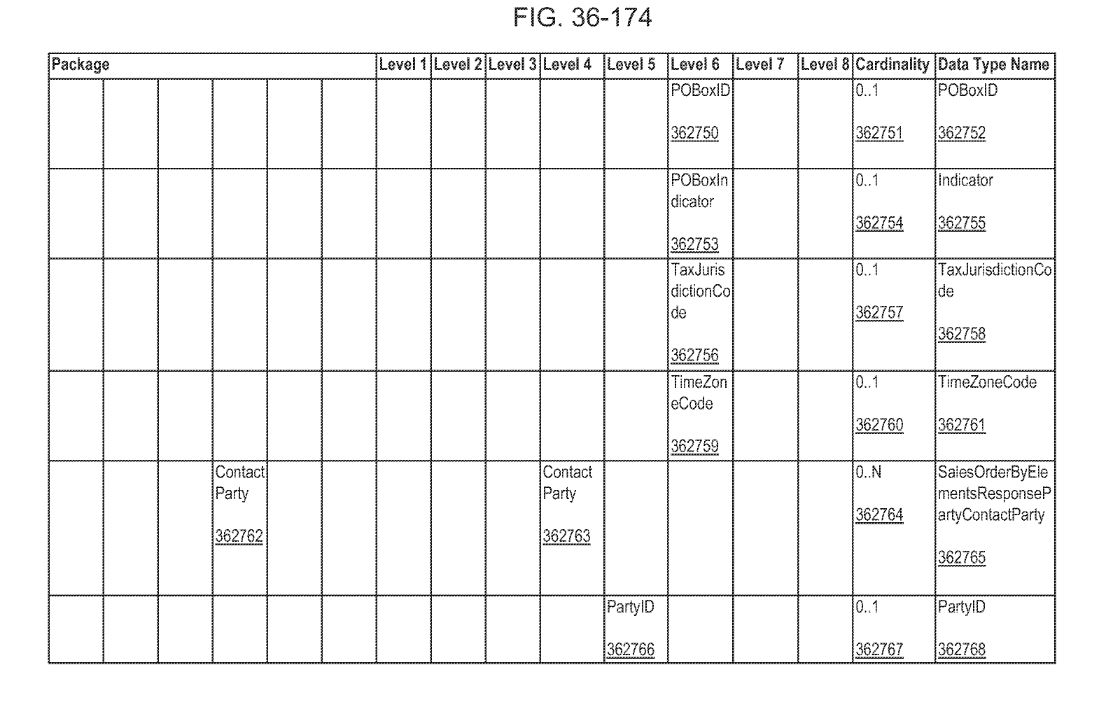

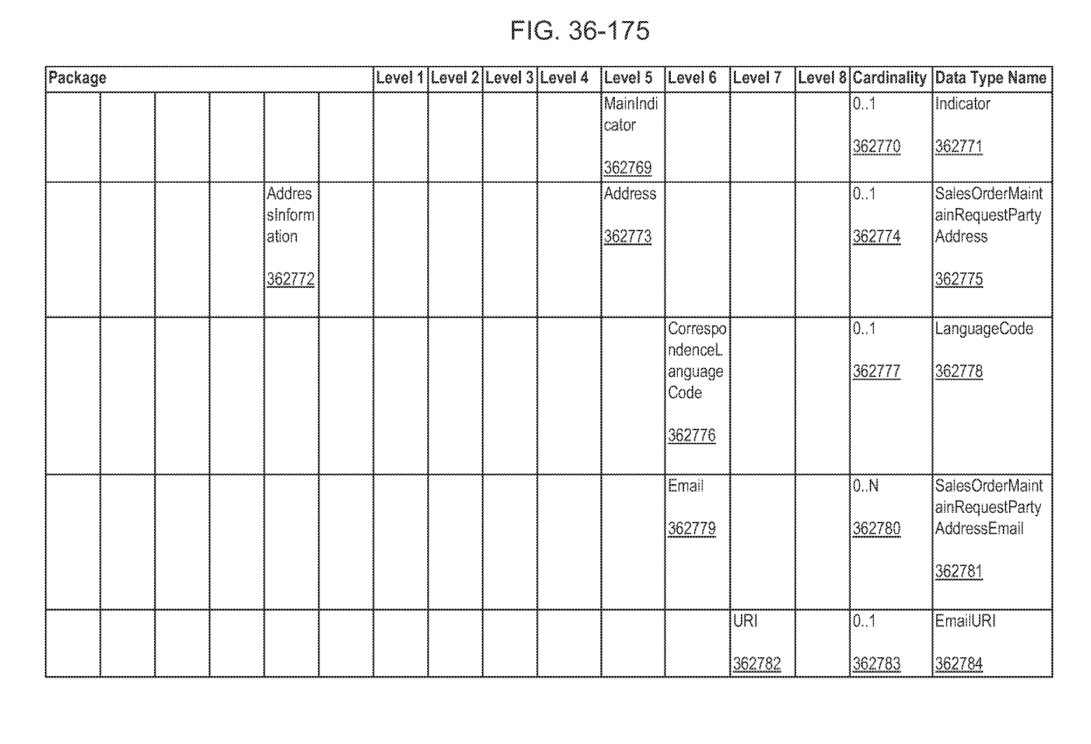

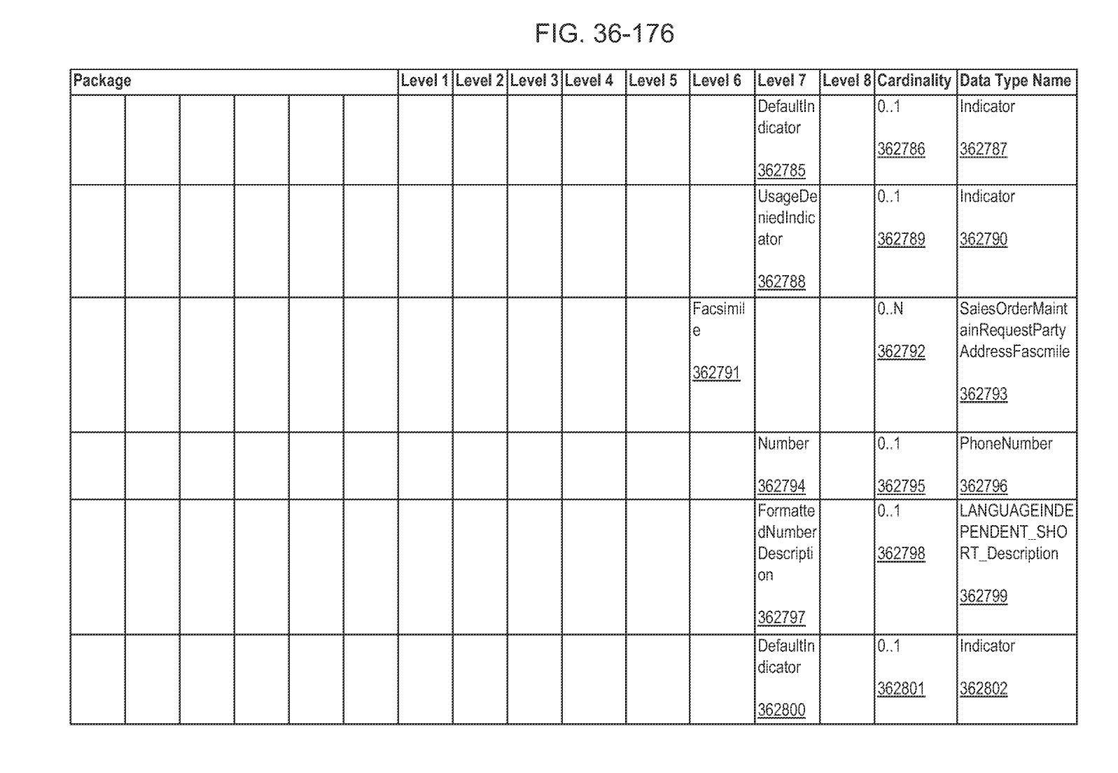

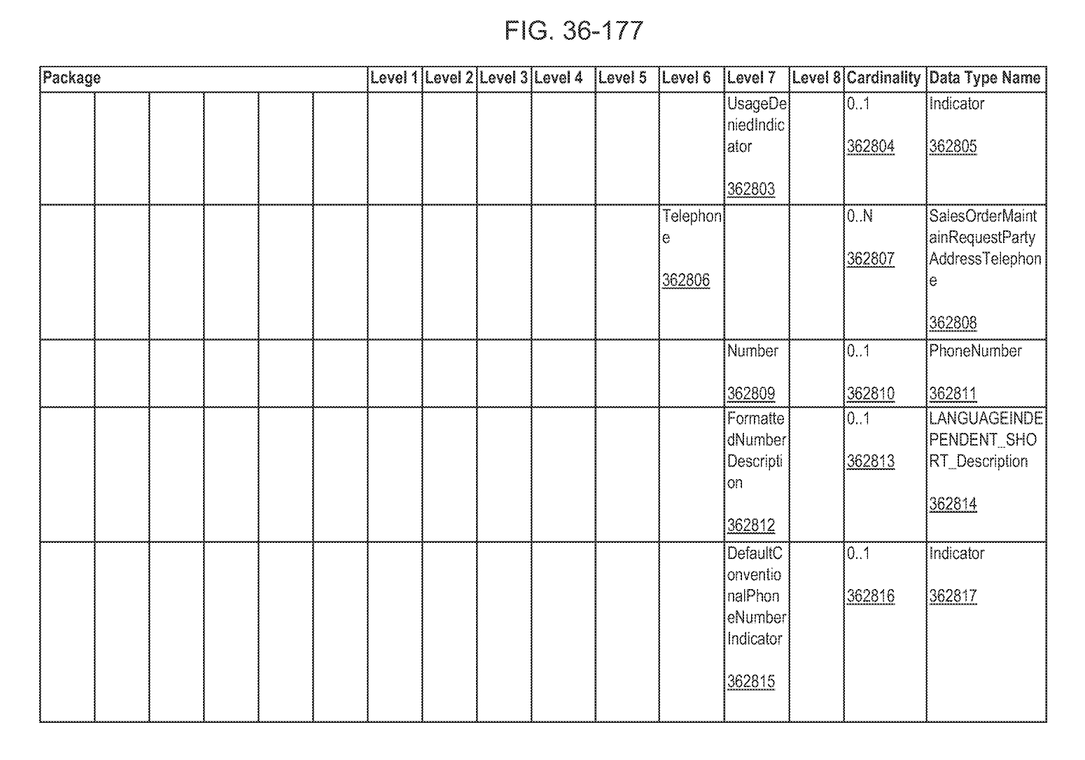

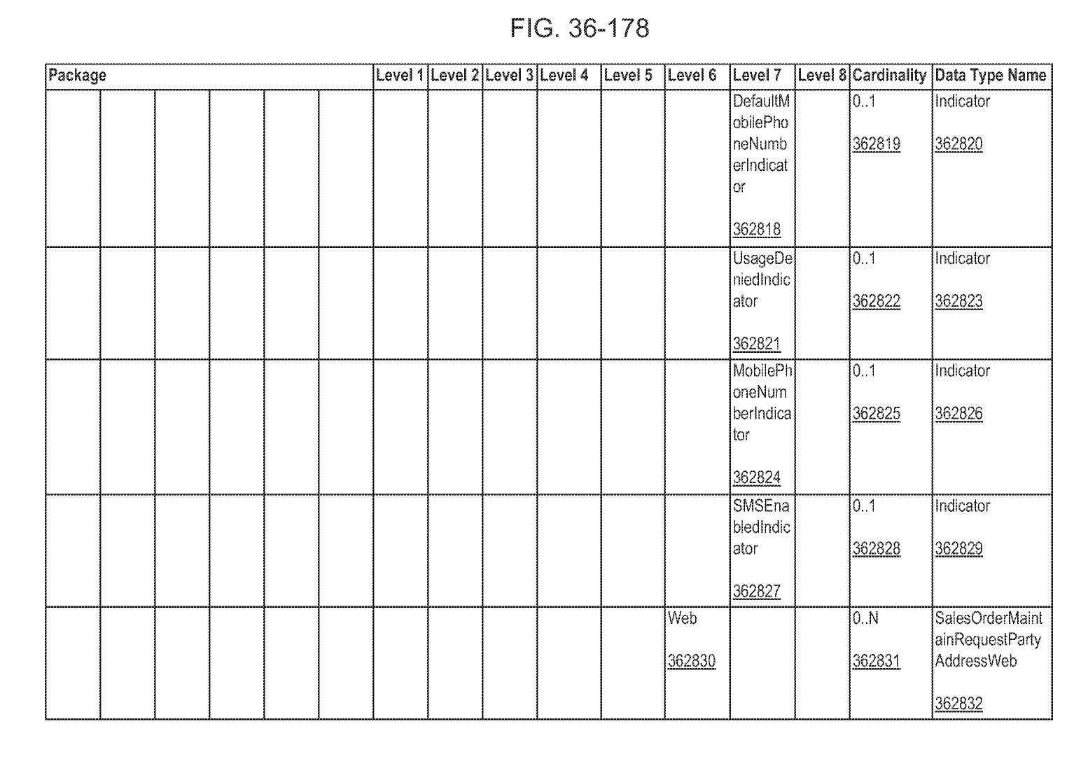

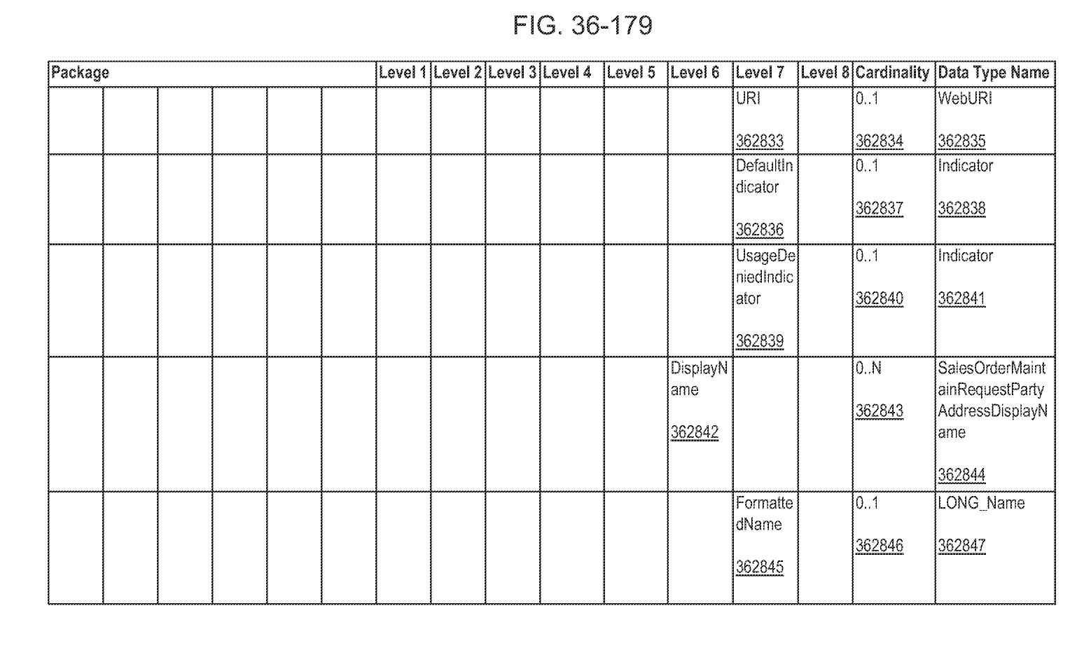

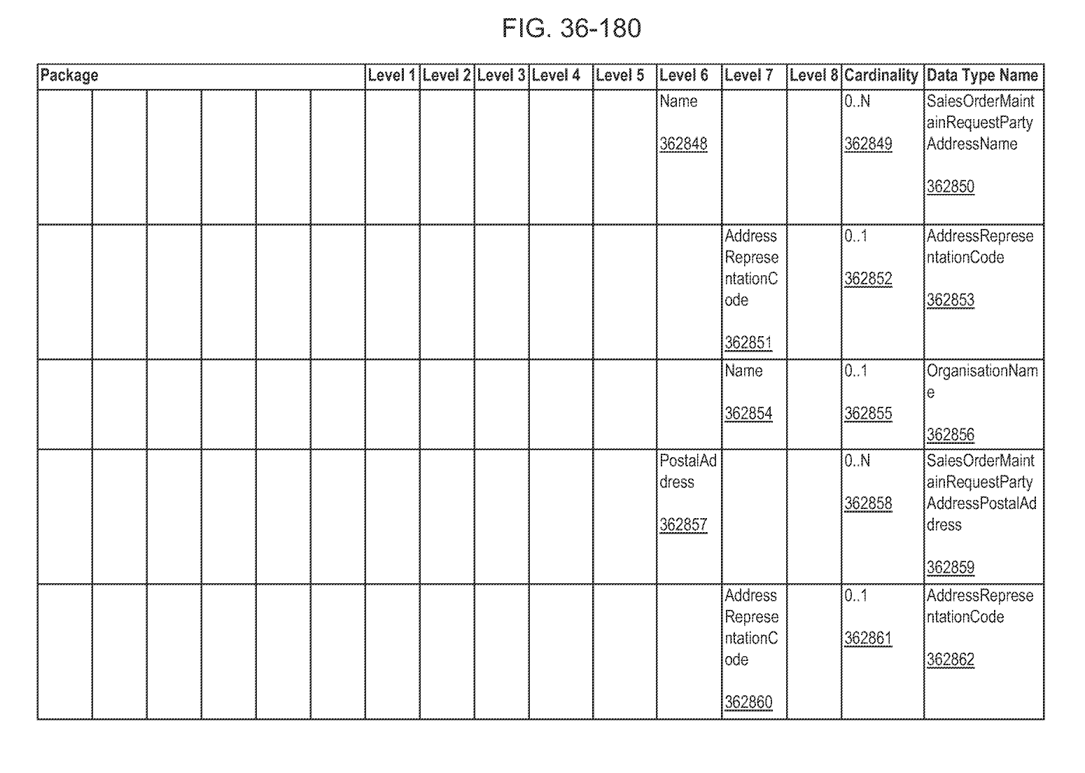

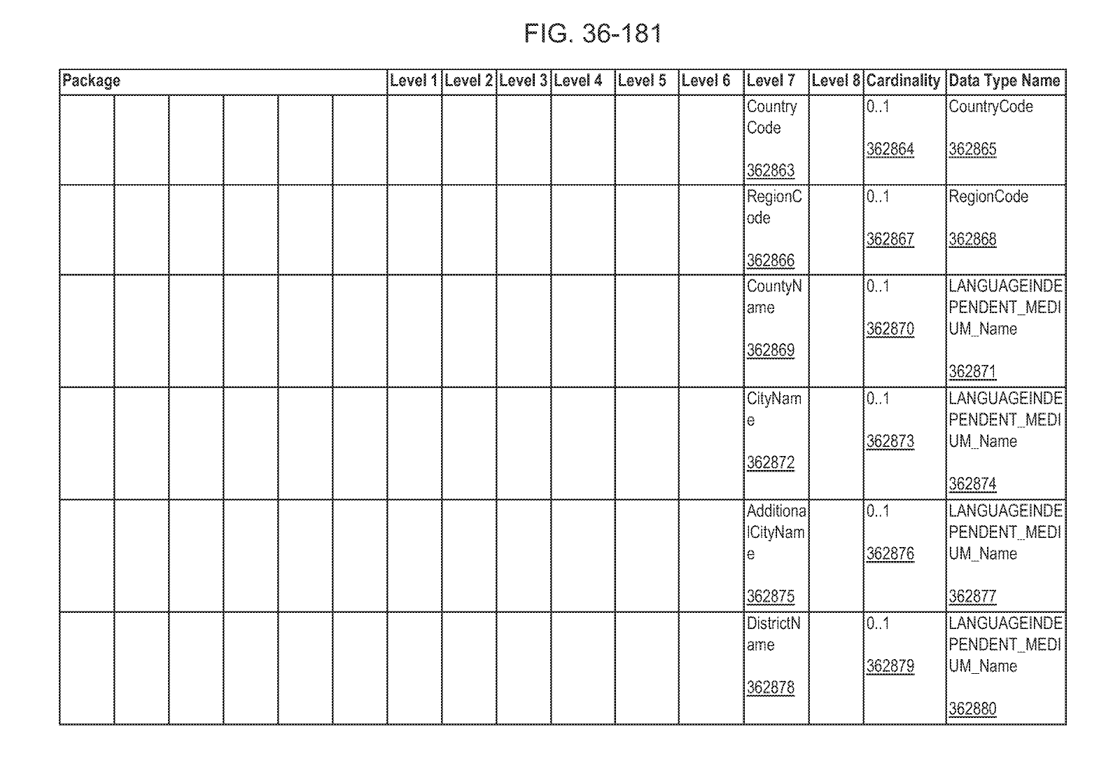

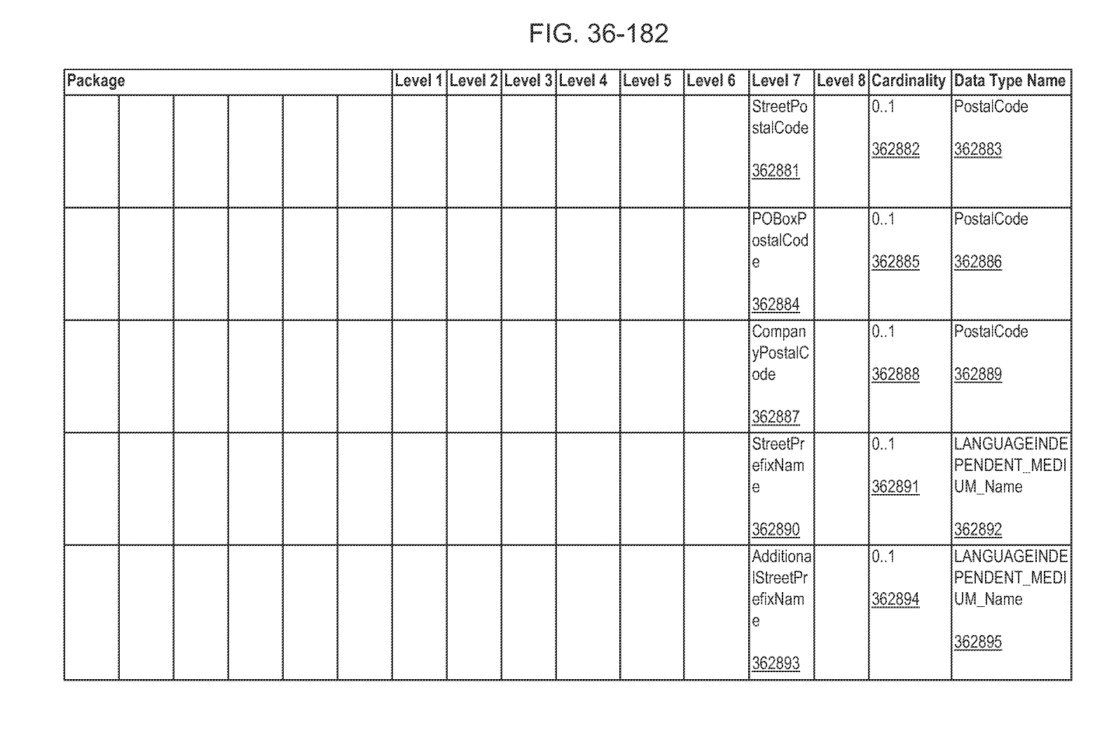

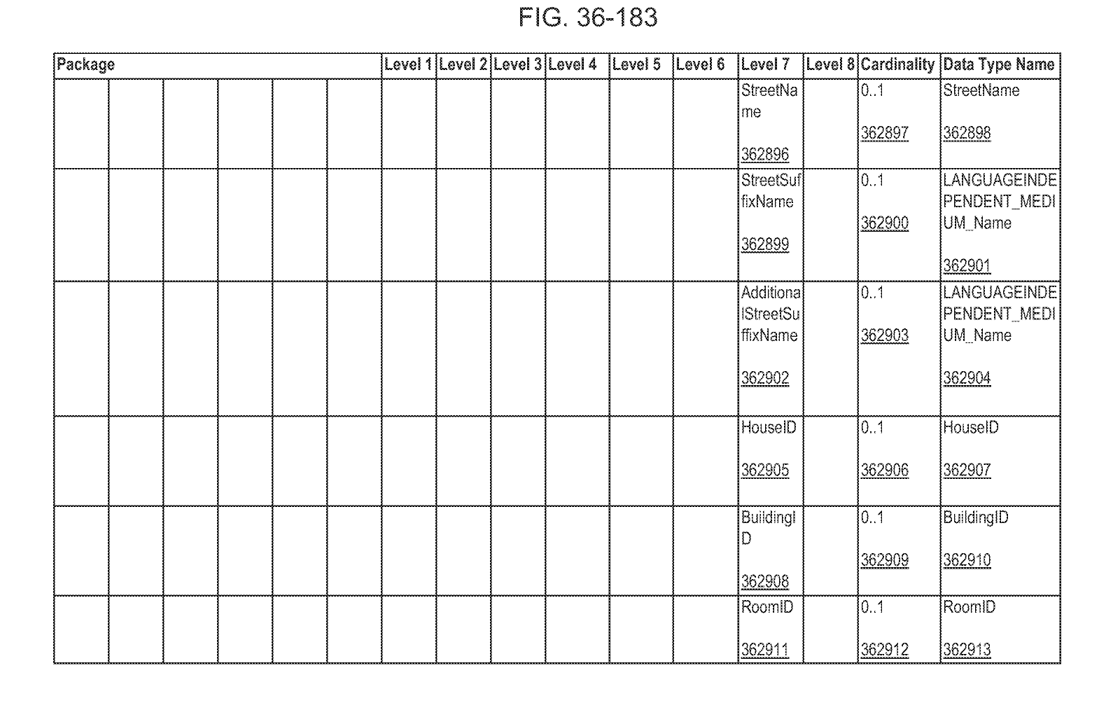

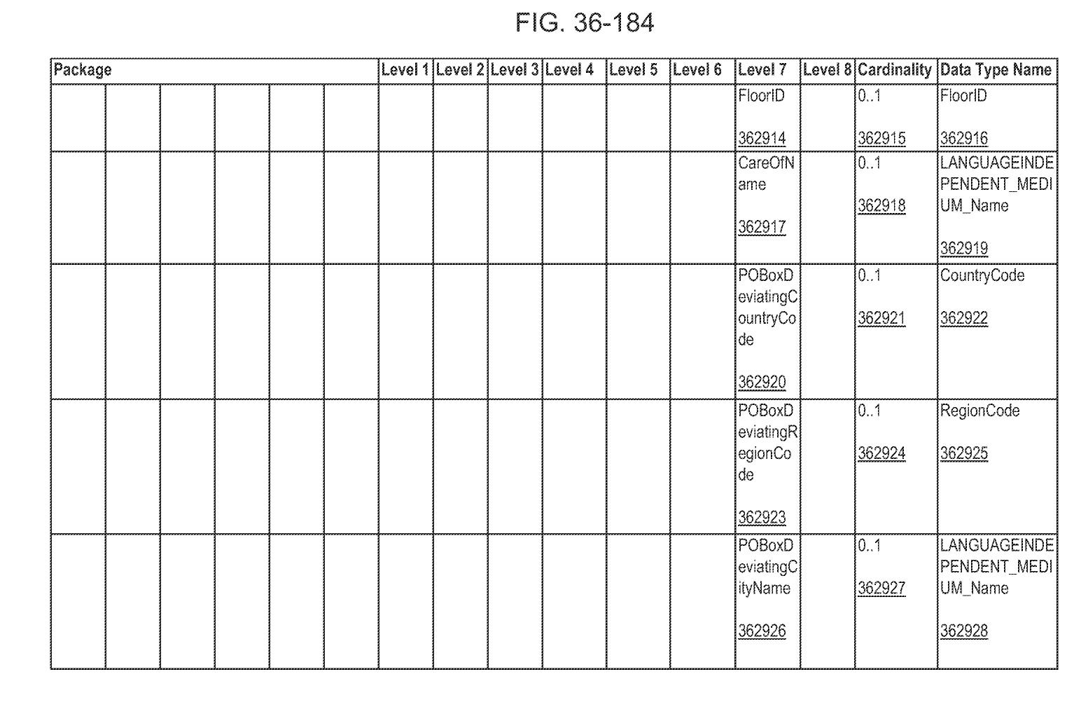

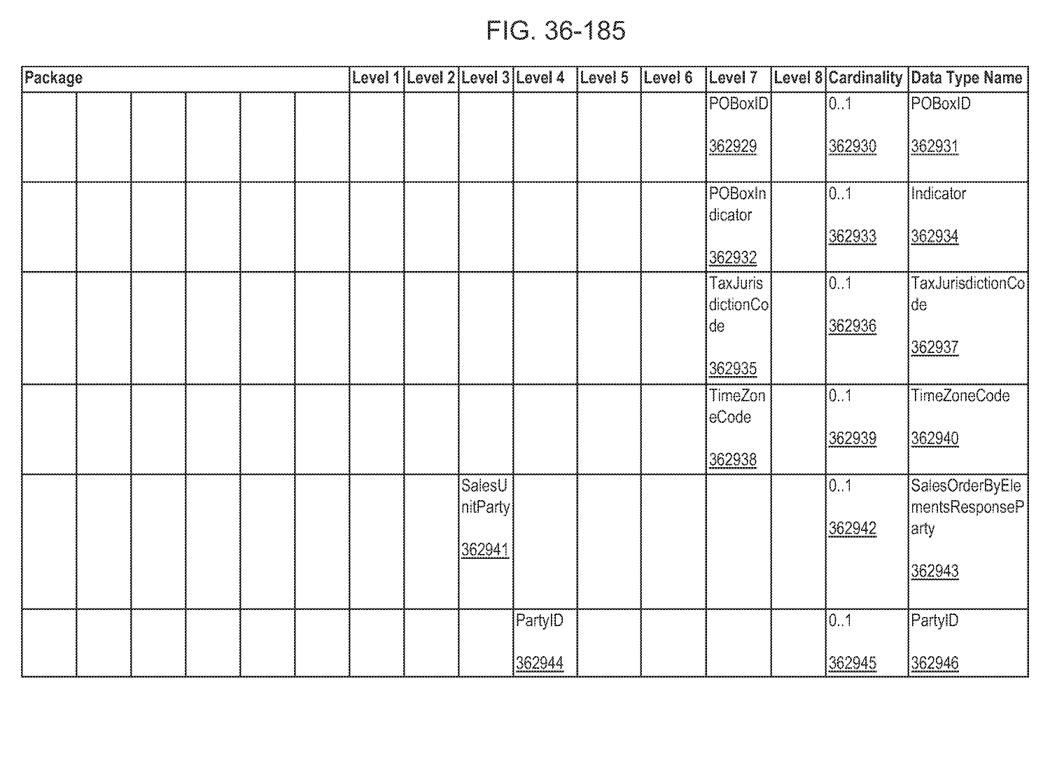

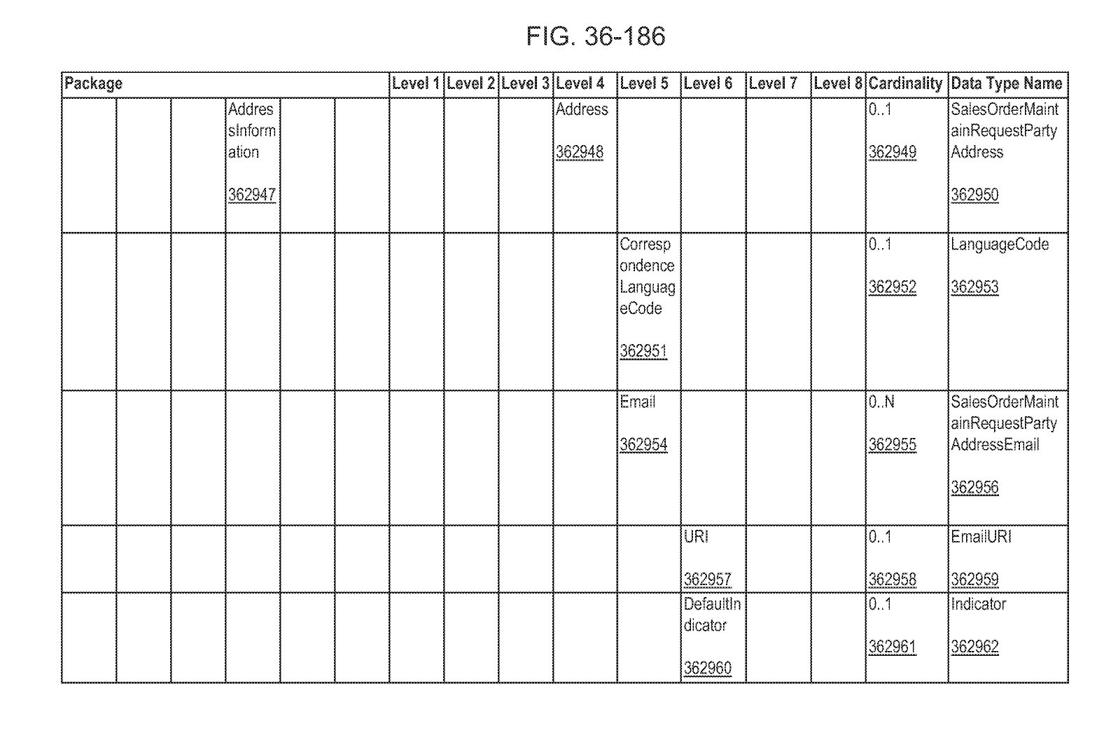

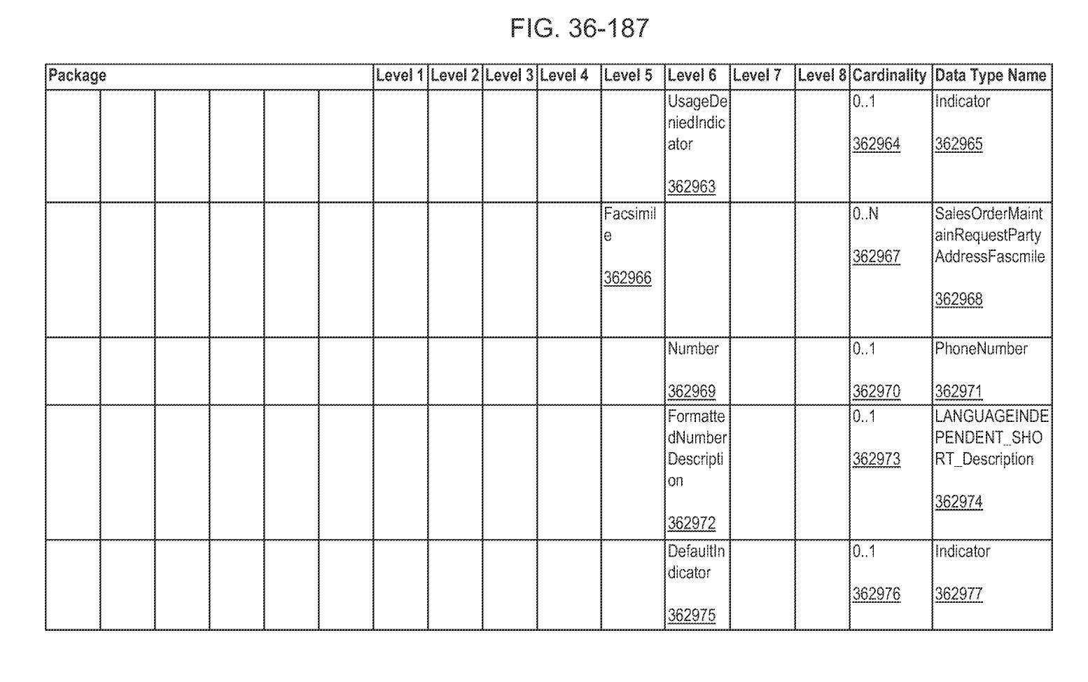

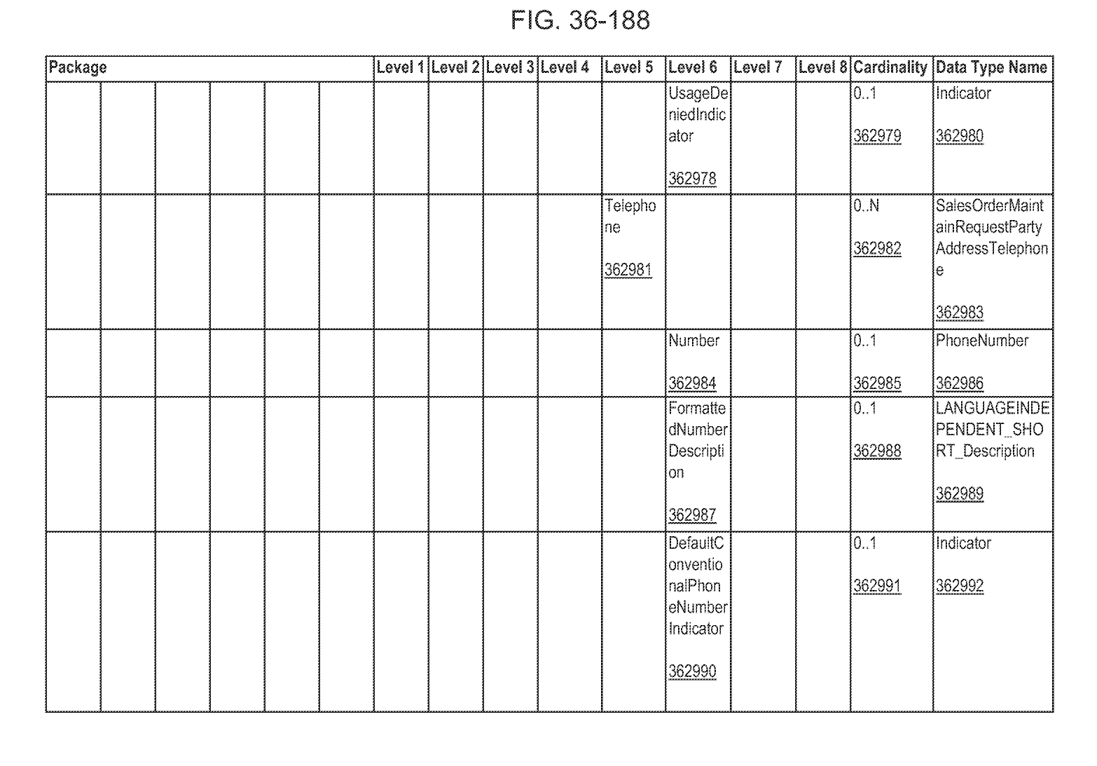

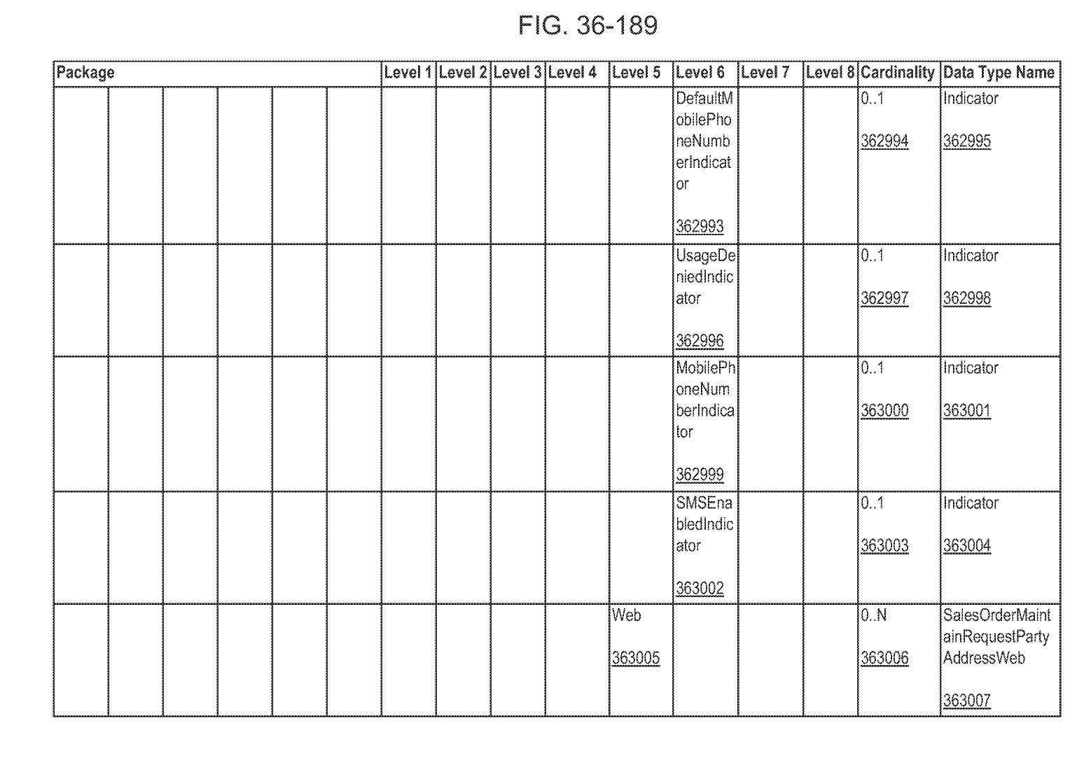

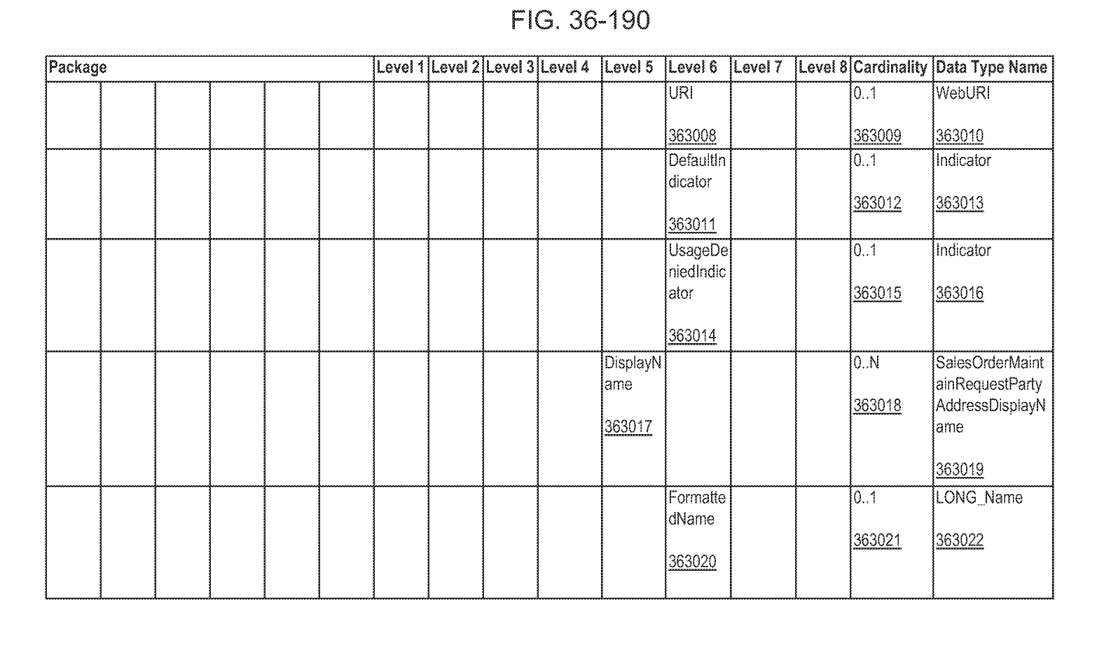

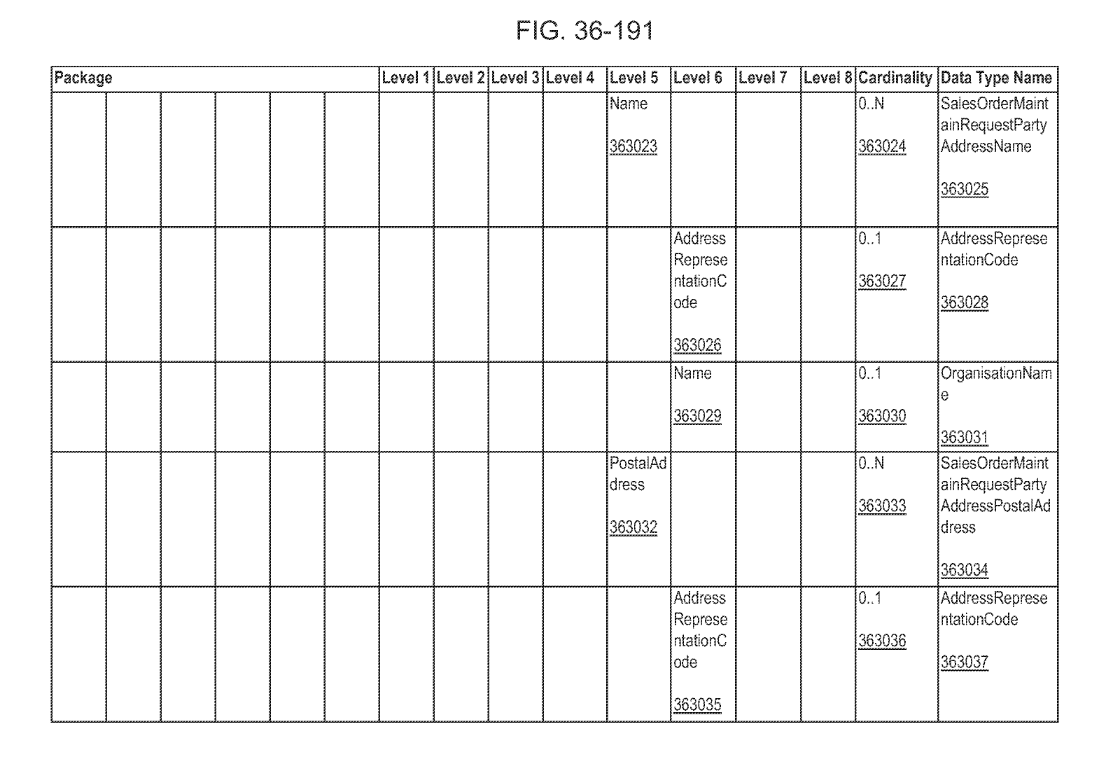

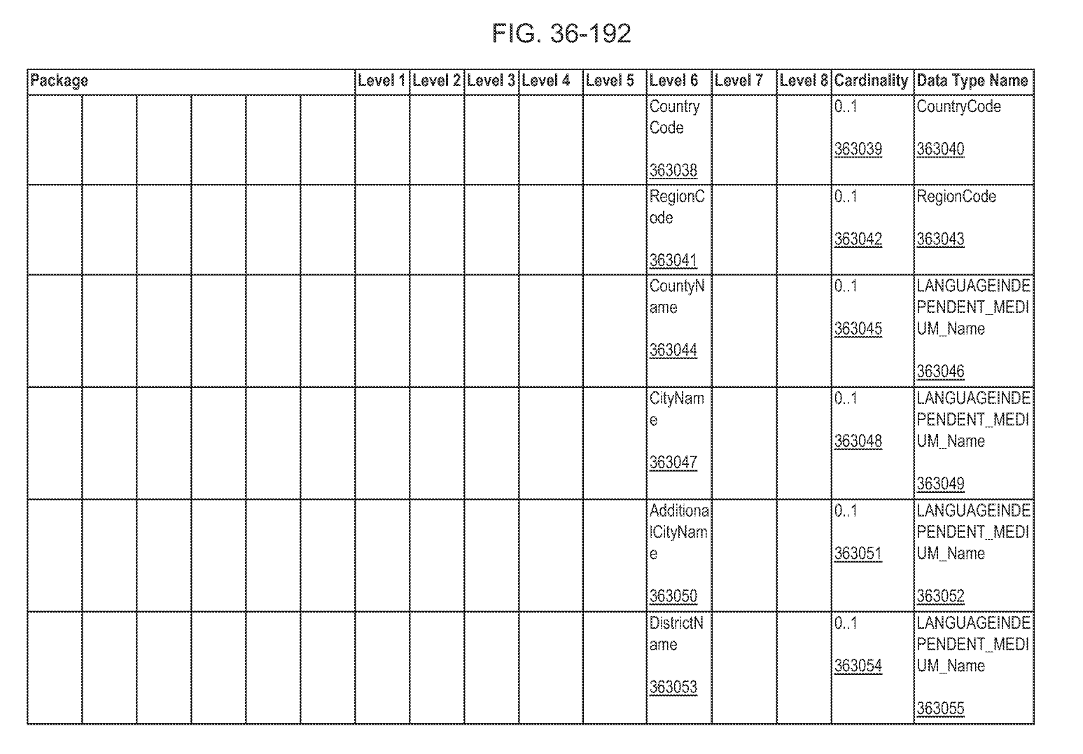

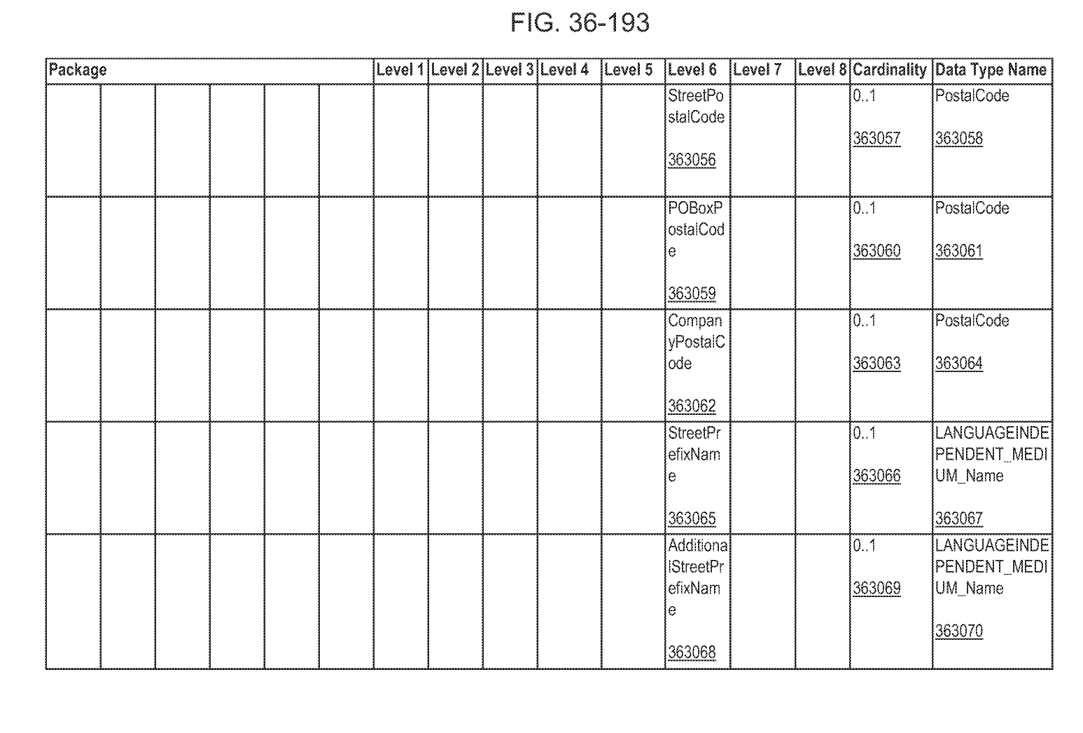

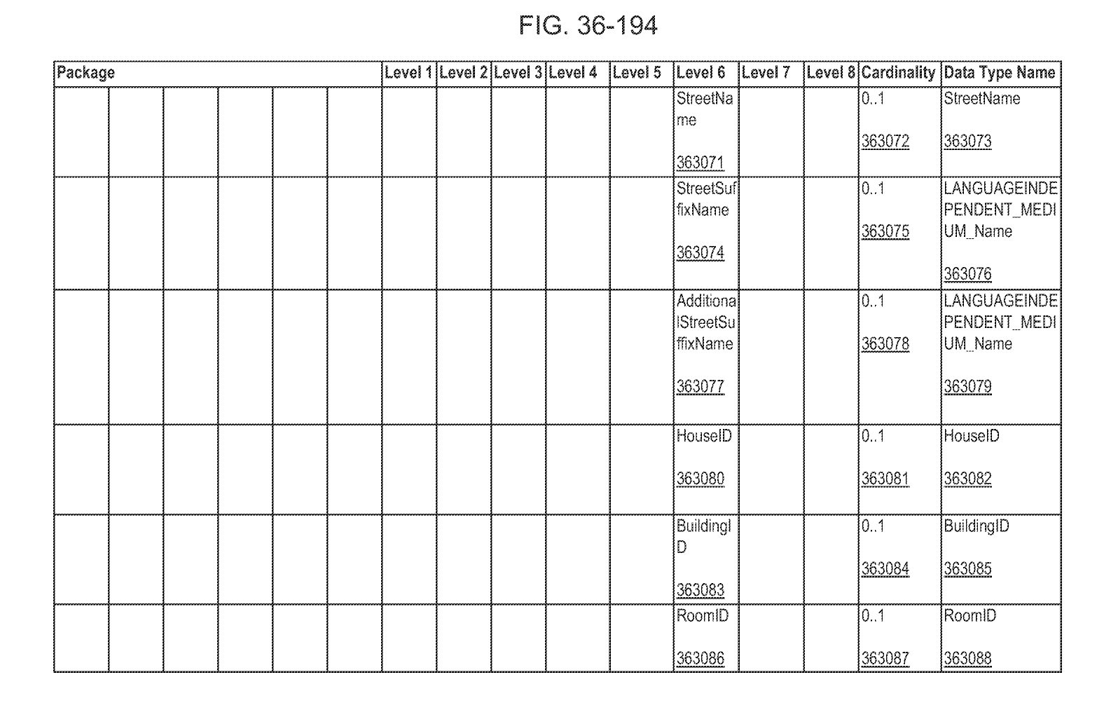

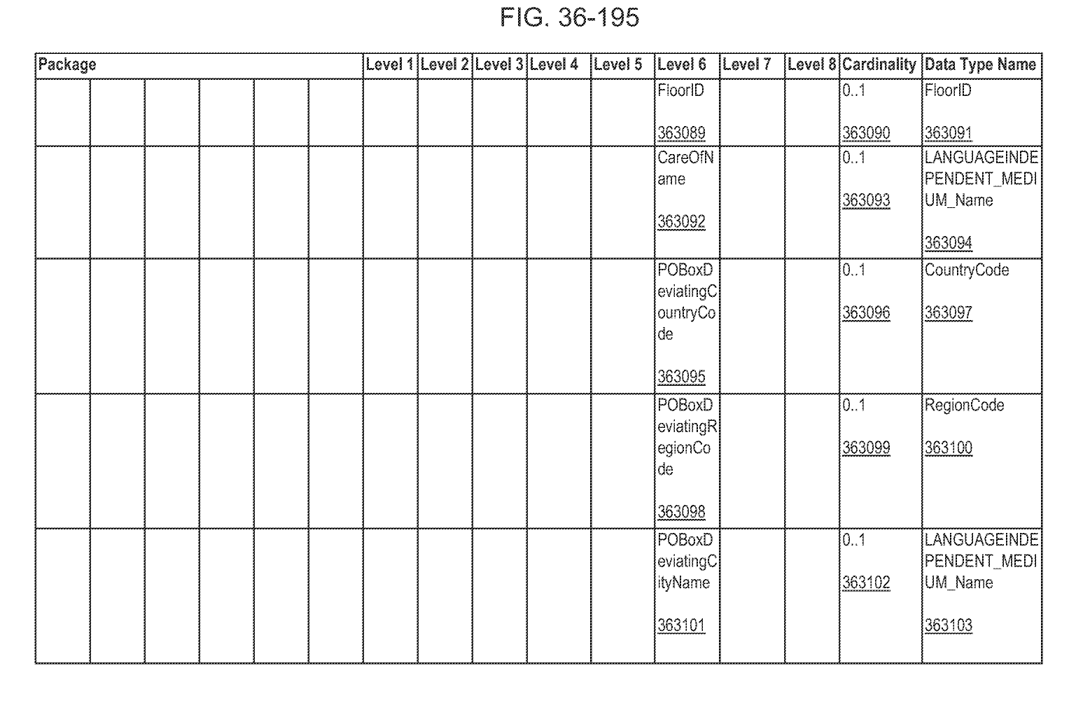

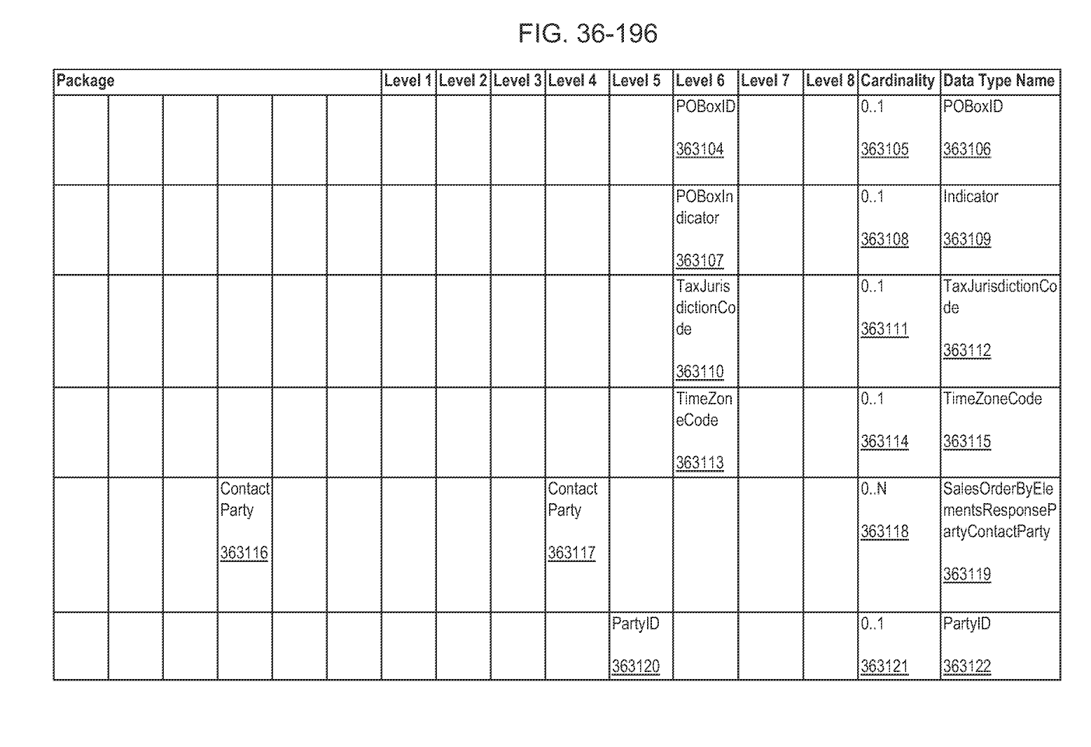

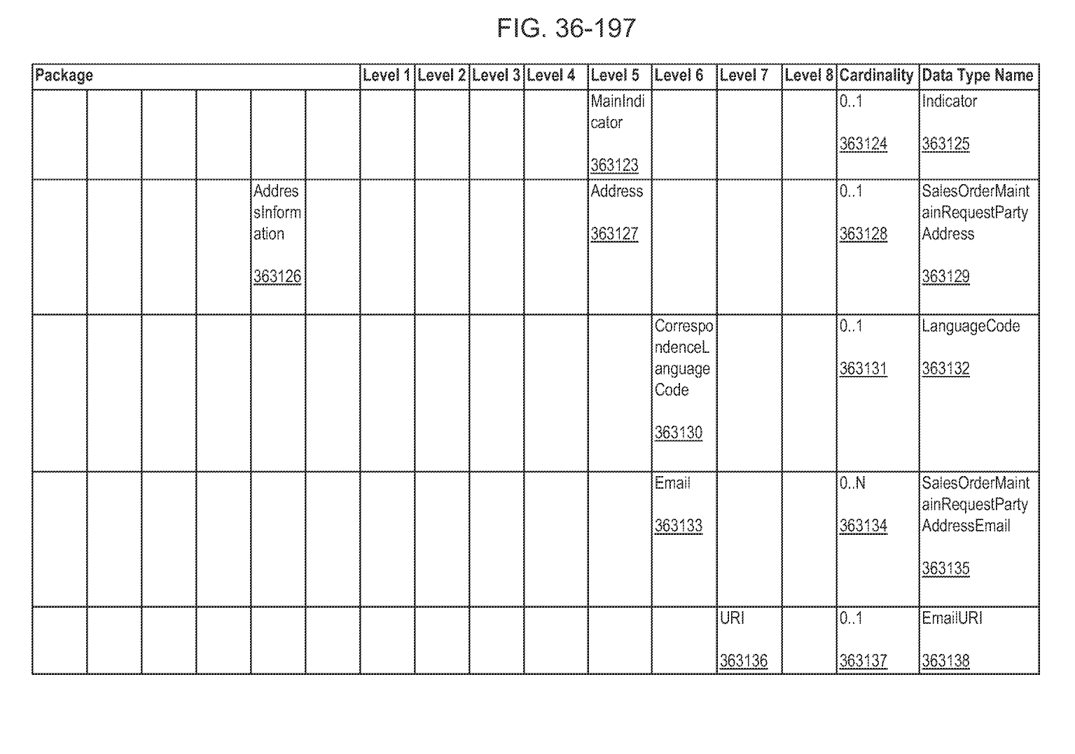

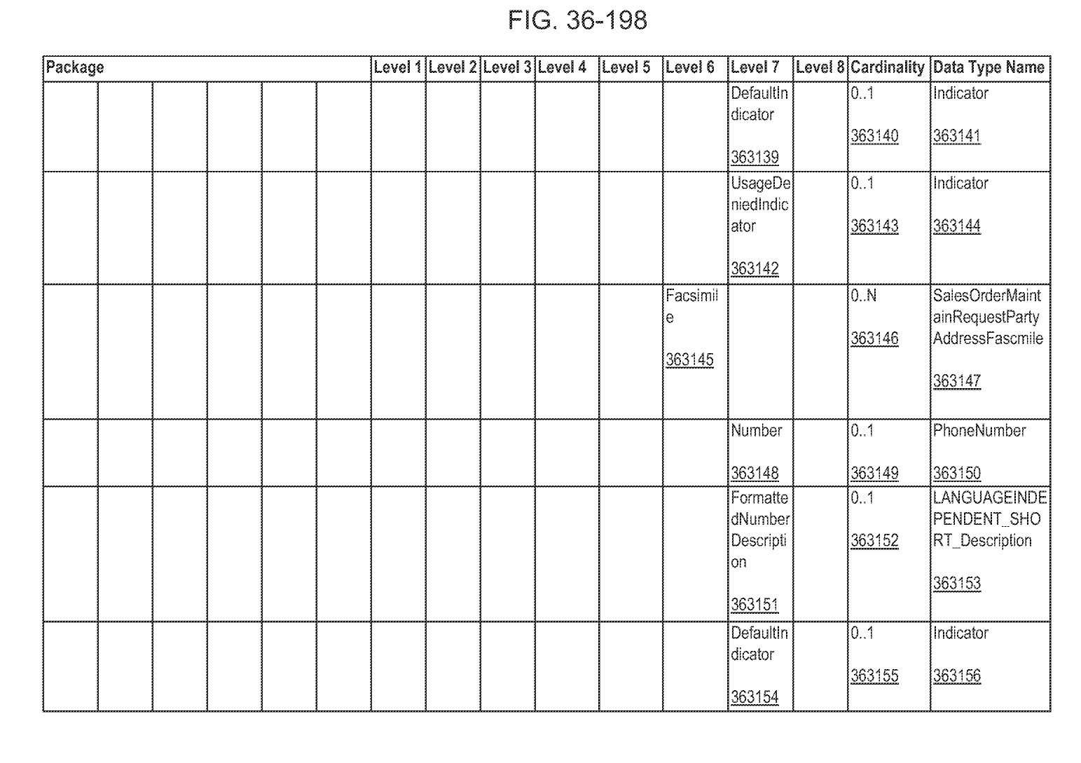

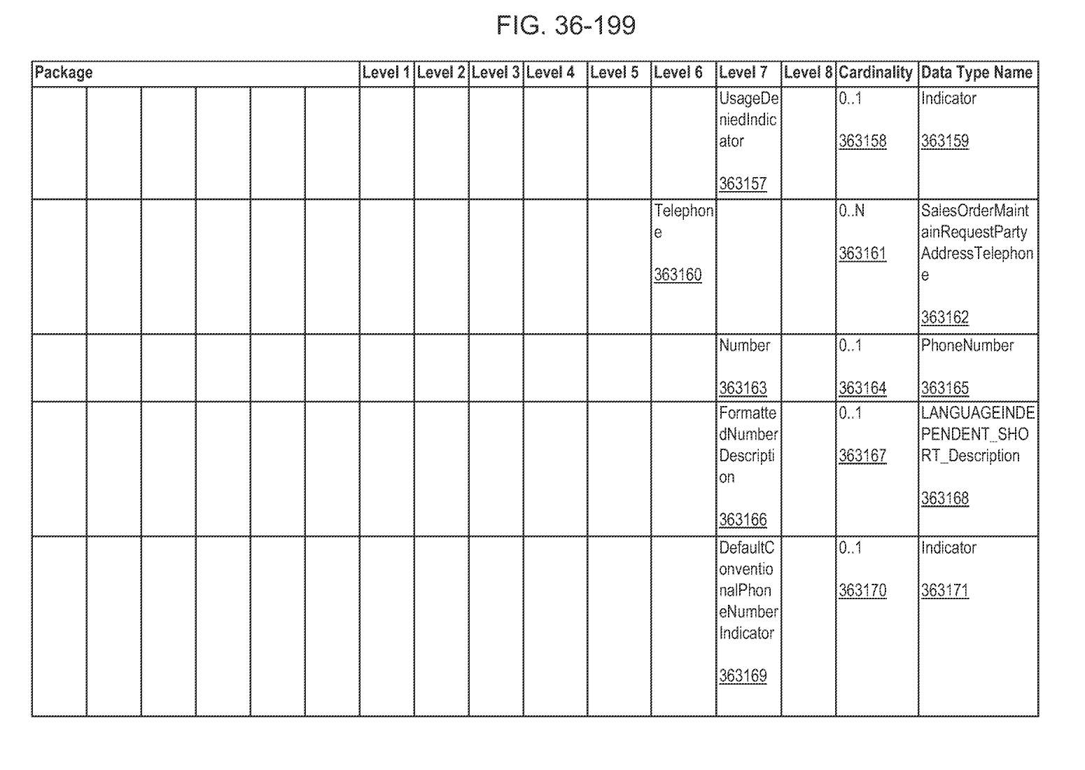

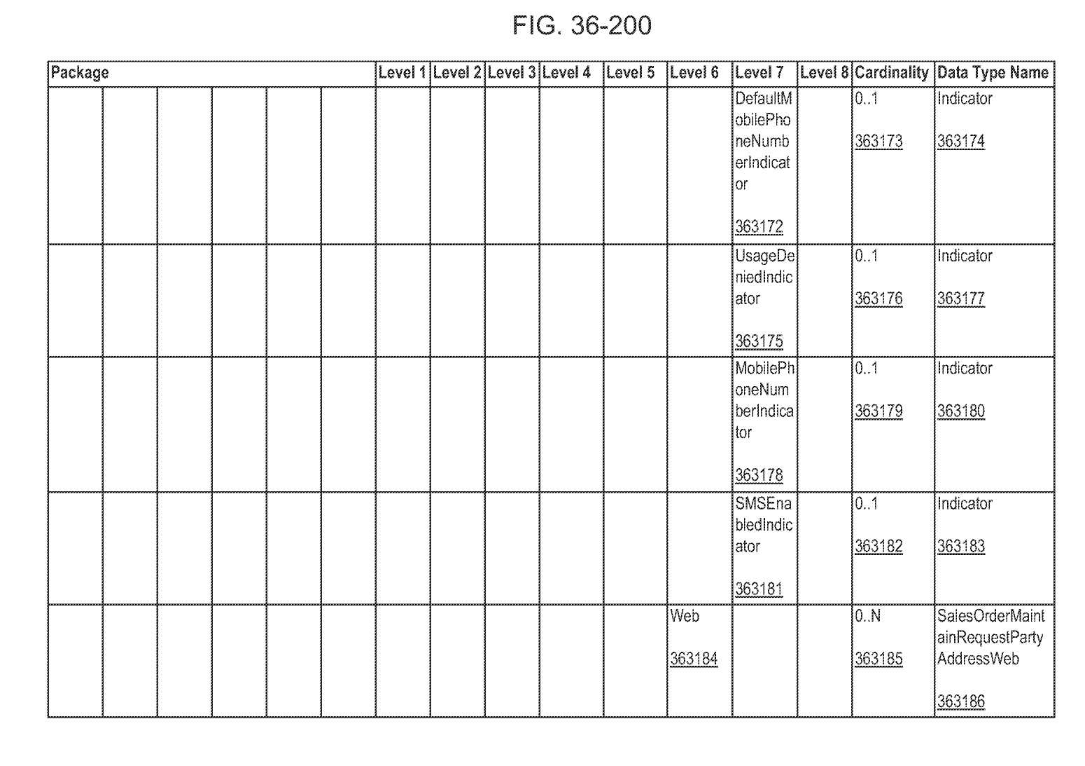

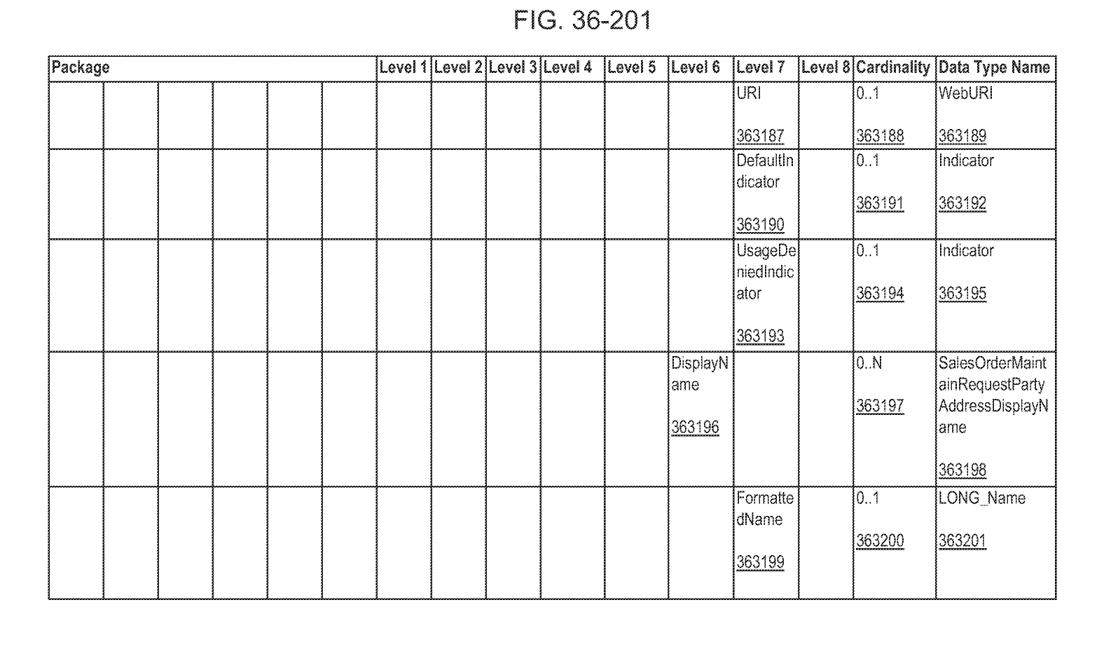

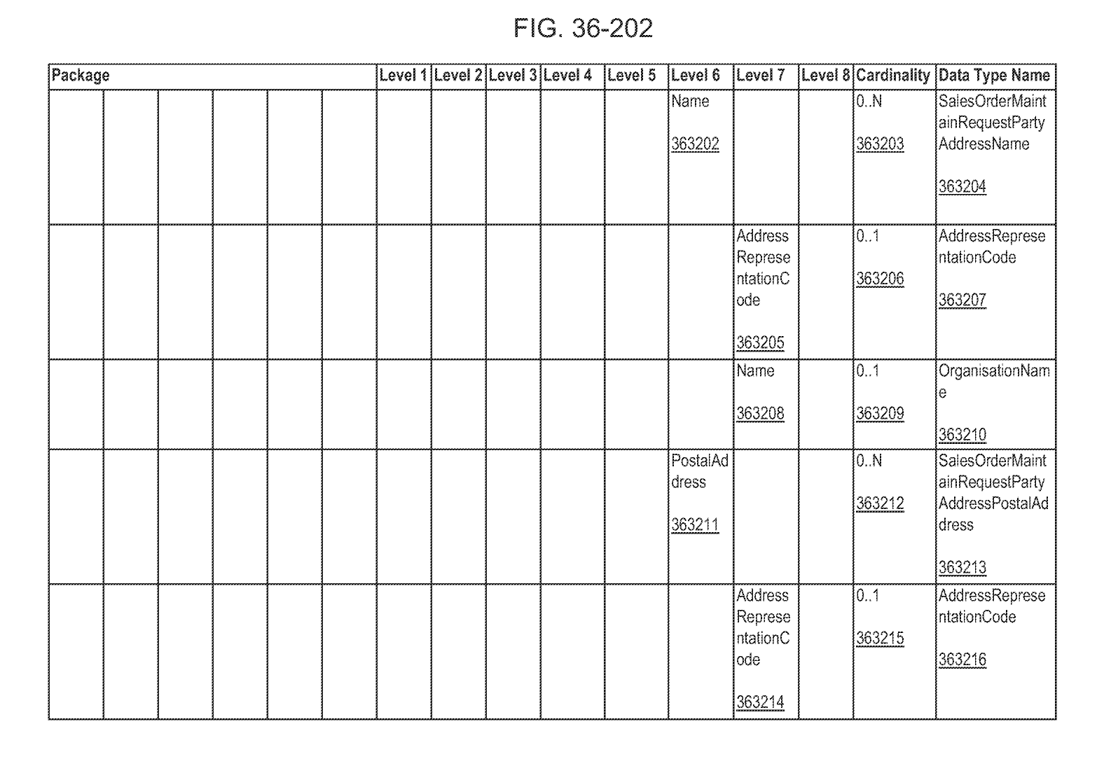

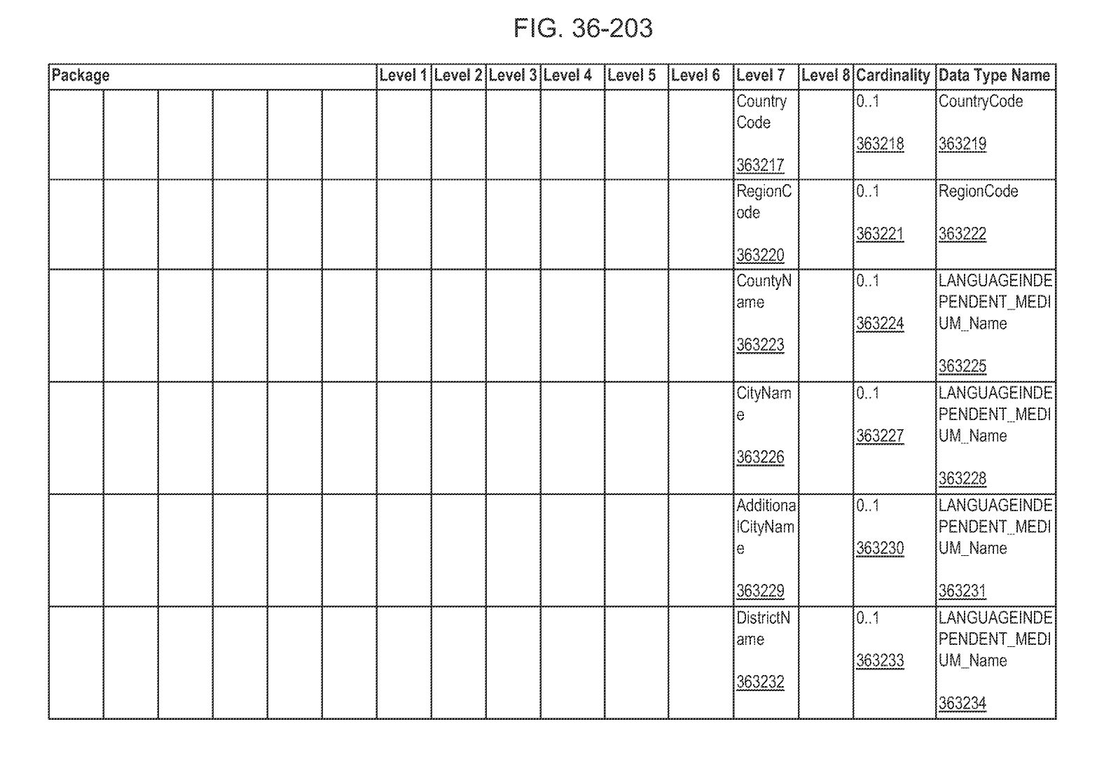

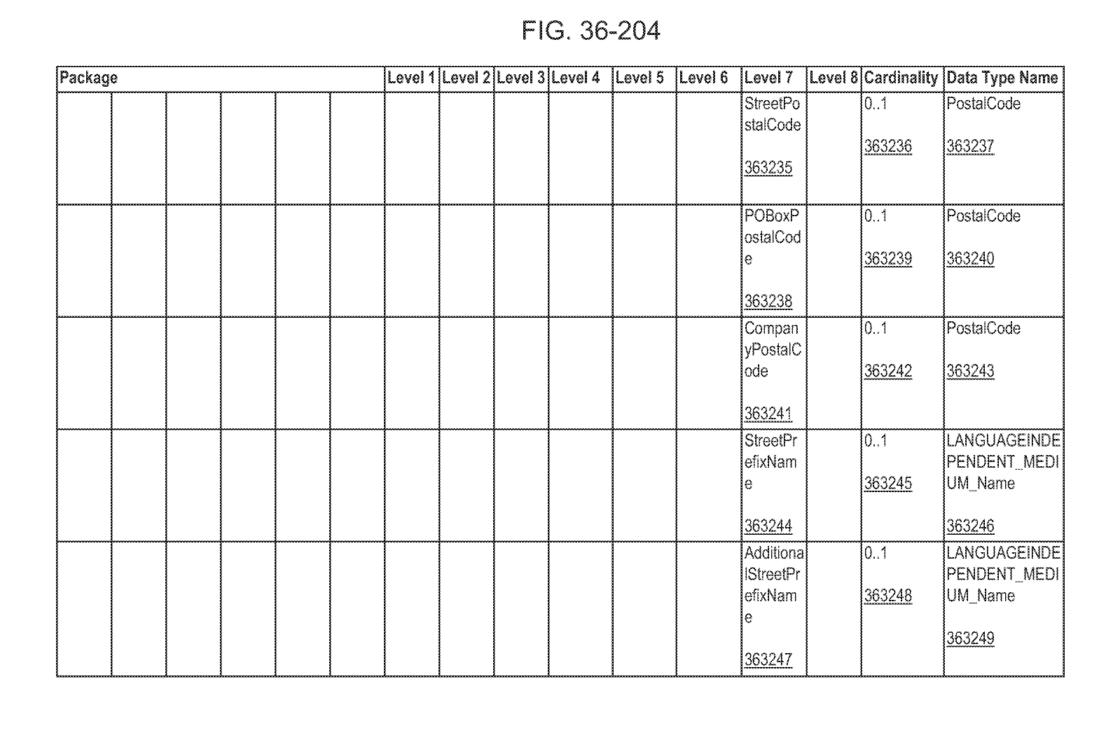

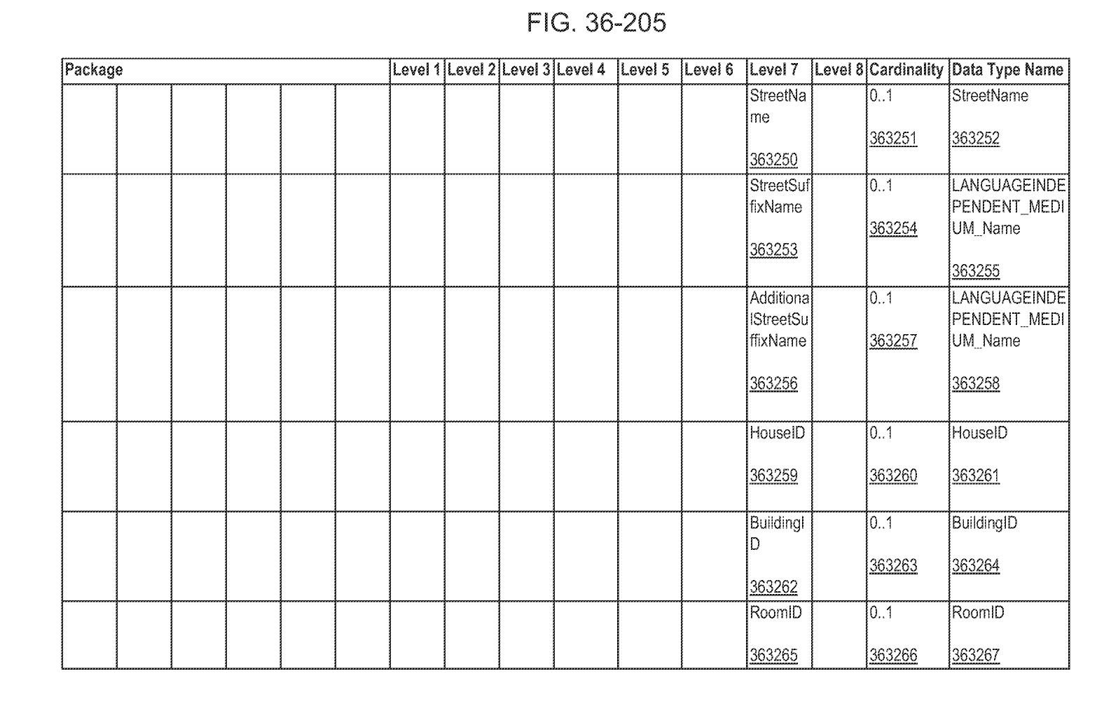

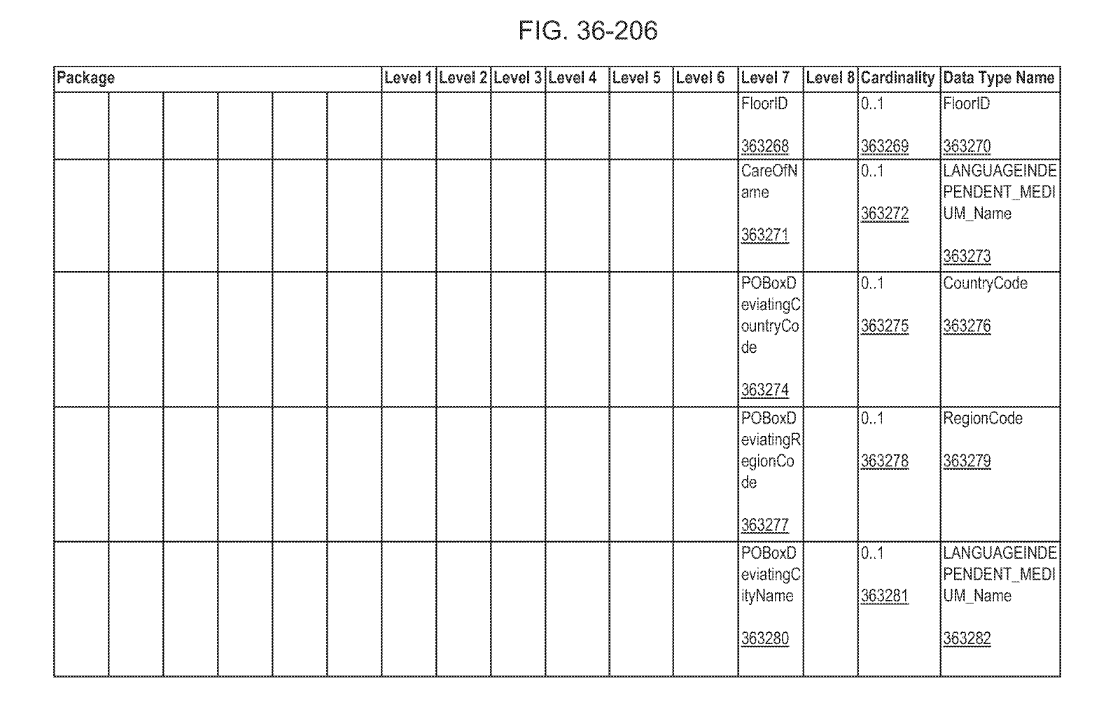

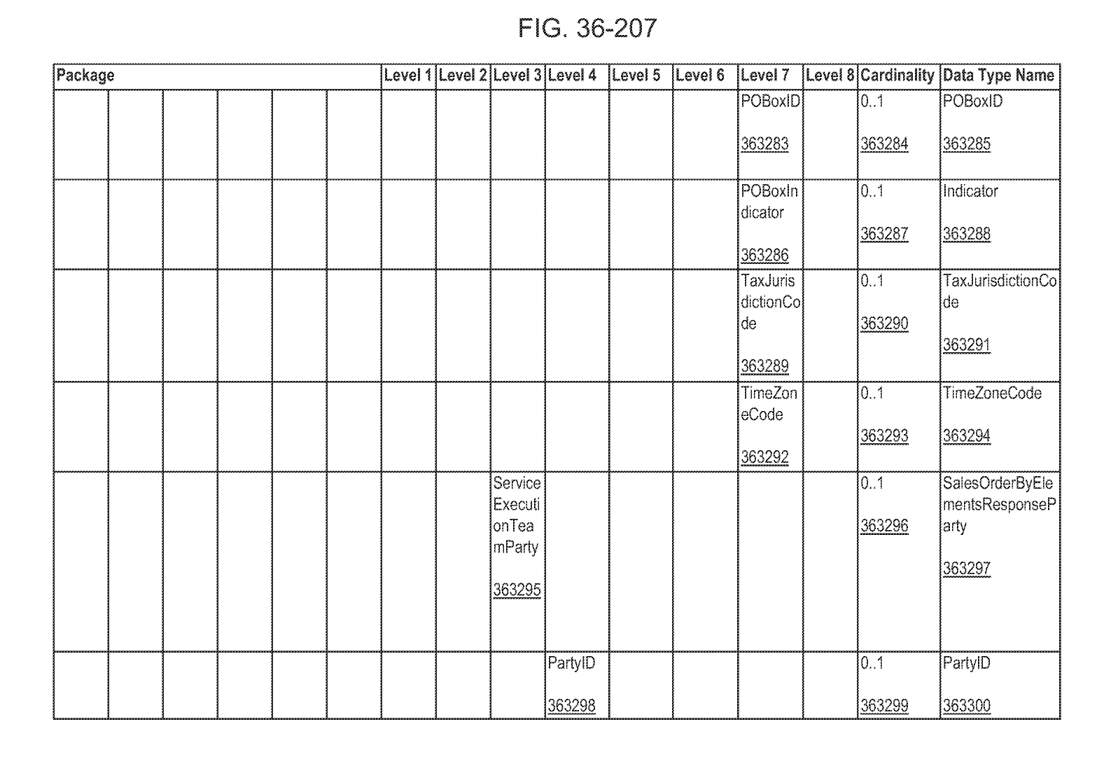

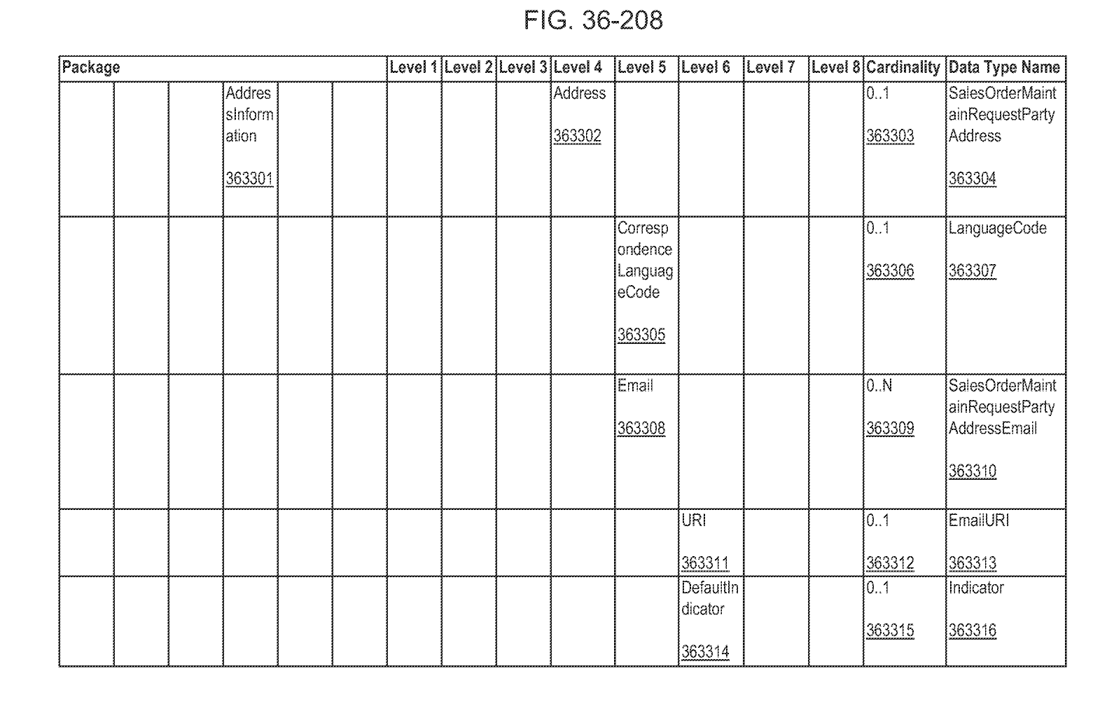

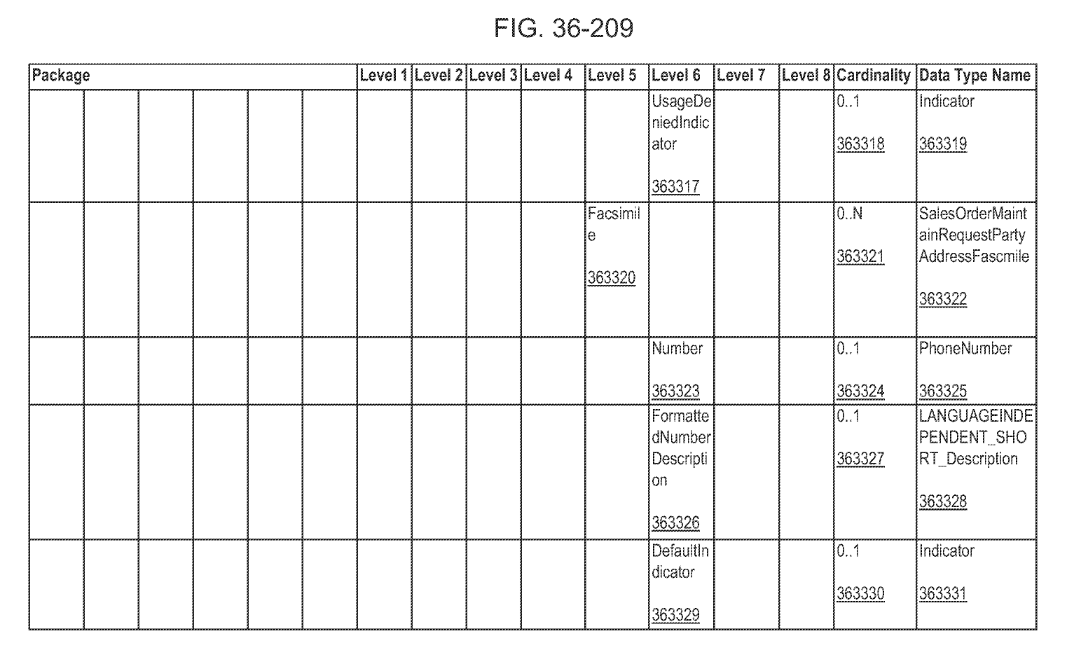

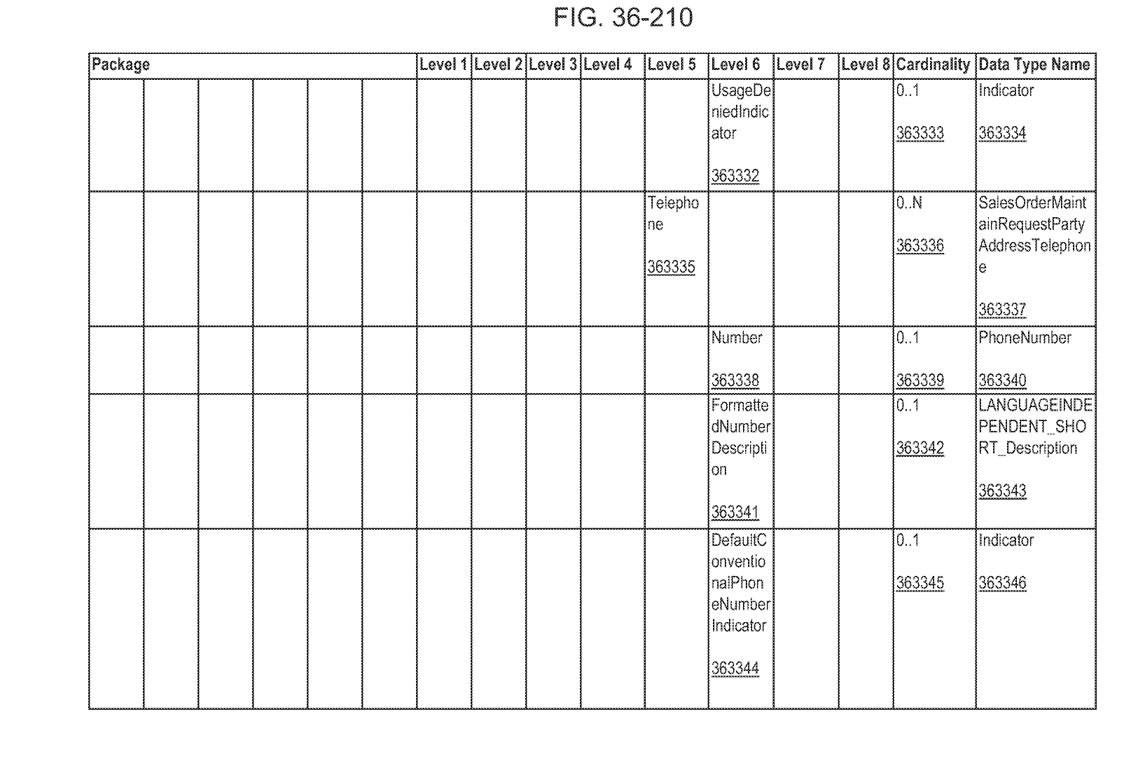

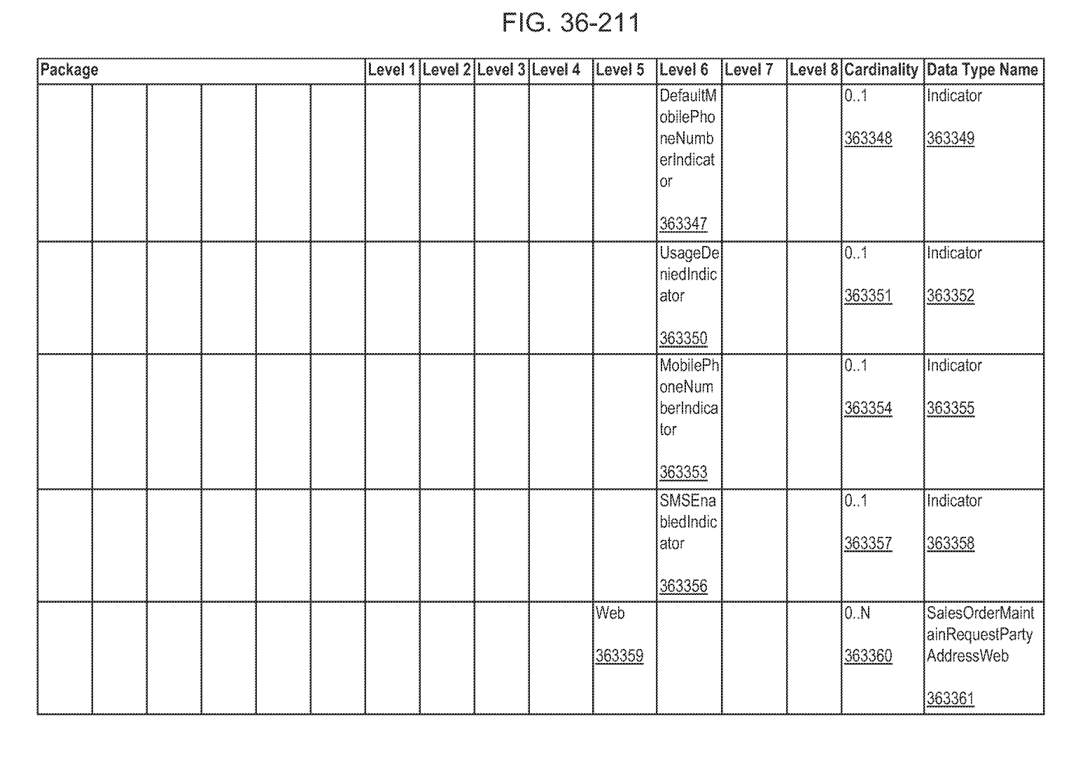

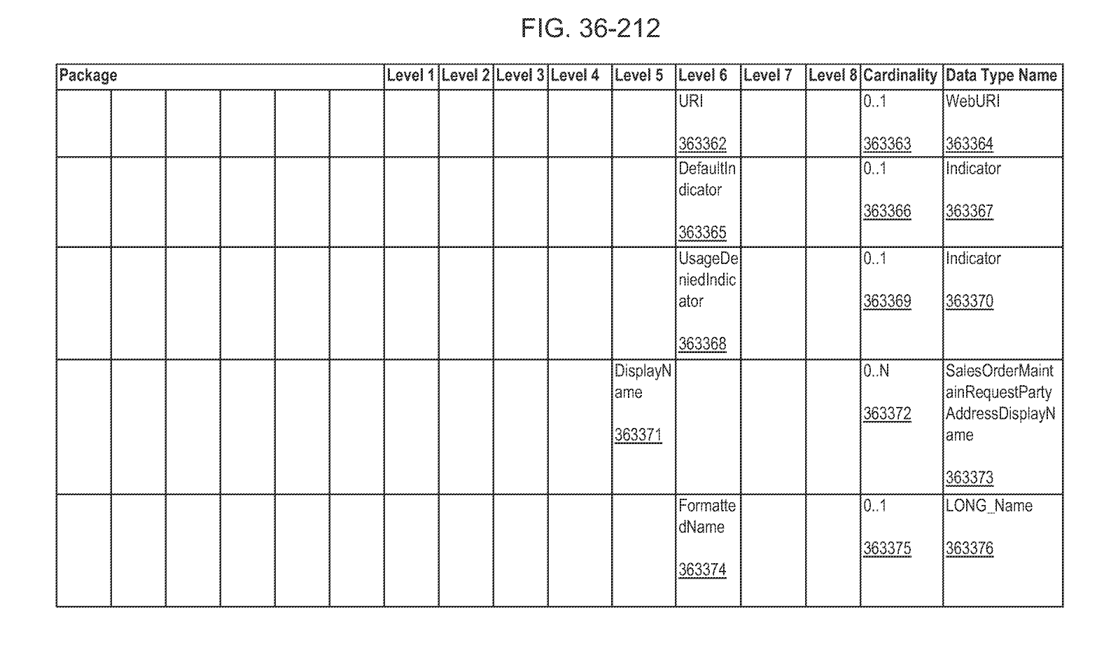

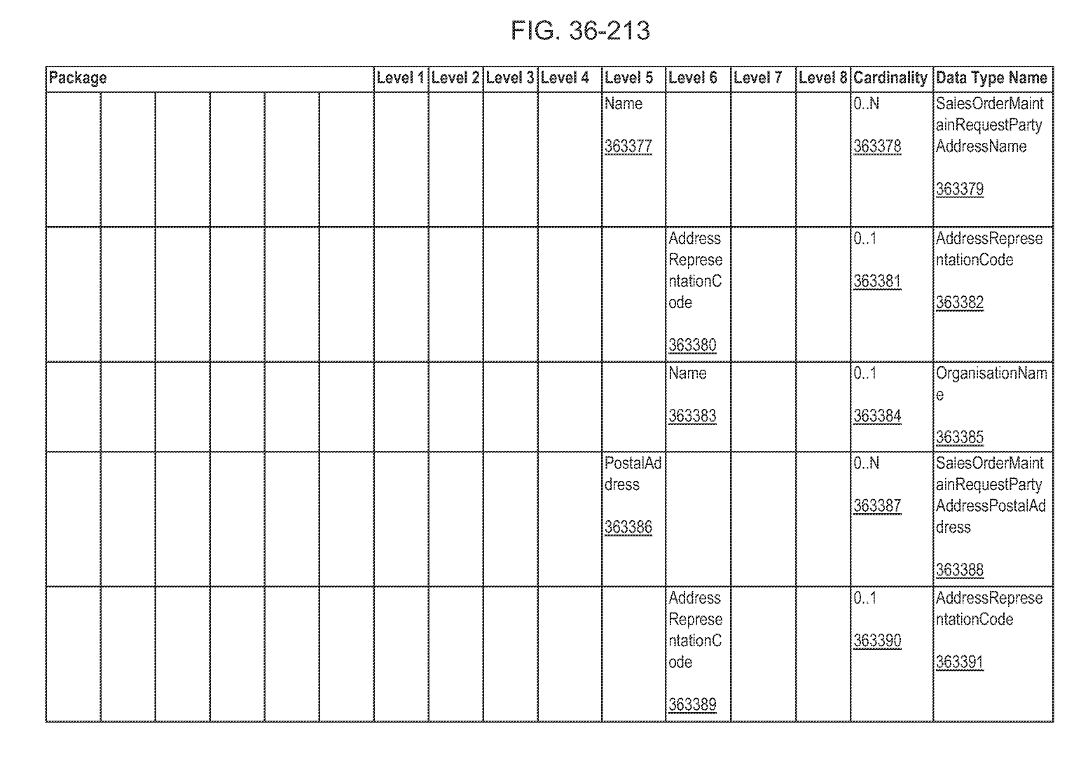

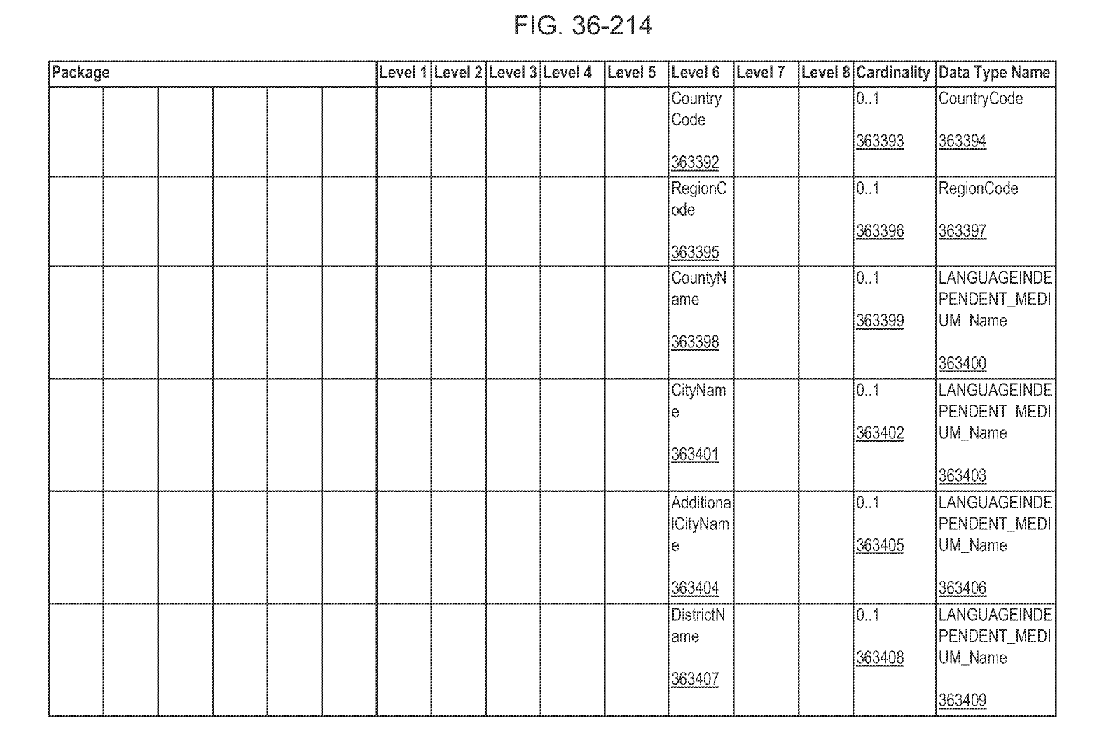

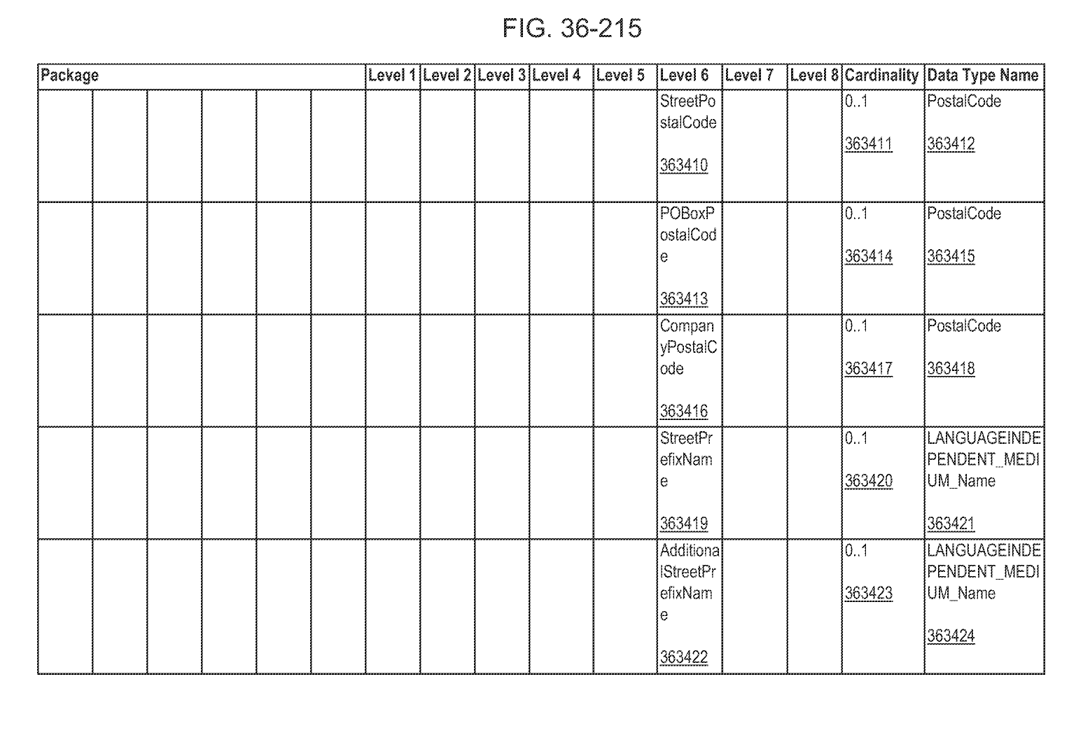

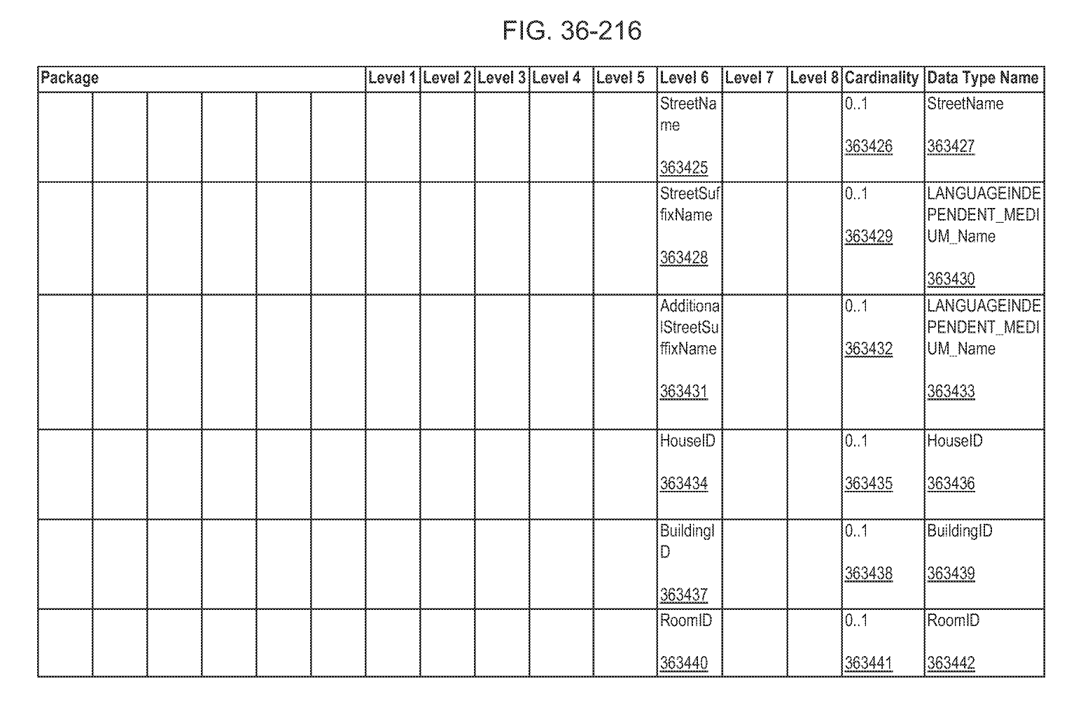

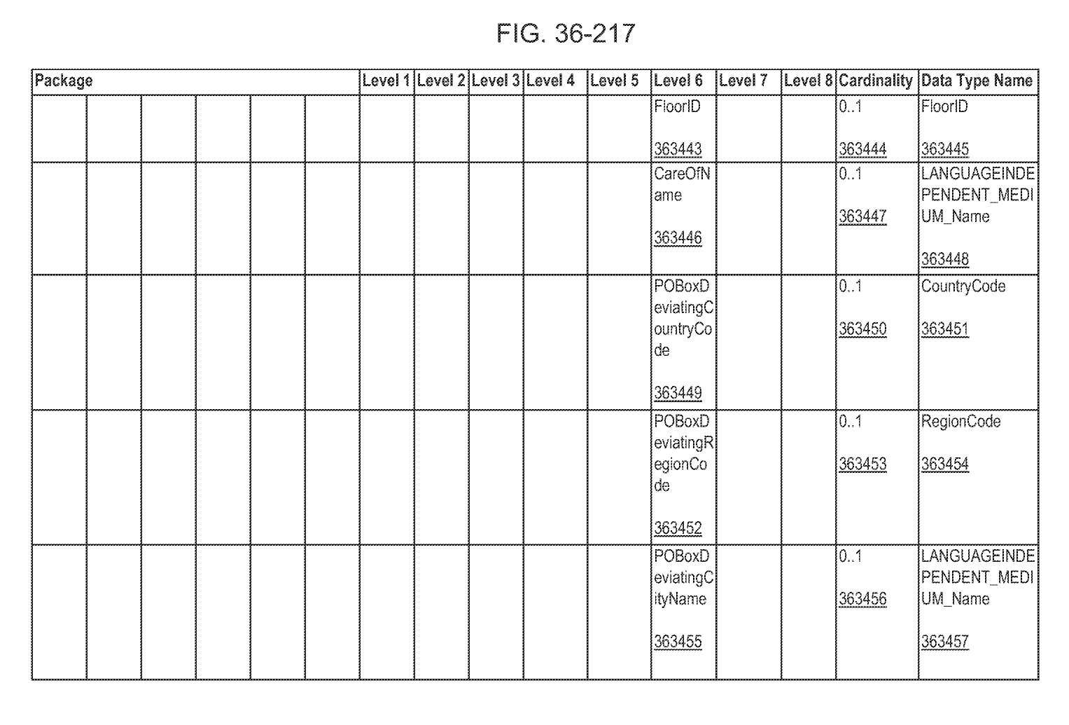

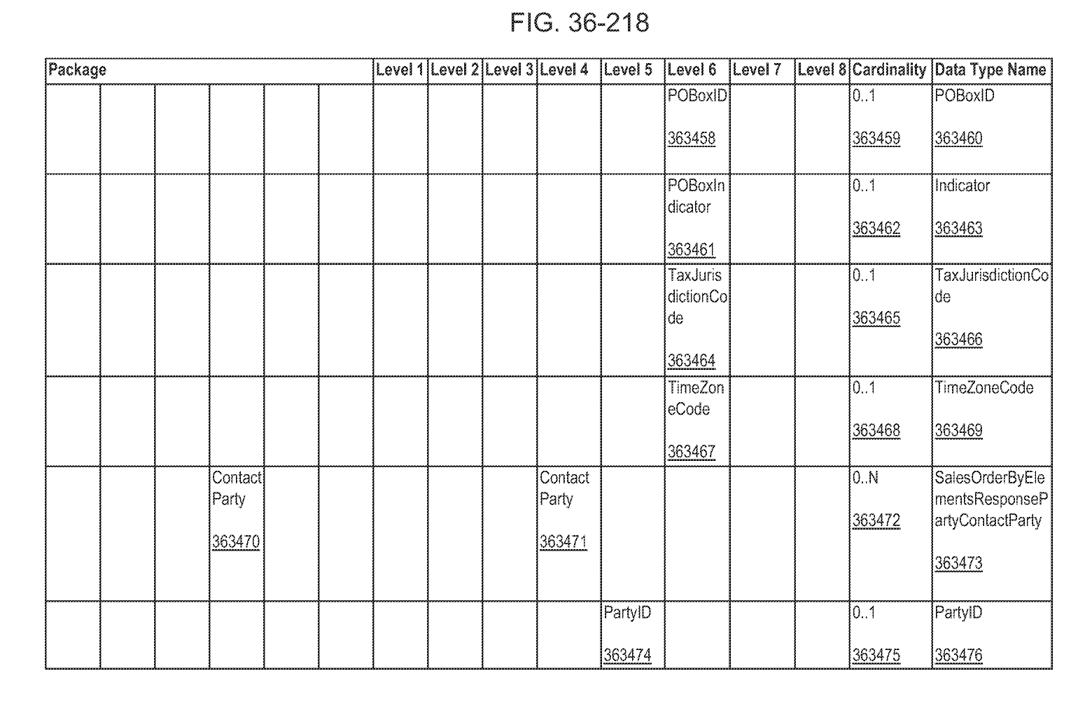

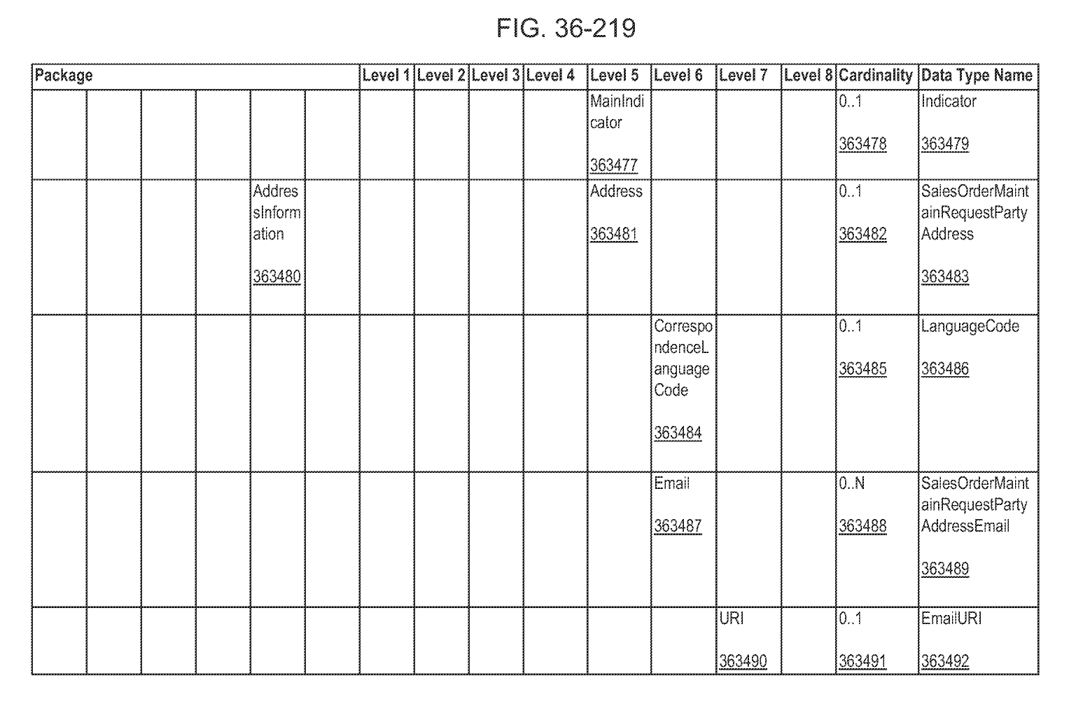

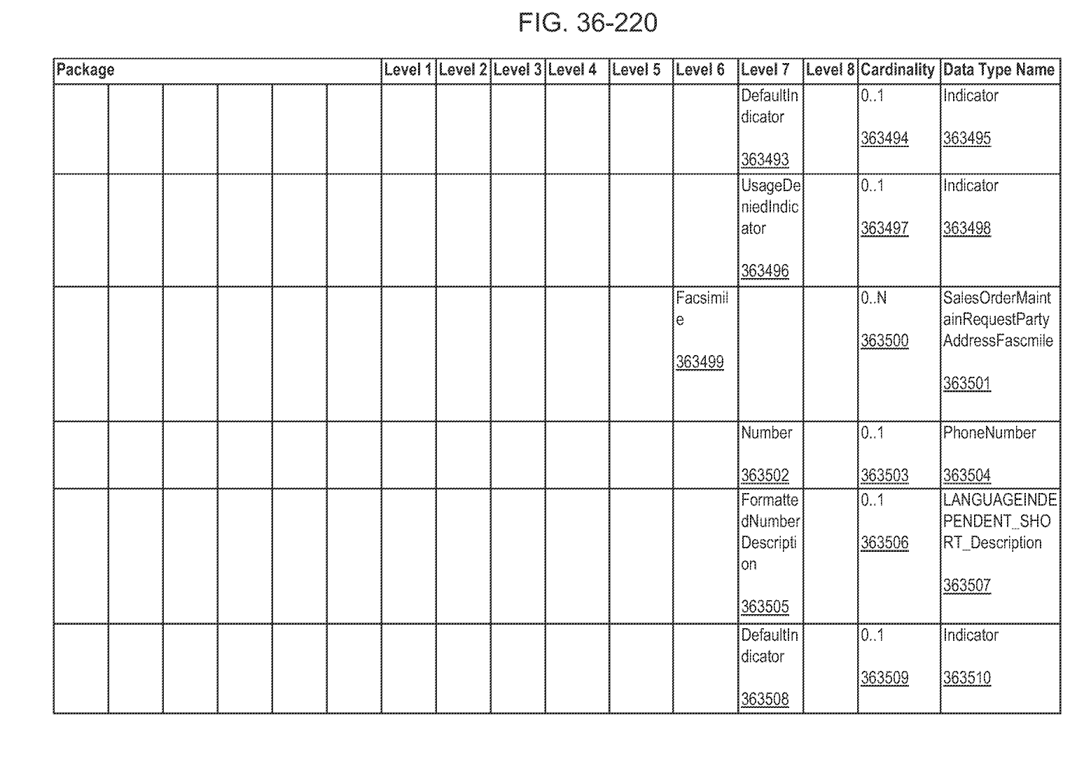

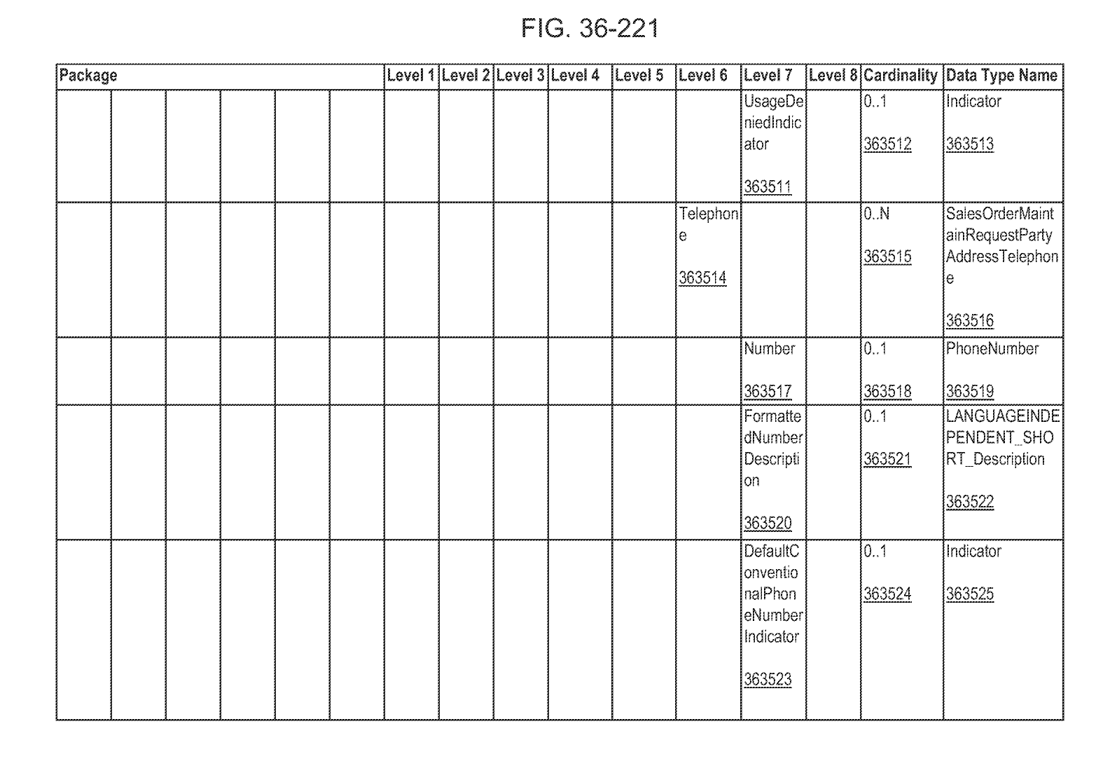

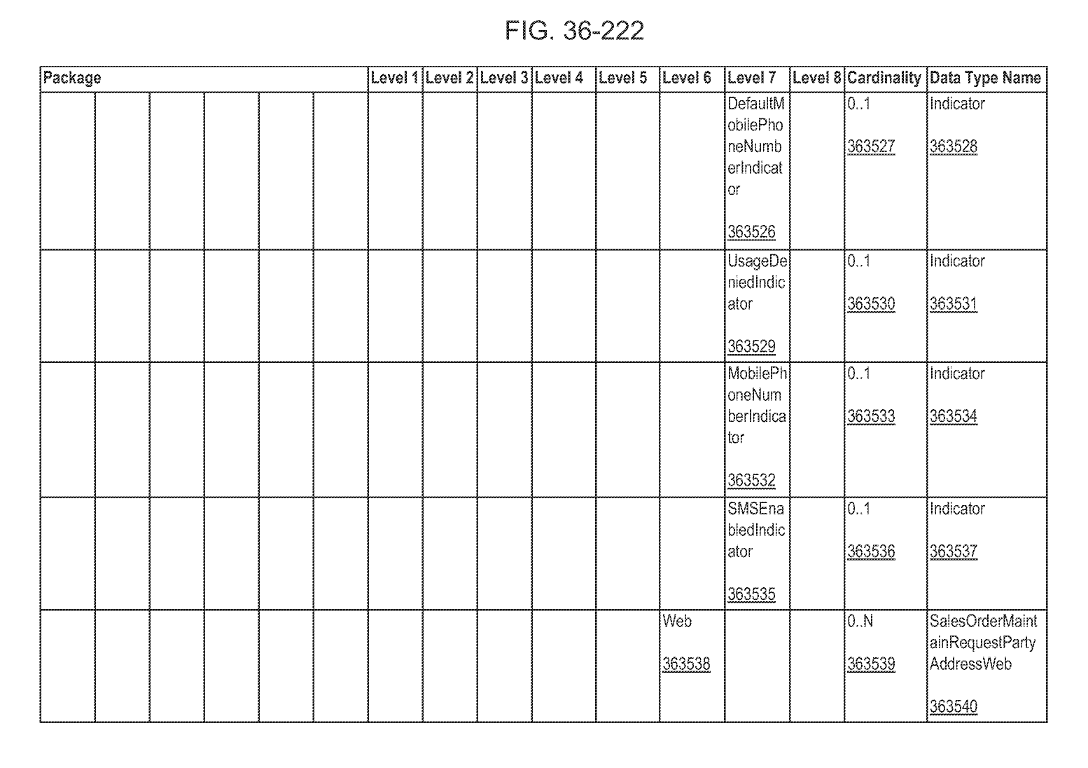

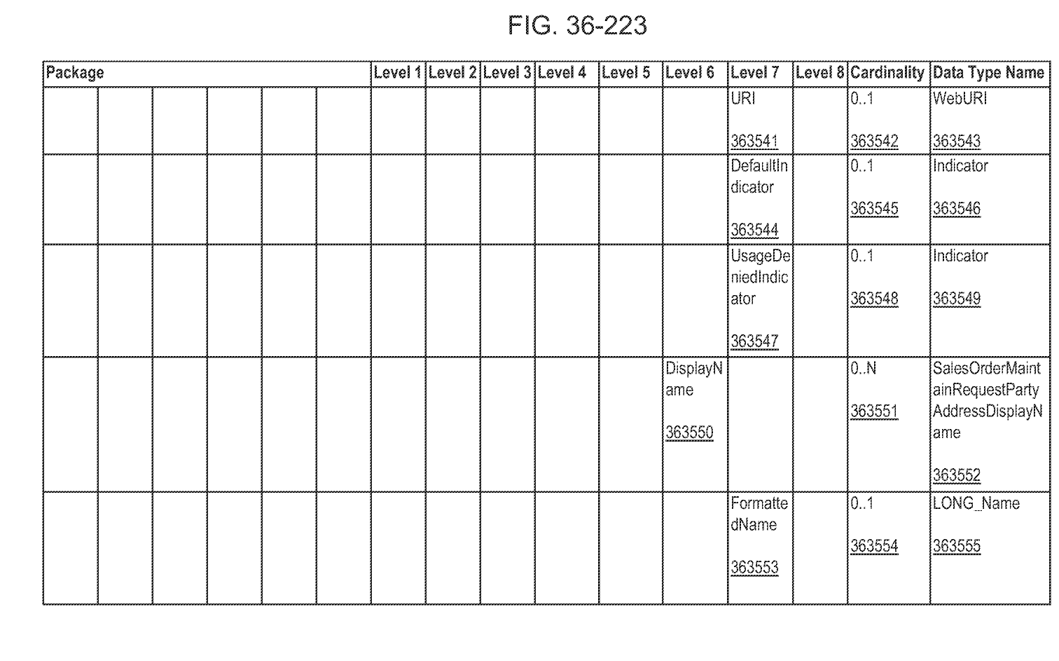

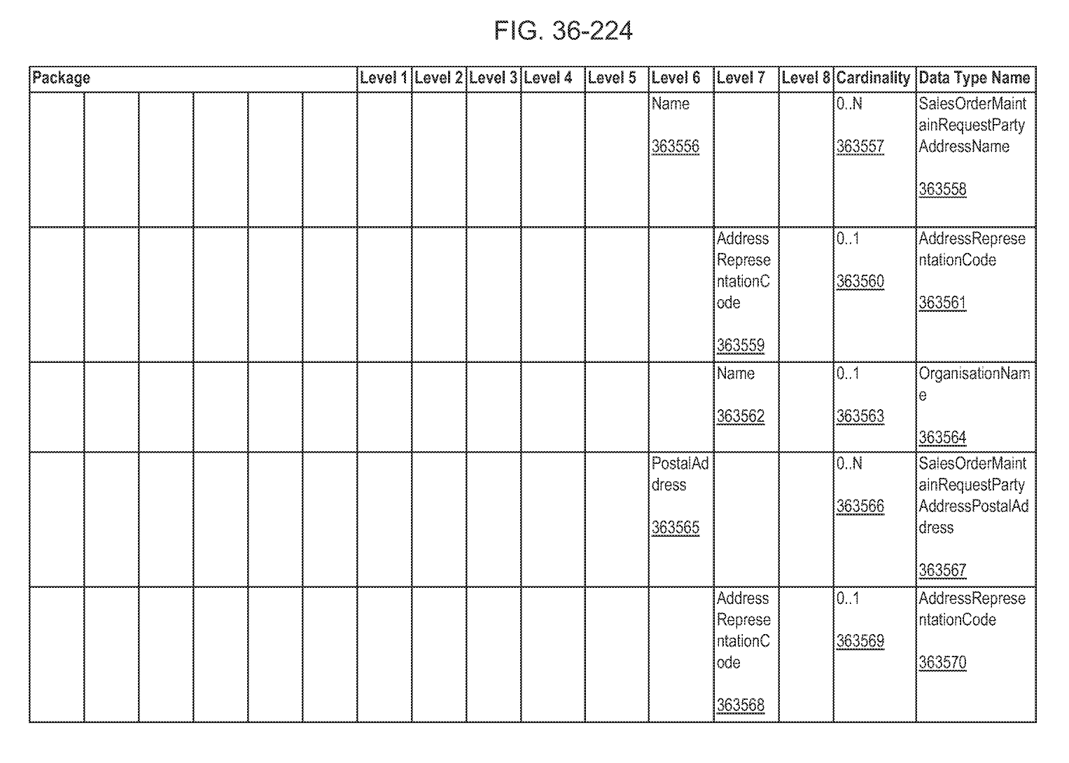

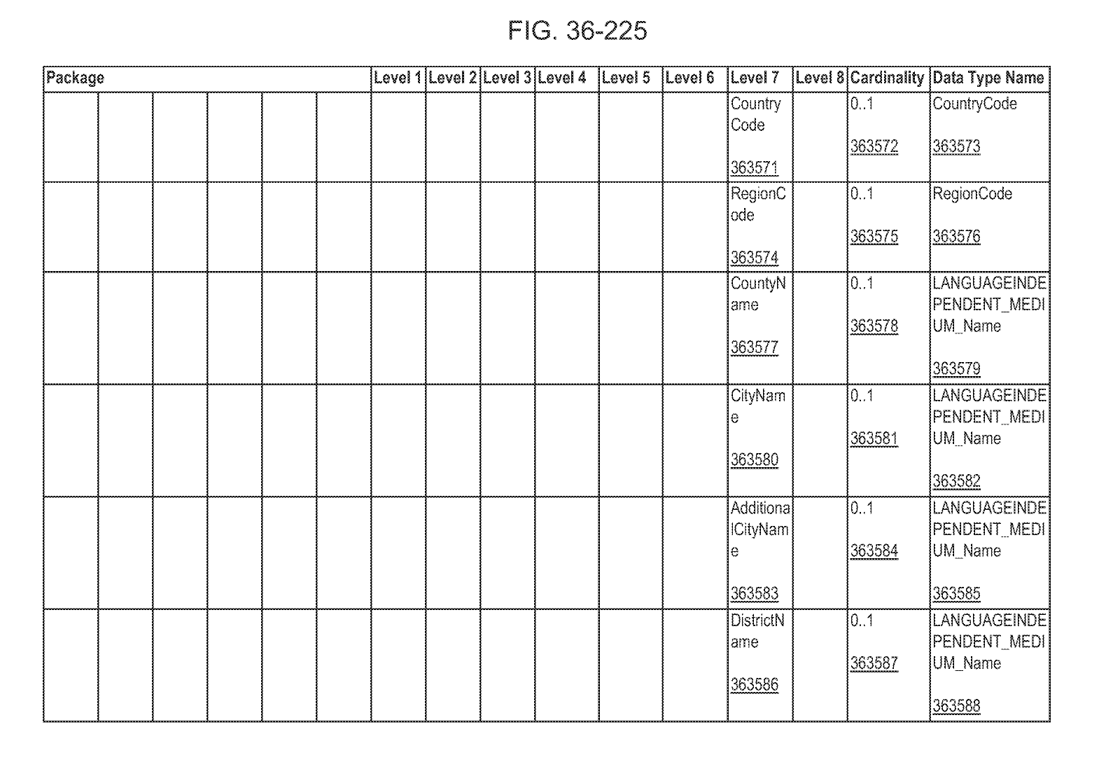

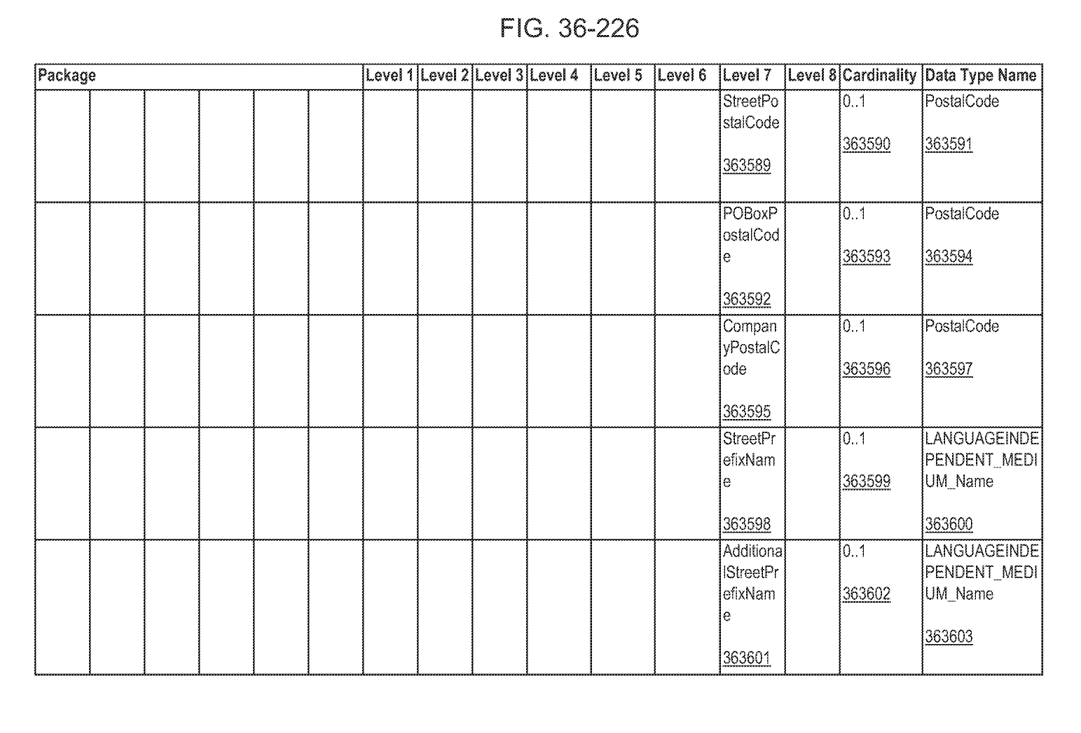

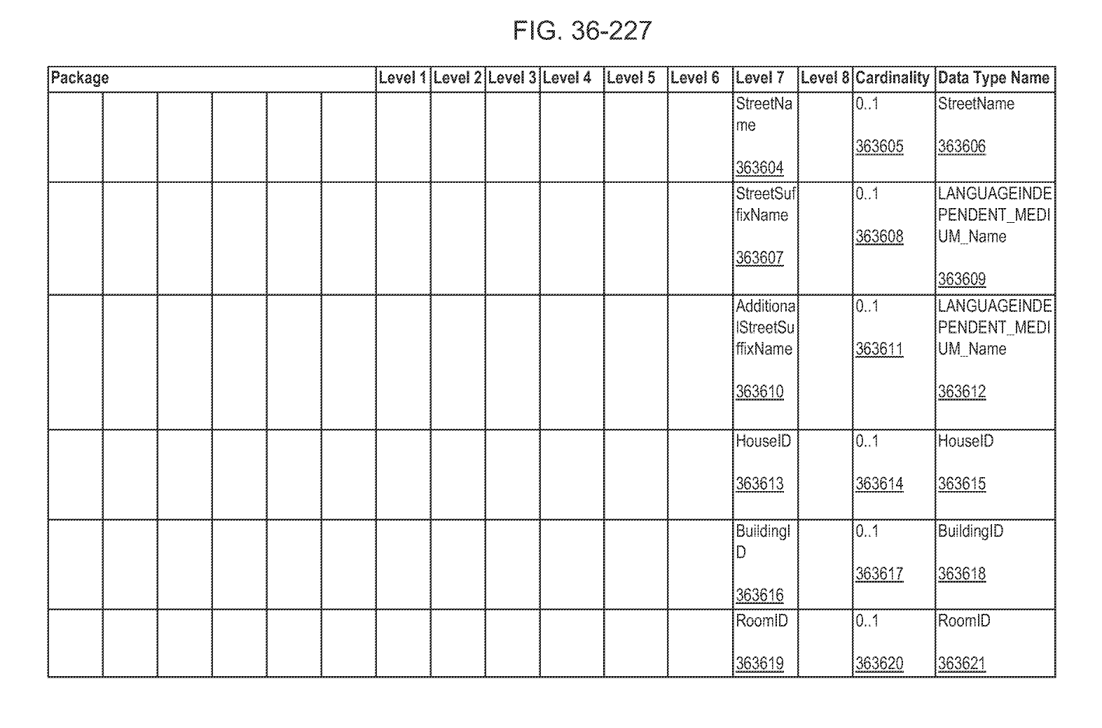

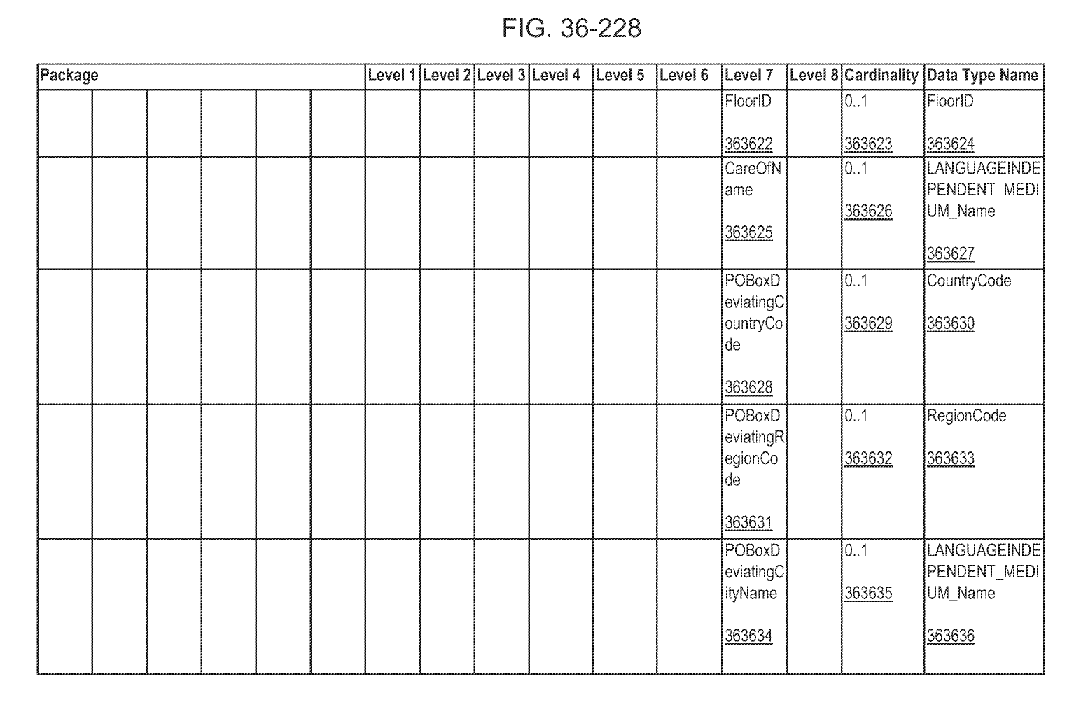

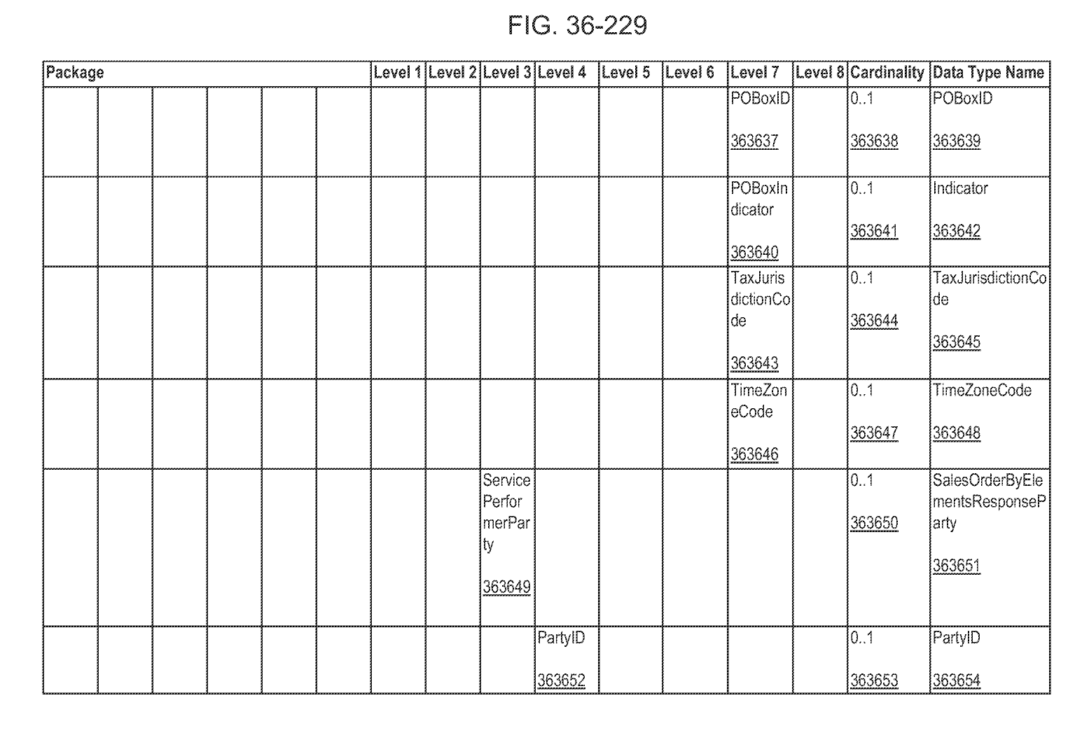

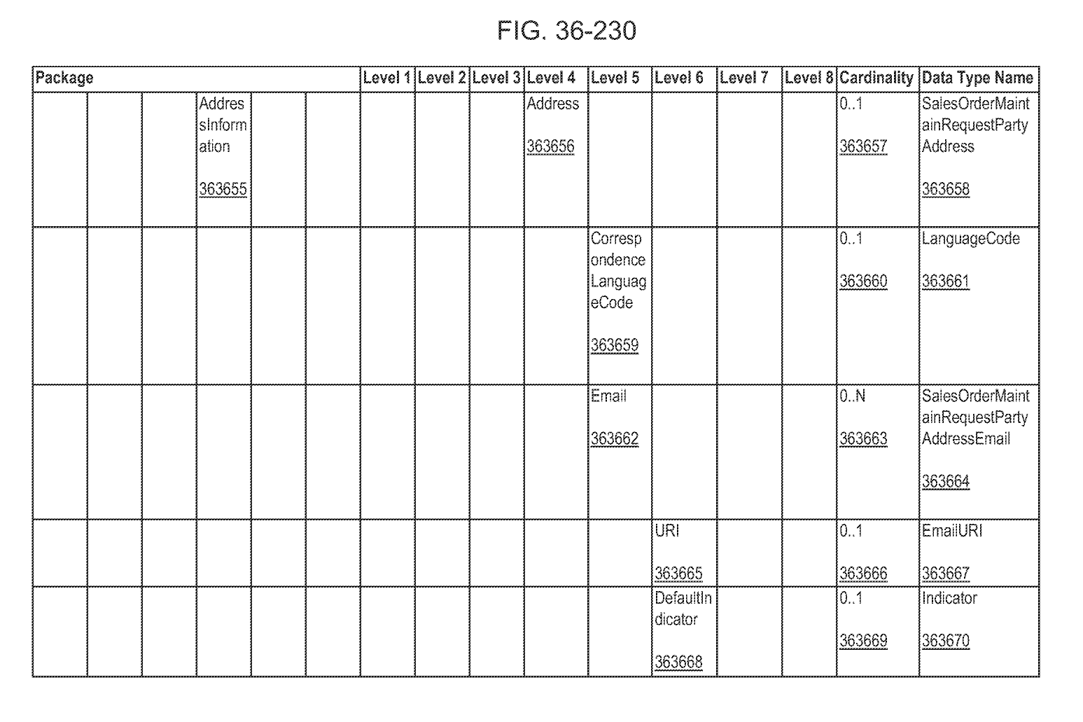

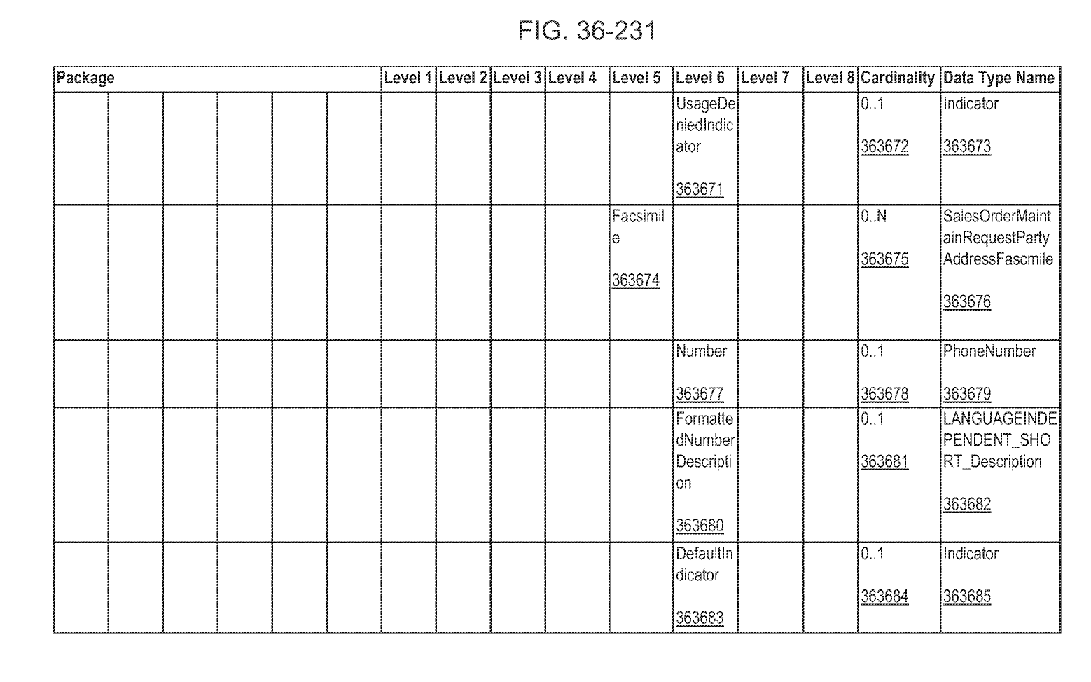

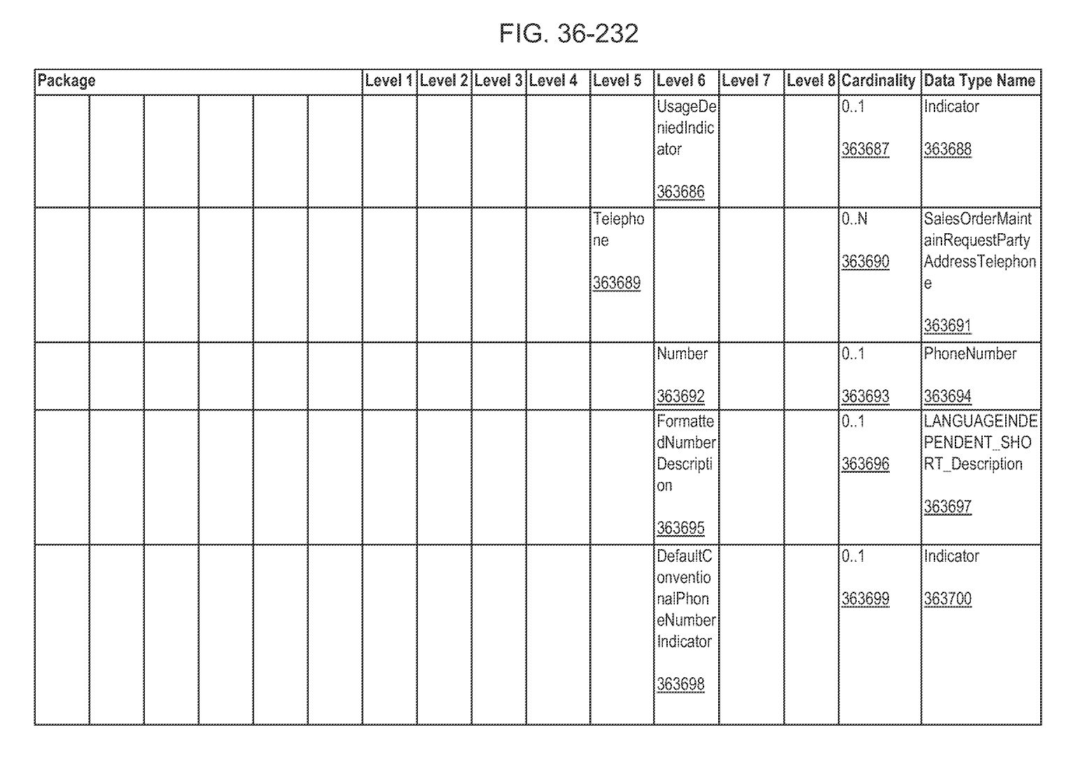

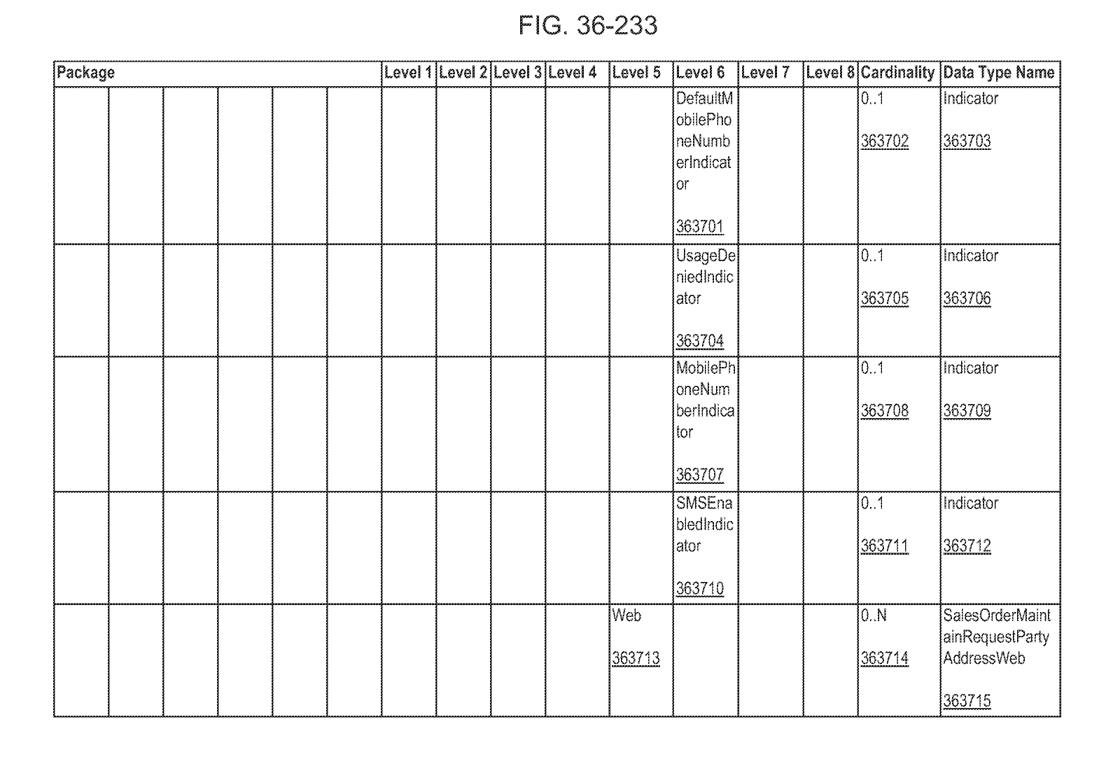

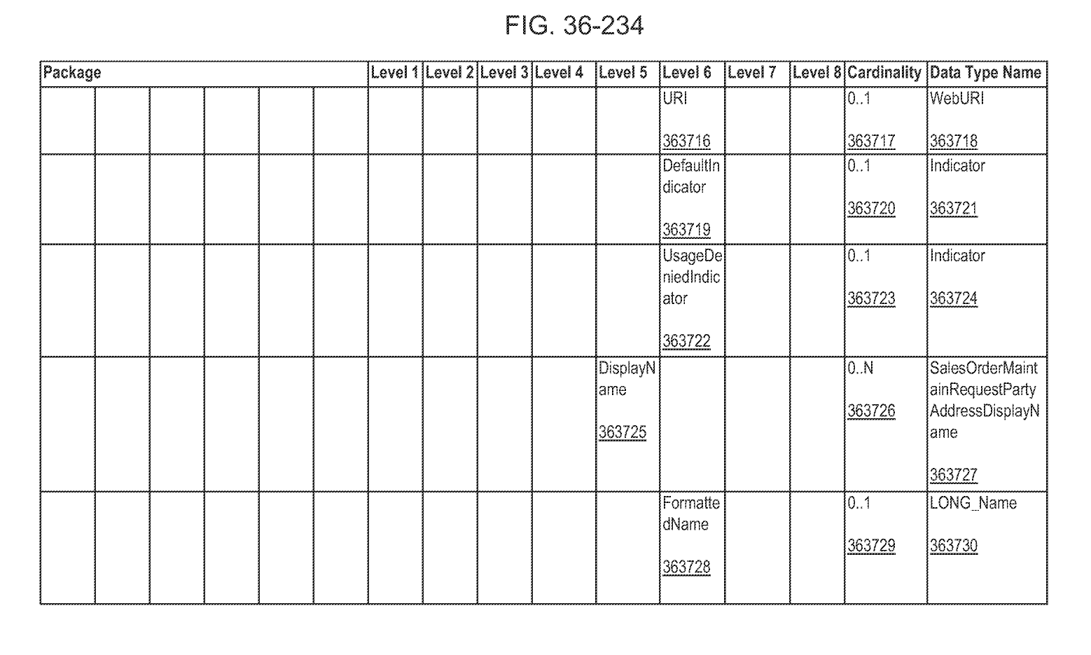

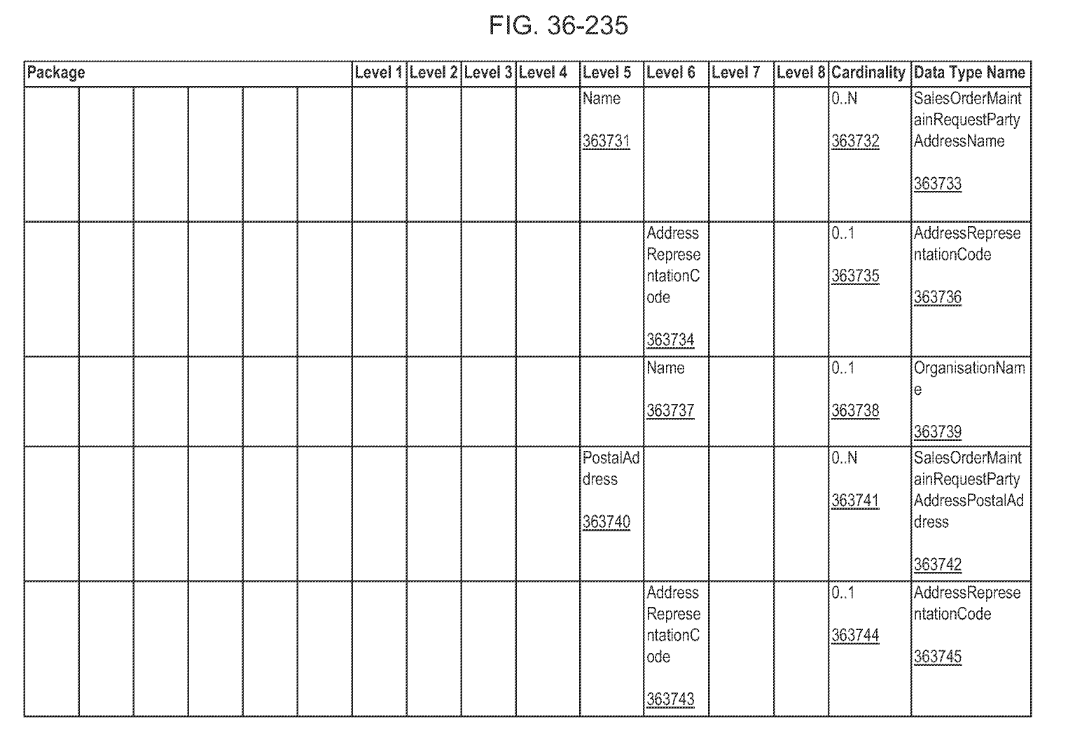

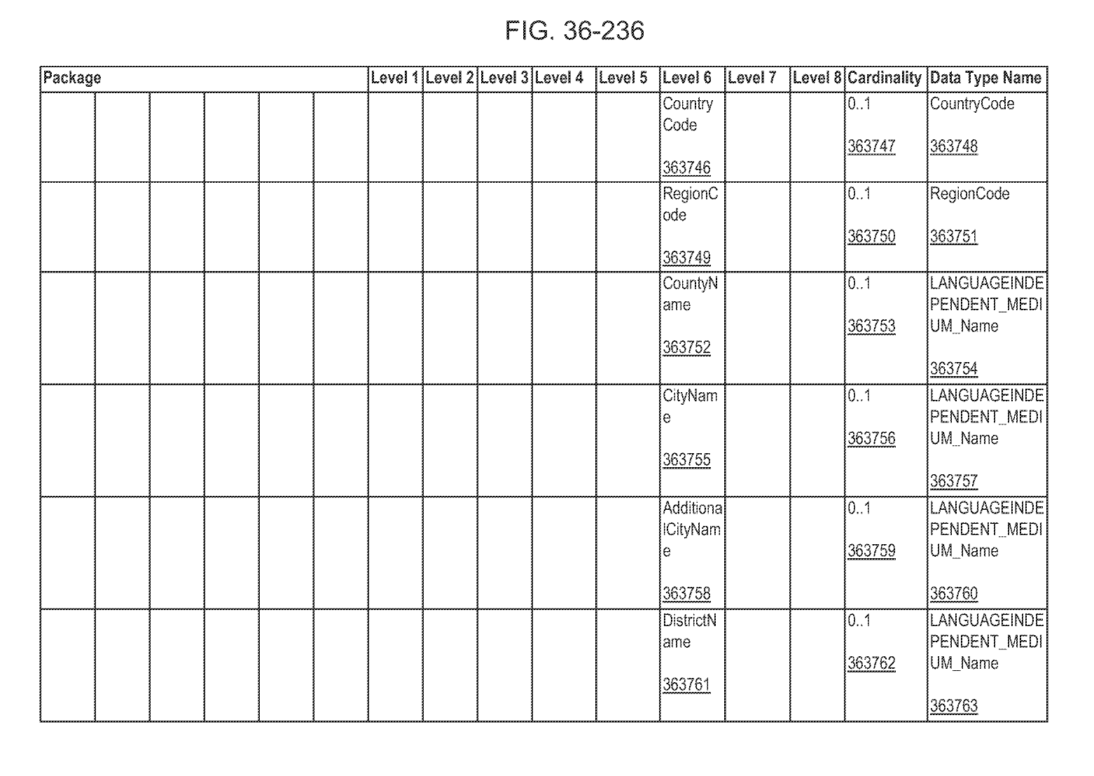

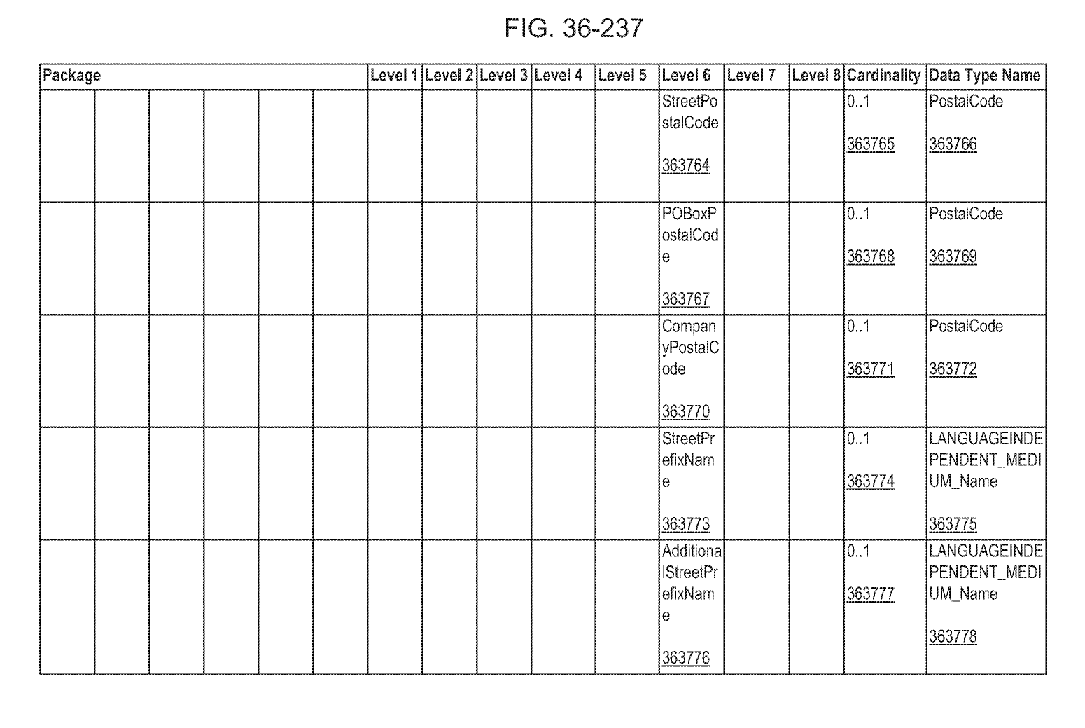

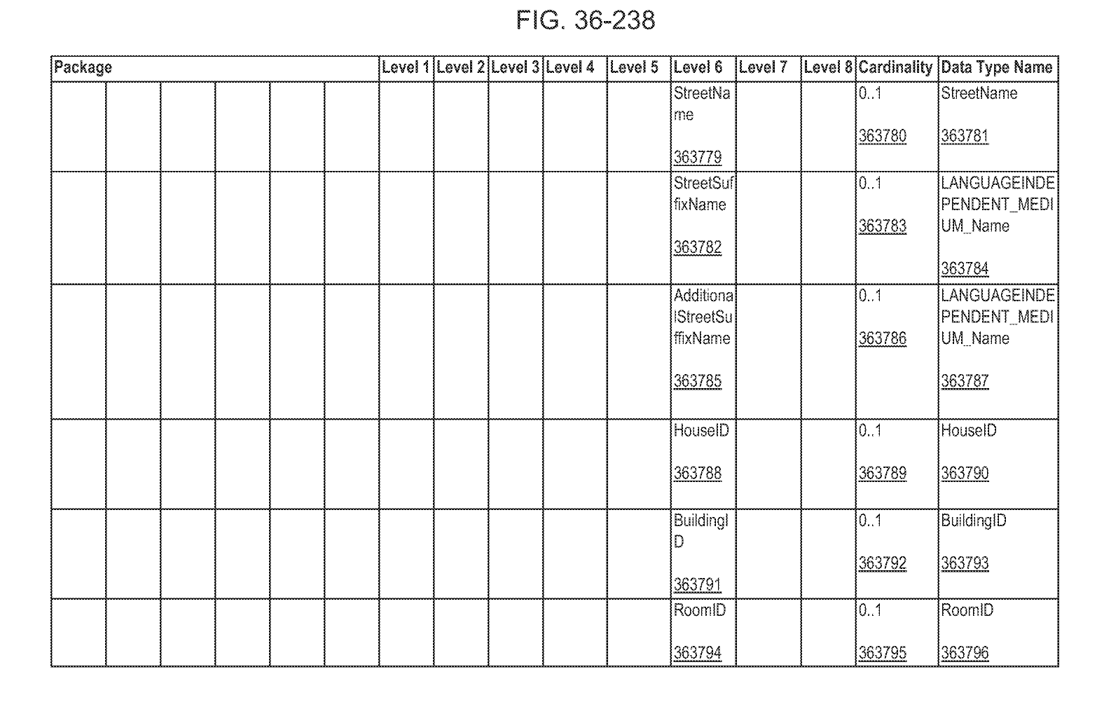

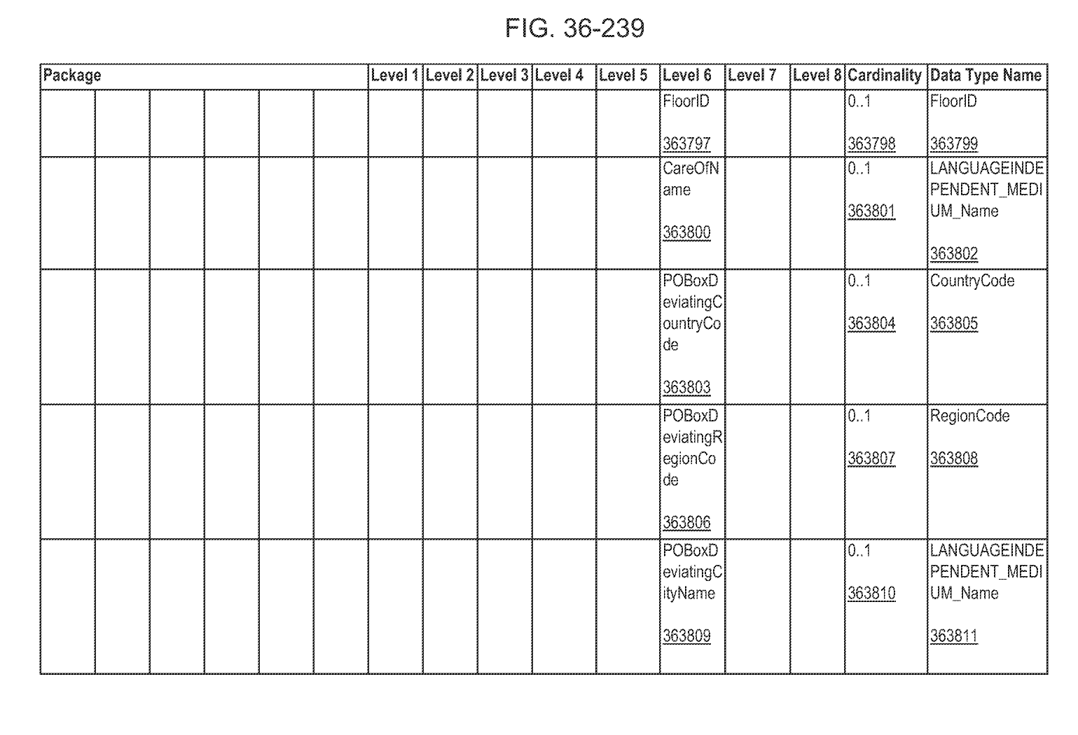

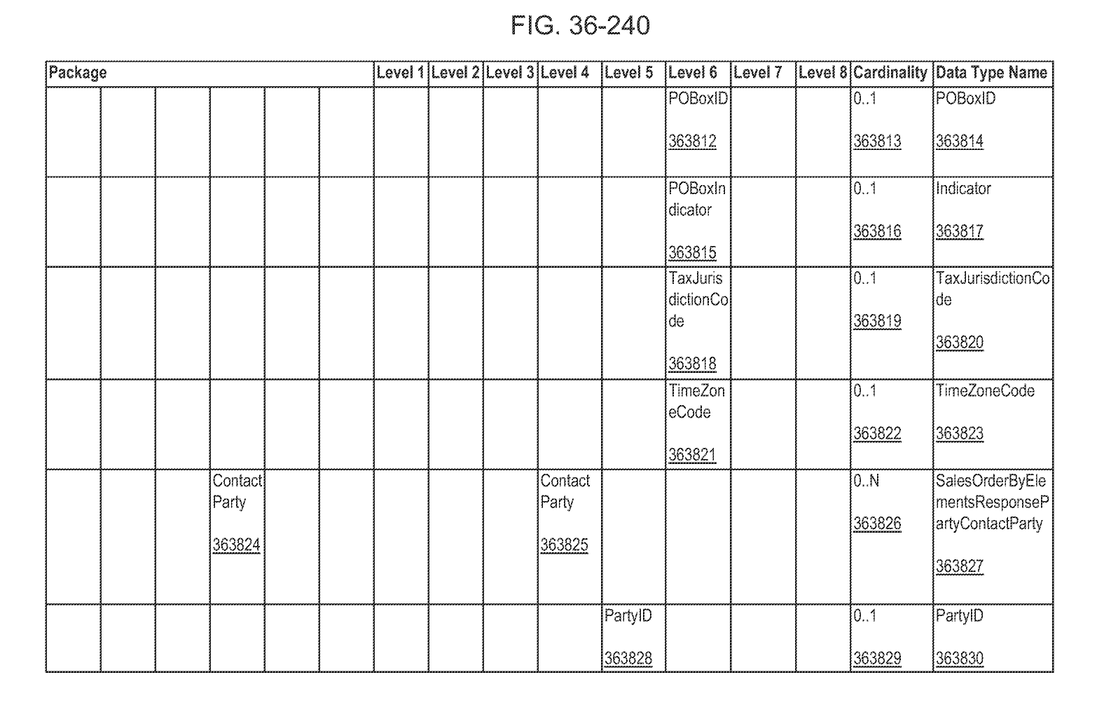

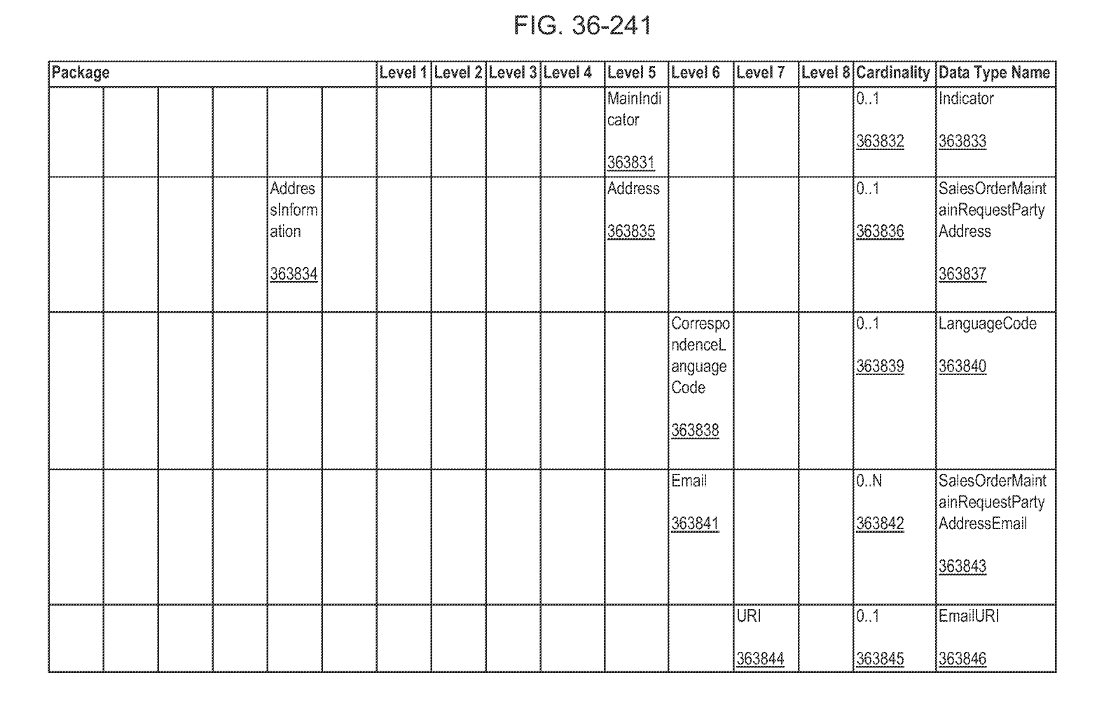

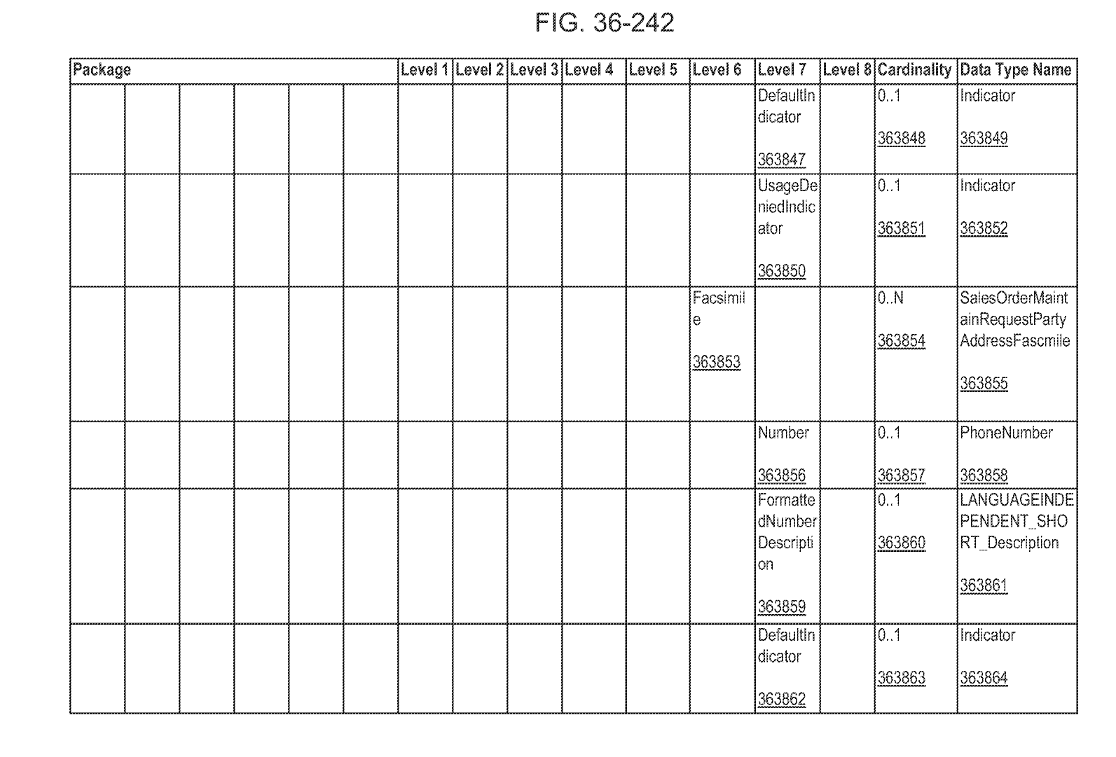

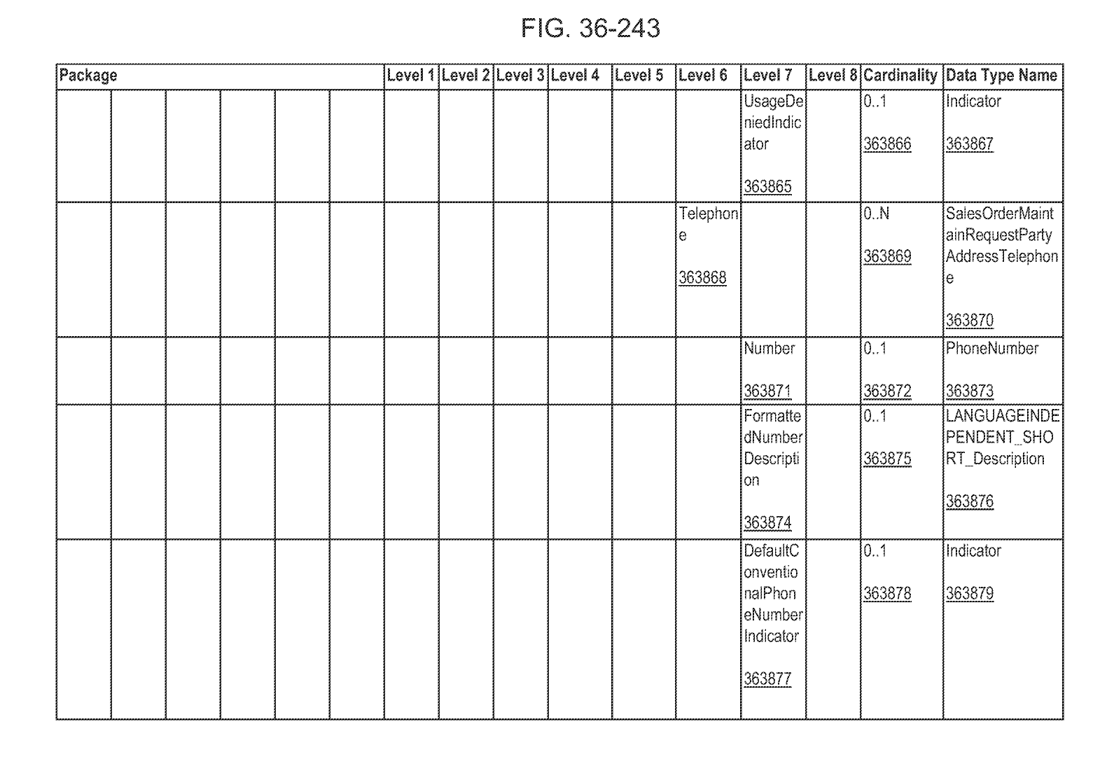

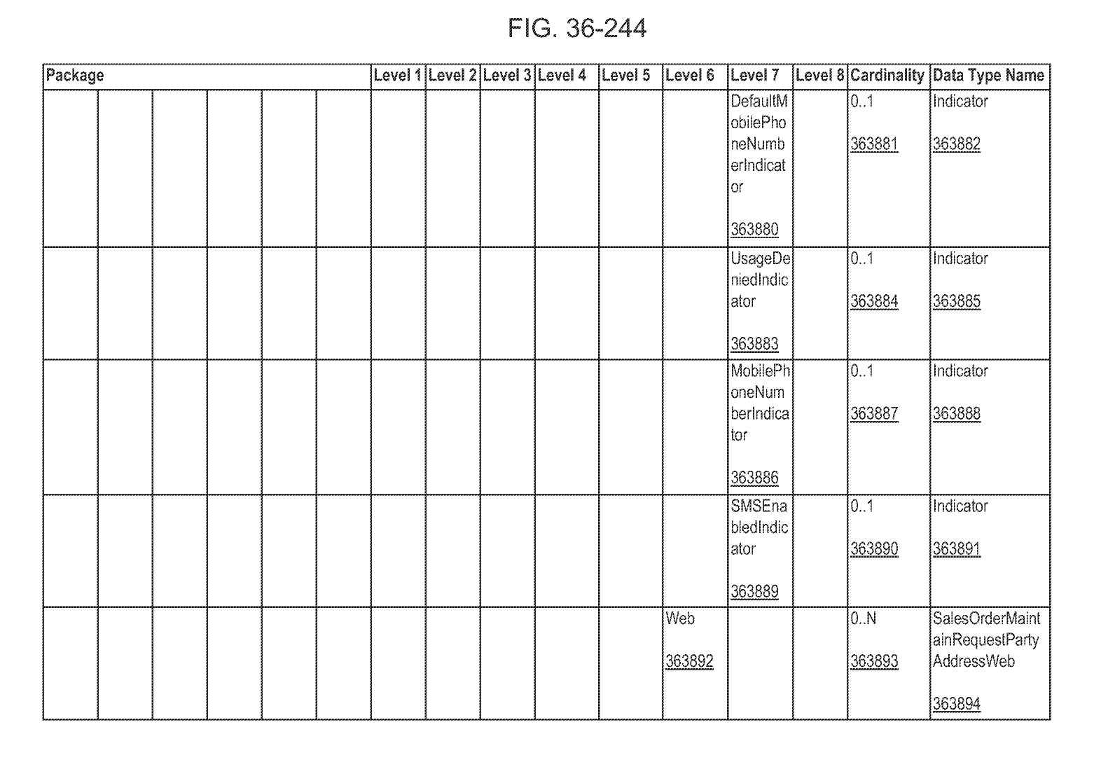

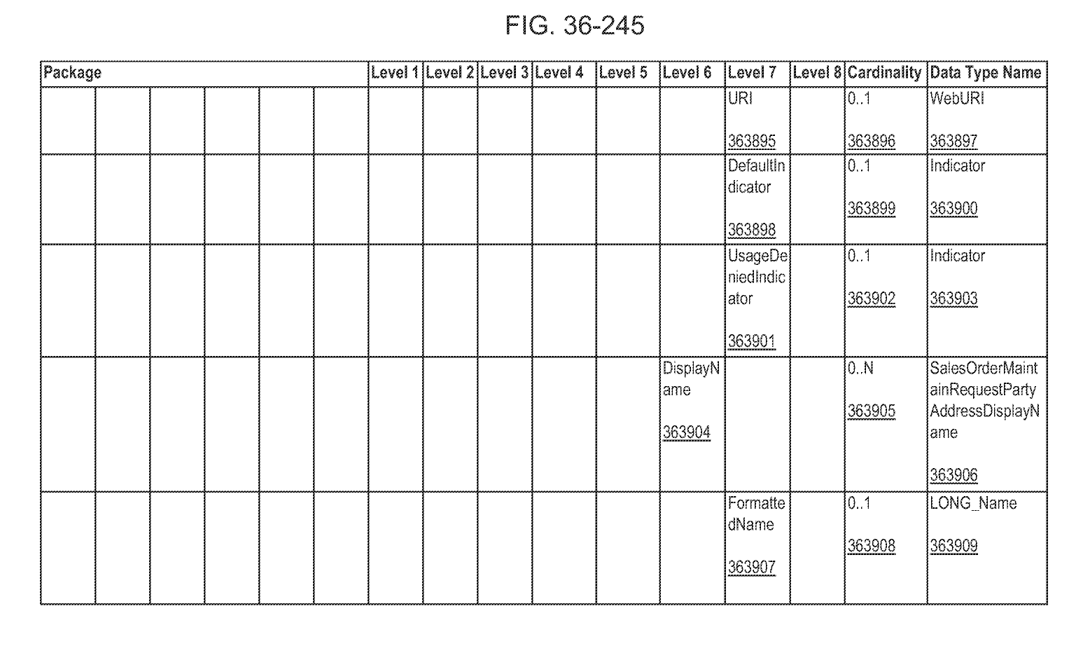

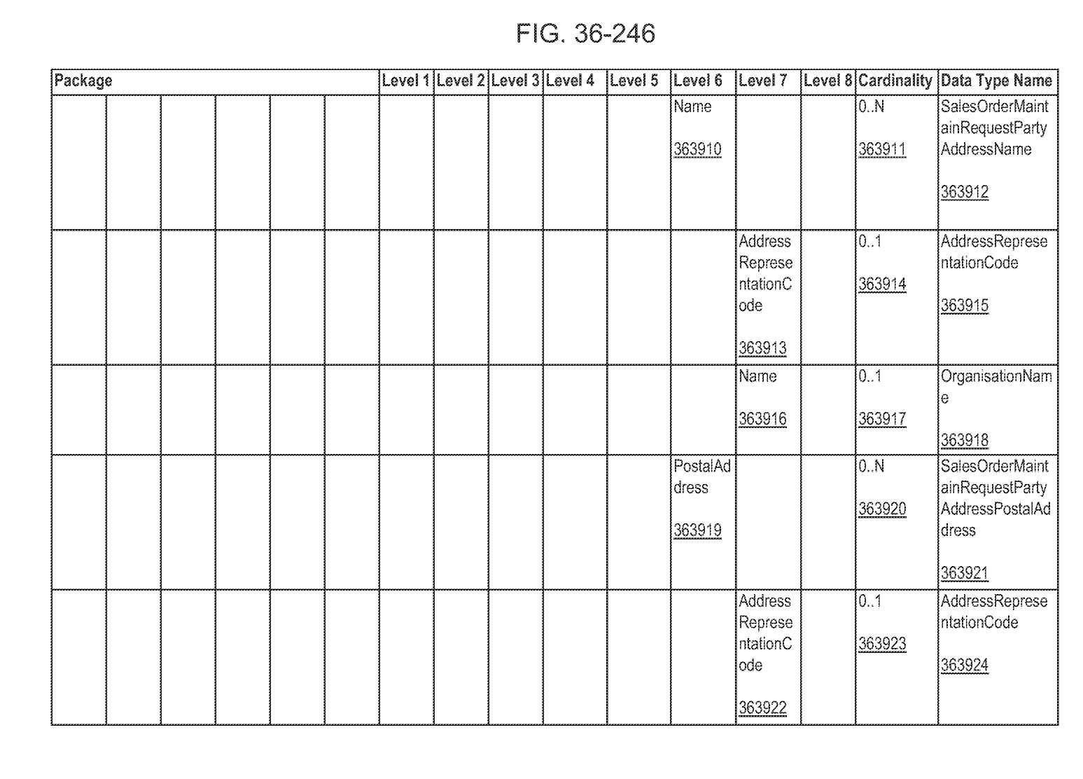

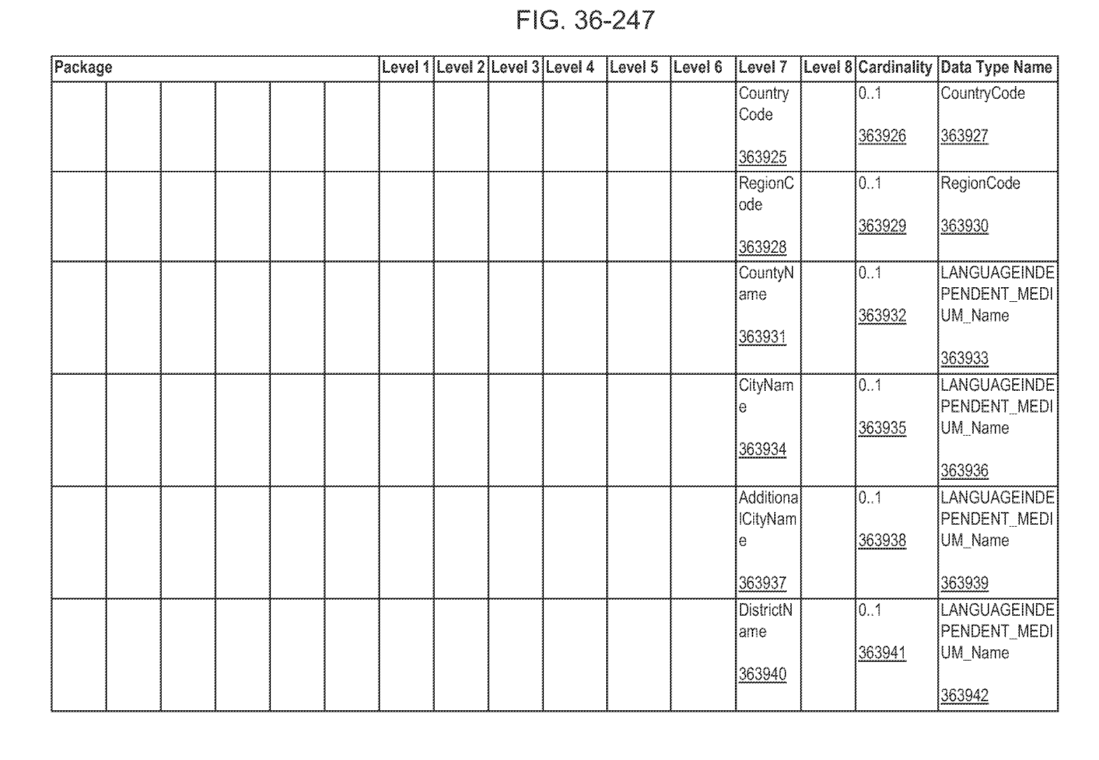

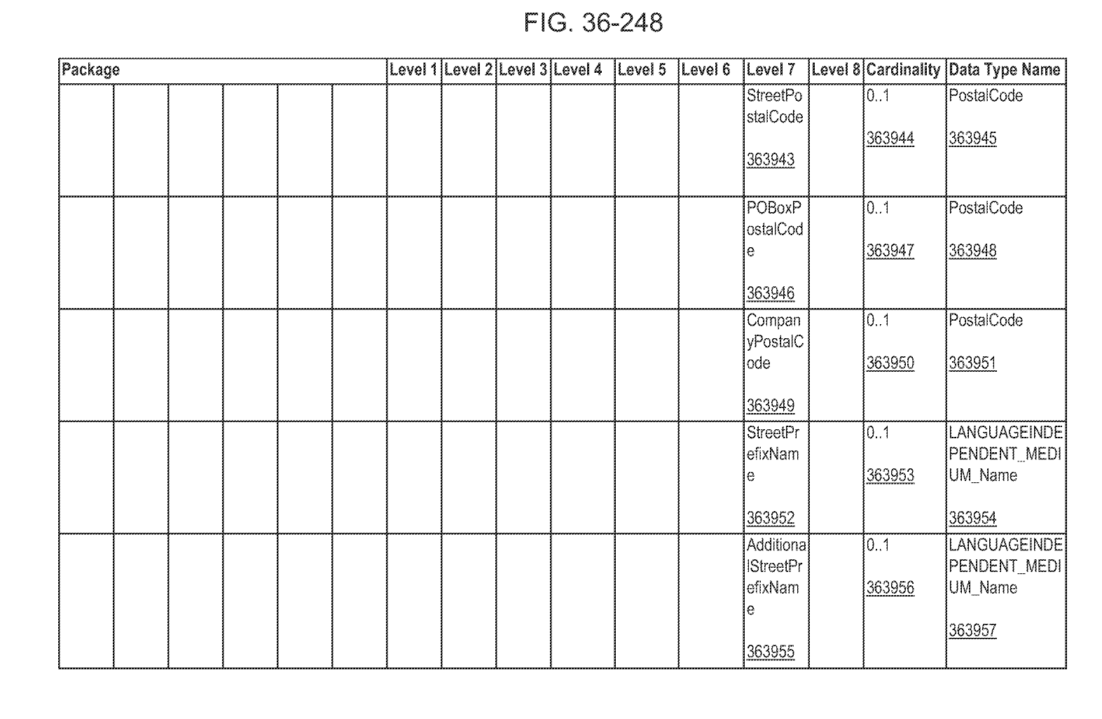

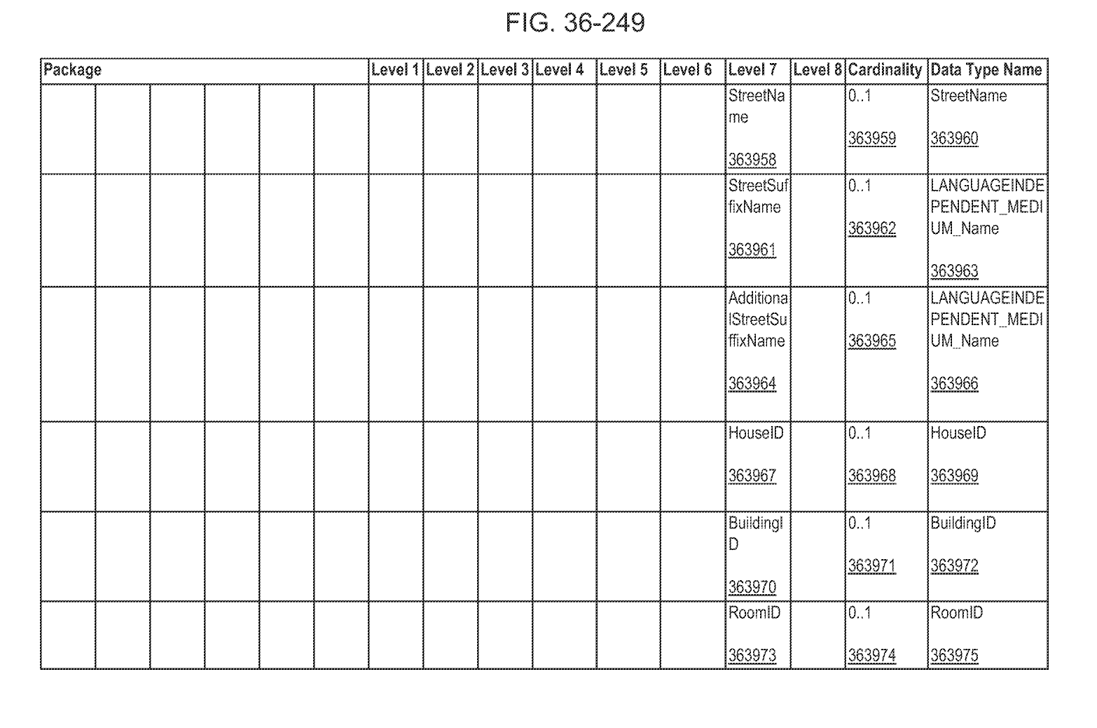

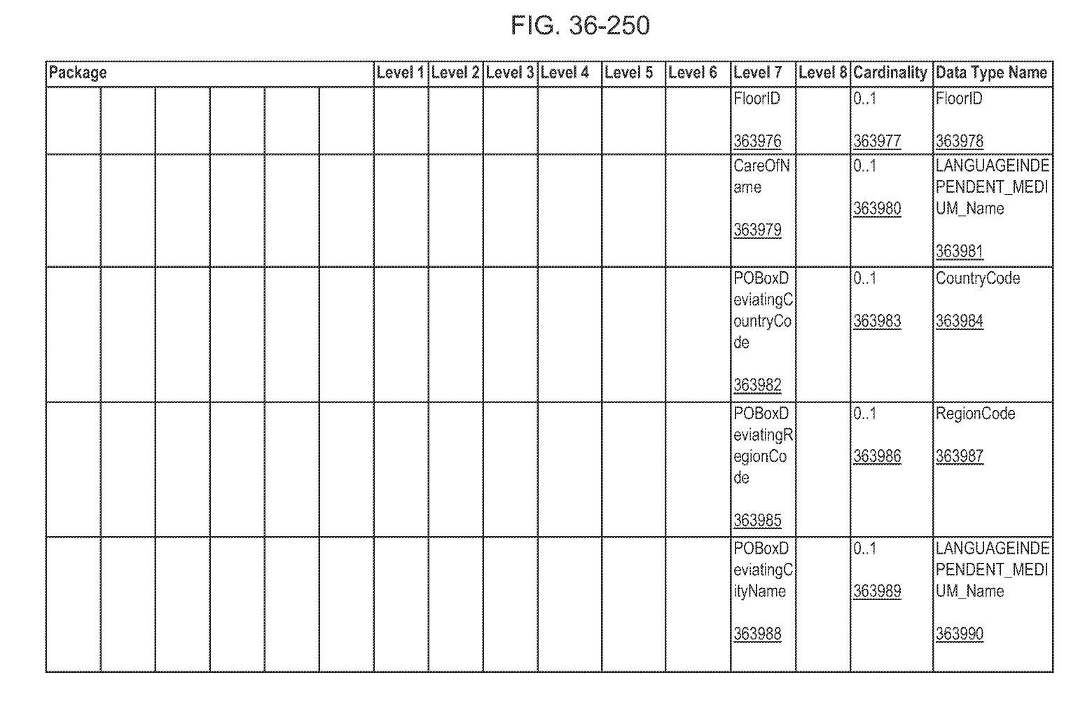

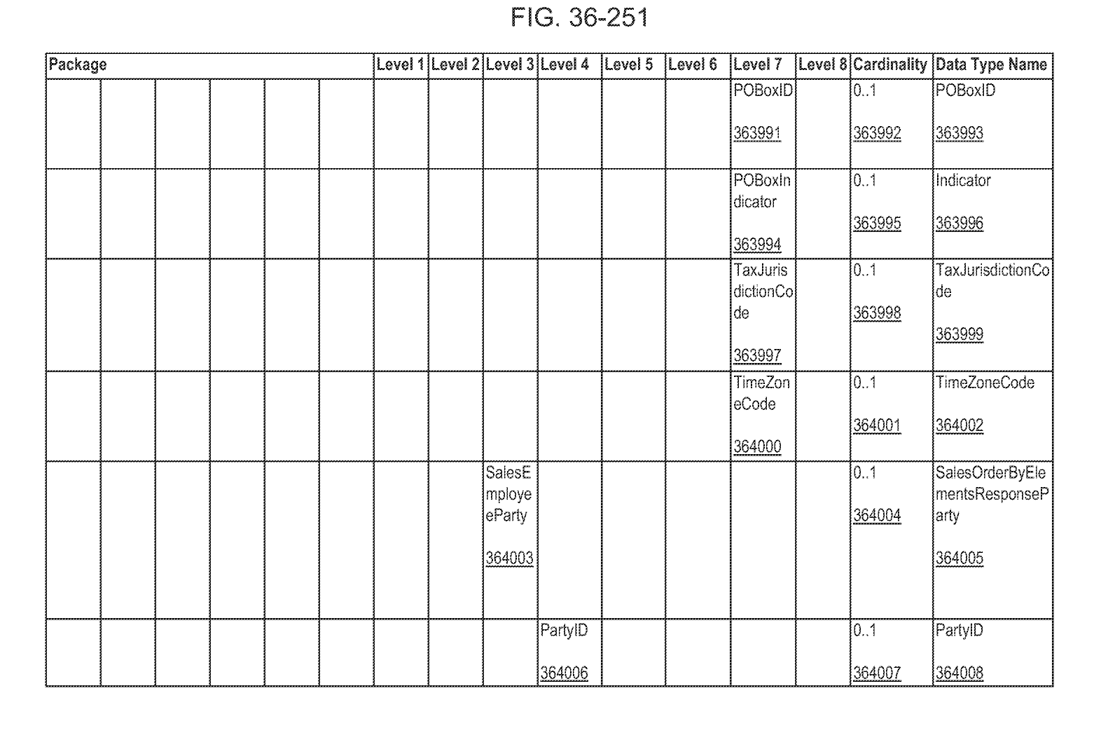

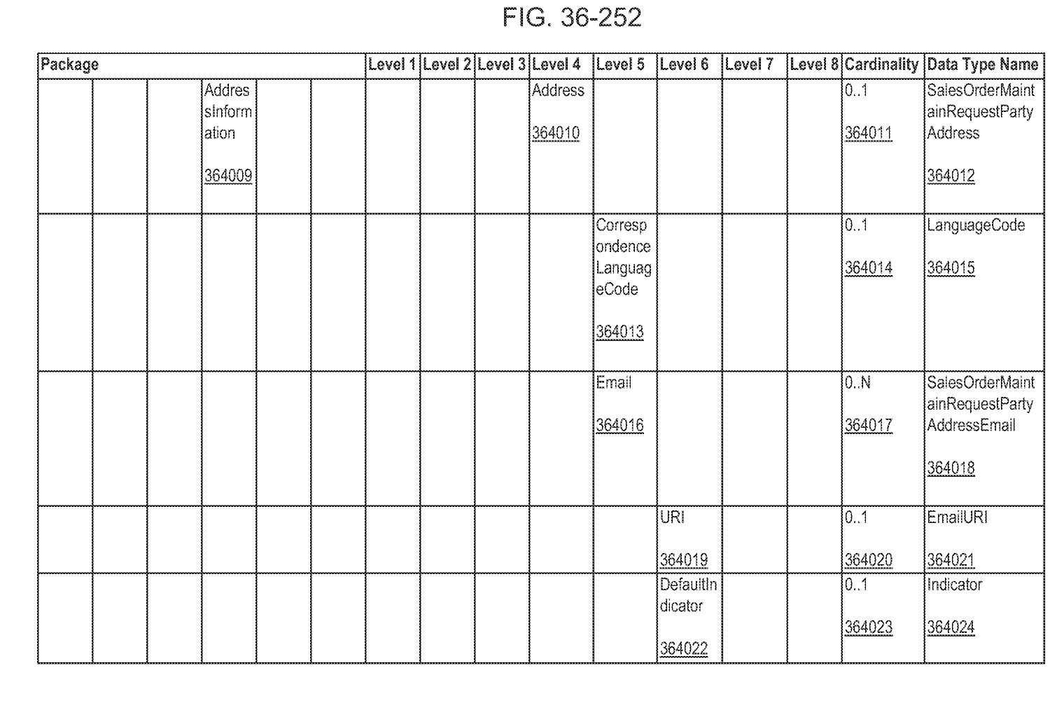

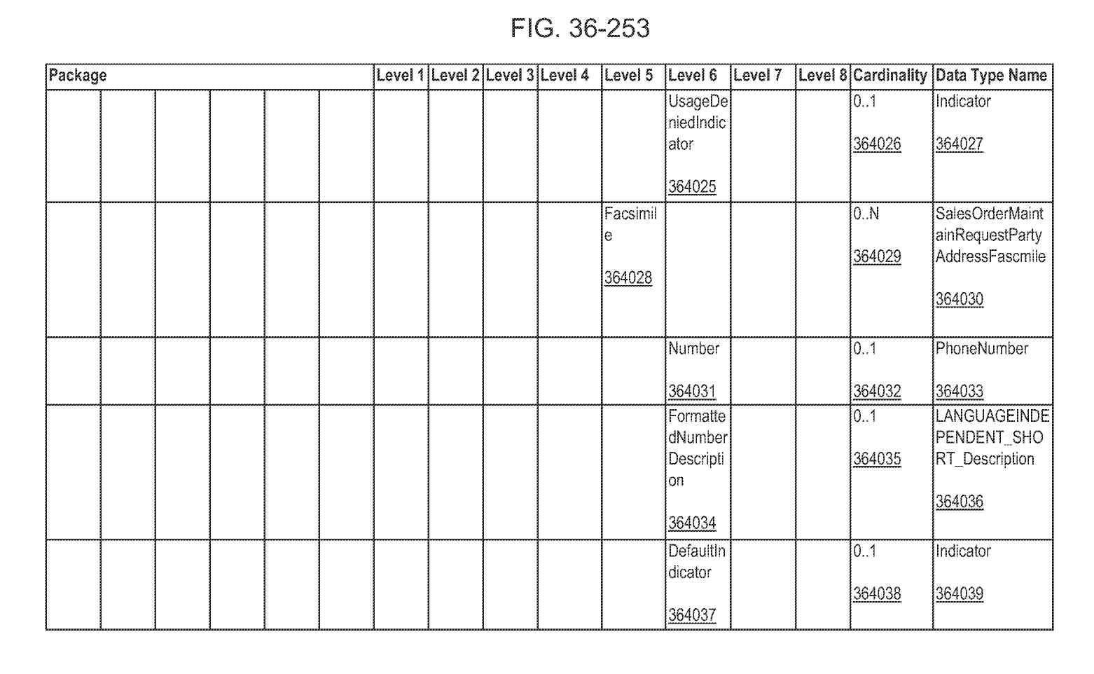

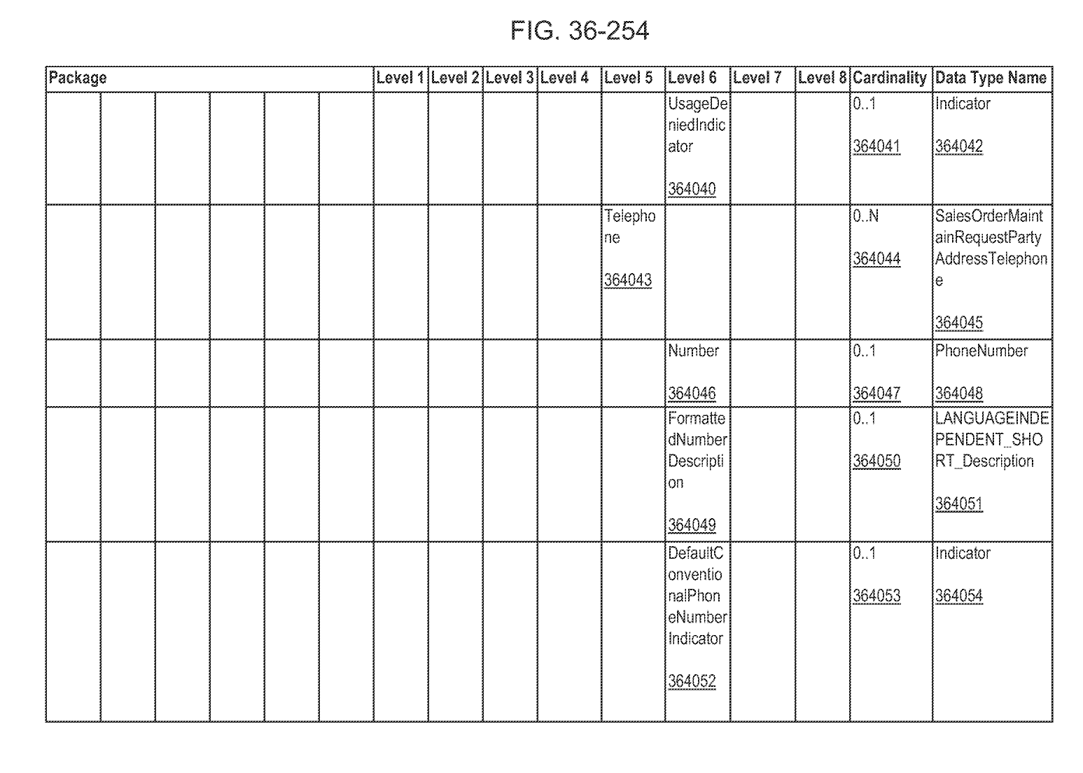

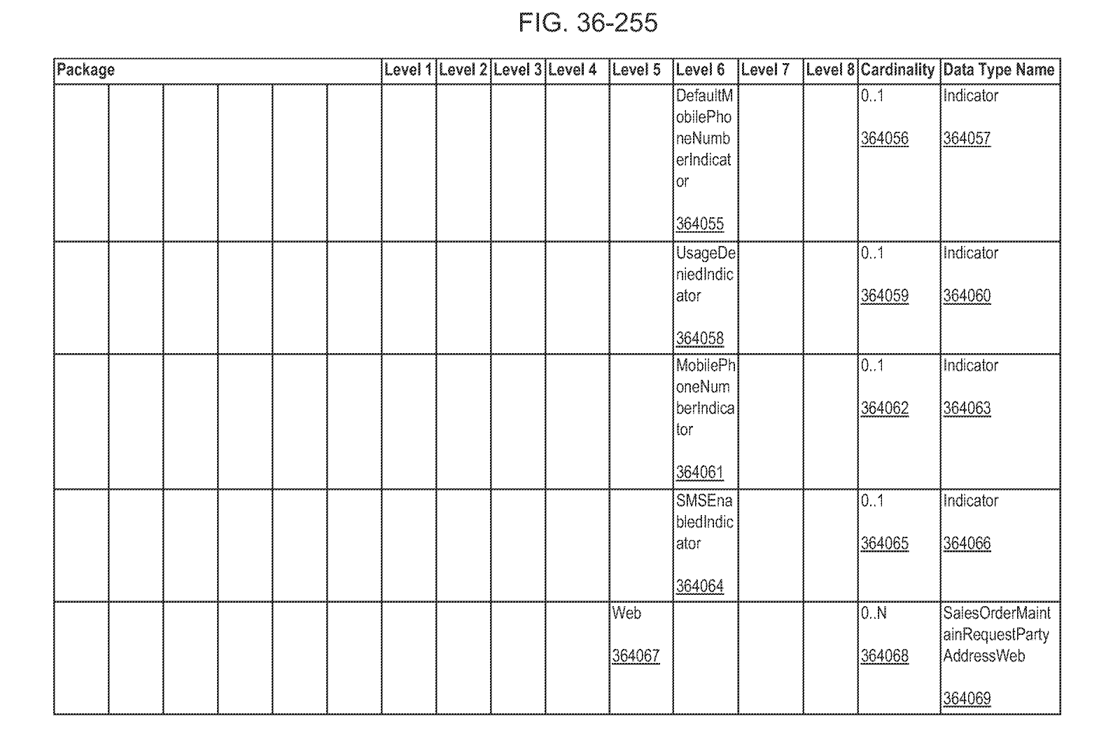

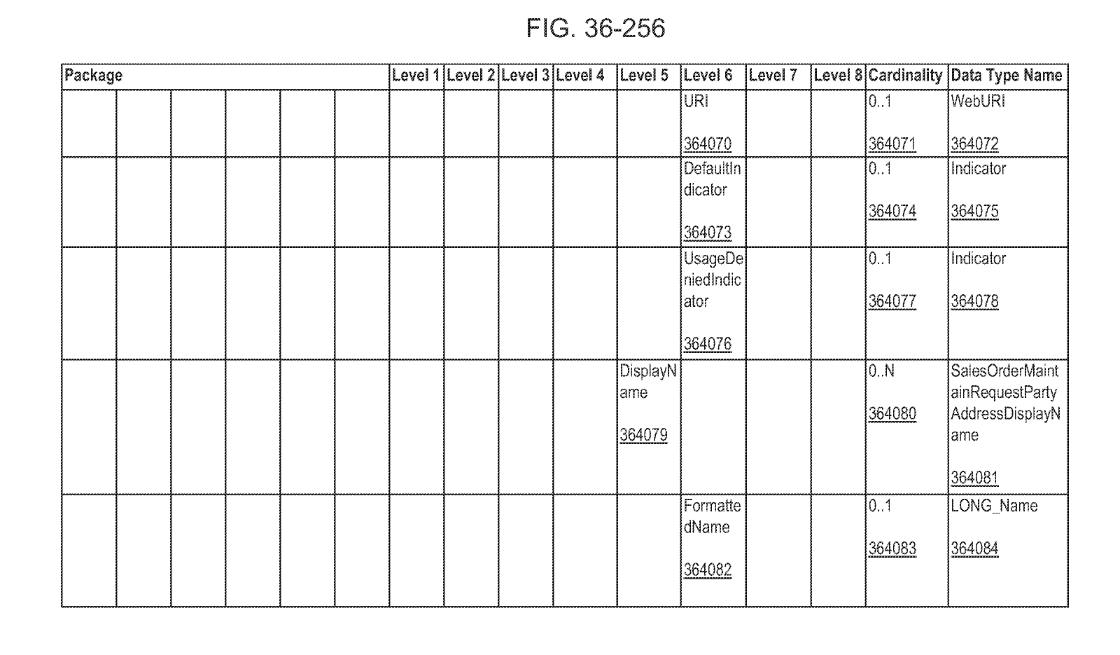

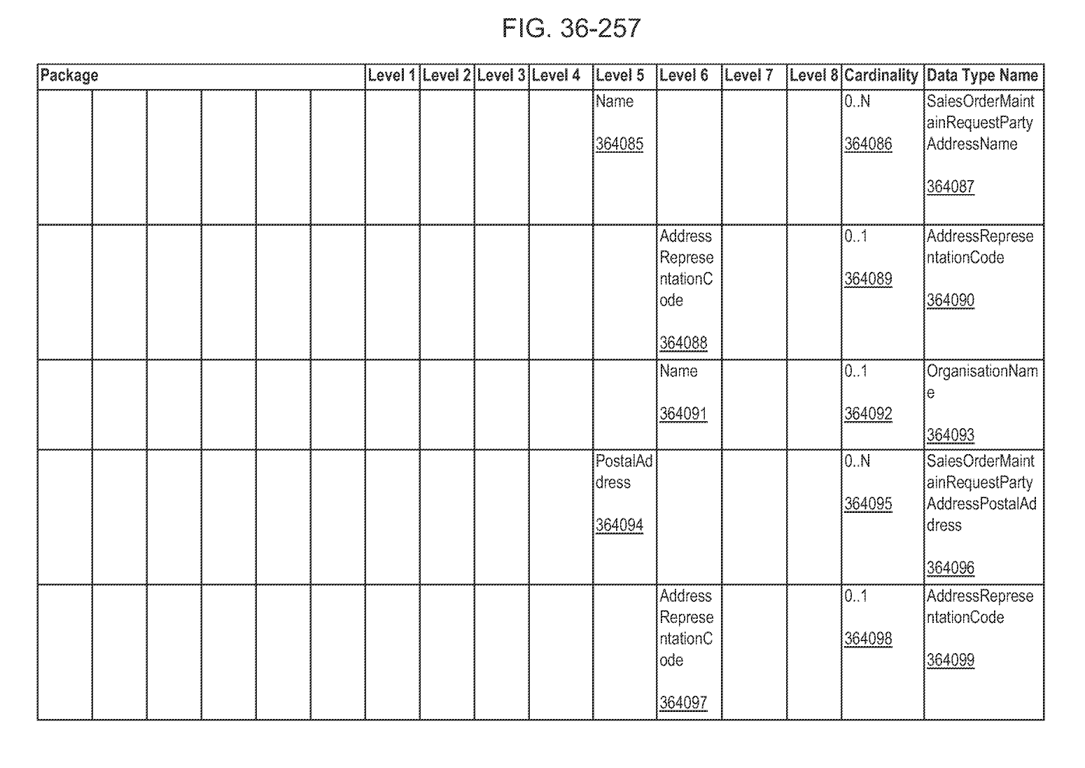

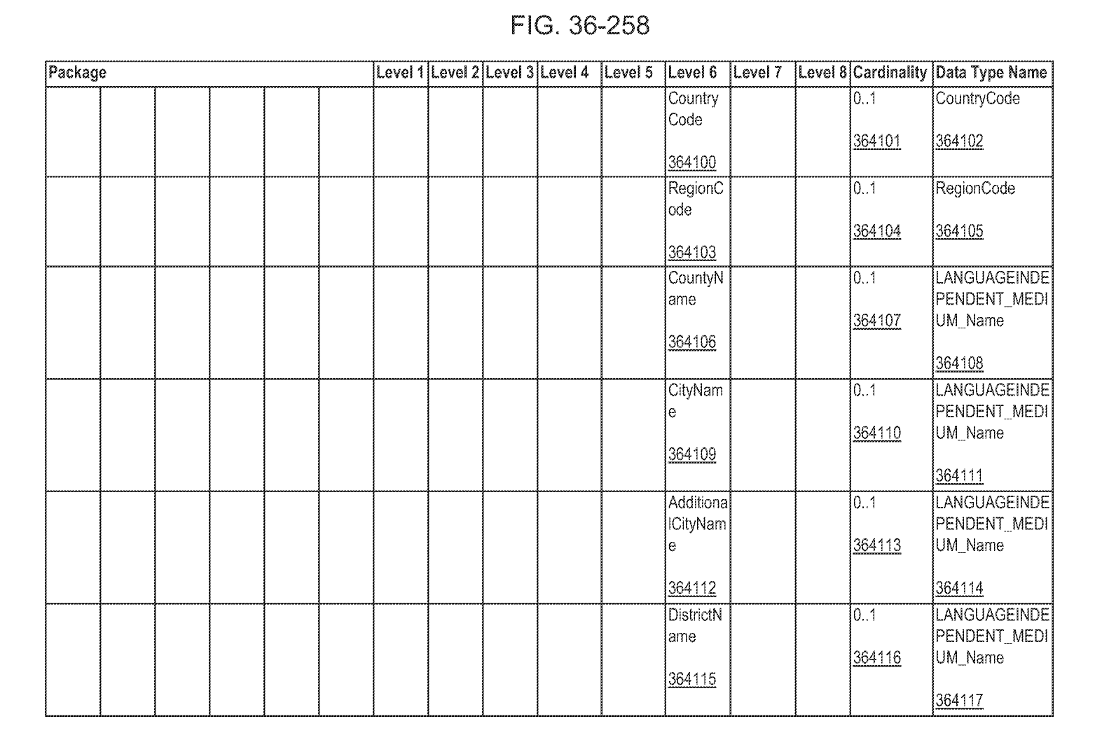

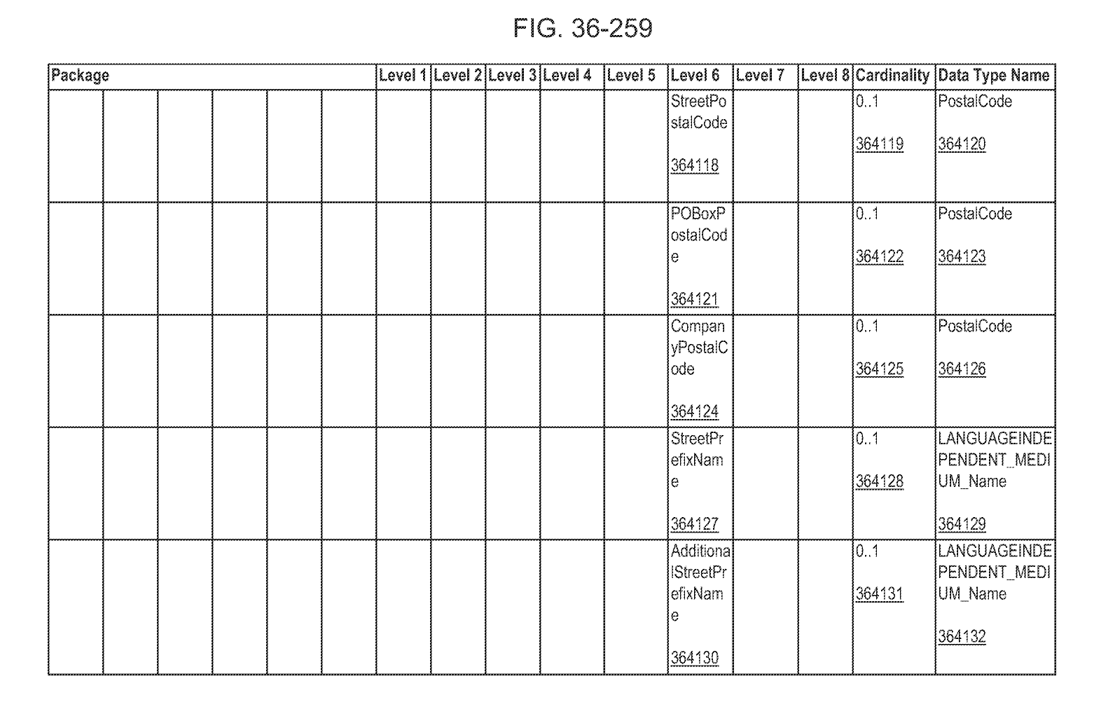

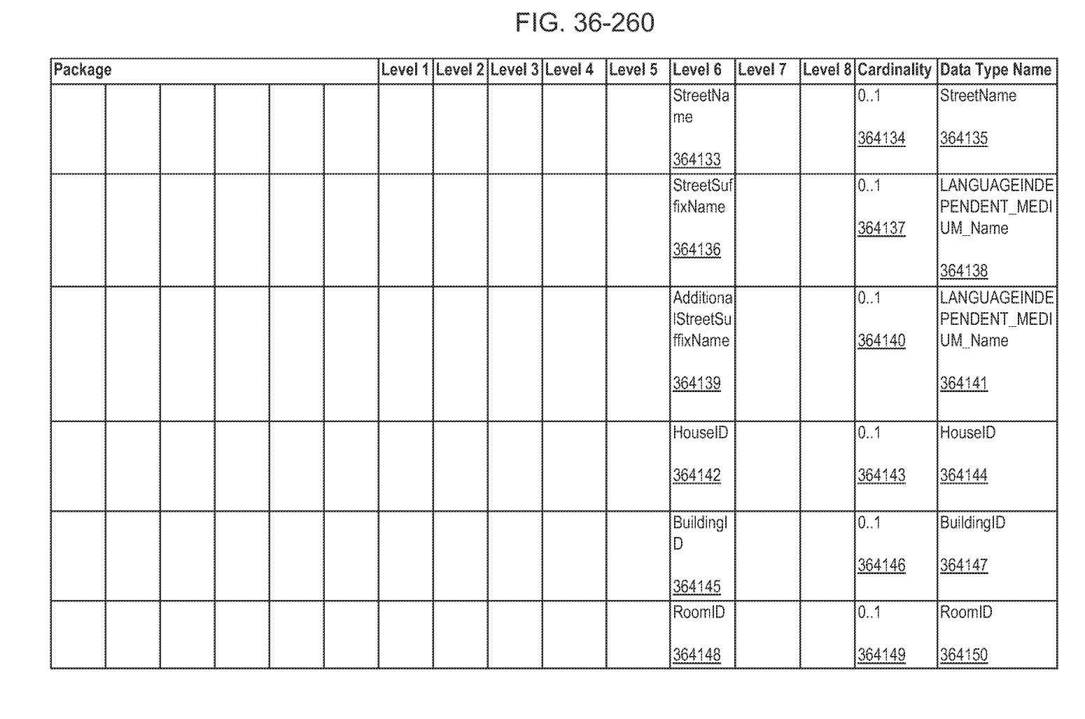

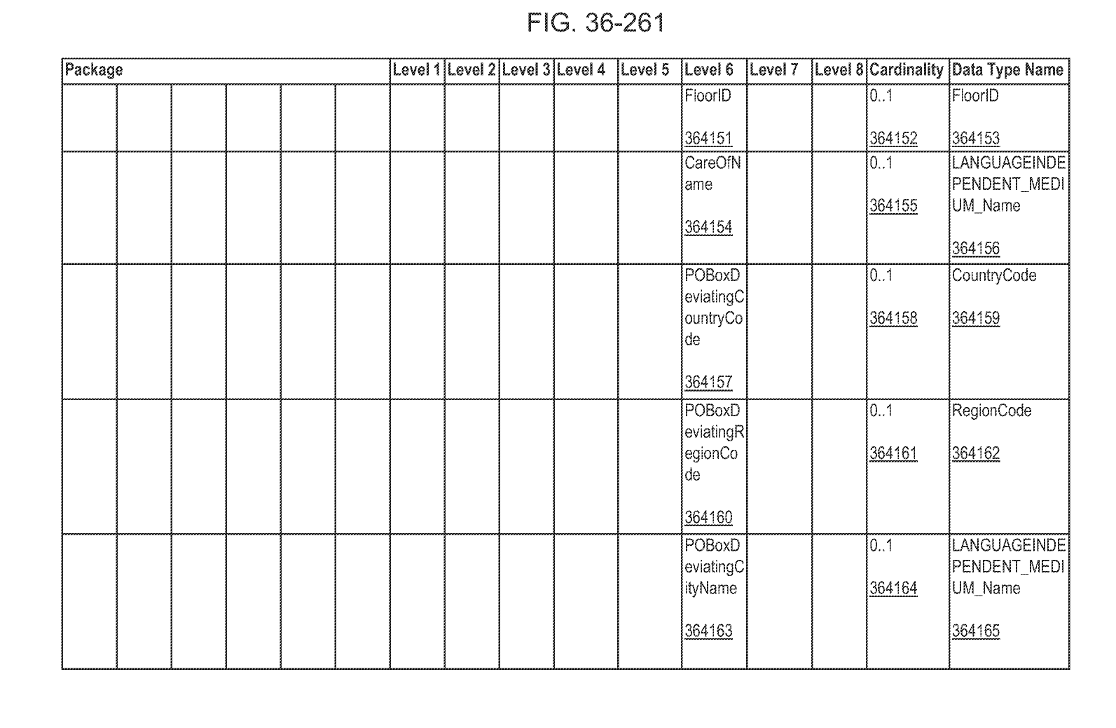

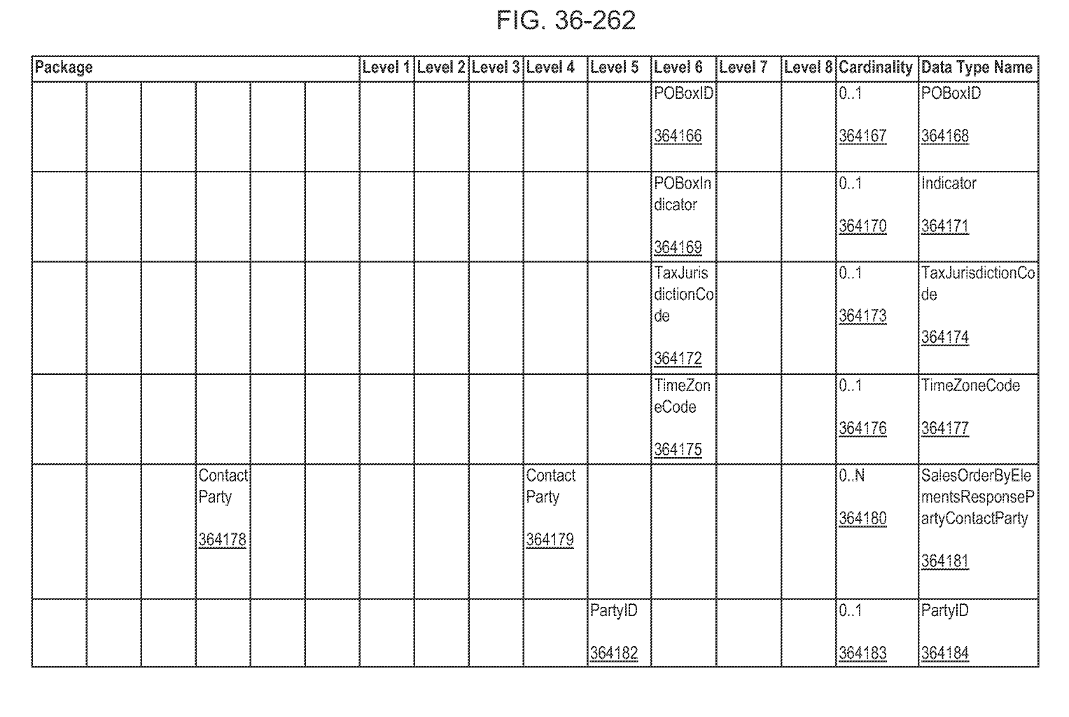

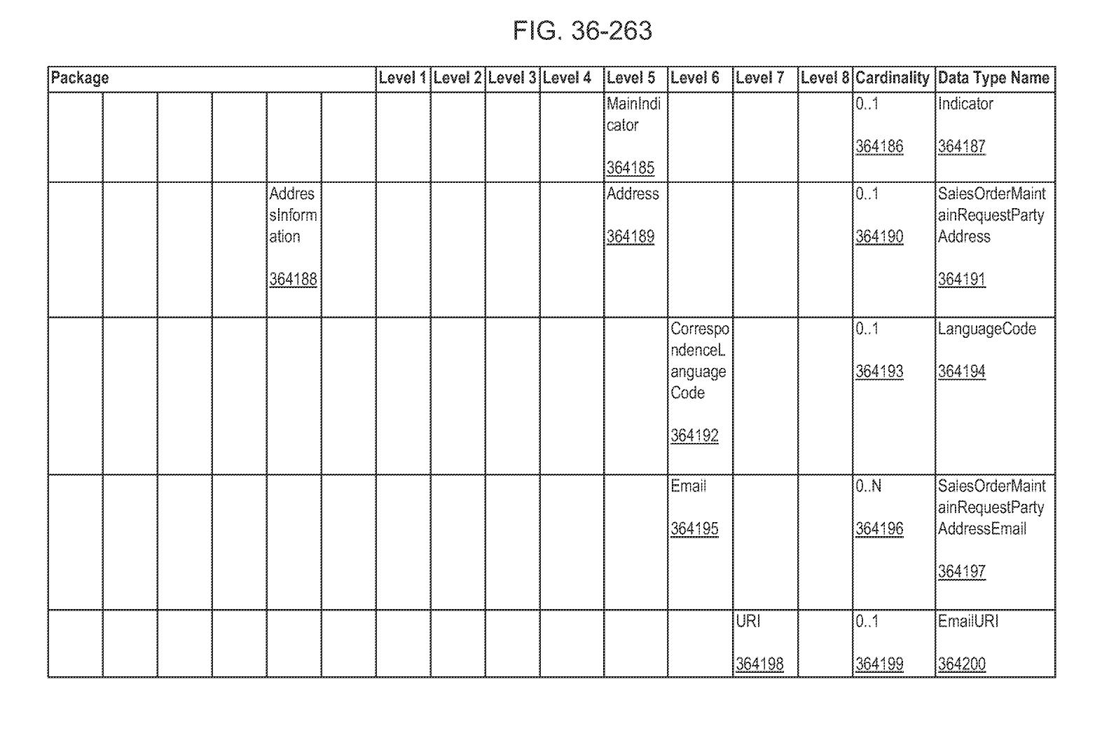

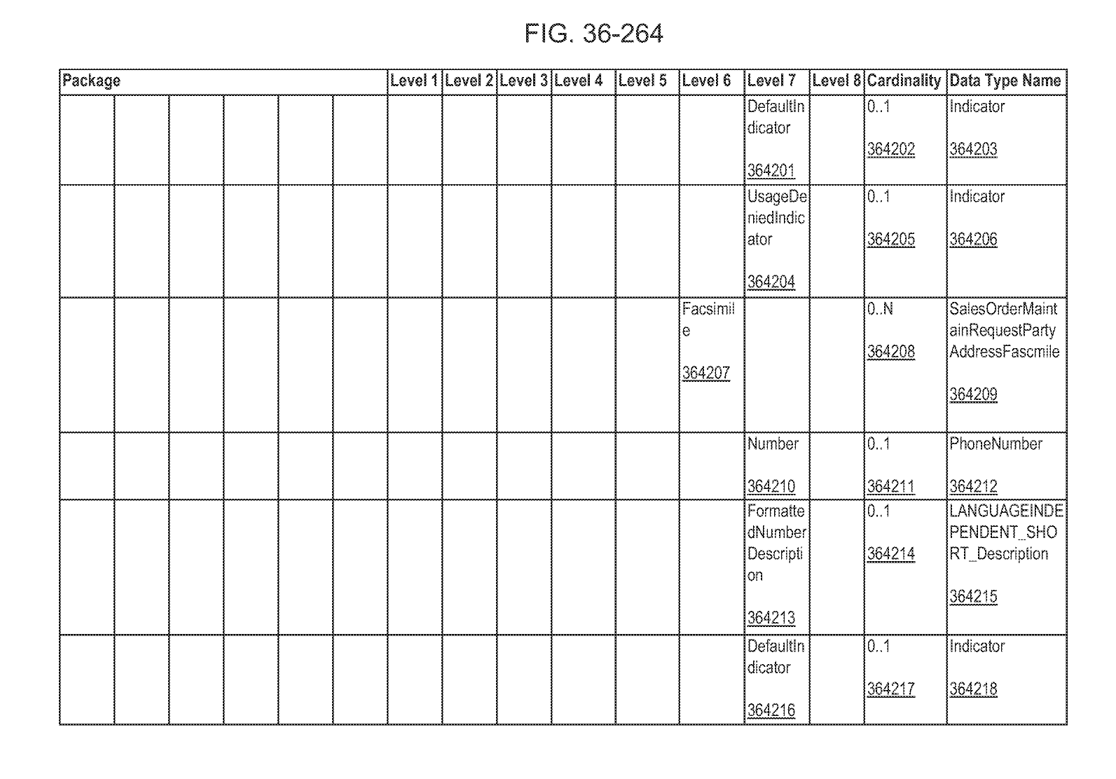

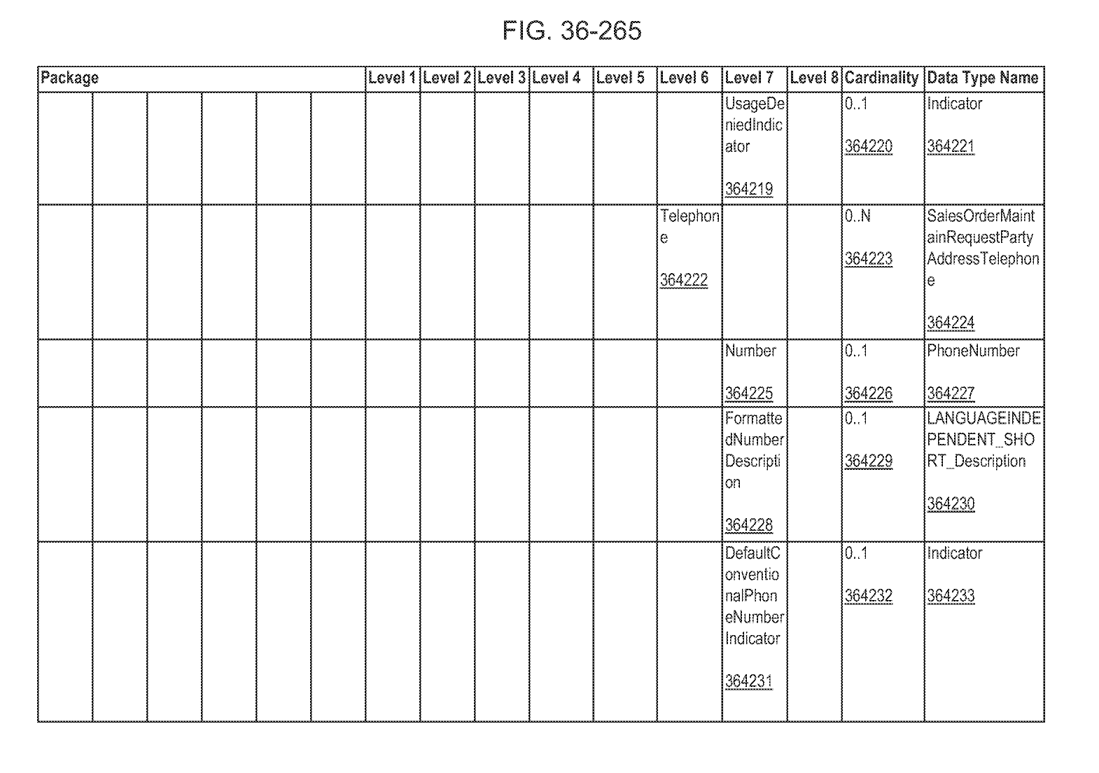

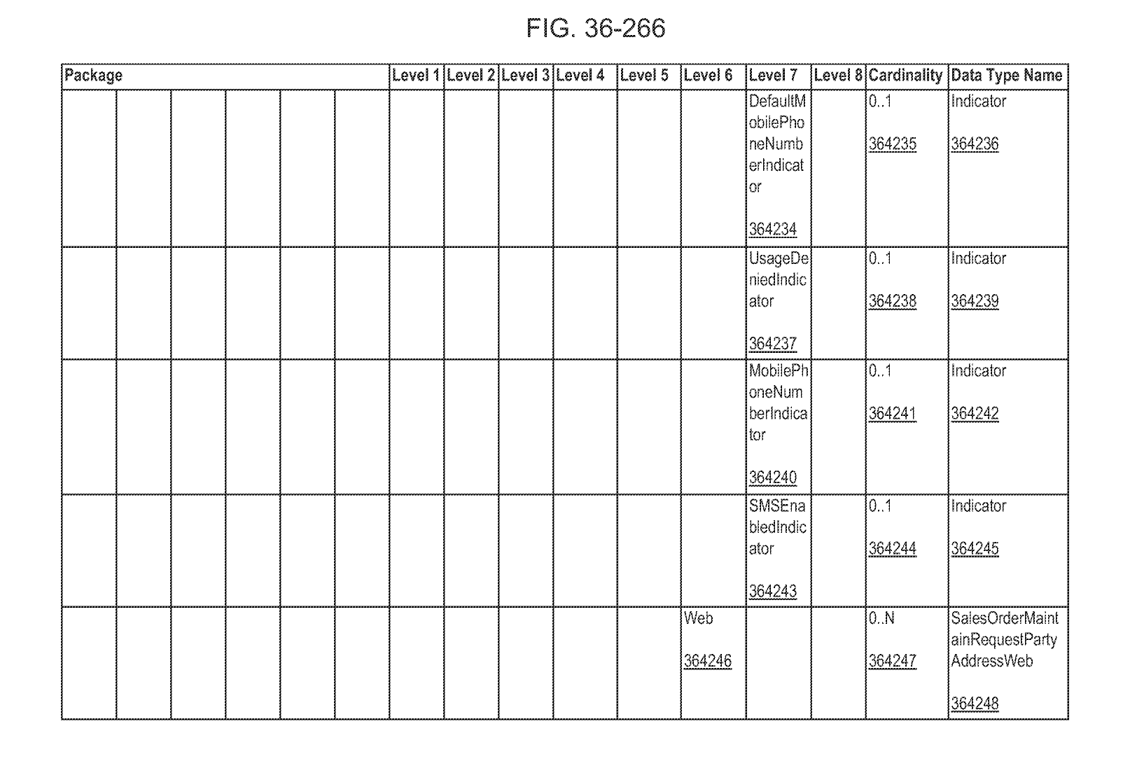

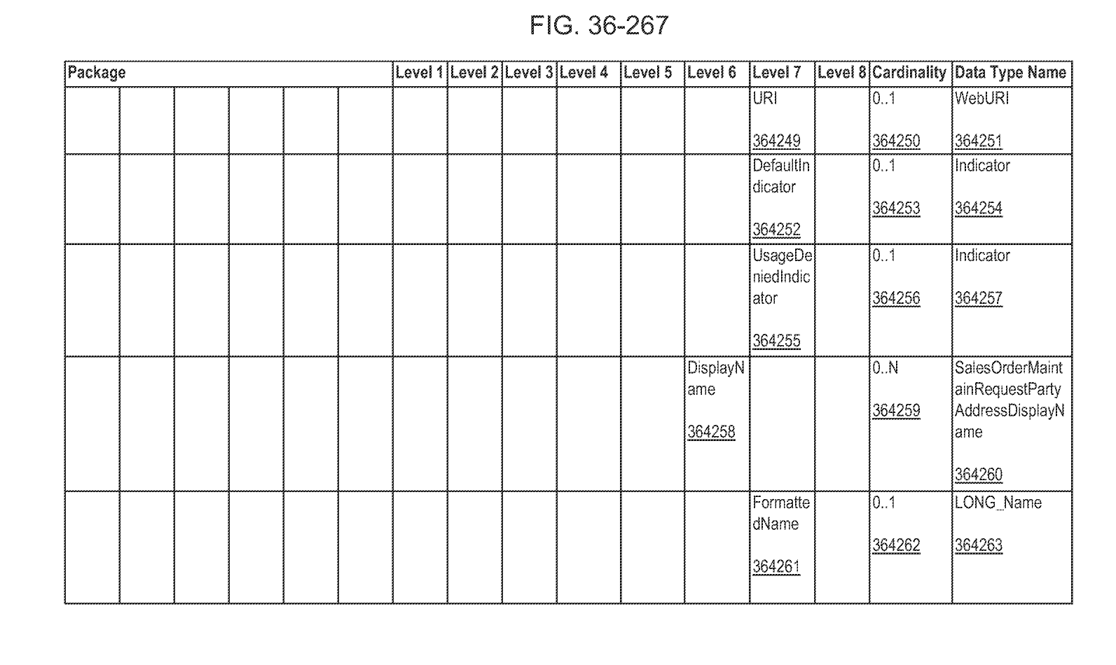

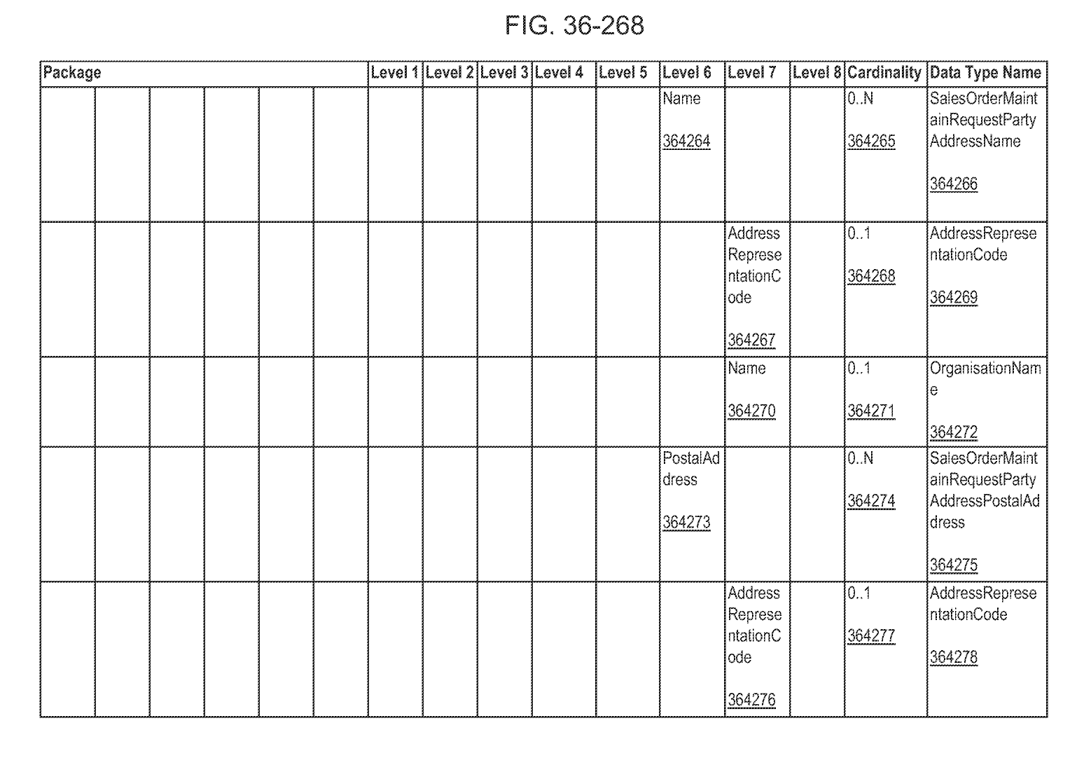

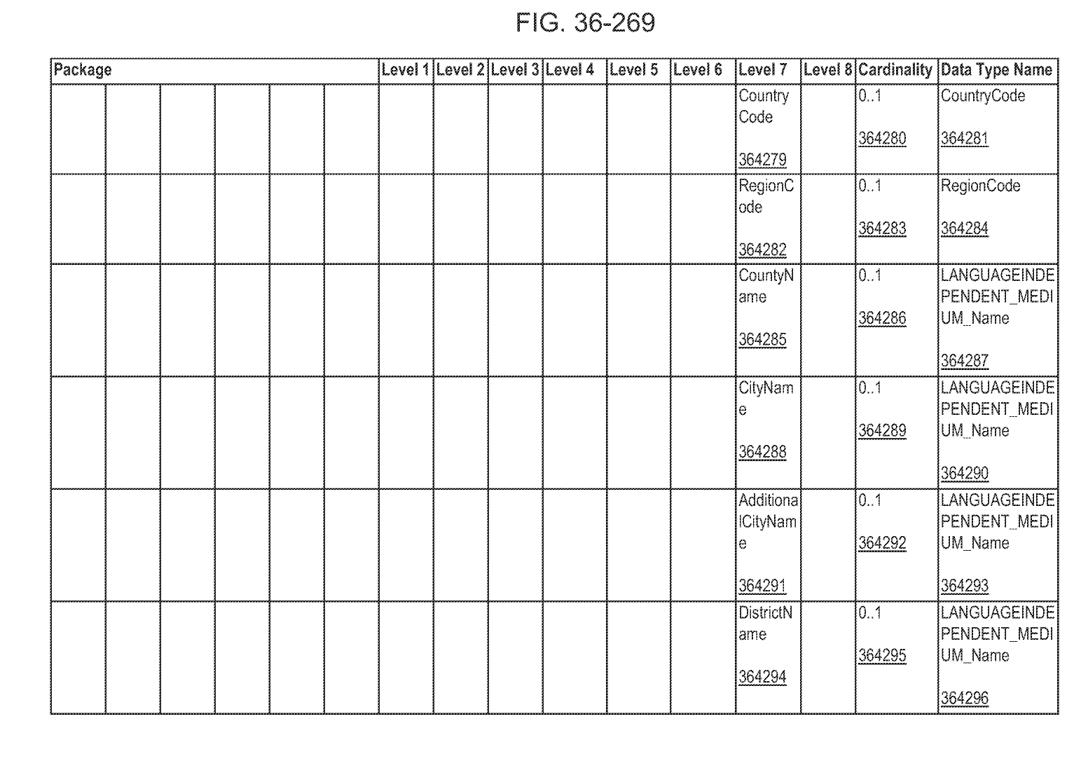

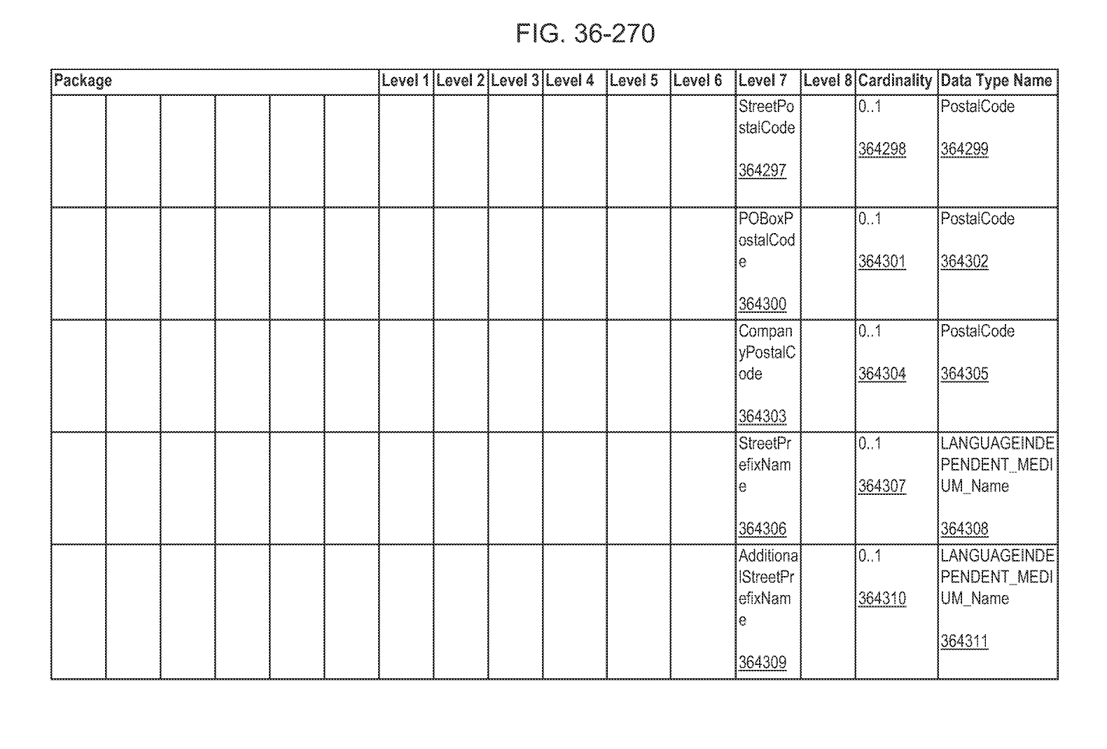

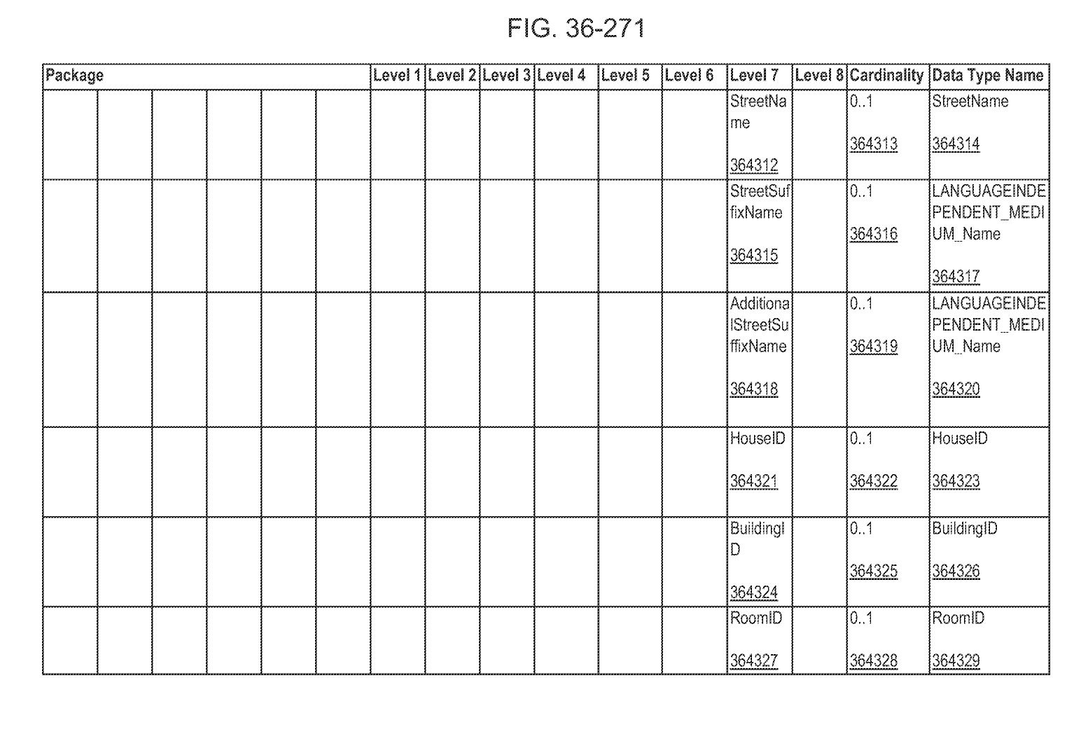

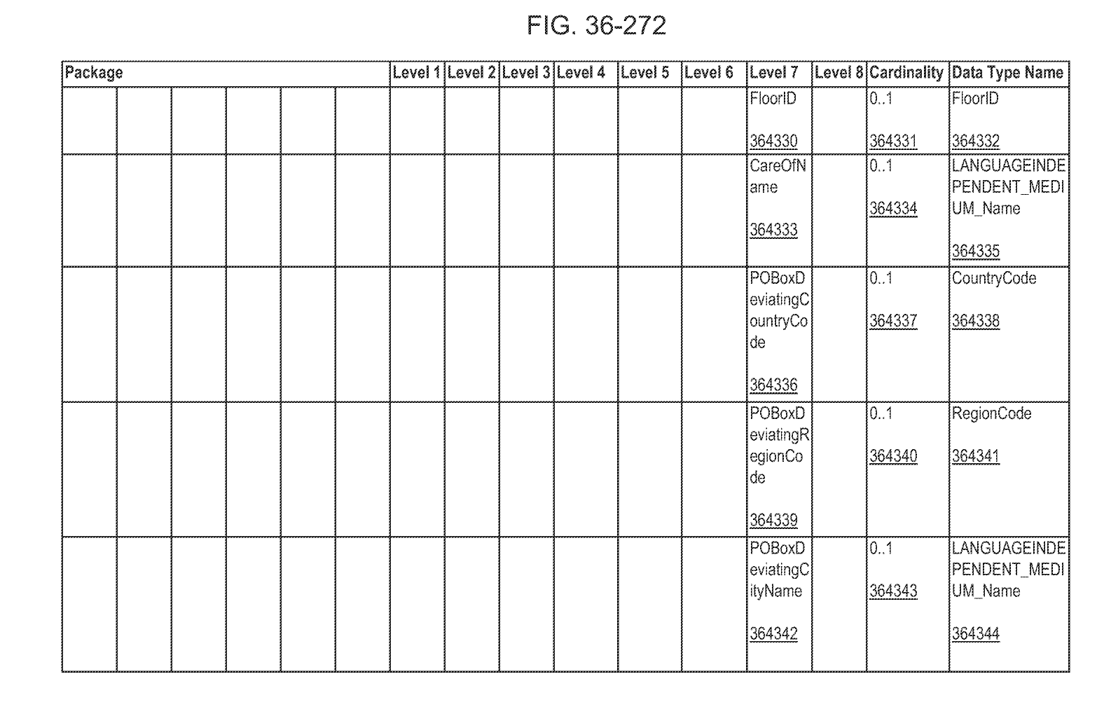

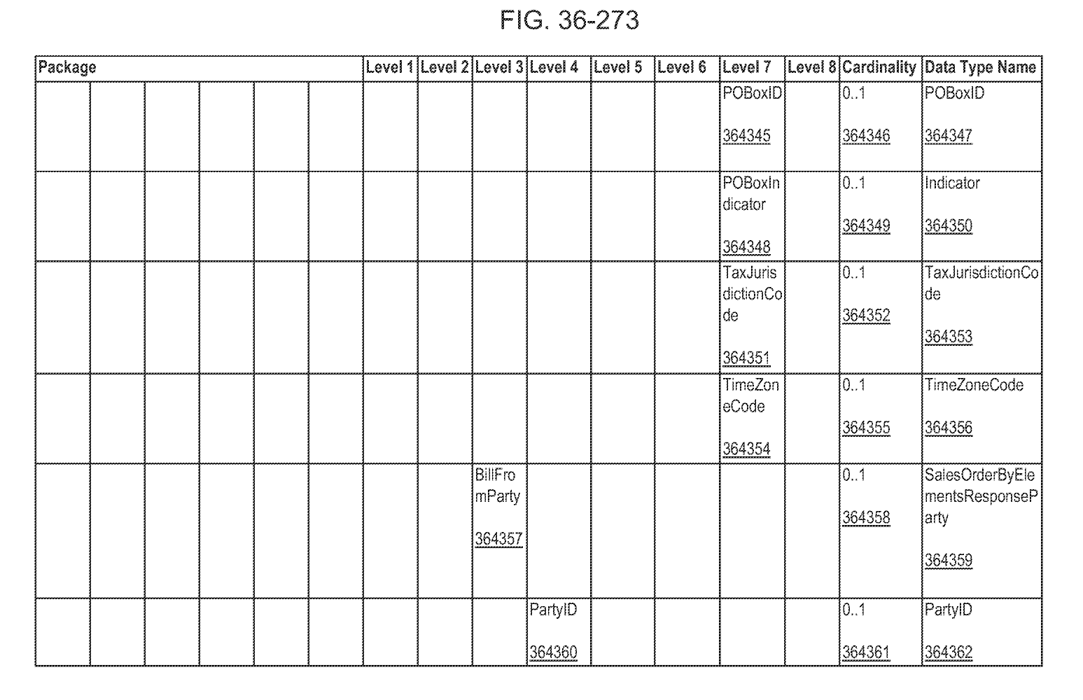

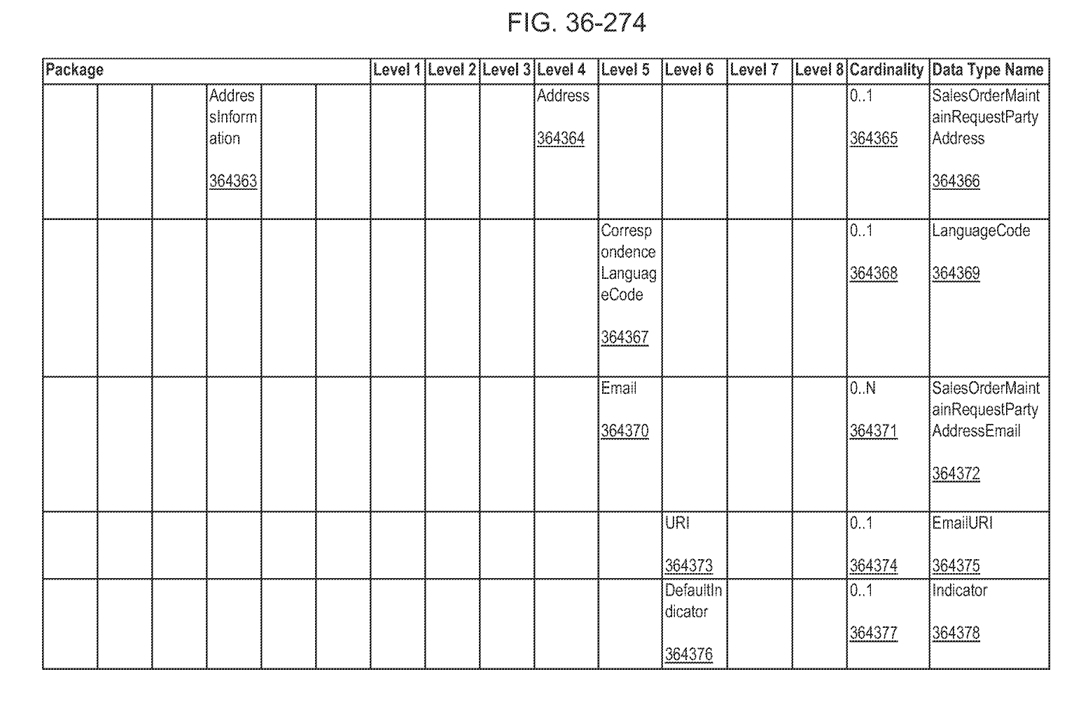

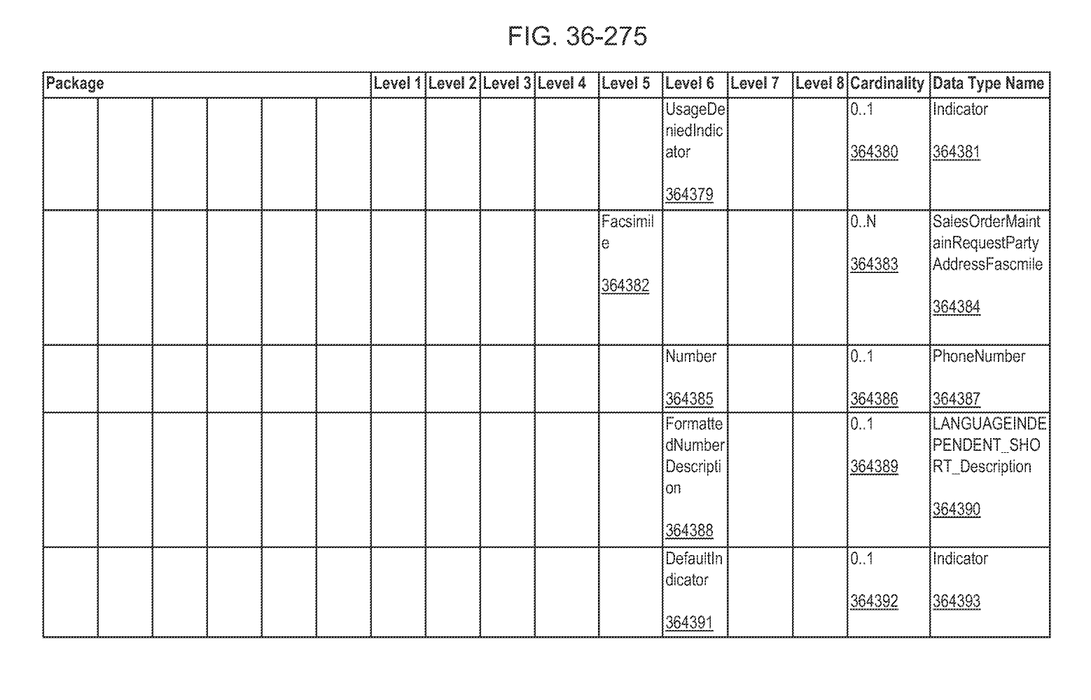

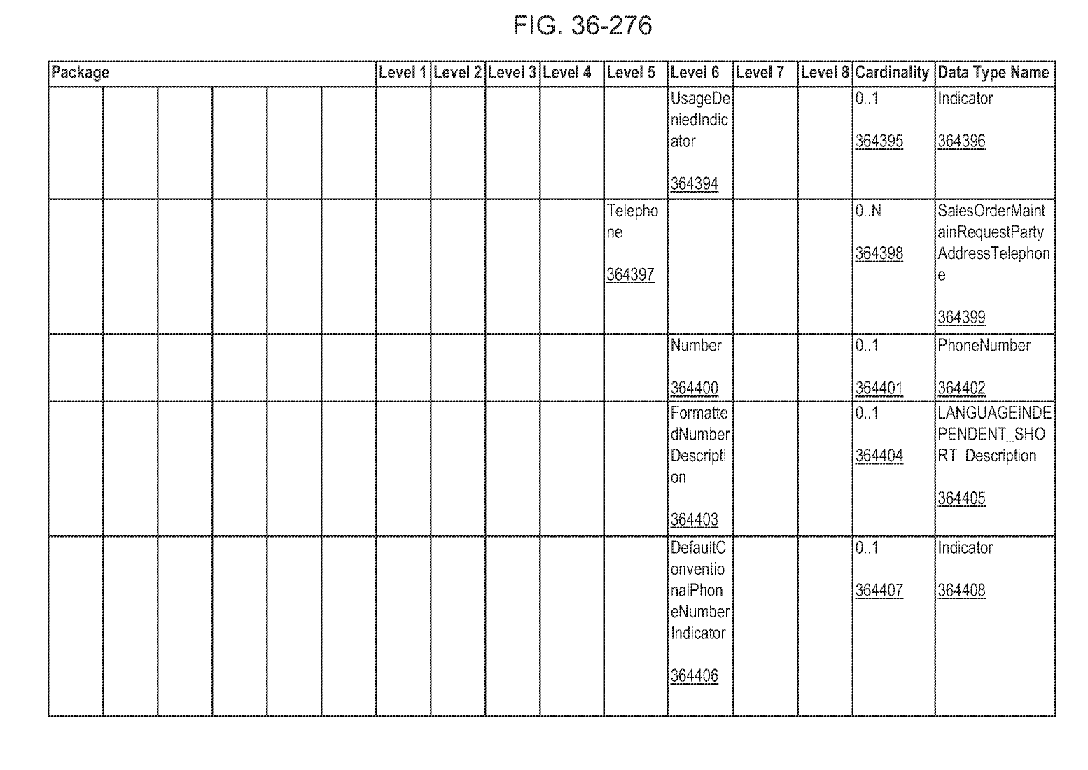

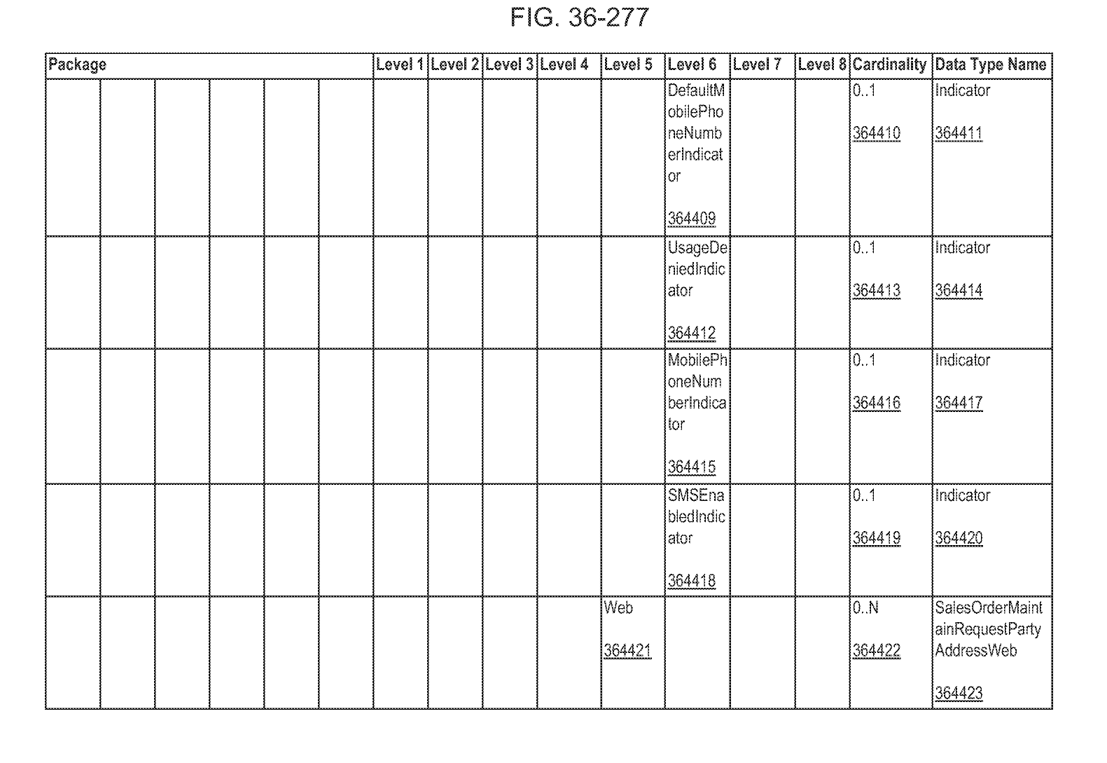

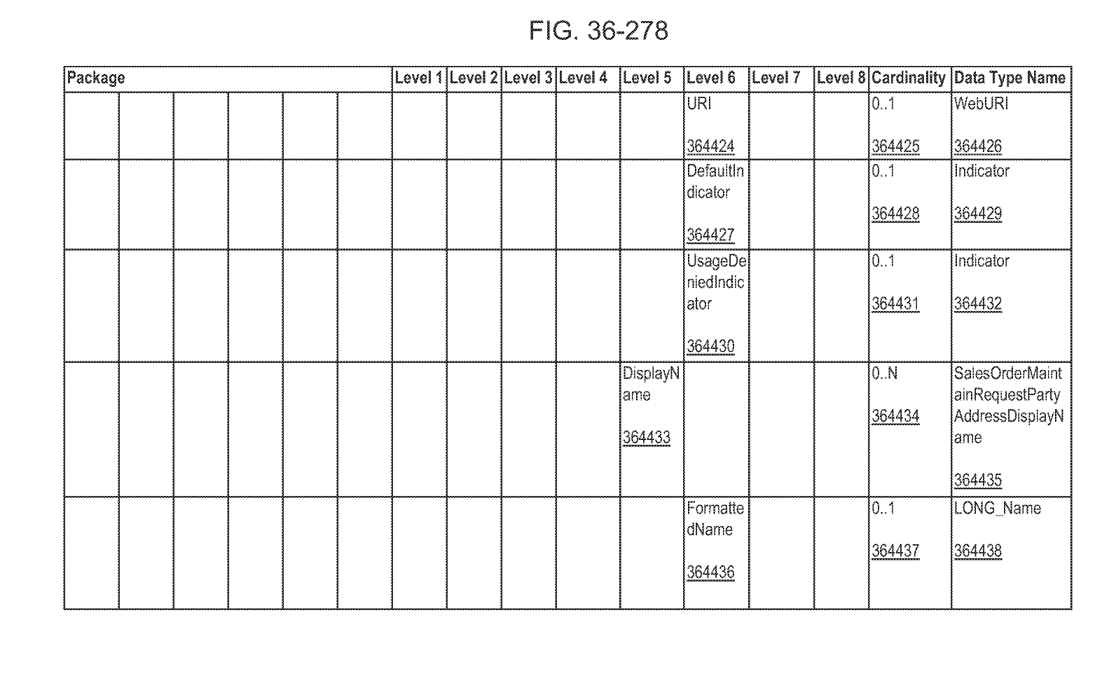

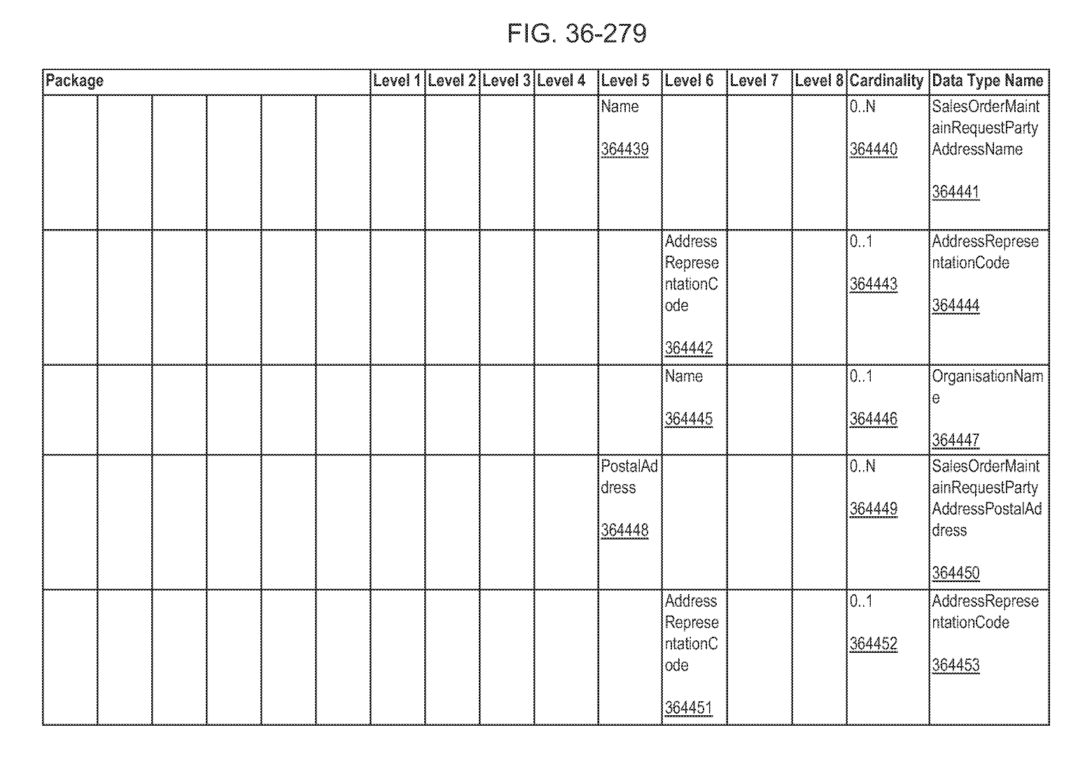

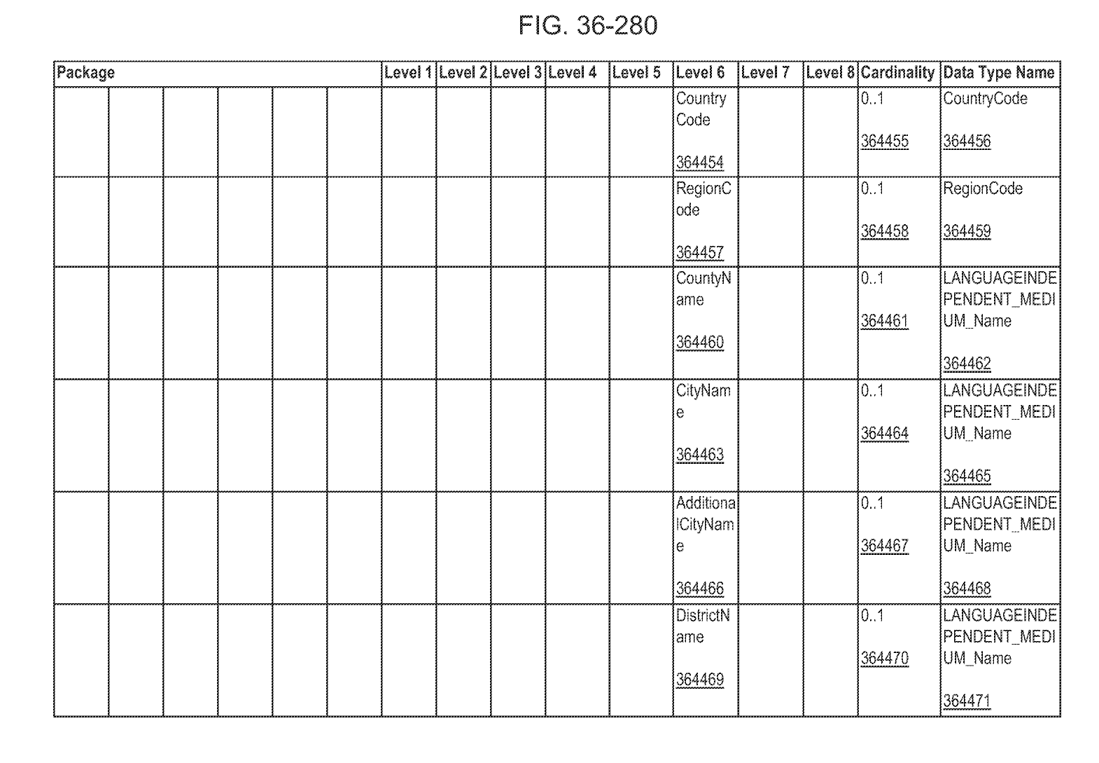

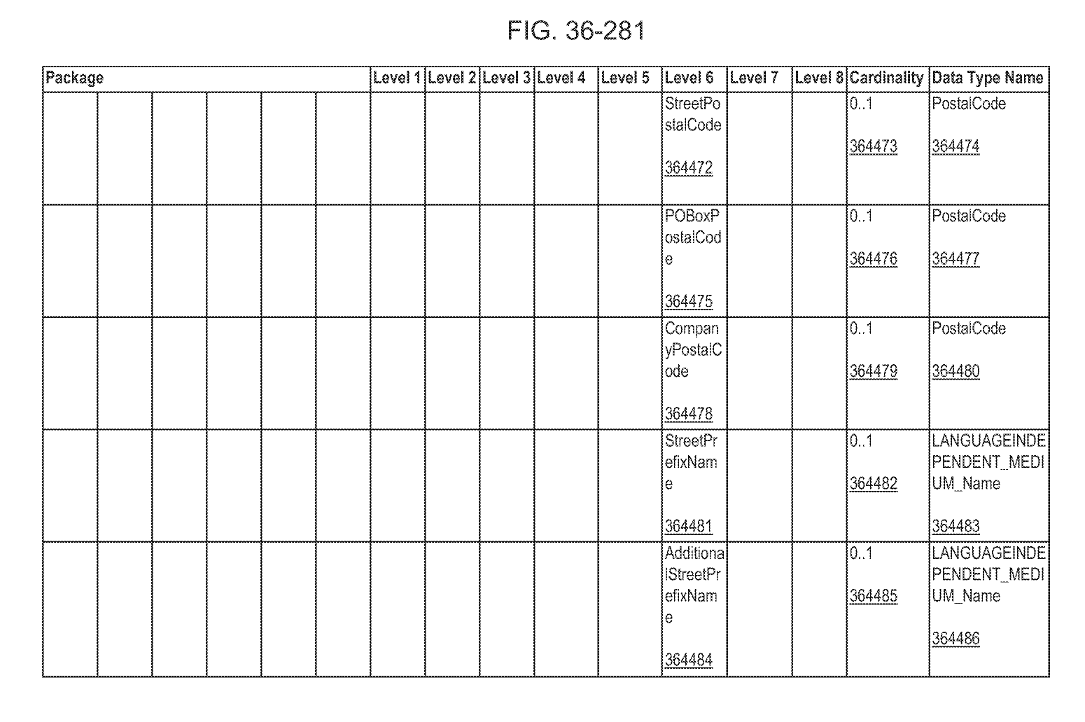

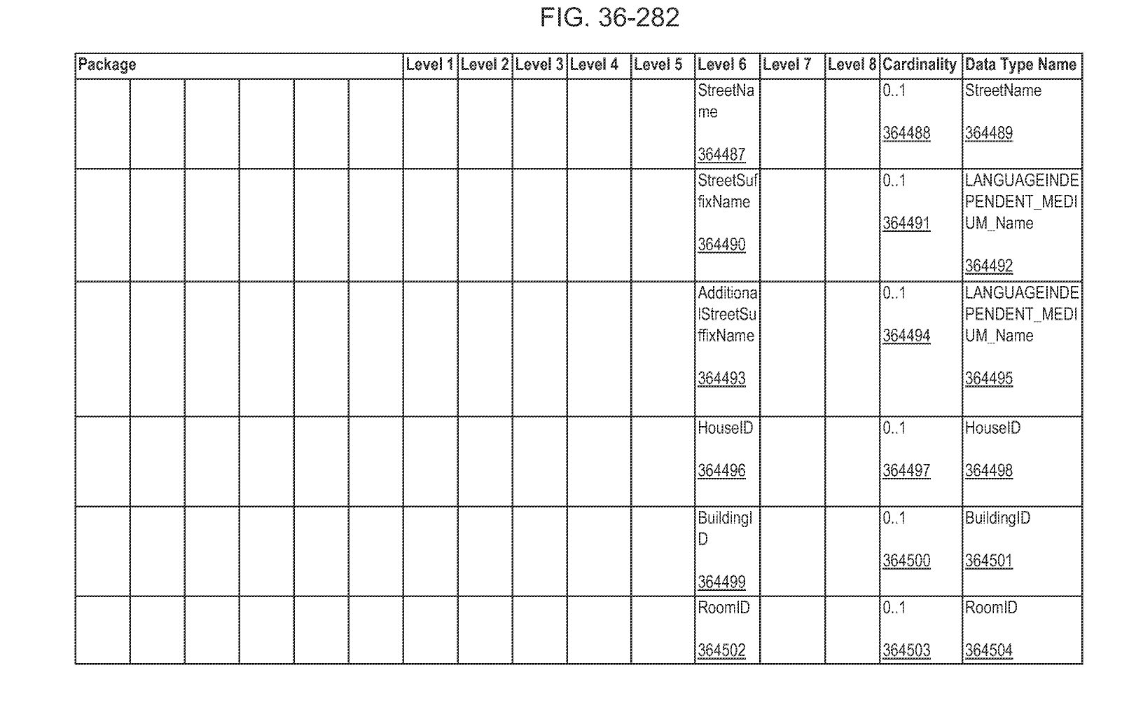

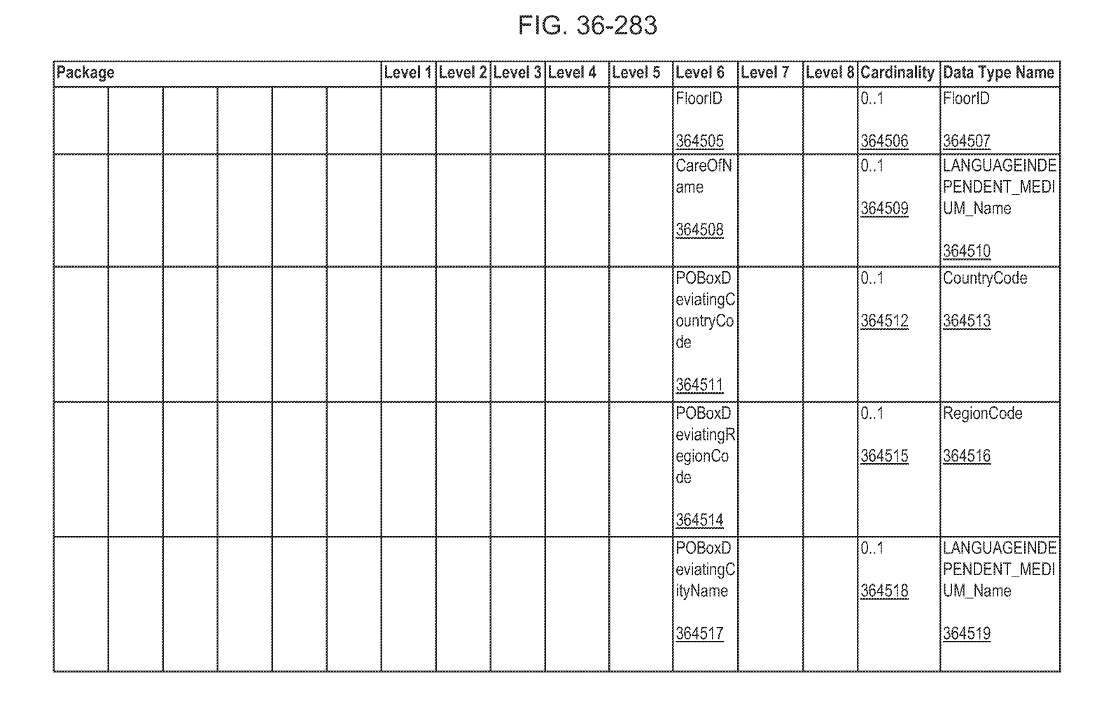

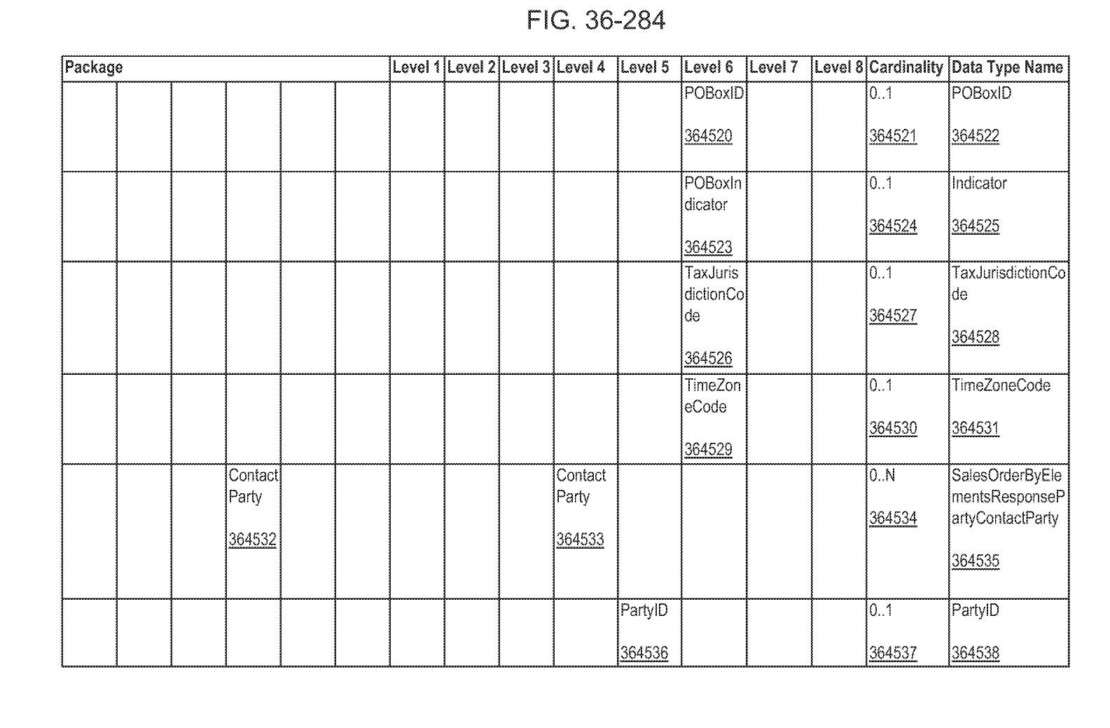

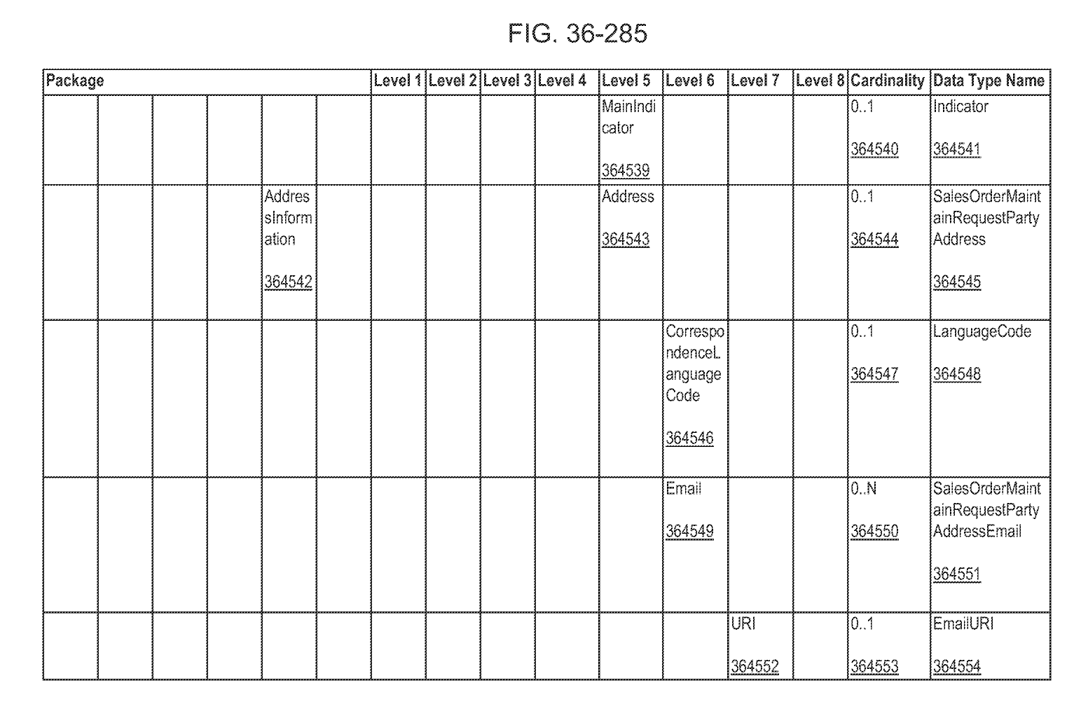

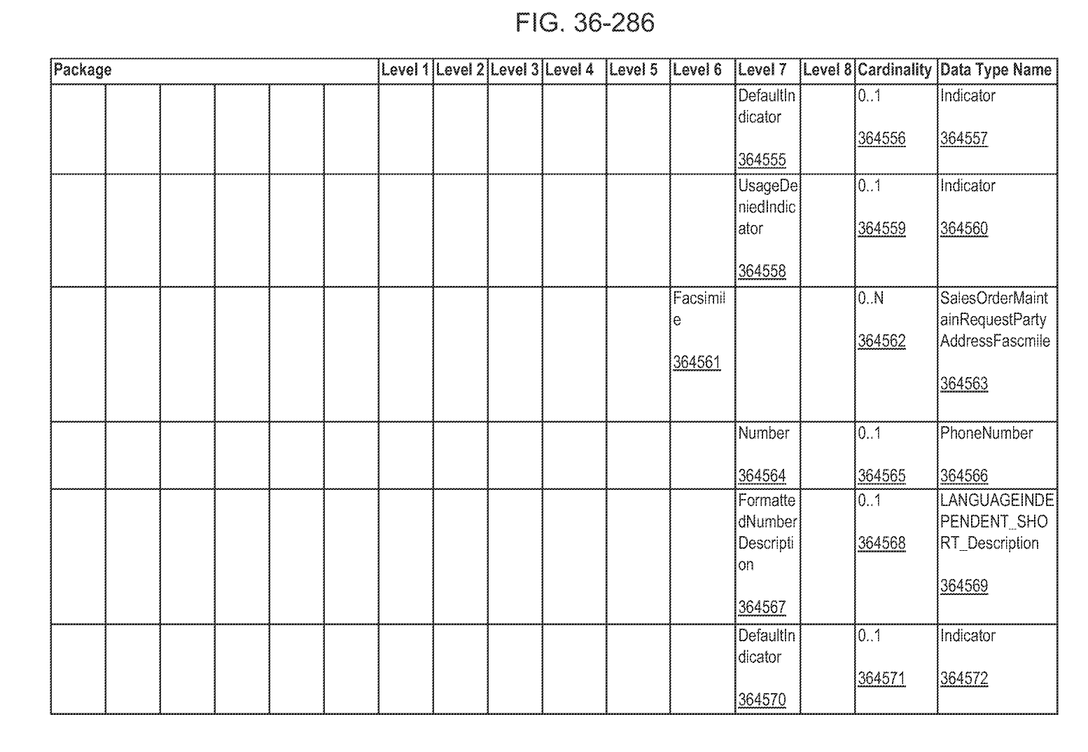

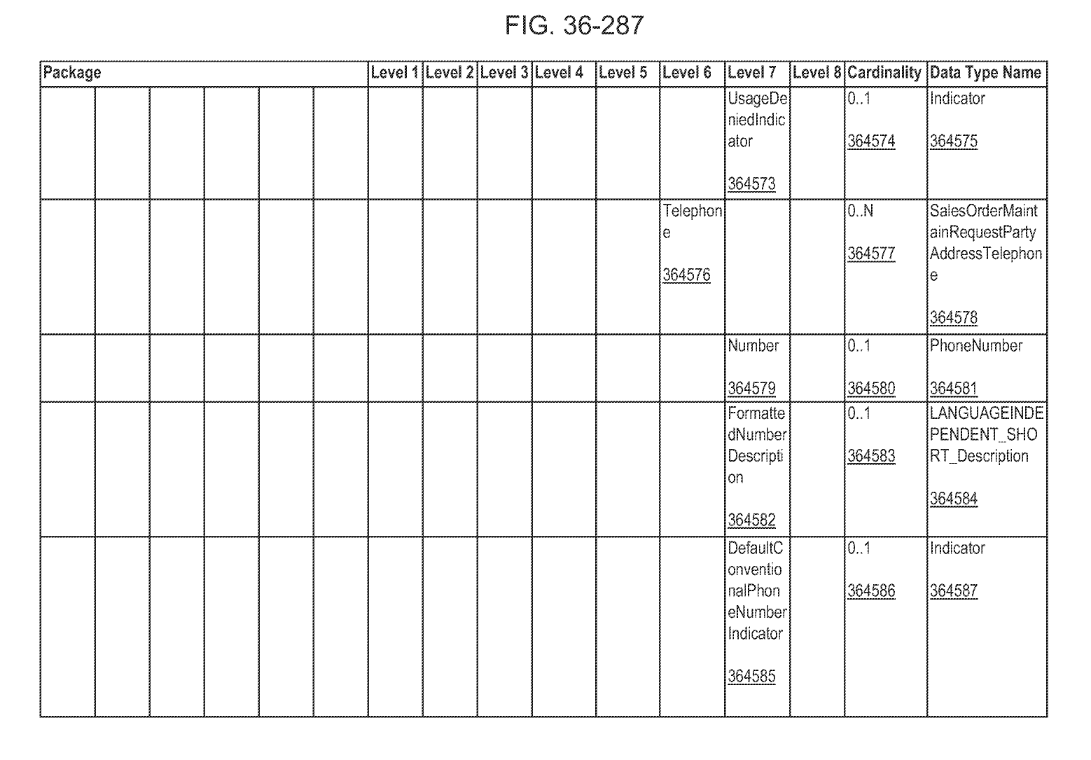

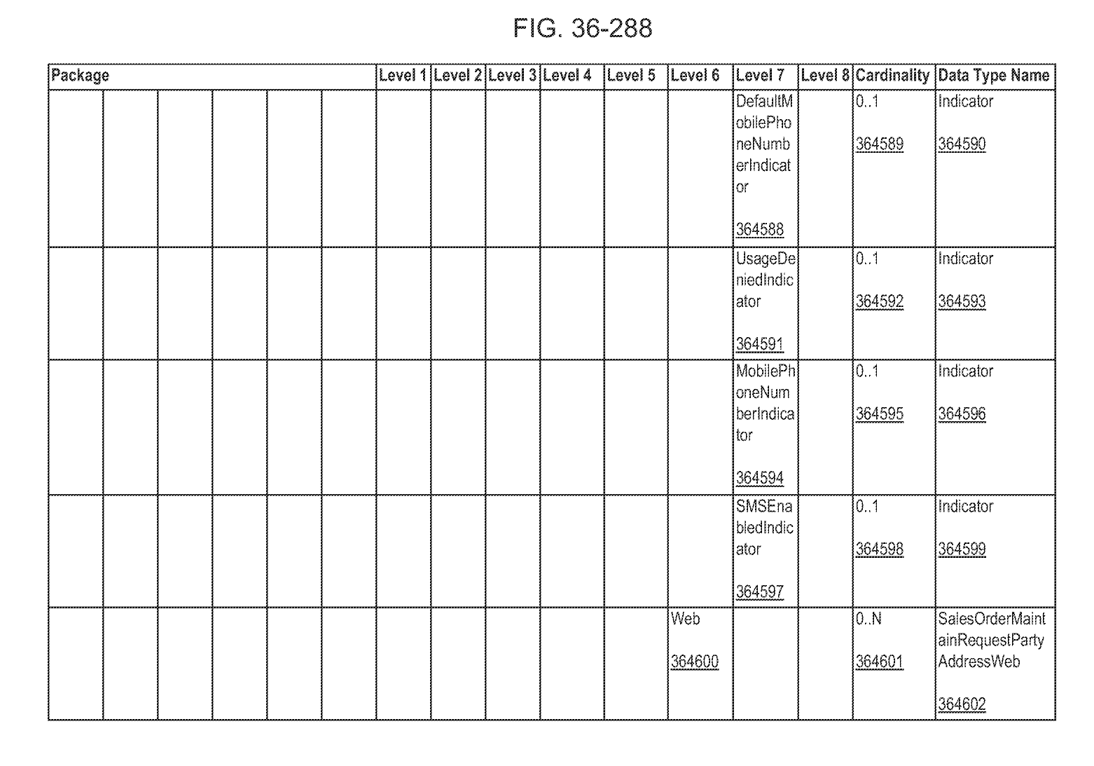

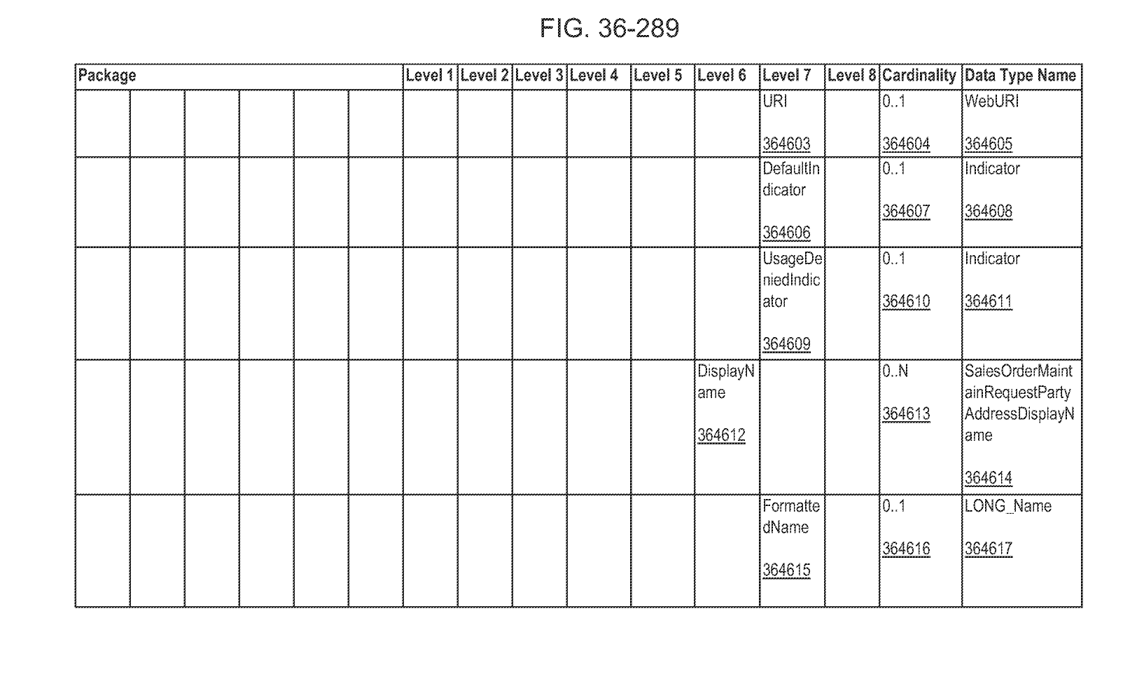

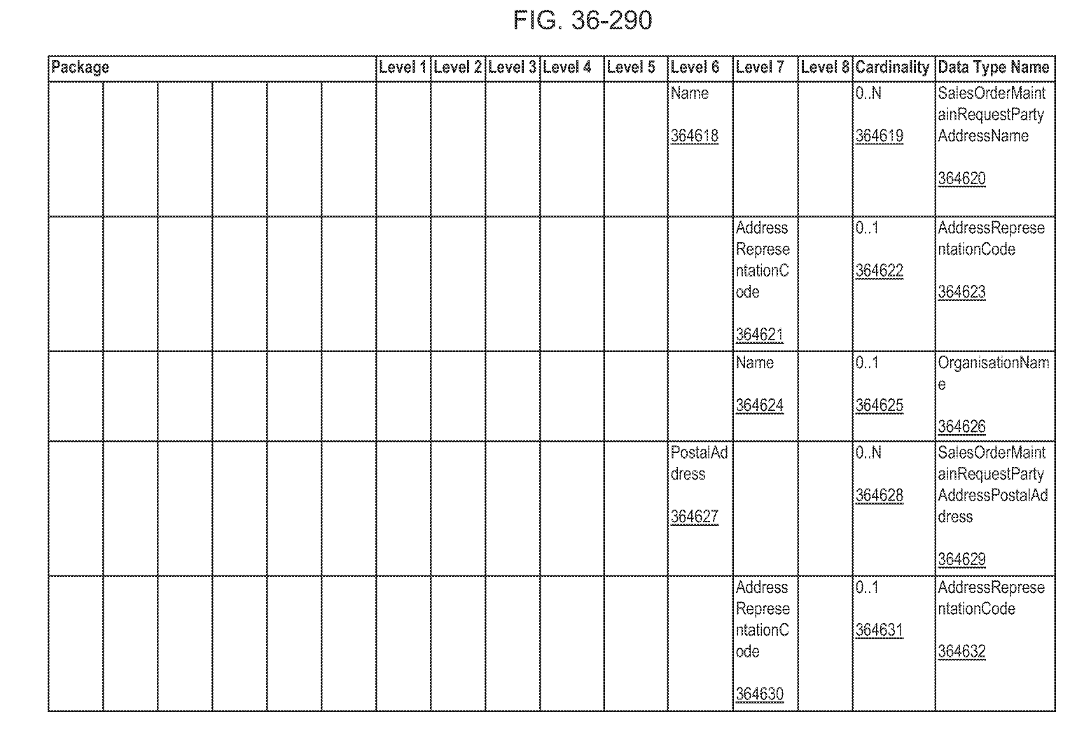

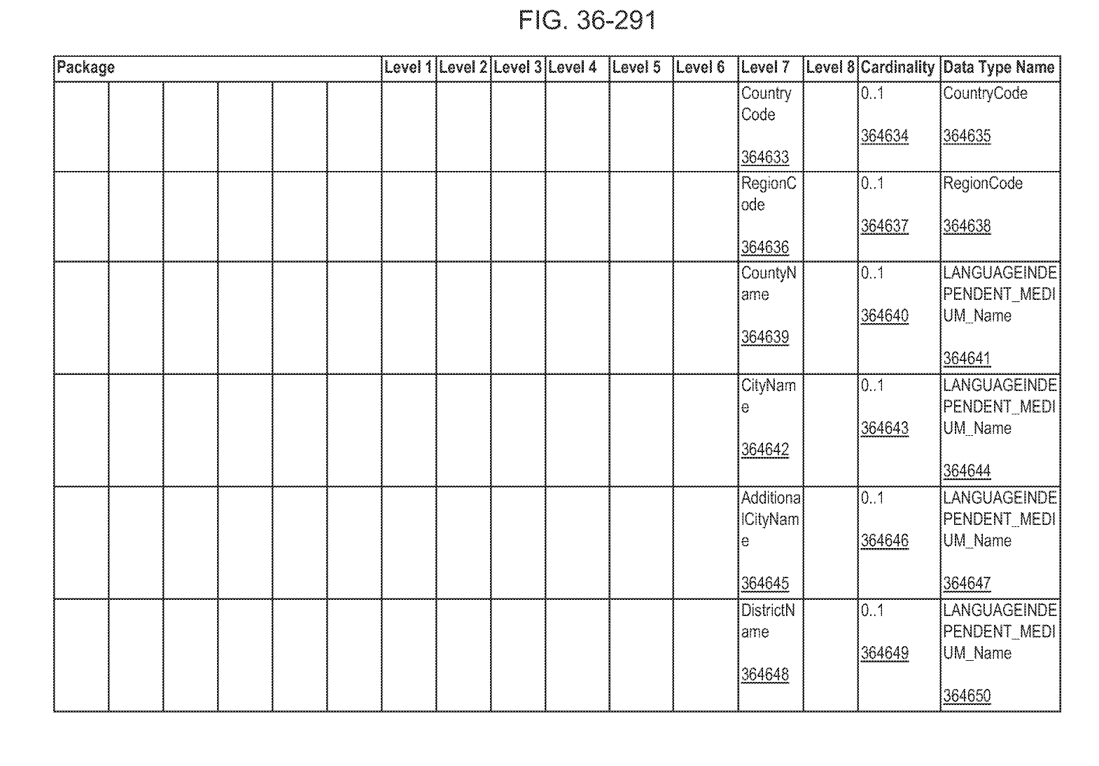

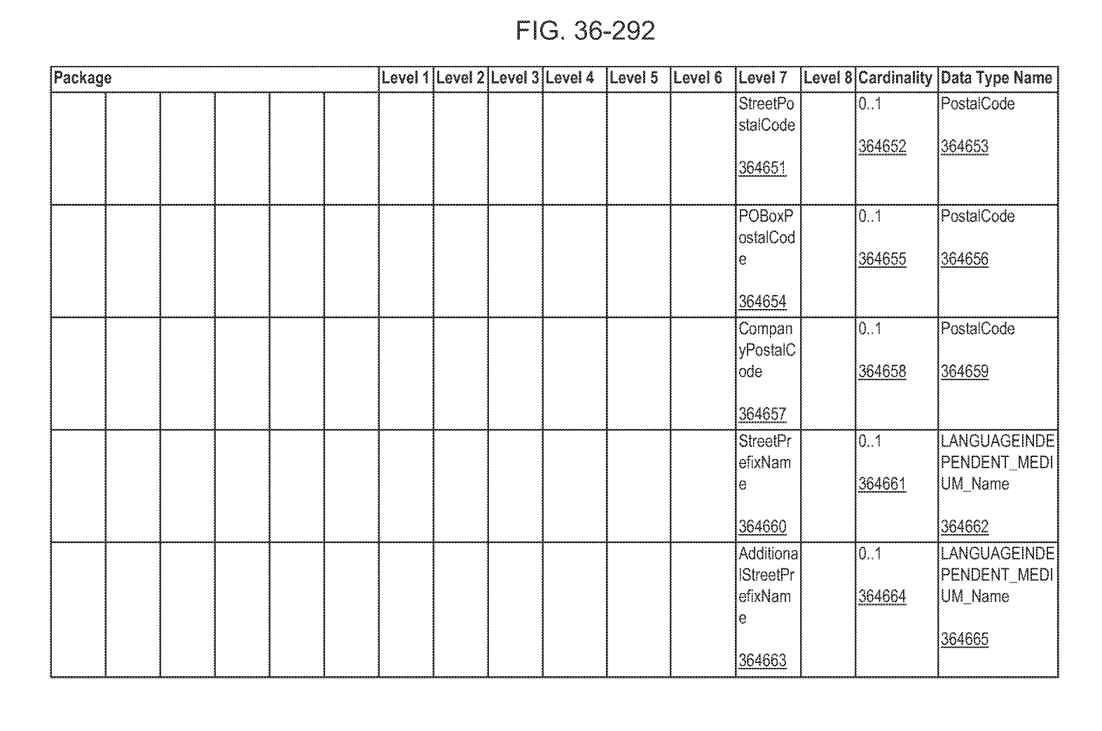

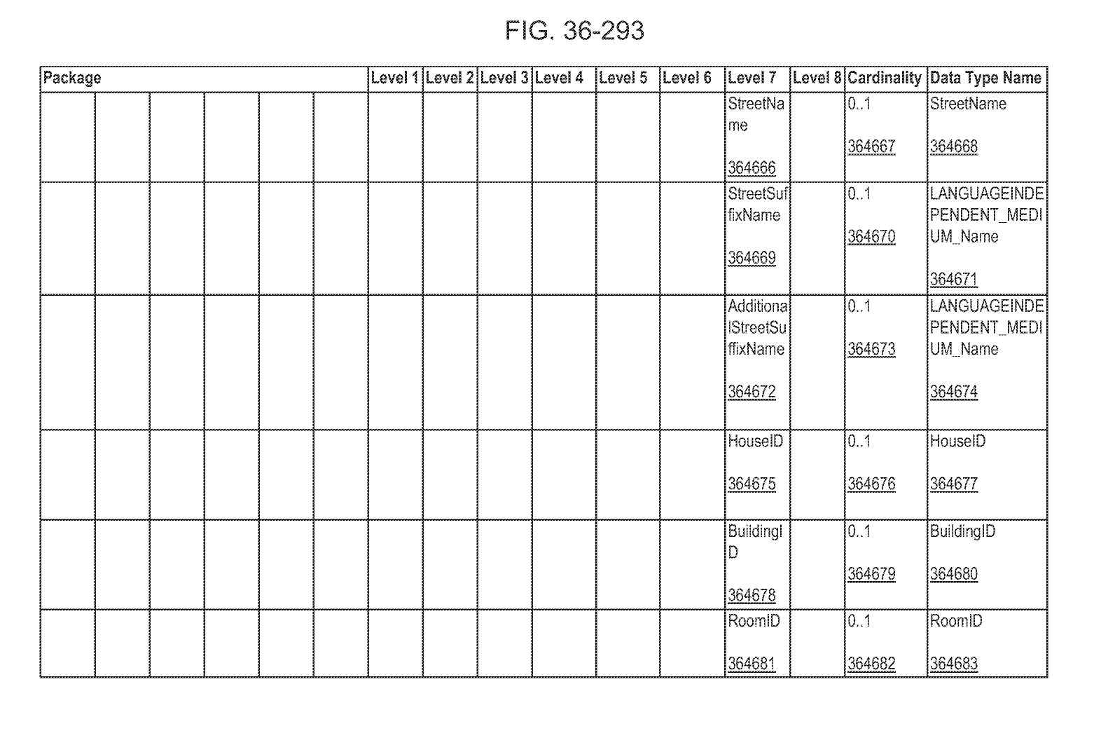

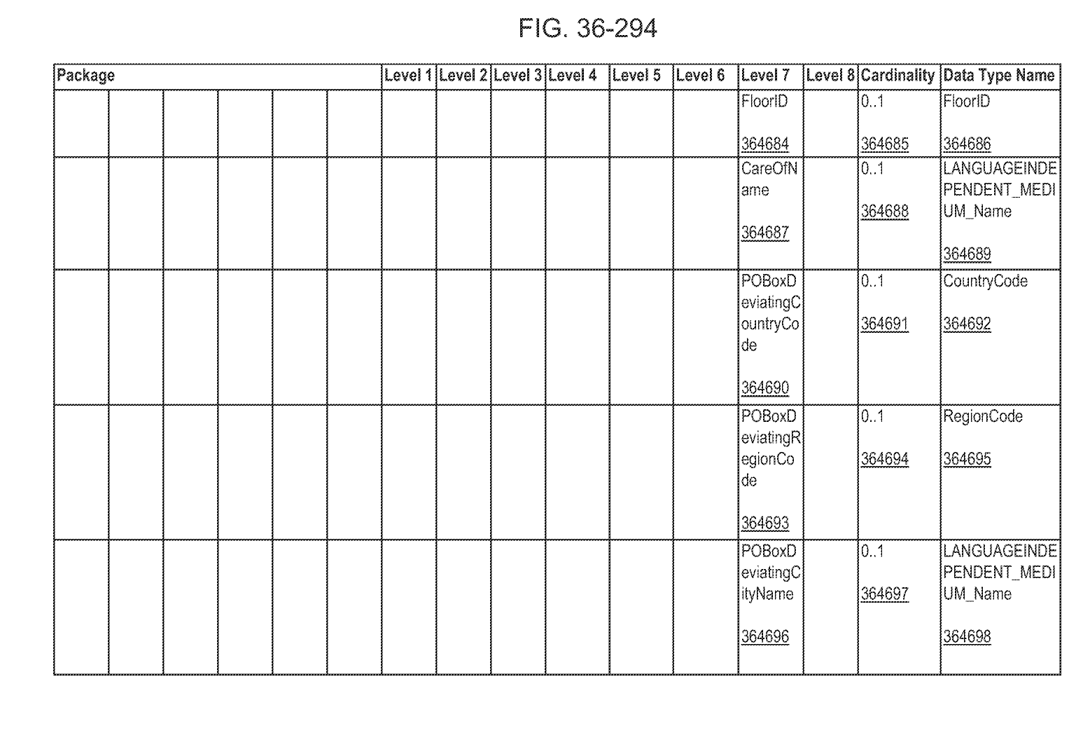

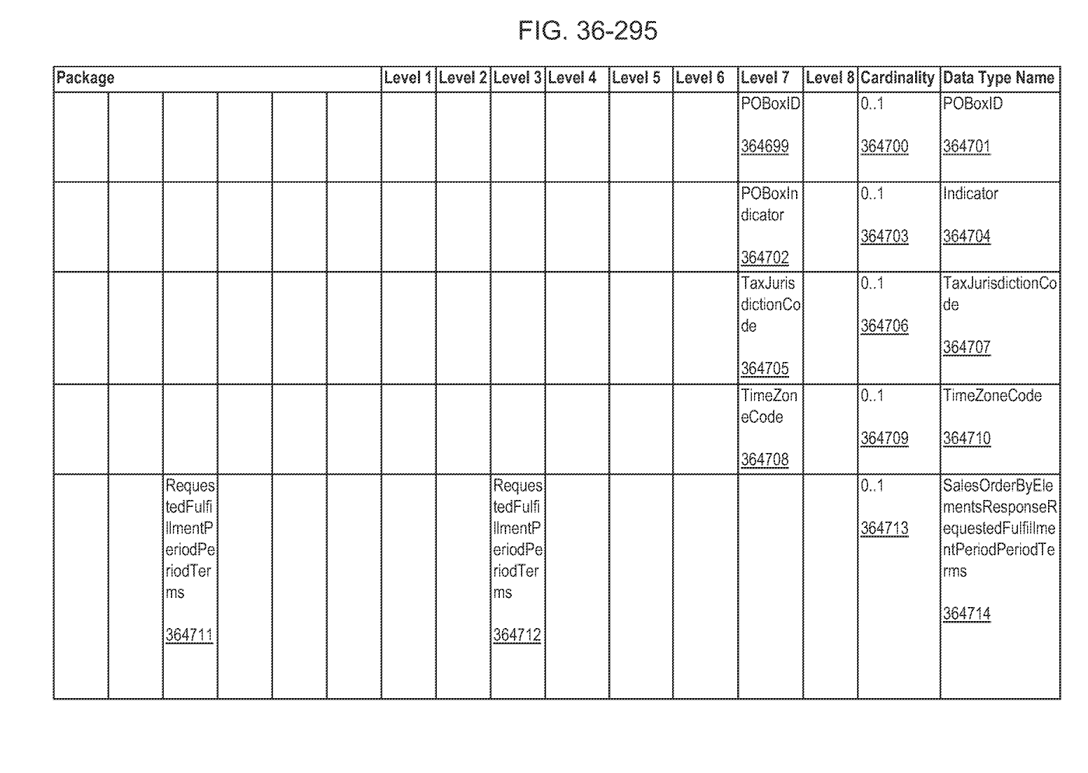

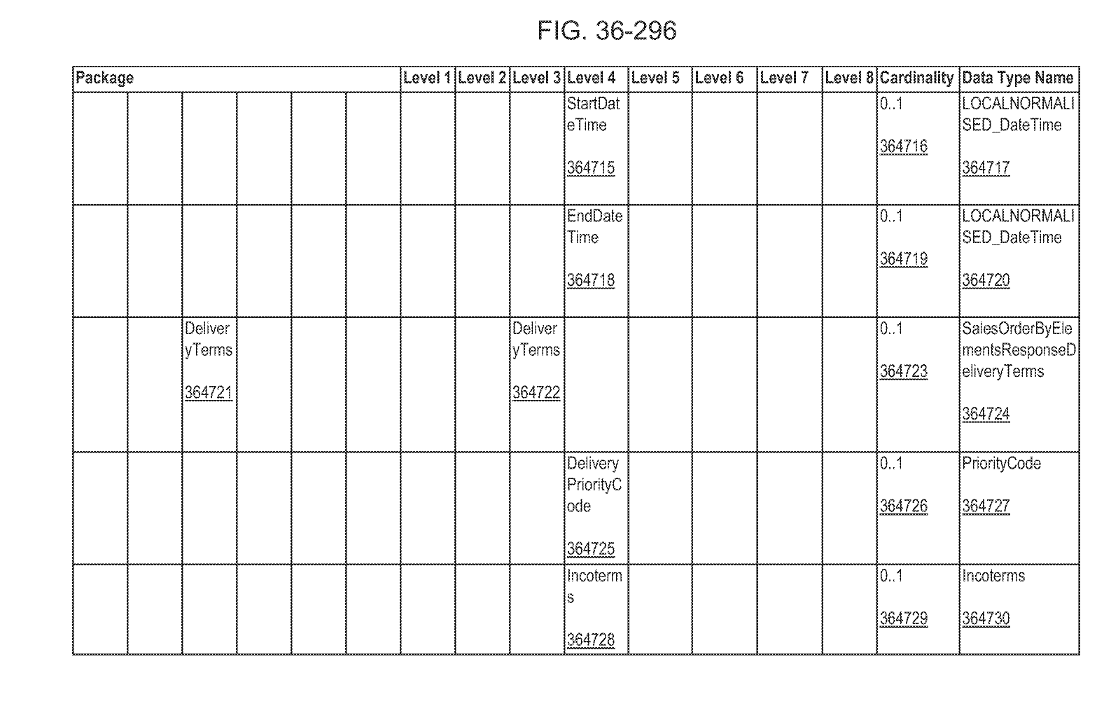

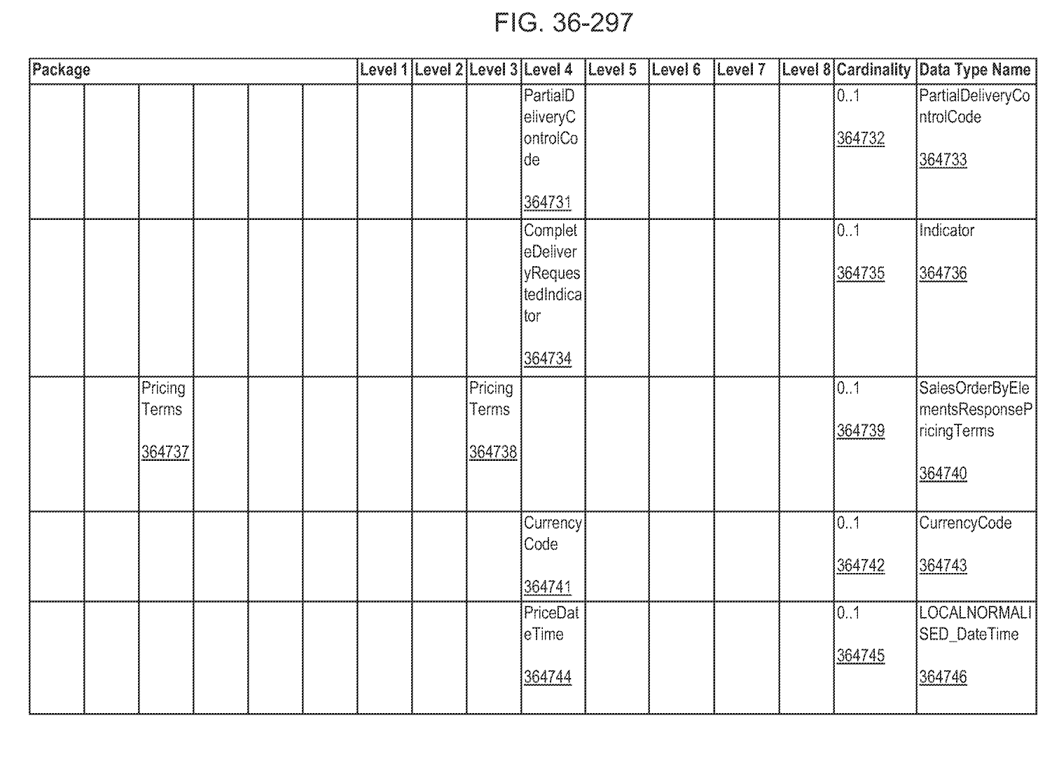

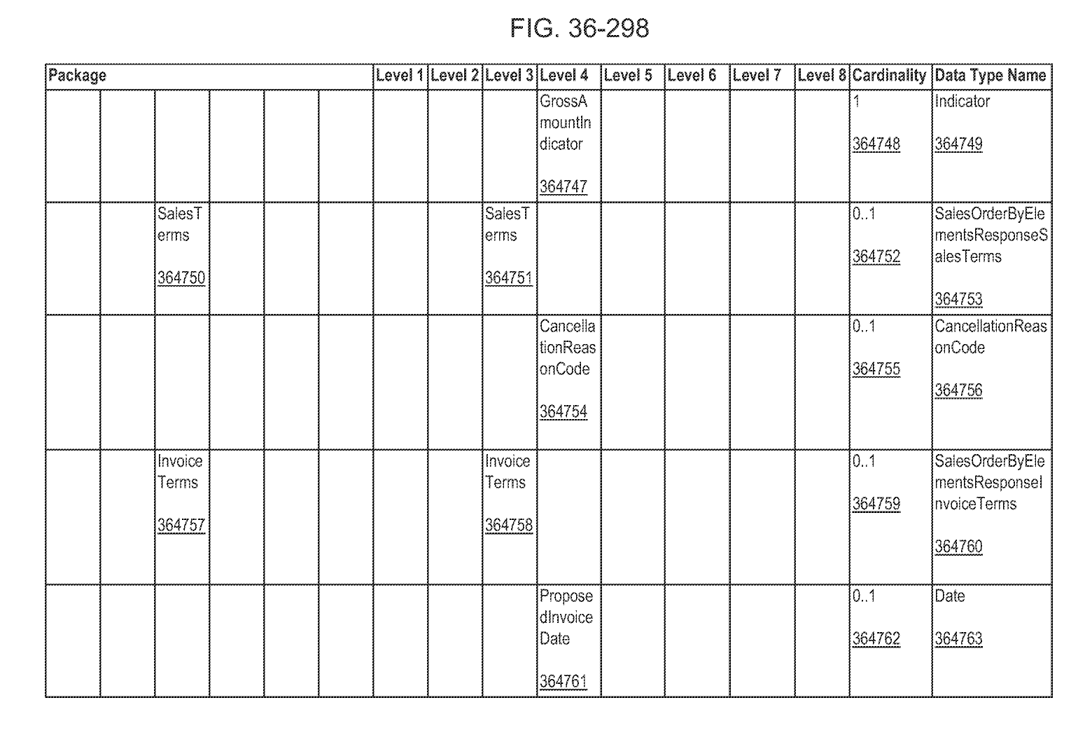

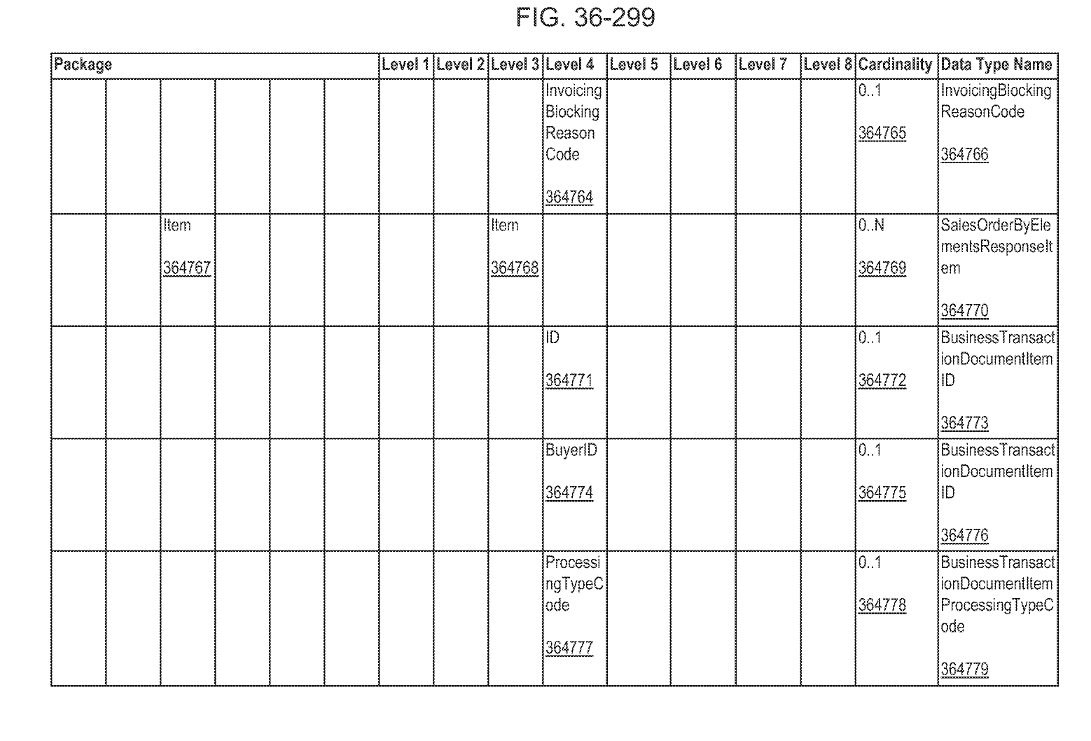

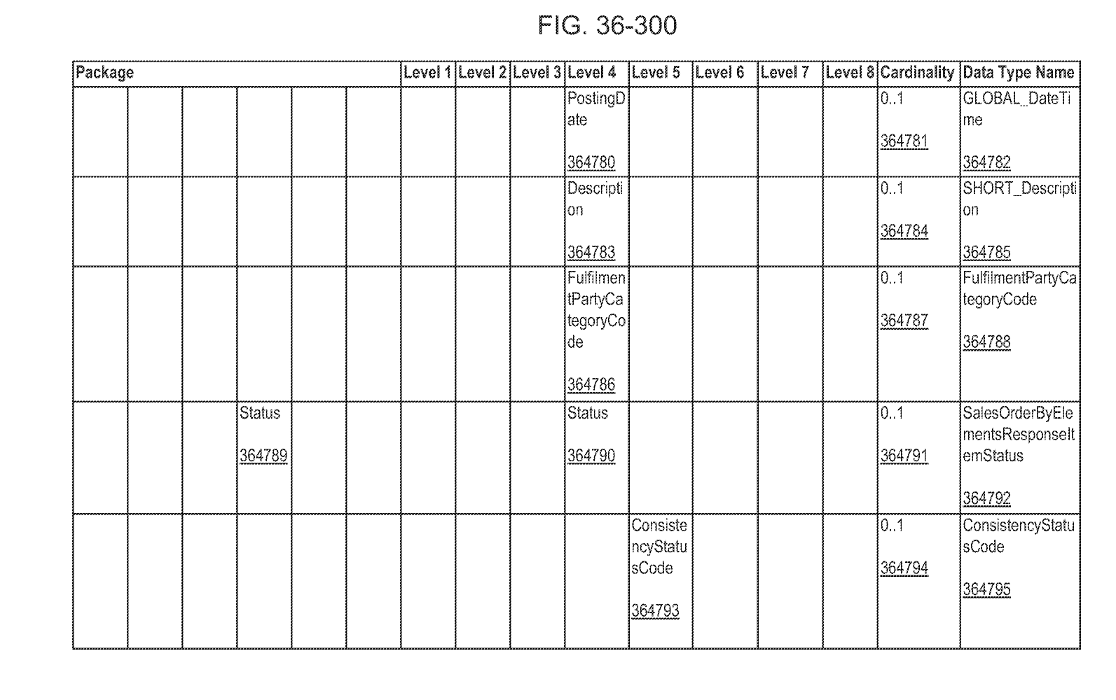

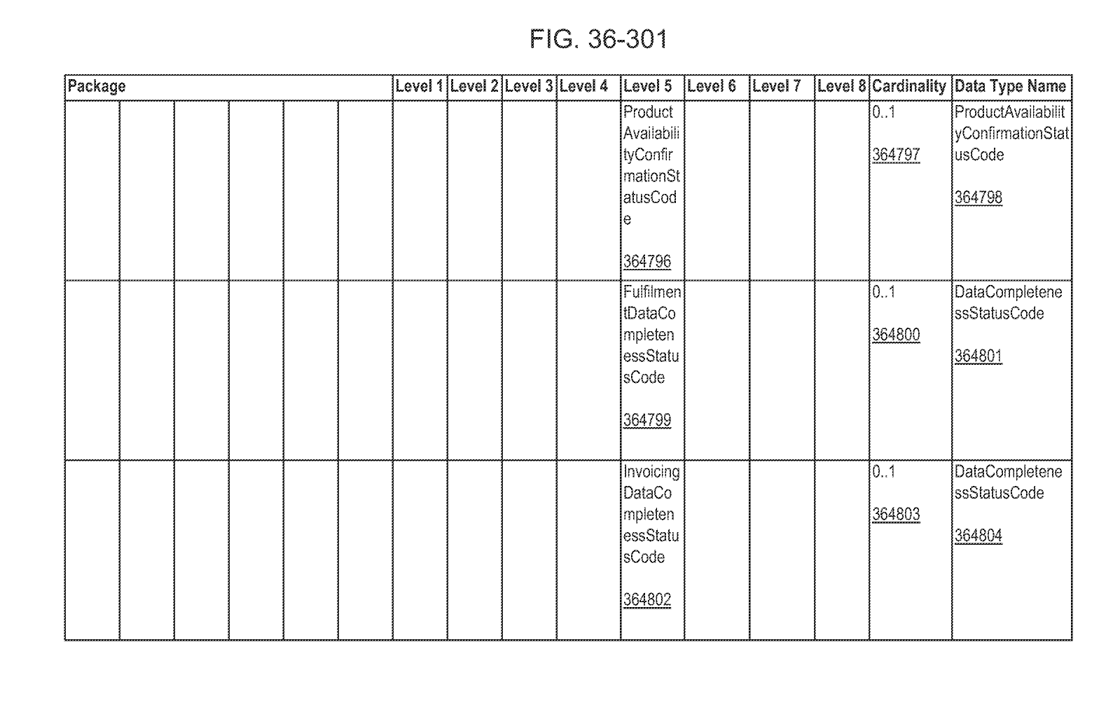

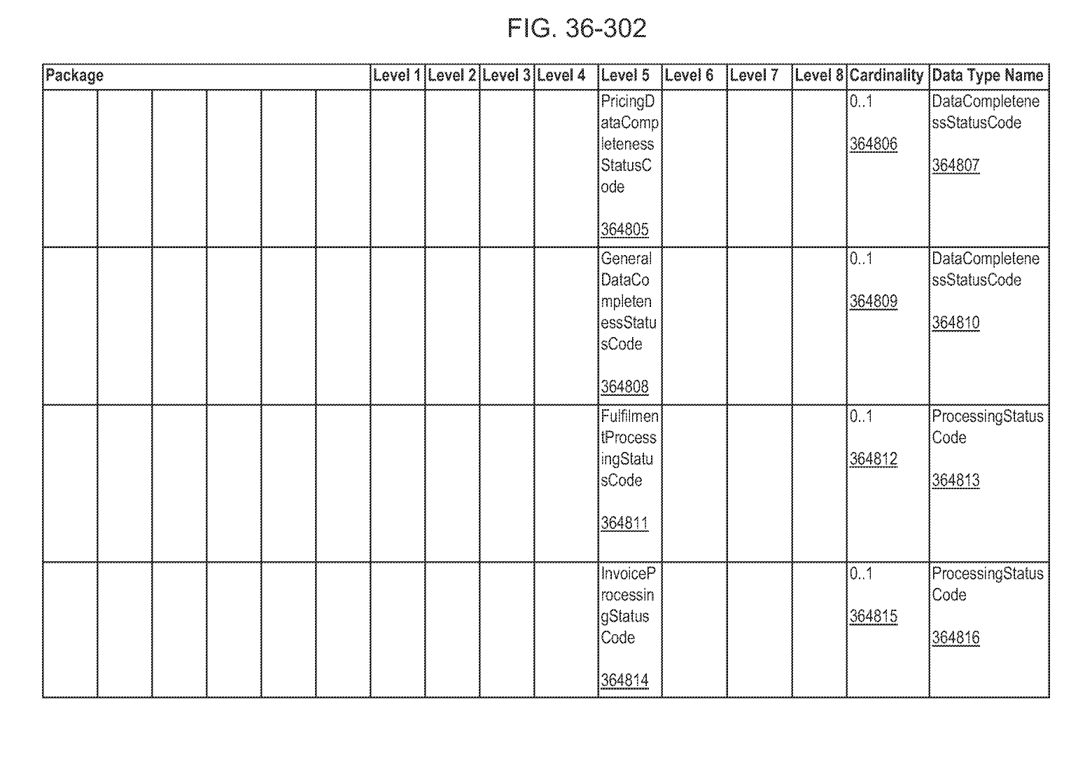

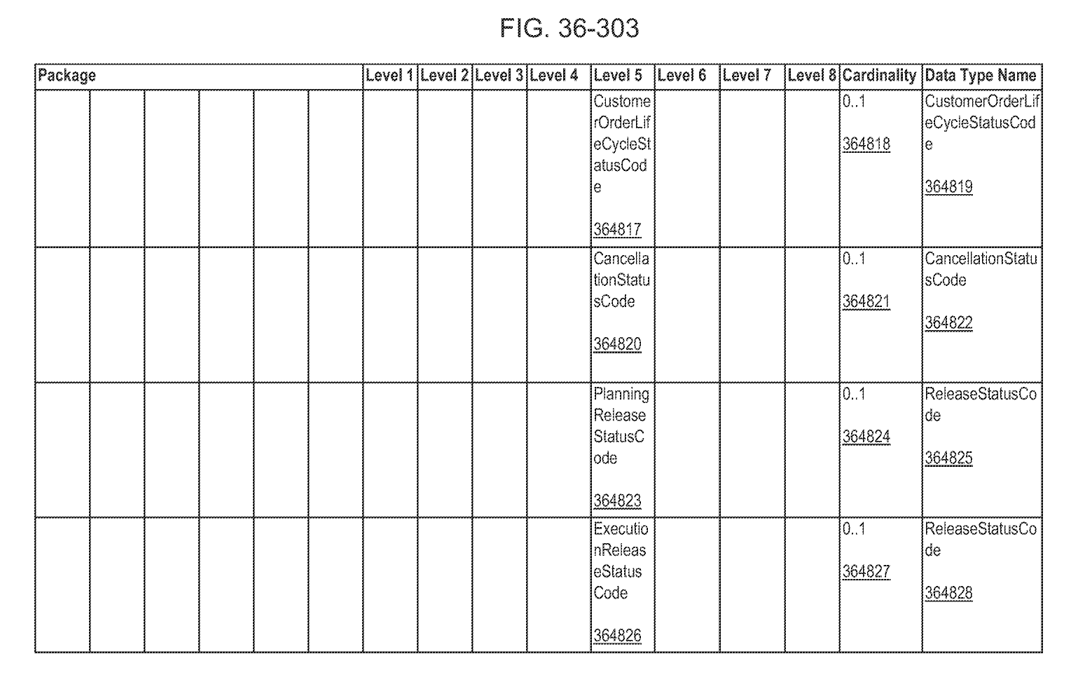

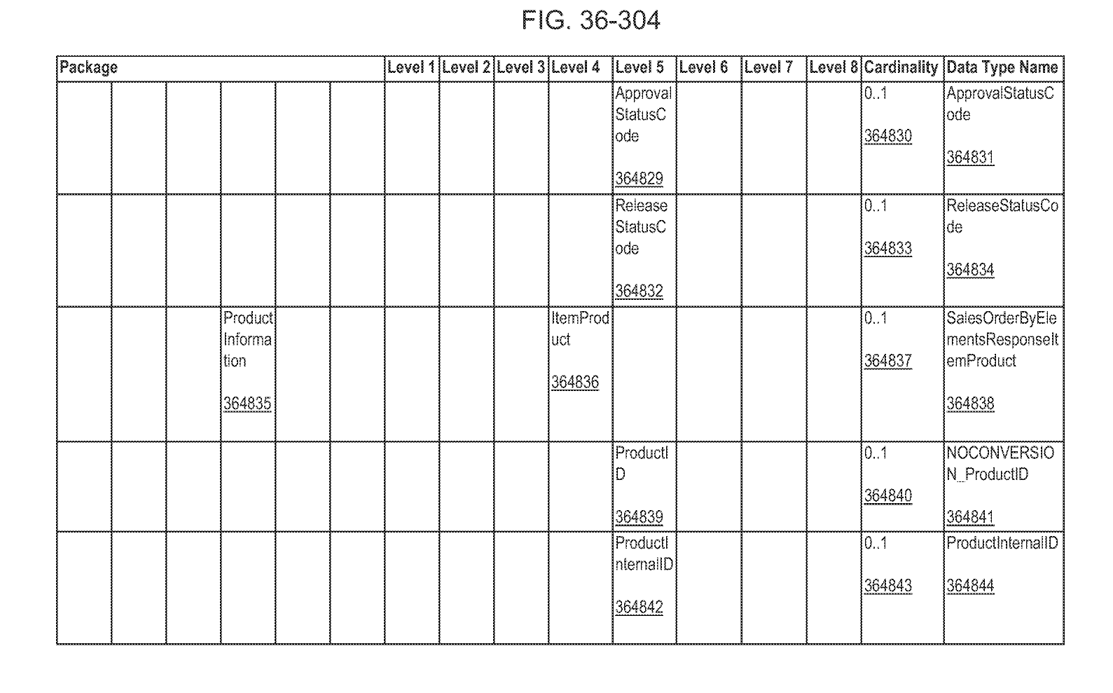

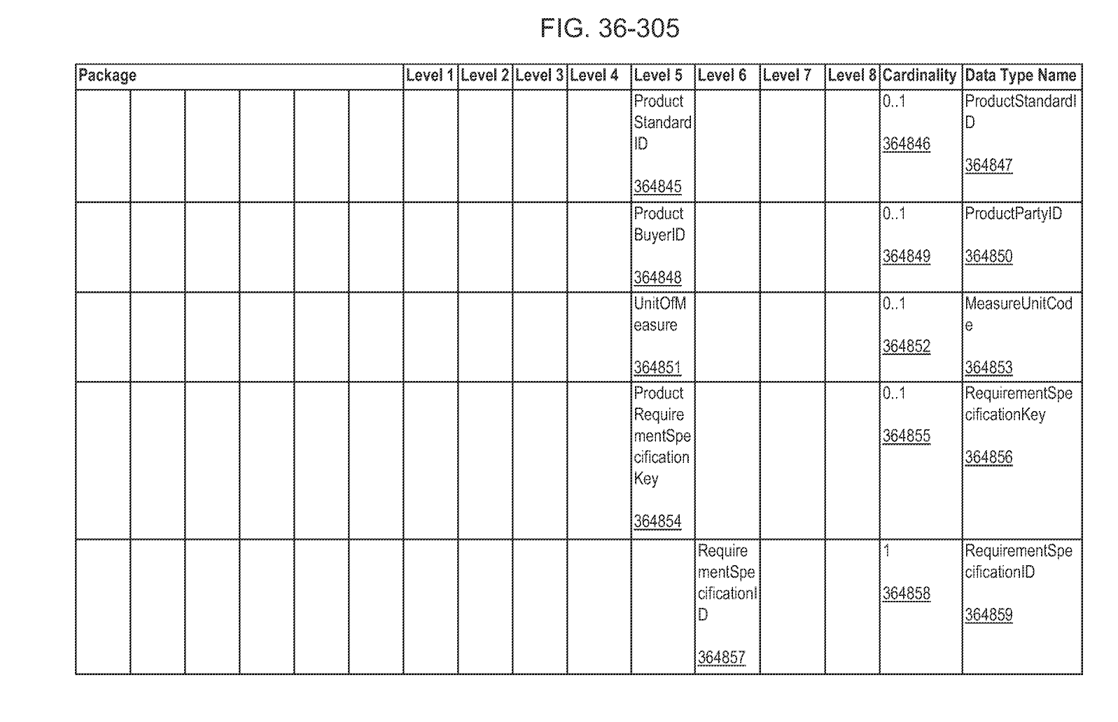

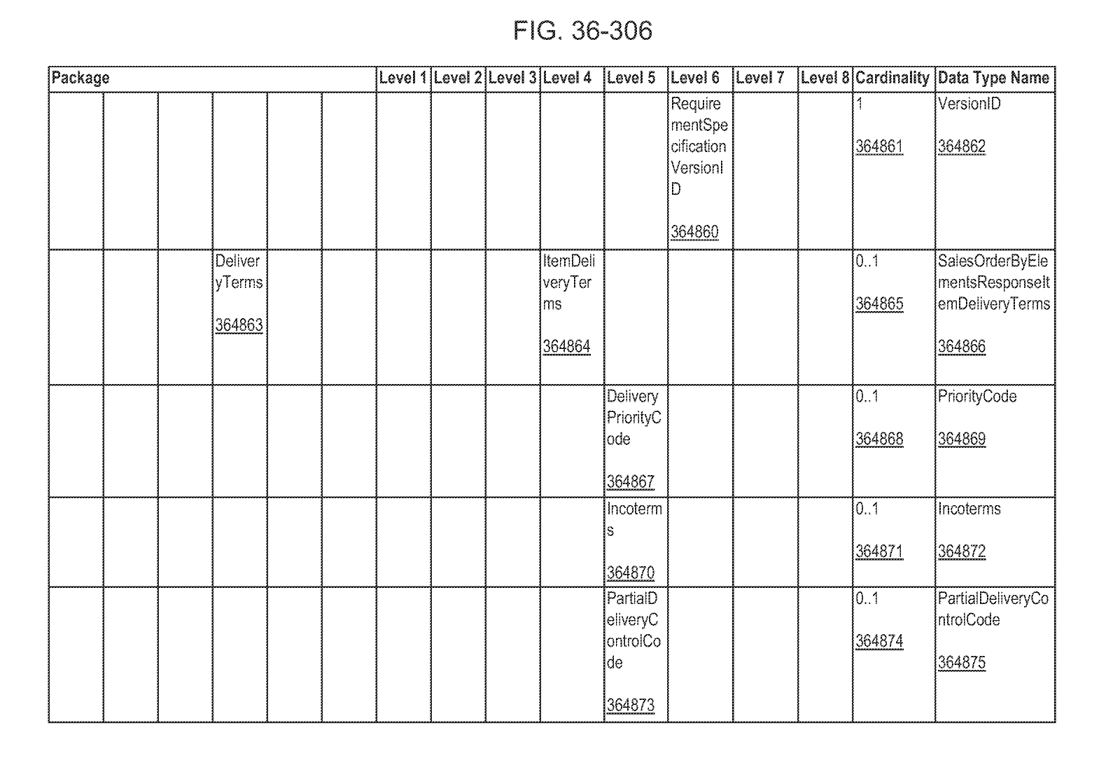

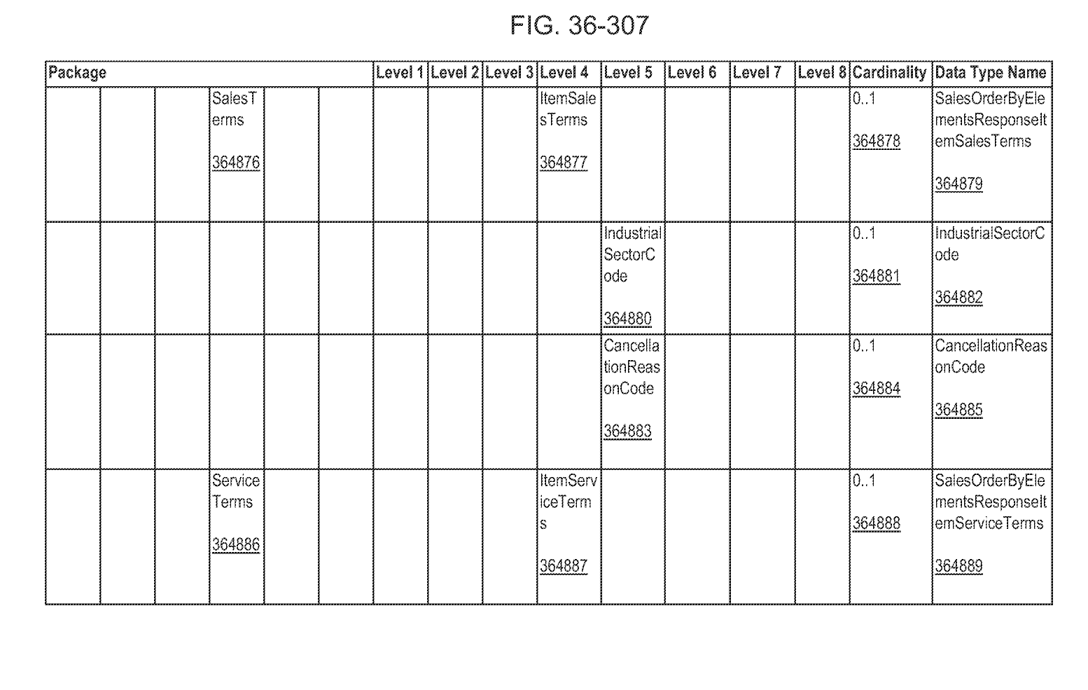

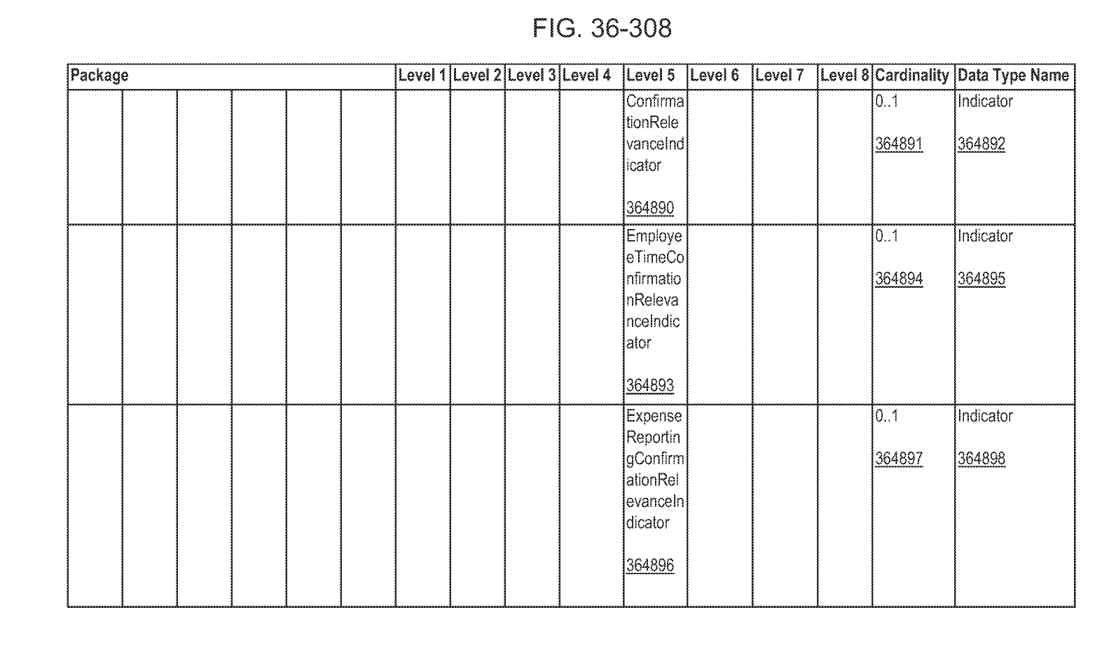

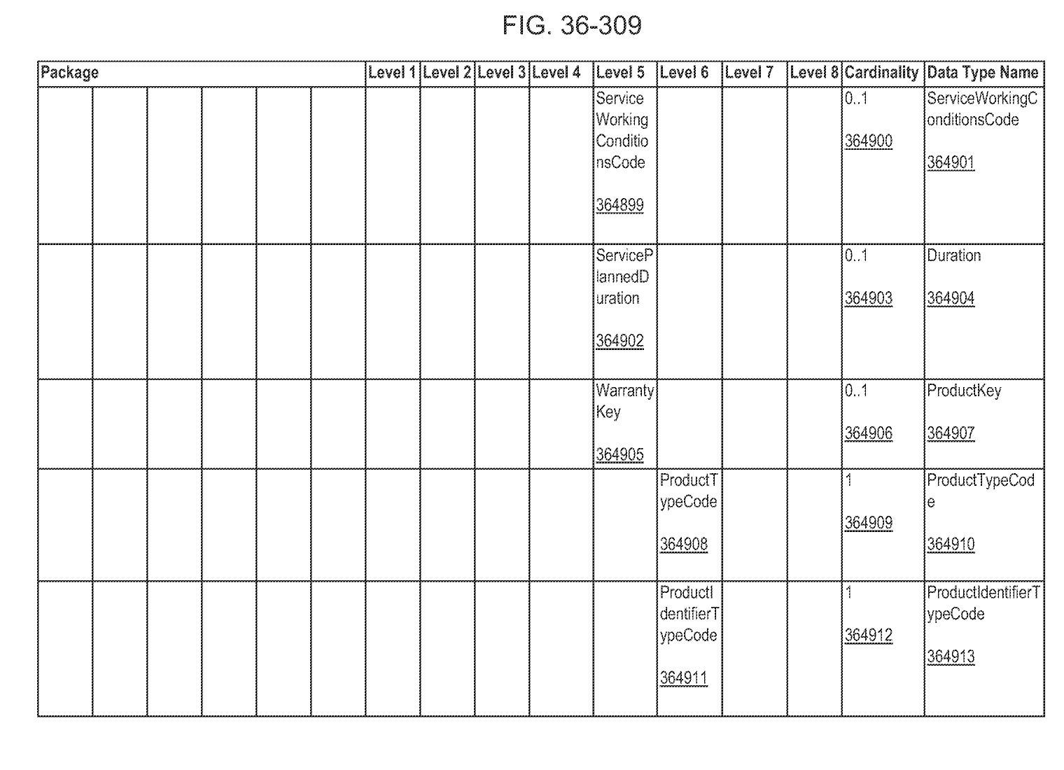

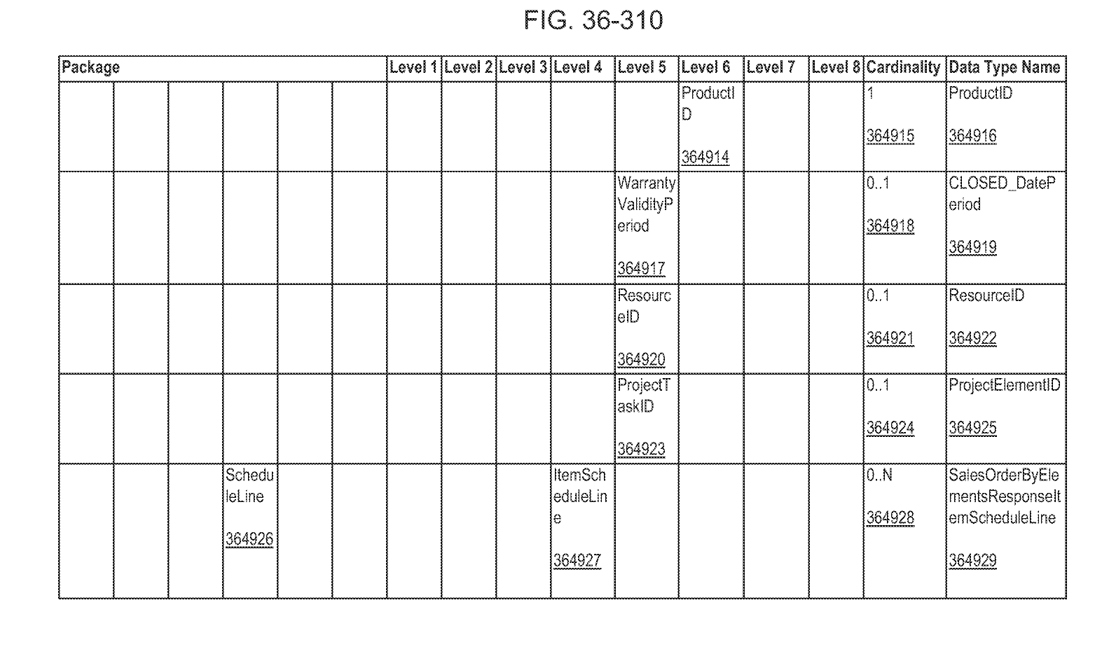

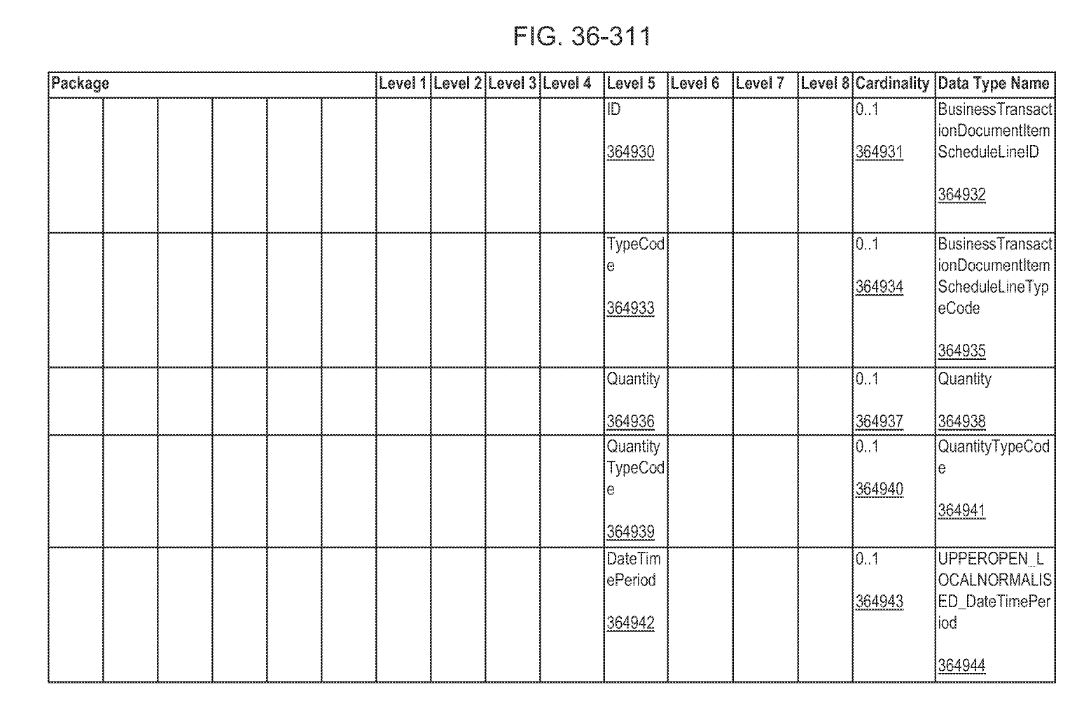

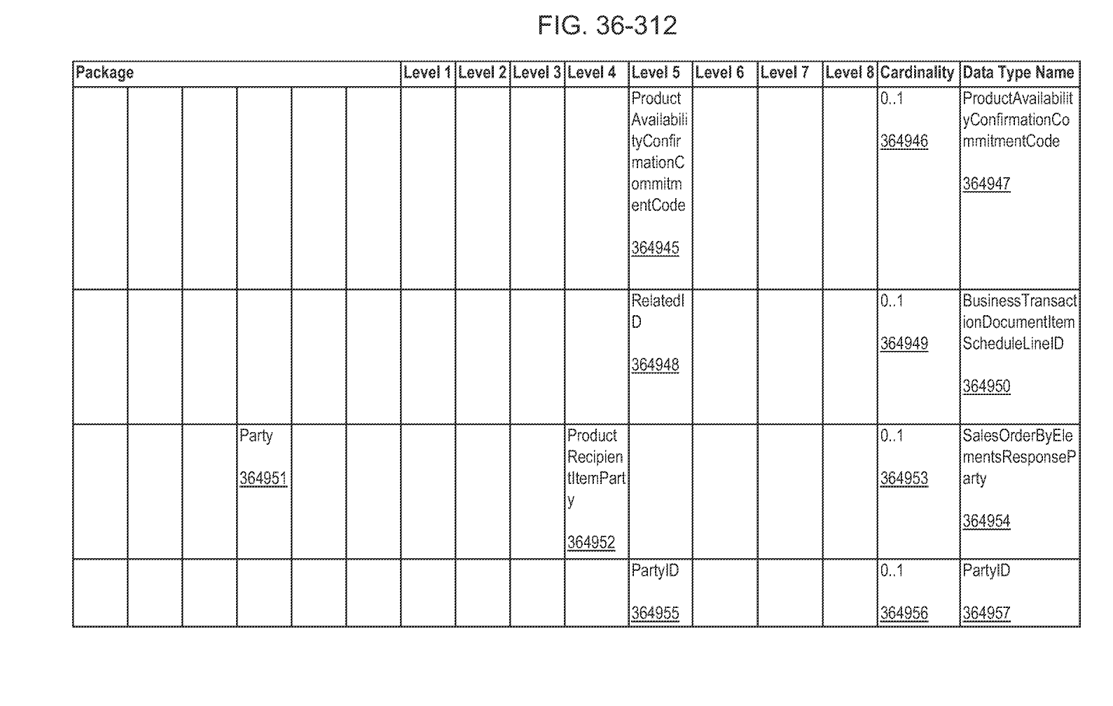

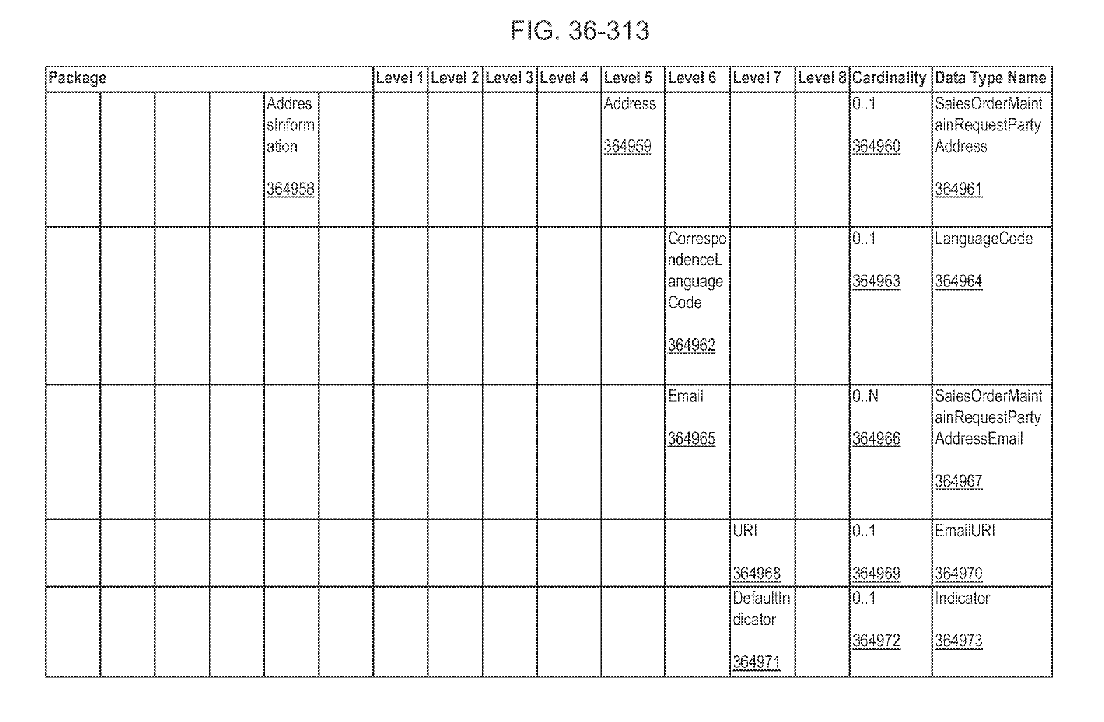

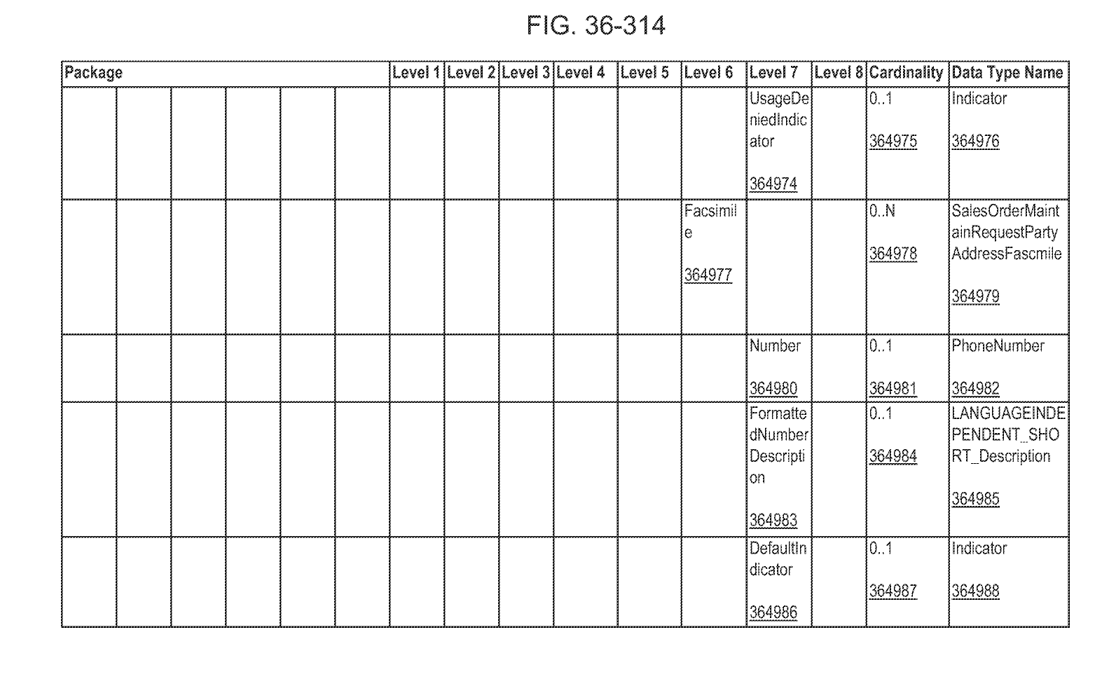

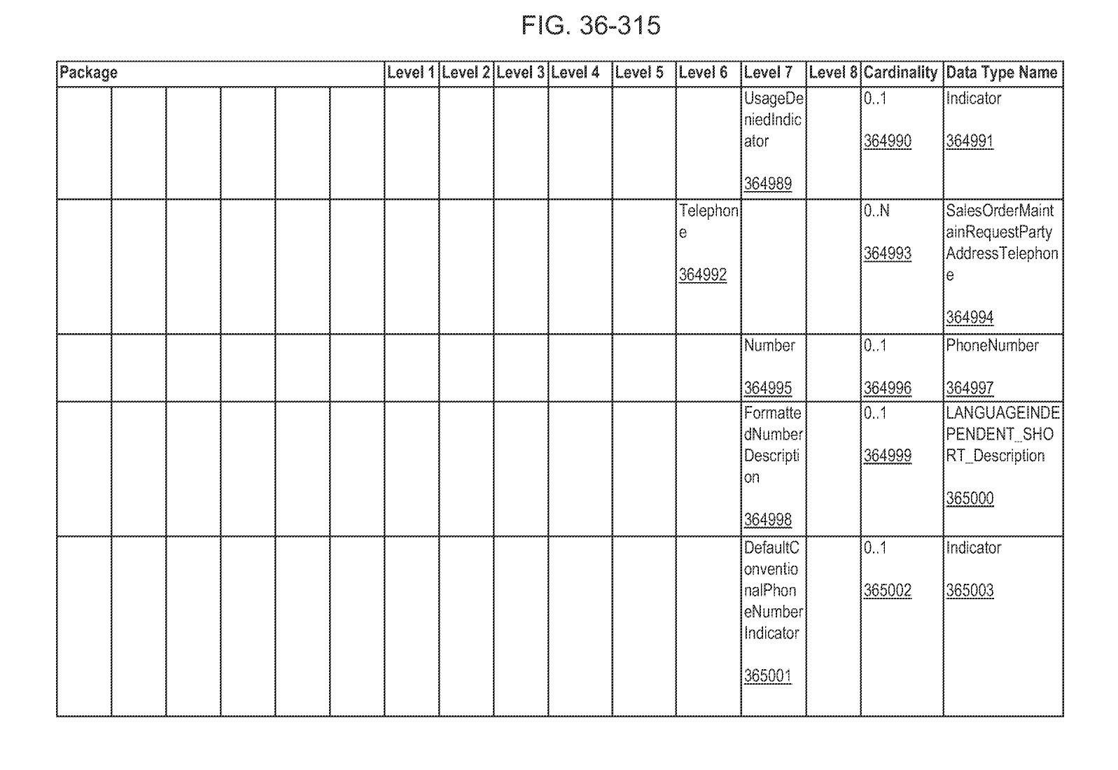

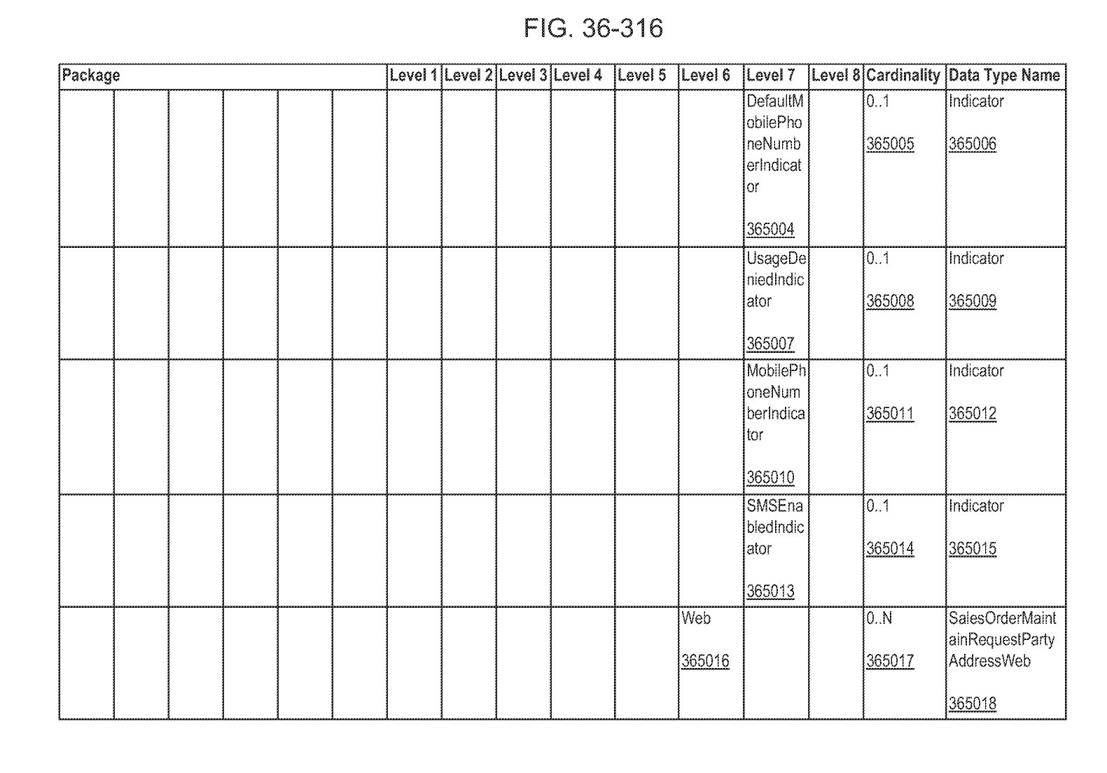

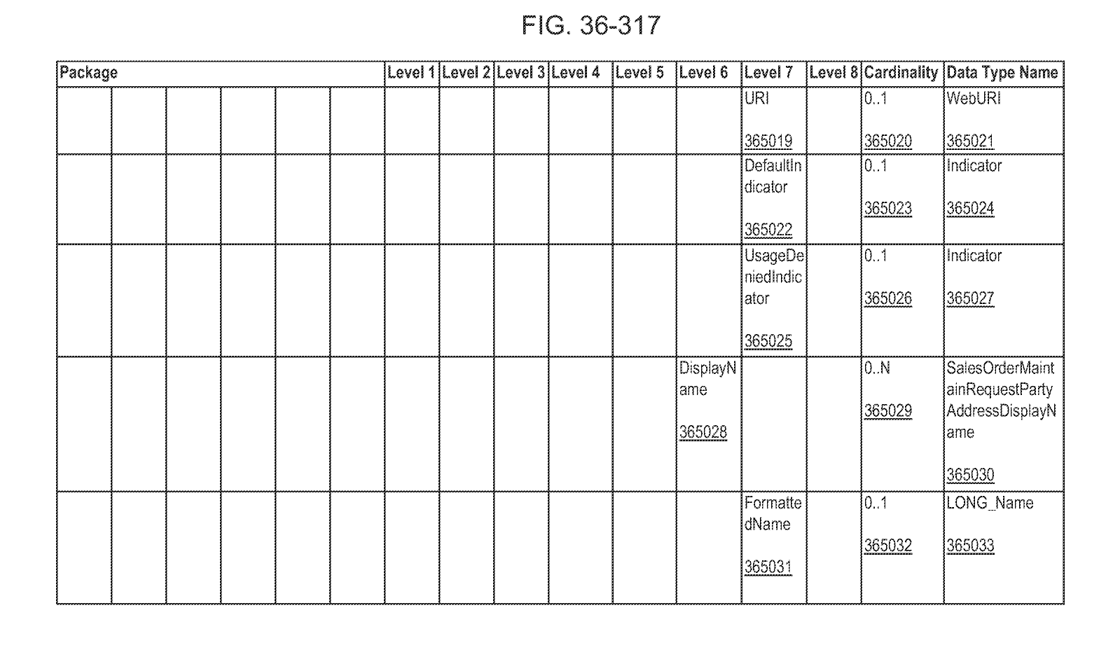

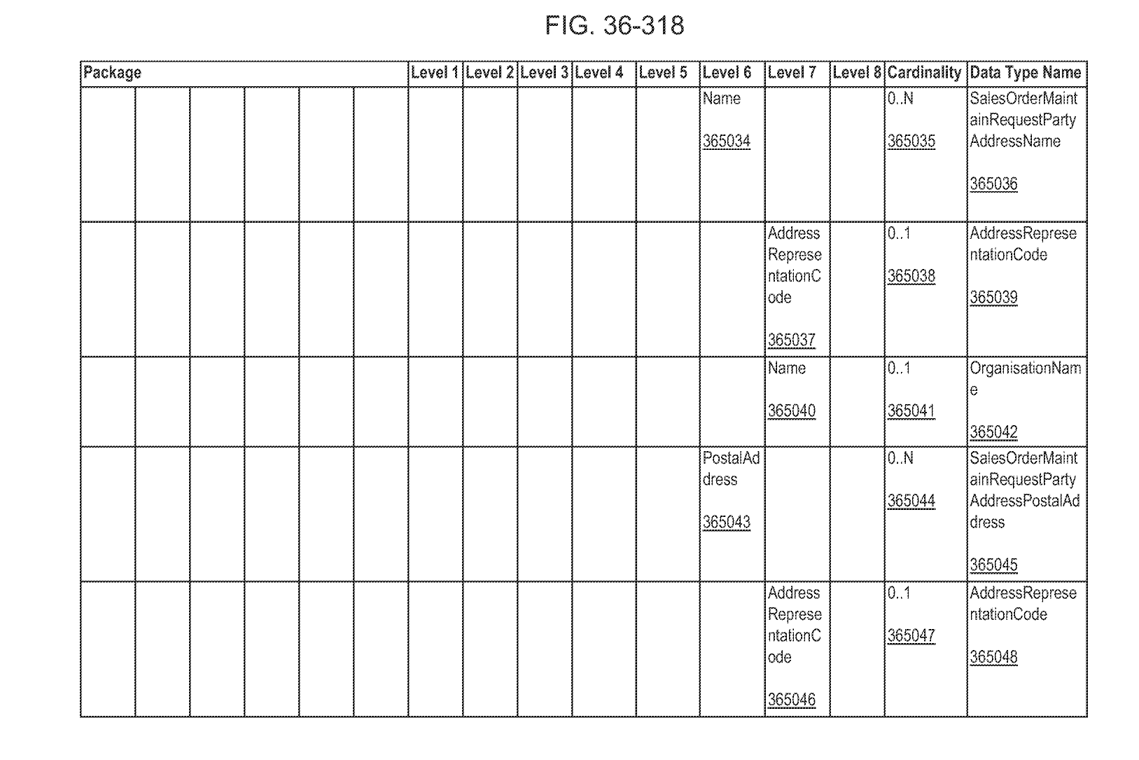

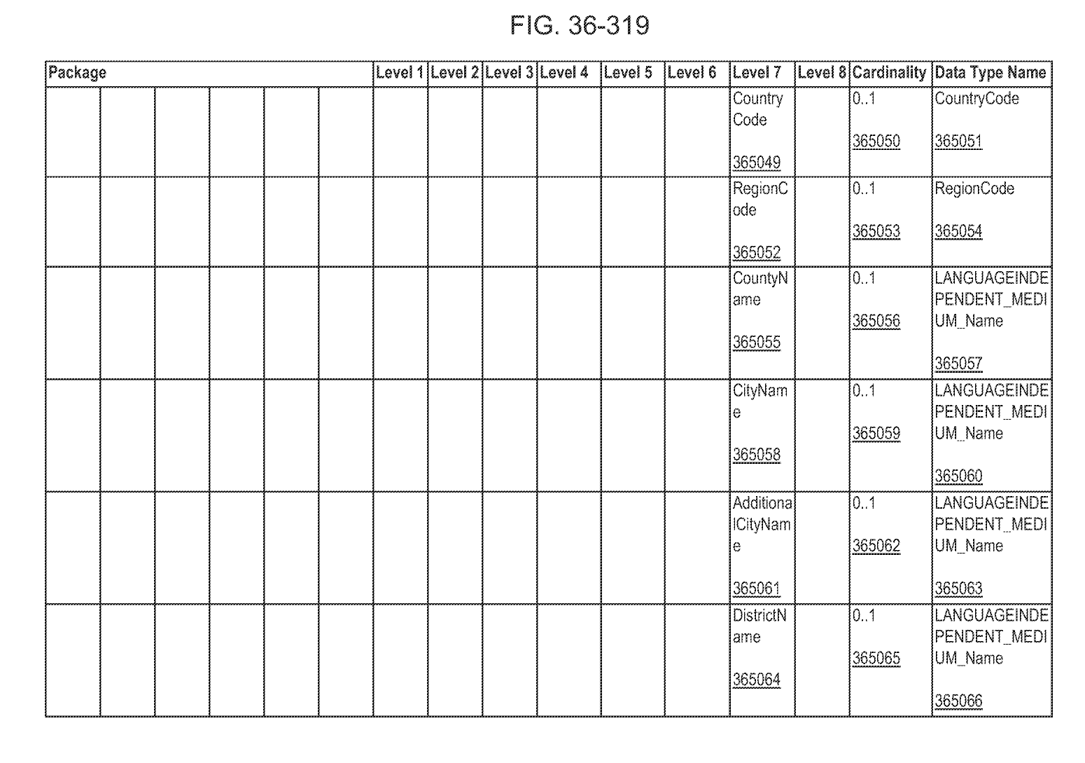

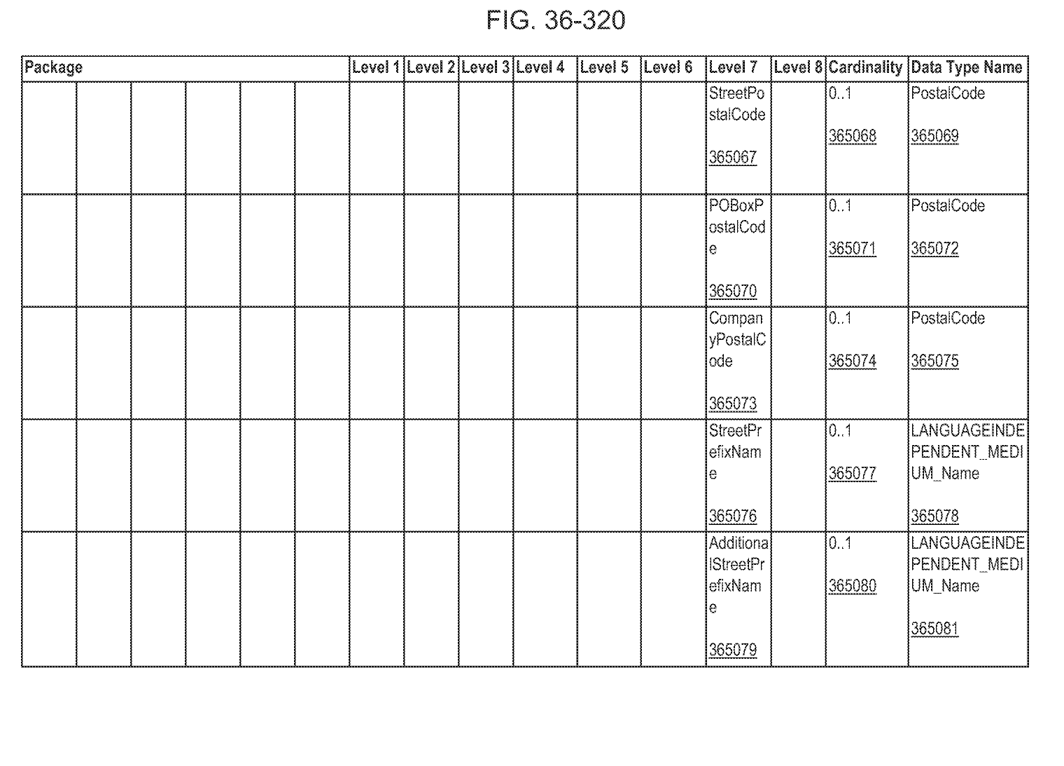

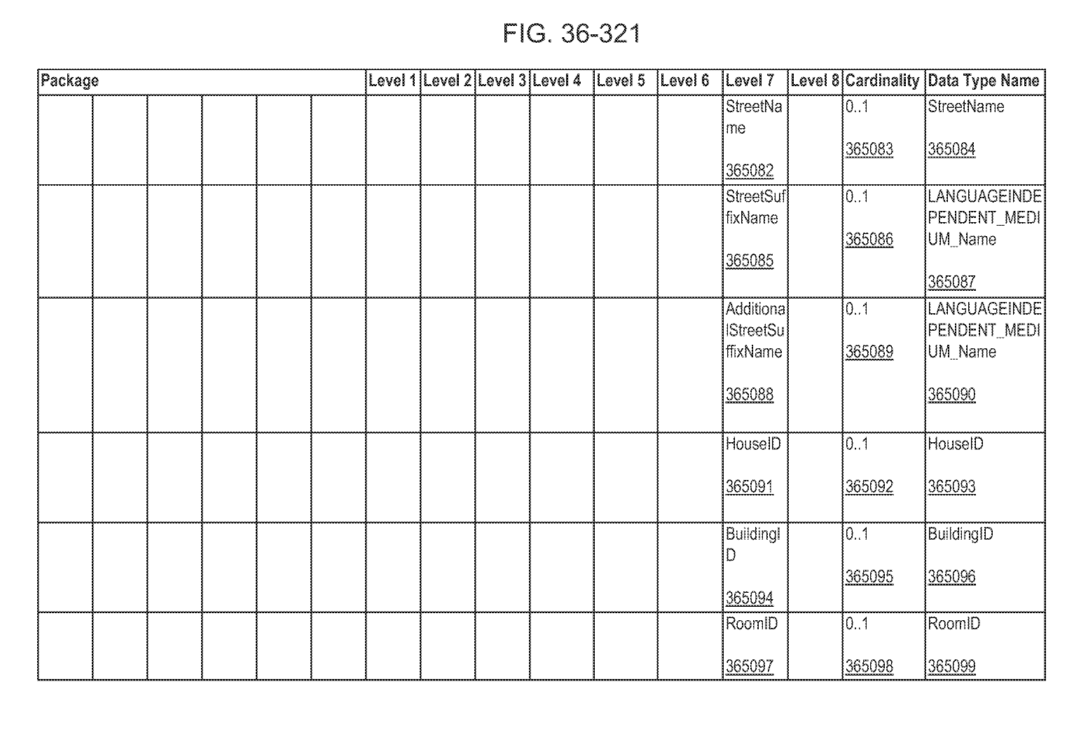

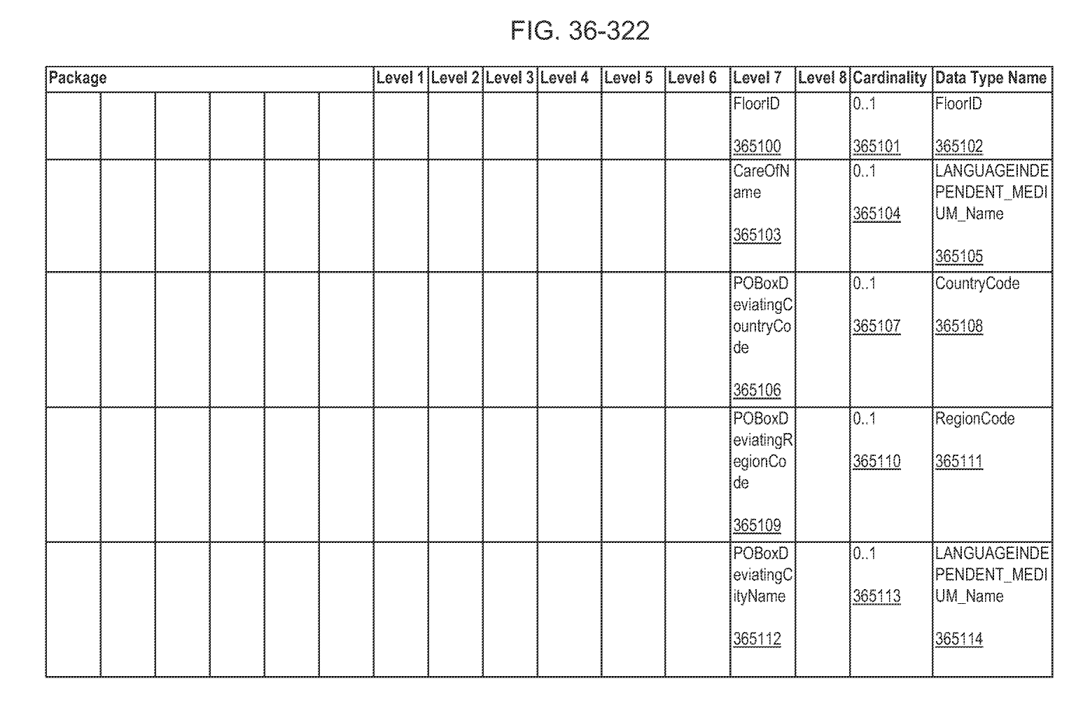

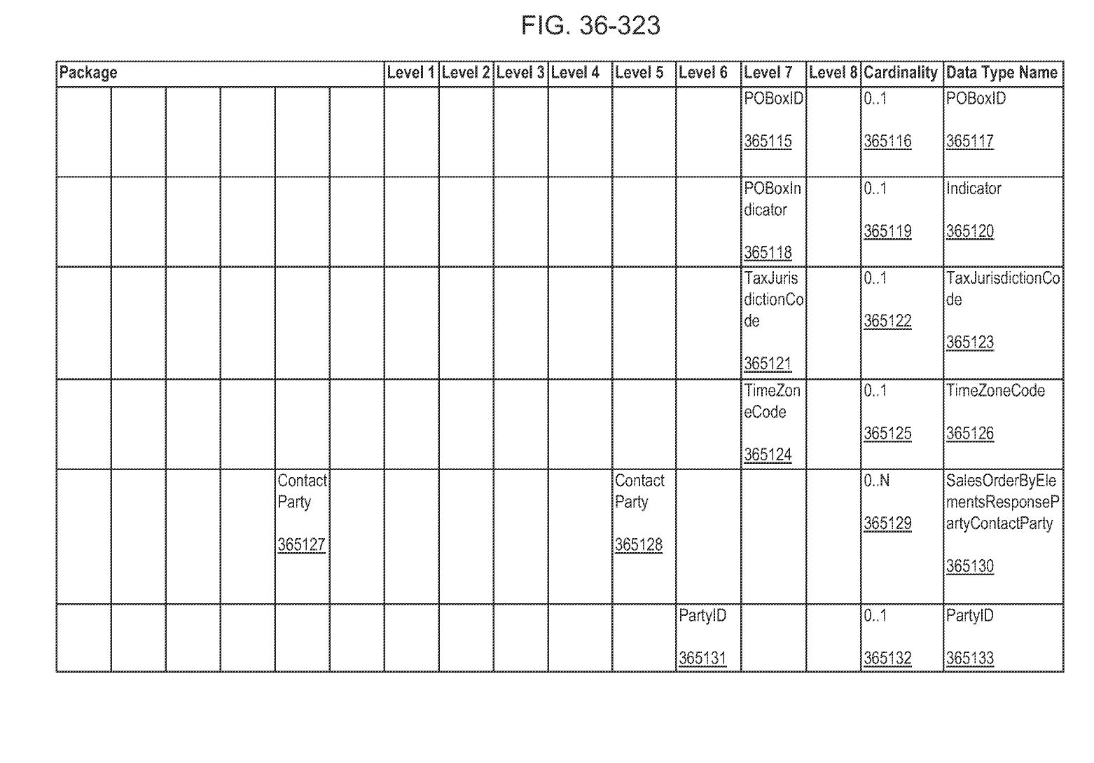

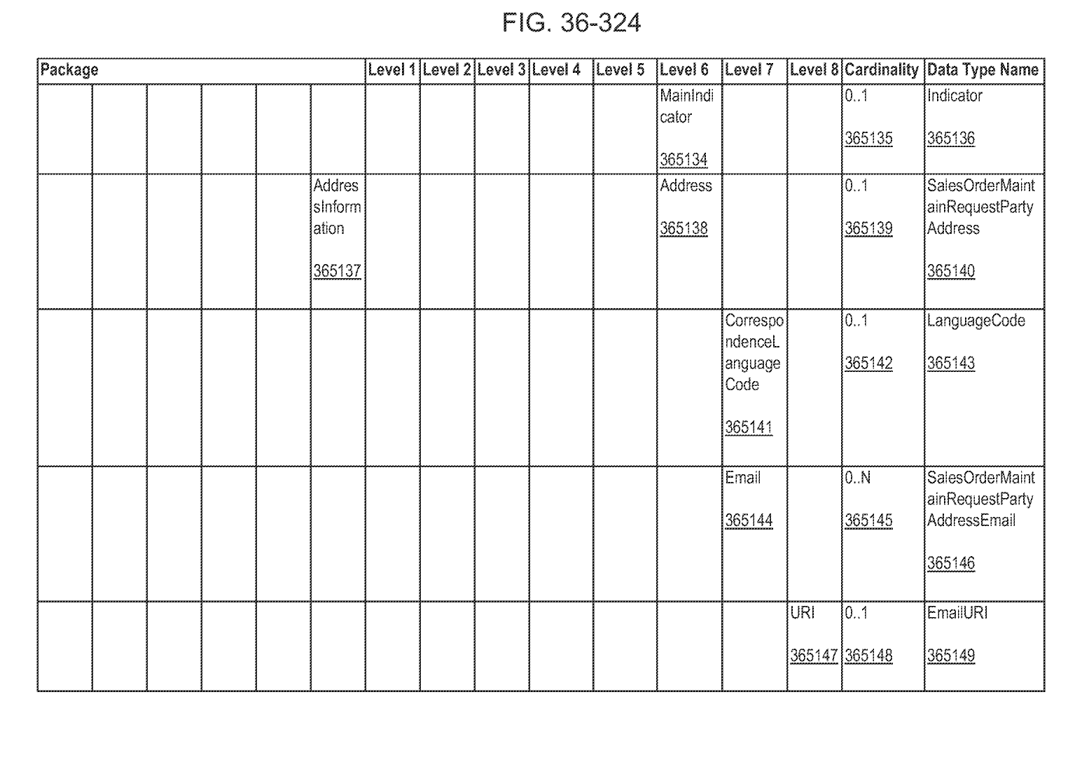

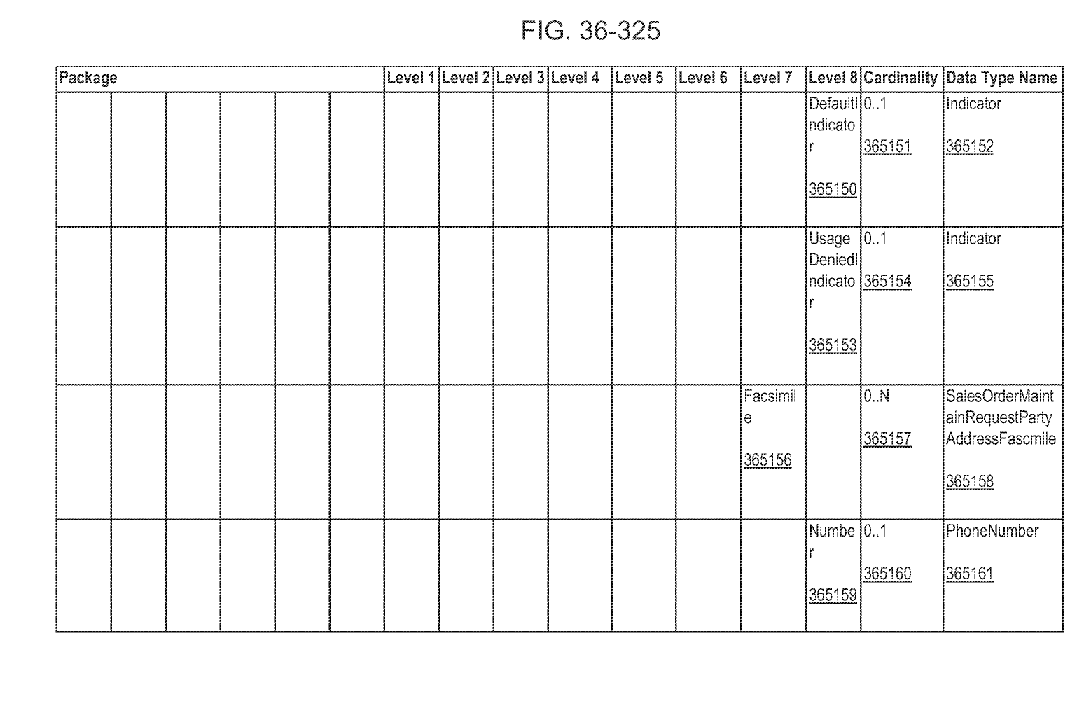

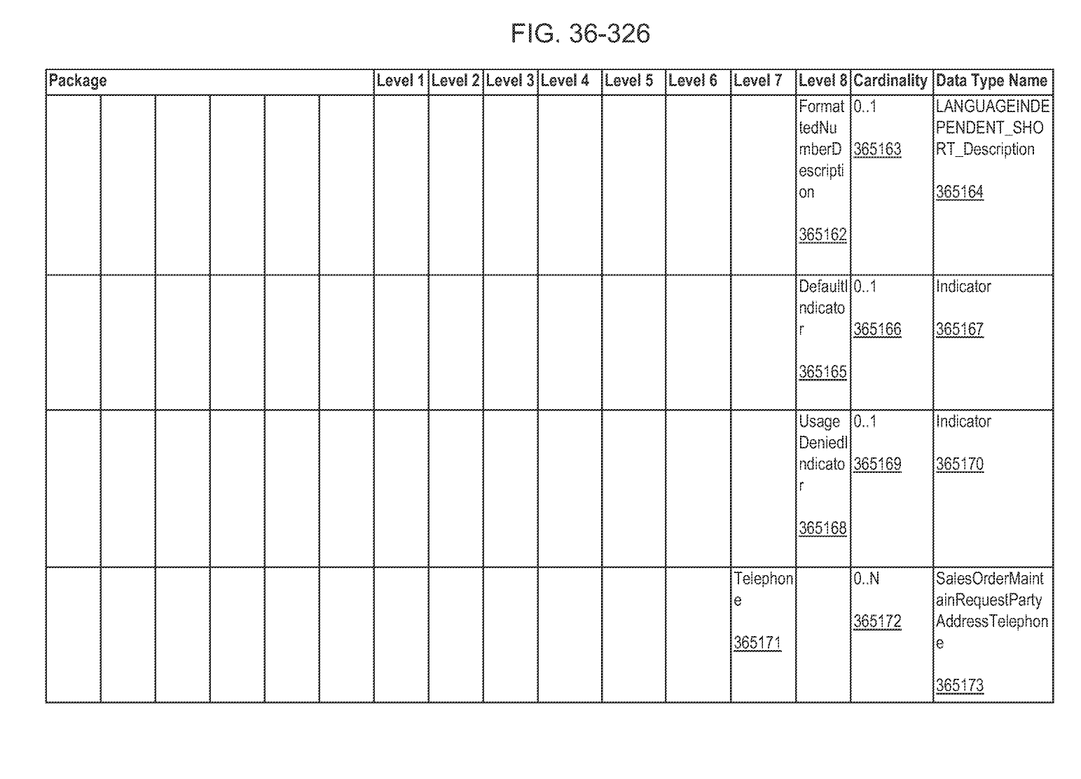

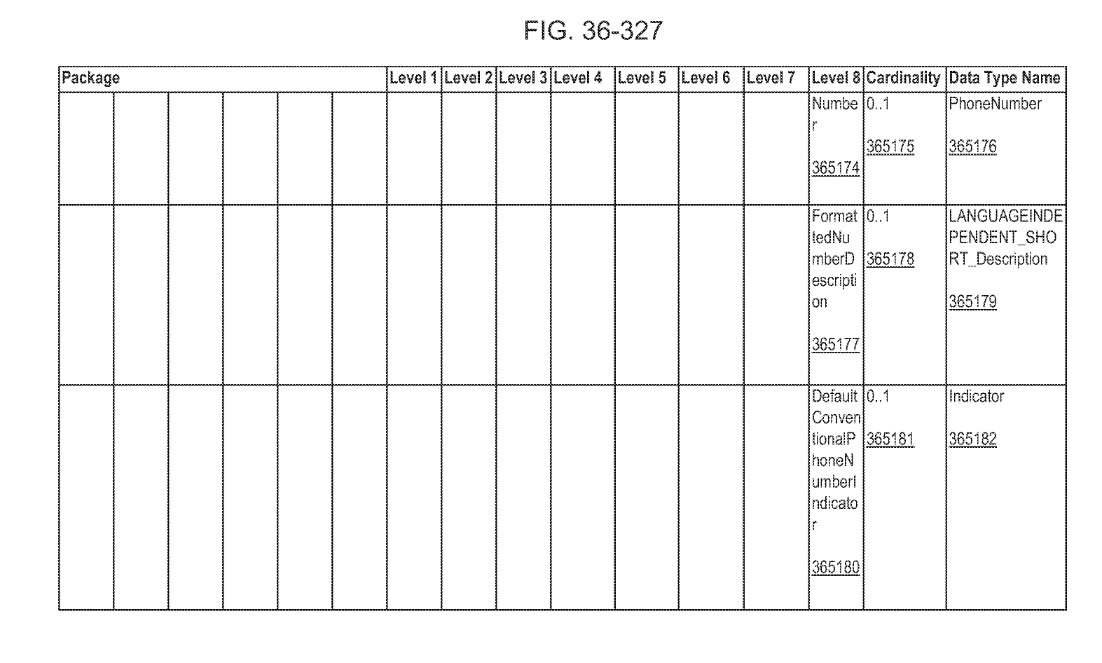

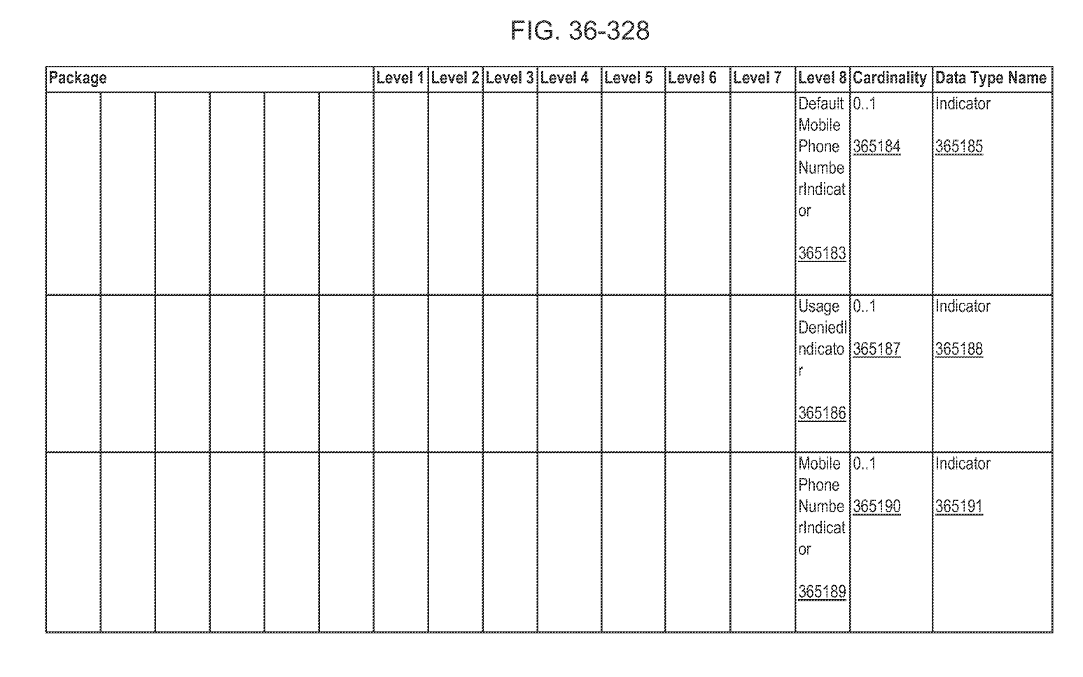

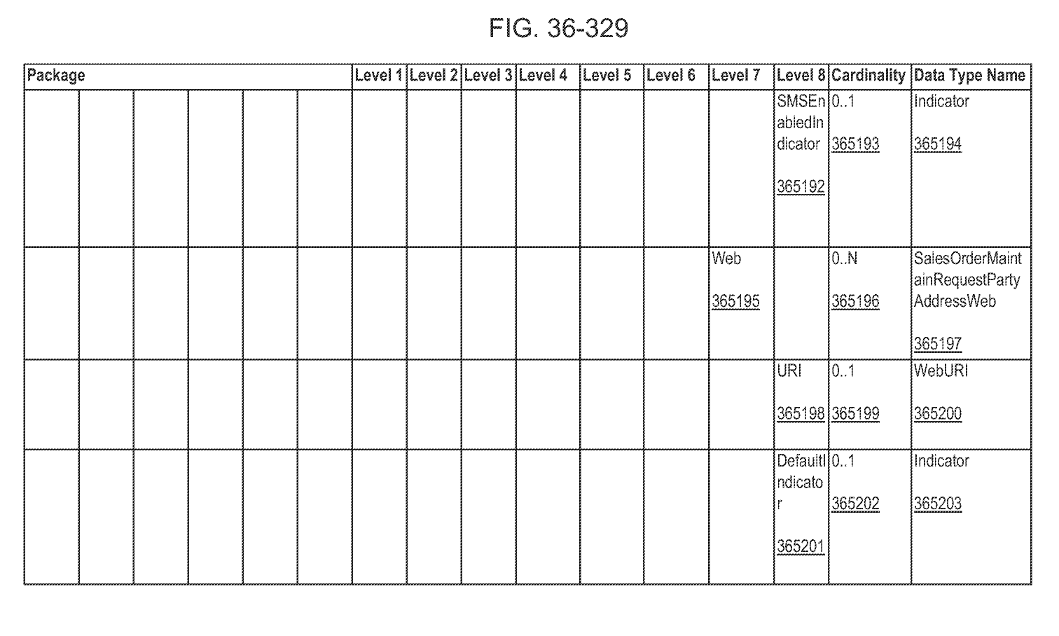

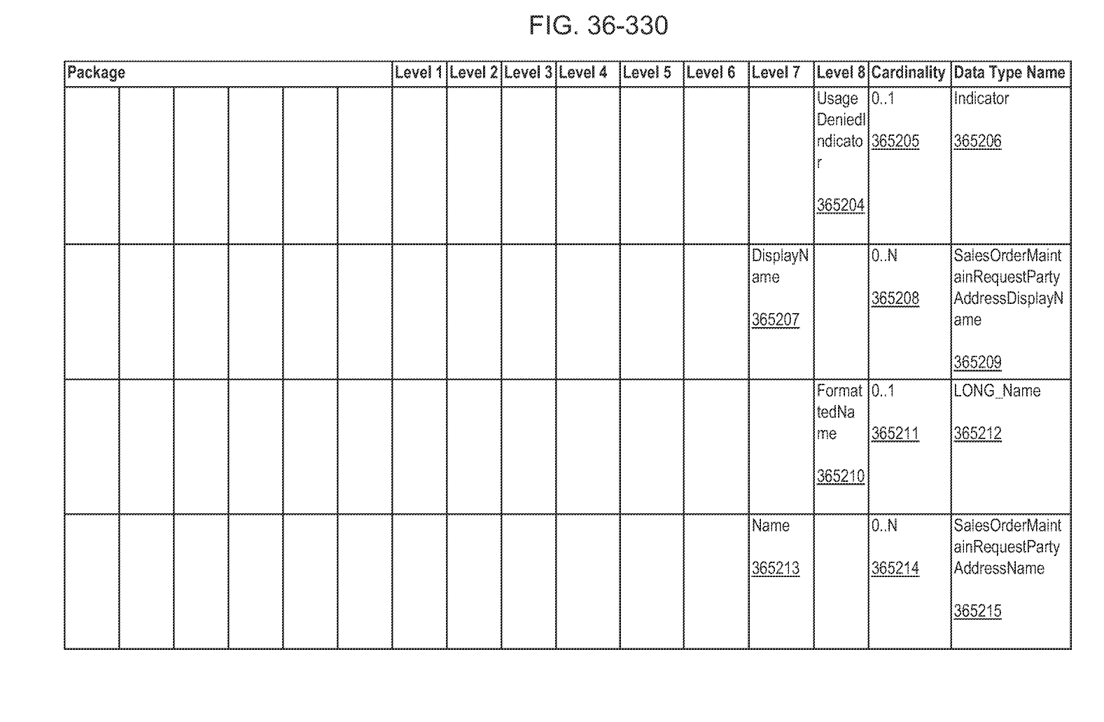

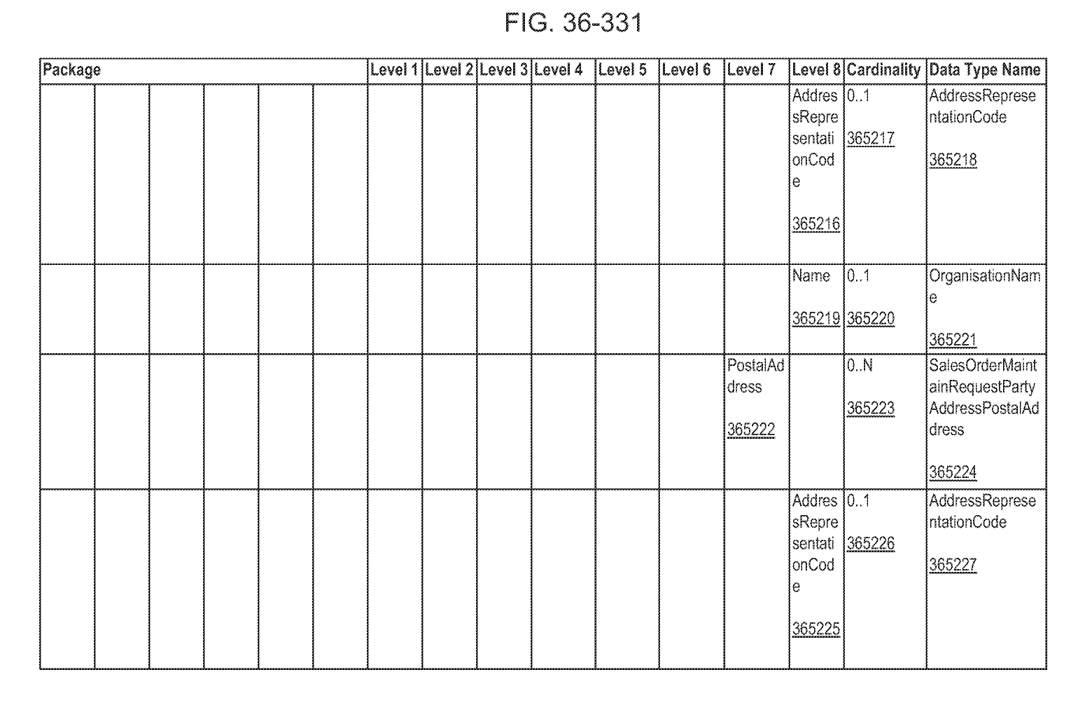

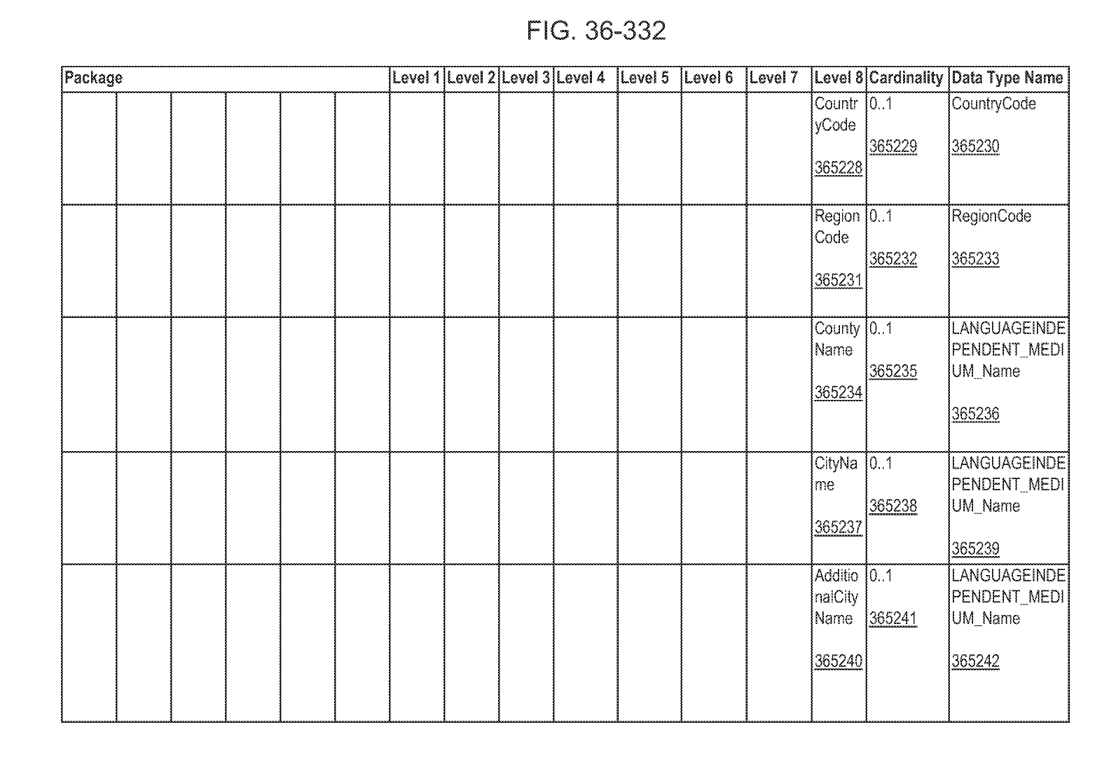

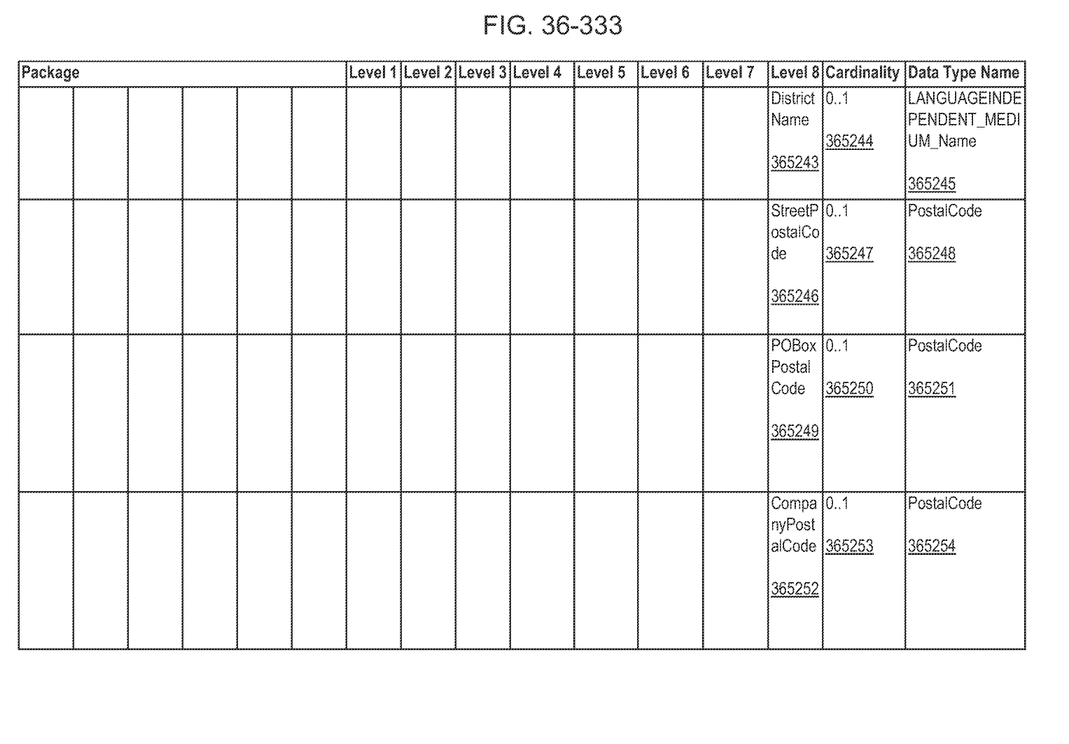

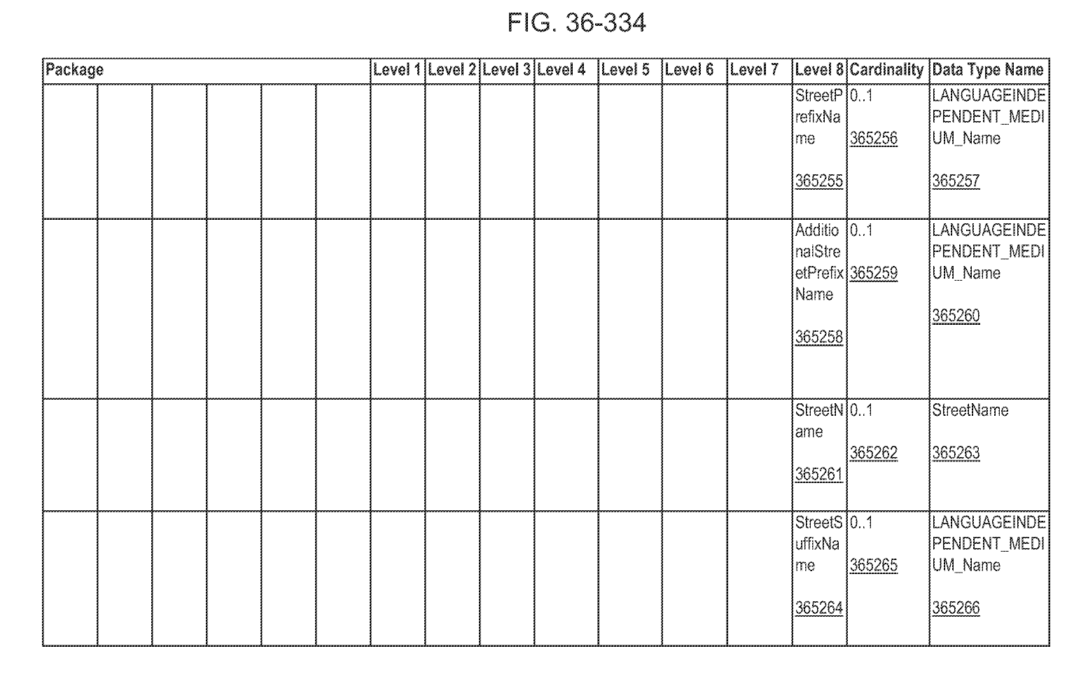

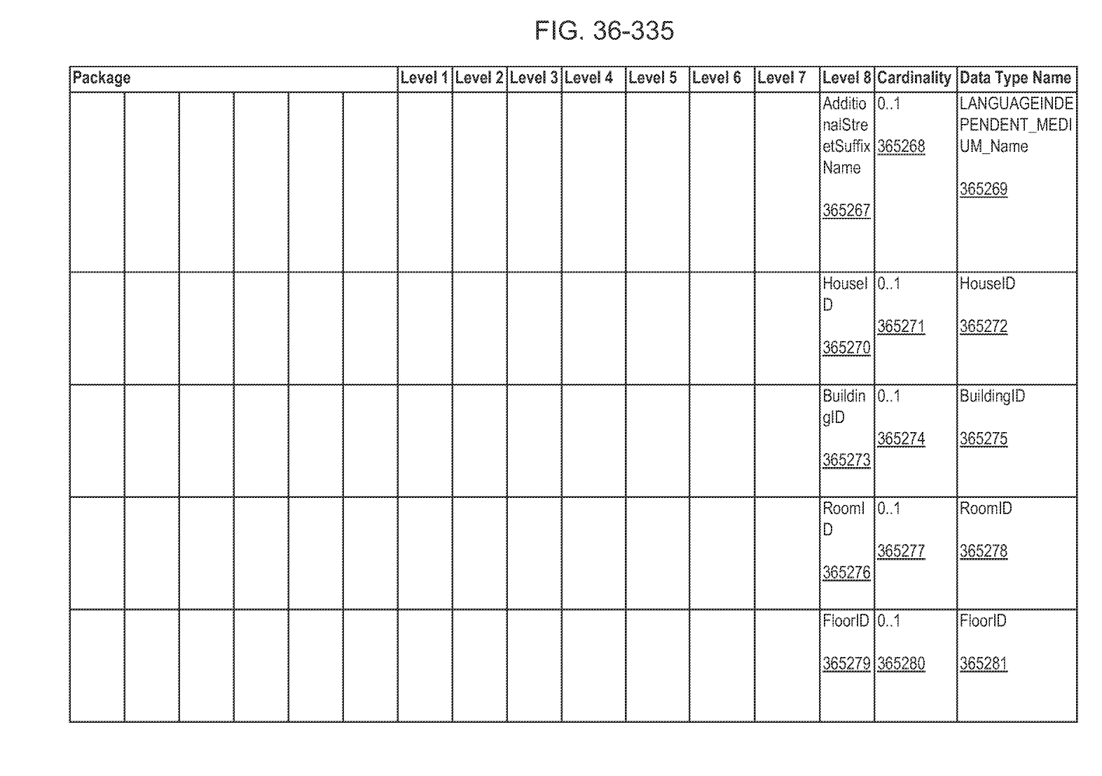

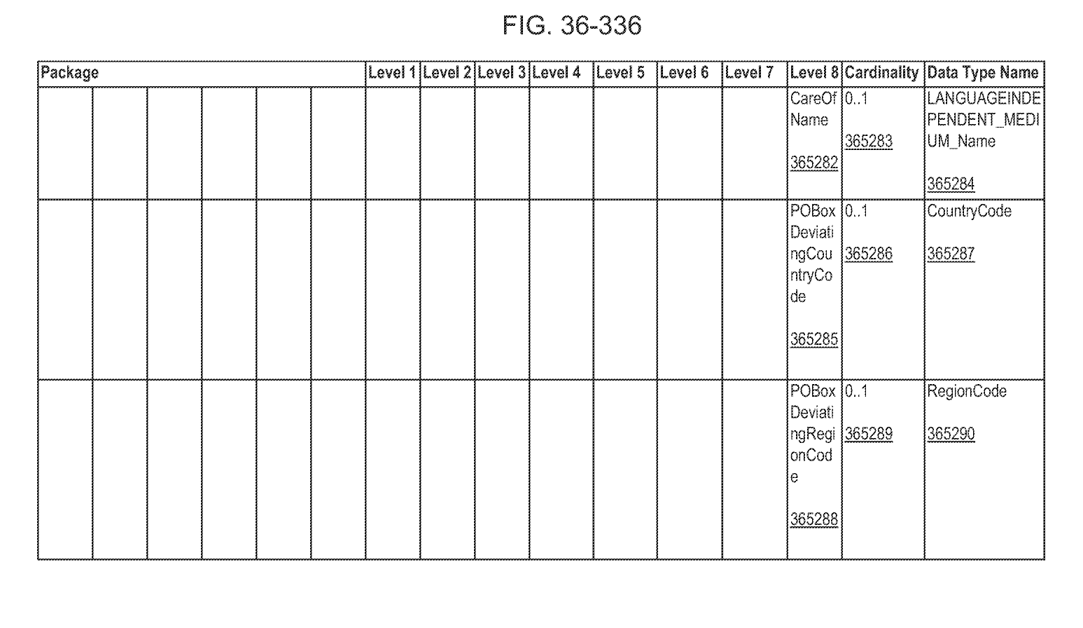

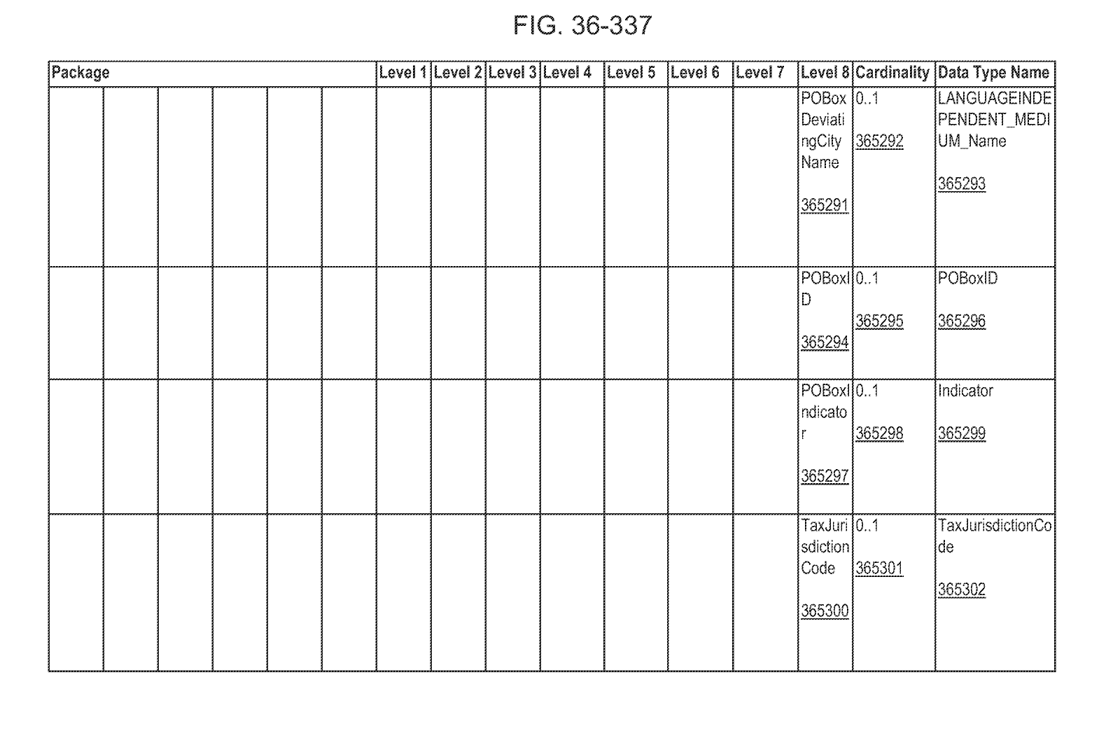

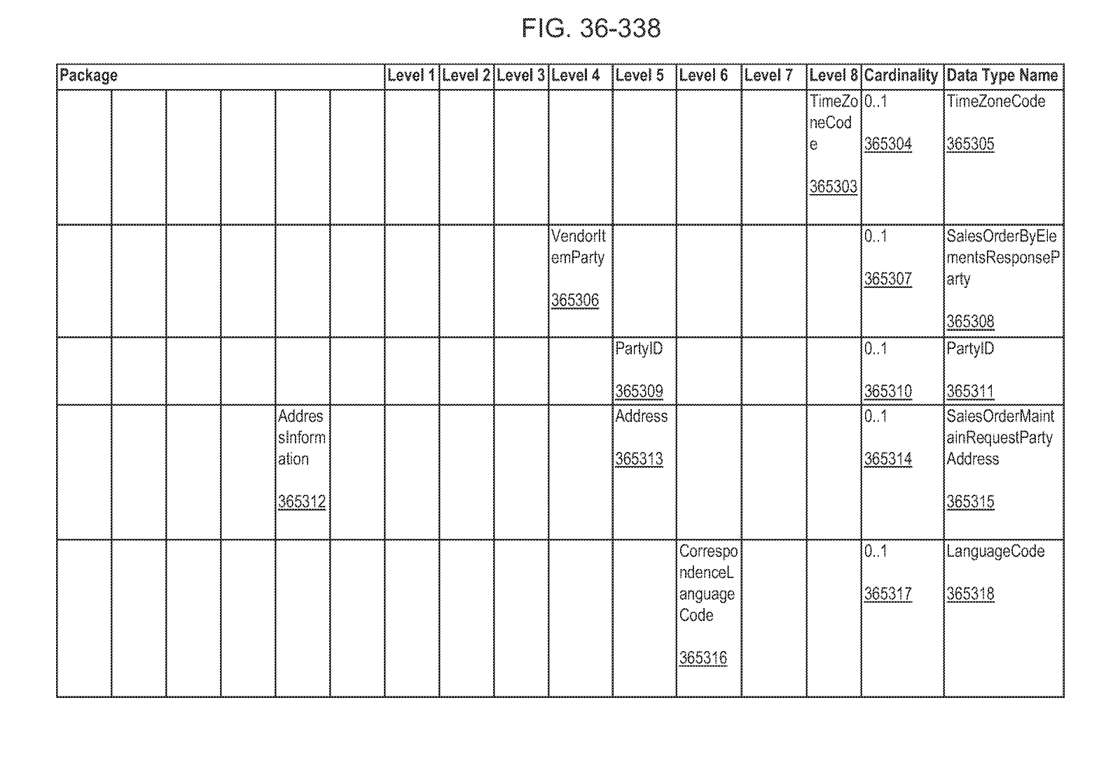

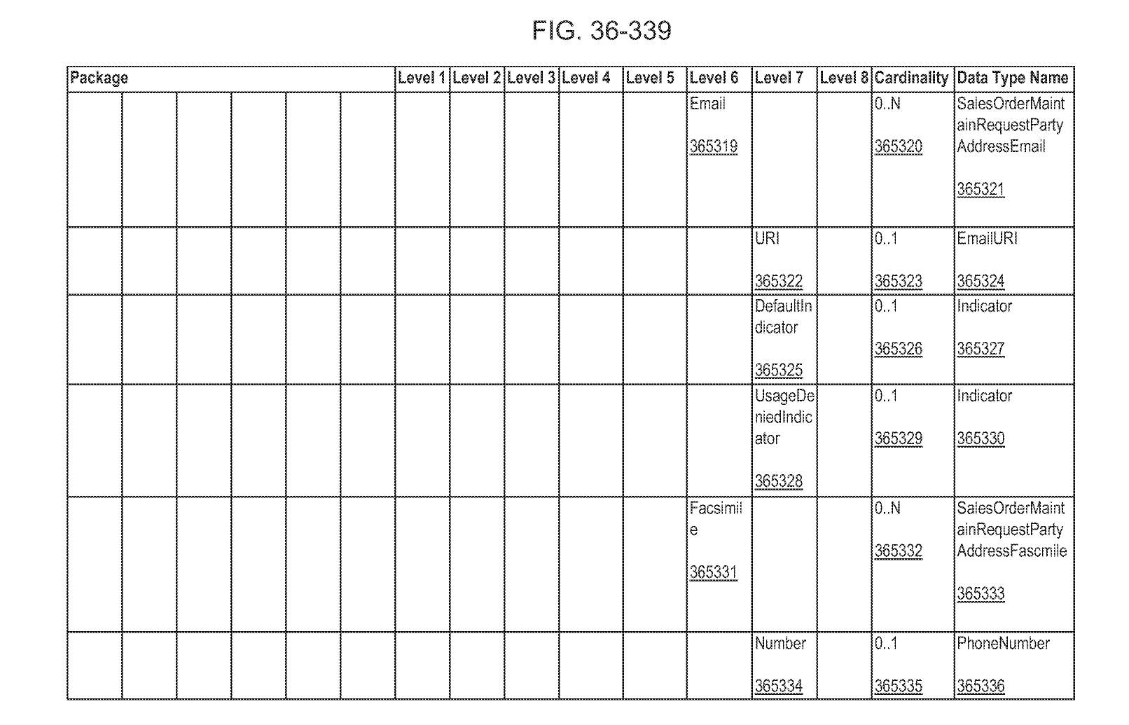

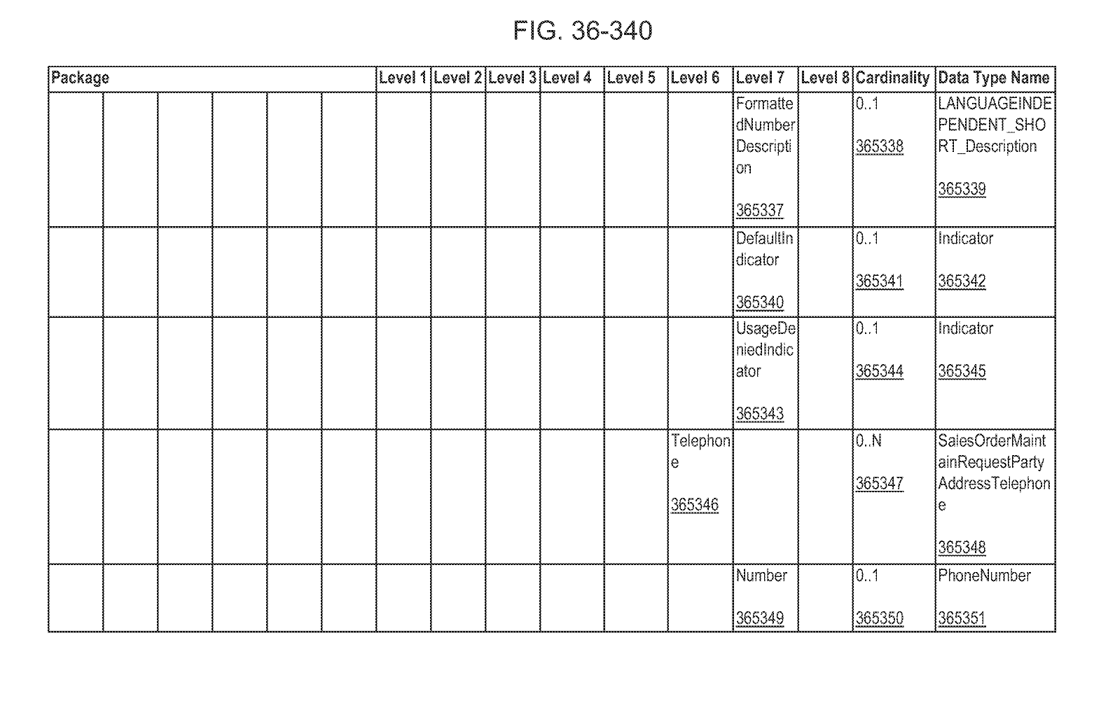

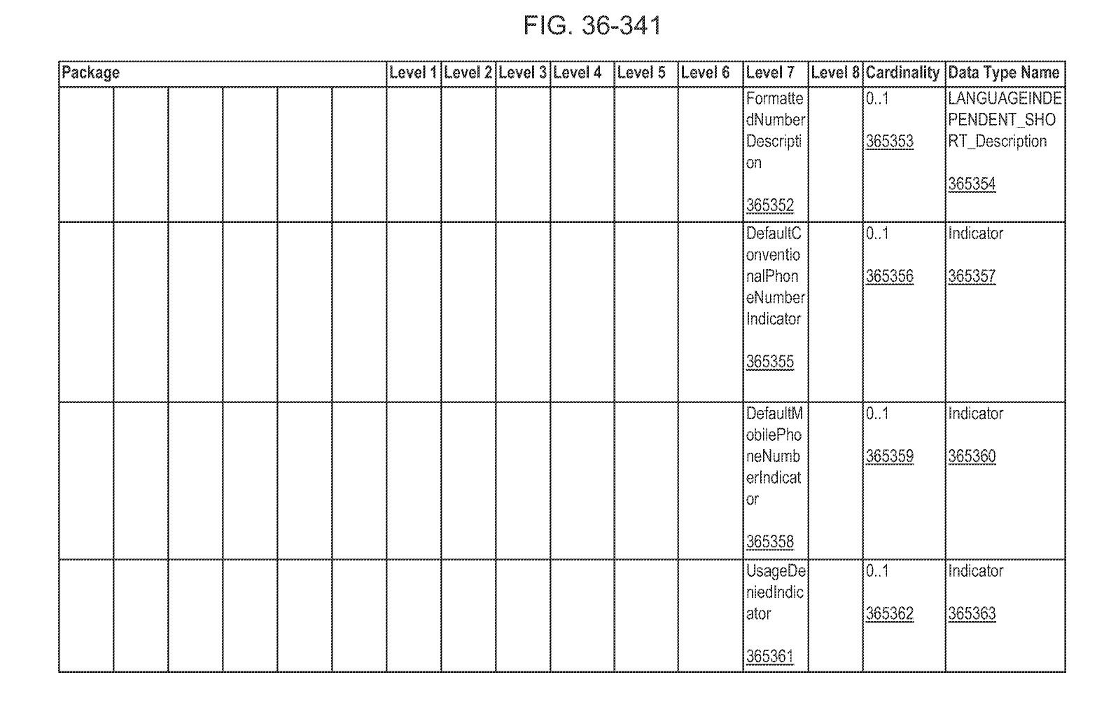

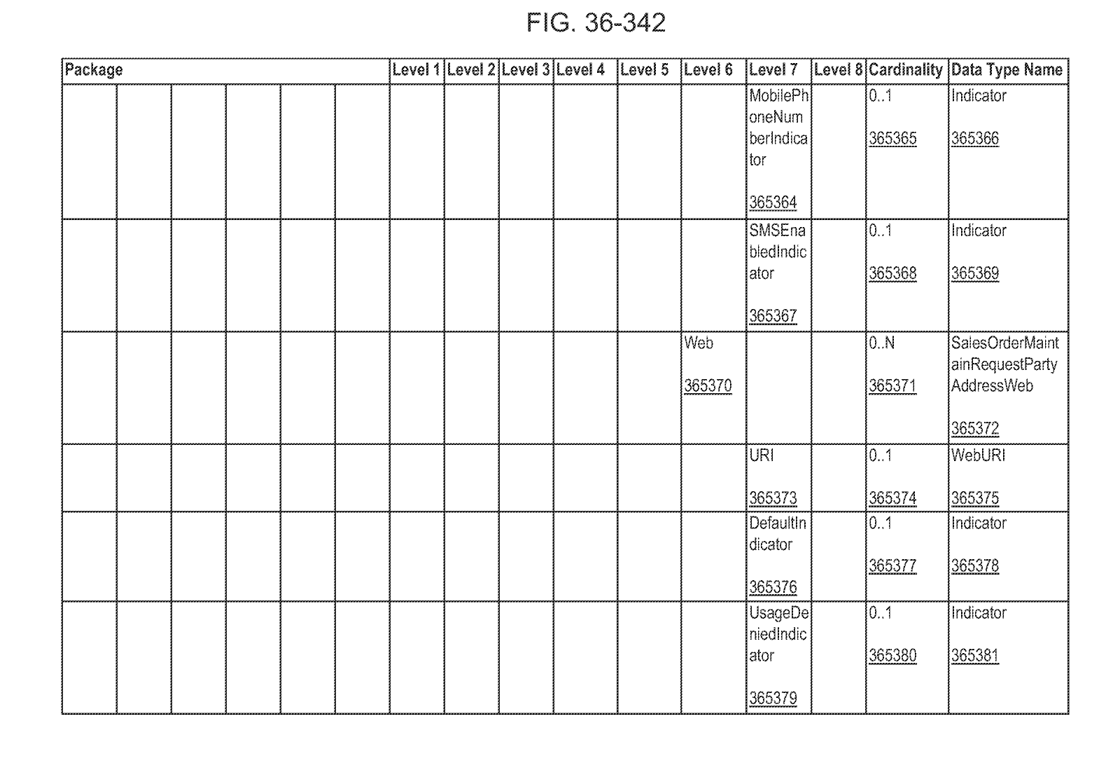

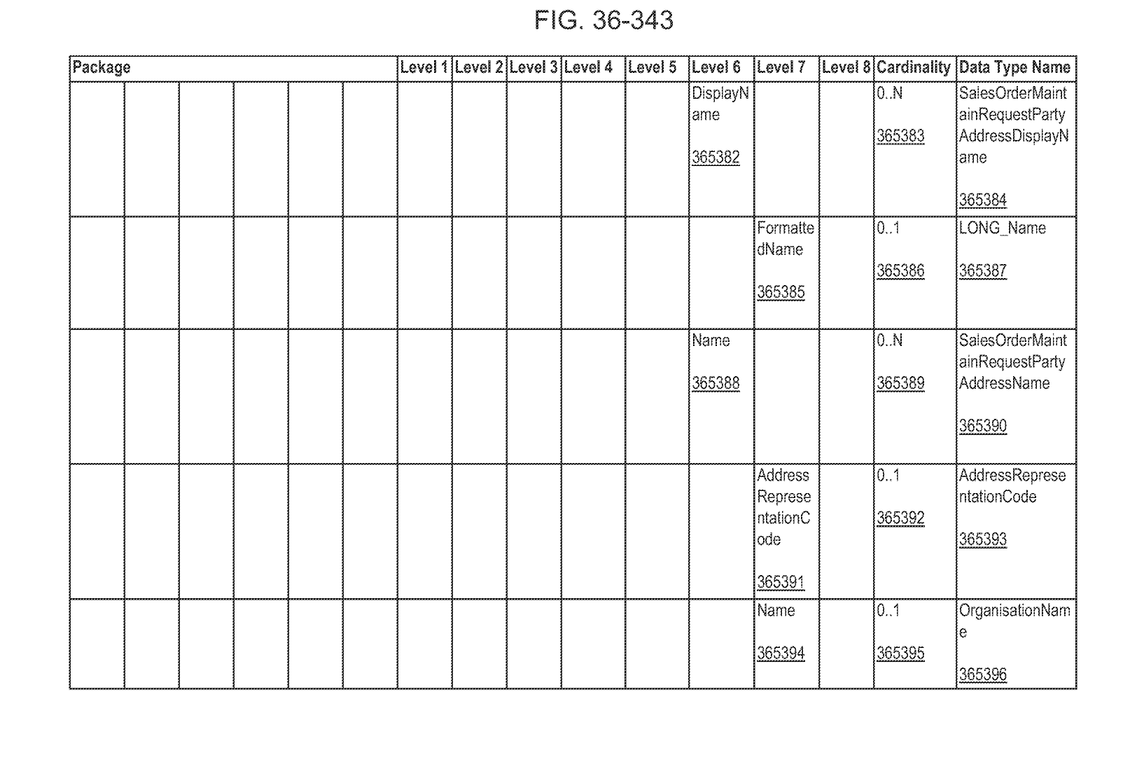

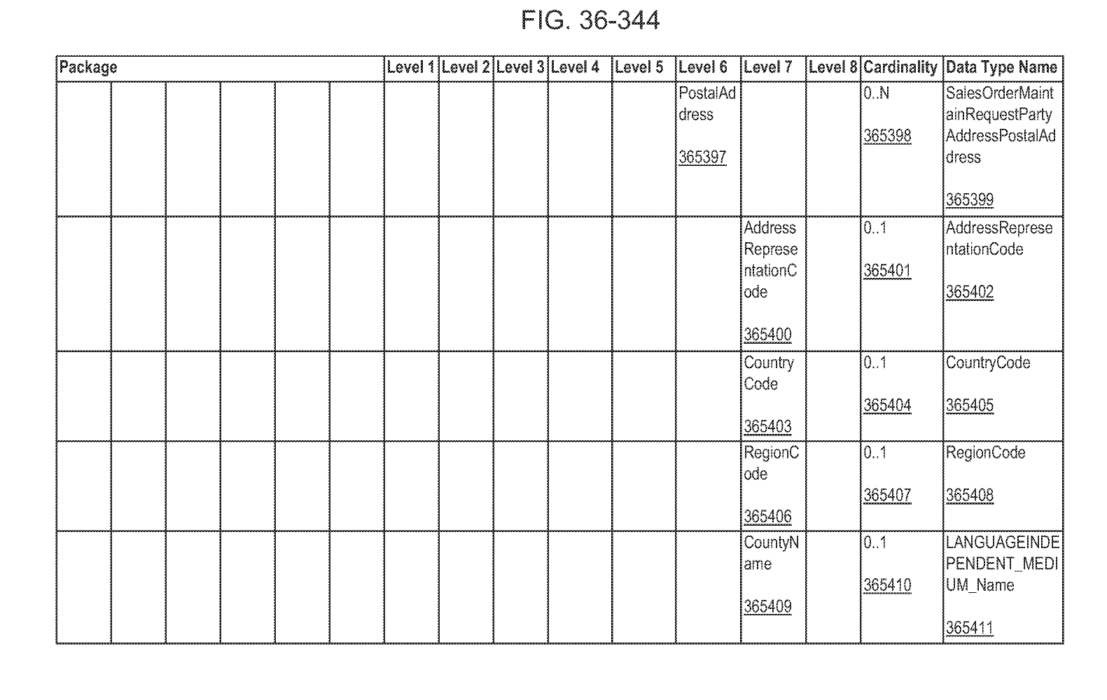

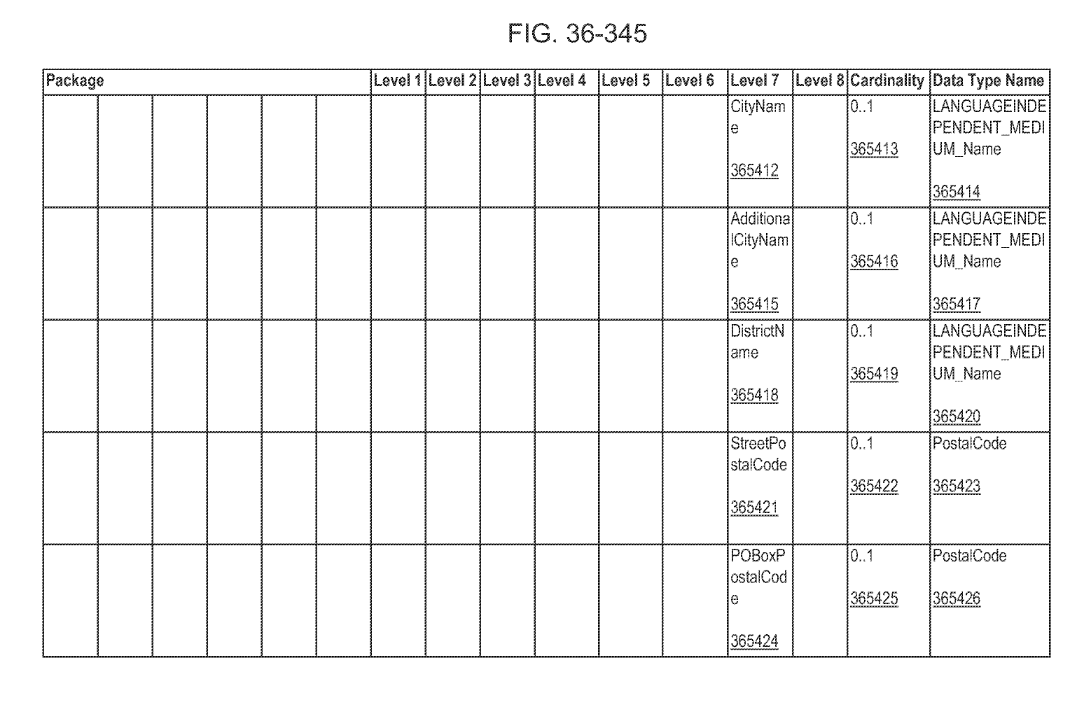

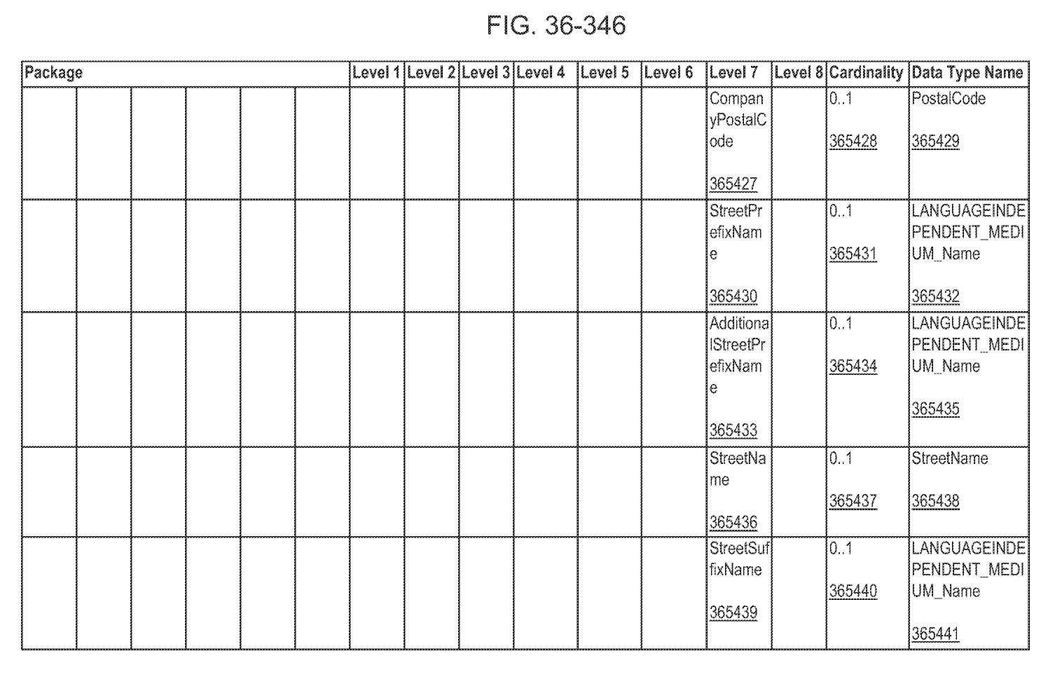

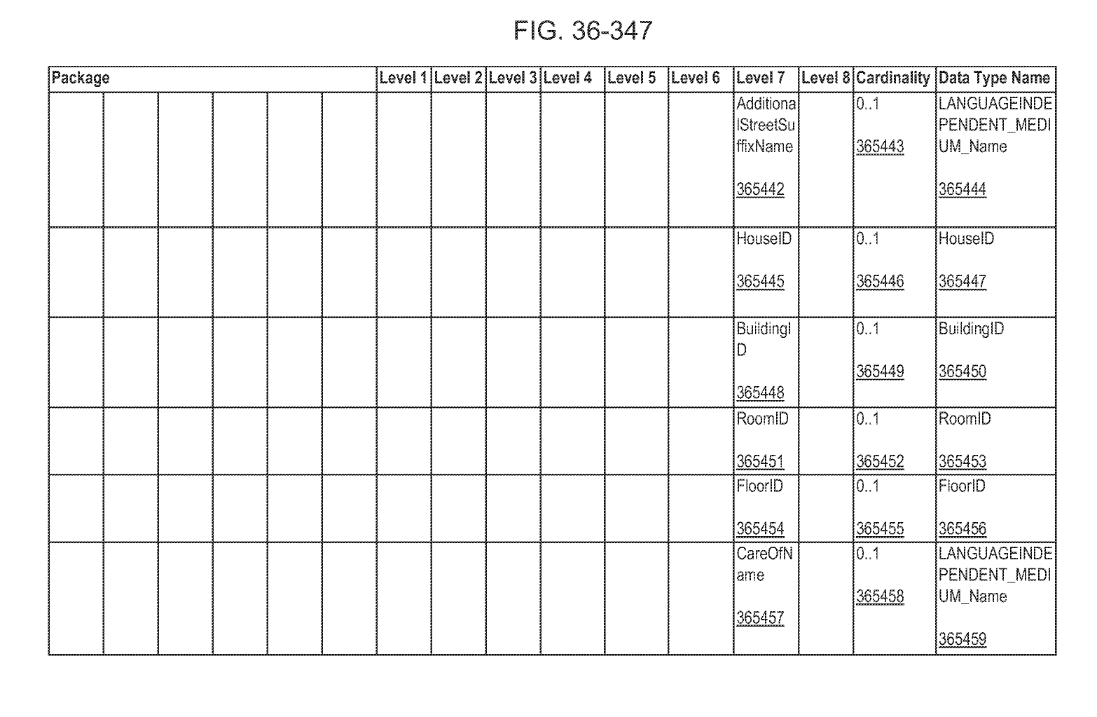

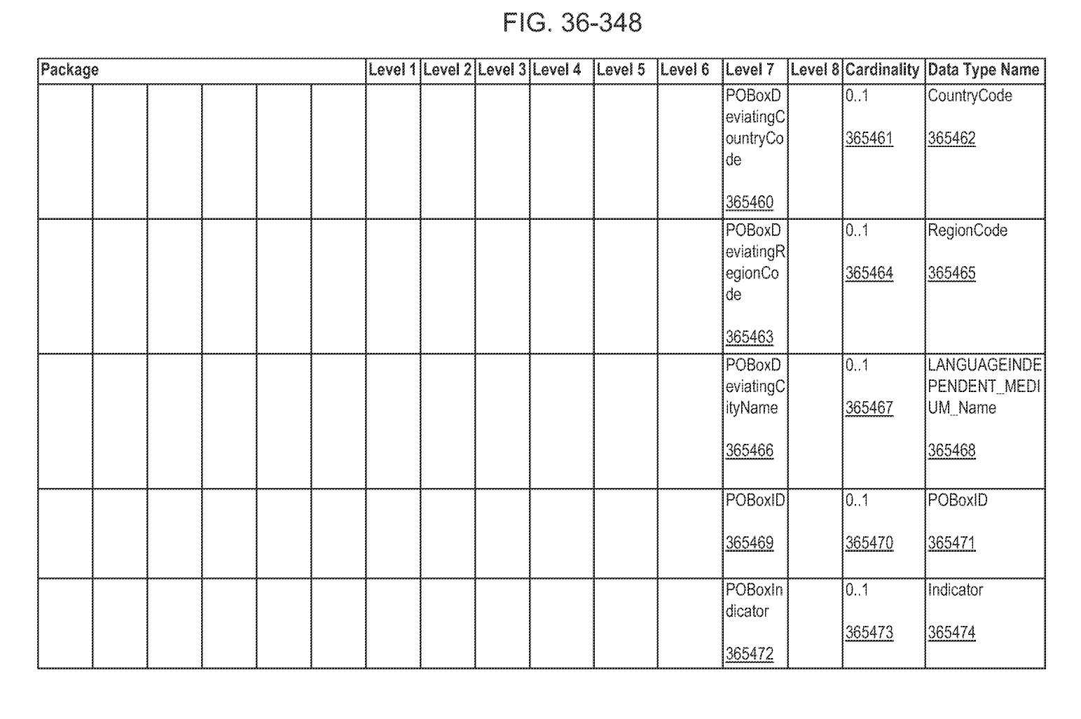

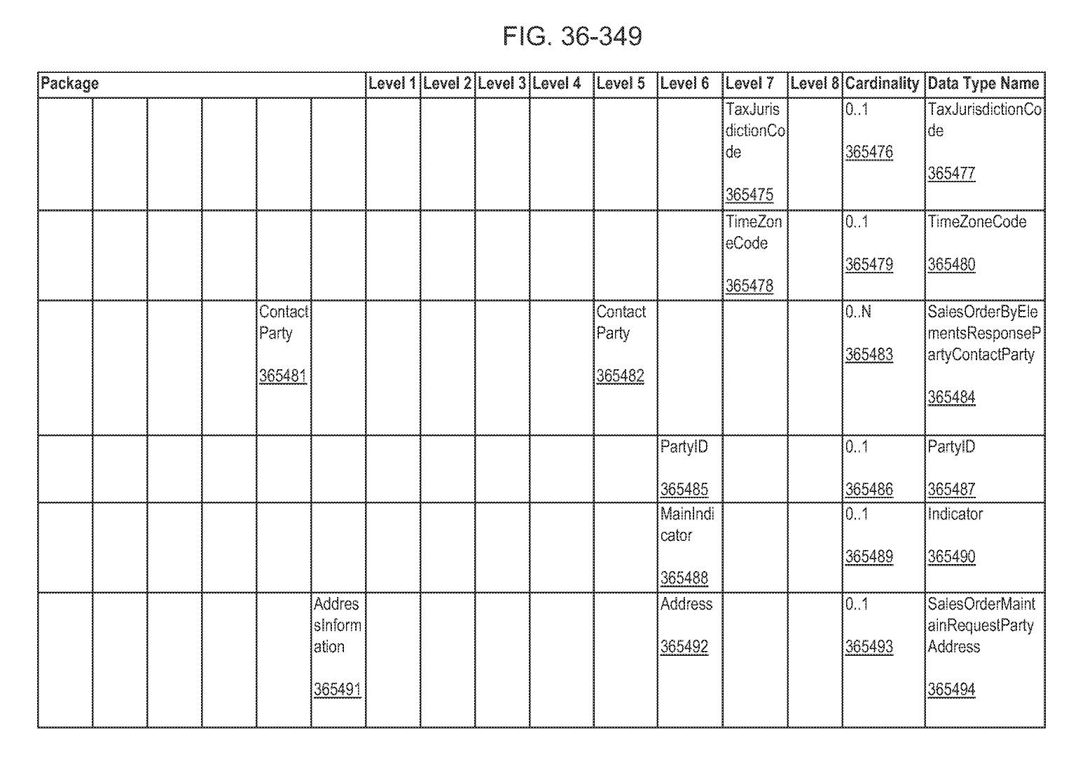

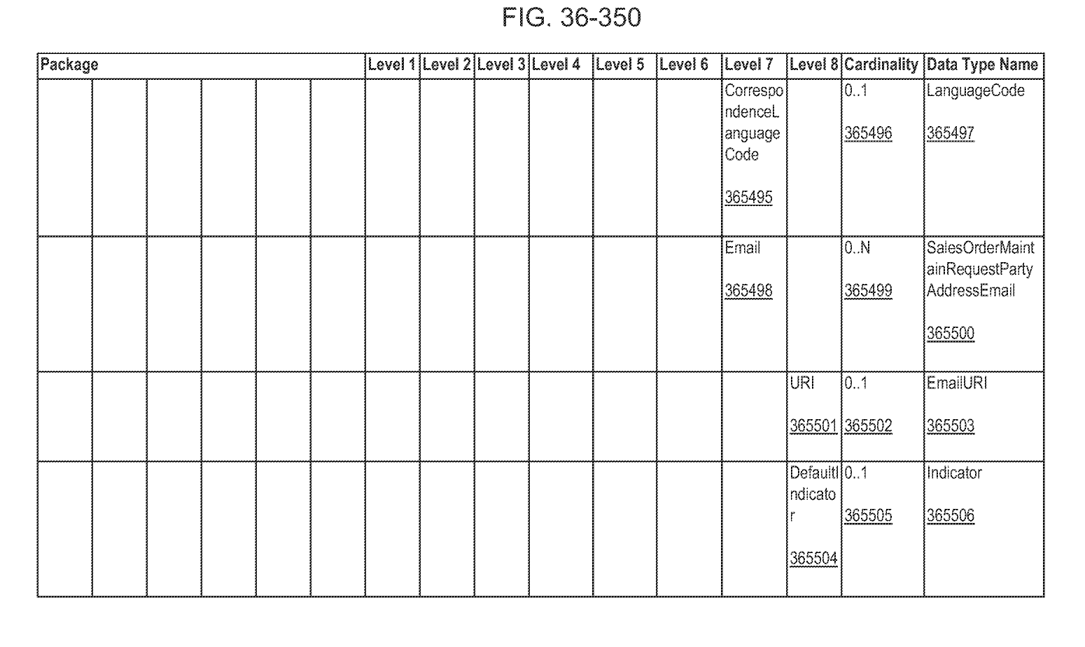

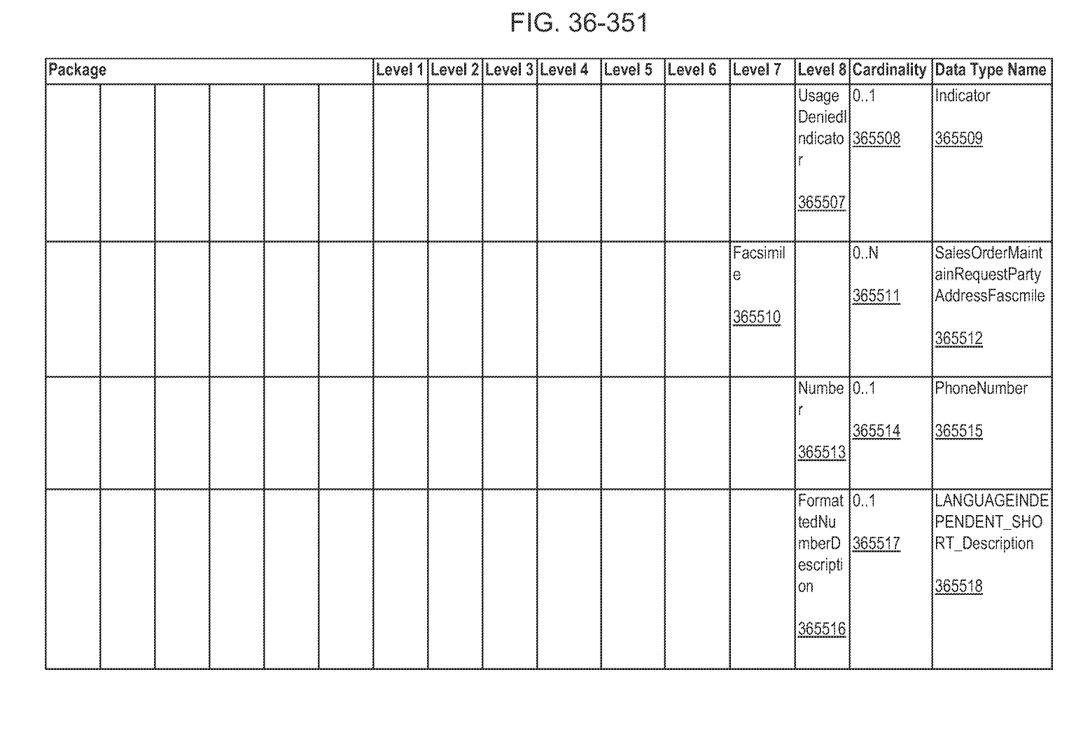

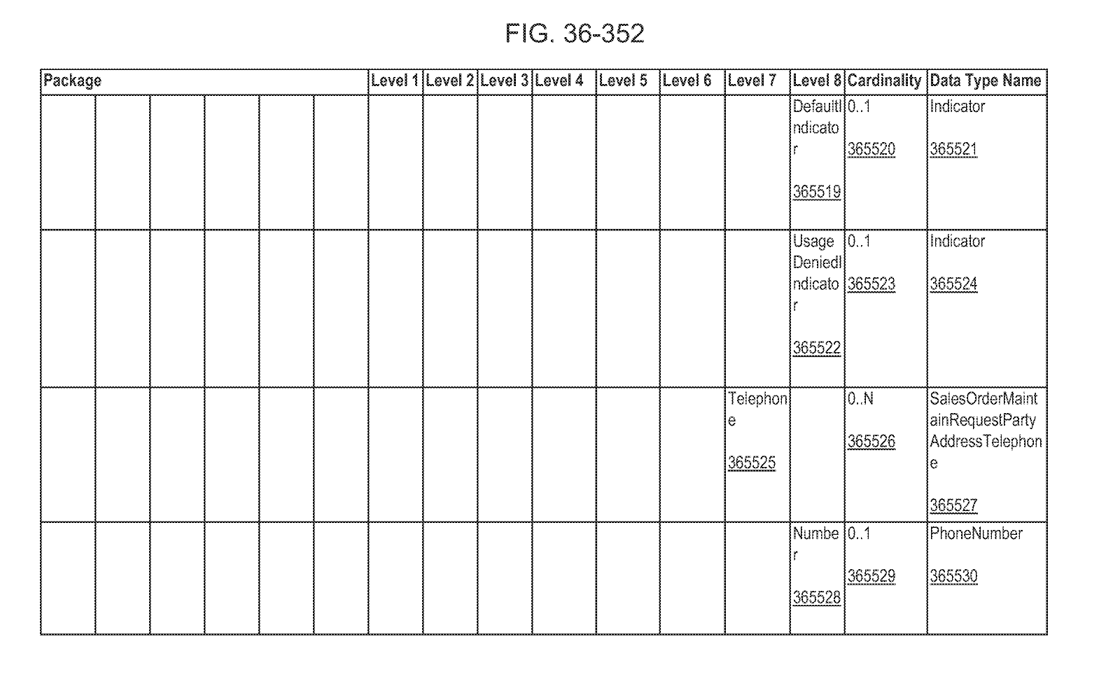

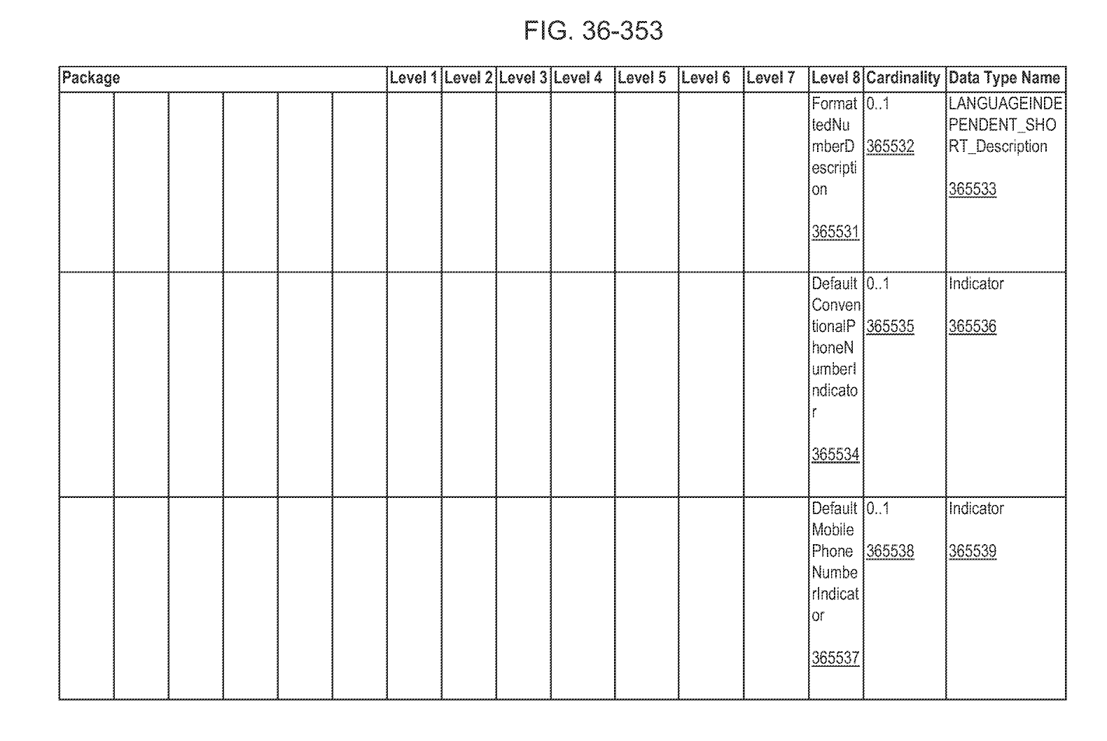

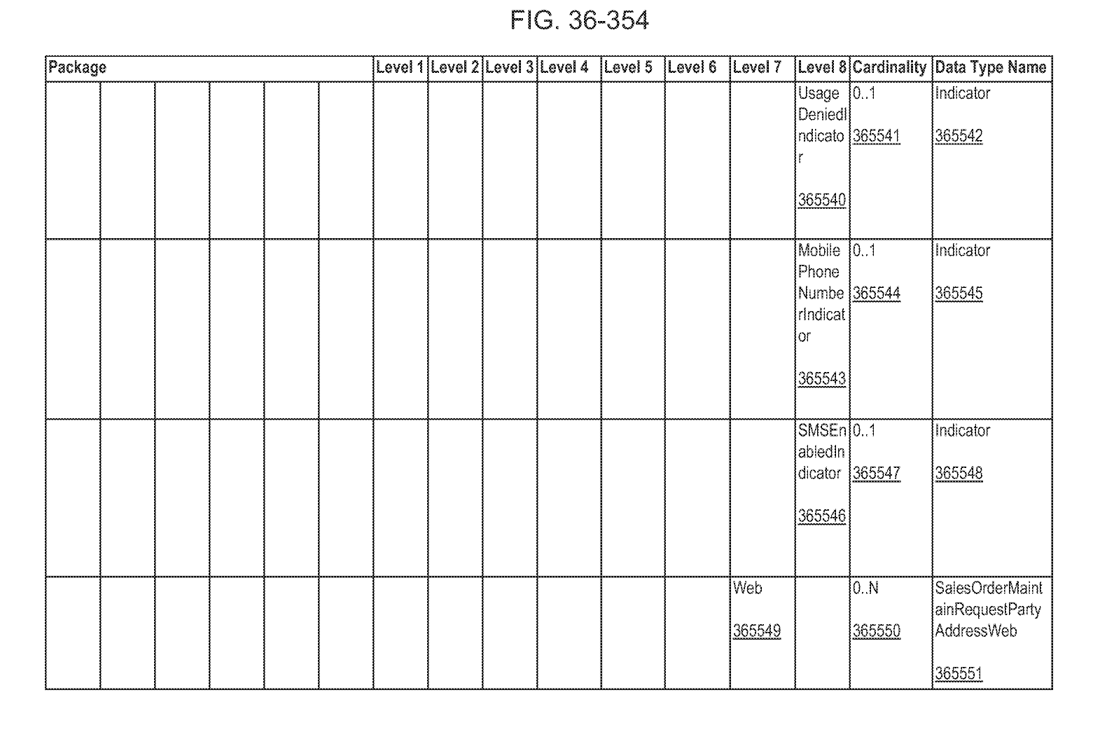

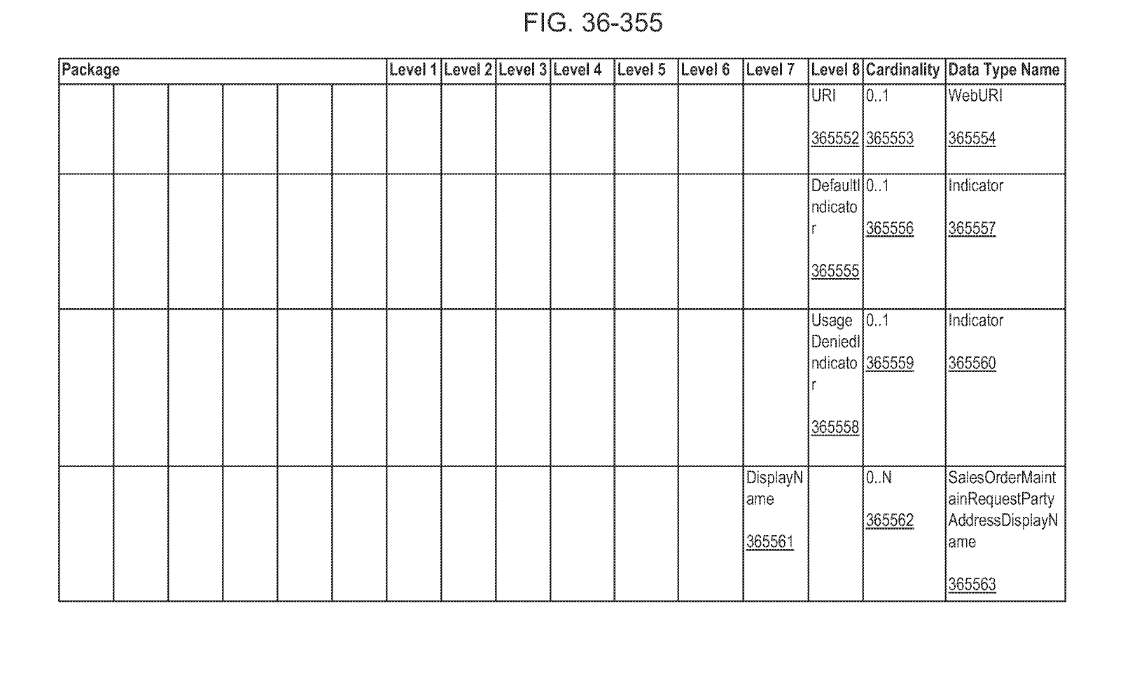

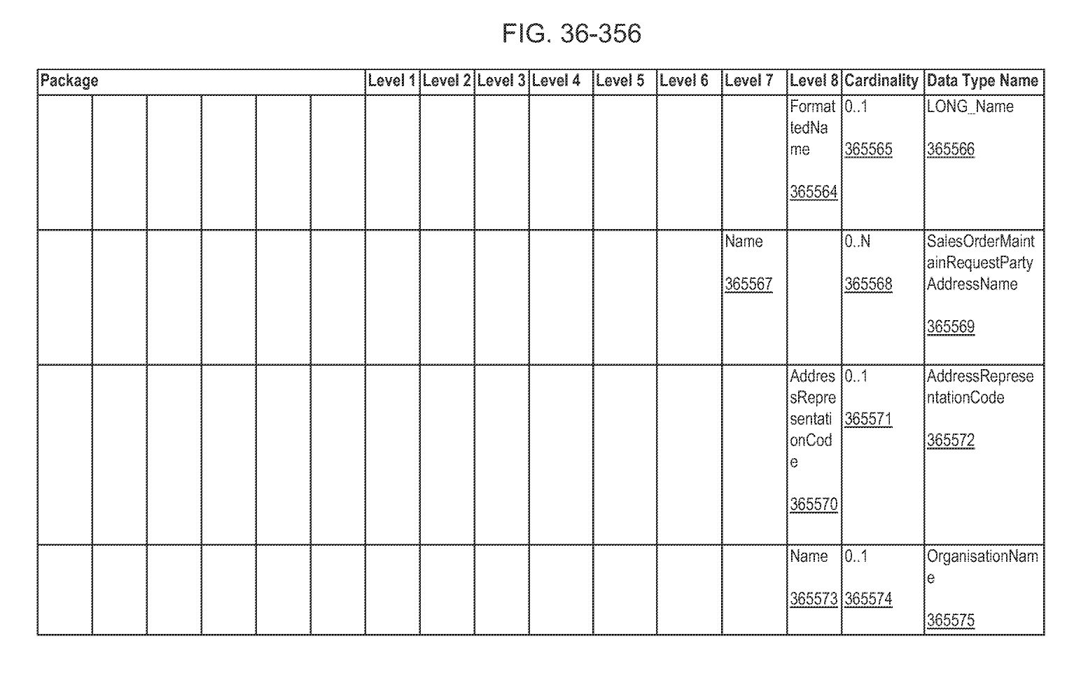

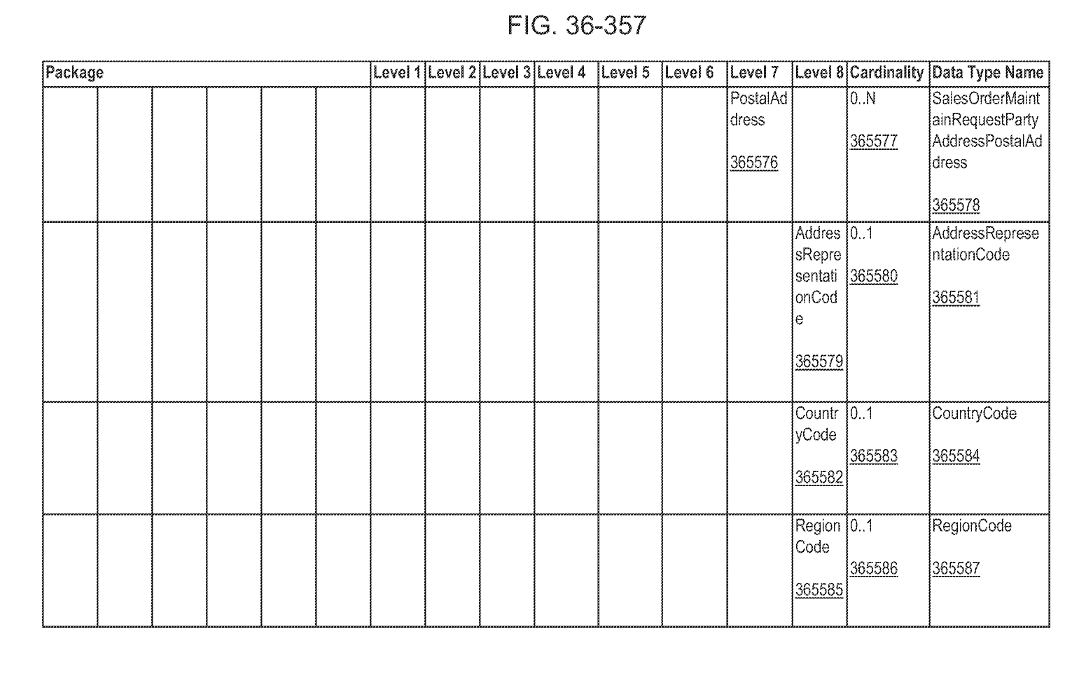

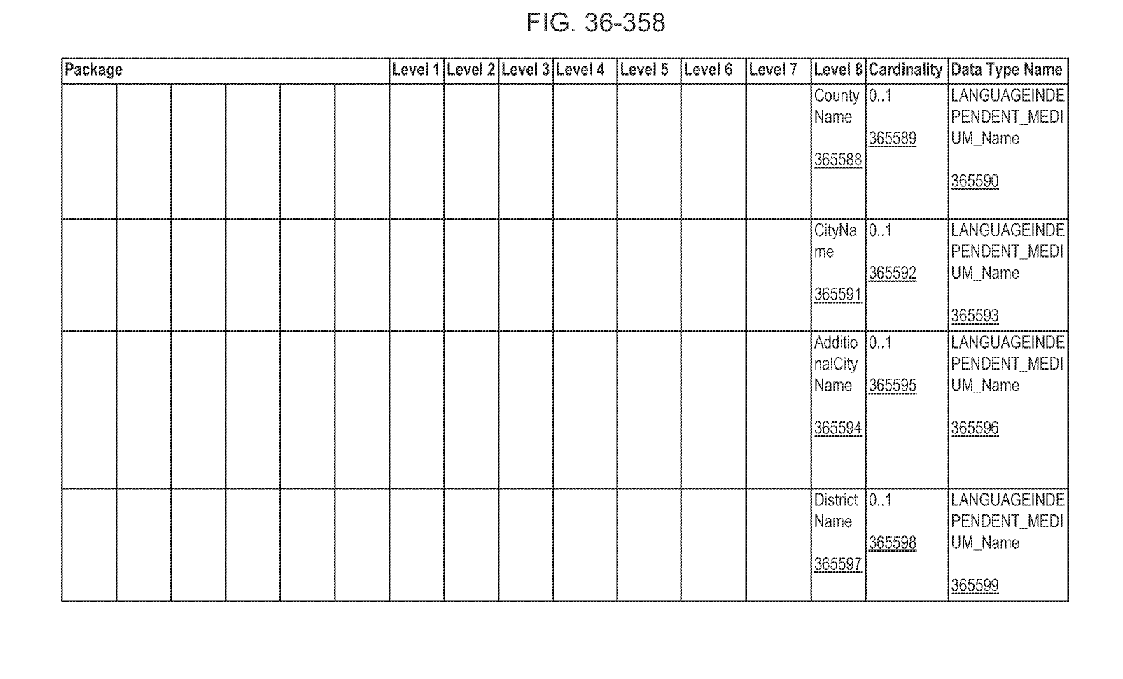

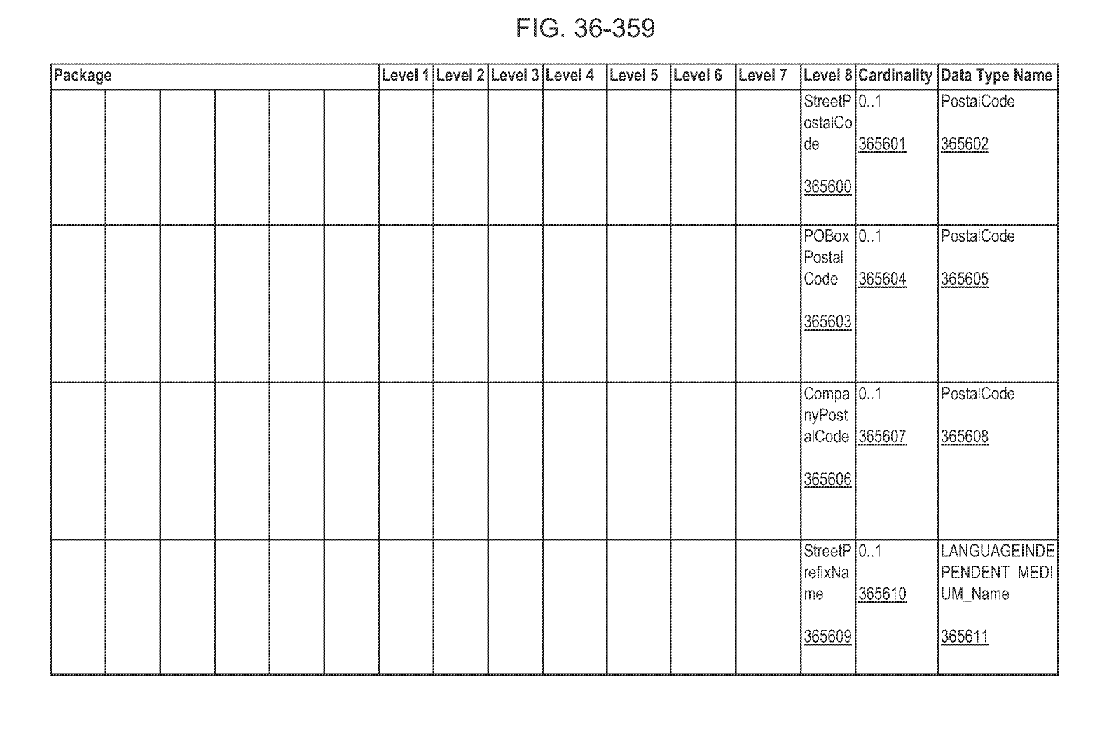

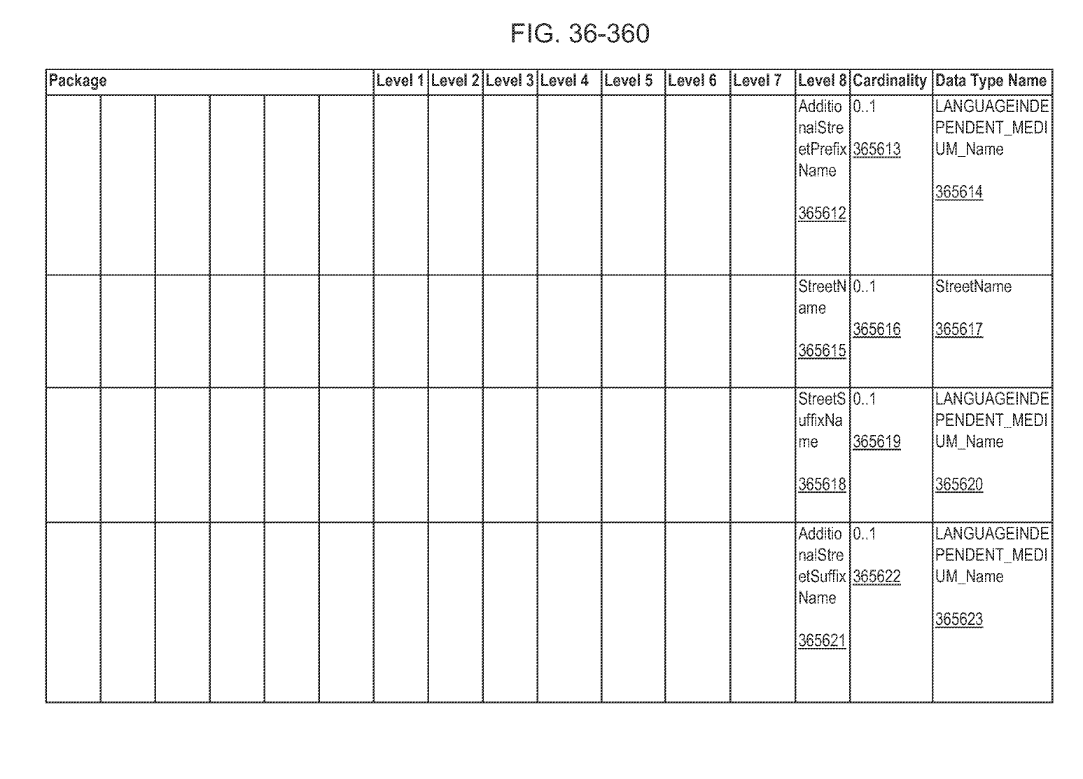

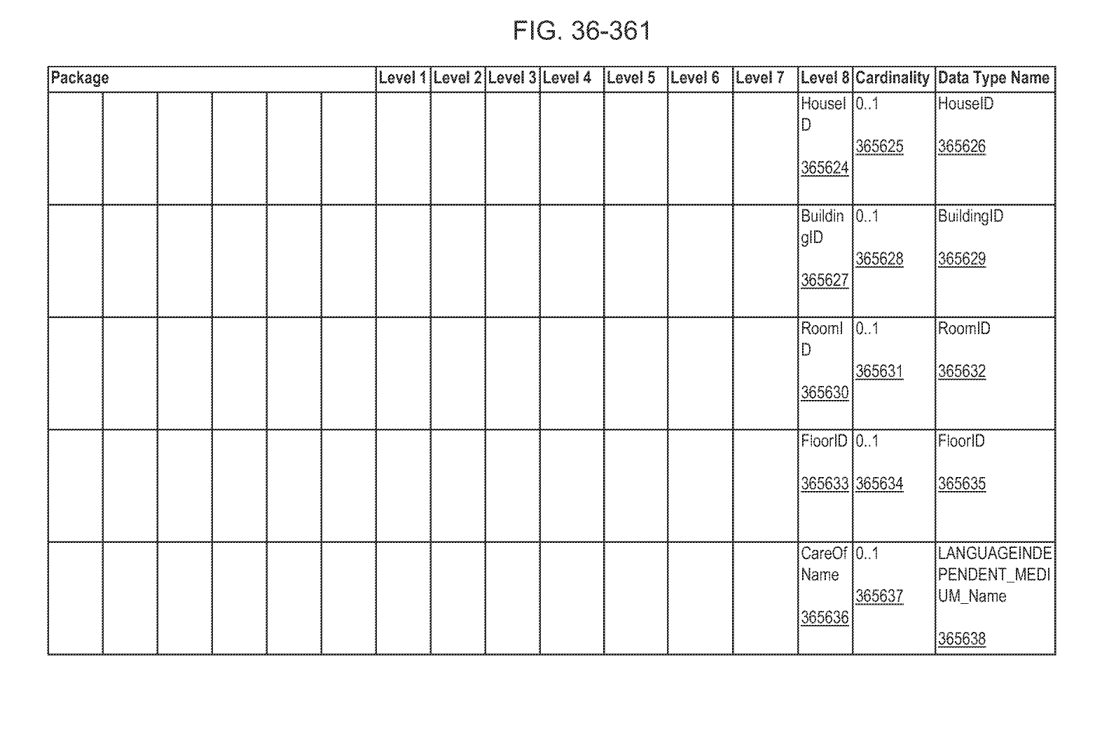

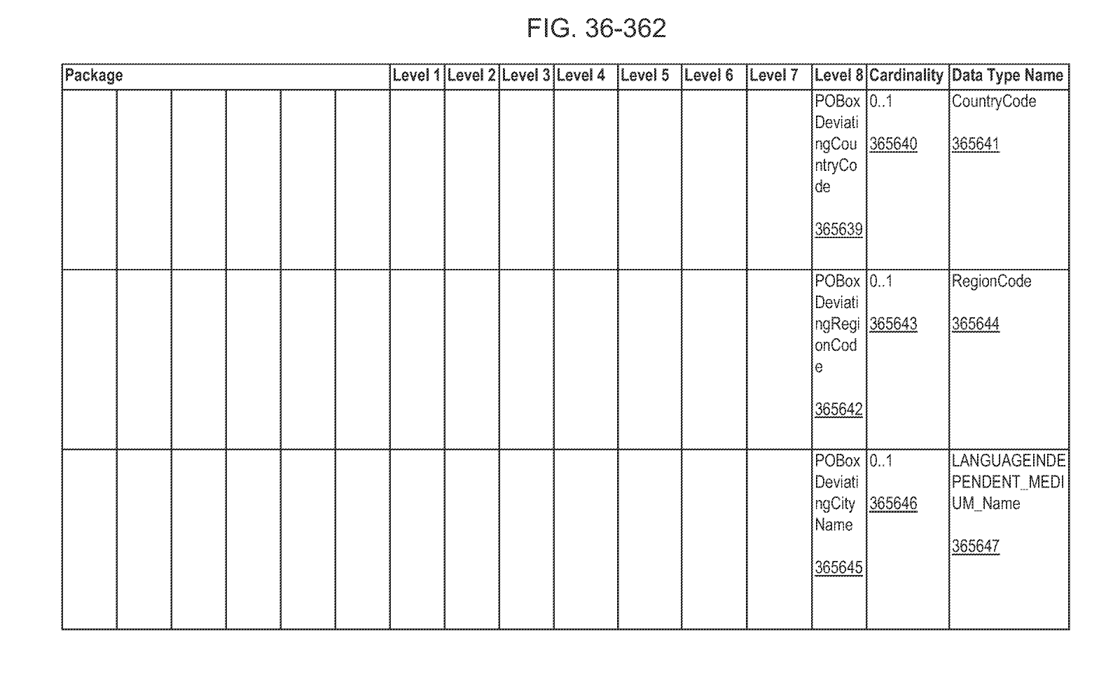

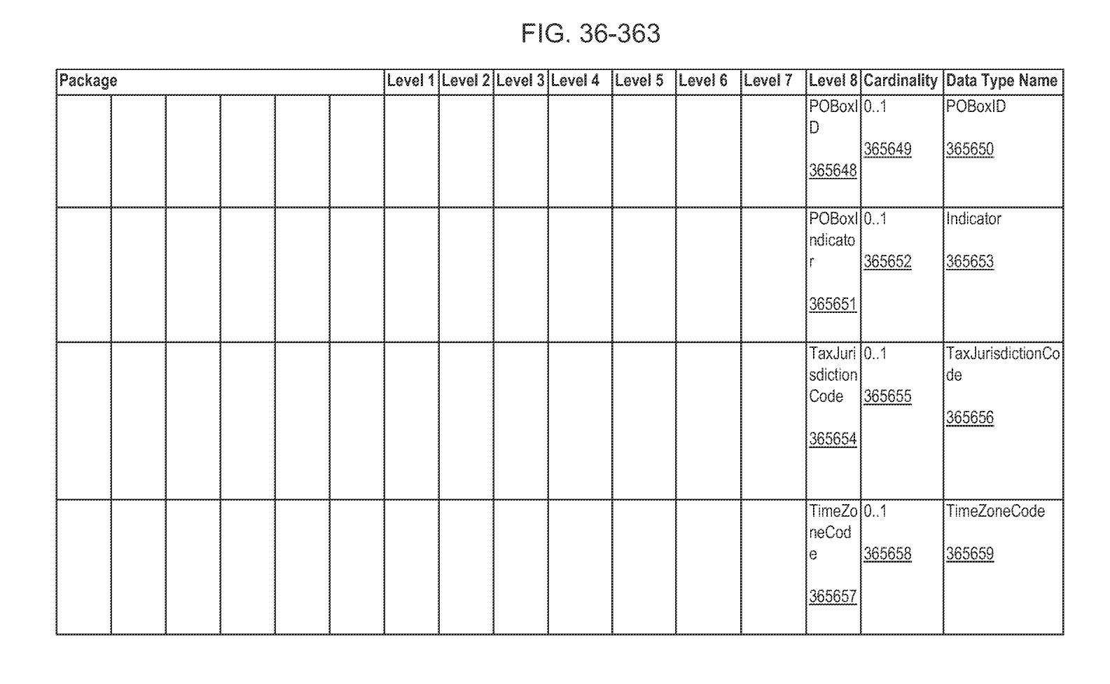

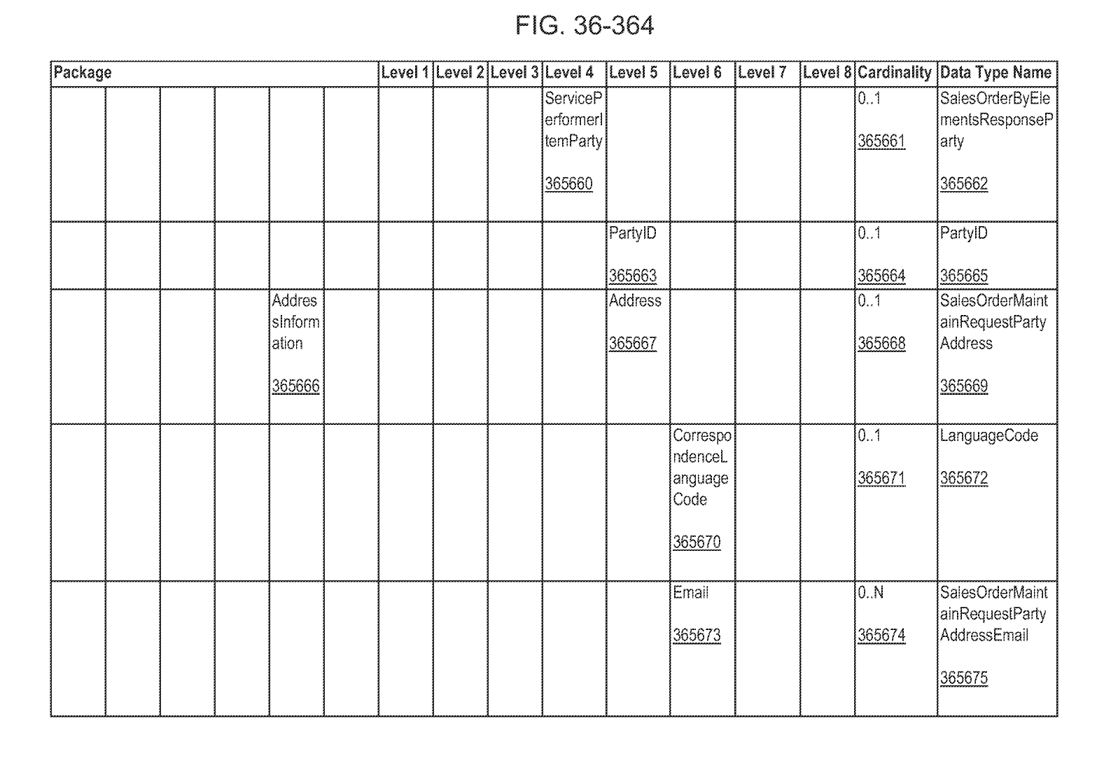

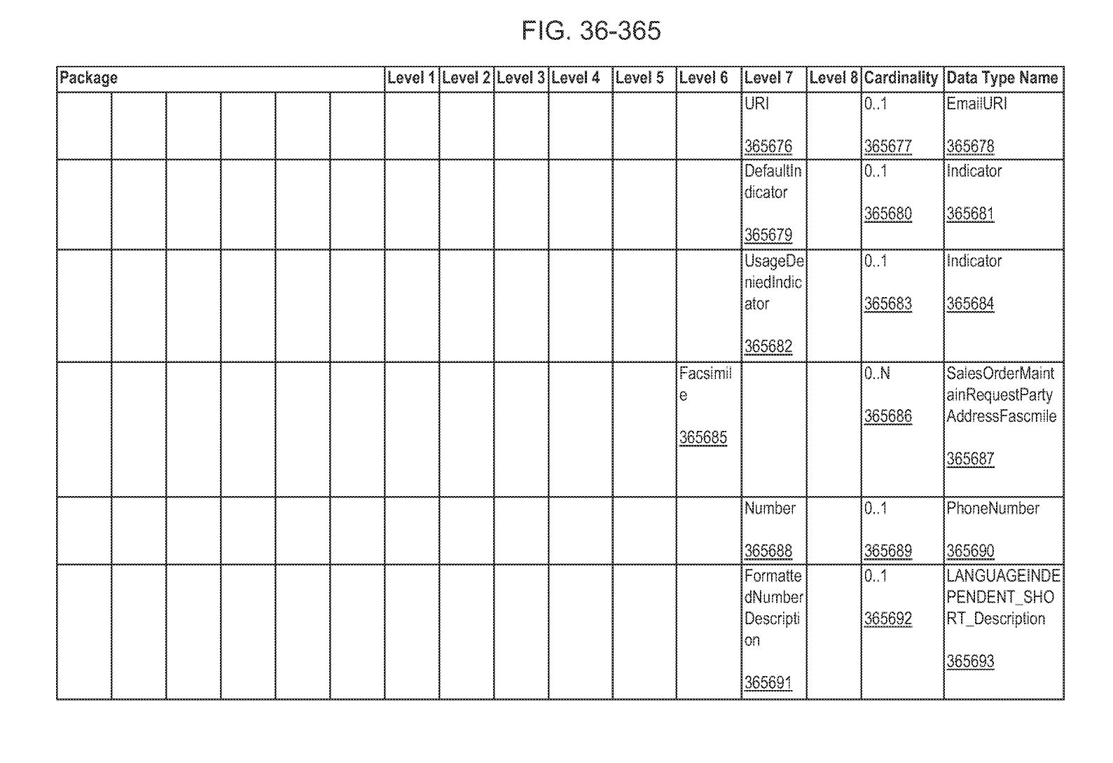

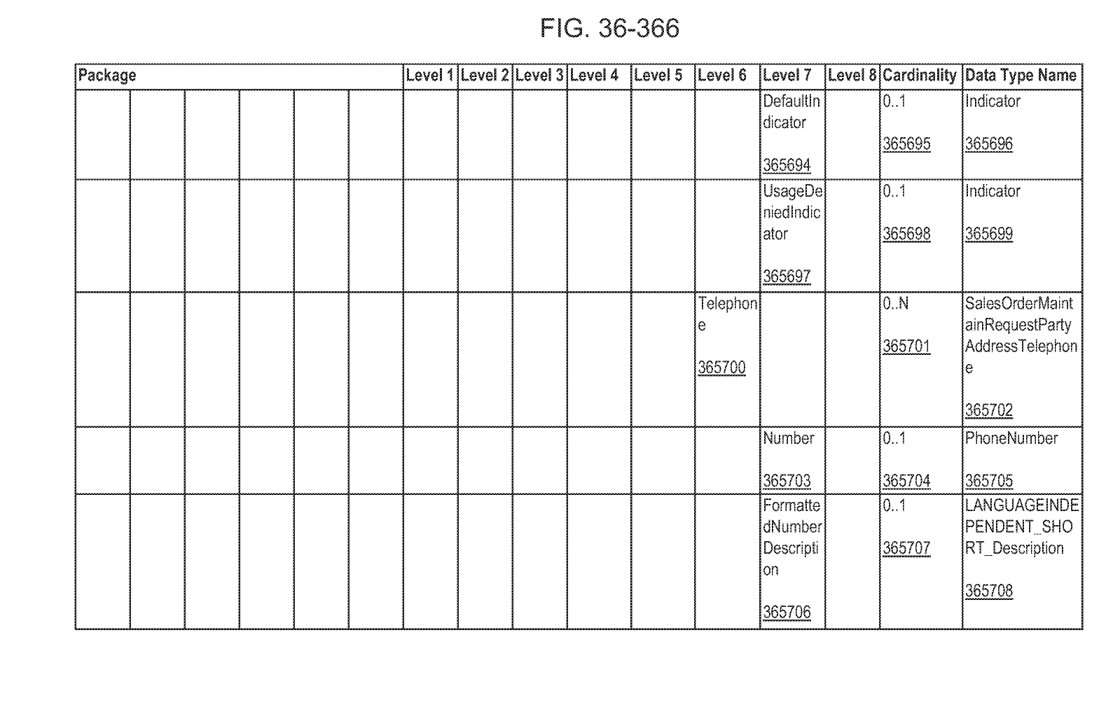

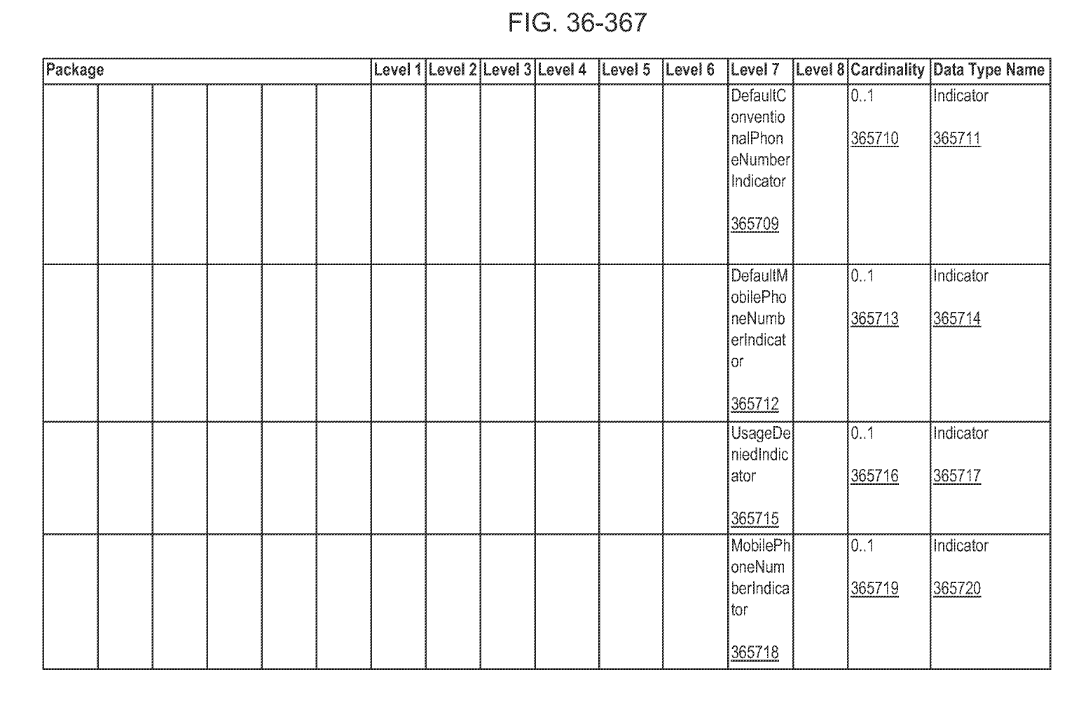

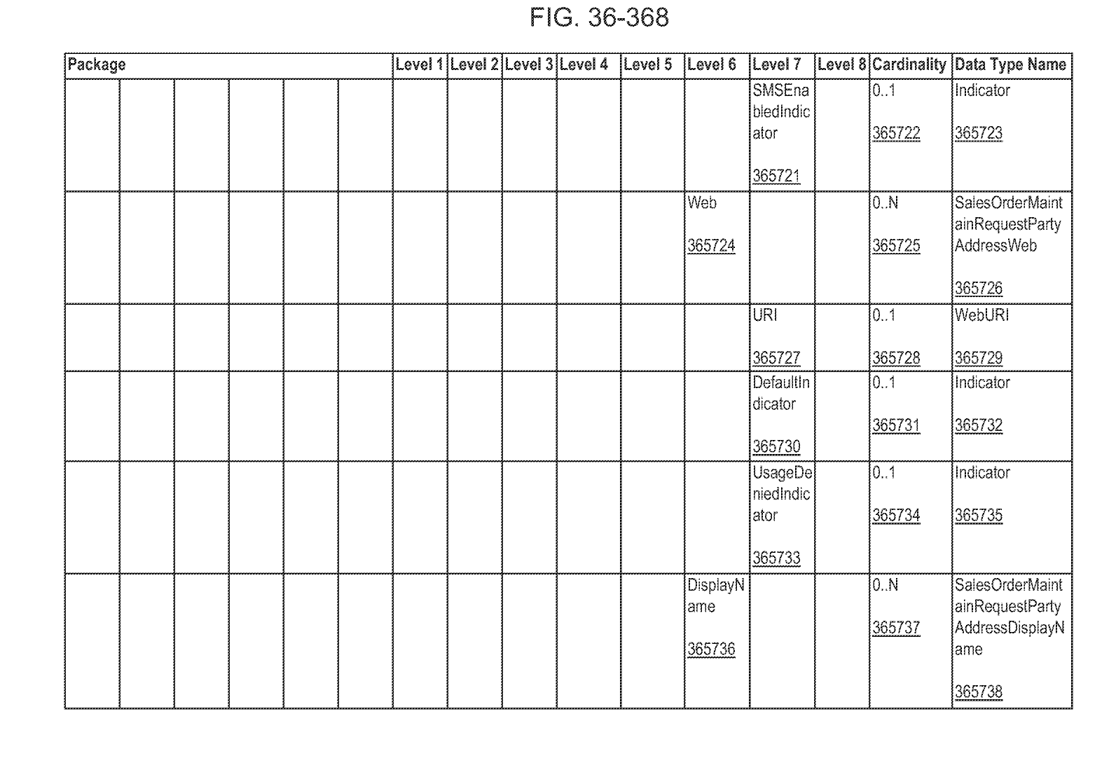

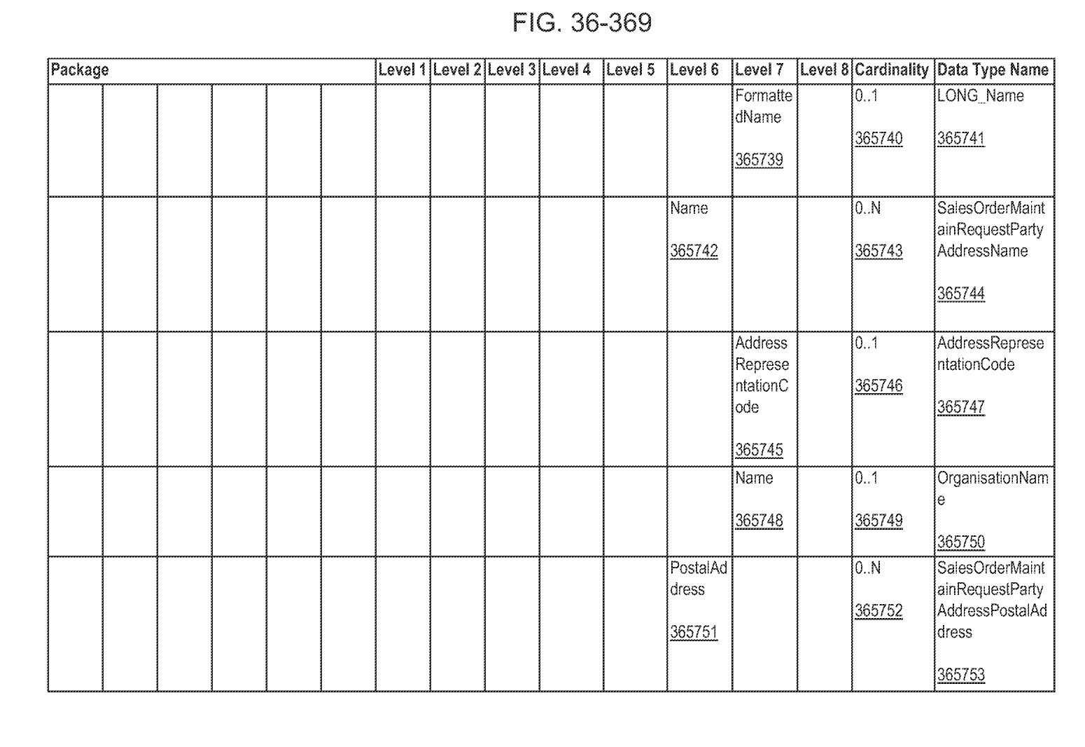

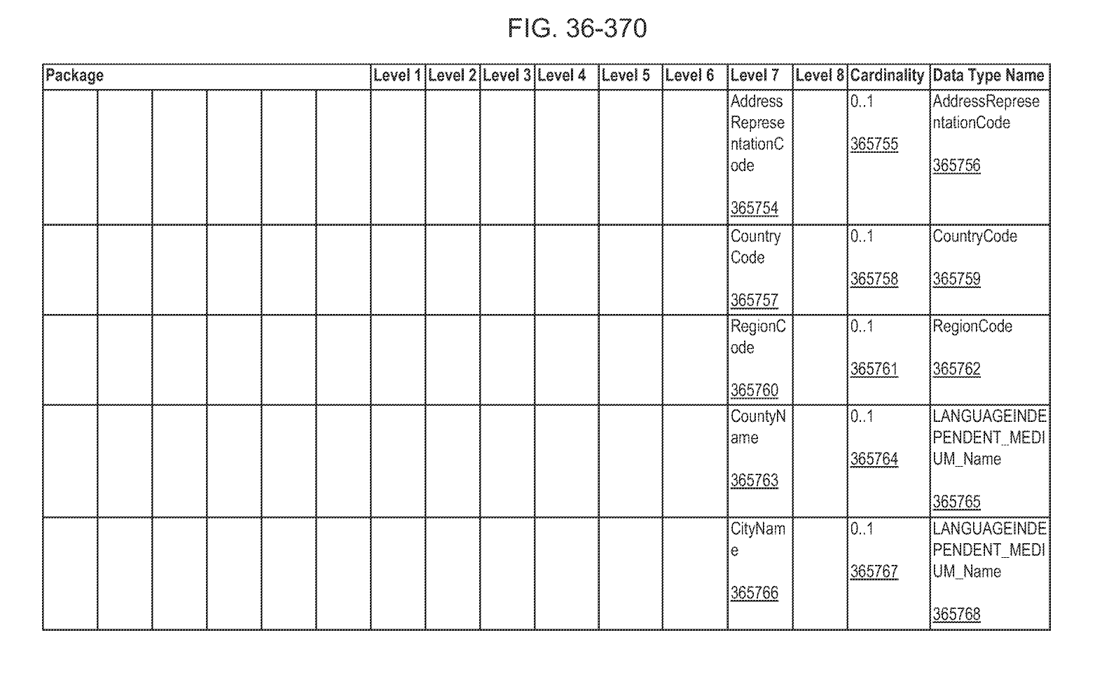

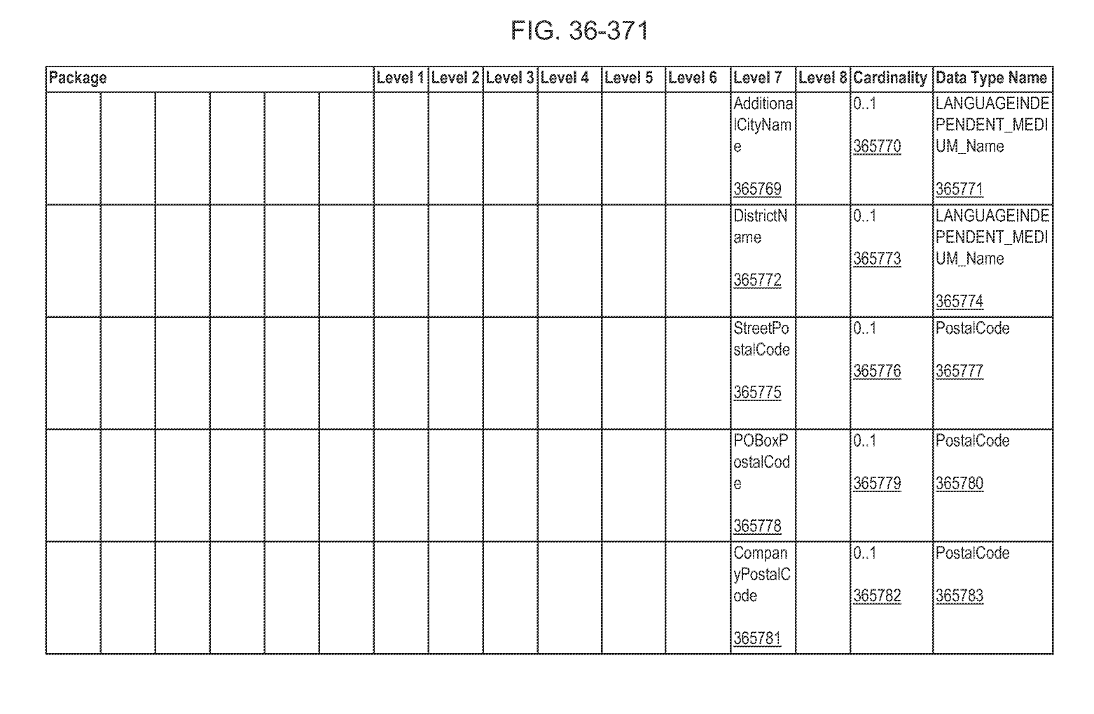

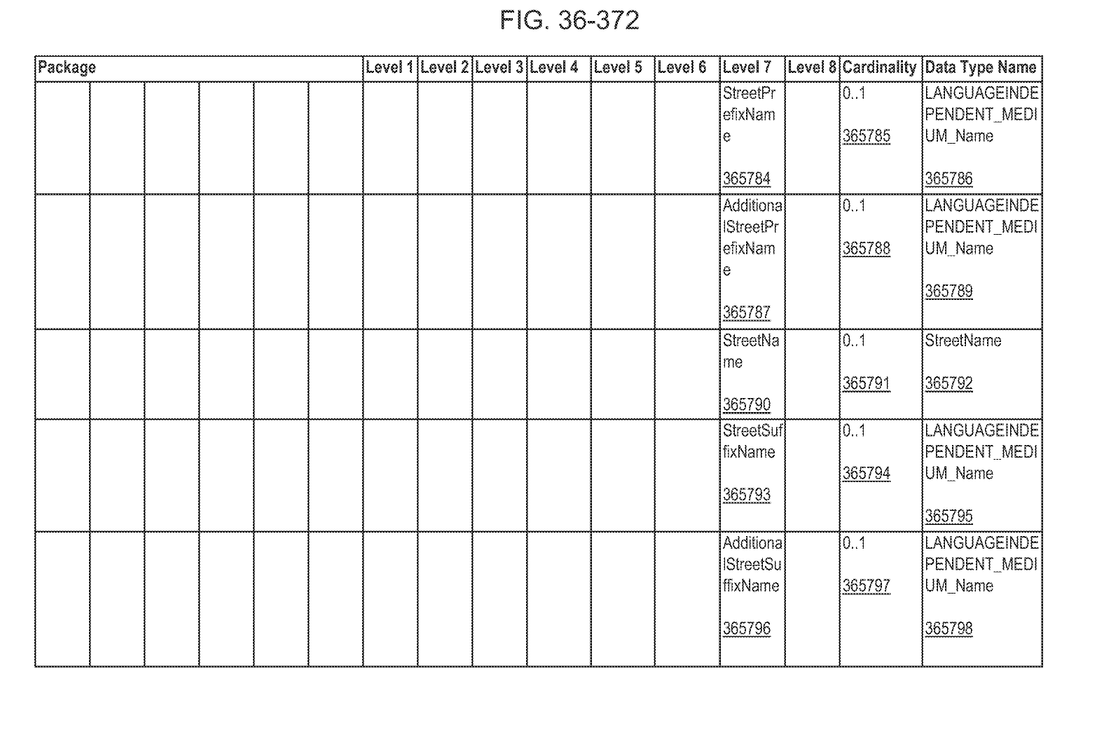

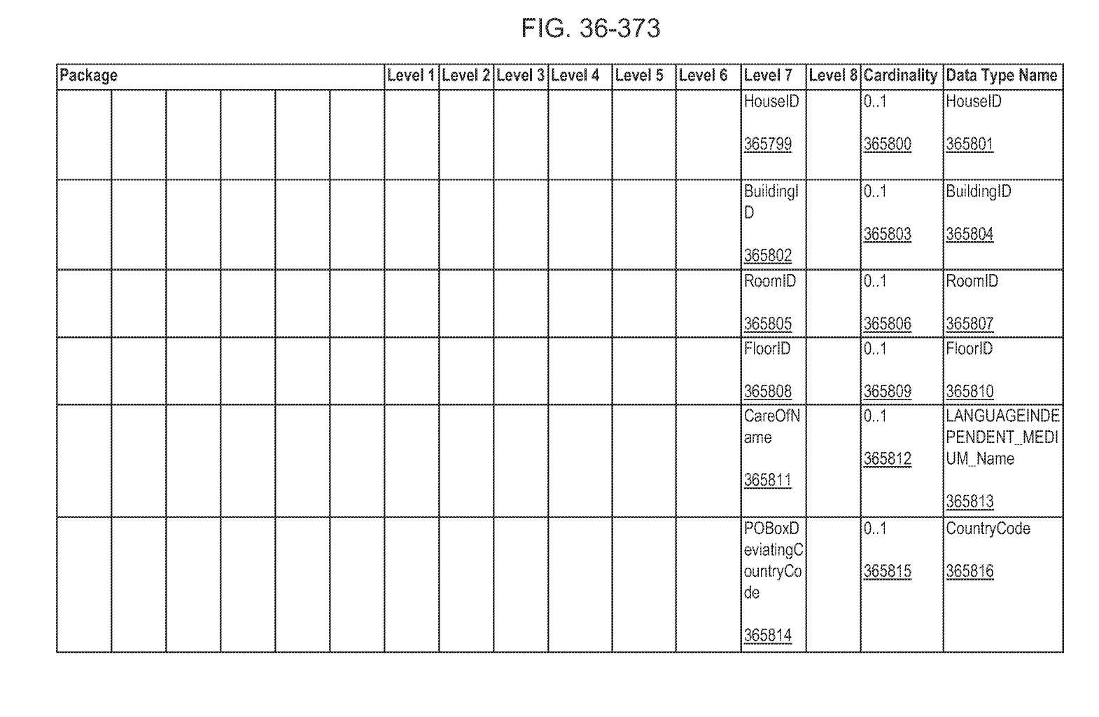

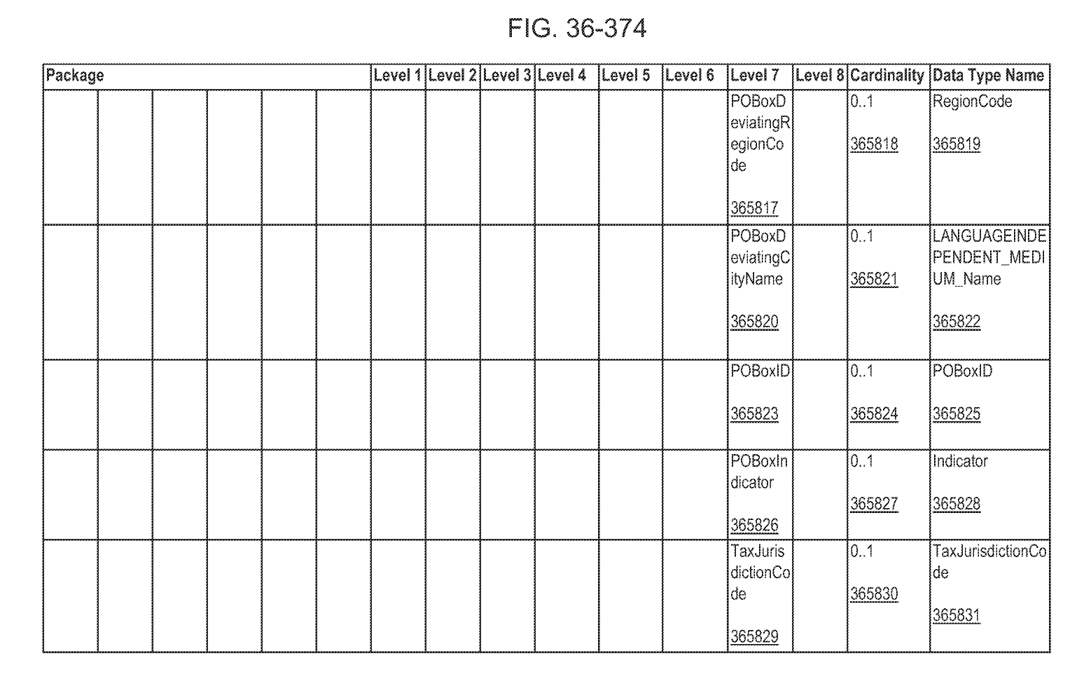

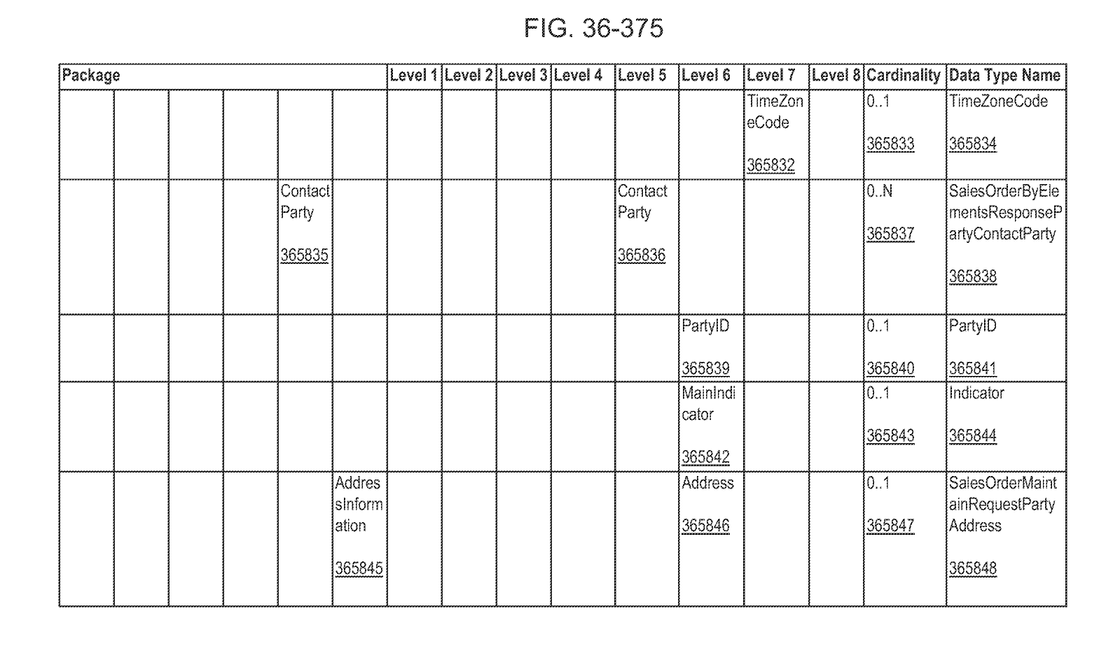

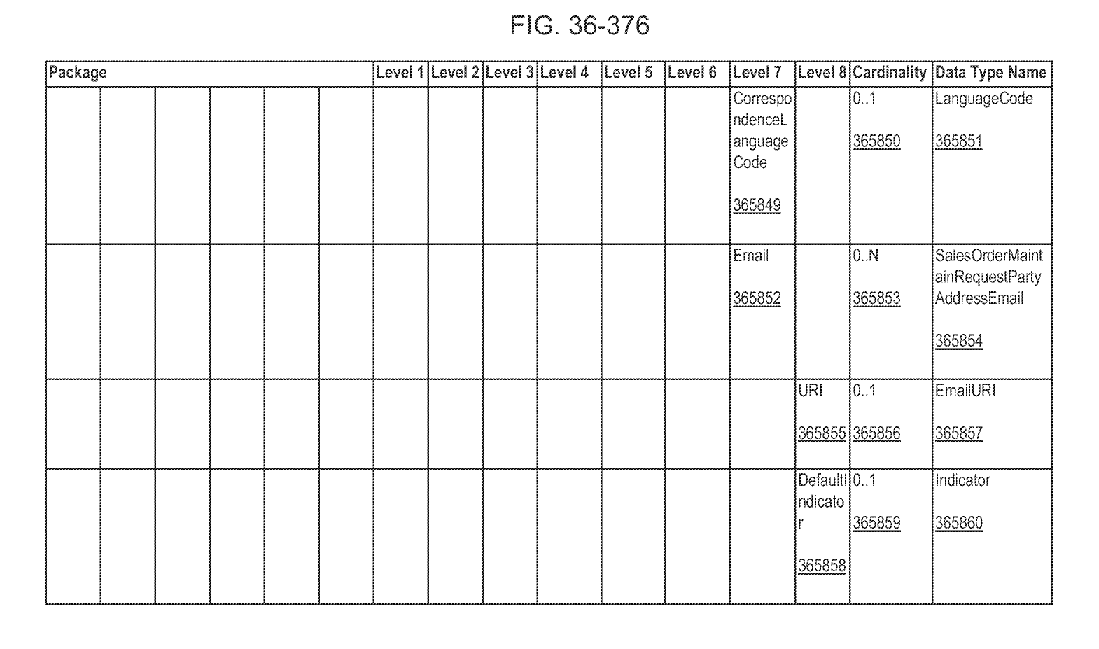

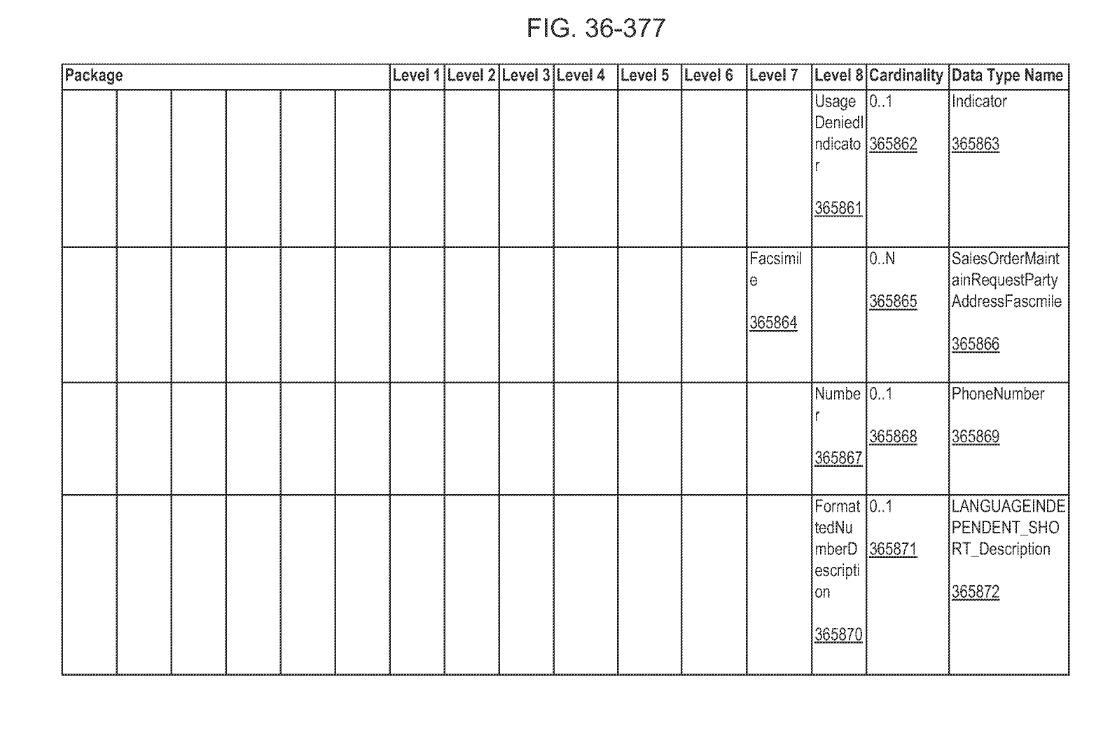

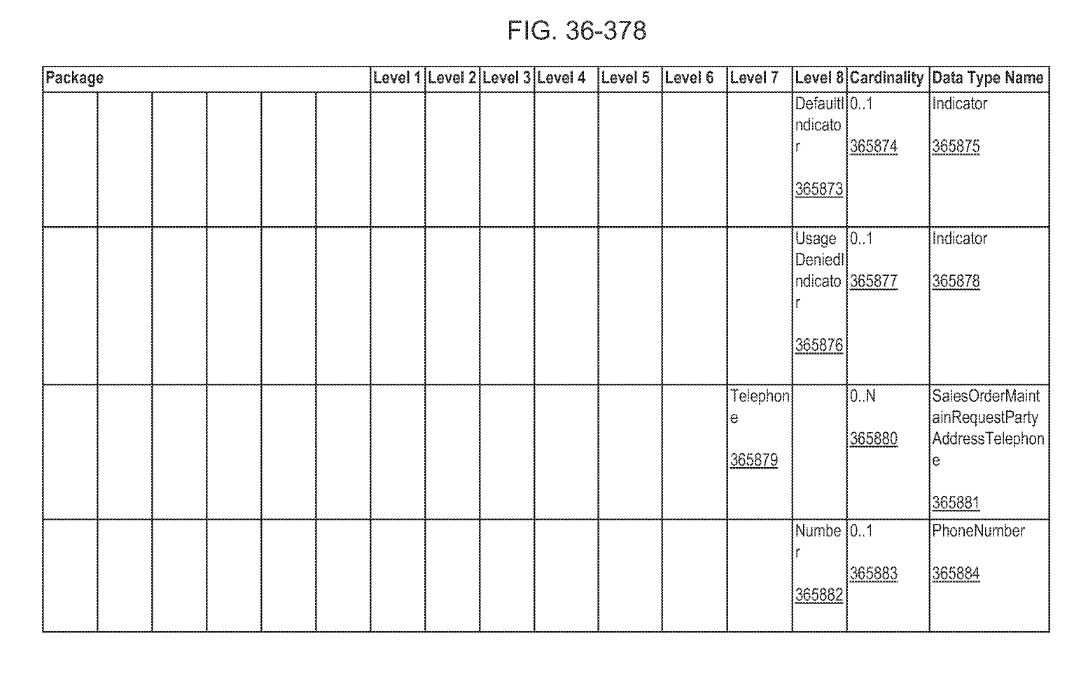

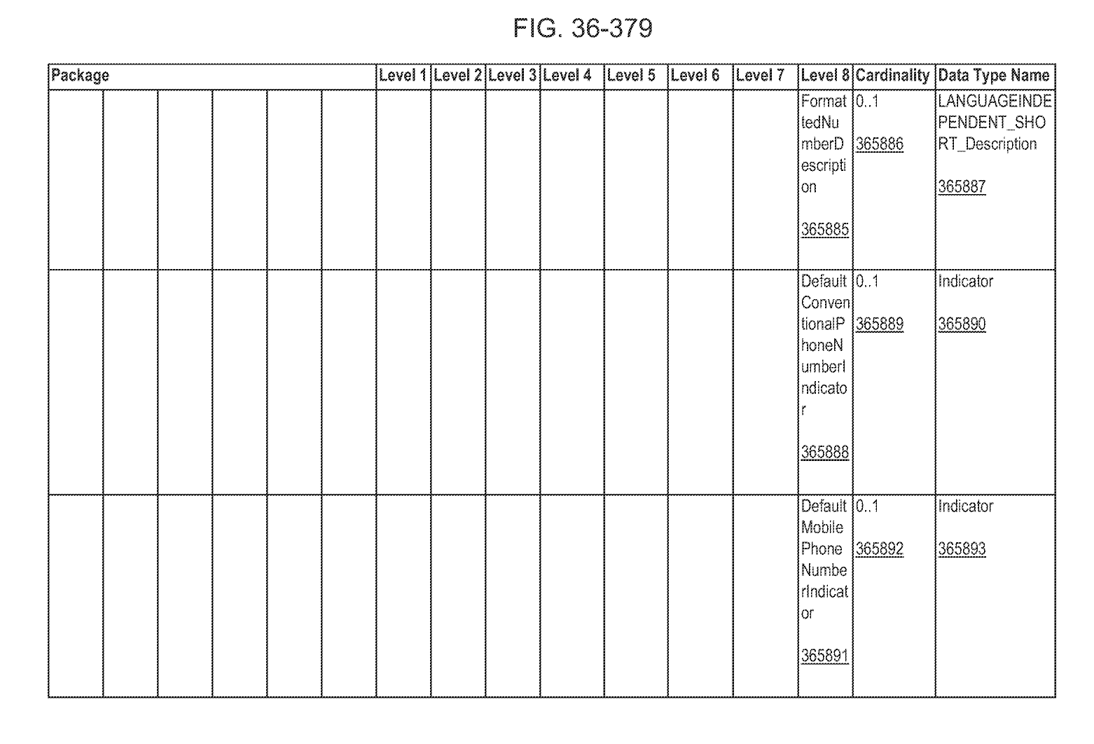

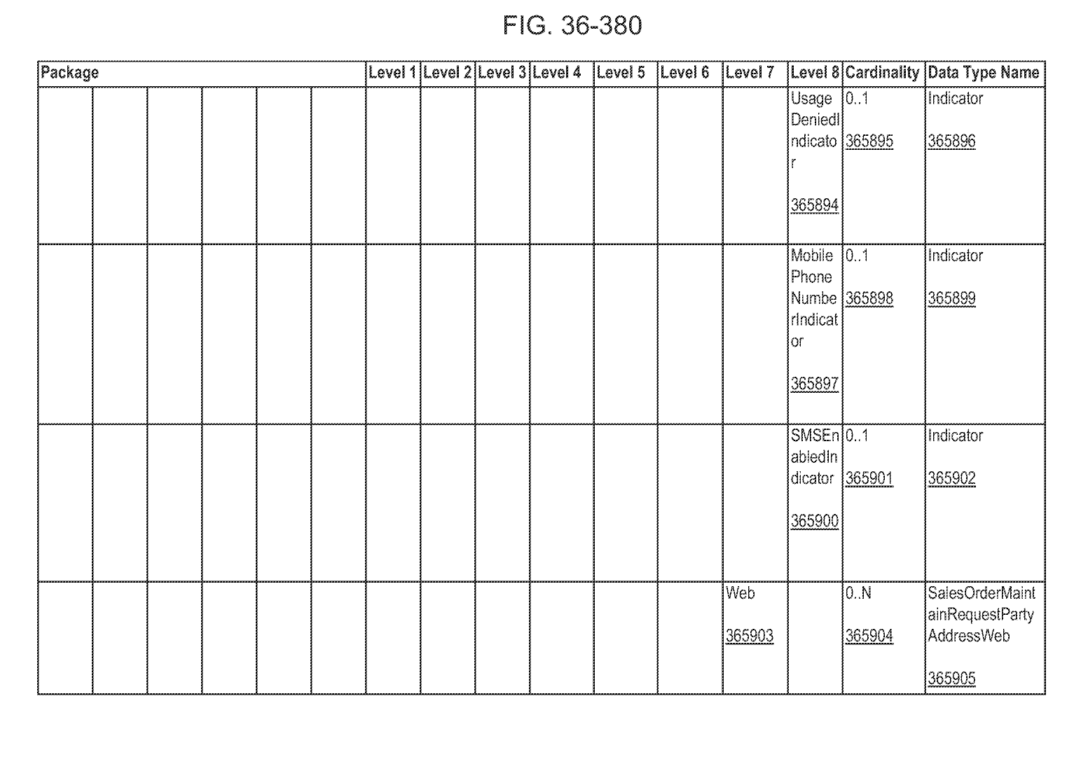

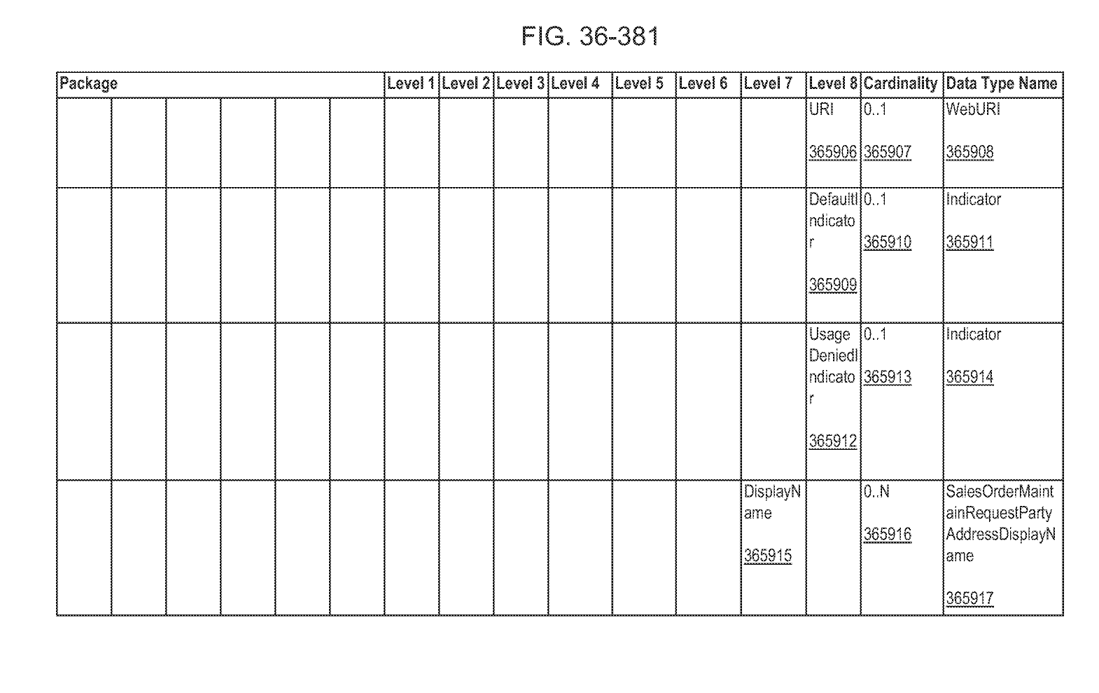

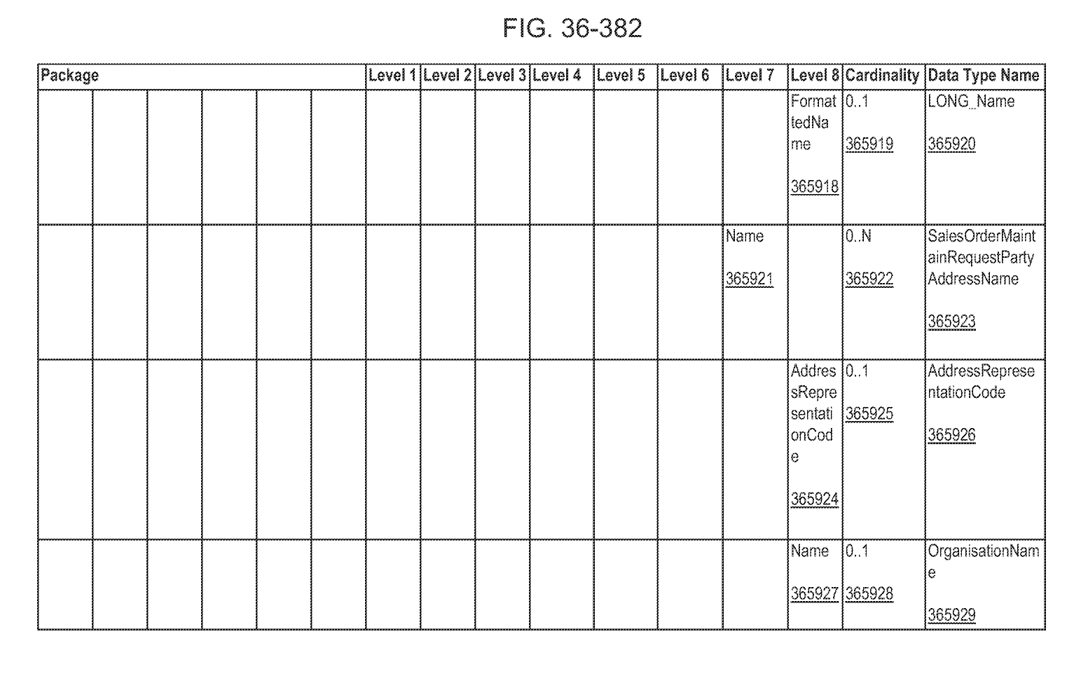

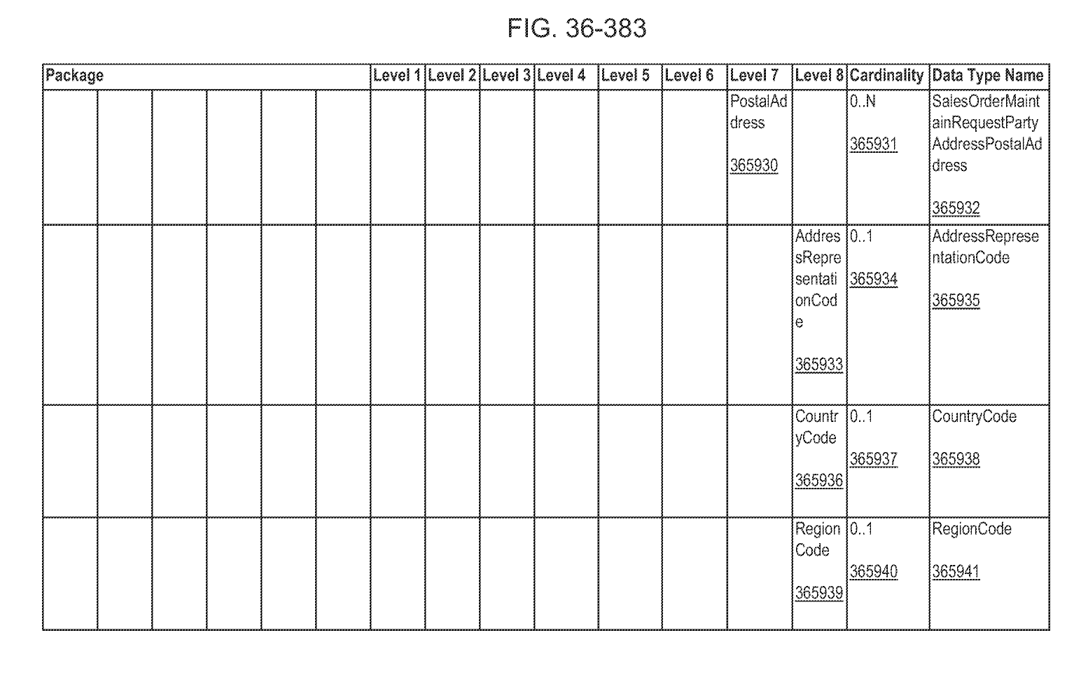

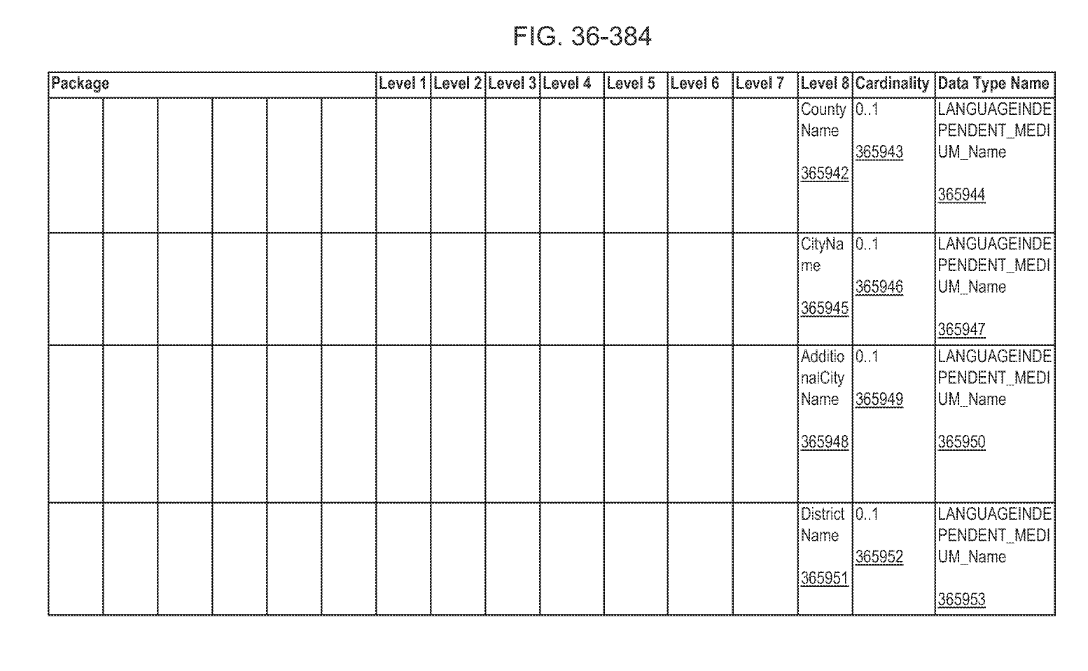

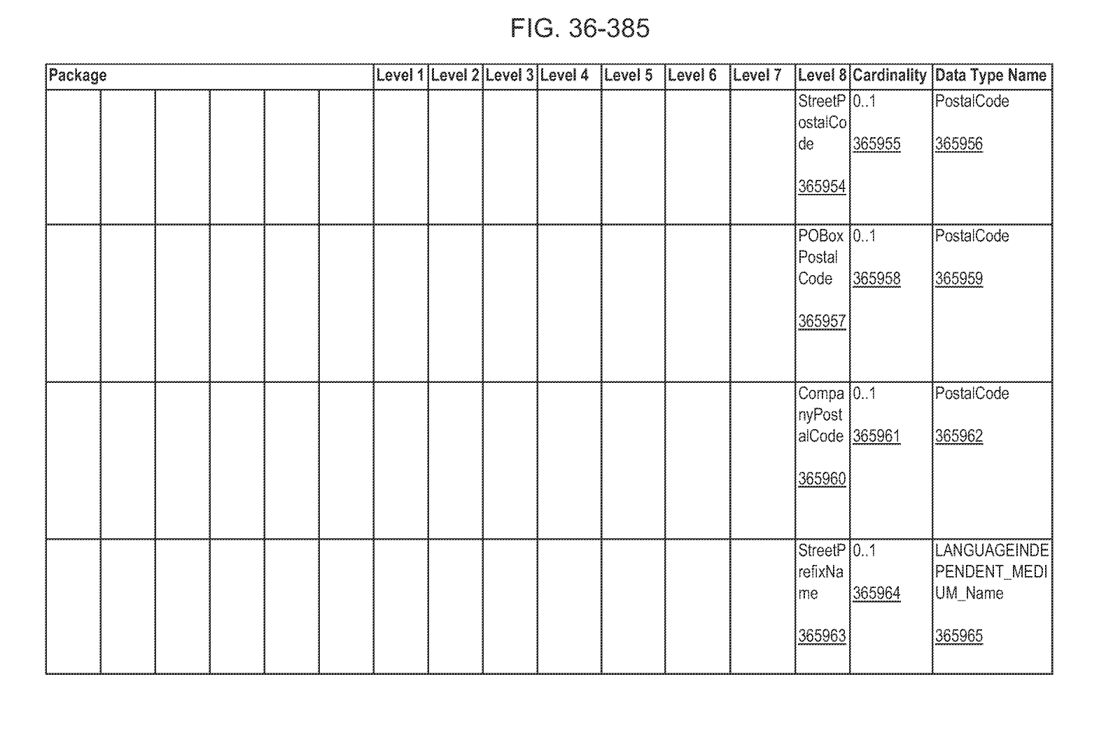

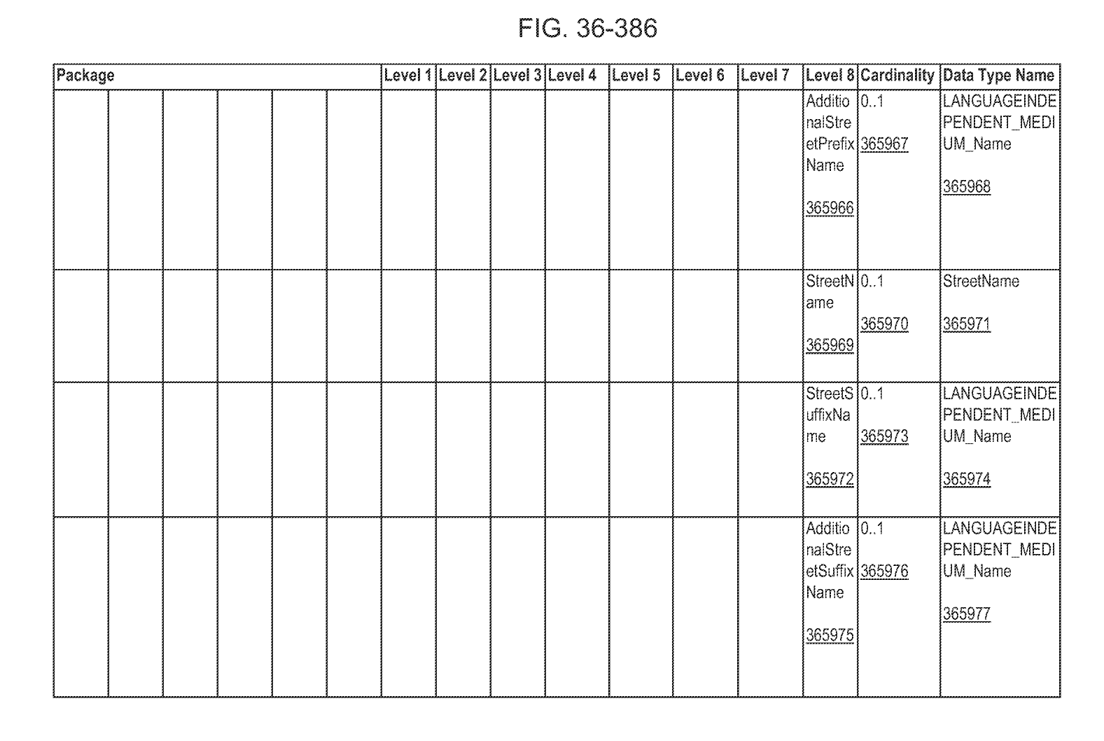

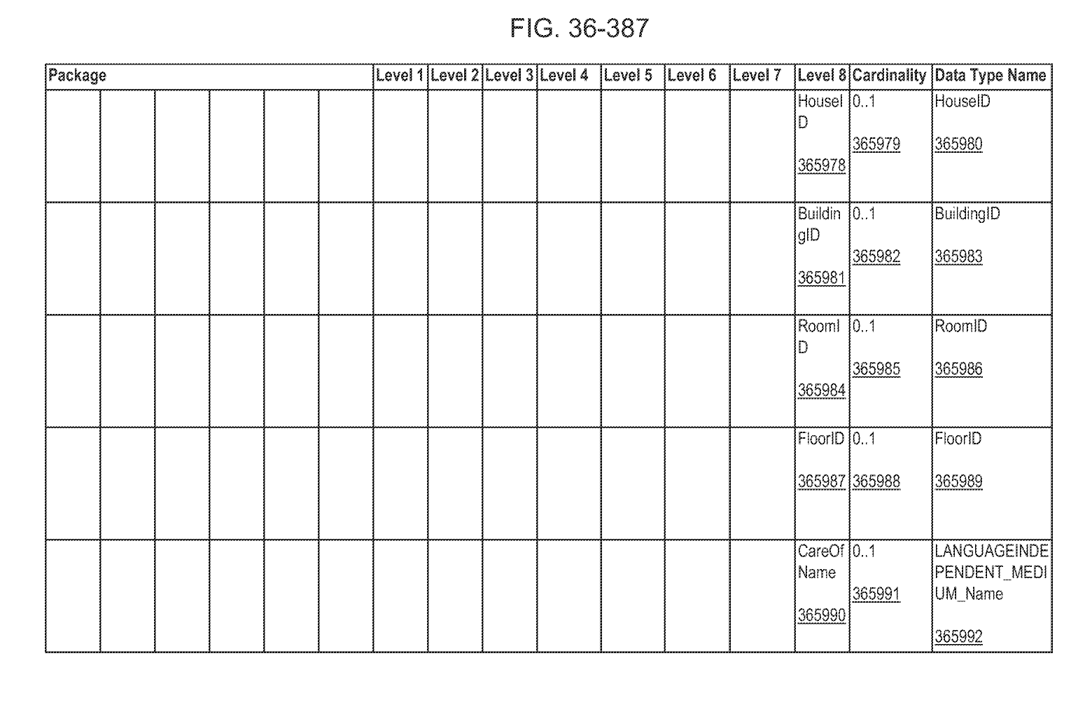

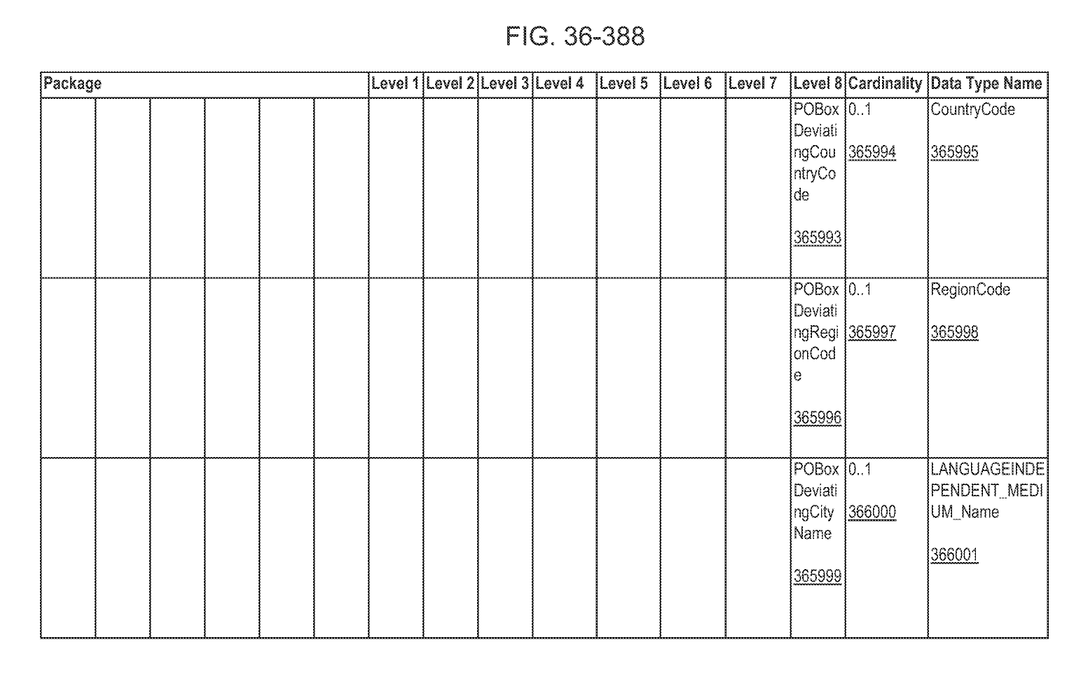

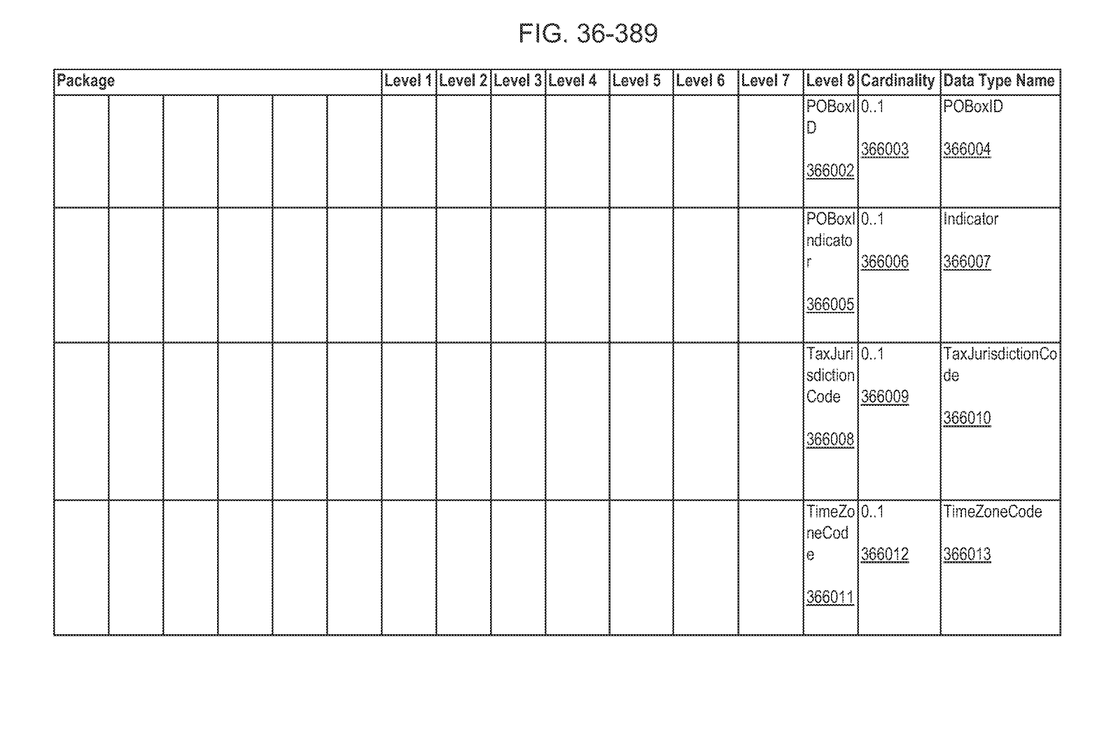

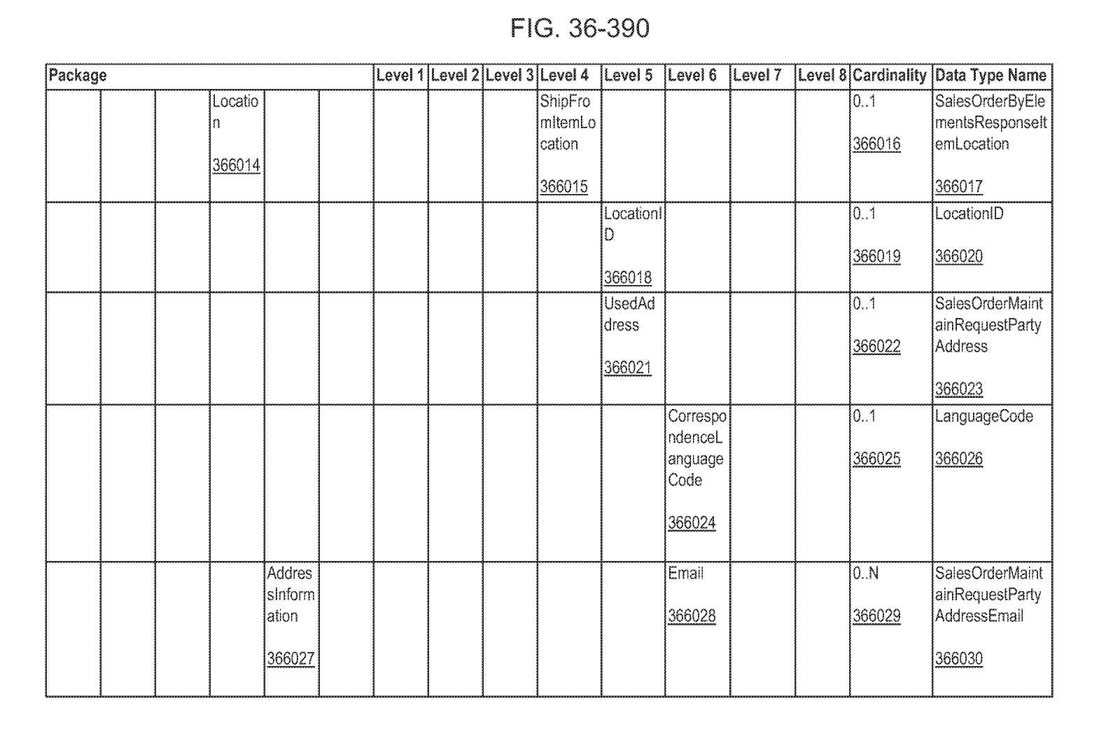

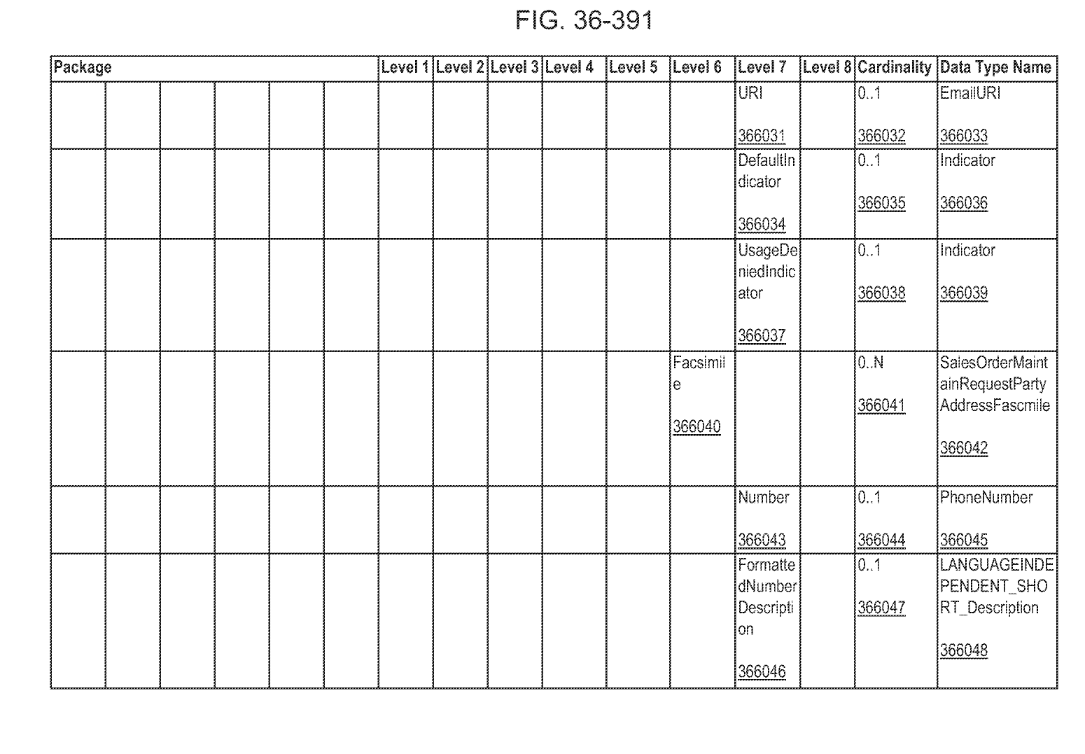

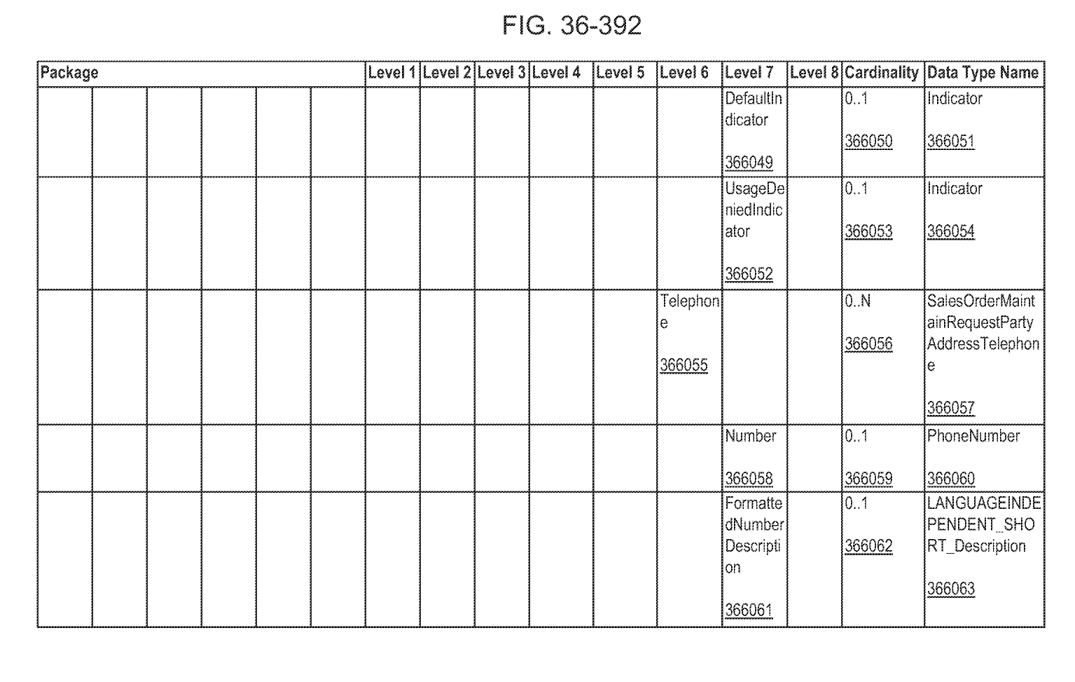

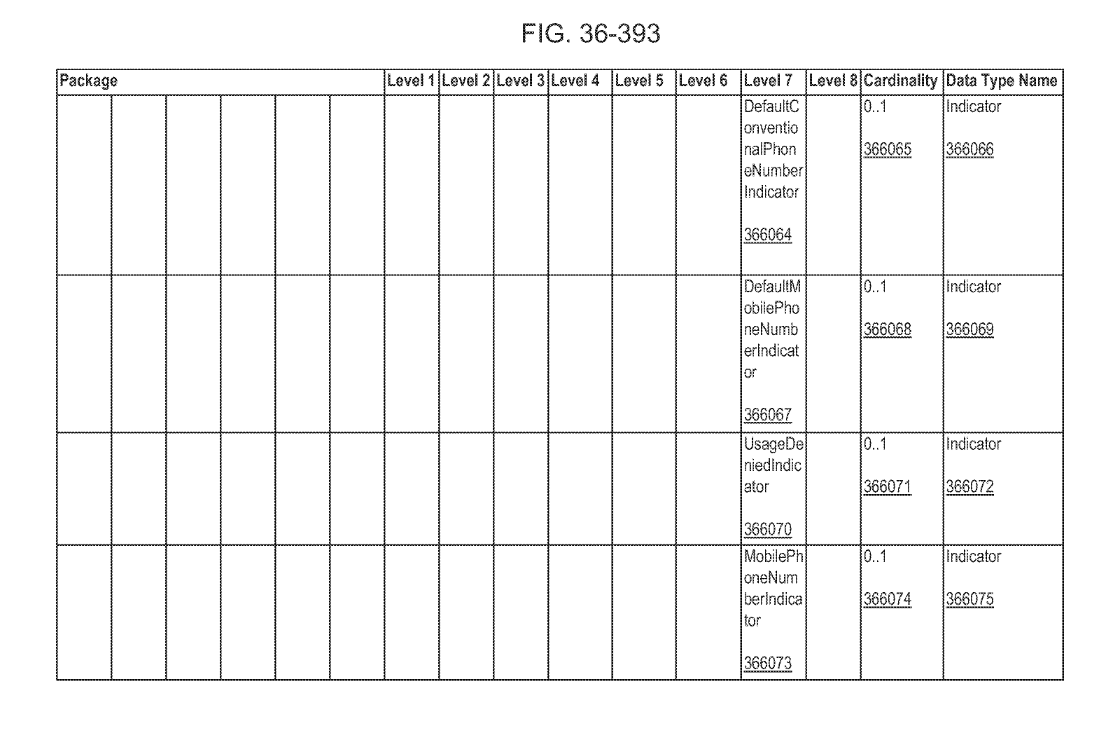

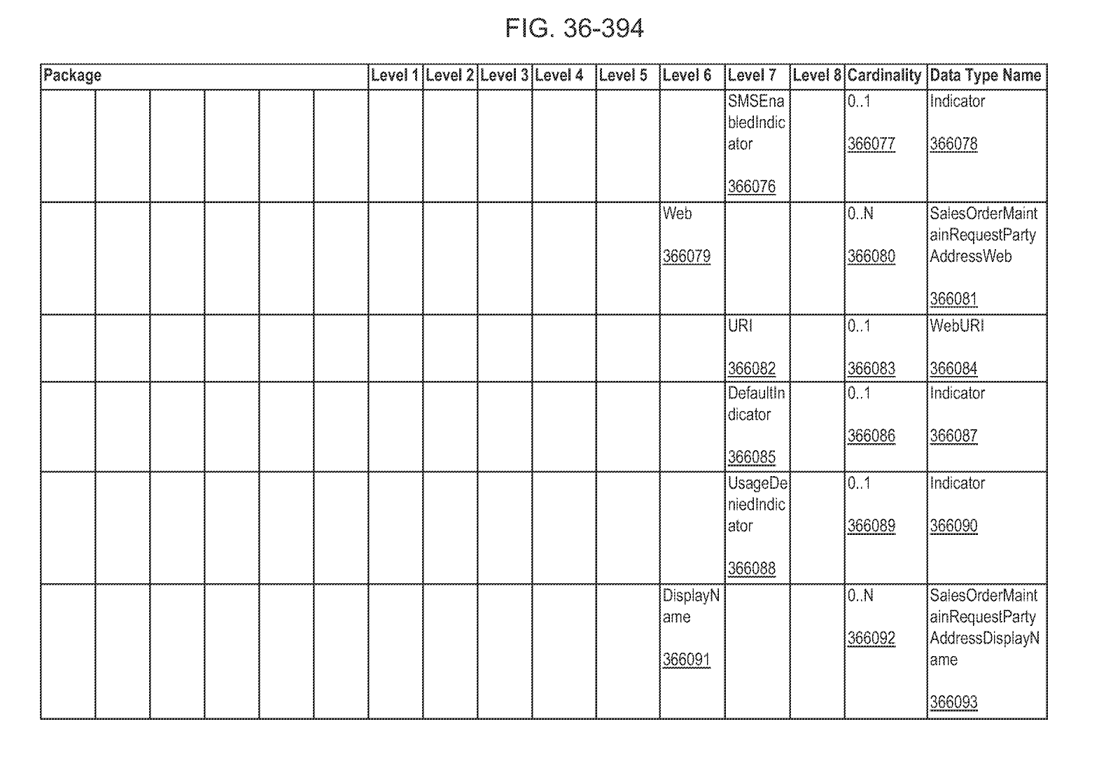

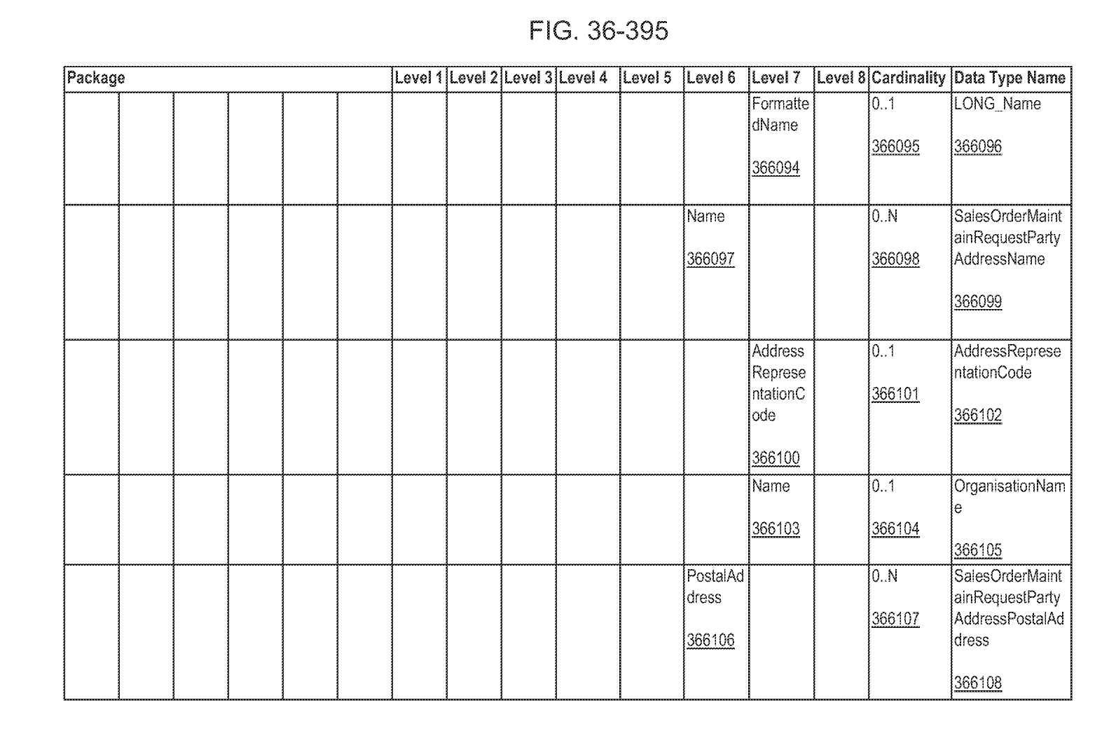

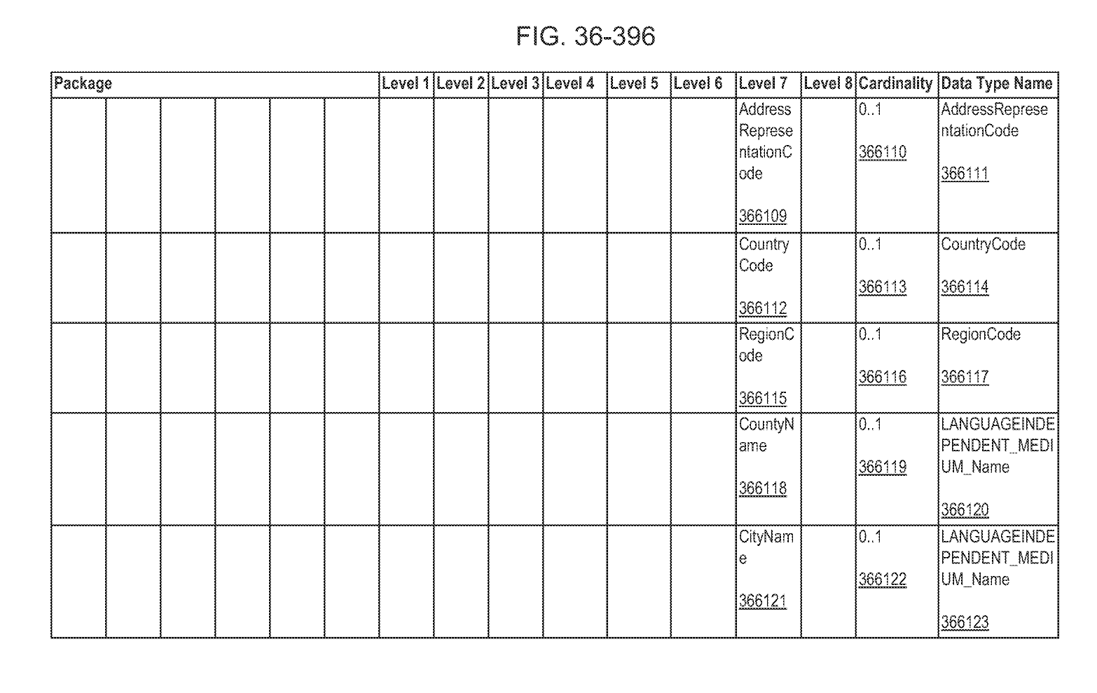

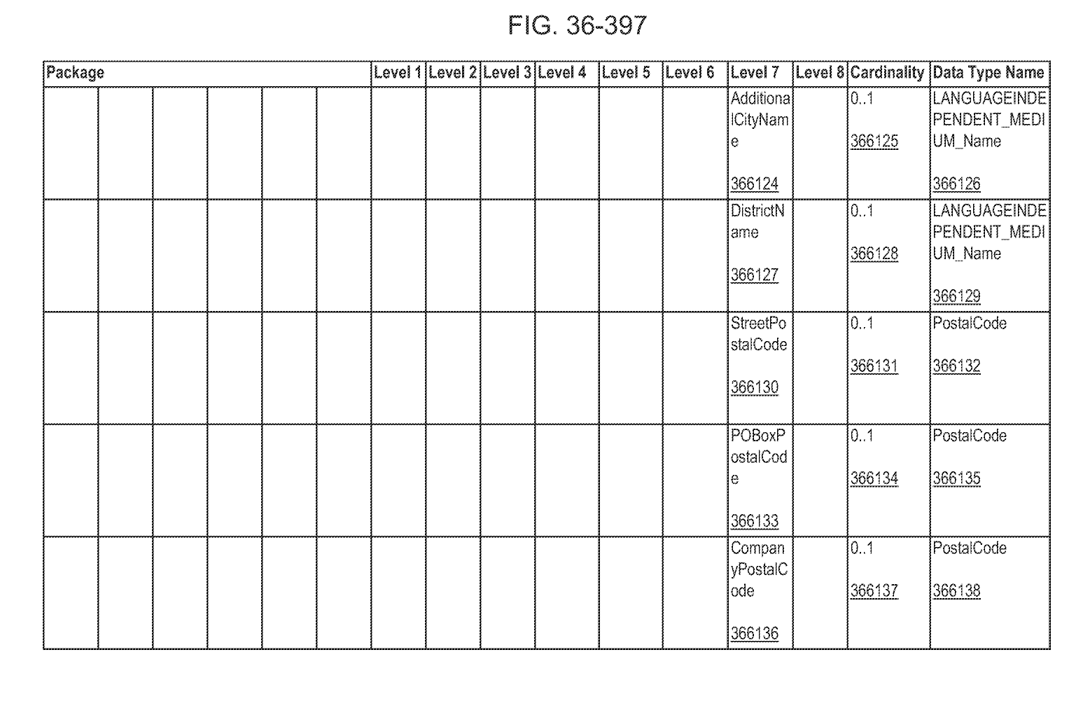

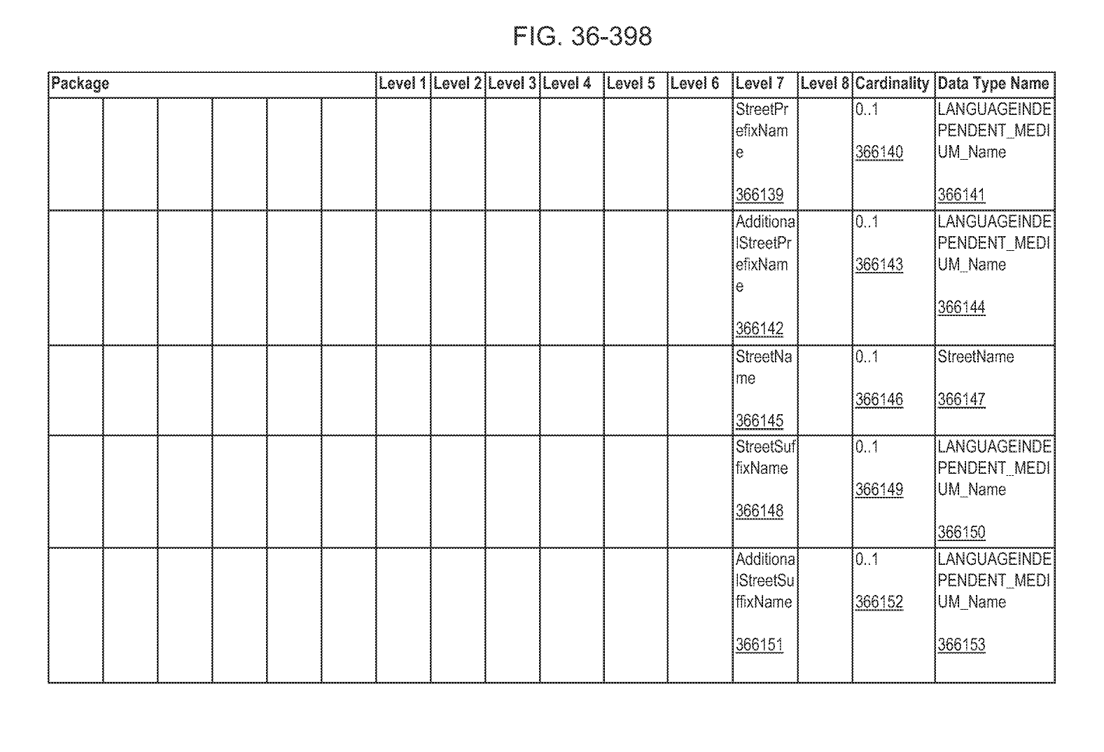

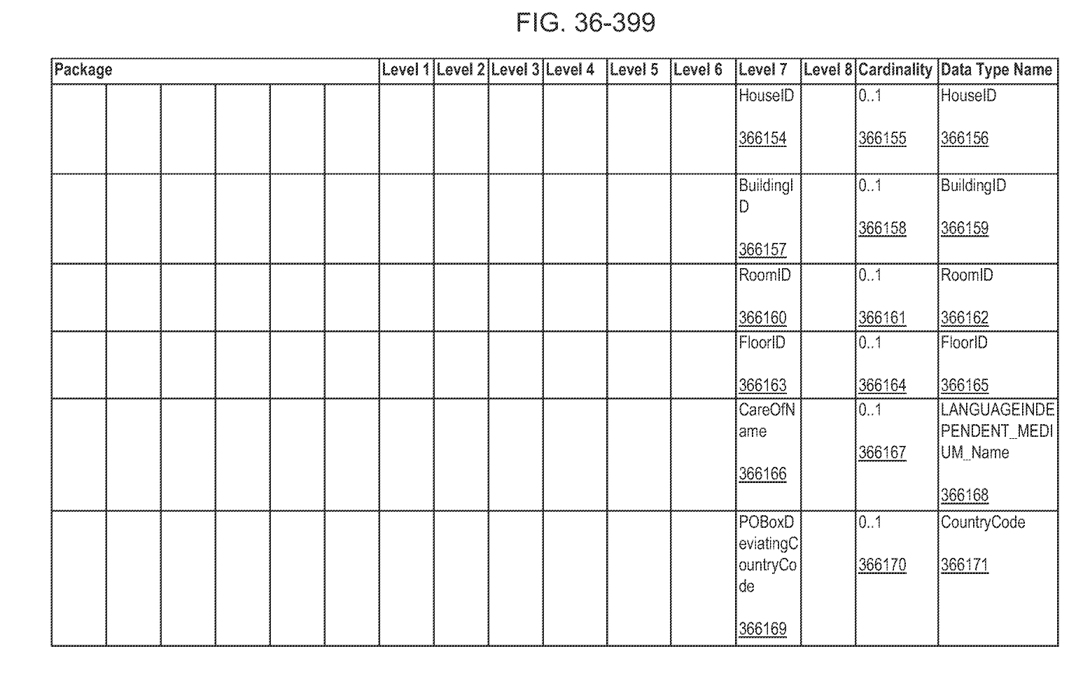

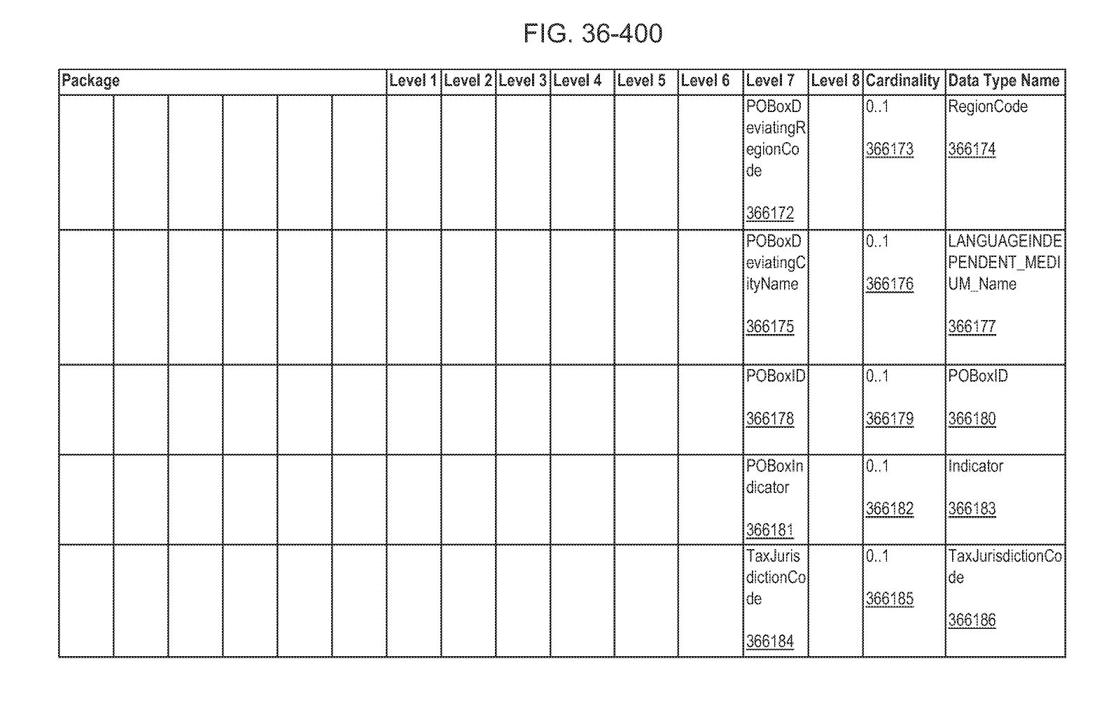

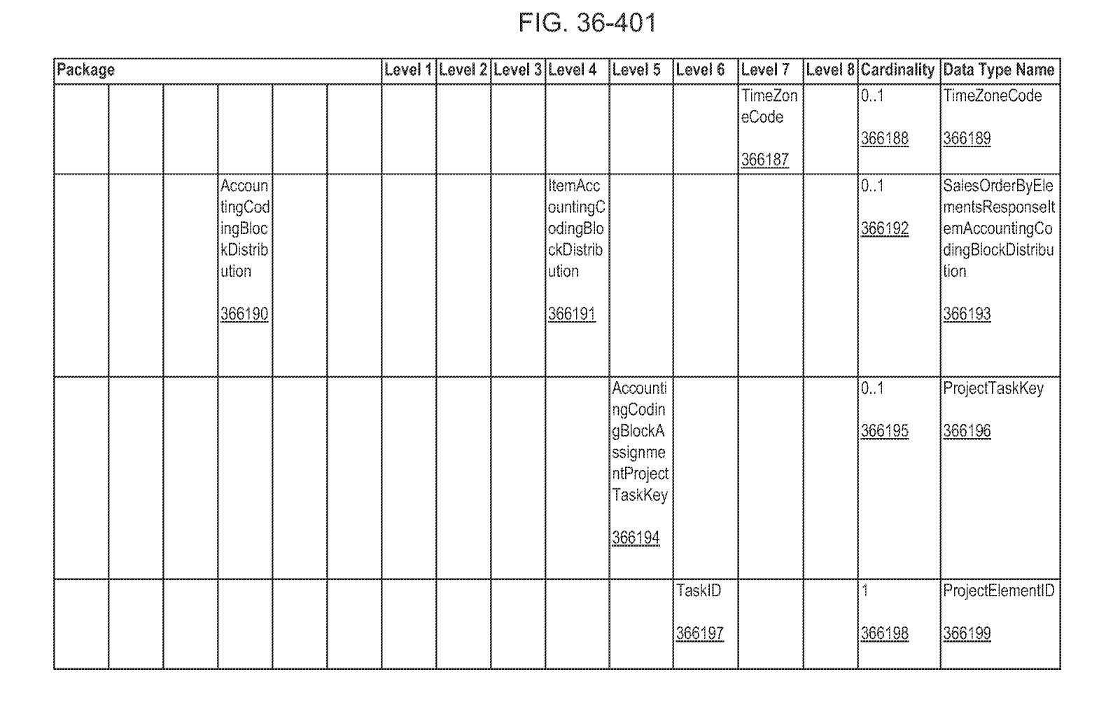

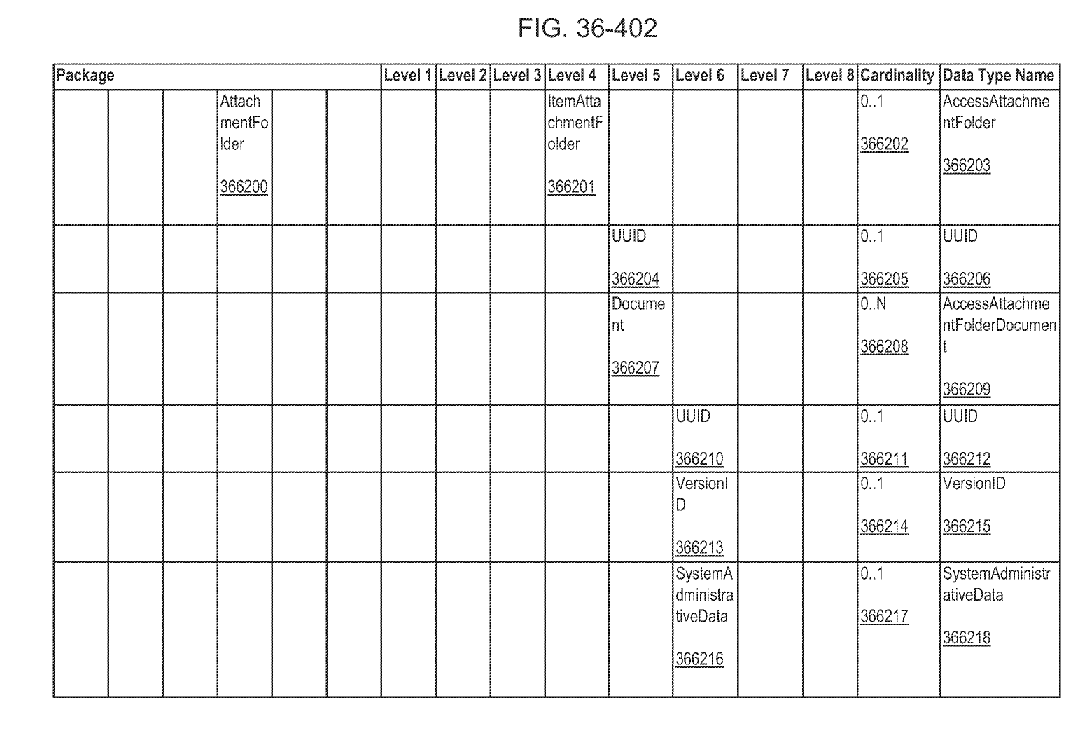

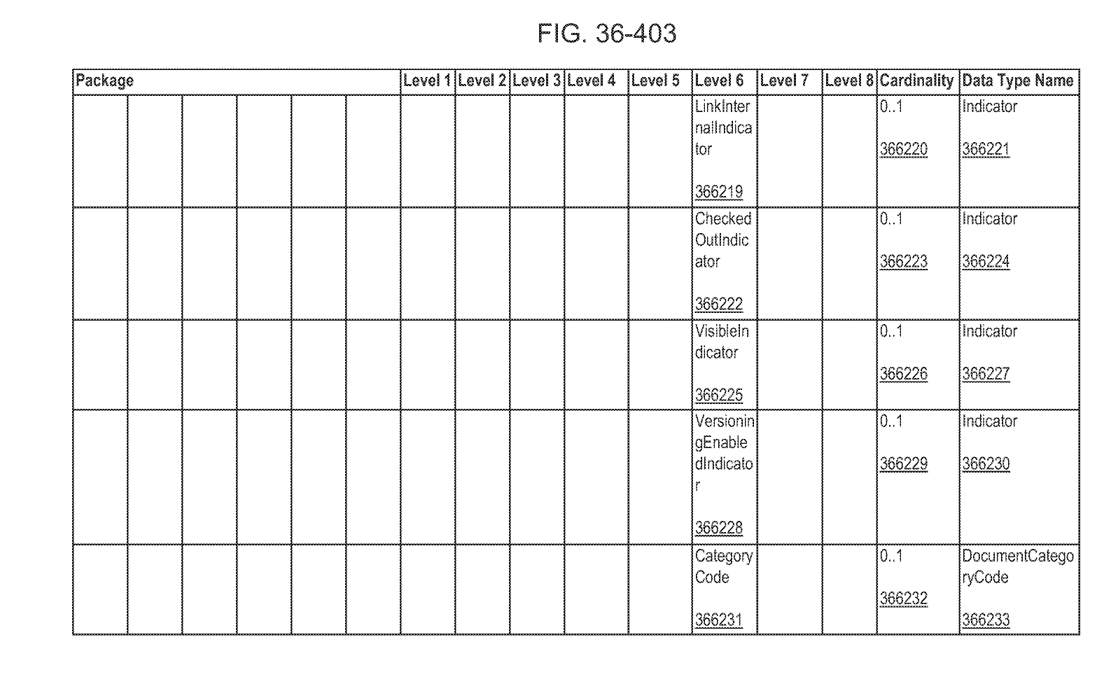

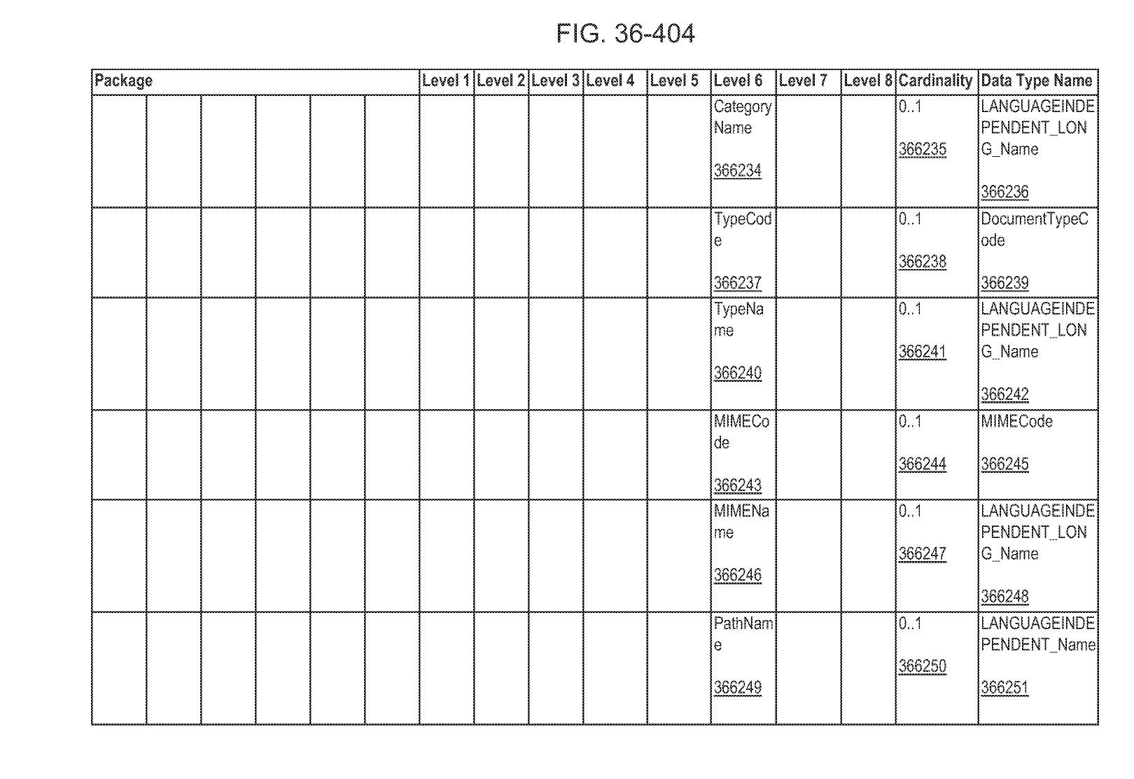

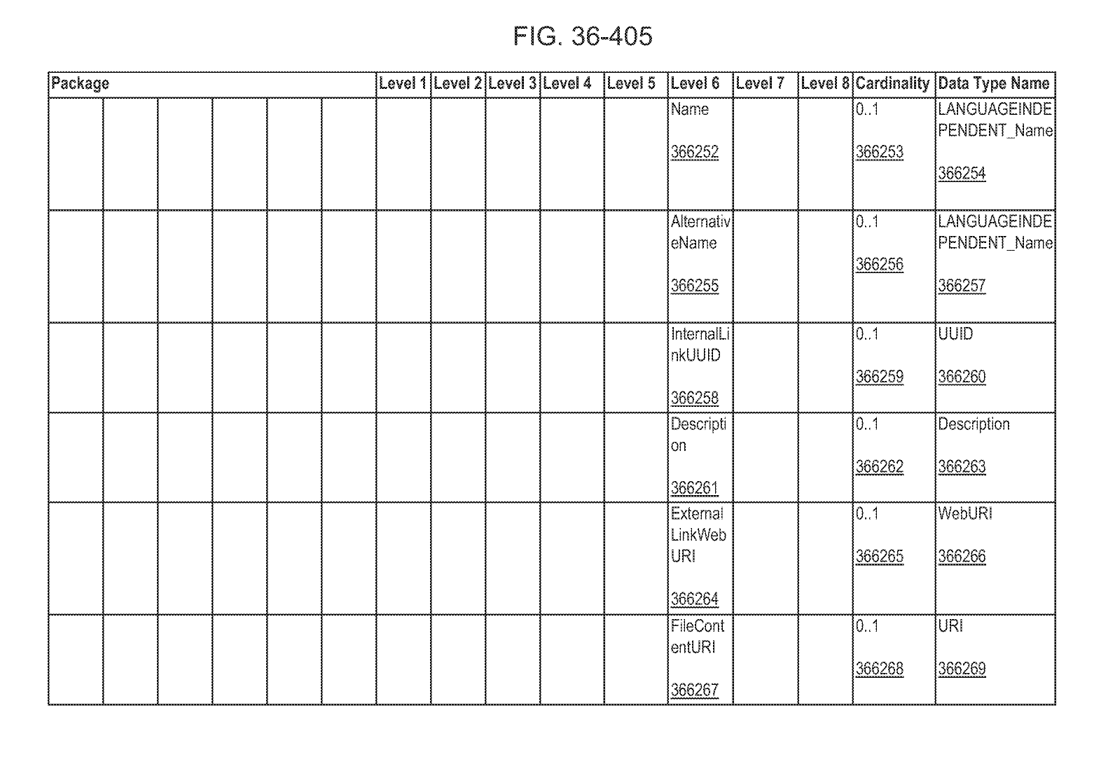

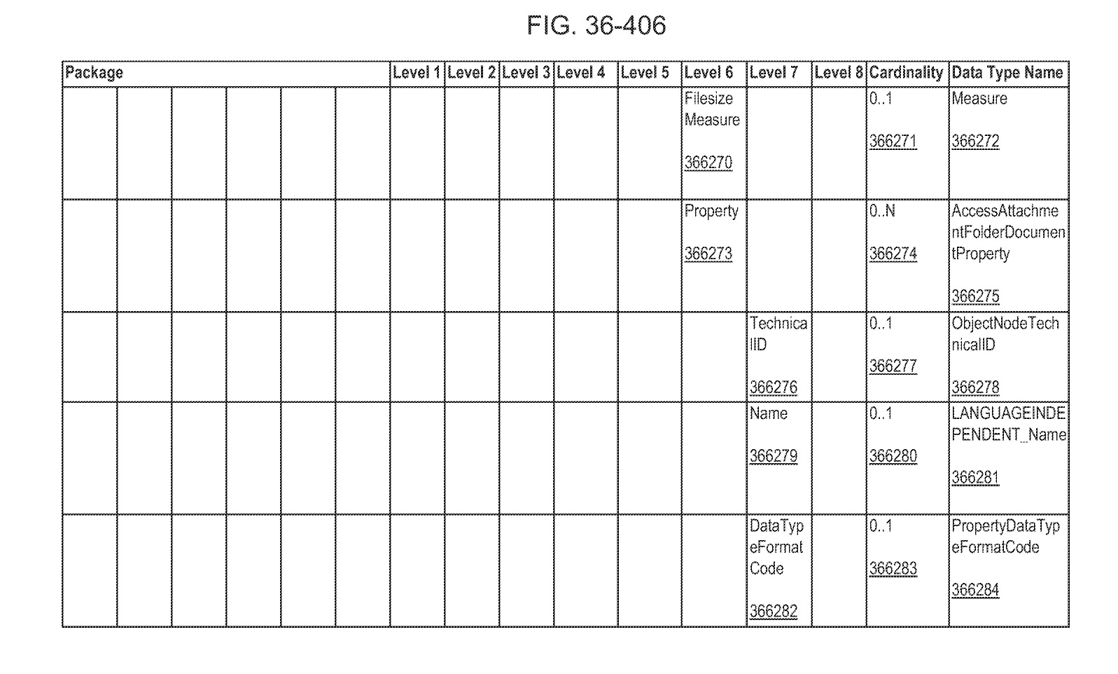

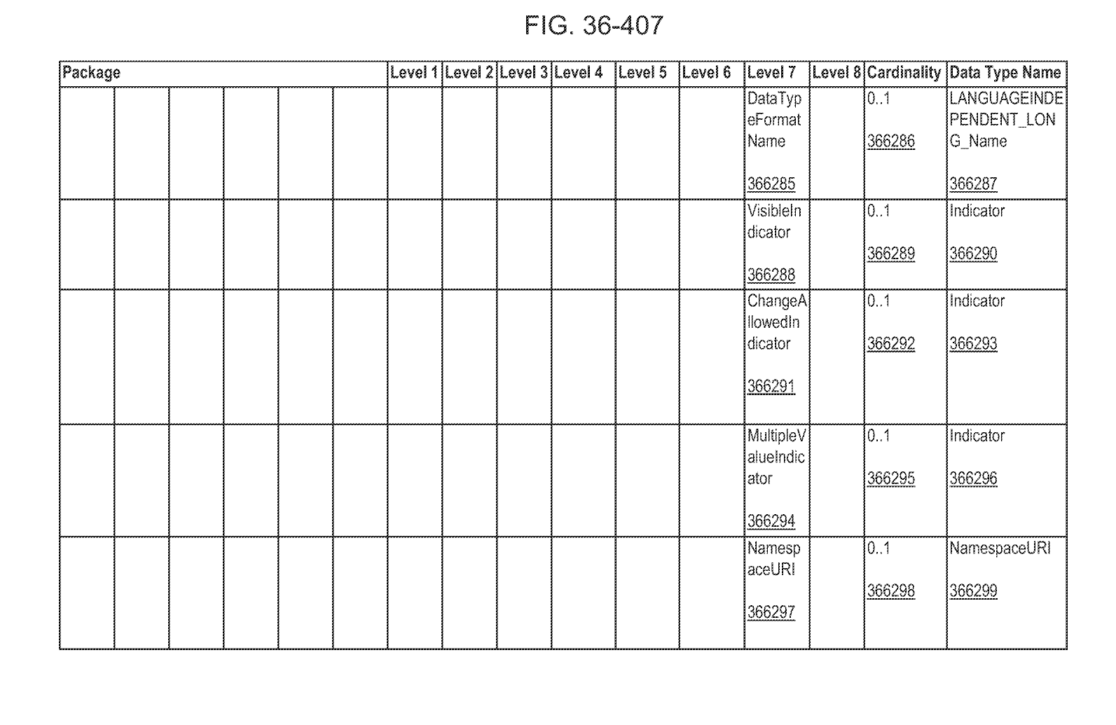

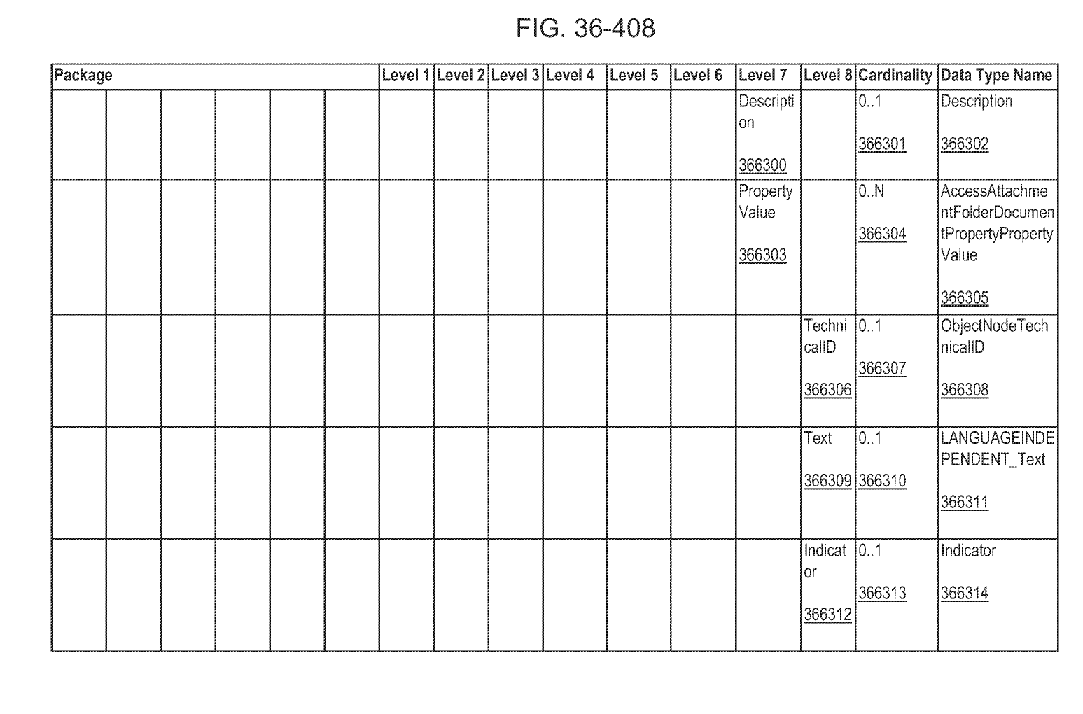

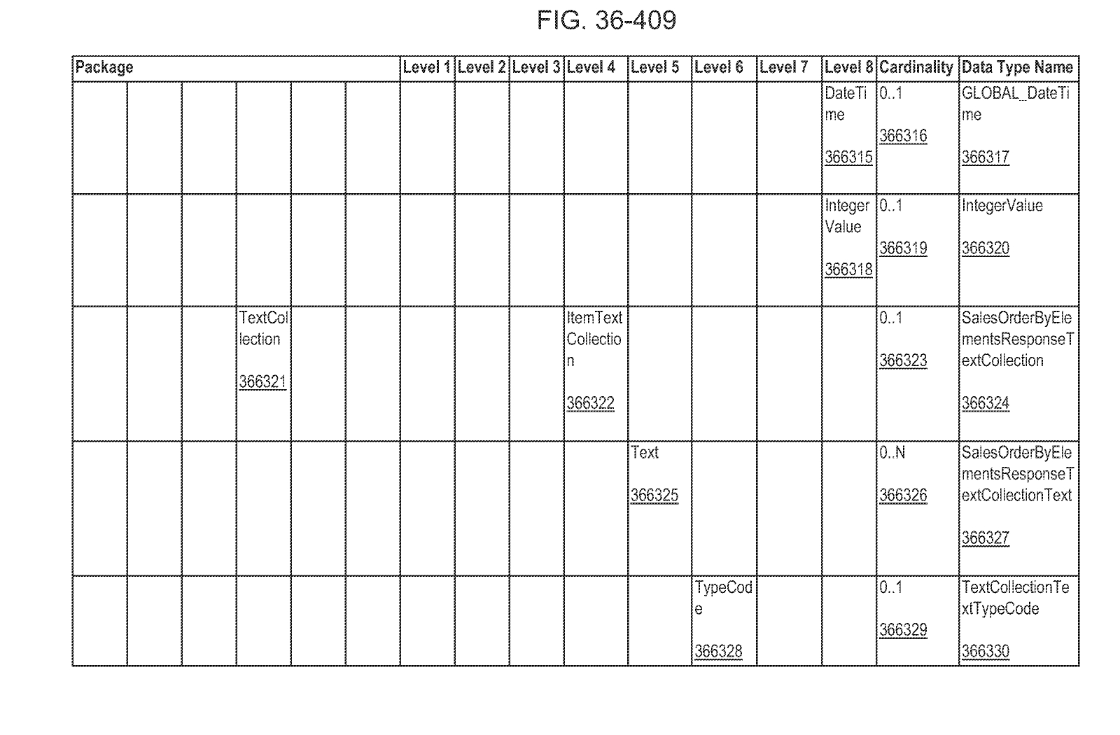

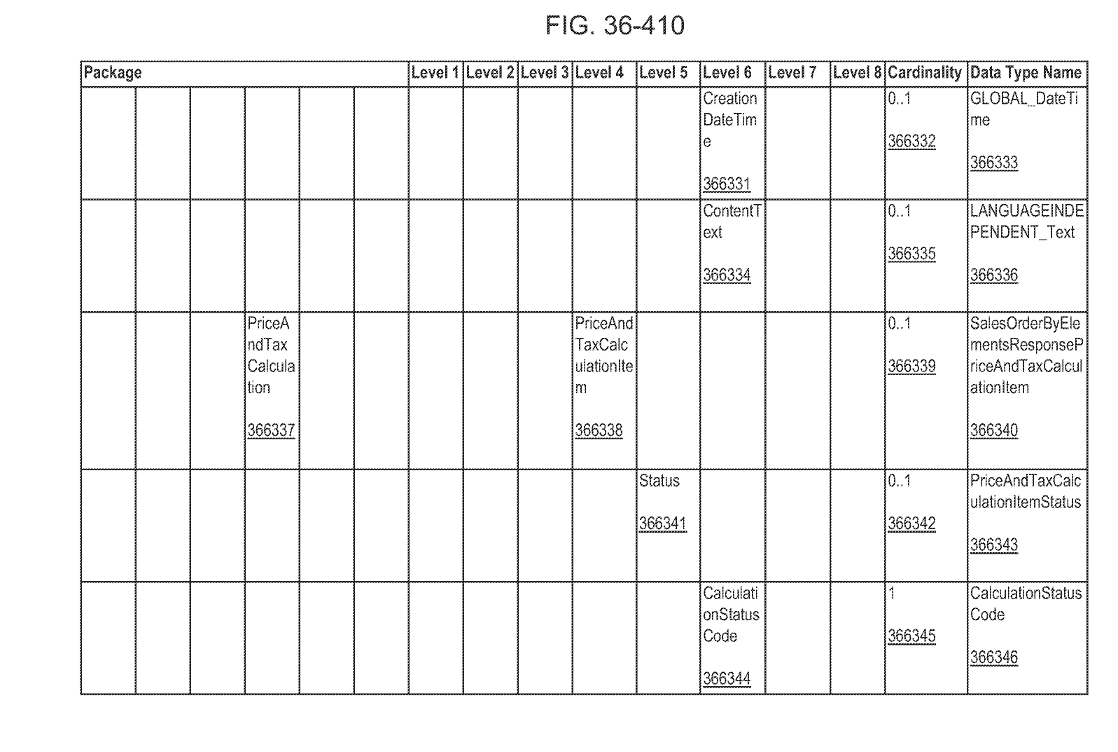

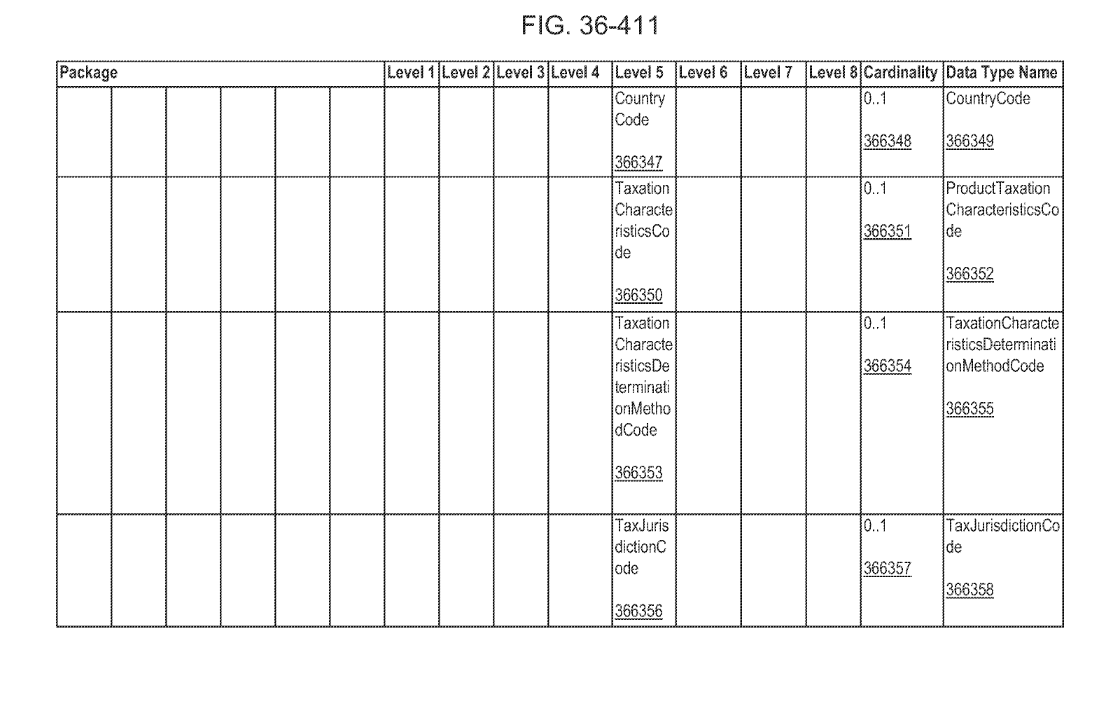

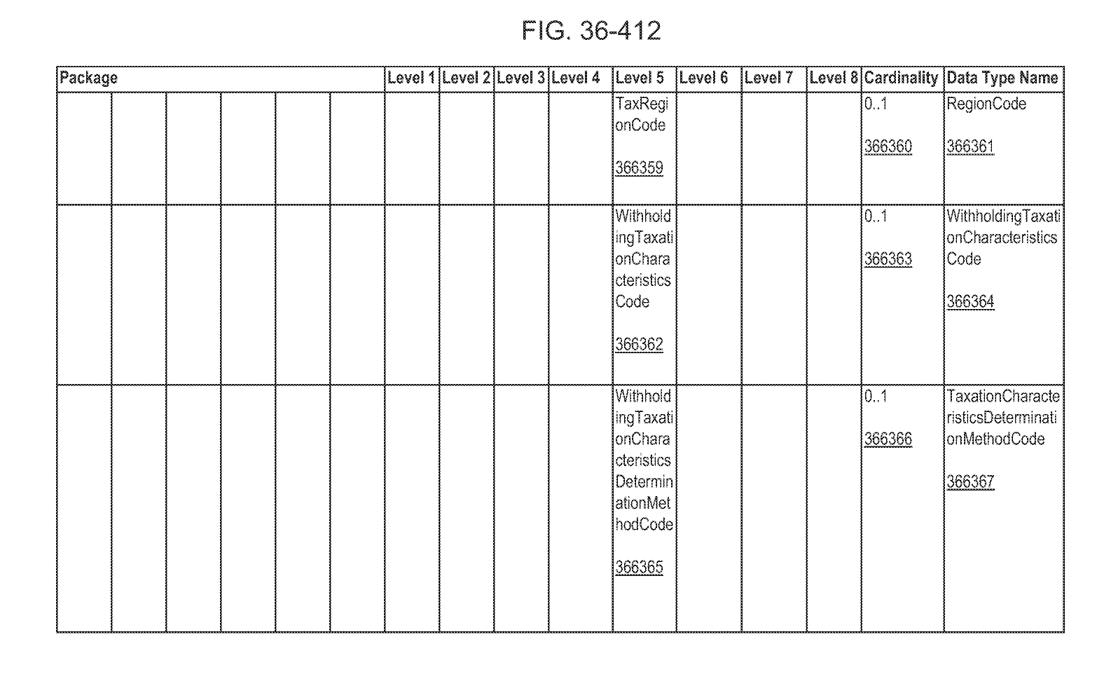

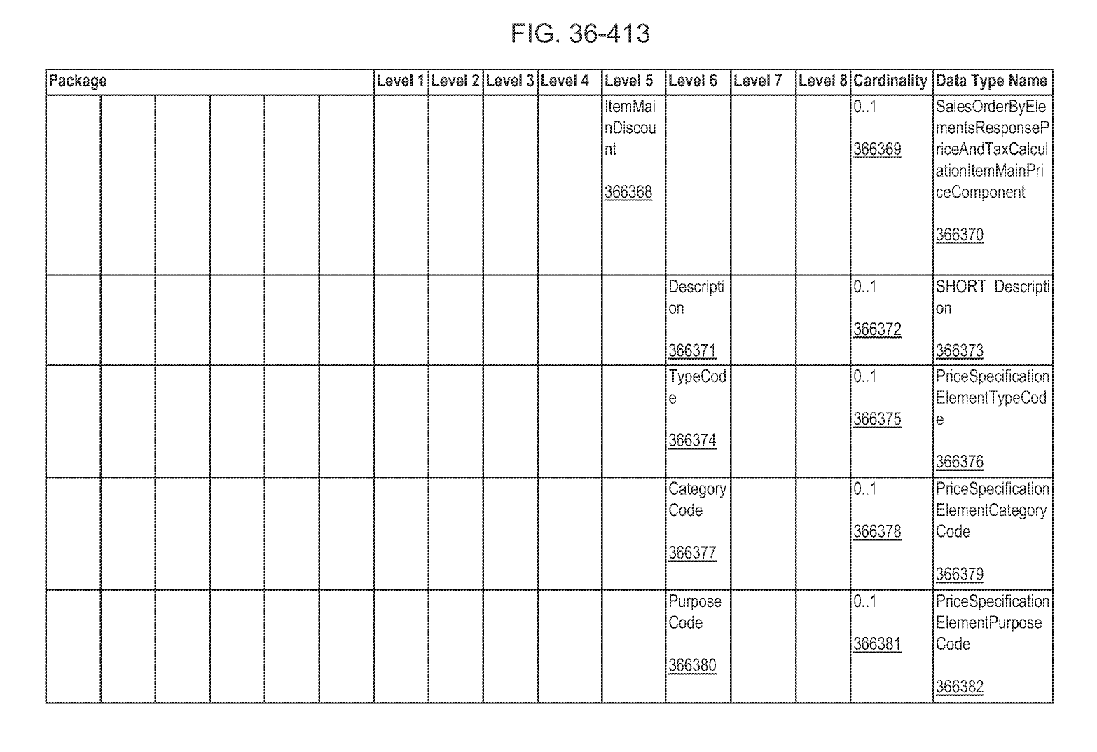

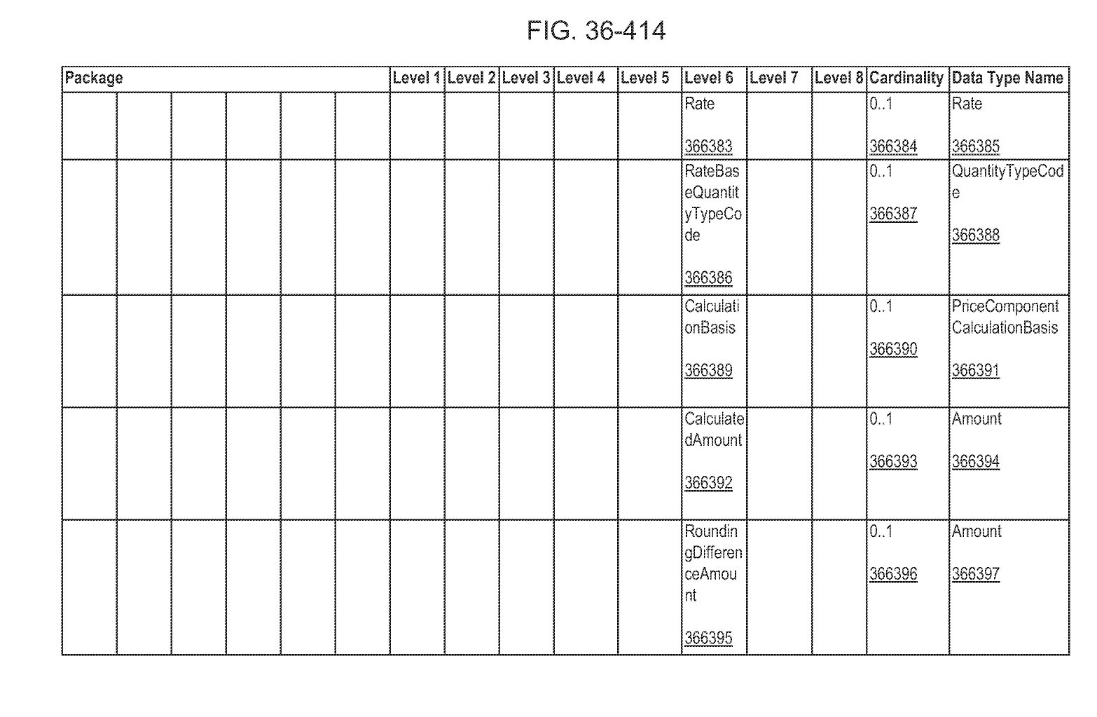

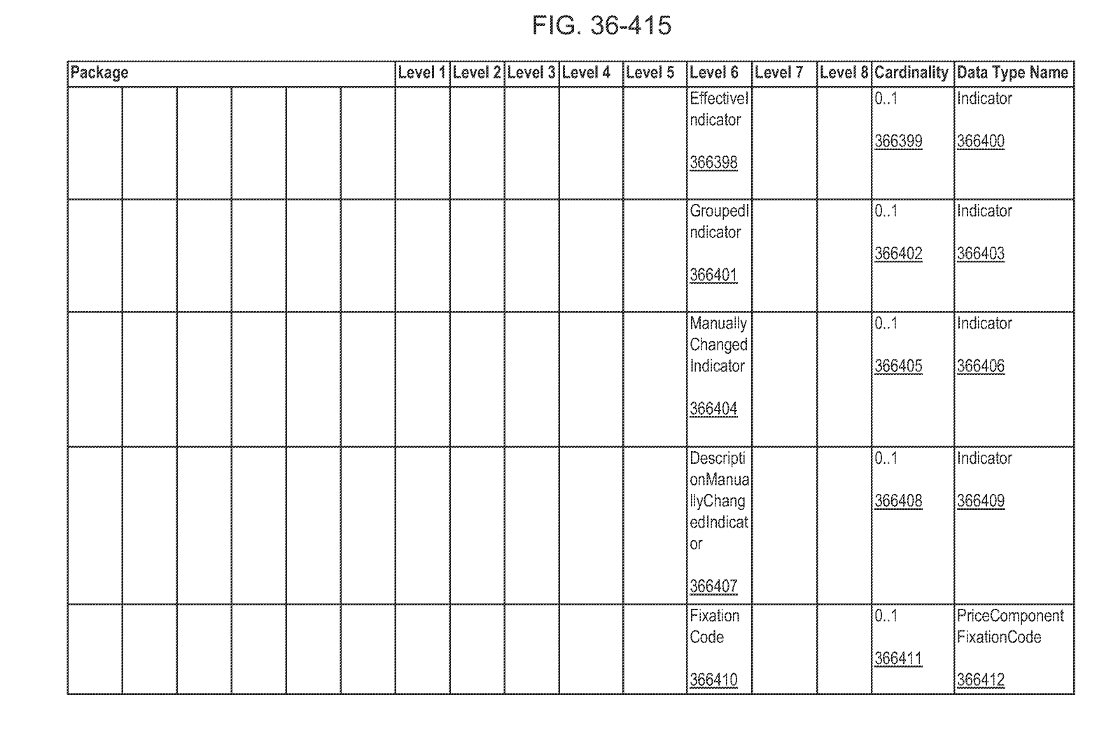

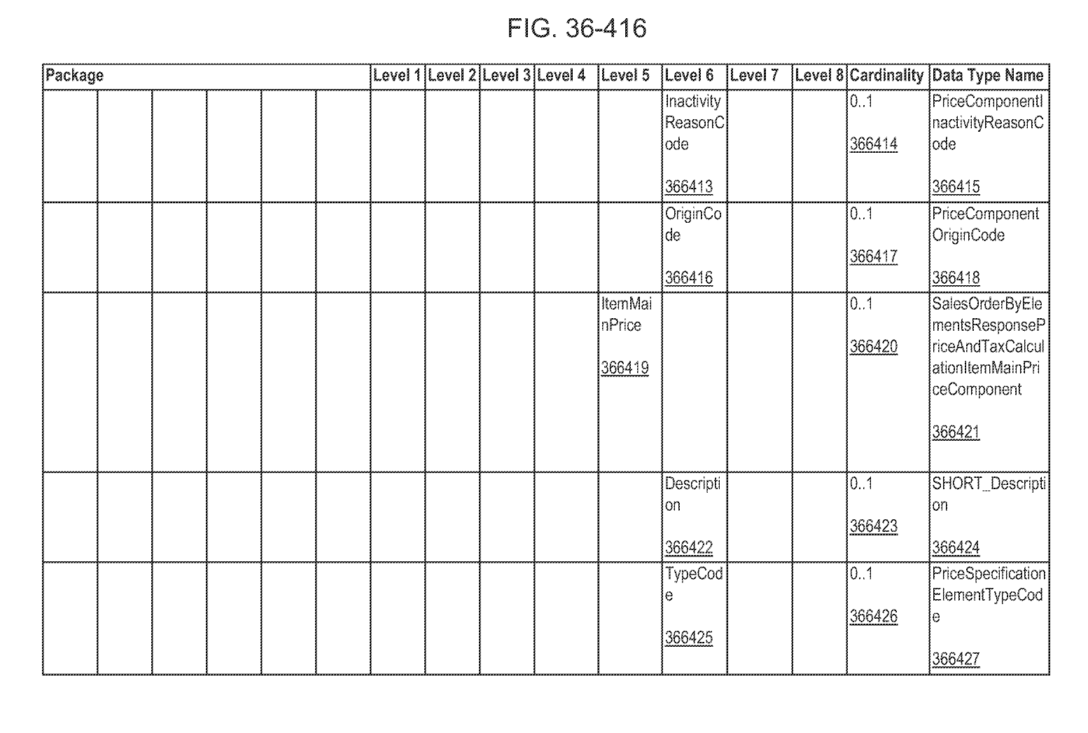

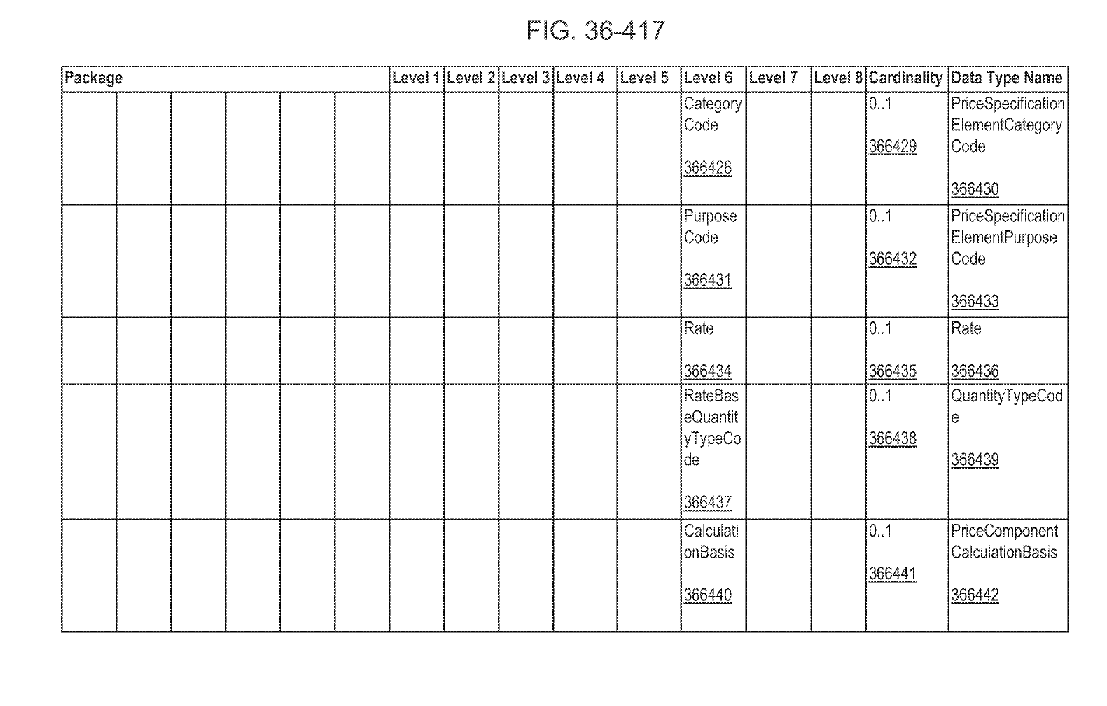

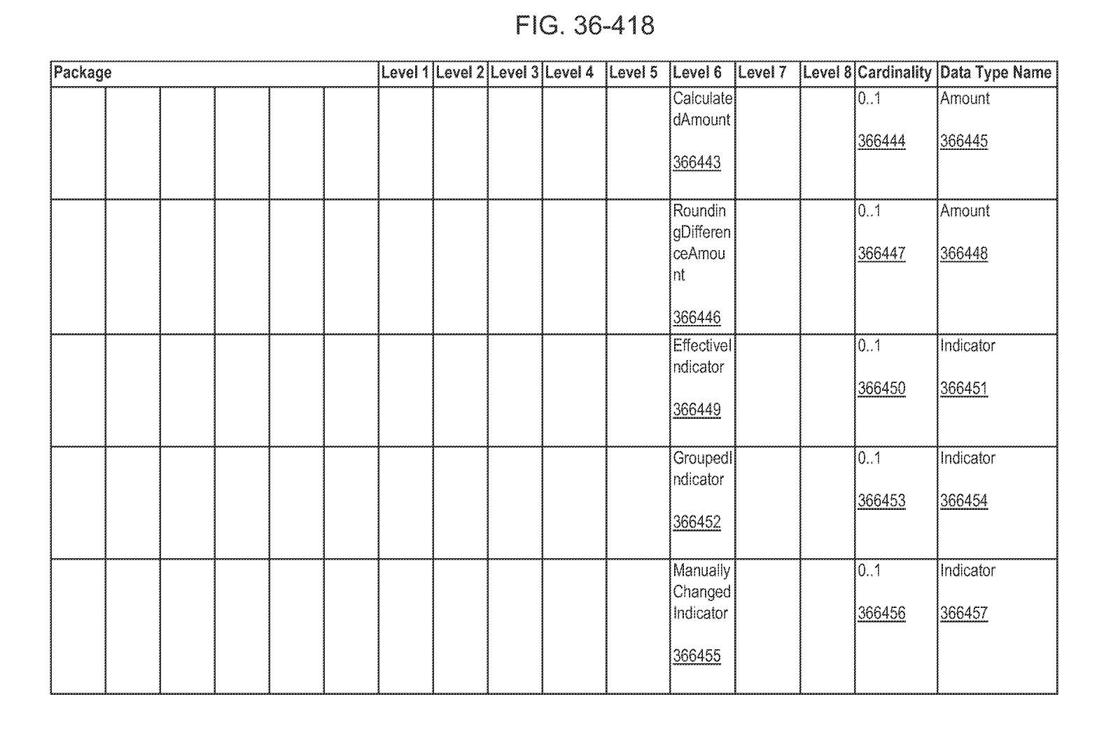

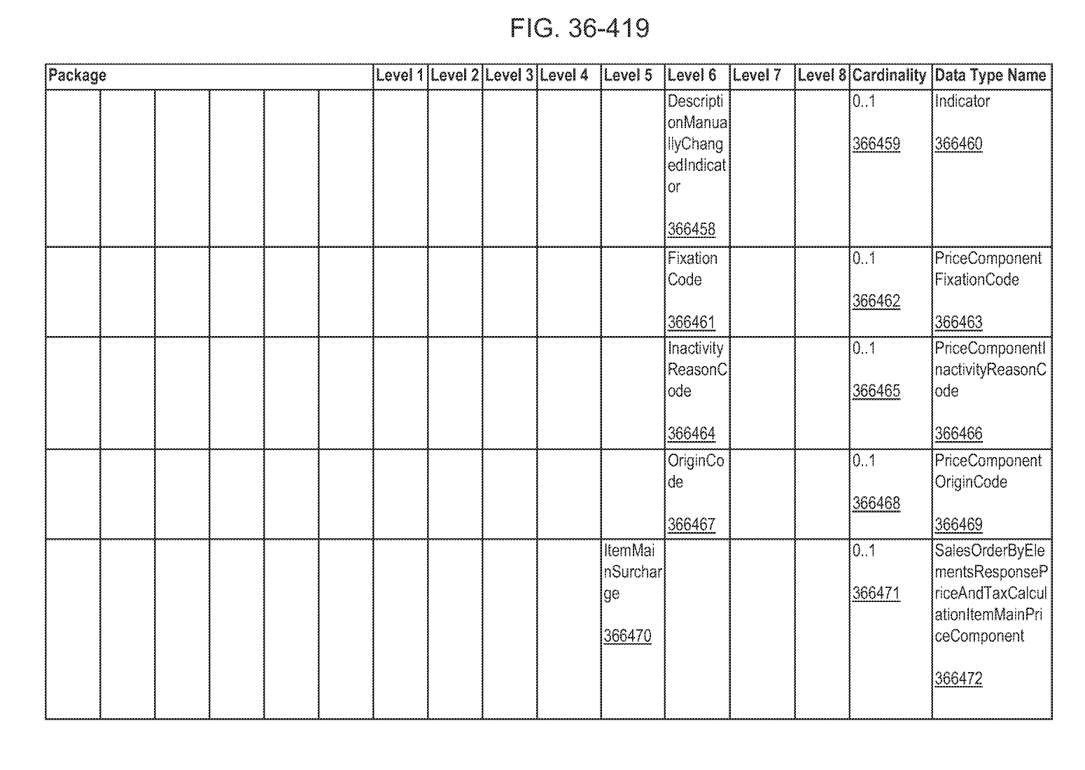

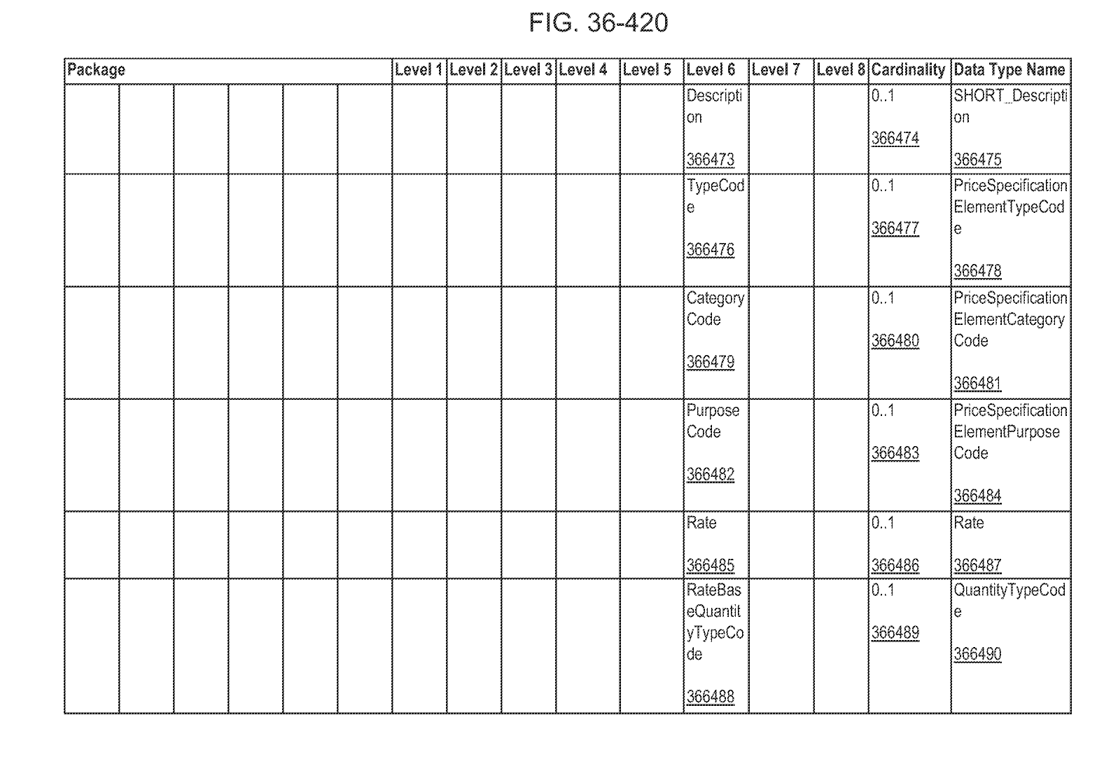

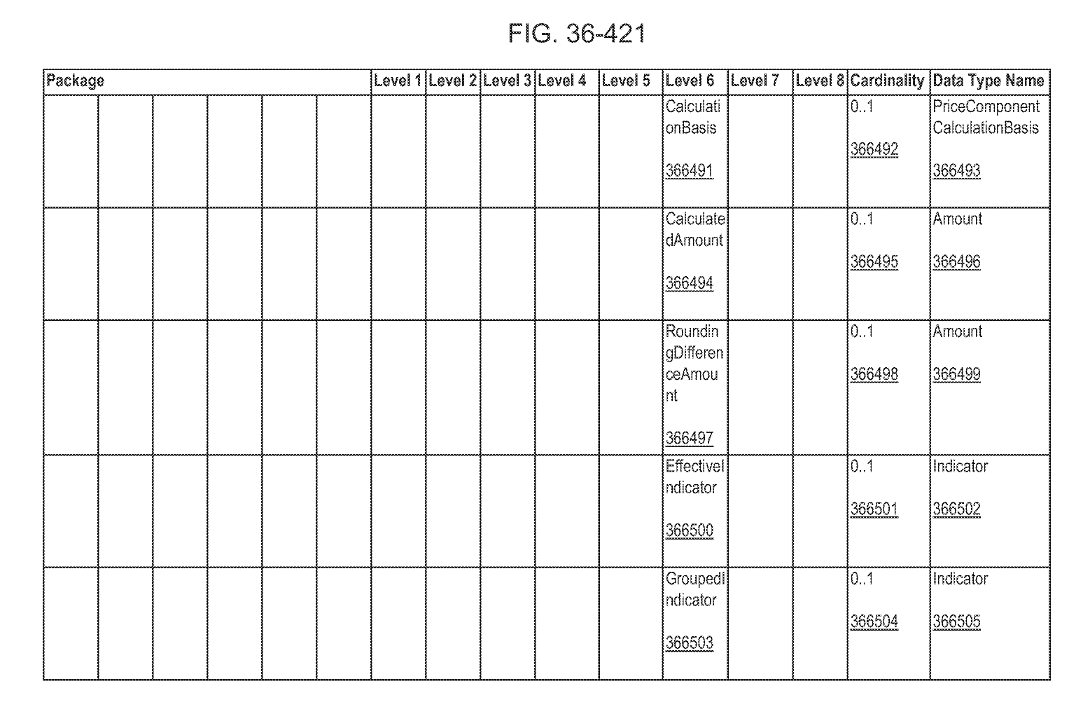

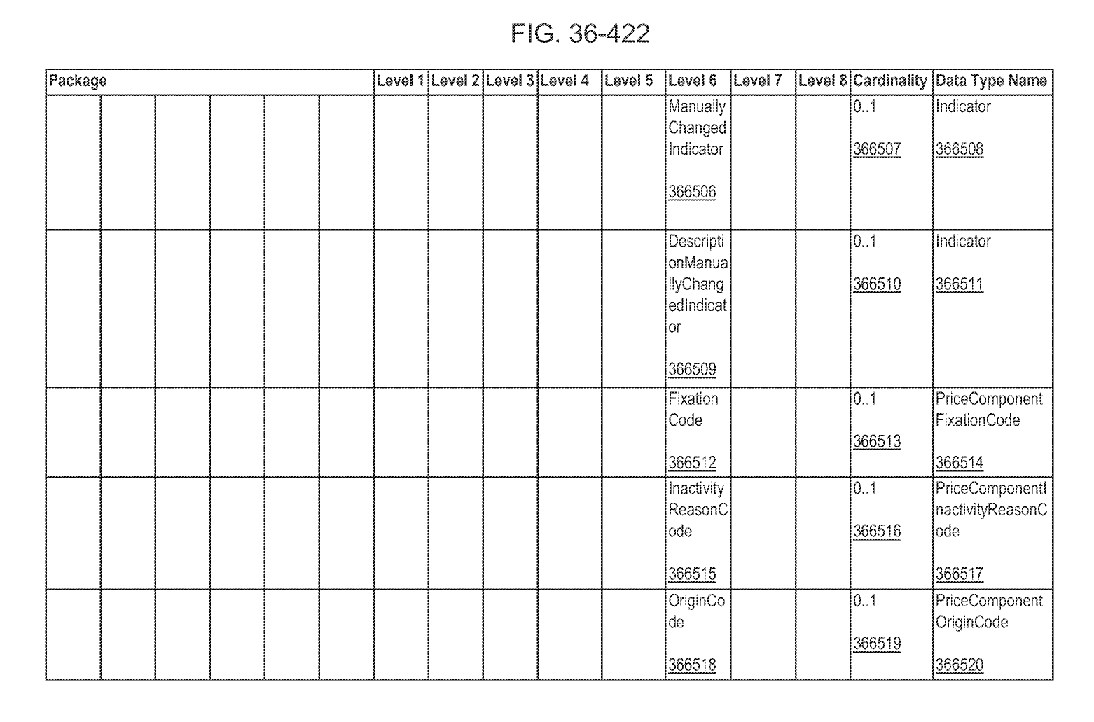

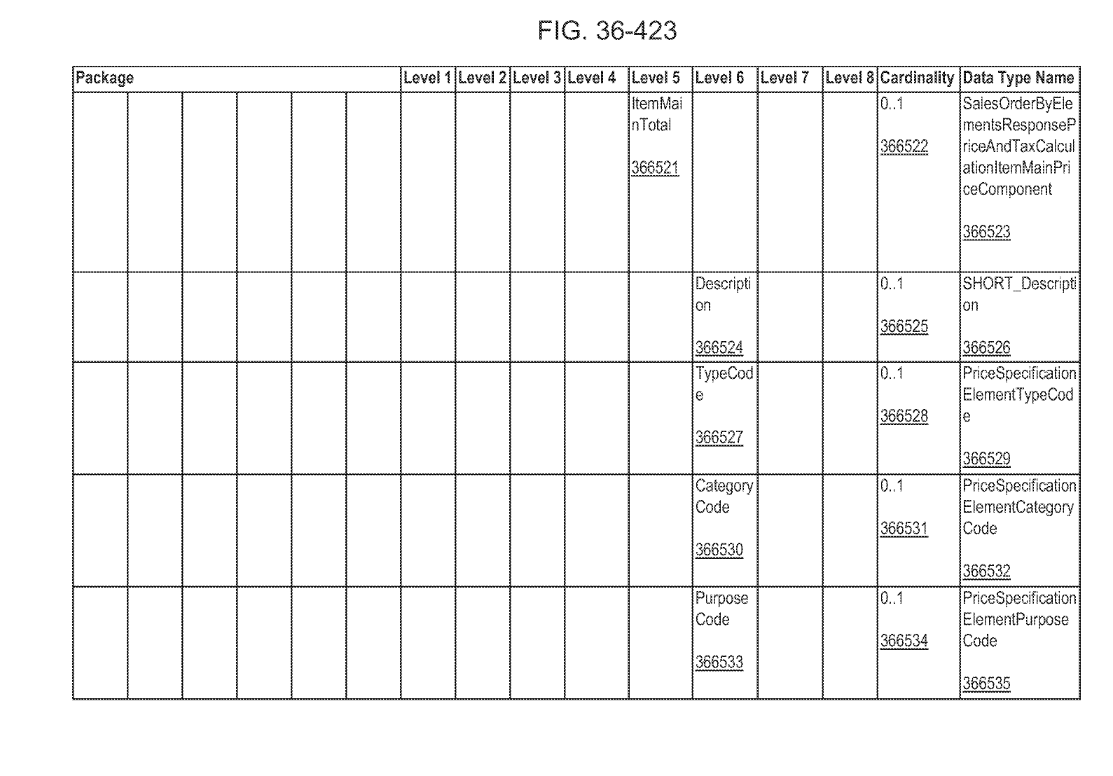

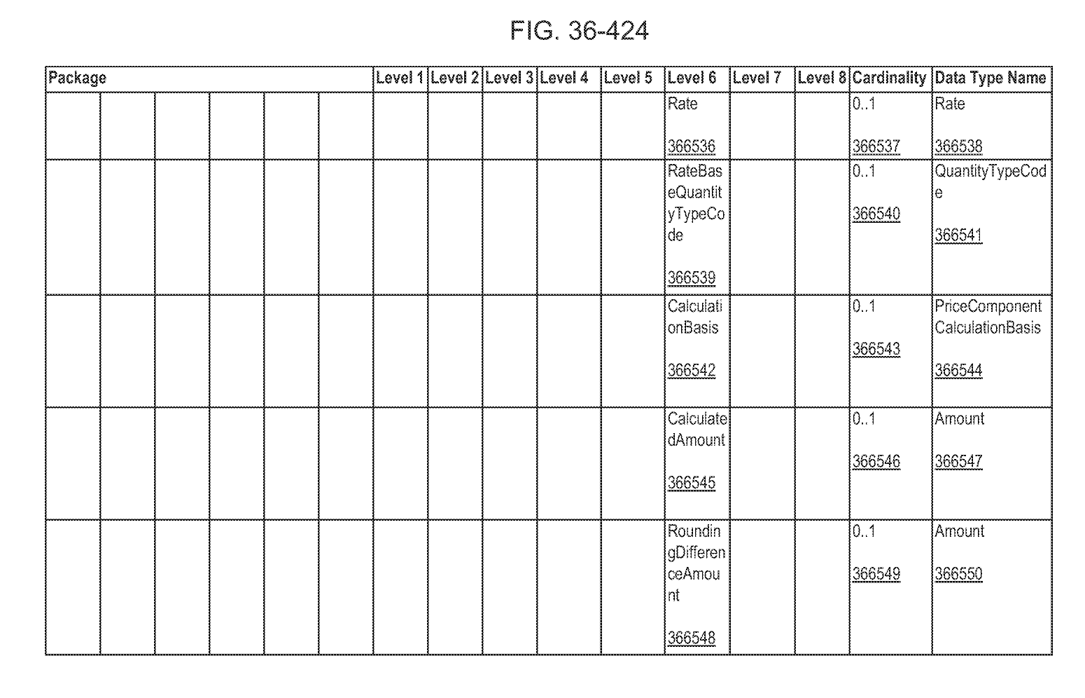

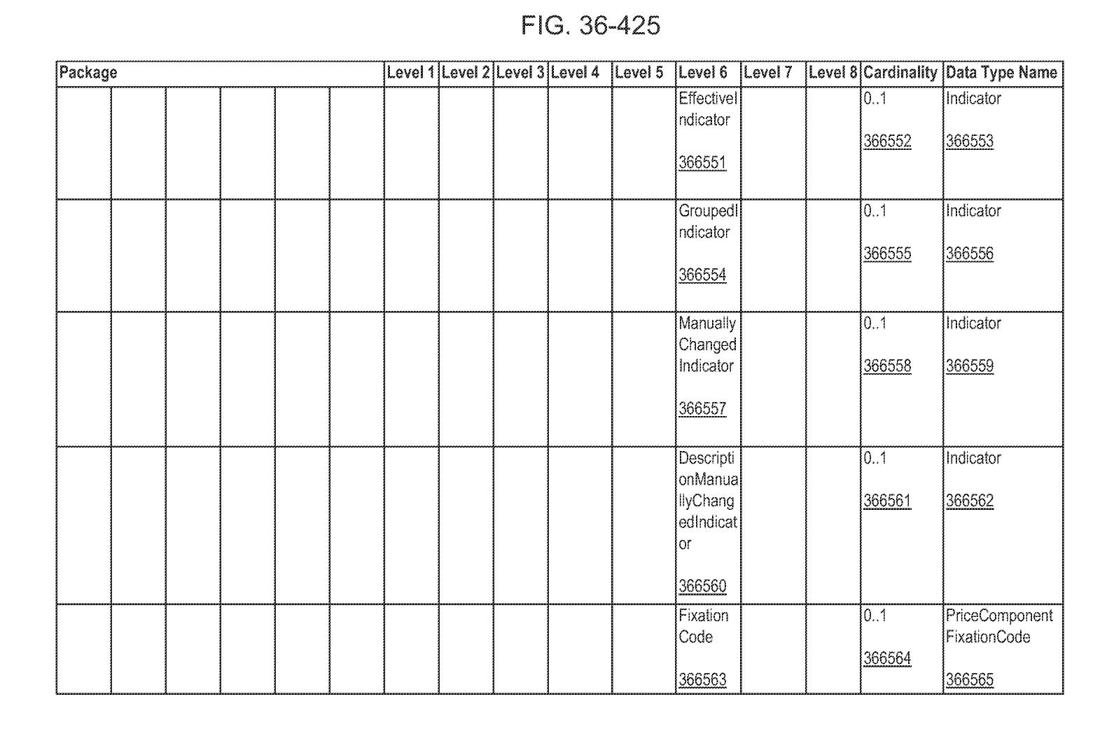

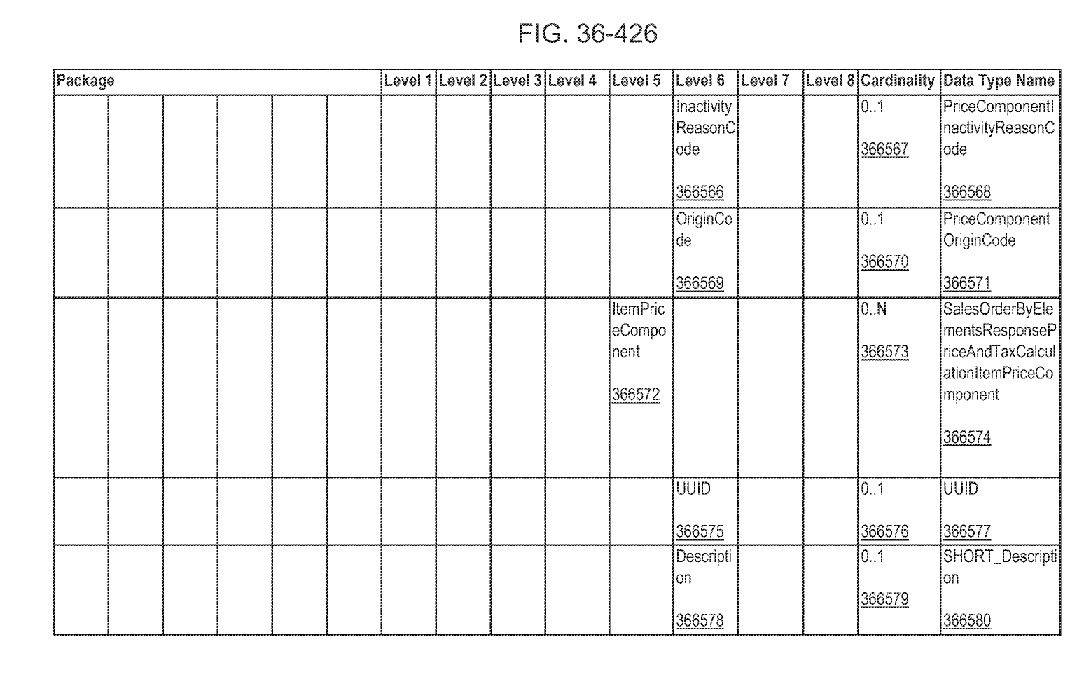

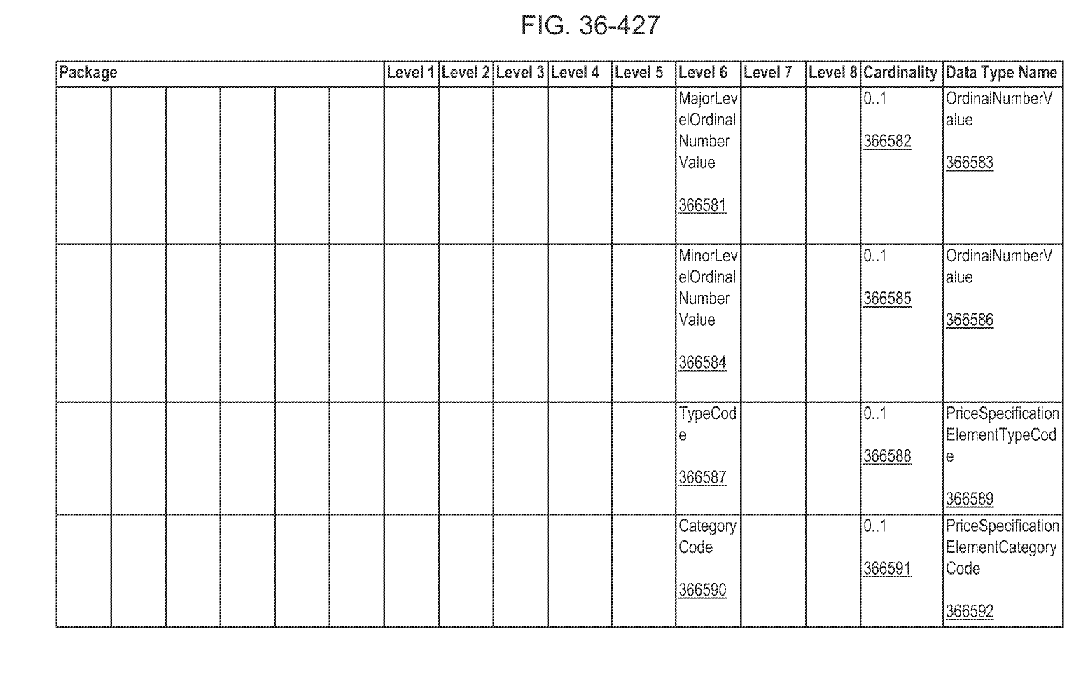

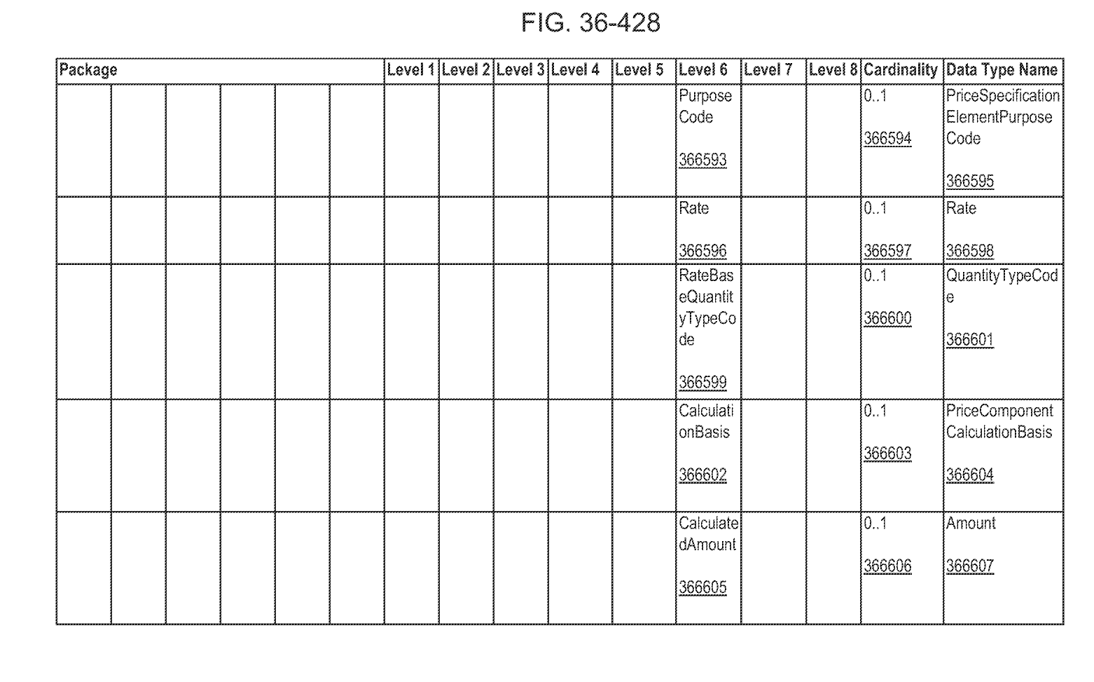

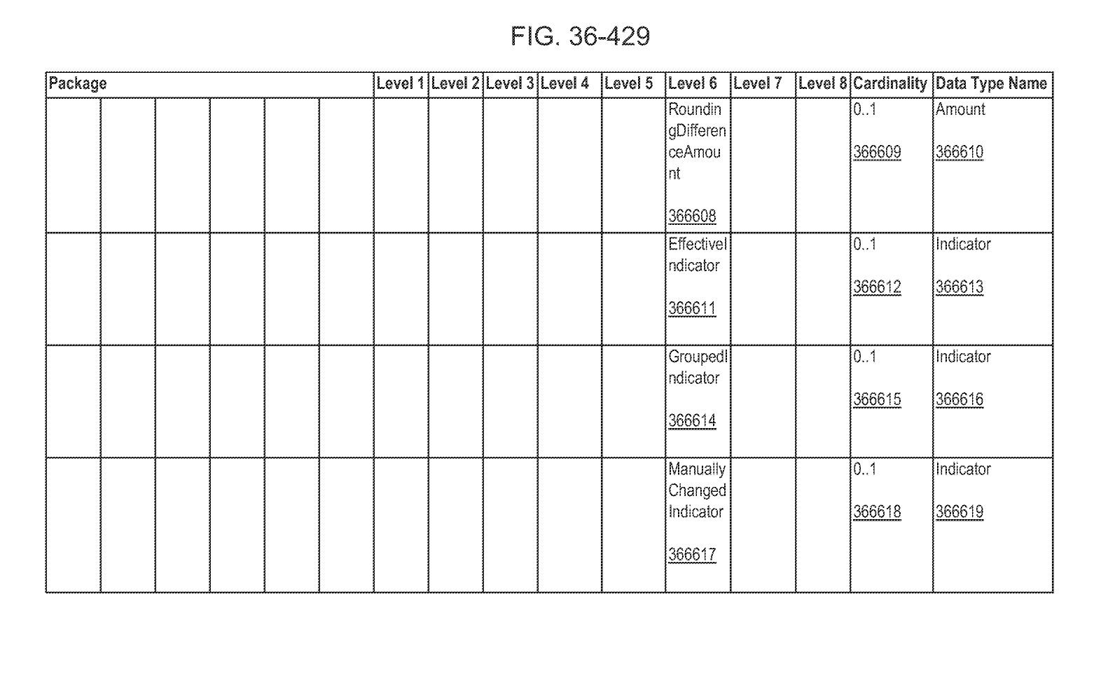

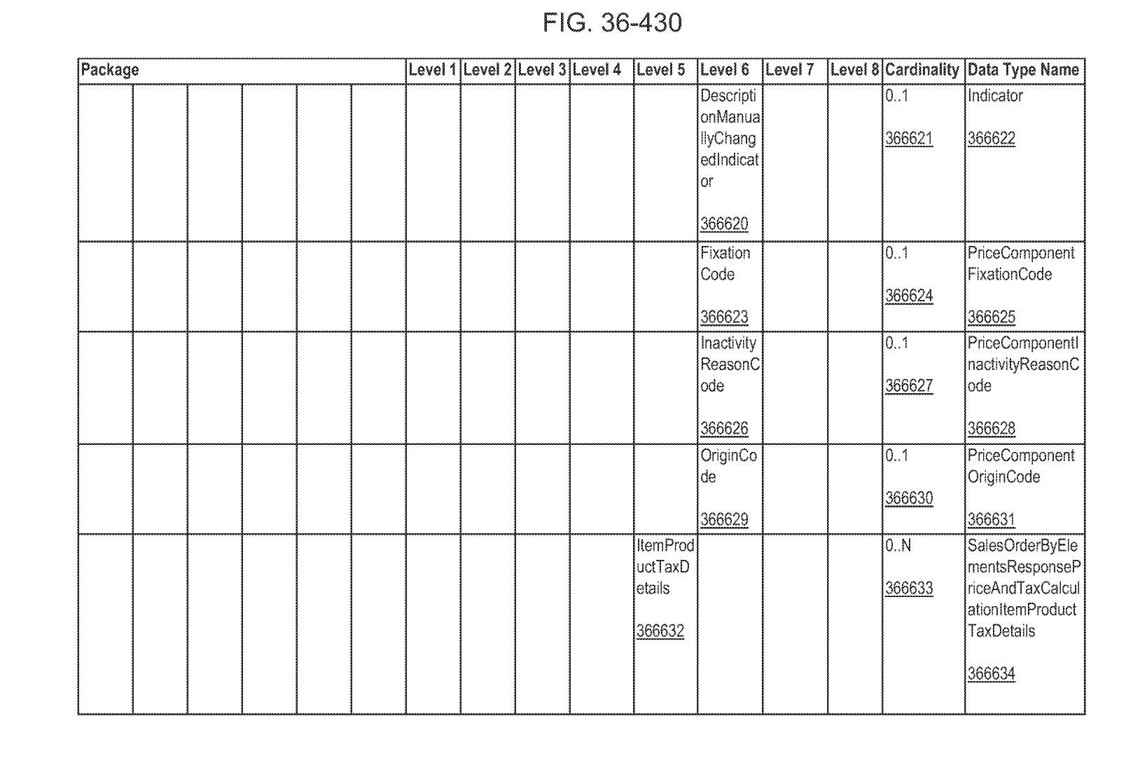

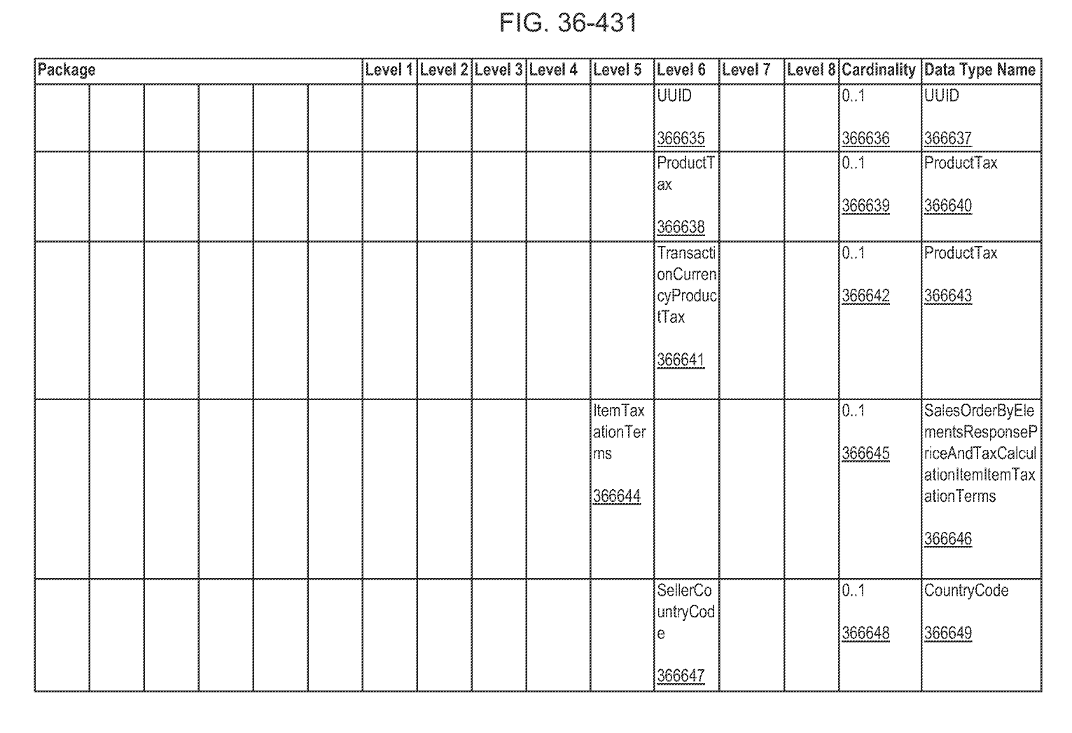

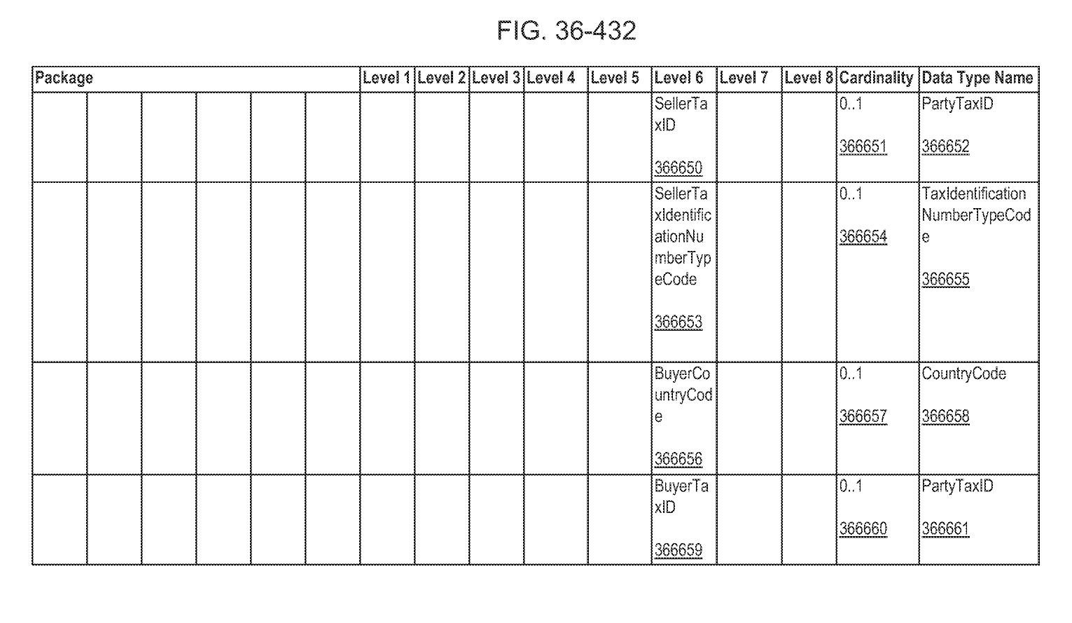

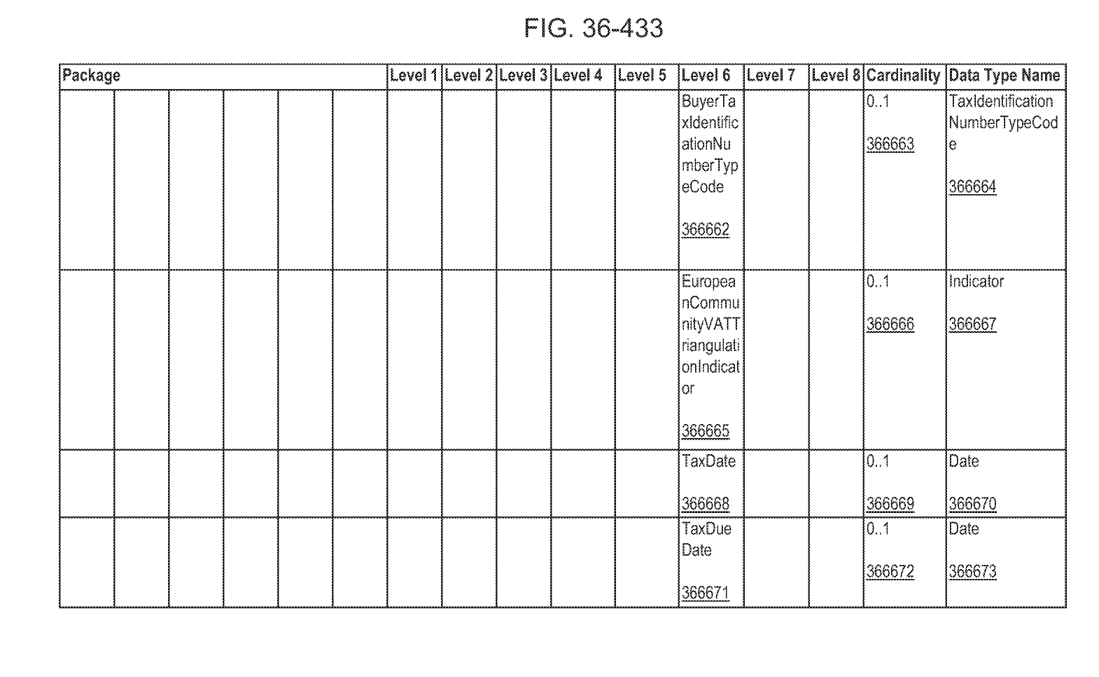

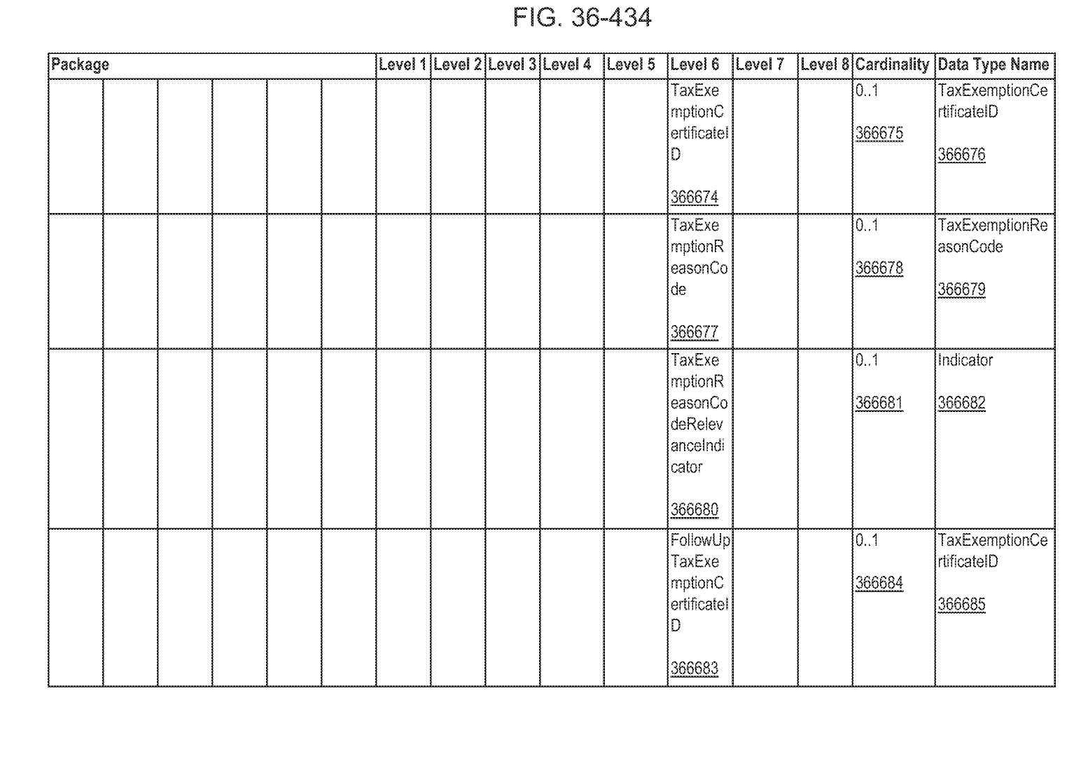

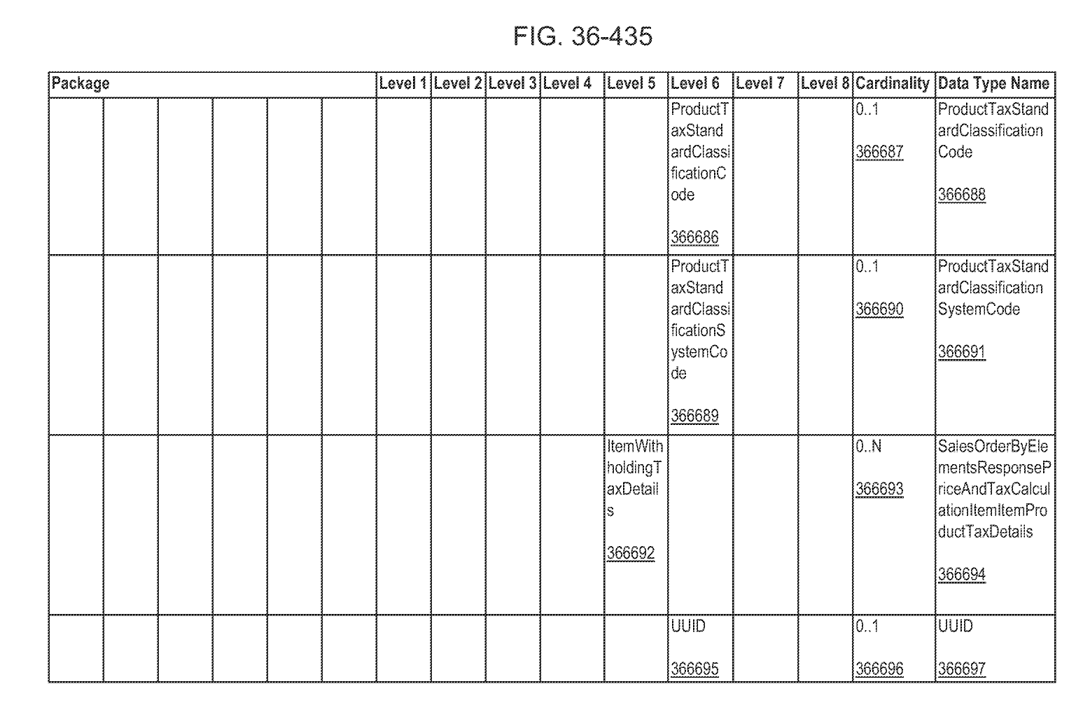

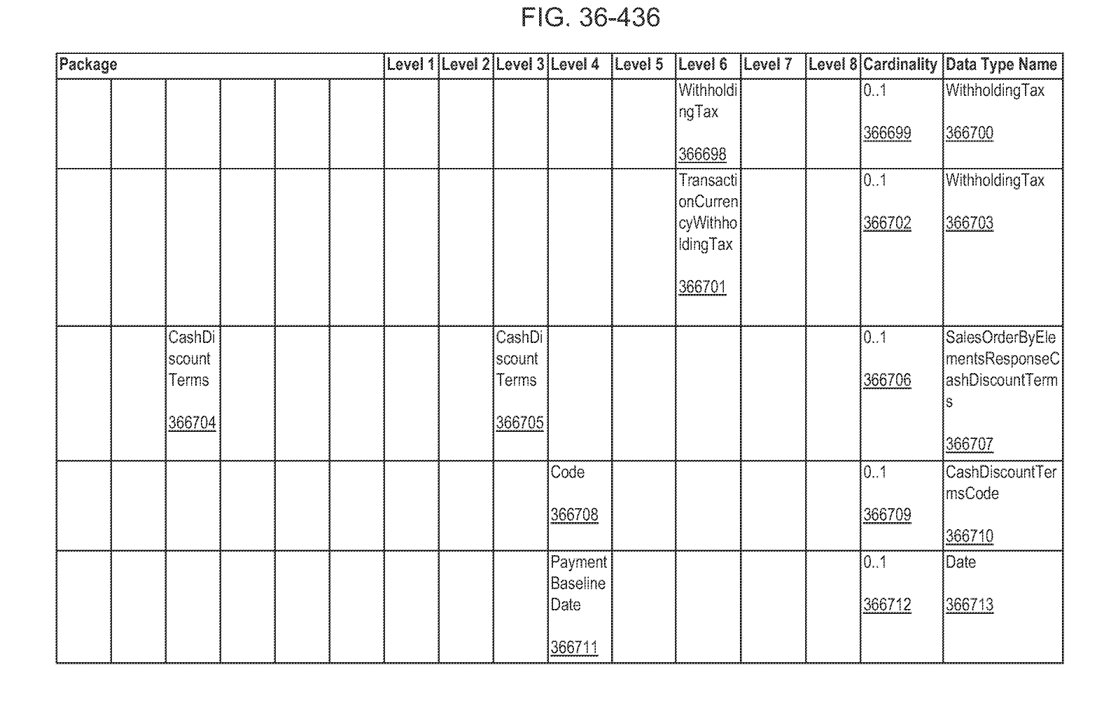

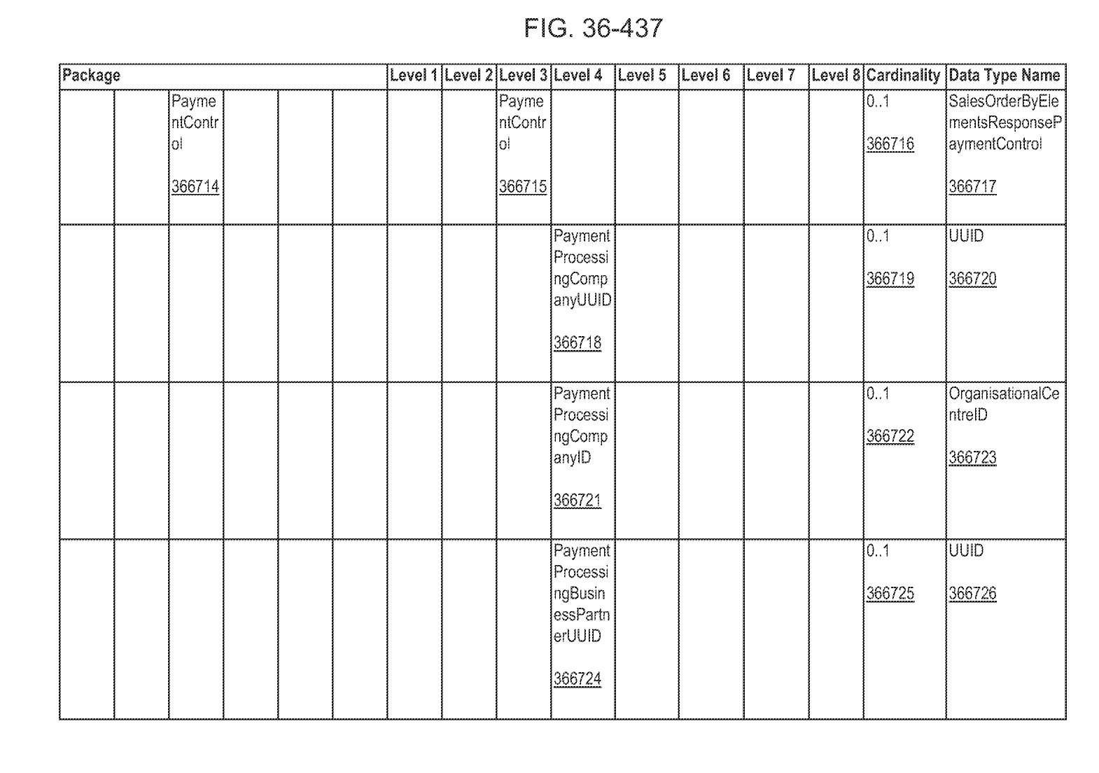

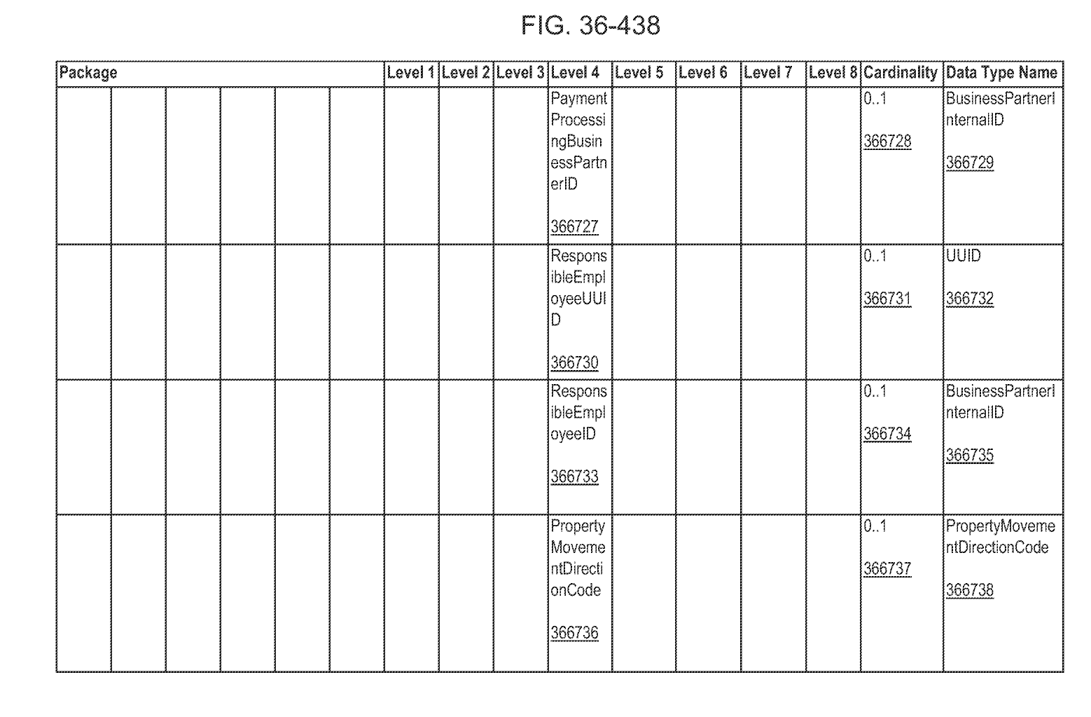

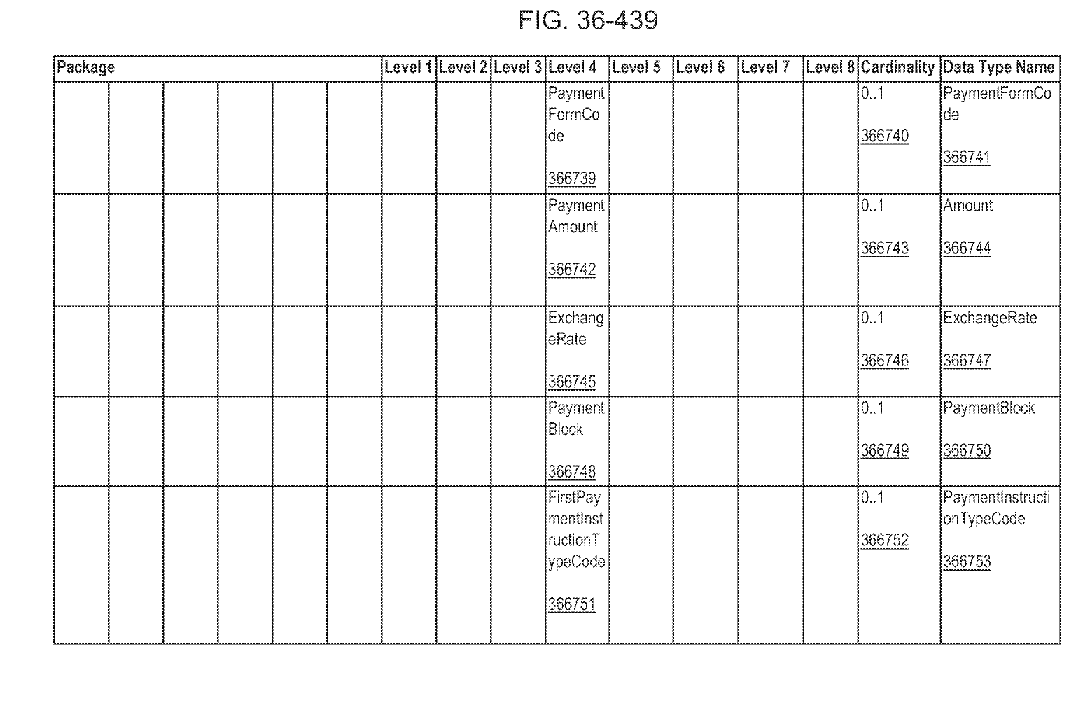

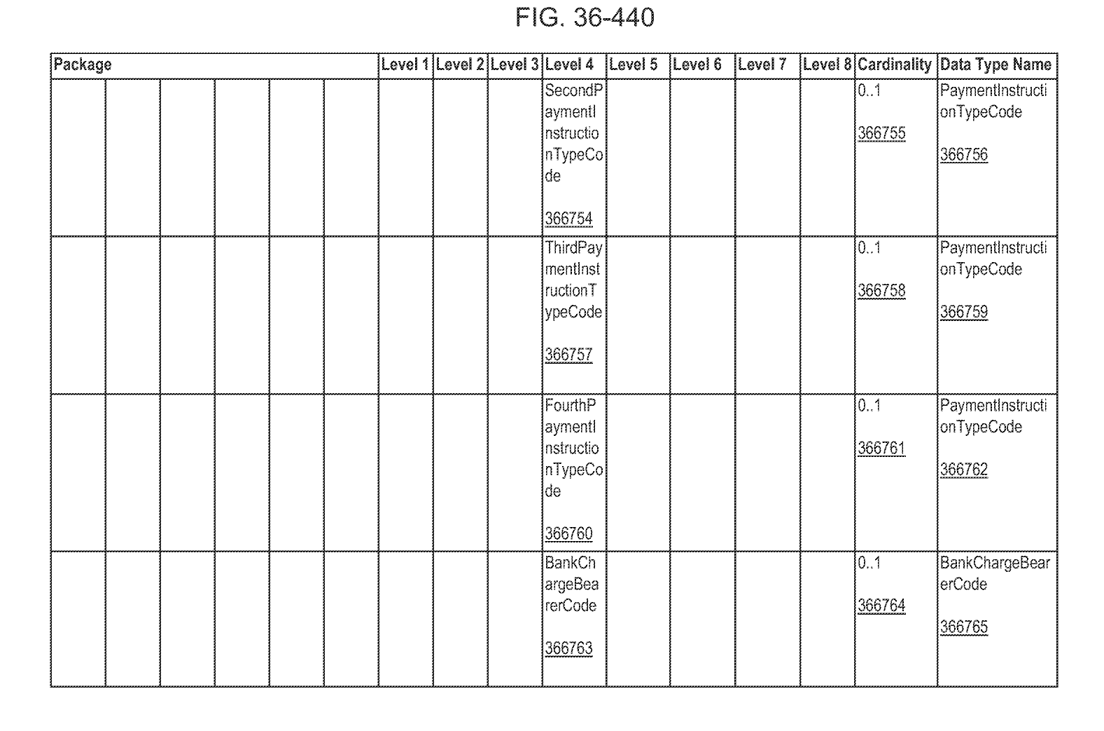

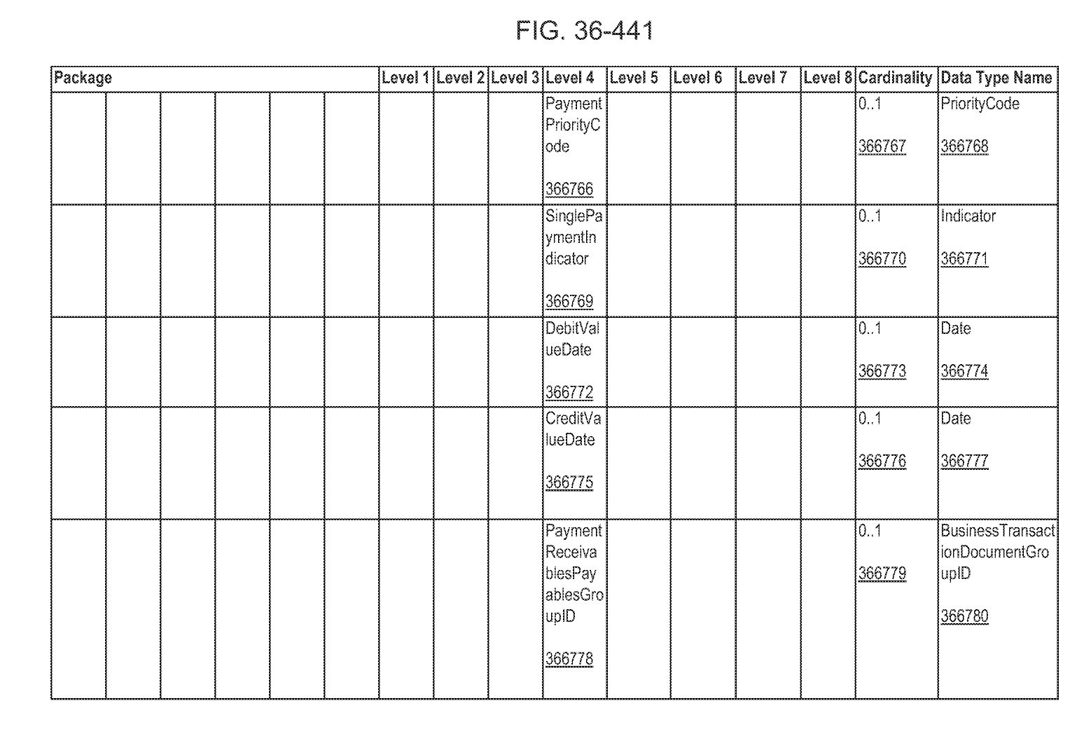

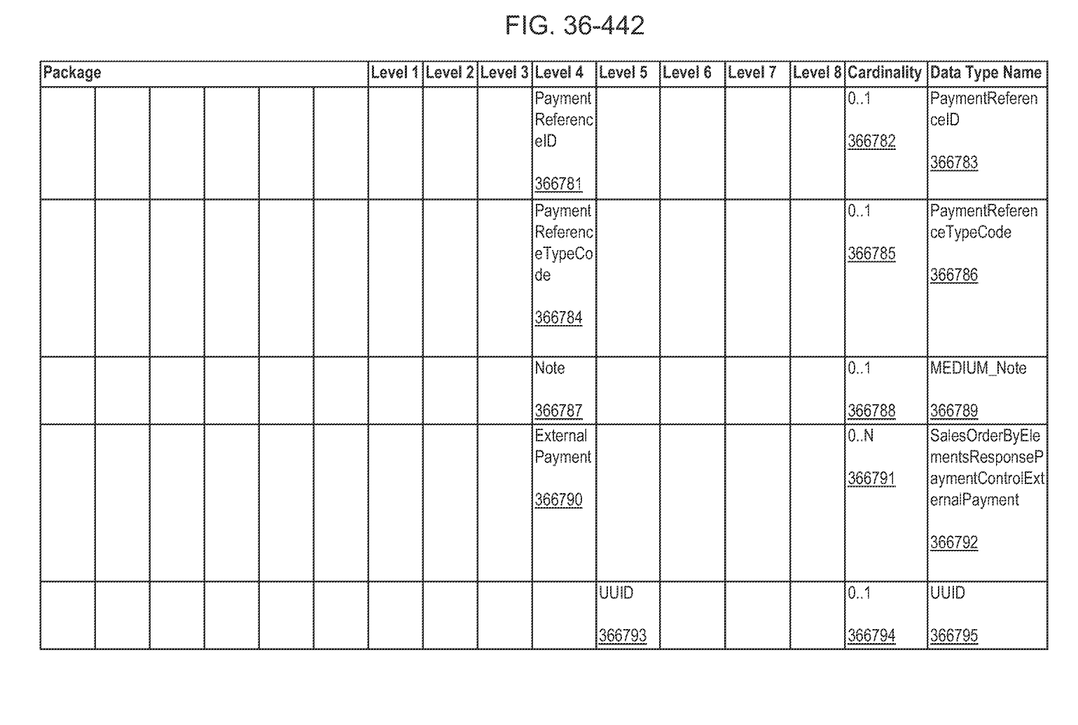

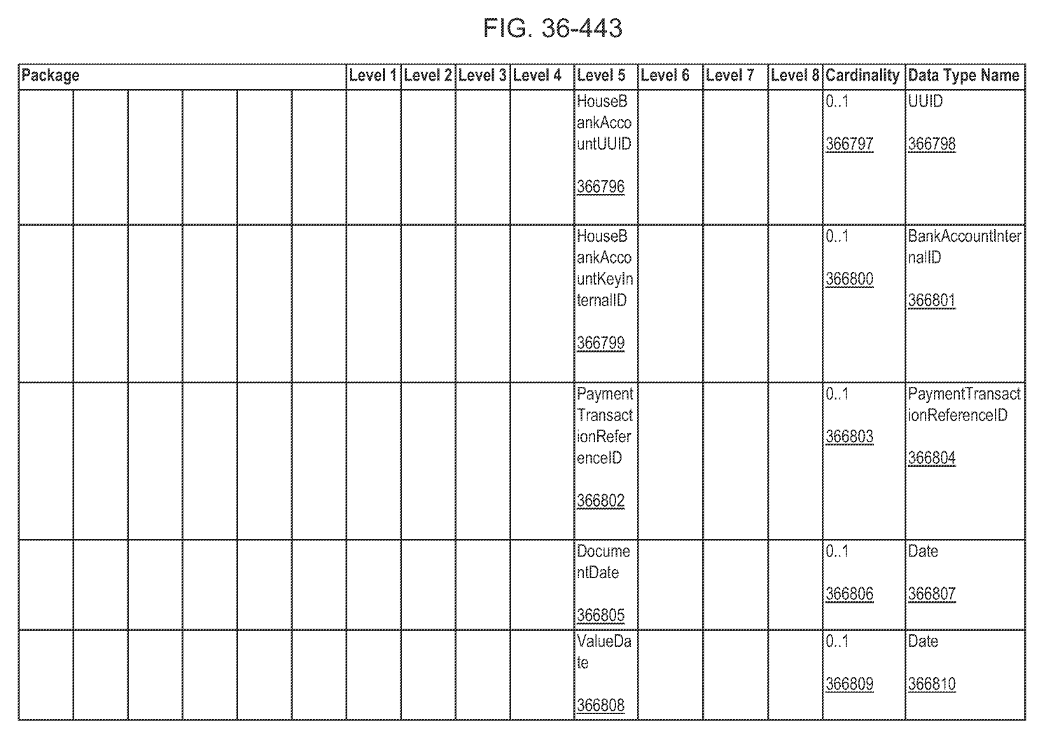

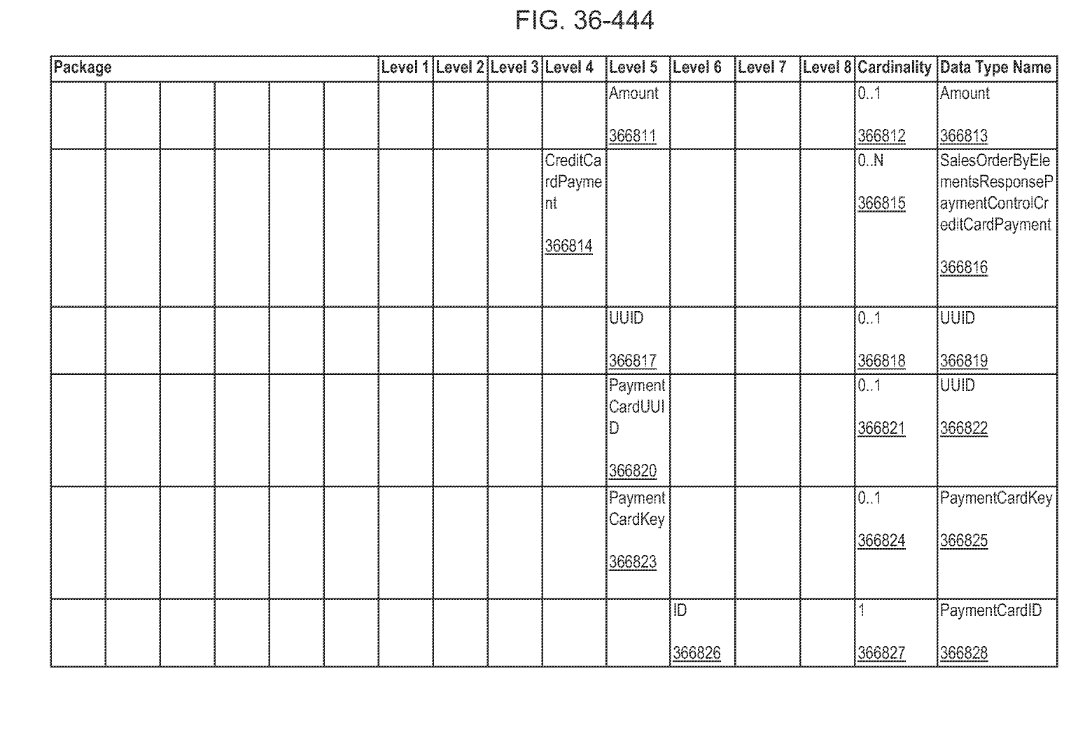

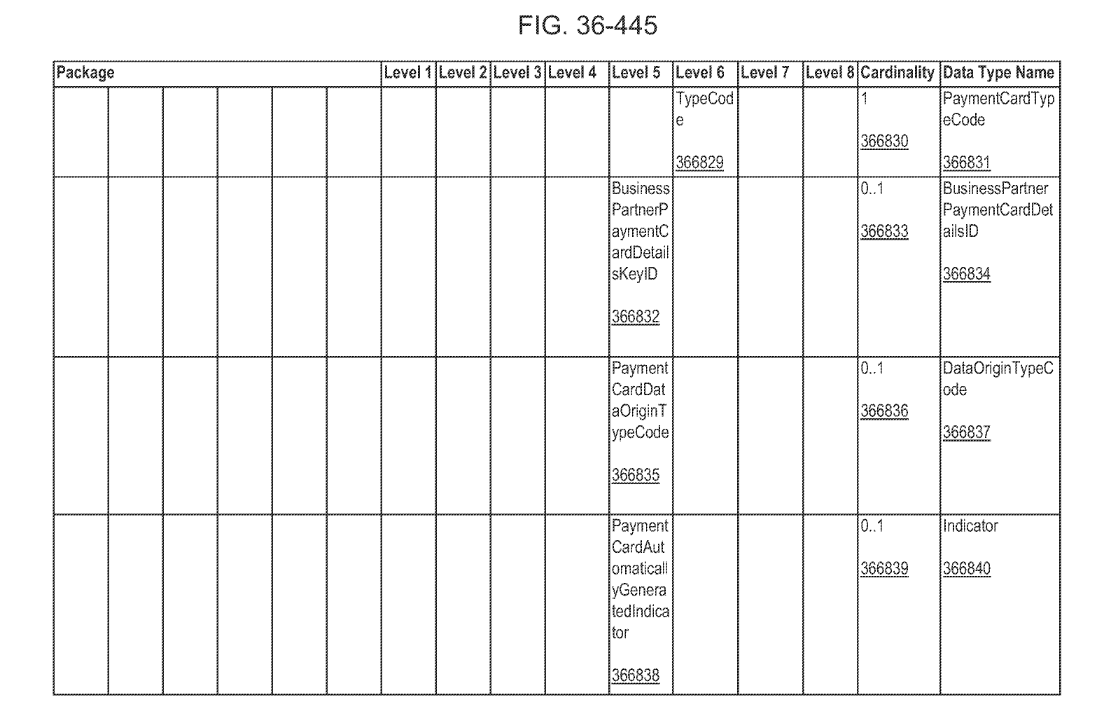

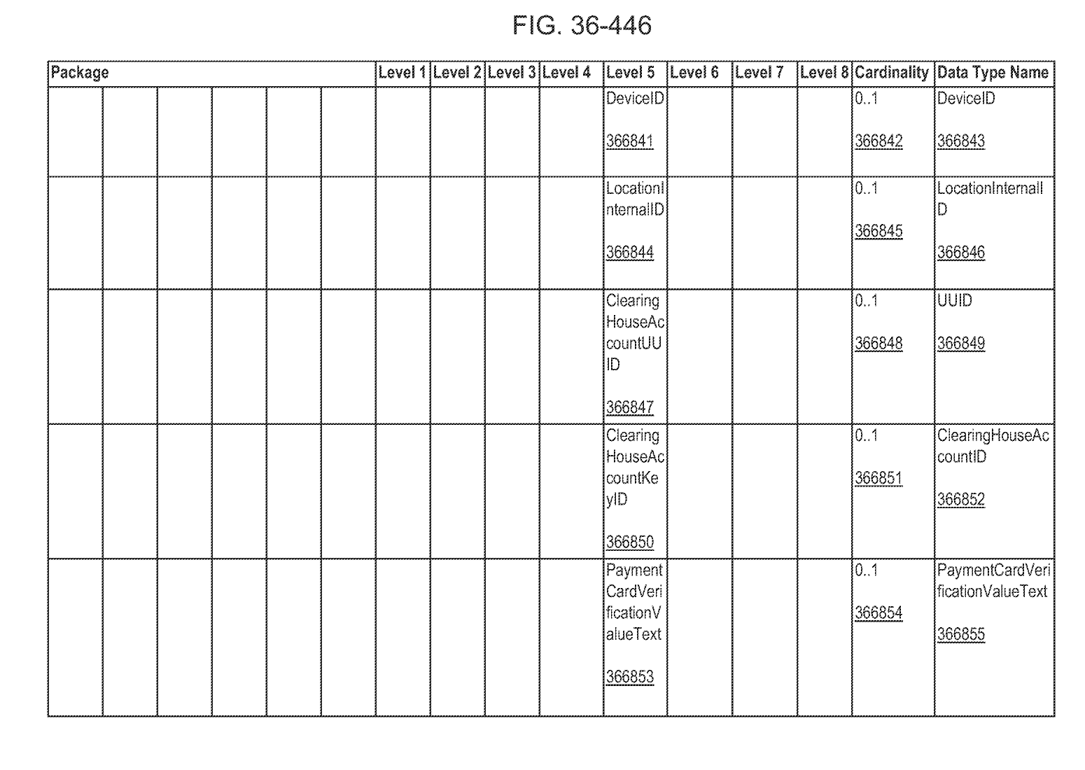

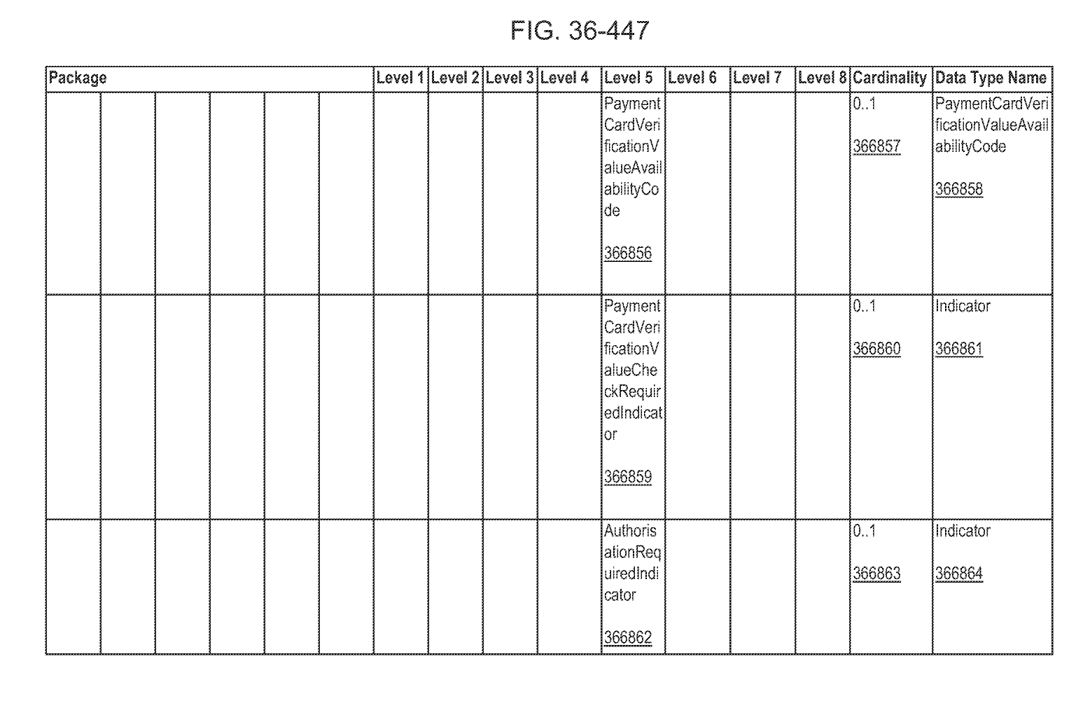

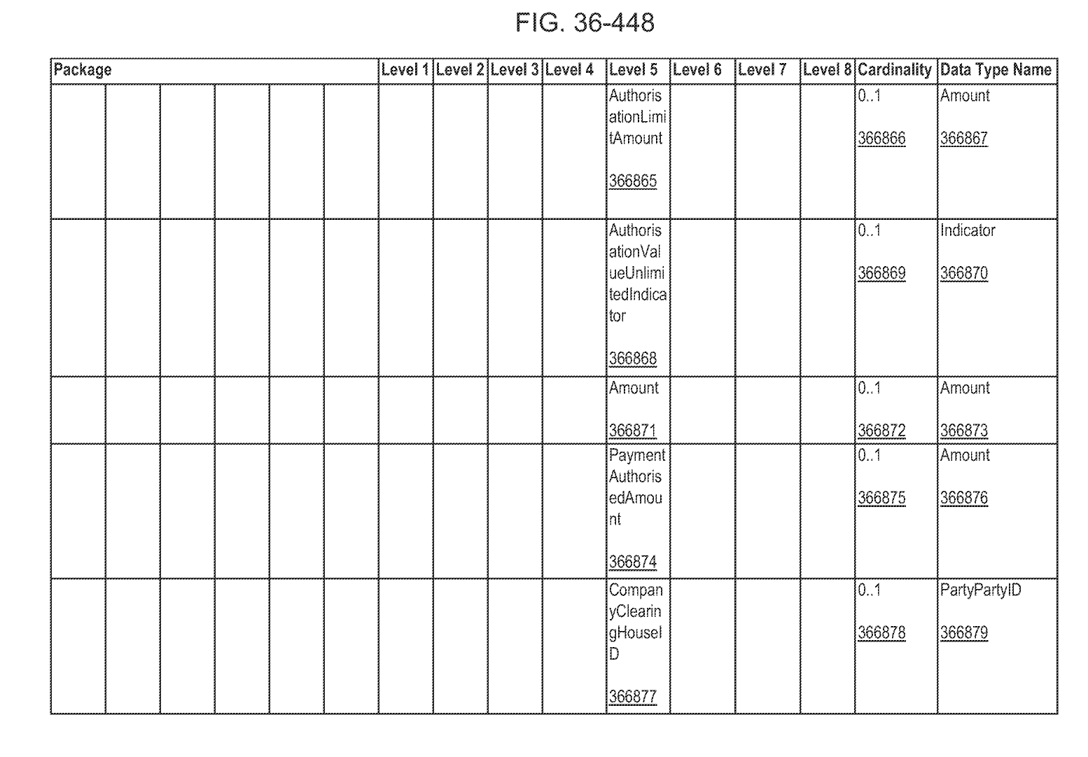

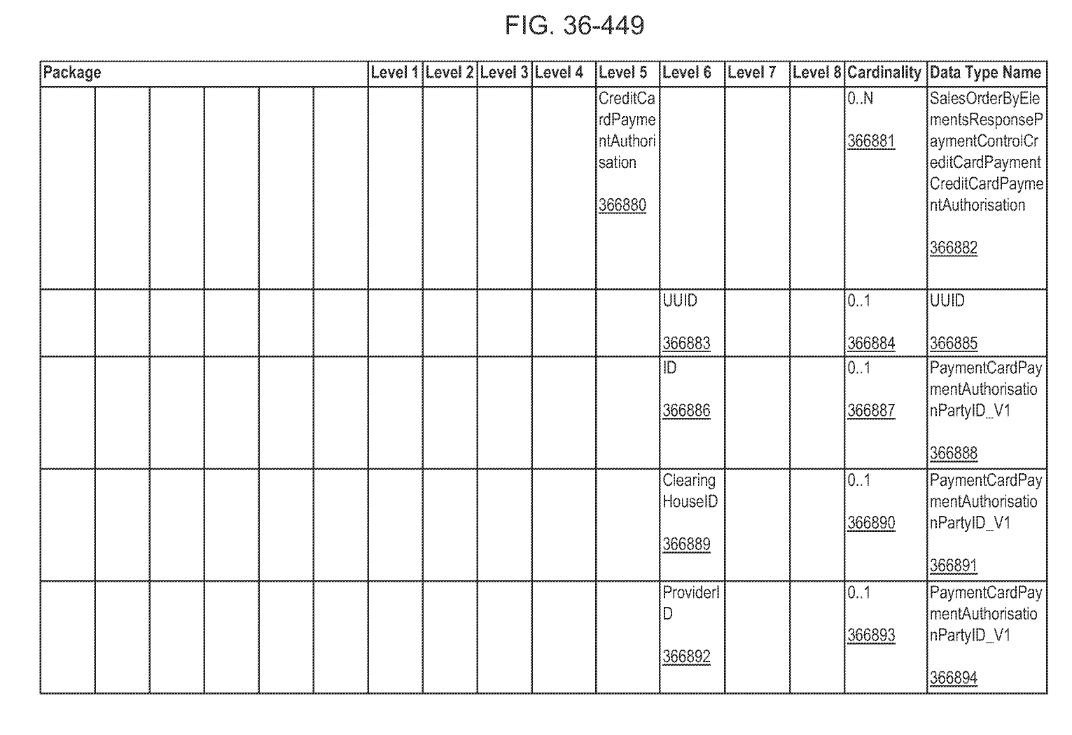

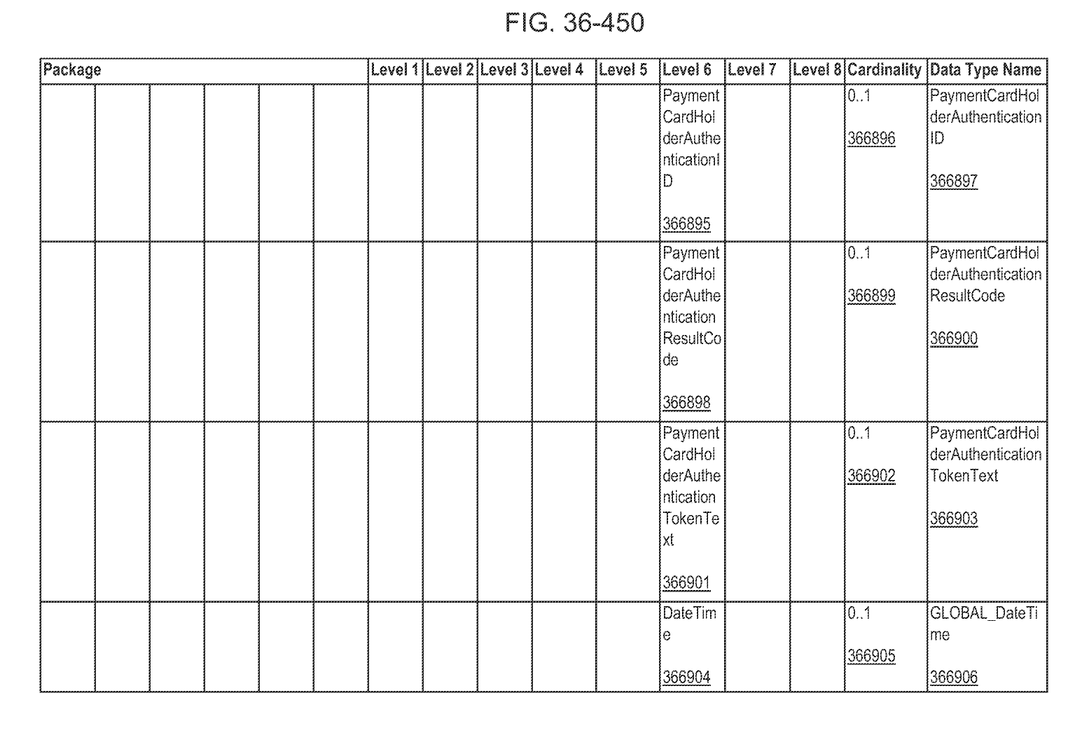

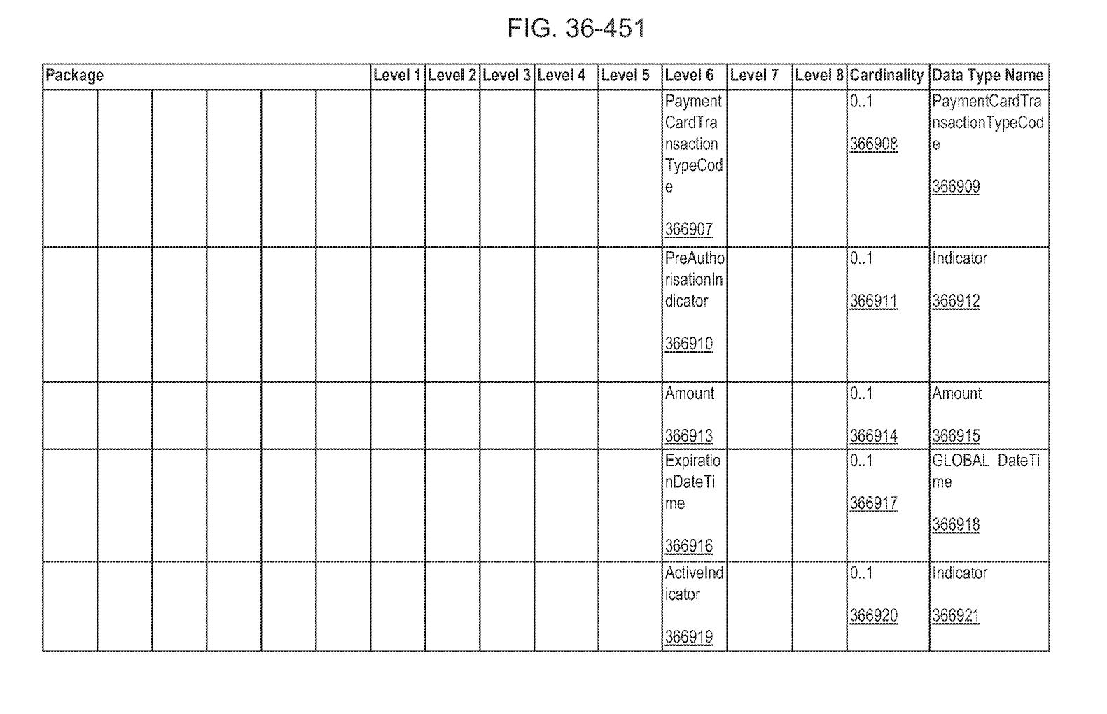

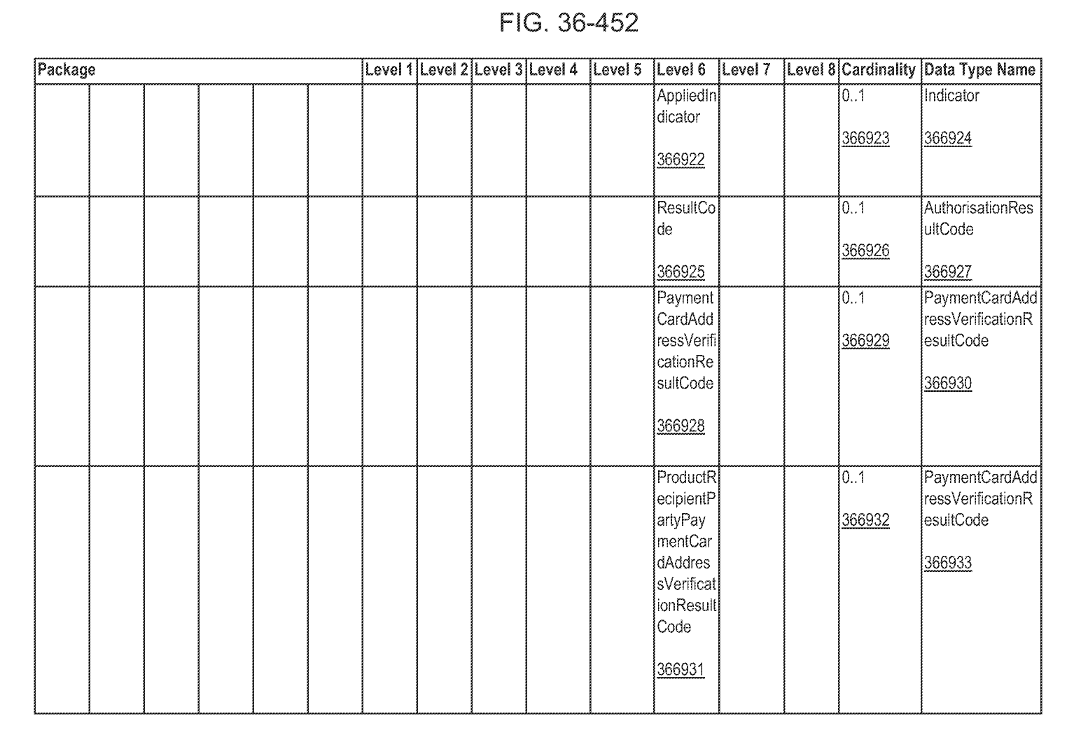

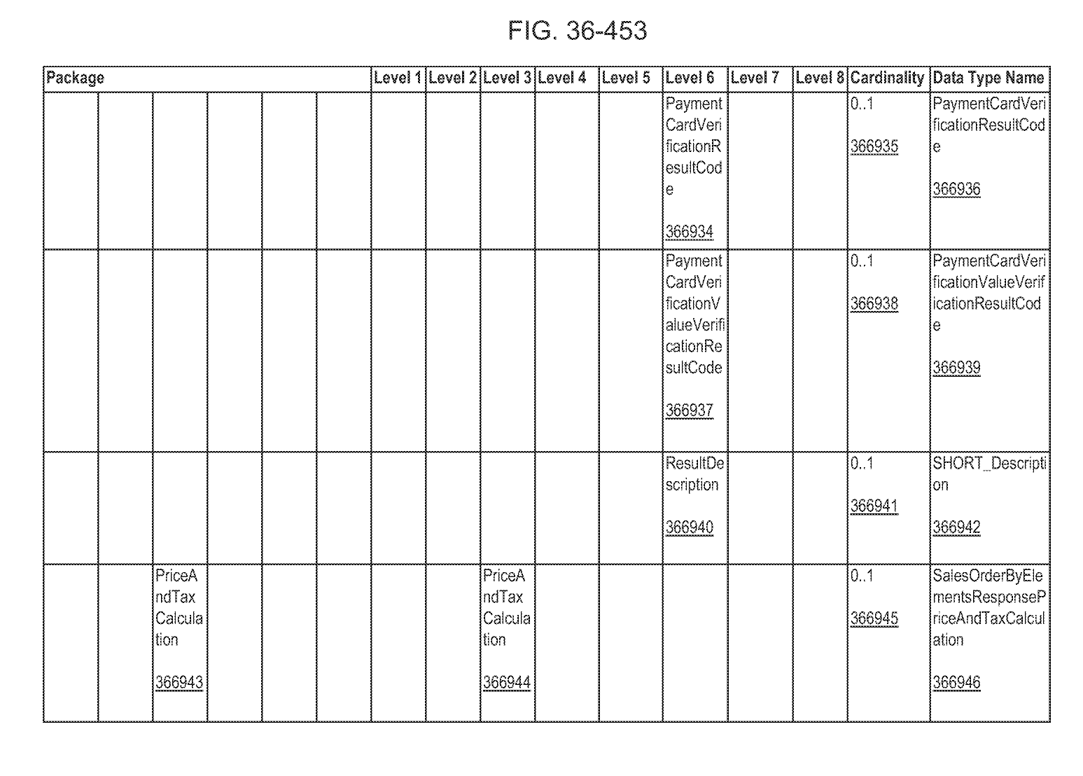

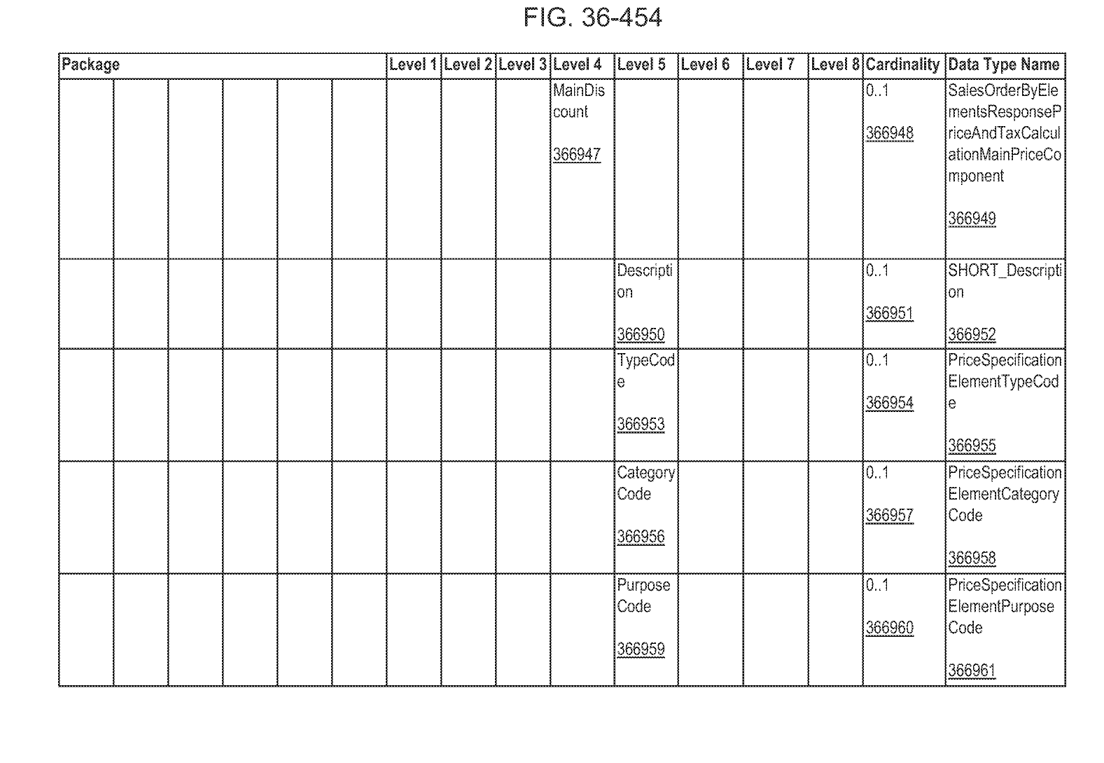

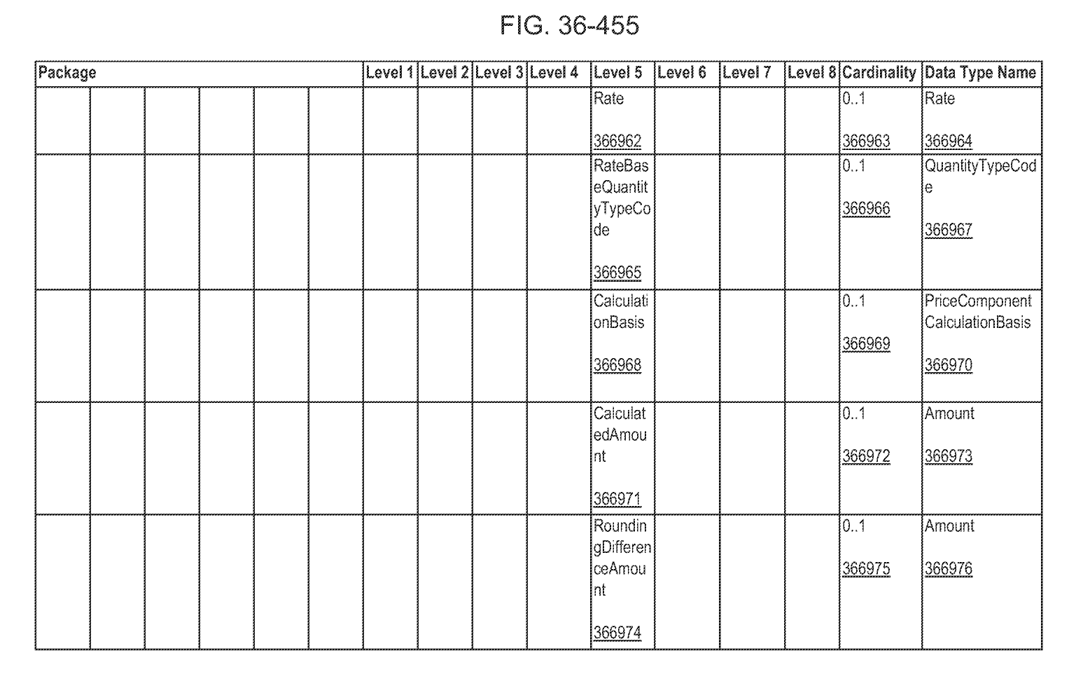

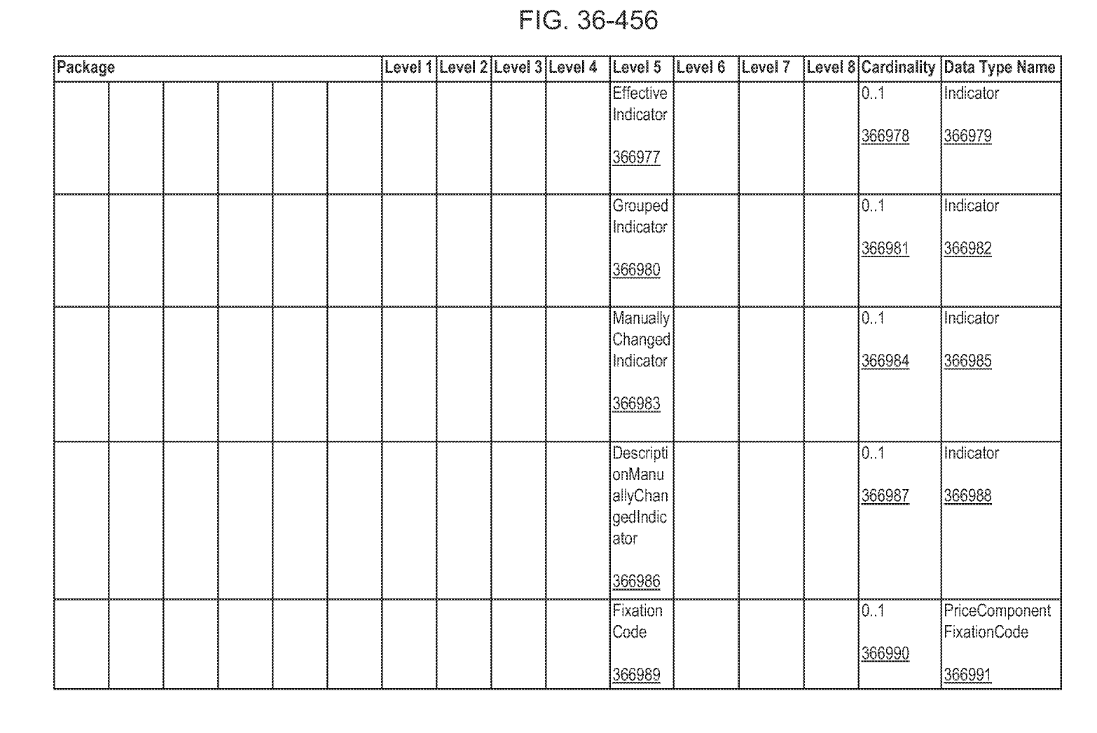

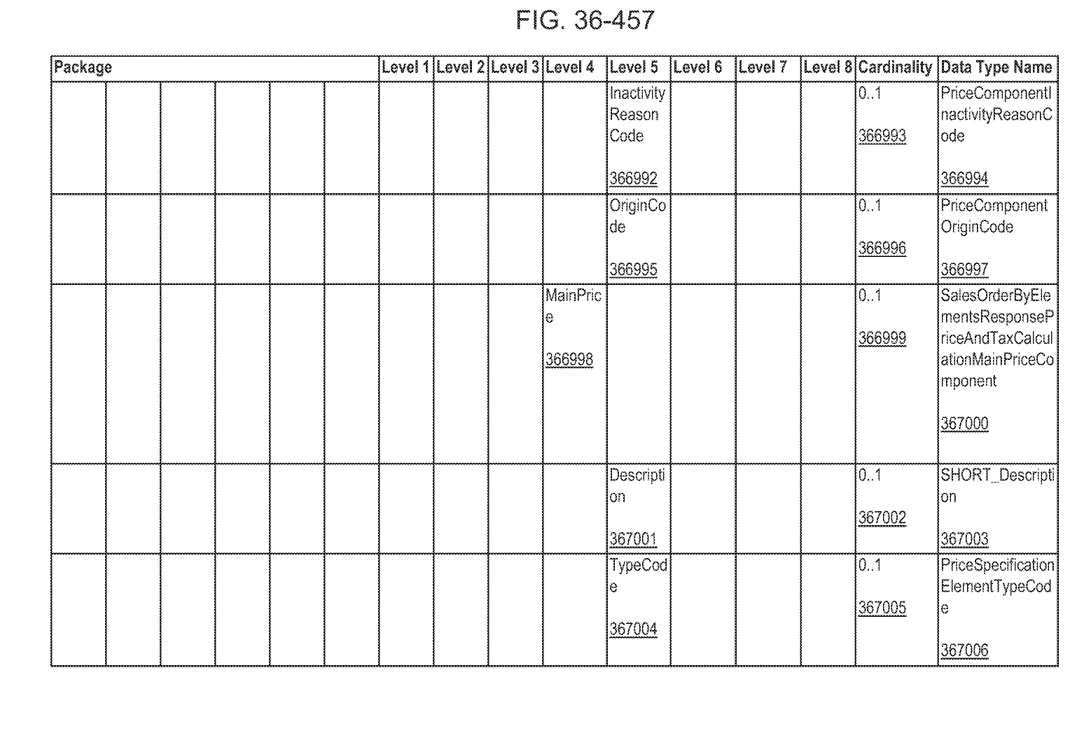

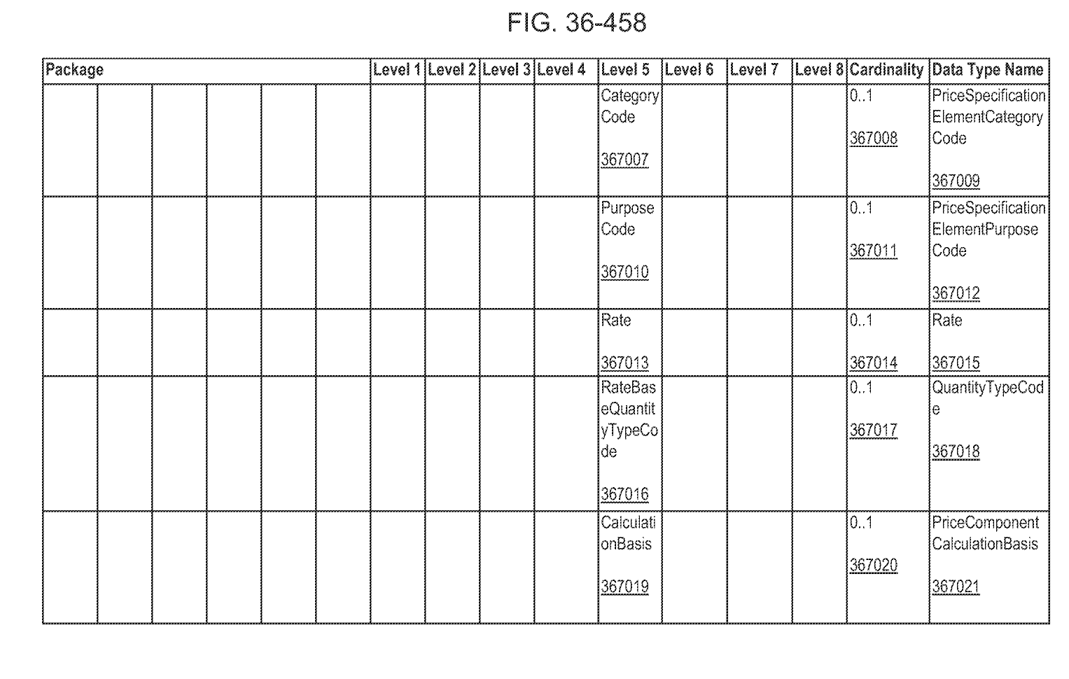

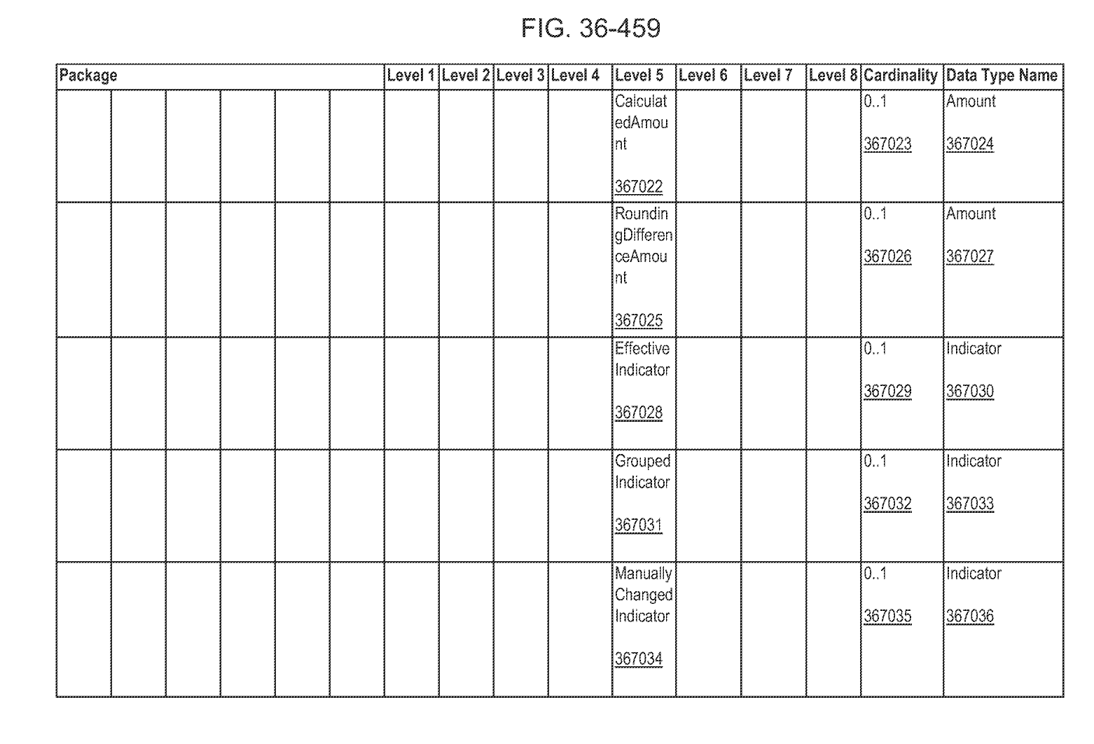

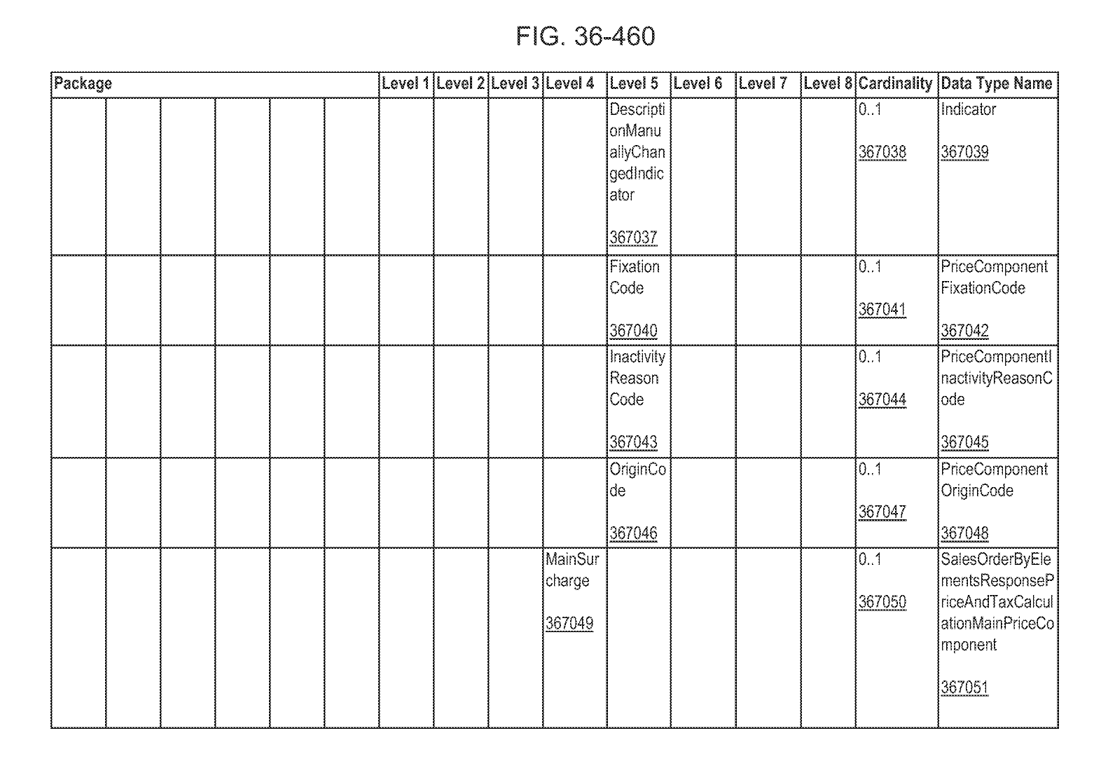

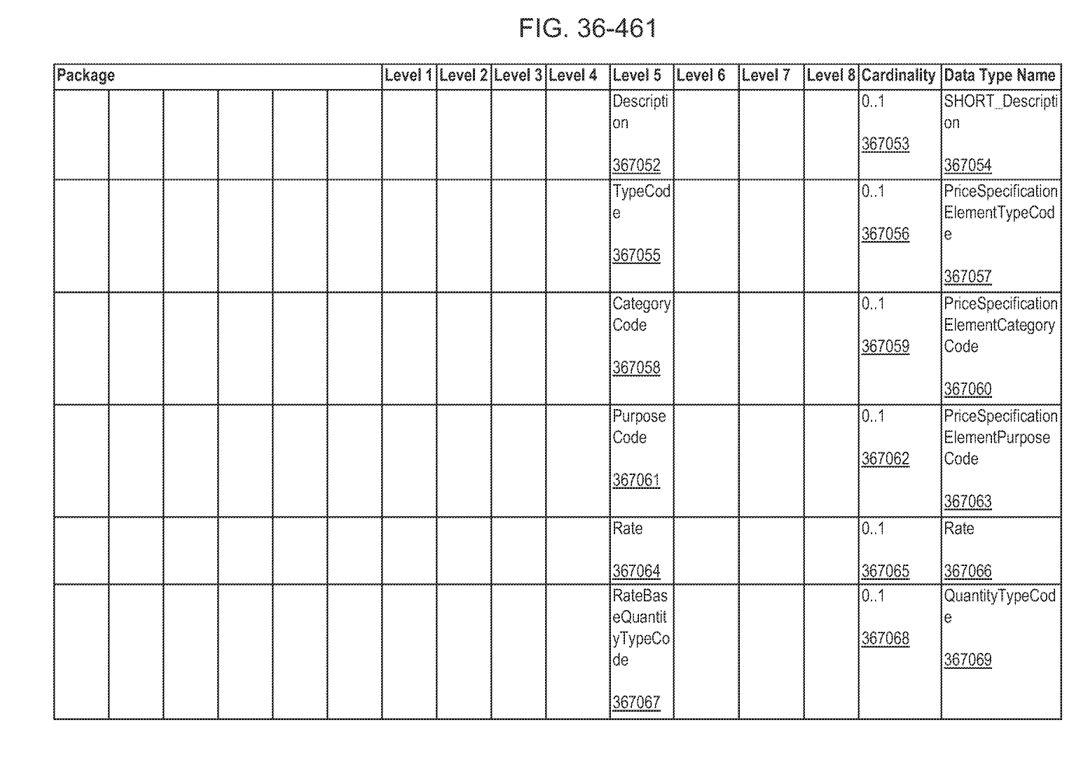

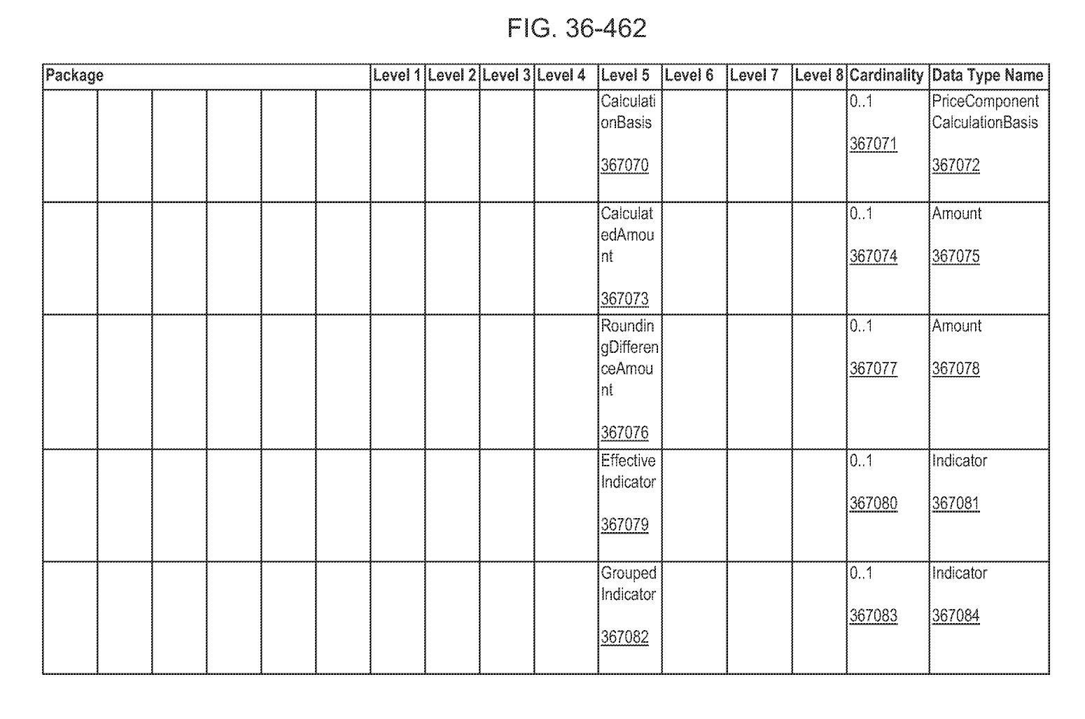

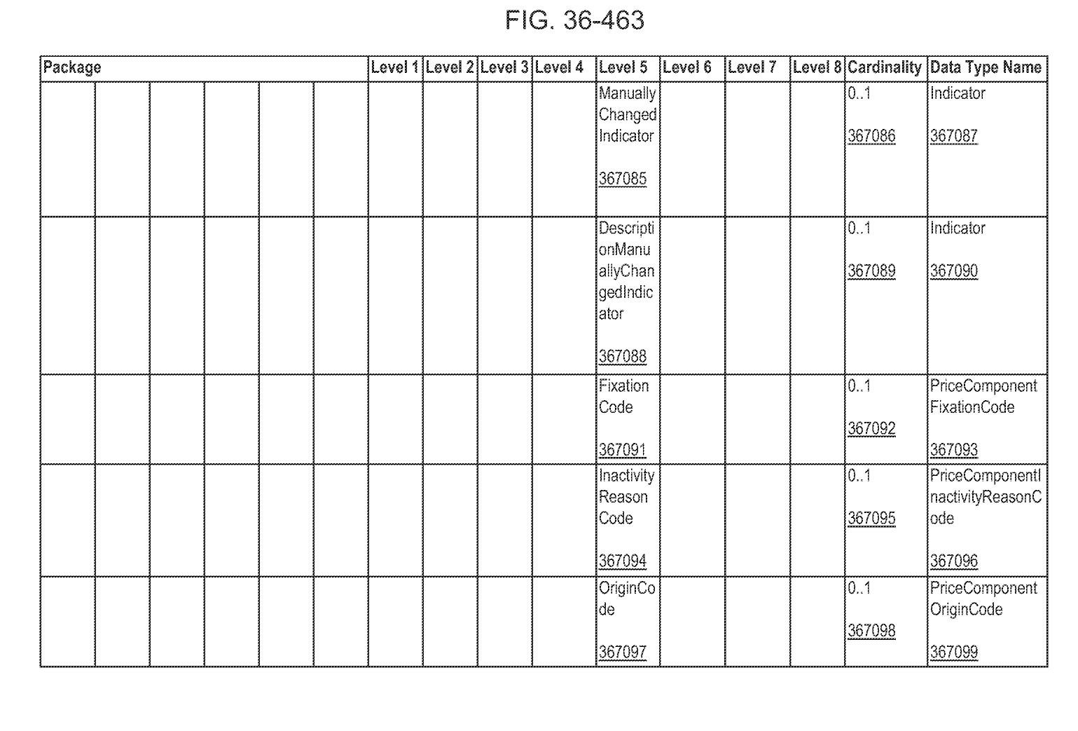

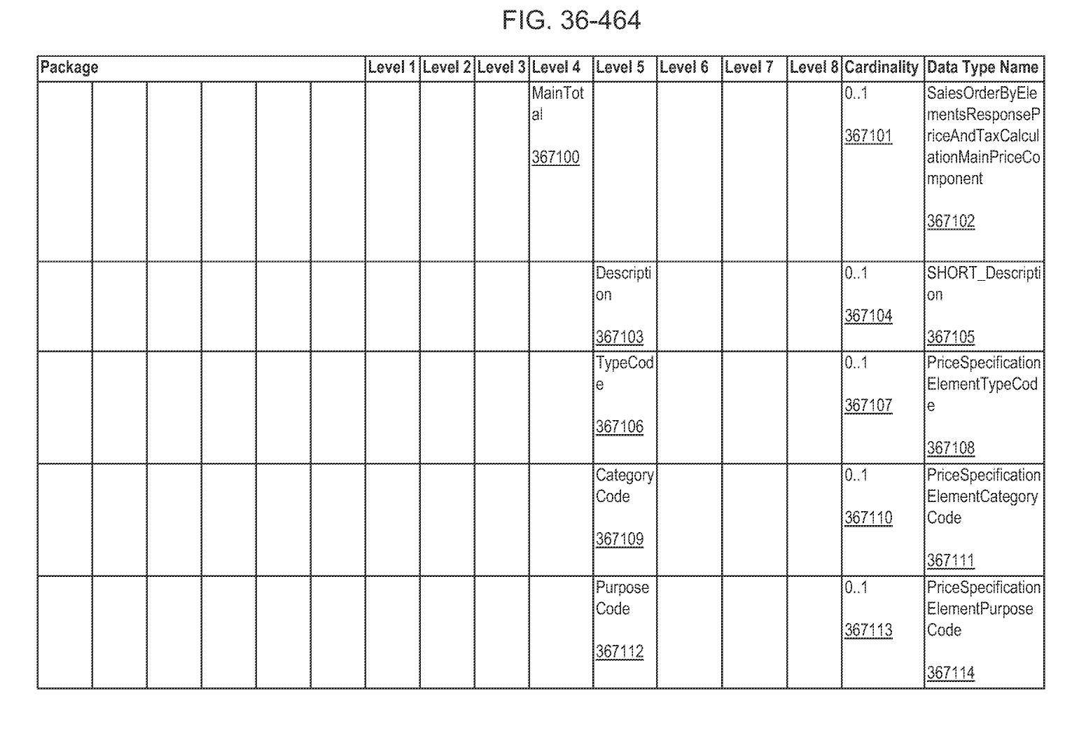

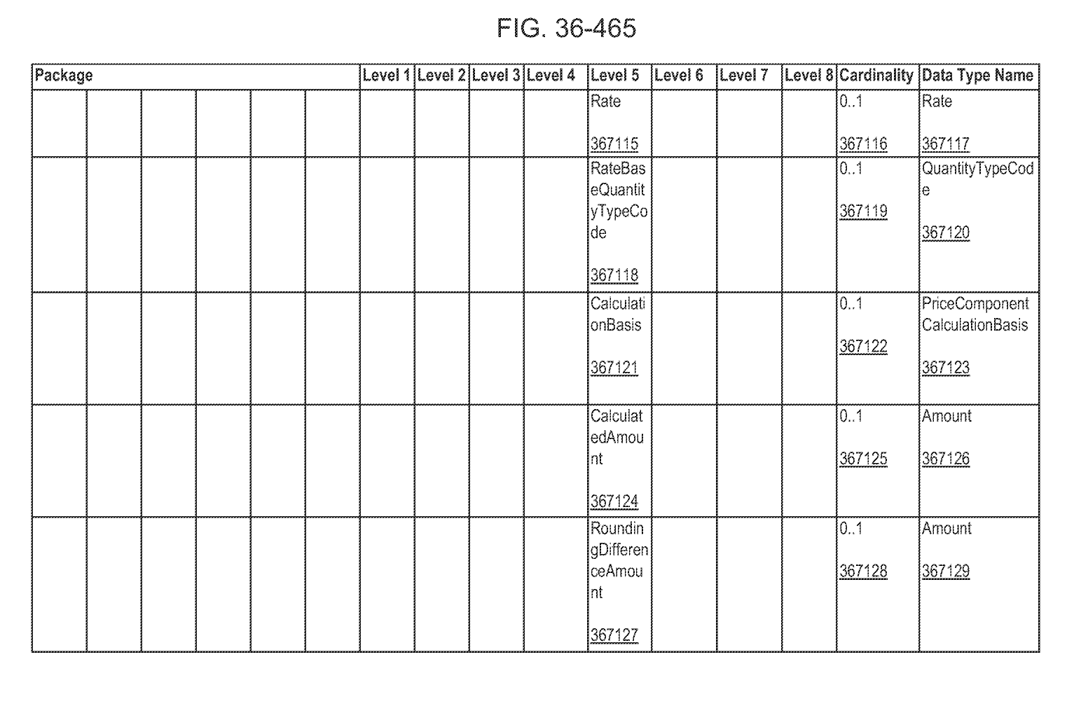

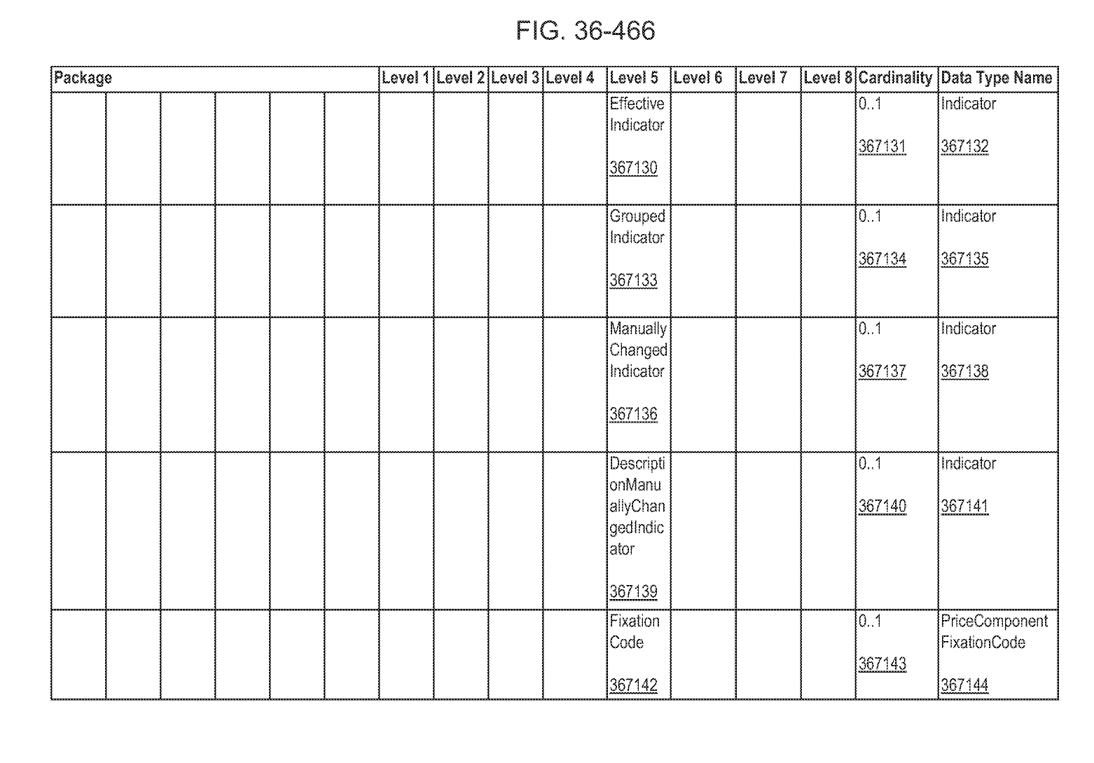

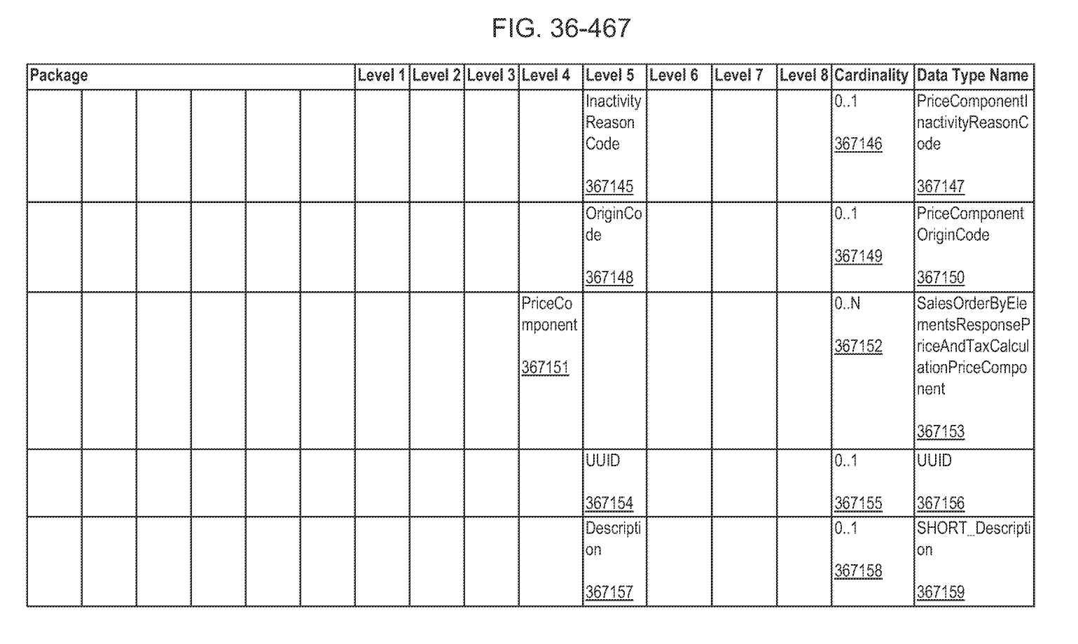

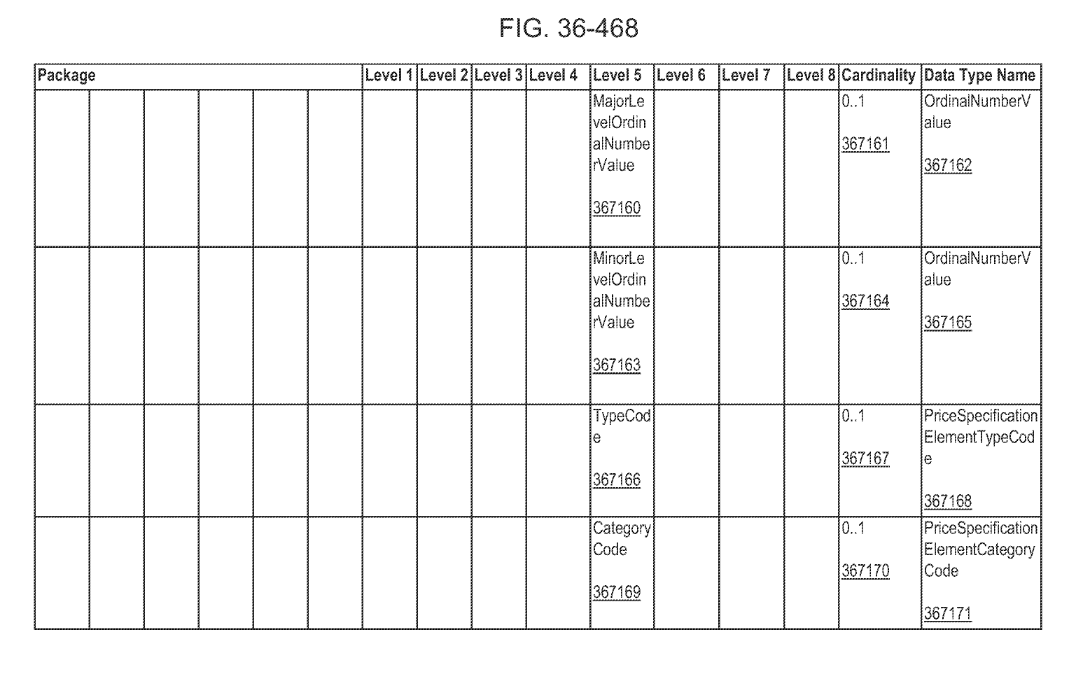

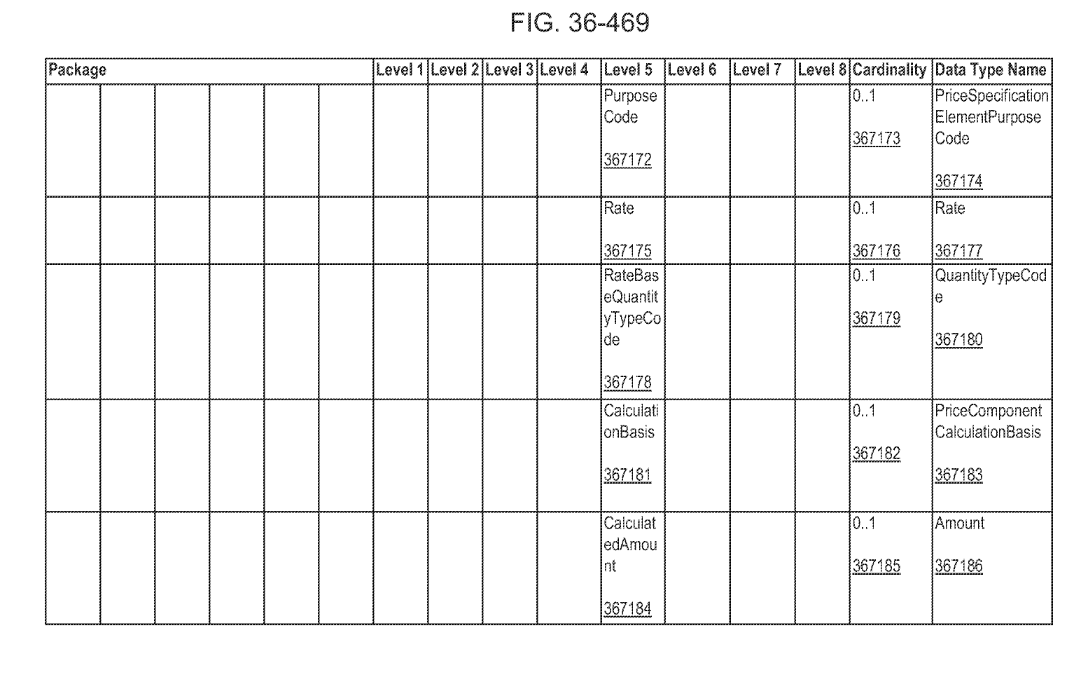

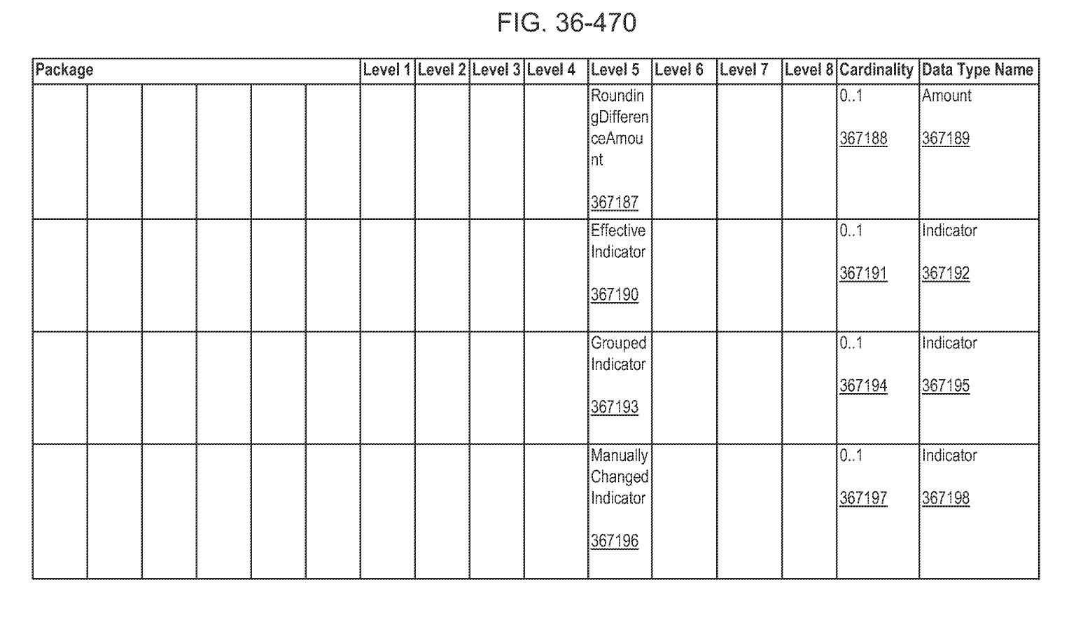

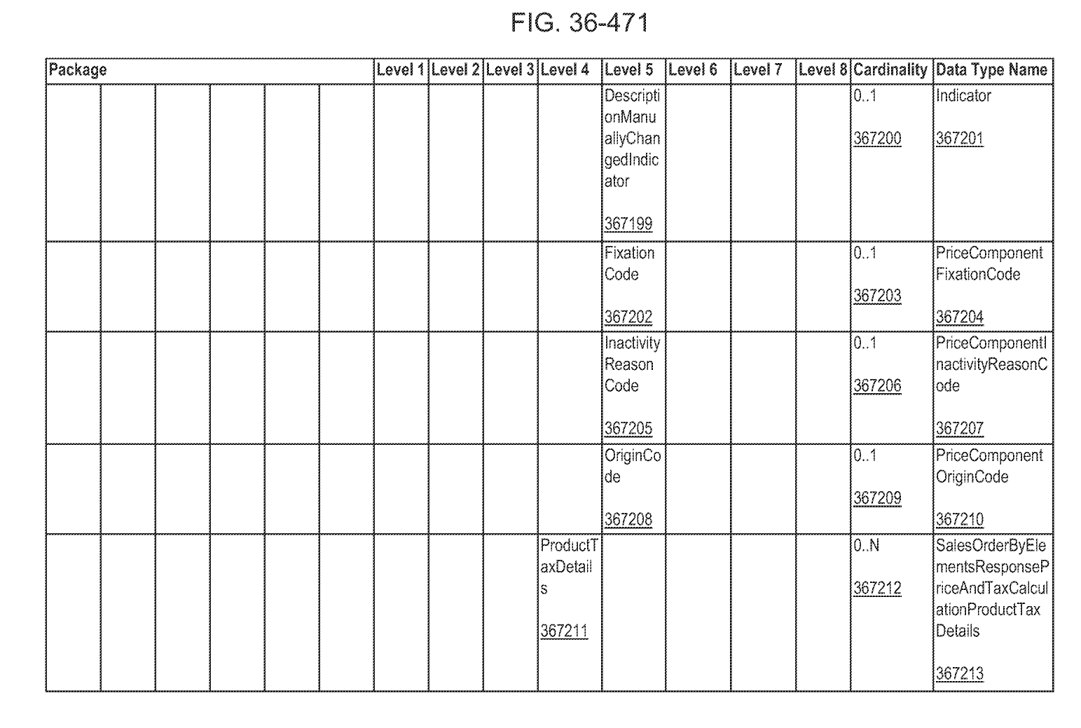

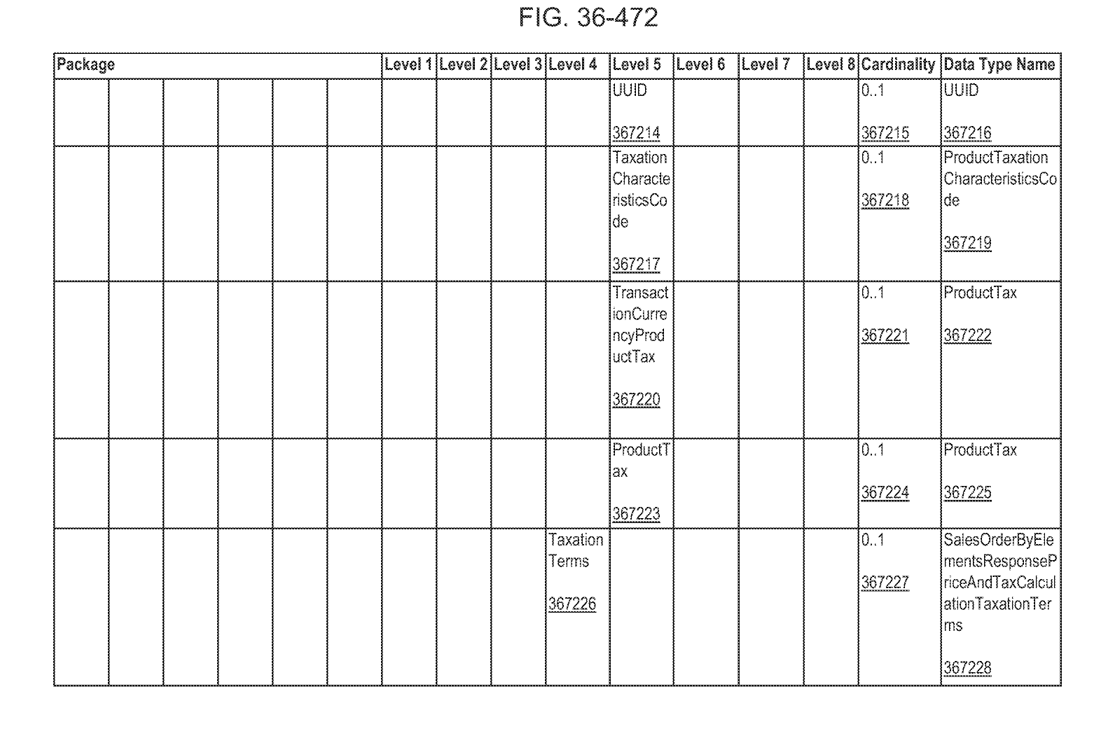

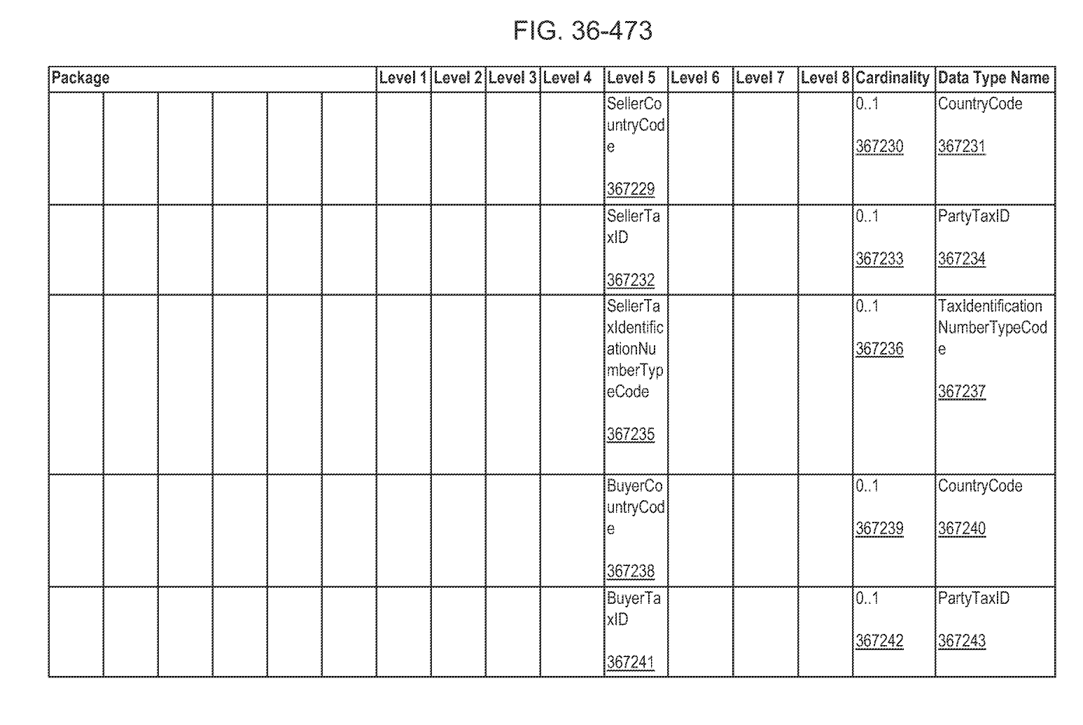

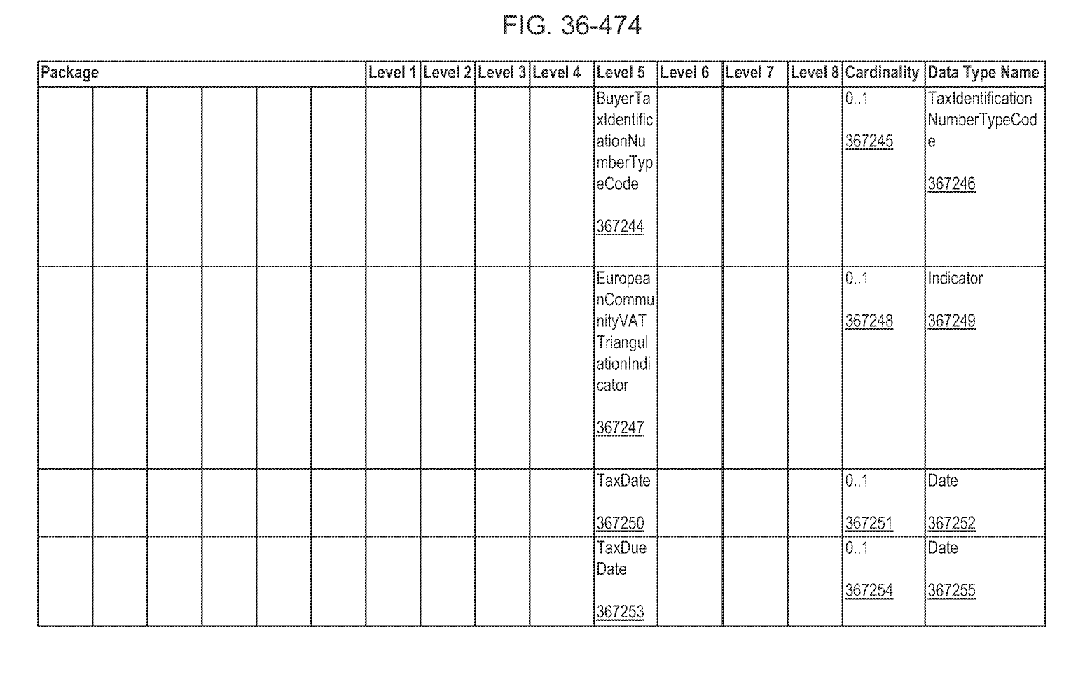

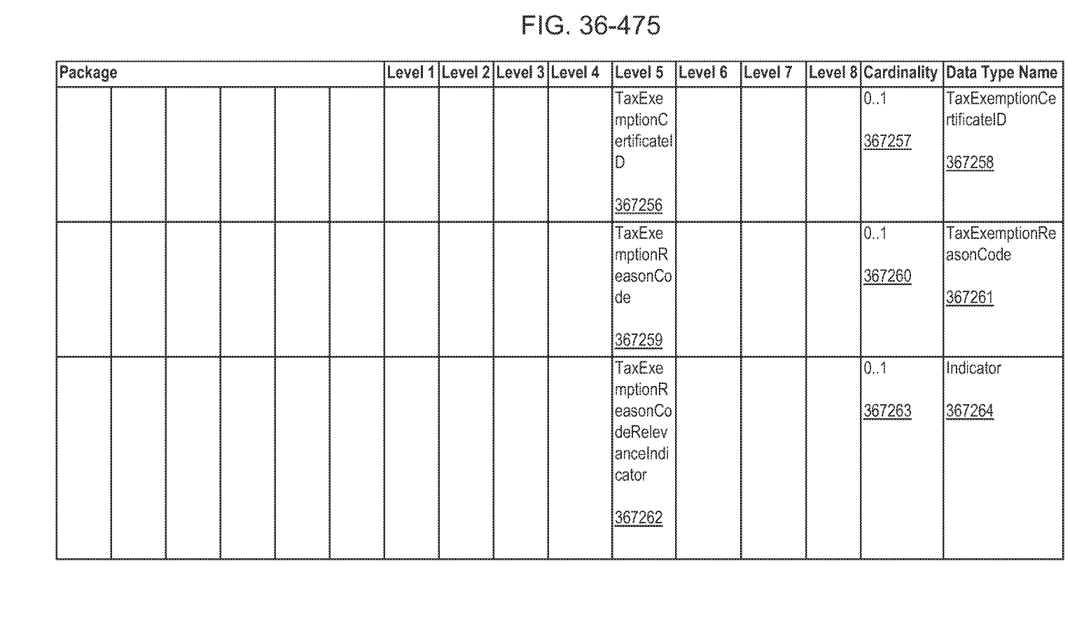

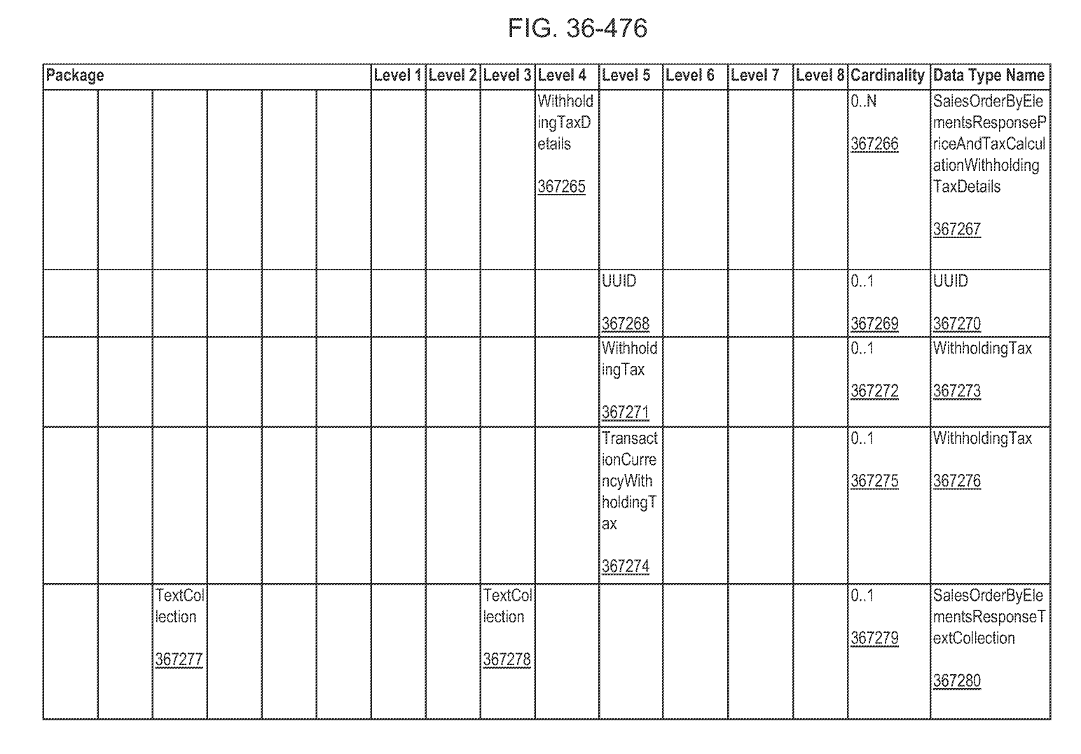

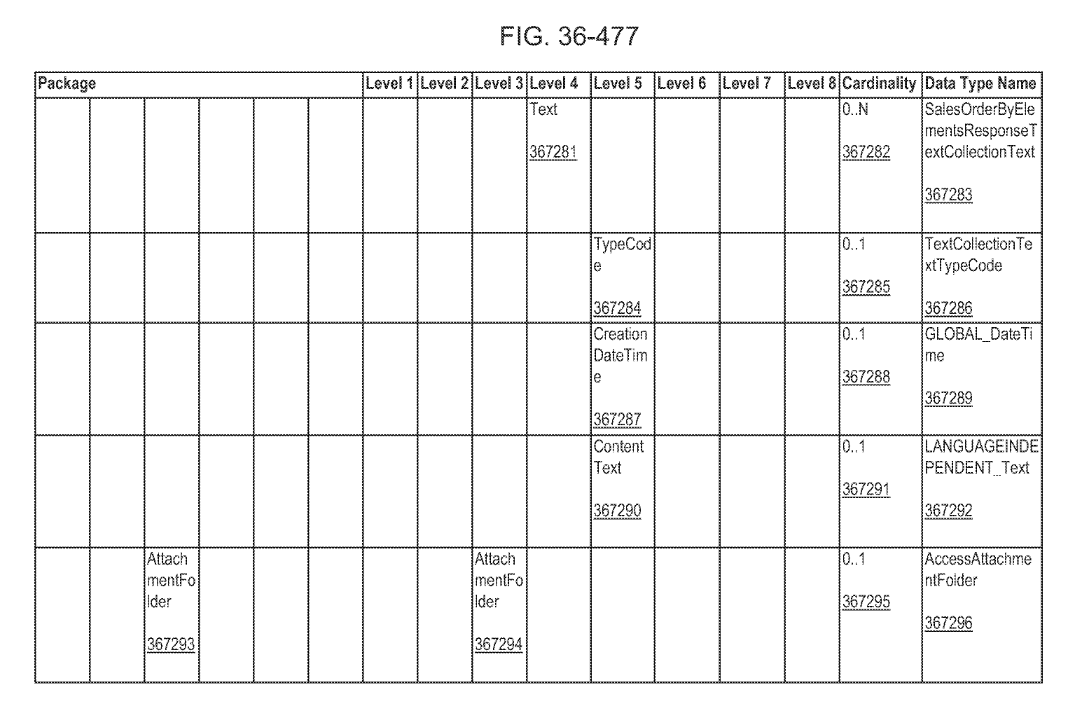

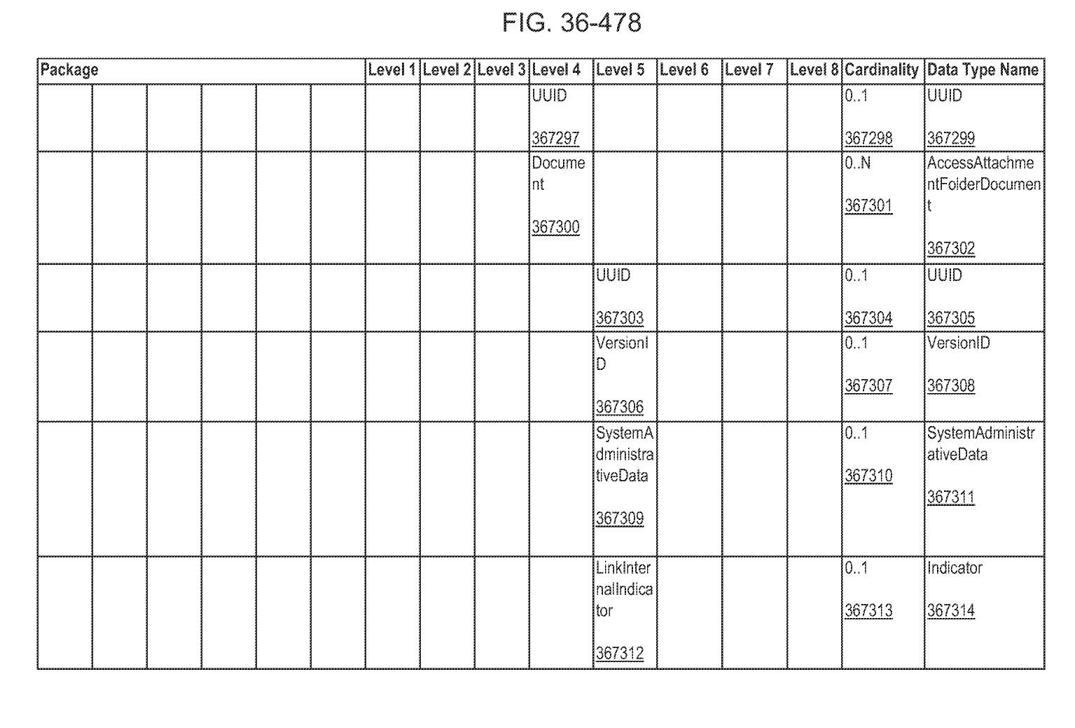

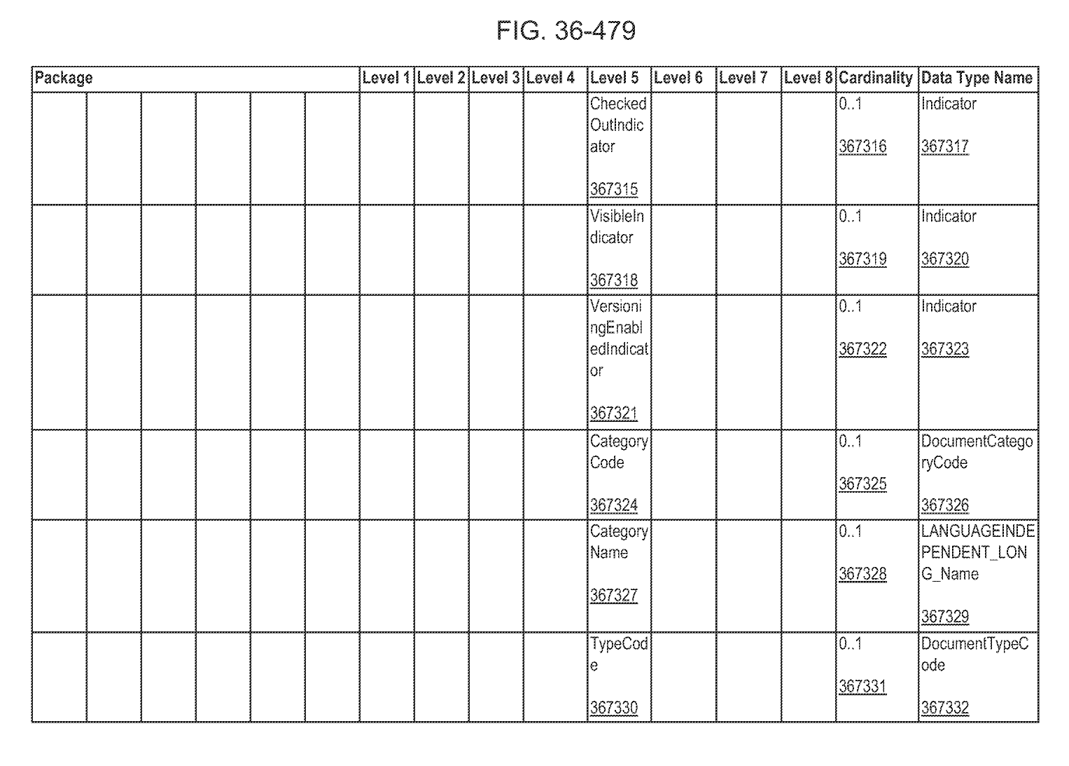

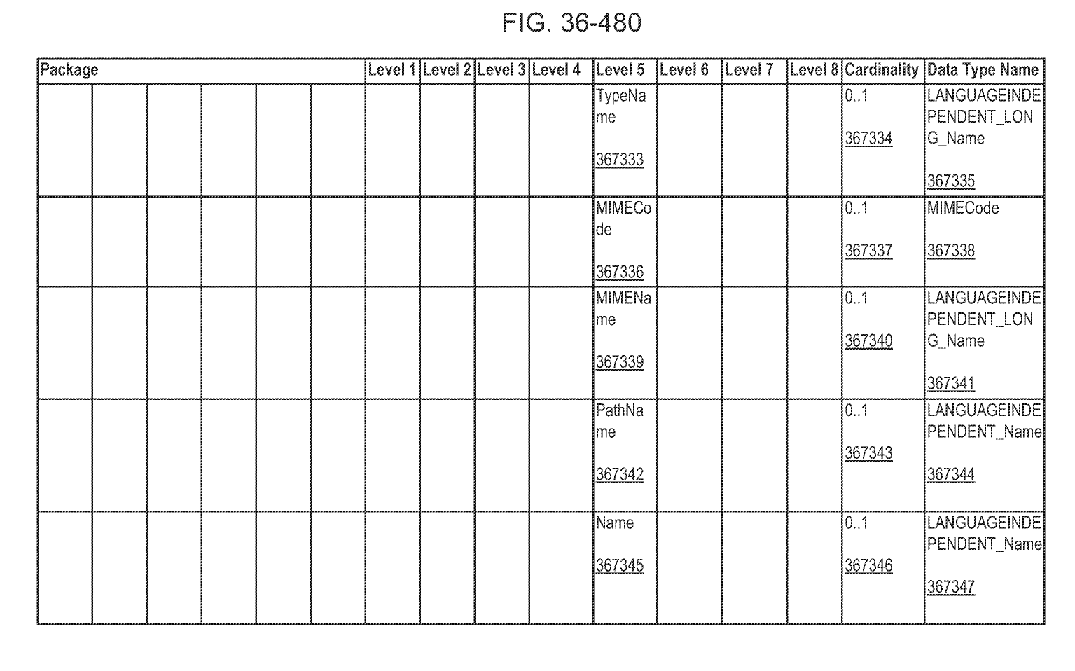

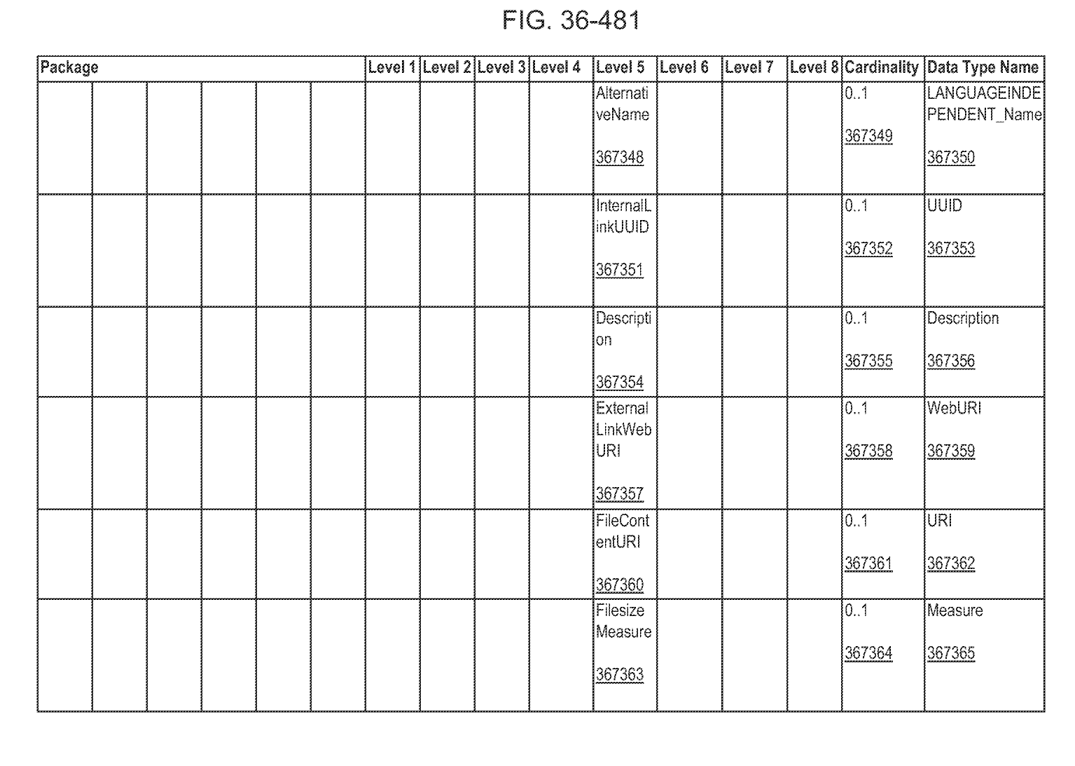

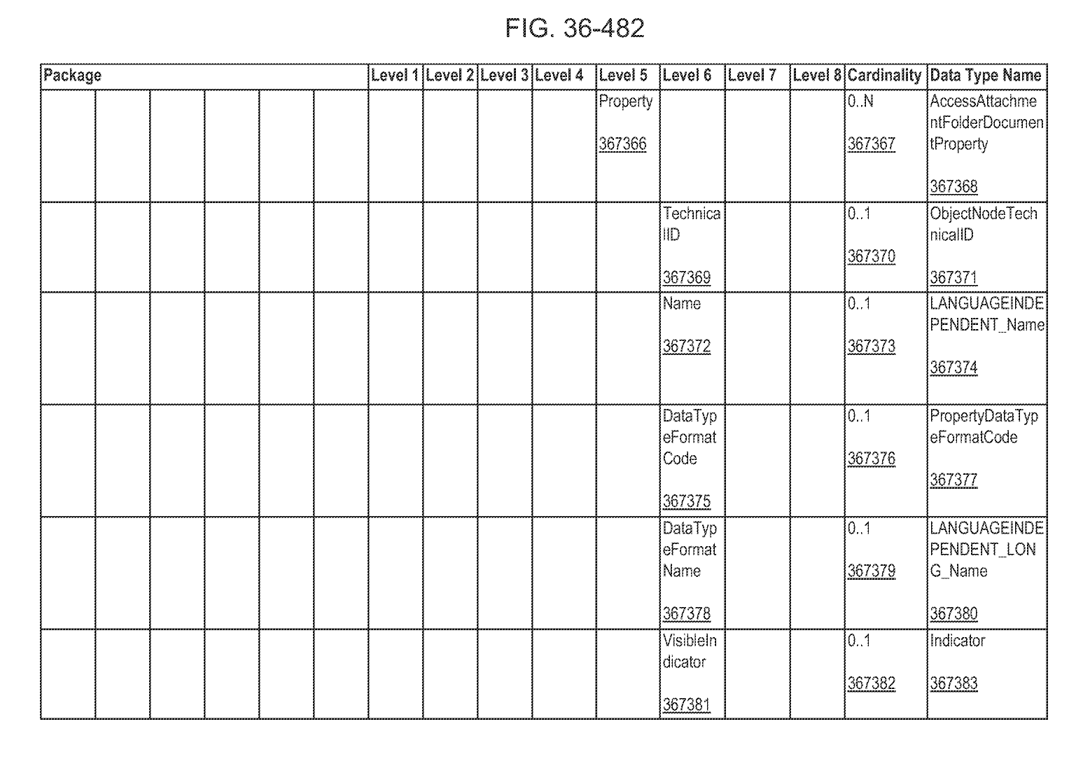

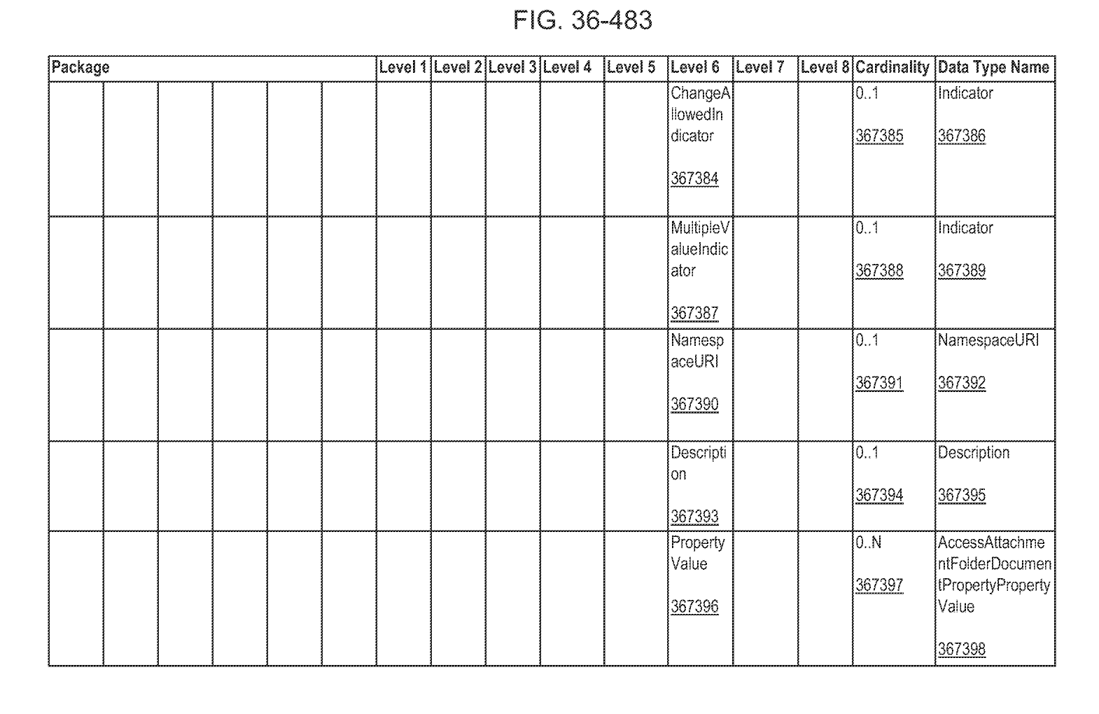

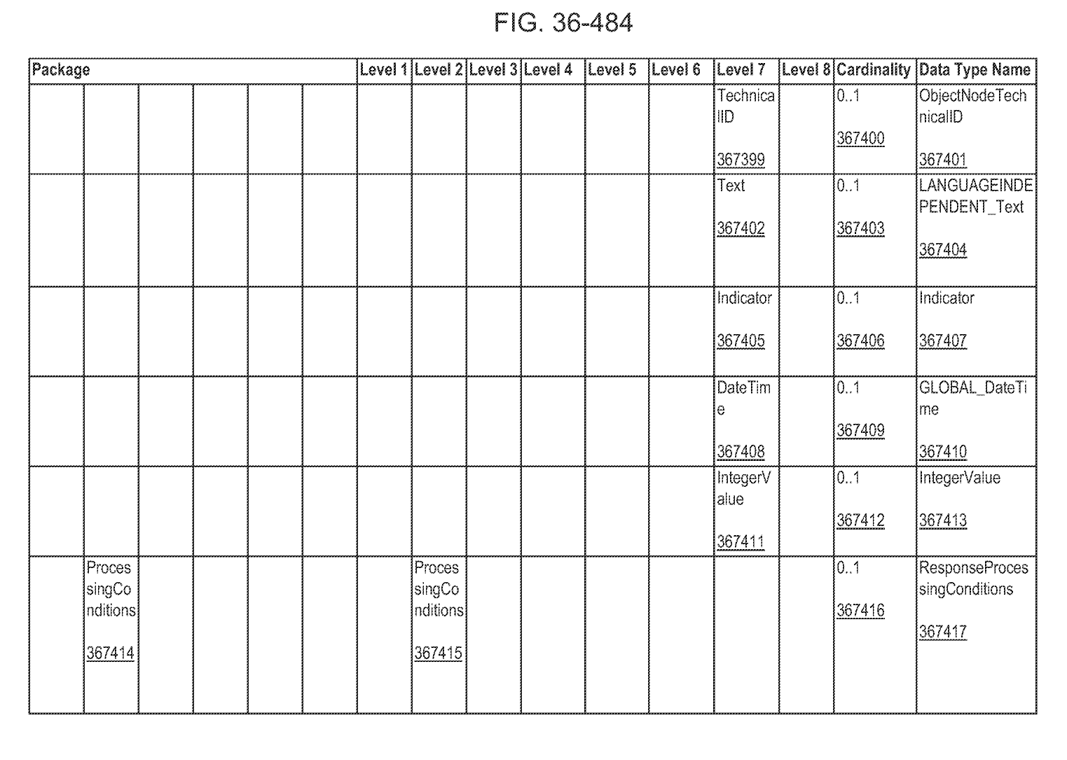

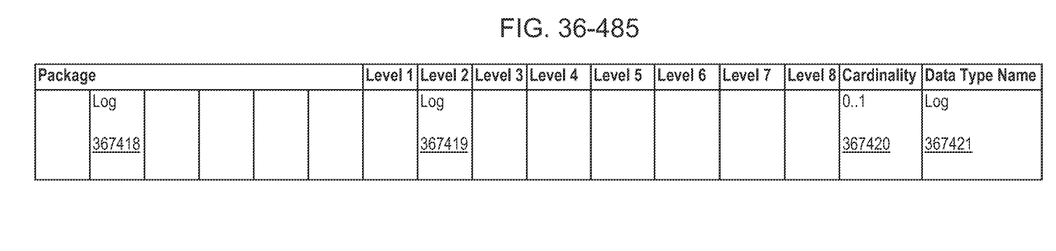

FIGS. 36-1 through 36-485 show an example configuration of an Element Structure that includes a Sales Order By Elements Response_sync 360000 package. Specifically, these figures depict the arrangement and hierarchy of various components such as one or more levels of packages, entities, and datatypes, shown here as 360000 through 367421. As described above, packages may be used to represent hierarchy levels. Entities are discrete business elements that are used during a business transaction. Data types are used to type object entities and interfaces with a structure. For example, the Sales Order By Elements Response_sync 360000 includes, among other things, a Sales Order By Elements Response_sync 360001. Accordingly, heterogeneous applications may communicate using this consistent message configured as such.

A number of implementations have been described. Nevertheless, it will be understood that various modifications may be made without departing from the spirit and scope of the disclosure. Accordingly, other implementations are within the scope of the following claims.

1. A computer readable medium including program code for providing a message-based interface for exchanging information about sales orders, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for querying information about specific sales orders, identified by selection criteria, including information about parties associated with sales orders and corresponding purchase orders, the first message including a first message package derived from the common business object model, the first message package hierarchically organized in memory based on the common business object model, the first message package including:
a sales order by elements query sync message entity;
a sales order selection by elements package, a processing conditions package, and a requested elements package, wherein the sales order by elements query package includes a sales order selection by elements entity, and wherein the sales order selection by elements entity includes at least one of a selection by identifier (ID) entity, a selection by buyer ID, a selection by item list customer order life cycle status code, a selection by name, a selection by buyer ID, a selection by posting date, a selection by data origin type code, a selection by approval status code, or a selection by employee responsible party ID, wherein the processing conditions package includes a processing conditions element, and wherein the requested elements package includes a requested elements entity, the request elements entity including a sales order entity;
program code for processing the first message according to the hierarchical organization of the first message package, where processing the first message includes unpacking the first message package based on the first message package's structure and the first message package's derivation from the common business object model, wherein the particular structure of the first message package is used at least in part to identify the purpose of the first message; and
program code for sending a second message to the heterogeneous application responsive to the first message, where the second message includes a second message package derived from the common business object model to provide consistent semantics with the first message package.

2. The computer readable medium of claim 1, wherein the sales order selection by elements entity further includes at least one of the following: at least one selection by item list customer order life cycle status code, at least one selection by name, at least one selection by buyer ID, at least one selection by posting date, at least one selection by data origin type code, at least one selection by item list execution release status code, at least one selection by approval status code, and at least one selection by employee responsible party ID.

3. The computer readable medium of claim 1, wherein the sales order selection by elements entity further includes at least one of the following: at least one selection by sales unit party ID, at least one selection by sales and service business area sales organisation ID, at least one selection by sales and service business area distribution channel code, at least one selection by service performer party ID, at least one selection by service execution team party ID, at least one selection by product ID, at least one selection by product requirement specification ID, and at least one selection by last changed date.

4. A distributed system operating in a landscape of computer systems providing message-based services defined in a service registry, the system comprising:
at least one processor operable to execute computer readable instructions embodied on non-transitory media;
a graphical user interface executable by the at least one processor and comprising computer readable instructions, embedded on non-transitory media, for querying information about specific sales orders, identified by selection criteria, including information about parties associated with sales orders and corresponding purchase orders, the instructions using a request;
a first memory storing a user interface controller executable by the at least one processor for processing the request and involving a message including a message package derived from a common business object model, where the common business object model includes business objects having relationships that enable derivation of message-based service interfaces and message packages, the message package hierarchically organized based on the common business object model, the hierarchical organization of the message package including:
a sales order by elements query sync message entity;
a sales order selection by elements package, a processing conditions package, and a requested elements package, wherein the sales order by elements query package includes a sales order selection by elements entity, and wherein the sales order selection by elements entity includes at least one of a selection by identifier (ID) entity, a selection by buyer ID, a selection by item list customer order life cycle status code, a selection by name, a selection by buyer ID, a selection by posting date, a selection by data origin type code, a selection by approval status code, or a selection by employee responsible party ID, wherein the processing conditions package includes a processing conditions element, and wherein the requested elements package includes a requested elements entity, the request elements entity including a sales order entity; and
a second memory, remote from the graphical user interface, storing a plurality of service interfaces executable by the at least one processor and derived from the common business object model to provide consistent semantics with messages derived from the common business object model, wherein one of the service interfaces is operable to process the message via the service interface according to the hierarchical organization of the message package, where processing the message includes unpacking the first message package based on the message package's structure and the message package's derivation from the common business object model, wherein the particular structure of the message package is used at least in part to identify the purpose of the message.

5. The distributed system of claim 4, wherein the first memory is remote from the graphical user interface.

6. The distributed system of claim 4, wherein the first memory is remote from the second memory.

7-10. (canceled)
